(19) United States
(12) Patent Application Publication
(10) Pub. No.: US 2011/0153362 A1
(43) Pub. Date: Jun. 23, 2011

(54) Method and mechanism for identifying protecting, requesting, assisting and managing information

(76) Inventors: David A. Valin, Flushing, NY (US); Alex Socolof, Briarcliff Manor, NY (US)

(21) Appl. No.: 12/653,749

(22) Filed: Dec. 17, 2009

(51) Int. Cl. G06F 17/00; G06K 9/62; H04N 13/02; G05B 19/00; G06K 7/00; G06Q 40/00; G06Q 20/00; G06Q 50/00; G06Q 10/00; E05B 65/00

(52) U.S. Cl. 705/3; 382/116; 348/47; 340/5.82; 235/435; 705/37; 70/57; 348/E13.074

(57) ABSTRACT

A method and mechanism used for or by, individuals, groups, corporations, (profit and non profit), professionals, businesses, schools, governments, institutions, and machines to help, protect, create, design, record, file, document, publish, authenticate, plan, market, personalize, distribute, manufacture, license, franchise, sponsor, advertise, publicize, track, project, calendar, voting, rate, conference, rent, lease, price, request, propose, order, pay, fund, buy, sell, lend, bank, finance, store, insure, barter, gift, repair, service, build, share, check, insure, install, learn, teach, research, promote, collaborate, adopt, think, monitor, manage, remind, administer, broadcast, target spatial points, communicate, manage energy communication, connect like minded people, offer self help, manage group health, combined with data aggregated from a vision engine, hearing engine, touch engine, taste engine, smell engine, with data from the mechanical internet, the life Internet, and fuzzy logical, abductive, inductive, deductive, and backward chaining reasoning, to give forward suggestions, proposals, decisions, information and search in a network and non network.

### BACKGROUND OF THE INVENTION

The inventors have built a machine, which is portable and works in wireless devices as well as a wired network that helps individuals to make better choices and decisions called GSense. GSense develops a personality by recording and storing information about a person that it is given, or that it comes in contact with. An example of how the machine can be used would be for a person that goes food shopping at a supermarket carrying a mobile device connected and attached to the GSense servers, a person could scan food products and be reminded by GSense whether those food products were appropriate for their diet. GSense is able to scan the product for its ingredients and determine if that product is too high in sodium for someone who has high blood pressure, or if the product has too many calories for someone who is on a diet. GSense analyzing this information and gives the results in real time and helps the user determine whether they should buy the product or not. It is the additional smart intelligent information that GSense provides that helps a person make a better more informed decision. GSense aggregates information, retrieves information, and sends information using reminders, requests, proposals and suggestions.

In addition GSense is connected to the Protect Anything Human Key which uses 18 different mechanisms to uniquely identify a human being, person, or individual. The Protect Anything Human Key is a new payment system because each person uses their own unique identity to authorize a payment. This will substantially reduce or eliminate identity theft for those that use this method and mechanism.

Additionally the Protect Anything Human Key can lock and unlock thereby protecting anything that a person, corporation or group, or institution, including government deems sensitive or worth securing protecting. The invention requires the user to use their unique identity to lock and unlock a protected device, network, machine, file, data, payment of record, by speaking a command and matching the voice command the their 3D identity. What can be protected by an individual is listed in the patent.

GSense with Protect Anything Human Keys can distribute information to spatial point targets, static or mobile, and distribute information and content in virtual augmented reality. Additionally, information can be transmitted bi-directionally or multi-directionally, to websites, networked screens, and or mobile wireless or wired devices.

GSense with the Protect Anything Human Key is embedded in a dual lens 3D camera, which can record, upload, 3D VAR content and distribute it live through the GSense Server Network or store the content for on demand, subscription, pay per view, pay per click or free use. Any 3D VAR content can be transmitted through the GDSense servers to any spatial point, website, mobile device, or display screen including glass.

GSense is a new point of purchase mechanism, advertising mechanism, sponsorship mechanism, and will transmit, and receive and distribute information, and content to floors glass, ceilings, walls, buildings, sidewalks, homes, and clothing thereby turning those surfaces into digital advertising space and content surfaces.

GSense with the Protect Anything Human Key is a new way to pay for goods and services, online and offline by attaching the individual and group payment to a unique individual identity.

In addition GSense with the Protect Anything Human Key will be linked attached to GSense Credit/Debit cards and other debit credit cards, eliminating the need for a user to register and give out personal information to multiple vendors and or websites.

GSense with the Protect Anything Human Key is a new way to register, retrieve, and identify products using smart product tags and objects inanimate and animate, The registry will contain information about the product, where it is made, the cost, color, texture, fabric etc. and demonstrate how it works, is assembled, and its features and benefits.

GSense has a smell, taste, hearing, vision, and touch engine which enables the mechanism to provide reasoning and analysis functions. Finally, GSense is an energy and communication network. It's energy is harvested from solar panels located on residential and commercial real estate properties. GSense can and does communicate with these panels for a totally intelligent dispersal and management of energy resources.

A method and mechanism for identifying, protecting, requesting, assisting and managing information

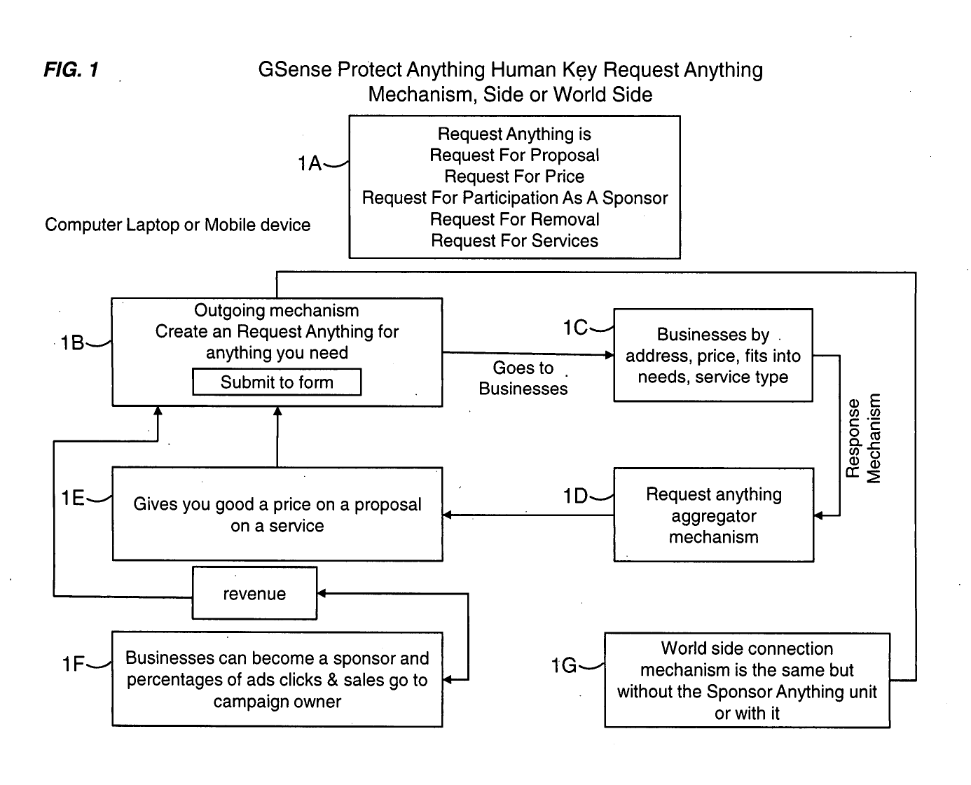

FIG. 1-1A describes Request Anything side or world side Request Anything is request for proposal, request for price, request for participation is a sponsor, request for removal, request for services.

FIG. 1-1B describes outgoing mechanism creating Request Anything for anything you need and the submit form button.

FIG. 1-1C describes how the outgoing mechanism submitted form goes to businesses as assist by address, price, fits into needs, and service type and then it's passed on to the response mechanism.

FIG. 1-1D describes the Request Anything aggregator mechanism as related to the response mechanism for businesses submit the form or consumer request for participation.

FIG. 1-1E describes where the Request Anything module and Request Anything aggregator mechanism passes the gives you a good price on a proposal or service to the user.

FIG. 1-1F shows where revenue can pass to businesses that become a sponsor and percentages of ad clicks and sales go to the campaign owner also.

FIG. 1-1G describes where the world side connection mechanism which can be used by any website anywhere is the same but without the Sponsor Anything unit or can be included with it.

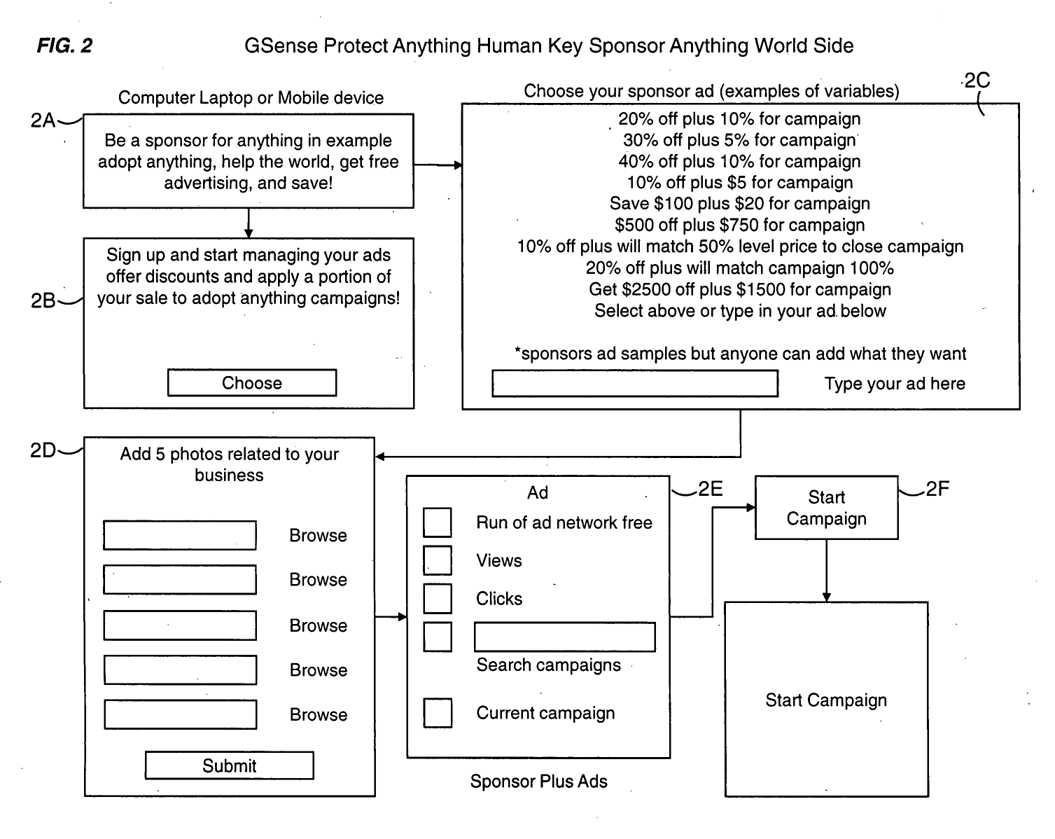

FIG. 2-2A describes the Sponsor Anything world side create an ad form where you can be a sponsor for the Adopt Anything campaign or any campaign, help the world, get free advertising and save on all your advertising needs.

FIG. 2-2B describes where the sponsor can sign up and start managing their ads offer discounts apply a portion of your sale to Adopt Anything campaign or any campaign with choose your advertisement.

FIG. 2-2C describes how a sponsor can choose their sponsor ad with examples of variables like “20% off plus 10% for campaign” also furthermore the sponsor can add their own advertising description in the form field with type your ad here.

FIG. 2-2D shows how you can add five photos related to your business by browsing your computer and selecting the image files and pushing the submit button.

FIG. 2-2E describes how you want your sponsor plus adds to be run and how you want to pay for them with run of ad network free, views, clicks pay per clicks pay per views, paper search for campaign, or only in the current campaign.

FIG. 2-2F shows how you can then start a campaign and get a confirmation that the campaign has started.

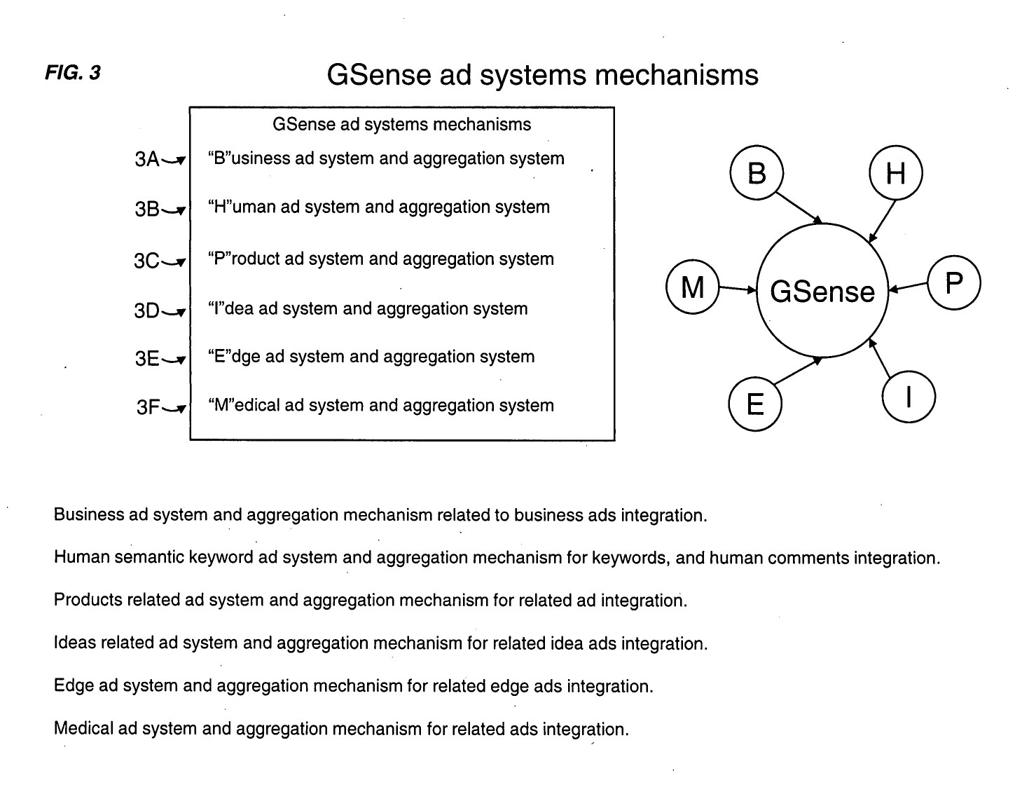

FIG. 3-3A describes the GSense advertising systems mechanism with the “B.” business advertising system aggregation system mechanism, the business advertising system and aggregation mechanism related to business advertising integration.

FIG. 3-3B describes the GSense advertising systems mechanism with the “H.” business advertising system and aggregation system mechanism, the human semantic keyword advertising system and aggregation mechanism for keywords, and human contents integration.

FIG. 3-3C describes the GSense advertising systems mechanism with the “P.” product advertising system and aggregation system mechanism, the products related advertising system and aggregation mechanism for related advertising integration.

FIG. 3-3D describes the GSense advertising systems mechanism with the “I” idea advertising system and aggregation system mechanism, the ideas related advertising system and aggregation mechanism for related idea advertising integration.

FIG. 3-3 E. describes the GSense advertising systems mechanism with the “E.” edge advertising system and aggregation system mechanism, the edge advertising system and aggregation mechanism for related edge advertising integration.

FIG. 3-3F describes the GSense advertising systems mechanism with the “M.” medical advertising system and aggregation system mechanism, the medical advertising system and aggregation mechanism for related advertising integration.

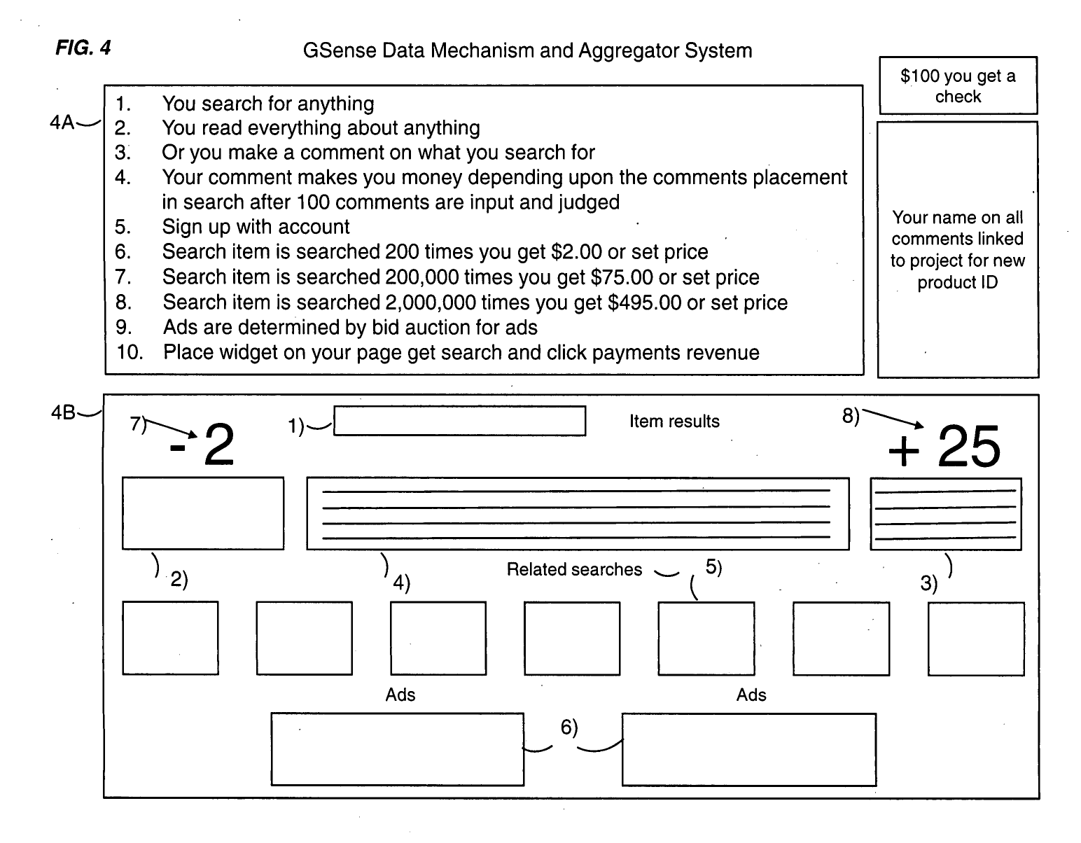

FIG. 4-4A describes the GSense data mechanism in aggregator system 1. you search for anything, 2. you read everything about anything, 3. or you make a comment on what you search for, 4. your comment makes you money depending upon the comments placement in search after 100 comments are input and judged, 5. sign-up with account, 6. search item is searched 200 times you get two dollars or set price, 7. search item is searched 200,000 times you get $75 or set price, 8. search out of search 2 million times you get $495 or set price, 9. ads are determined by bid auction for advertisements, 10. place widget on your page gets search and click payments revenue, when you're advertising amounts get up to $100 you get a check mailed or money into your bank account, your name is on all comments links project for new product ID so that you get advertising revenue when there's activity, the better and more useful the content or comment is the more you get paid for your comment or content, the system automatically utilizes a checks and balance system to determine the value of the content or comment.

FIG. 4-4B describes the search front end interface of GSense data mechanism and aggregation system, negative comments show up on the left 7), positive comments troubled the right 8), the search box is 1), and the item results show up in 4), the full comment that is negative shows up in 2), the full comment that is positive shows up in 3), anything related to the search information shows up immediately at 5), advertisements that are related to subject searched show up in 6).

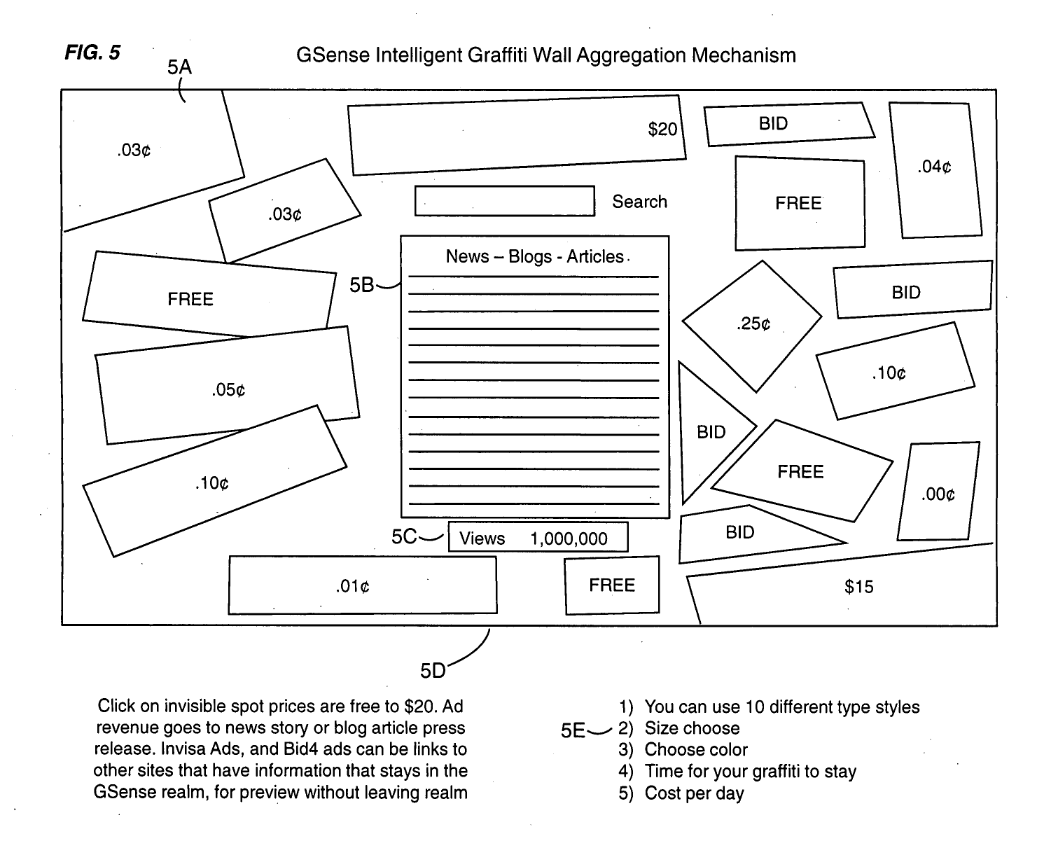

FIG. 5-5A describes the GSense intelligent graffiti wall aggregation mechanism advertisements with various rises from free to $20, furthermore demonstrates that adds can be bought and sold, can be bid for, position and placement can be achieved by advertising agencies and sponsors or Adopt Anything campaign or any campaign owner's.

FIG. 5-5B describes the content area where news articles, articles, blogs, comments, ideas, images, video, music, or anything can be displayed, played, viewed, listened to, read to.

FIG. 5-5C describes the amount of views that the center content area has had.

FIG. 5-5D describes how you can click on invisible spot prices and their free to $20, and they have different ways that you can purchase advertiser and position the advertising revenue goes to the news story or blog article or press release, invisible ads, bid for ads can be links to other sites that have information that stays in the GSense realm, for preview without leaving the GSense realm.

FIG. 5-5E describes how you can 1) use 10 different or many typestyles 2) choose the size, 3) choose color of the type, 4) choose the time for your graffiti type to stay, 5) choose the cost per day that you pay.

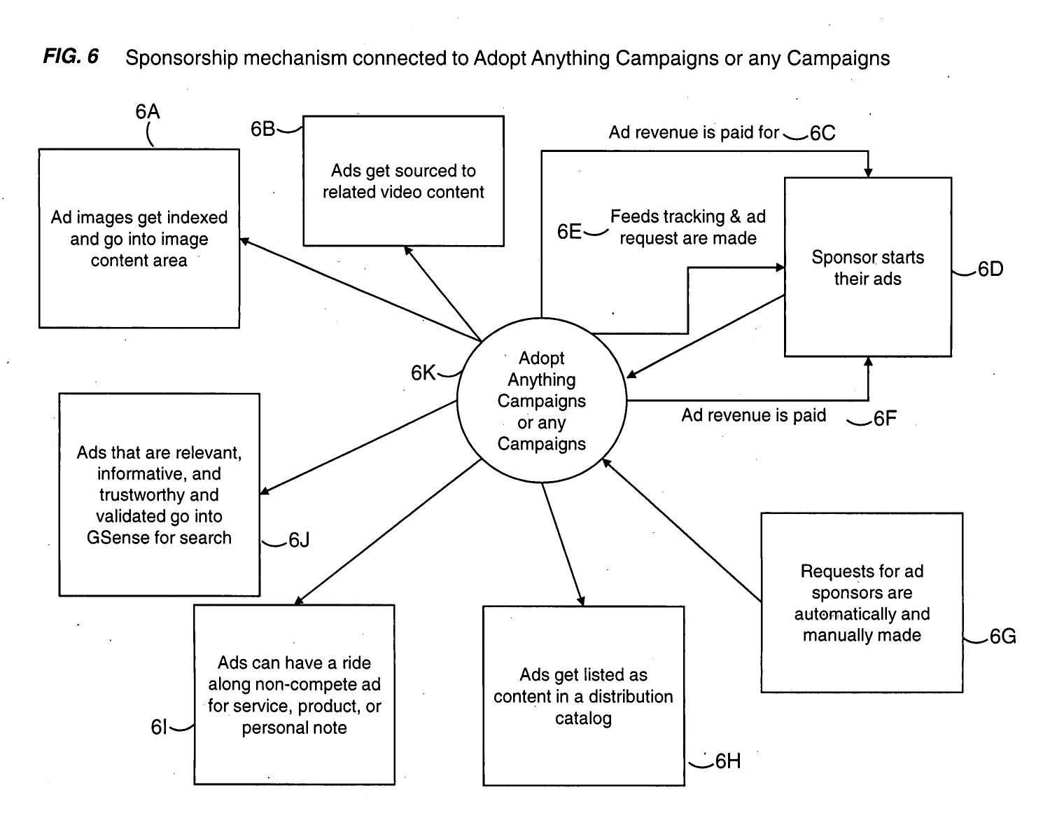

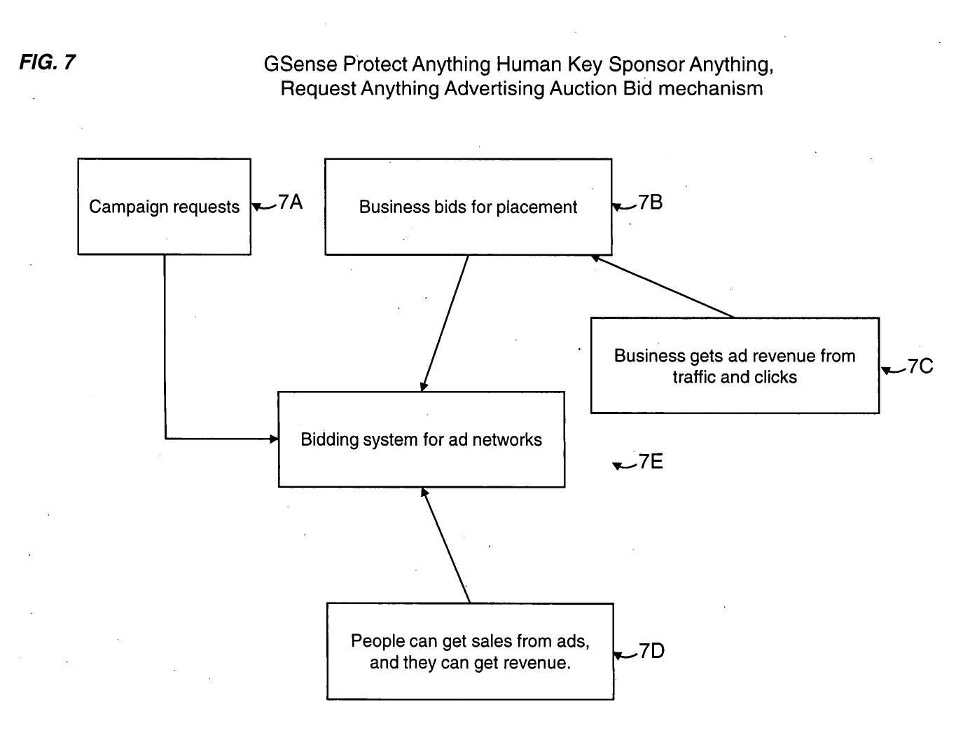

FIG. 6-6A describes how in Adopt Anything campaign or any campaign and damages get indexed and go into image content area.

FIG. 6-6B describes how the ads get source to relative and related video content.

FIG. 6-6C describes how the ad revenue is paid for and close to sponsor starting area from the Adopt Anything campaign or any campaign.

FIG. 6-6D shows sponsor starting their heads f and the blowback to where the ads get source to related video content flowing to the Adopt Anything campaign or any campaign.

FIG. 6-6E describes how is Sponsor Anything feeds tracking and add requests are made flowing to sponsor starts their ads.

FIG. 6-6F describes how Adopt Anything campaign or any campaign ad revenue is paid after sponsor starts their advertisements.

FIG. 6-6D describes the mechanism where request for advertising sponsors is automatically made and manually made.

FIG. 6-6H describes how sponsor advertisements get listed as content in a distribution catalog with links back to Adopt Anything campaign or any campaign.

FIG. 6-6I describes Adopt Anything campaign or any campaign sponsor advertisements can have a ride along non-compete advertisement for service, product, or personal notes.

FIG. 6-6J describes the mechanism for Adopt Anything campaign or any campaign sponsor advertisements that are relevant and from informative sources, and trustworthy, validated utilizing GSense for search and decision-making.

FIG. 6-6K describes the mechanism Adopt Anything campaign or any campaign that connects to all of sponsors advertisements described.

FIG. 7-7A describes the mechanism for Sponsor Anything campaign Request Anything response or will search campaigns and make request to have and add and share revenue on the campaign.

FIG. 7-7B describes the mechanism where business can become a sponsor and bid for ad placement.

FIG. 7-7C describes the mechanism whereby a business that becomes a Sponsor Anything participant business can get ad revenue from traffics and clicks.

FIG. 7-7D describes a mechanism where the campaign user or people can get sales from ads and they can get revenue connecting the sponsors.

FIG. 7-7E describes the mechanism of a bidding system for ad networks so that all businesses that are sponsors can bid for bid placement in ads.

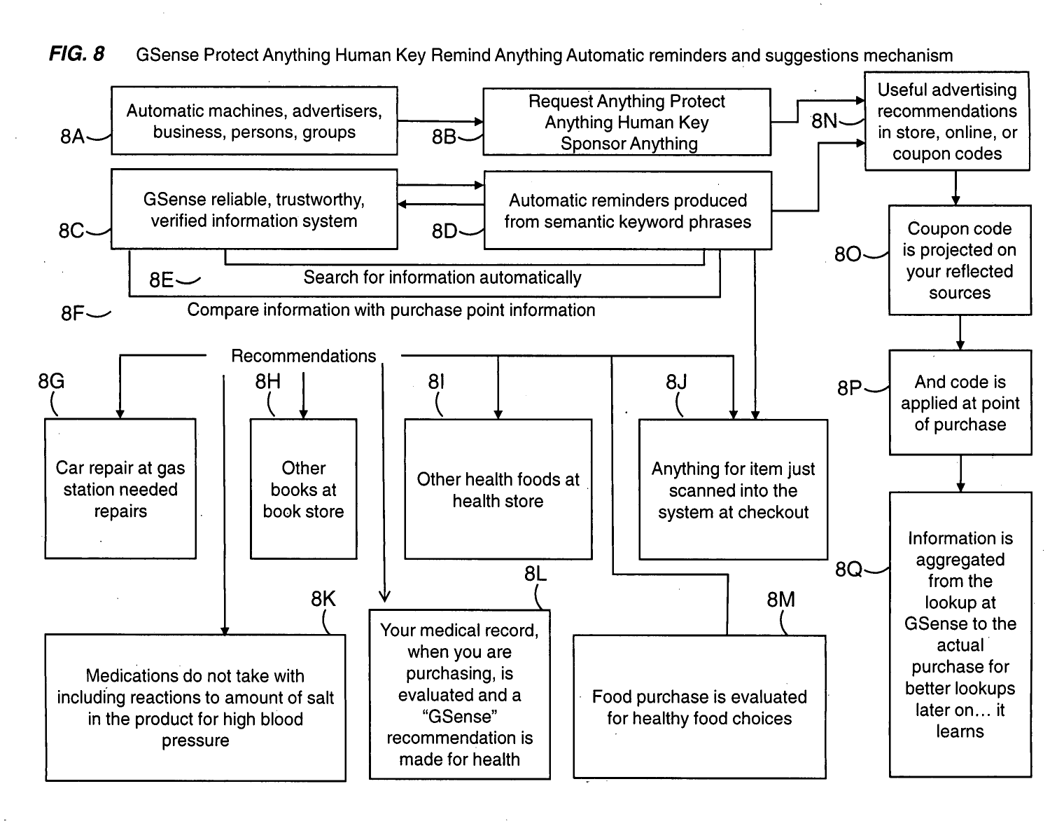

FIG. 8-8A describes the mechanism of GSense functions automatic machines, advertisers, businesses, persons, groups can become Request Anything, Protect Anything Human Key Human Key response or anything members.

FIG. 8-8B describes the mechanism of GSense functions where Request Anything, Protect Anything Human Key Human Key, Sponsor Anything businesses, can get useful advertising recommendations de and store online or coupon codes.

FIG. 8-8C describes mechanism of GSense functions demonstrating the GSense reliable, trustworthy, verified information system providing automatic reminders.

FIG. 8-8D describes mechanism of GSense functions such as automatic reminders produce from semantic keyword phrases flowing to useful advertising recommendations.

FIG. 8-8E describes mechanism of GSense functions where you can search for information automatically.

FIG. 8-8F describes mechanism of GSense functions where you can compare information with point of purchase information.

FIG. 8-8G describes mechanism of GSense functions where you can get recommendations for car repair gas station people in it that needs repair.

FIG. 8-8H describes mechanism of GSense functions where you can get recommendations for other books went shopping at a bookstore and at point-of-purchase automatically.

FIG. 8-8I describes mechanism of GSense functions where all your purchasing in a health food store can be related to other health food items that are in your point-of-purchase bag and you can get a recommendation of related goods.

FIG. 8-8J describes mechanism of GSense functions where any item anything that is scanned into the system and check out can give recommendations for anything related to those items so that you can possibly add to other products.

FIG. 8-8K describes mechanism of GSense functions where you can get recommendations for medications like do not take with including reactions to amount of salt in the product like blood pressure, helps maintain good health.

FIG. 8-8L describes mechanism of GSense functions where as you purchase things it's added to your medical record or Journal or my medical Journal and is evaluated with the GSense engine and the GSense recommendation is made for good health.

FIG. 8-8M describes mechanism of GSense functions where point-of-purchase food items are evaluated for healthy food choices through the GSense engine and recommendations are made best choices.

FIG. 8-8N describes mechanism of GSense functions where useful advertising recommendations from the GSense engine provided in store, online or with coupon codes.

FIG. 8-8O describes mechanism of GSense functions where the coupon code is projected on reflected sources notifying you of discounts through the GSense engine.

FIG. 8-8P describes mechanism of GSense functions where the coupon code is applied automatically at point-of-purchase.

FIG. 8-8Q describes mechanism of GSense function where information is aggregated from the lookup at GSense to the actual purchase for better lookups later on . . . . It learns.

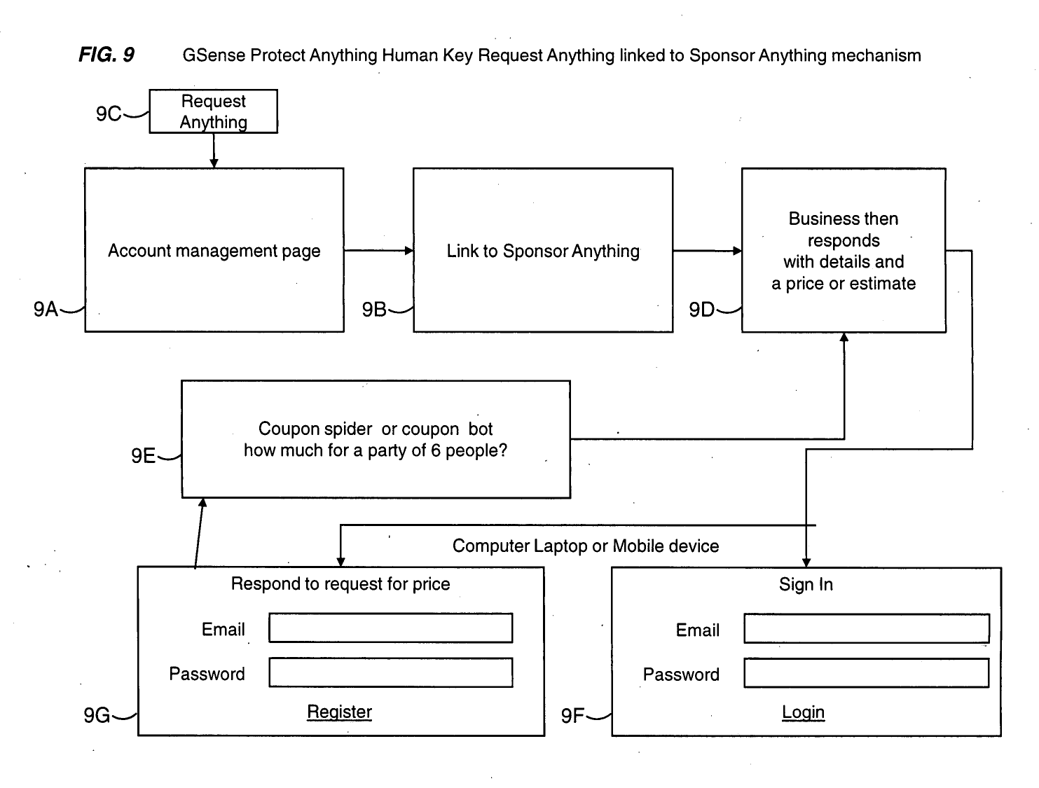

FIG. 9-9A describes the Request Anything mechanism account management page that is linked to Sponsor Anything component.

FIG. 9-9B describes the Request Anything mechanism link to Sponsor Anything as related to Request Anything.

FIG. 9-9C describes the Request Anything mechanism flowing to the account management page and the link to Sponsor Anything.

FIG. 9-9D describes the Request Anything mechanism where a business then responds with details and a price or estimate.

FIG. 9-9E describes the Request Anything mechanism where a coupon spider or coupon bot asked the question how much for a party of six people?.

FIG. 9-9F describes the Request Anything mechanism where user can sign in with your e-mail and password and you can login.

FIG. 9-9G describes the Request Anything mechanism where business or sponsor can respond to a request for price with e-mail and password registration.

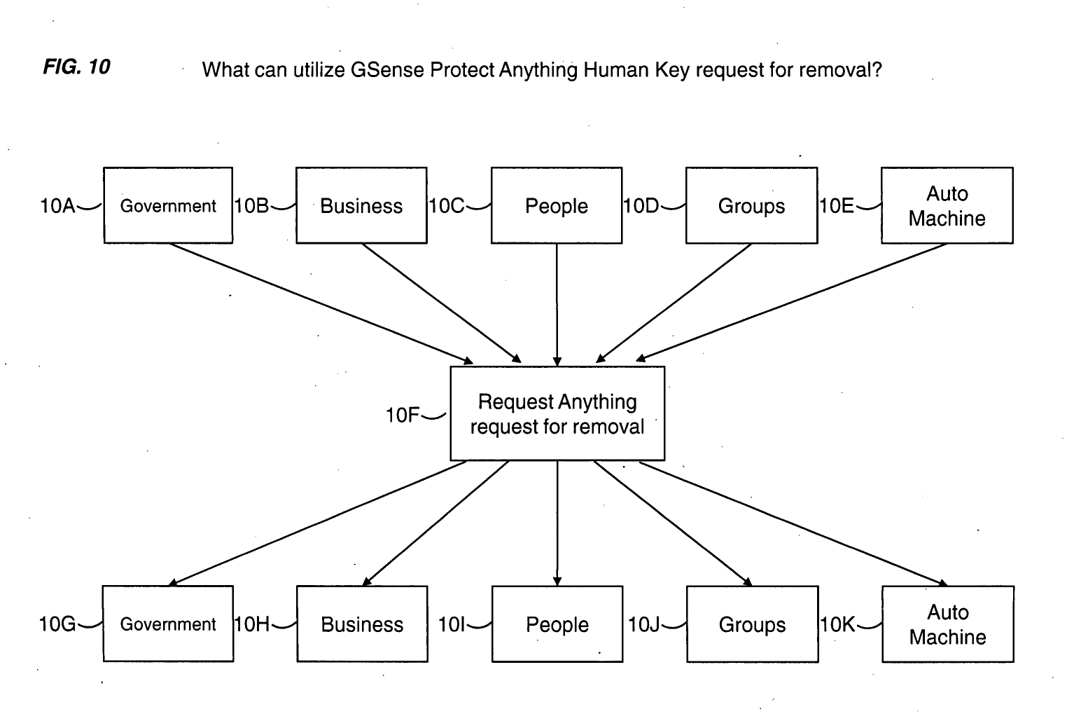

FIG. 10-10A describes Request Anything request for removal what can request for removal mechanism government from government, business, people, groups, automatically from machine.

FIG. 10-10B describes Request Anything request for removal what can request for removal mechanism business from government, business, people, groups, automatically from machine.

FIG. 10-10C describes Request Anything request for removal what can request for removal mechanism people from government, business, people, groups, automatically from machine.

FIG. 10-10D describes Request Anything request for removal what can request for removal mechanism groups from government, business, people, groups, automatically from machine.

FIG. 10-10E describes Request Anything request for removal what can request for removal mechanism automatic machines from government, business, people, groups, automatically from machine.

FIG. 10-10F describes Request Anything request for removal mechanism between the request entity or person to the entity or person that is being requested to remove anything from.

FIG. 10-10G describes Request Anything request for removal what can be targeted for request for removal mechanism government from government, business, people, groups, automatically from machine.

FIG. 10-10H describes Request Anything request for removal what can be targeted for request for removal mechanism business from government, business, people, groups, automatically from machine.

FIG. 10-10I describes Request Anything request for removal what can be targeted for request for removal mechanism people from government, business, people, groups, automatically from machine.

FIG. 10-10J describes Request Anything request for removal what can be targeted for request for removal mechanism groups from government, business, people, groups, automatically from machine.

FIG. 10-10K describes Request Anything request for removal what can be targeted for request for removal mechanism automatic machines from government, business, people, groups, automatically from machine.

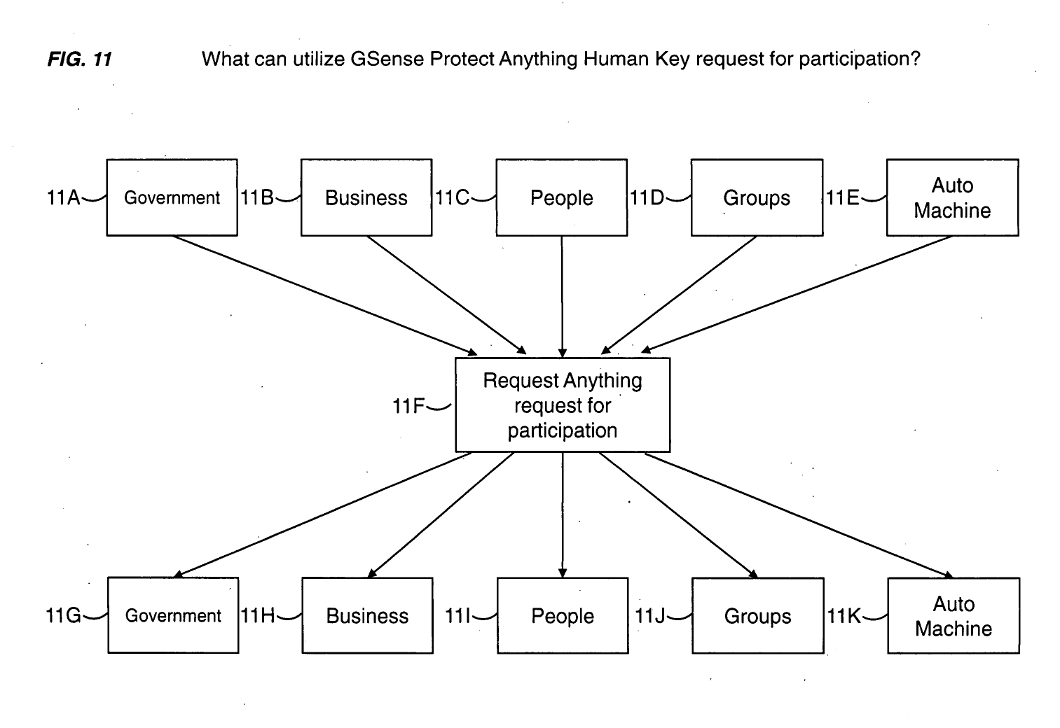

FIG. 11-11A describes Request Anything request for participation what can request for participation mechanism government from government, business, people, groups, automatically from machine.

FIG. 11-11B describes Request Anything request for participation what can request for participation mechanism business from government, business, people, groups, automatically from machine.

FIG. 11-11C describes Request Anything request for participation what can request for participation mechanism people from government, business, people, groups, automatically from machine.

FIG. 11-11D describes Request Anything request for participation what can request for participation mechanism groups from government, business, people, groups, automatically from machine.

FIG. 11-11E describes Request Anything request for participation what can request for participation mechanism automatic machines from government, business, people, groups, automatically from machine.

FIG. 11-11F describes Request Anything request for participation mechanism between the request entity or person to the entity or person that is being requested to remove anything from.

FIG. 11-11G describes Request Anything request for participation what can be targeted for request for participation mechanism government from government, business, people, groups, automatically from machine.

FIG. 11-11H describes Request Anything request for participation what can be targeted for request for participation mechanism business from government, business, people, groups, automatically from machine.

FIG. 11-11I describes Request Anything request for participation what can be targeted for request for participation mechanism people from government, business, people, groups, automatically from machine.

FIG. 11-11J describes Request Anything request for participation what can be targeted for request for participation mechanism groups from government, business, people, groups, automatically from machine.

FIG. 11-11K describes Request Anything request for participation what can be targeted for request for participation mechanism automatic machines from government, business, people, groups, automatically from machine.

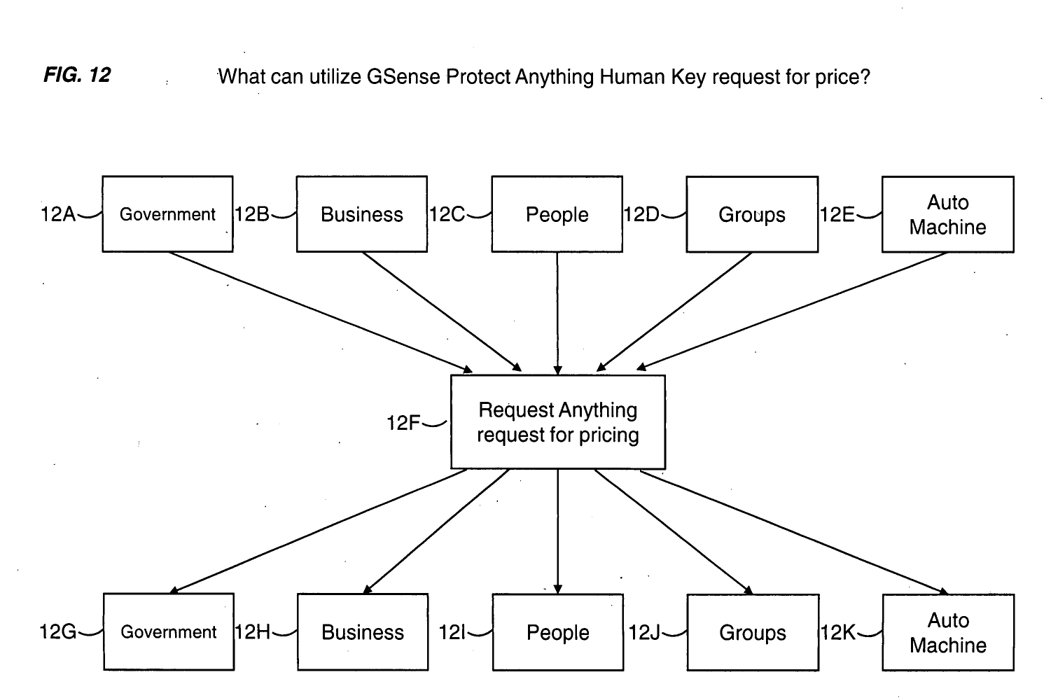

FIG. 12-12A describes Request Anything request for pricing what can request for pricing mechanism government from government, business, people, groups, automatically from machine.

FIG. 12-12B describes Request Anything request for pricing what can request for pricing mechanism business from government, business, people, groups, automatically from machine.

FIG. 12-12C describes Request Anything request for pricing what can request for pricing mechanism people from government, business, people, groups, automatically from machine.

FIG. 12-12D describes Request Anything request for pricing what can request for pricing mechanism groups from government, business, people, groups, automatically from machine.

FIG. 12-12E describes Request Anything request for pricing what can request for pricing mechanism automatic machines from government, business, people, groups, automatically from machine.

FIG. 12-12F describes Request Anything request for pricing mechanism between the request entity or person to the entity or person that is being requested to remove anything from.

FIG. 12-12G describes Request Anything request for pricing what can be targeted for request for pricing mechanism government from government, business, people, groups, automatically from machine.

FIG. 12-12H describes Request Anything request for pricing what can be targeted for request for pricing mechanism business from government, business, people, groups, automatically from machine.

FIG. 12-12I describes Request Anything request for pricing what can be targeted for request for pricing mechanism people from government, business, people, groups, automatically from machine.

FIG. 12-12J describes Request Anything request for pricing what can be targeted for request for pricing mechanism groups from government, business, people, groups, automatically from machine.

FIG. 12-12K describes Request Anything request for pricing what can be targeted for request for pricing mechanism automatic machines from government, business, people, groups, automatically from machine.

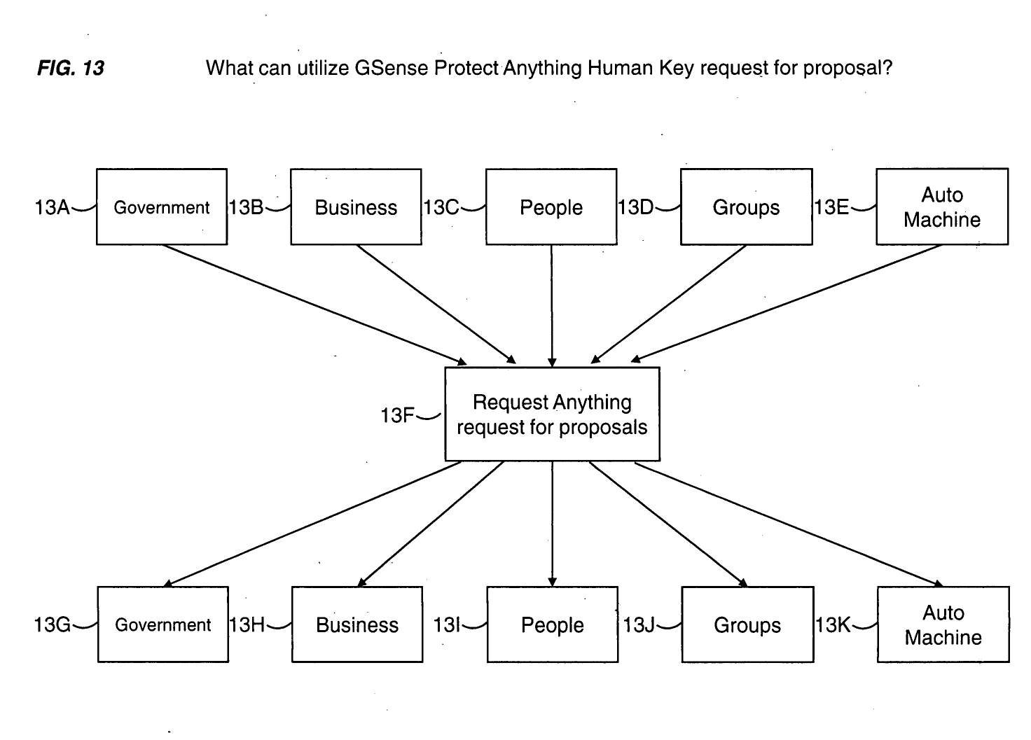

FIG. 13-13A describes Request Anything request for proposals what can request for proposals mechanism government from government, business, people, groups, automatically from machine.

FIG. 13-13B describes Request Anything request for proposals what can request for proposals mechanism business from government, business, people, groups, automatically from machine.

FIG. 13-13C describes Request Anything request for proposals what can request for proposals mechanism people from government, business, people, groups, automatically from machine.

FIG. 13-13D describes Request Anything request for proposals what can request for proposals mechanism groups from government, business, people, groups, automatically from machine.

FIG. 13-13E describes Request Anything request for proposals what can request for proposals mechanism automatic machines from government, business, people, groups, automatically from machine.

FIG. 13-13F describes Request Anything request for proposals mechanism between the request entity or person to the entity or person that is being requested to remove anything from.

FIG. 13-13G describes Request Anything request for proposals what can be targeted for request for proposals mechanism government from government, business, people, groups, automatically from machine.

FIG. 13-13H describes Request Anything request for proposals what can be targeted for request for proposals mechanism business from government, business, people, groups, automatically from machine.

FIG. 13-13I describes Request Anything request for proposals what can be targeted for request for proposals mechanism people from government, business, people, groups, automatically from machine.

FIG. 13-13J describes Request Anything request for proposals what can be targeted for request for proposals mechanism groups from government, business, people, groups, automatically from machine.

FIG. 13-13K describes Request Anything request for proposals what can be targeted for request for proposals mechanism automatic machines from government, business, people, groups, automatically from machine.

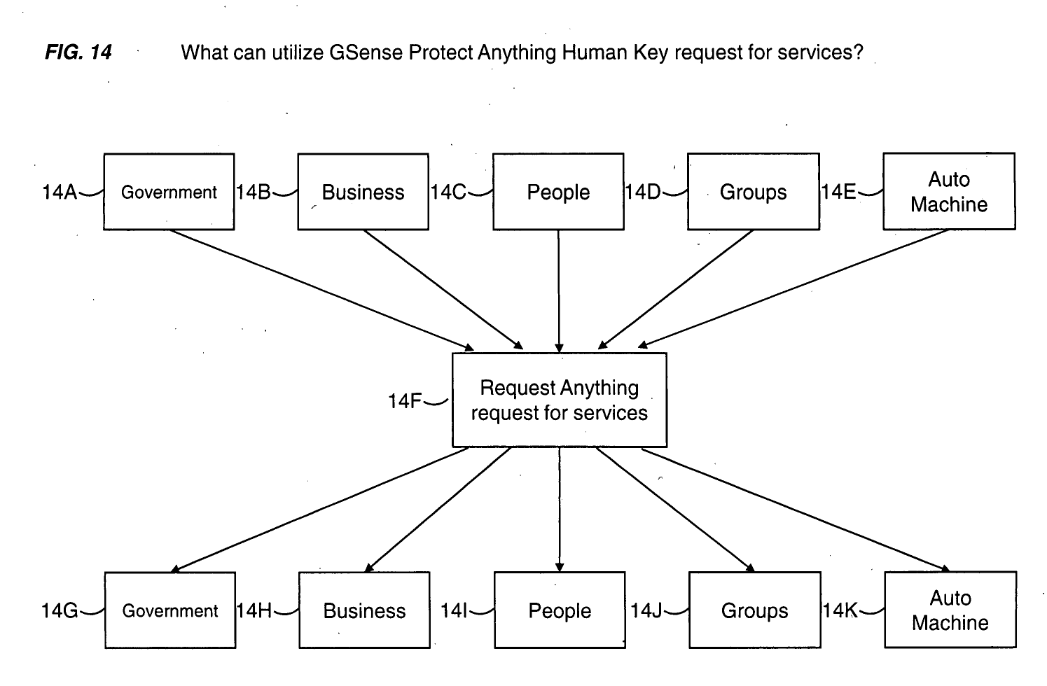

FIG. 14-14A describes Request Anything request for services what can request for services mechanism government from government, business, people, groups, automatically from machine.

FIG. 14-14B describes Request Anything request for services what can request for services mechanism business from government, business, people, groups, automatically from machine.

FIG. 14-14C describes Request Anything request for services what can request for services mechanism people from government, business, people, groups, automatically from machine.

FIG. 14-14D describes Request Anything request for services what can request for services mechanism groups from government, business, people, groups, automatically from machine.

FIG. 14-14E describes Request Anything request for services what can request for services mechanism automatic machines from government, business, people, groups, automatically from machine.

FIG. 14-14F describes Request Anything request for services mechanism between the request entity or person to the entity or person that is being requested to remove anything from.

FIG. 14-14G describes Request Anything request for services what can be targeted for request for services mechanism government from government, business, people, groups, automatically from machine.

FIG. 14-14H describes Request Anything request for services what can be targeted for request for services mechanism business from government, business, people, groups, automatically from machine.

FIG. 14-14I describes Request Anything request for services what can be targeted for request for services mechanism people from government, business, people, groups, automatically from machine.

FIG. 14-14J describes Request Anything request for services what can be targeted for request for services mechanism groups from government, business, people, groups, automatically from machine.

FIG. 14-14K describes Request Anything request for services what can be targeted for request for services mechanism automatic machines from government, business, people, groups, automatically from machine.

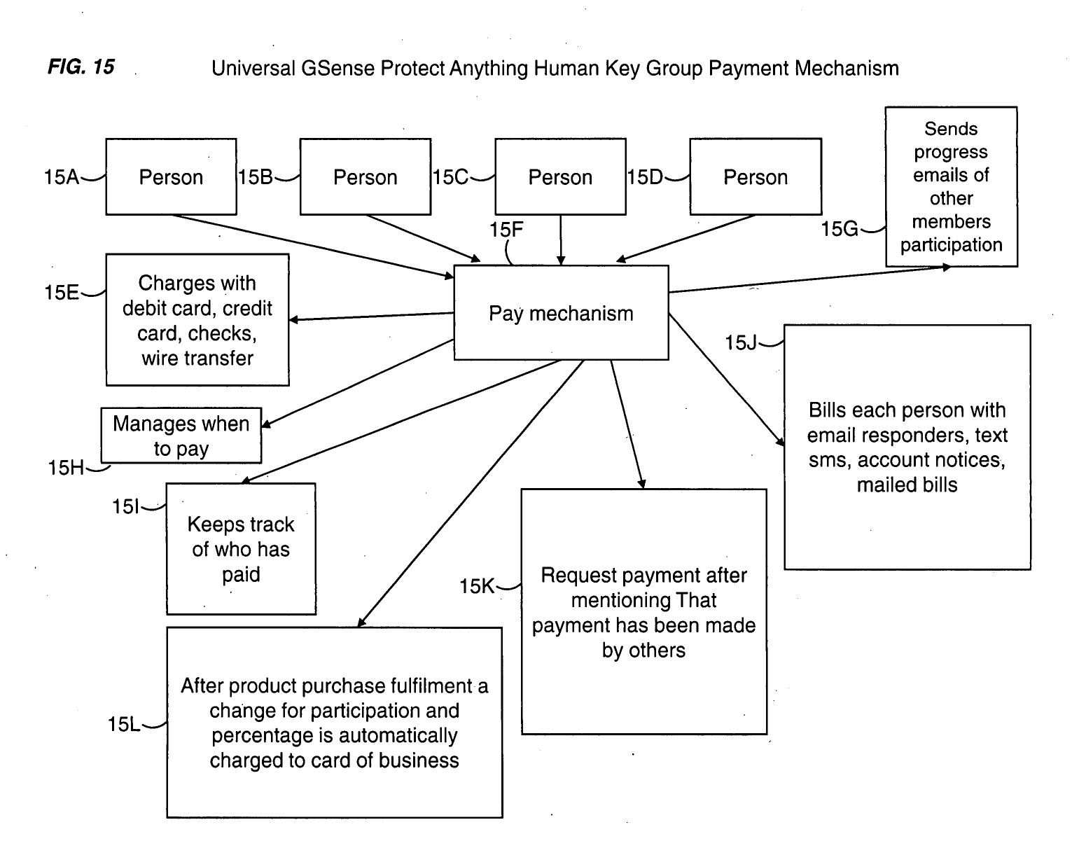

FIG. 15-15A describes the universal GSense group payment mechanism person connected to pay mechanism.

FIG. 15-15B describes the universal GSense group payment mechanism person connected to pay mechanism.

FIG. 15-15C describes the universal GSense group payment mechanism person connected to pay mechanism.

FIG. 15-15D describes the universal GSense group payment mechanism person connected to pay mechanism.

FIG. 15-15E describes the universal GSense group payment mechanism after going through the Protect Anything Human Key Human Key identification mechanism person charges with debit card, credit card, checks, or wire transfer.

FIG. 15-15F describes the universal GSense group payment mechanism that manages groups or large groups and sends them to the appropriate function.

FIG. 15-15G describes the universal GSense group payment mechanism that sends progress e-mails or other members participation notes and reminders.

FIG. 15-15H describes the universal GSense group payment mechanism that manages to function of when to pay.

FIG. 15-15I describes the universal GSense group payment mechanism and keeps track of who is paid and what they paid in the time and date that they paid.

FIG. 15-15J describes the universal GSense group payment mechanism that bills each person with e-mail responders, text SMS, account notices, mailed bills.

FIG. 15-15K describes the universal GSense group payment mechanism that can request a payment after mentioning that payment has been made by other participants or groups.

FIG. 15-15L describes the universal GSense group payment mechanism where after product purchase fulfillment a charge for participation and percentages automatically charged to card of the business.

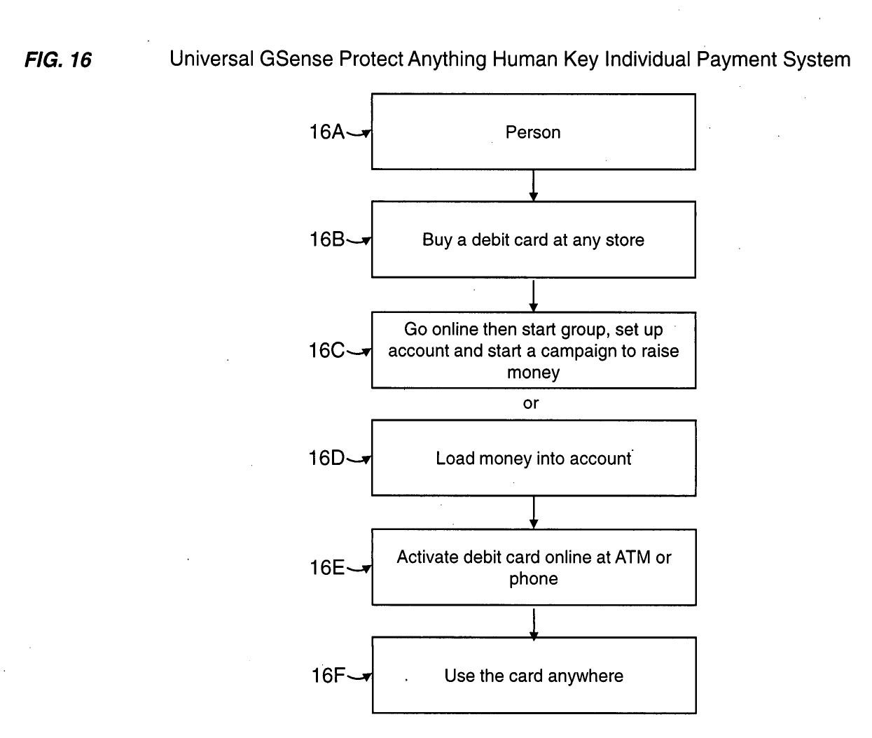

FIG. 16-16A describes universal individual payment system where persons or person or multiple people in groups can participate.

FIG. 16-16B describes universal individual payment system where you can buy a debit card in any store.

FIG. 16-16C describes universal individual payment system where you can go online, set up account and start a campaign to raise money through Adopt Anything campaign or any campaign mechanism.

FIG. 16-16D describes universal individual payment system where you can load money into the account of the card you purchased at a store.

FIG. 16-16E describes universal individual payment system where you can activate debit card online or at any ATM or by phone.

FIG. 16-16F describes universal individual payment system where you can use the card anywhere like a credit card or debit card.

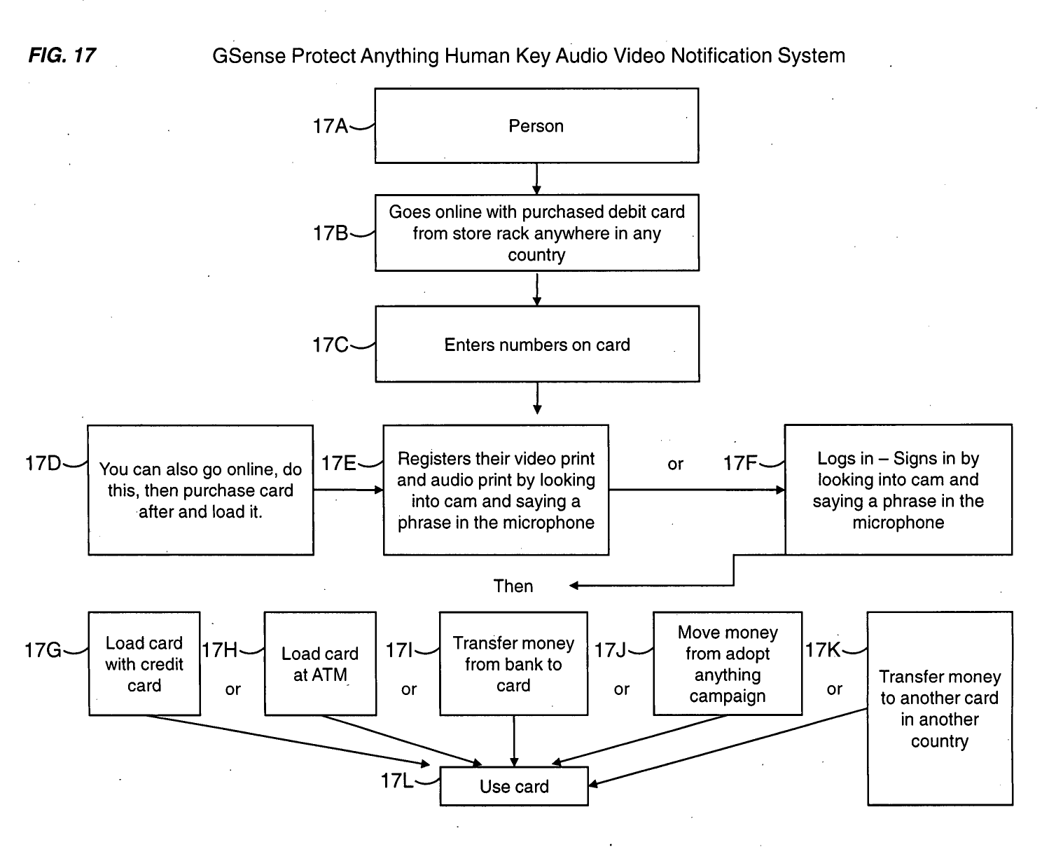

FIG. 17-17A describes Protect Anything Human Key Human Key audio video identification system utilizing credit or debit card where a person can purchase a debit card.

FIG. 17-17B describes Protect Anything Human Key Human Key audio video identification system for a person goes online with purchase debit card can store rack anywhere in the country or any country.

FIG. 17-17C describes Protect Anything Human Key Human Key audio video identification system for a person to enter numbers on the card that was purchased from any store anywhere.

FIG. 17-17D describes Protect Anything Human Key Human Key audio video identification system where you can also go online, do this, then purchase card after and loaded.

FIG. 17-17E describes Protect Anything Human Key Human Key audio video identification system where a person registers are video print and audio print by looking into cam and saying a phrase in the microphone.

FIG. 17-17F describes Protect Anything Human Key Human Key audio video identification system or person logs in, and signs in by looking into cam and saying a phrase in the microphone.

FIG. 17-17G describes Protect Anything Human Key Human Key audio video identification system where person can load card with credit card.

FIG. 17-17H describes Protect Anything Human Key Human Key audio video identification system where the person can load card in ATM machine.

FIG. 17-17I describes Protect Anything Human Key Human Key audio video identification system where person can transfer money from bank to card.

FIG. 17-17J describes Protect Anything Human Key audio video identification system or person can move money from Adopt Anything campaign or any campaign to debit or credit card.

FIG. 17-17K describes Protect Anything Human Key audio video identification system where anyone can transfer money to another card in another country.

FIG. 17-17L describes Protect Anything Human Key audio video identification system where anyone can use to card.

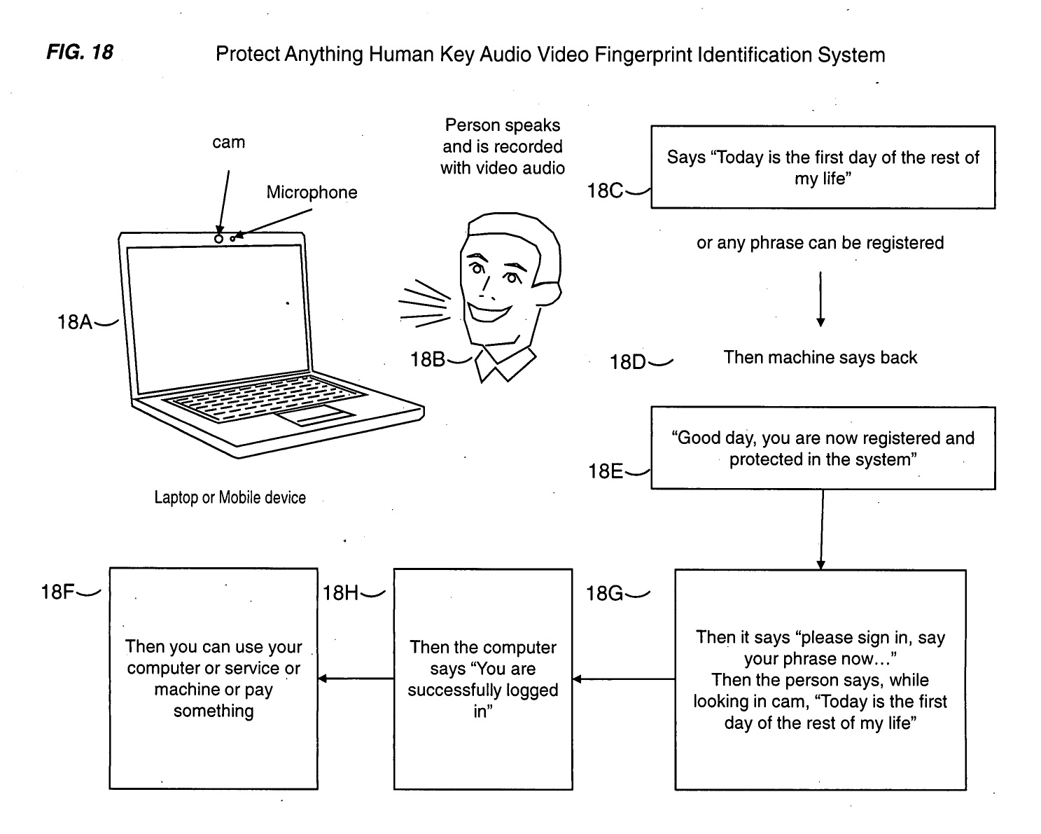

FIG. 18-18A describes Protect Anything Human Key audio video digital fingerprint identification system laptop with video cam and audio microphone.

FIG. 18-18B describes Protect Anything Human Key audio video digital fingerprint identification person speaks and is recorded with audio and video.

FIG. 18-18C describes Protect Anything Human Key audio video digital fingerprint identification where a person says “today is the first day of the rest of my life” or any key phrase can be registered.

FIG. 18-18D describes Protect Anything Human Key audio video digital fingerprint identification describes then machine says back.

FIG. 18-18E describes Protect Anything Human Key audio video digital fingerprint identification describes how the machine says back “Good day, you are now registered and protected in the system”.

FIG. 18-18F describes Protect Anything Human Key audio video digital fingerprint identification once you are signed in and authenticated that its only you, then you can use your computer or service or machine or pay something.

FIG. 18-18G describes Protect Anything Human Key audio video digital fingerprint identification follows with then the computer says “you're successfully logged in”.

FIG. 18-18H describes Protect Anything Human Key audio video digital fingerprint identification then it, the machine says “please sign in, say your key phrase now . . . ” then the person says, while looking at the cam, “today is the first day of the rest of my life” and if you are in the system registered and that is your key phrase, it will let you into whatever you are trying to securely get into.

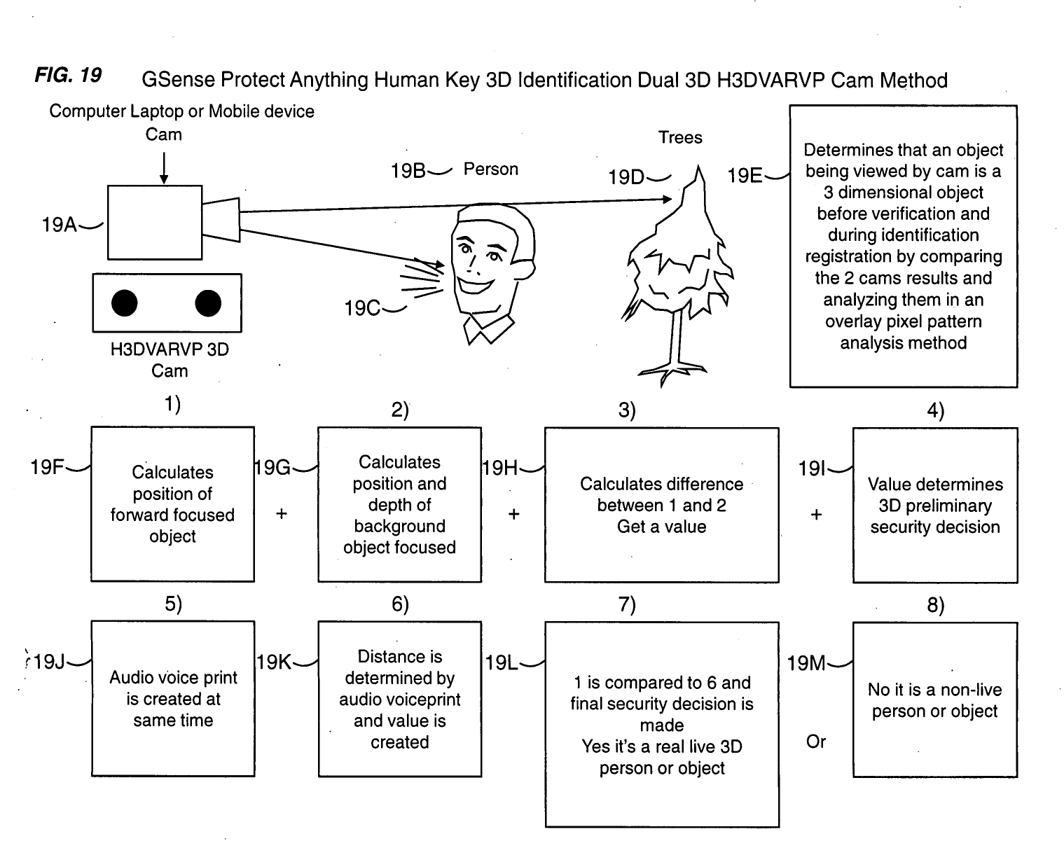

FIG. 19-19A, describes the Protect Anything Human Key 3-D identification method Dual 3D PA3D cam.

FIG. 19-19B describes the Protect Anything Human Key 3-D identification method Dual 3D PA3D person looking at the cam.

FIG. 19-19C describes the Protect Anything Human Key 3-D identification method Dual 3D PA3D person talking or saying a phrase.

FIG. 19-19D describes the Protect Anything Human Key 3-D identification method Dual 3D PA3D background trees, objects, people, or things.

FIG. 19-19E describes the Protect Anything Human Key 3-D identification method Dual 3D PA3D and how it determines that object being viewed by cam is a three-dimensional object for verification and during identification registration by comparing the 2 cams results and analyzing them in an overlay pixel pattern analysis method.

FIG. 19-19F describes the Protect Anything Human Key 3-D identification method Dual 3D PA3D the 1) mechanism calculates position of forward focused object.

FIG. 19-19G describes the Protect Anything Human Key 3-D identification method Dual 3D PA3D the 2) mechanism that calculates position and depth of background object focused.

FIG. 19-19H describes the Protect Anything Human Key 3-D identification method Dual 3D PA3D the 3) mechanism that calculates the difference between one and two and gets a value.

FIG. 19-19I describes the Protect Anything Human Key 3-D identification method Dual 3D PA3D the 4) mechanism where a value determines 3-D preliminary security decision.

FIG. 19-19J describes the Protect Anything Human Key 3-D identification method Dual 3D PA3D the 5) mechanism or audio voice print is created at the same time.

FIG. 19-19K describes the Protect Anything Human Key 3-D identification method Dual 3D PA3D the 6) mechanism businesses determined by audio voice print and value is created.

FIG. 19-19L describes the Protect Anything Human Key 3-D identification method Dual 3D PA3D the 7) mechanism than one is compared to six and file security decision is made yes it's a real live 3-D person or object with other Dual 3D PA3D GSense thermal, smell, mechanisms combined.

FIG. 19-19M describes the Protect Anything Human Key 3-D identification method Dual 3D PA3D the 8) and mechanism can say now is a non-live person or object.

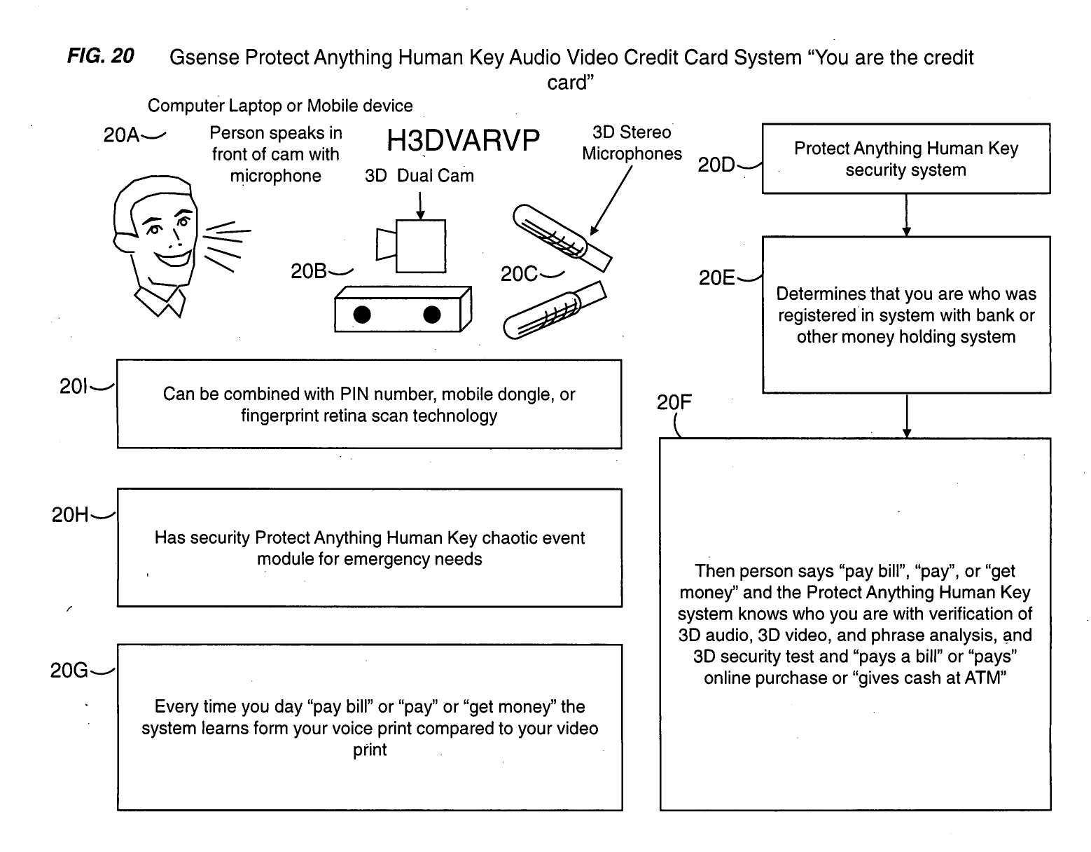

FIG. 20-20A describes the Protect Anything Human Key Audio Video Credit Card System “You are the credit card” the person speaks at the H3DVARV 3D Human Video Audio Stereo Viewing and Recording Mechanism cams and microphones.

FIG. 20-20B describes the Protect Anything Human Key Audio Video Credit Card System with H3DVARV 3D Human Video Audio Stereo Viewing and Recording Mechanism cams.

FIG. 20-20C describes the Protect Anything Human Key Audio Video Credit Card System with H3DVARV 3D Human Video Audio Stereo Viewing and Recording Mechanism microphones.

FIG. 20-20D describes the Protect Anything Human Key Audio Video Credit Card System with H3DVARV 3D Human Video Audio Stereo Viewing and Recording Mechanism Protect Anything Human Key security system.

FIG. 20-20E describes the Protect Anything Human Key Audio Video Credit Card System with H3DVARV 3D Human Video Audio Stereo Viewing and Recording Mechanism determines that you are who is registered in mechanism of bank rather money holding system.

FIG. 20-20F describes the Protect Anything Human Key Audio Video Credit Card System with H3DVARV 3D Human Video Audio Stereo Viewing and Recording Mechanism where person says “pay Bill”, “pay”, or “get money” in the Protect Anything Human Key system does for your verification of audio, video, and phrase analysis, with three security test and “pays the bill” or “pays” online purchase or “gives cash at ATM”.

FIG. 20-20G describes the Protect Anything Human Key Audio Video Credit Card System with H3DVARV 3D Human Video Audio Stereo Viewing and Recording Mechanism where every time you say “a bill” or “pay” or “get money” system learns from your voice print compared to your video print.

FIG. 20-20H describes the Protect Anything Human Key Audio Video Credit Card System with H3DVARV 3D Human Video Audio Stereo Viewing and Recording Mechanism where a security Protect Anything Human Key chaotic event module for emergency needs.

FIG. 20-20I describes the Protect Anything Human Key Audio Video Credit Card System with H3DVARV 3D Human Video Audio Stereo Viewing and Recording Mechanism where the system can be combined with pin number, mobile dongle, or biometrics fingerprint retina scan technology.

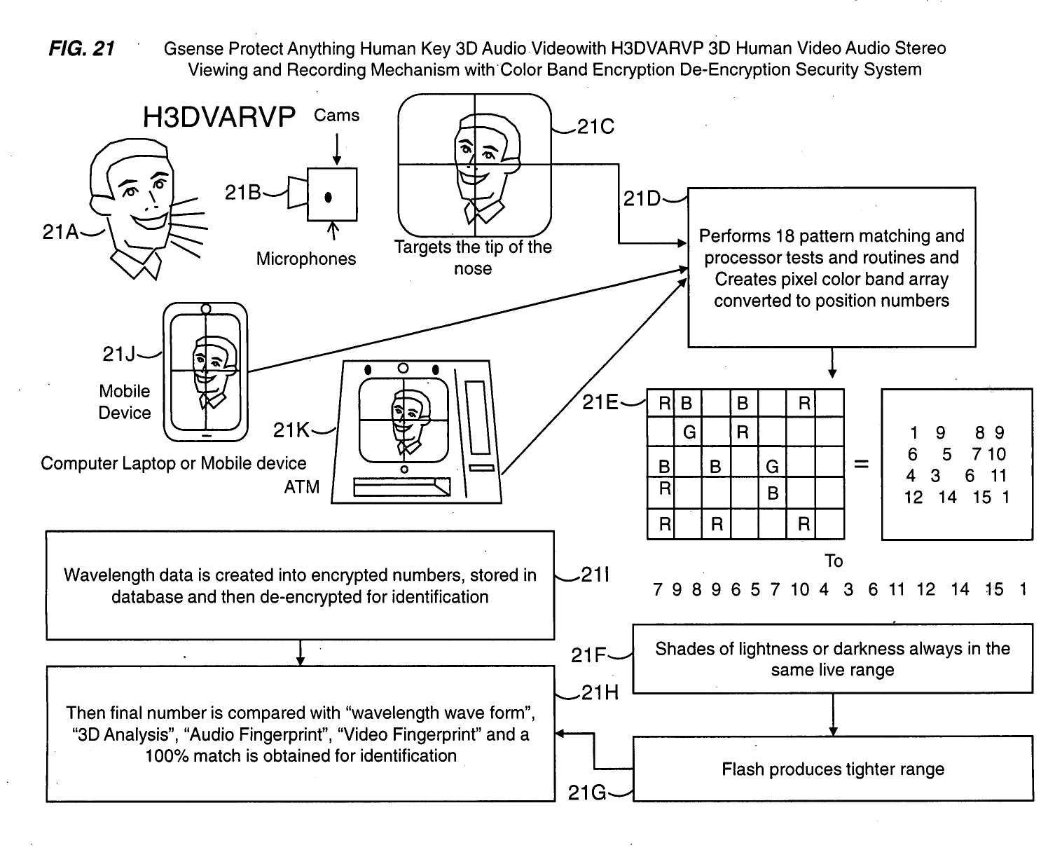

FIG. 21-21A describes the Protect Anything Human Key 3D Audio Video Color Band Encryption De-Encryption Security System with H3DVARV 3D Human Video Audio Stereo Viewing and Recording Mechanism where a person speaks.

FIG. 21-21B describes the Protect Anything Human Key 3D Audio Video Color Band Encryption De-Encryption Security System with H3DVARV 3D Human Video Audio Stereo Viewing and Recording Mechanism cams.

FIG. 21-21C describes the Protect Anything Human Key 3D Audio Video Color Band Encryption De-Encryption Security System with H3DVARV 3D Human Video Audio Stereo Viewing and Recording Mechanism where crosshairs target the tip of the human's nose.

FIG. 21-21D describes the Protect Anything Human Key 3D Audio Video Color Band Encryption De-Encryption Security System with H3DVARV 3D Human Video Audio Stereo Viewing and Recording Mechanism where the mechanism automatically does 16 tests and creates pixel color band array converted to position numbers.

FIG. 21-21E describes the Protect Anything Human Key 3D Audio Video Color Band Encryption De-Encryption Security System with H3DVARV 3D Human Video Audio Stereo Viewing and Recording Mechanism where the red, green, and blue is converted to numbers.

FIG. 21-21F describes the Protect Anything Human Key 3D Audio Video Color Band Encryption De-Encryption Security System with H3DVARV 3D Human Video Audio Stereo Viewing and Recording Mechanism where the shades of lightness or darkness always in the same live range during conversion with mechanisms algorithm.

FIG. 21-21G describes the Protect Anything Human Key 3D Audio Video Color Band Encryption De-Encryption Security System with H3DVARV 3D Human Video Audio Stereo Viewing and Recording Mechanism where the flash produces tighter range during recognition.

FIG. 21-21H describes the Protect Anything Human Key 3D Audio Video Color Band Encryption De-Encryption Security System with H3DVARV 3D Human Video Audio Stereo Viewing and Recording Mechanism where then the final numbers are compared with wavelength wave form 3-D analysis, audio fingerprint, video fingerprint, and a 100% match is obtained for identification.

The 21-21I describes the Protect Anything Human Key 3D Audio Video Color Band Encryption De-Encryption Security System with H3DVARV 3D Human Video Audio Stereo Viewing and Recording Mechanism where the wavelength data is created into encrypted numbers, stored in database and then decrypted for identification.

FIG. 21-21J describes the Protect Anything Human Key 3D Audio Video Color Band Encryption De-Encryption Security System with H3DVARV 3D Human Video Audio Stereo Viewing and Recording Mechanism is utilized with mobile device, laptop or computer.

FIG. 21-21K describes the Protect Anything Human Key 3D Audio Video Color Band Encryption De-Encryption Security System with H3DVARV 3D Human Video Audio Stereo Viewing and Recording Mechanism where is utilizing in bank ATM with 3D cams and 3D Stereo Microphones.

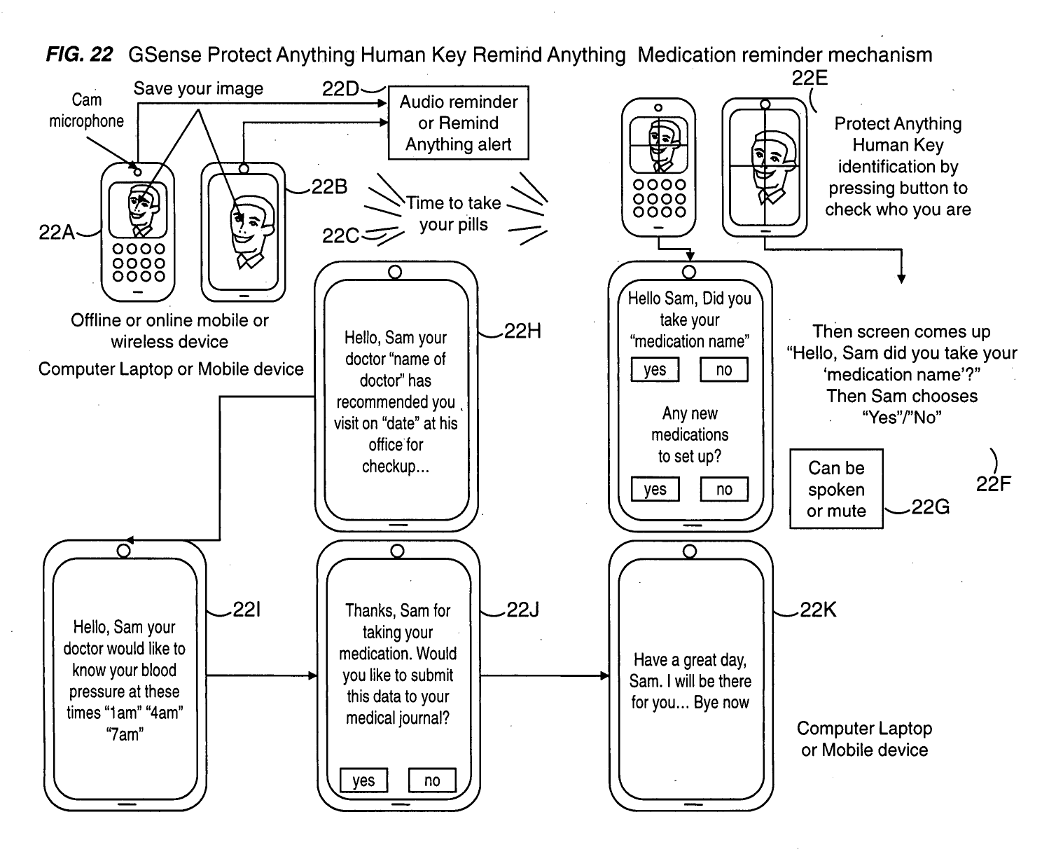

FIG. 22-22A describes the Remind Anything mechanism utilizing CAM microphone to save image off-line or online mobile or wireless device.

FIG. 22-22B describes the Remind Anything mechanism utilizing keyboard mobile device, and touch screen mobile device.

FIG. 22-22C describes the Remind Anything mechanism for comment time to take your pills or medications example.

FIG. 22-22D describes the Remind Anything mechanism that can create an audio reminder or Remind Anything alert.

FIG. 22-22E describes Remind Anything mechanism utilizing the Protect Anything Human Key identification mechanism by pressing button to check who you are.

FIG. 22-22F describes Remind Anything mechanism and screen comes up “hello; Sam did you take your medication name?” Then Sam chooses “yes”/“no”.

FIG. 22-22G describes Remind Anything mechanism can be and spoken mode or mute.

FIG. 22-22H describes Remind Anything mechanism displaying or saying hello, Sam your Dr. name of doctor has recommended you visit on date at his office for checkout.

FIG. 22-22I describes Remind Anything mechanism displaying or saying hello Sam your daughter like to know your blood pressure at these times “1 AM” “4 AM” “7 AM”.

FIG. 22-22J describes Remind Anything mechanism displaying thanks, Sam for taking your medication. Would you like to submit this data to your medical Journal? Also includes a “yes” button and the “no” button.

FIG. 22-22K describes Remind Anything mechanism saying or displaying a great day, Sam. I will be there for you . . . by now.

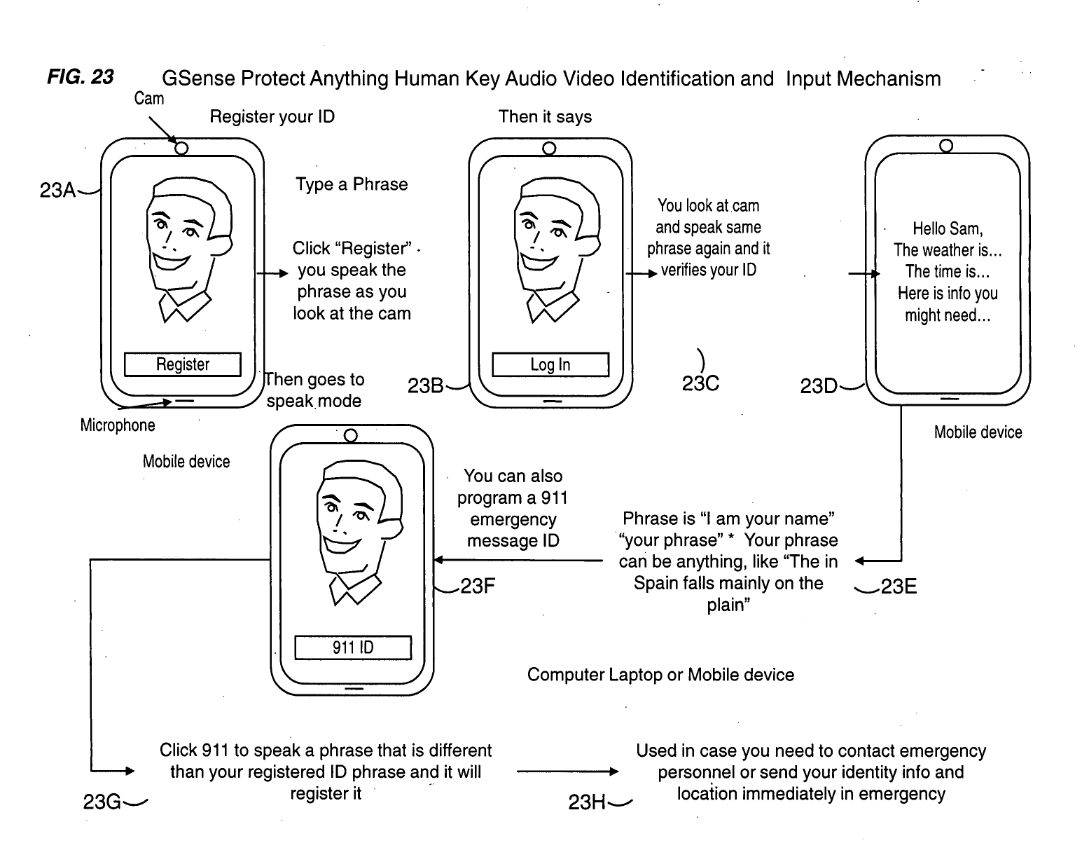

FIG. 23-23A describes Protect Anything Human Key Audio Video Identification and Input Mechanism you can use laptop or any mobile device with cam and microphone register ID by typing the phrase click “Register” you speak the phrase as you look at the cam.

FIG. 23-23B describes Protect Anything Human Key Audio Video Identification and Input Mechanism then it says at “Log In” click.

FIG. 23-23C describes Protect Anything Human Key Audio Video Identification and Input Mechanism where you look at the cam speak same phrase again and it verifies your ID.

FIG. 23-23D describes Protect Anything Human Key Audio Video Identification and Input Mechanism where it responds after verification with fellow Sam, the weather is . . . the time is . . . here is info you might need today . . . .

FIG. 23-23E describes Protect Anything Human Key Audio Video Identification and Input Mechanism where phrase is I am your name or your phrase your phrase can be anything, like the rain in Spain falls mainly on the plain whatever you want choose.

FIG. 23-23F describes Protect Anything Human Key Audio Video Identification and Input Mechanism for you can also program a 911 emergency message ID.

FIG. 23-23G describes Protect Anything Human Key Audio Video Identification and Input Mechanism where you can click 911 to speaker praised his different than your register ID phrase and will register it.

FIG. 23-23H describes Protect Anything Human Key Audio Video Identification and Input Mechanism where used in case you need to contact emergency personnel and our senior identity and location immediately in emergency.

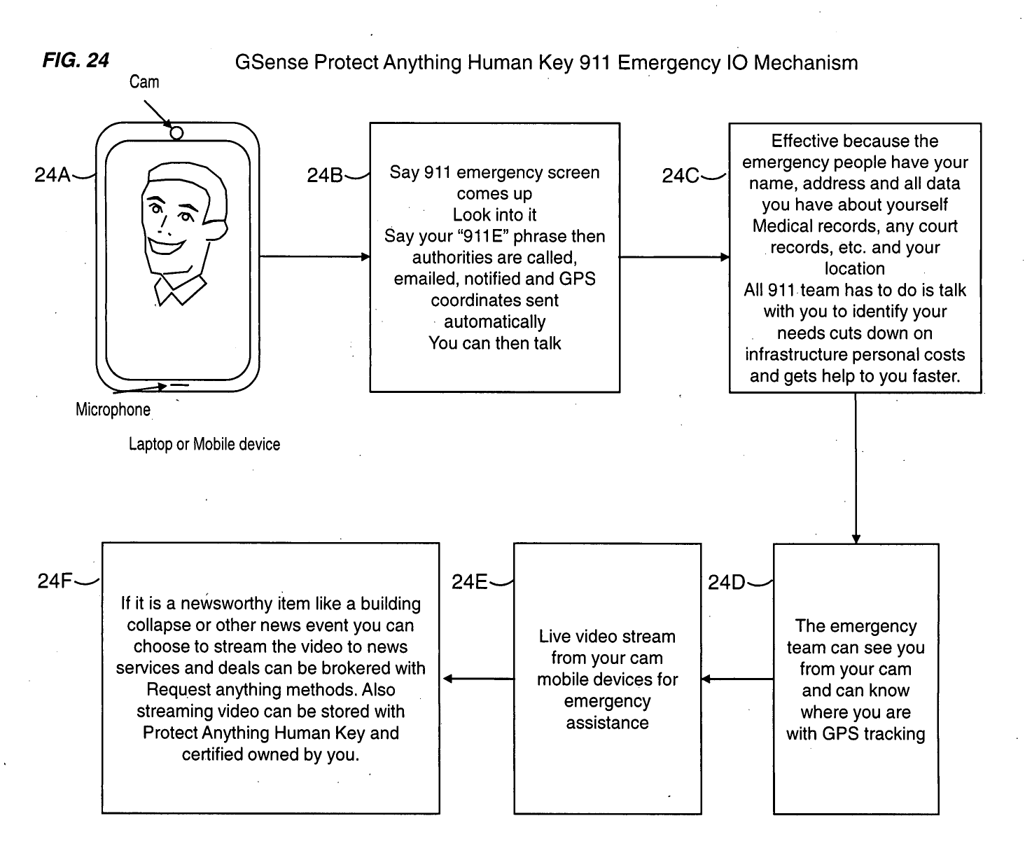

FIG. 24-24A describes Protect Anything Human Key 911 Emergency Input Output Mechanism where laptop or any mobile device with cam and microphone can be used.

FIG. 24-24B describes Protect Anything Human Key 911 Emergency Input Output Mechanism for you say 911 emergency screen comes up look into it say your 911 E. phrase that authorities are called, e-mailed, notified, and GPS coordinates sent Automatically you can then talk.

FIG. 24-24C describes Protect Anything Human Key 911 Emergency Input Output Mechanism where it shows that it is effective because the emergency people have your name, address, and albeit you have about yourself, medical records, any court records, and any other records, and your location, all 911 team has to do is talk with you to identify your needs cut down on infrastructure personal cost and gets help to you faster.

FIG. 24-24D describes Protect Anything Human Key 911 Emergency Input Output Mechanism where the emergency team can see you from your cam and can know where you are but GPS tracking.

FIG. 24-24E describes Protect Anything Human Key 911 Emergency Input Output Mechanism where you can have live video stream from your cam or mobile devices or laptop for mercy assistance.

FIG. 24-24D describes Protect Anything Human Key 911 Emergency Input Output Mechanism where the report anything mechanism can be applied it is a newsworthy item like a building collapse are the new Senate you can choose to stream video to new services and deals can be brokered with Request Anything mechanism and method, also streaming video can be stored with Protect Anything Human Key and certified owned by you.

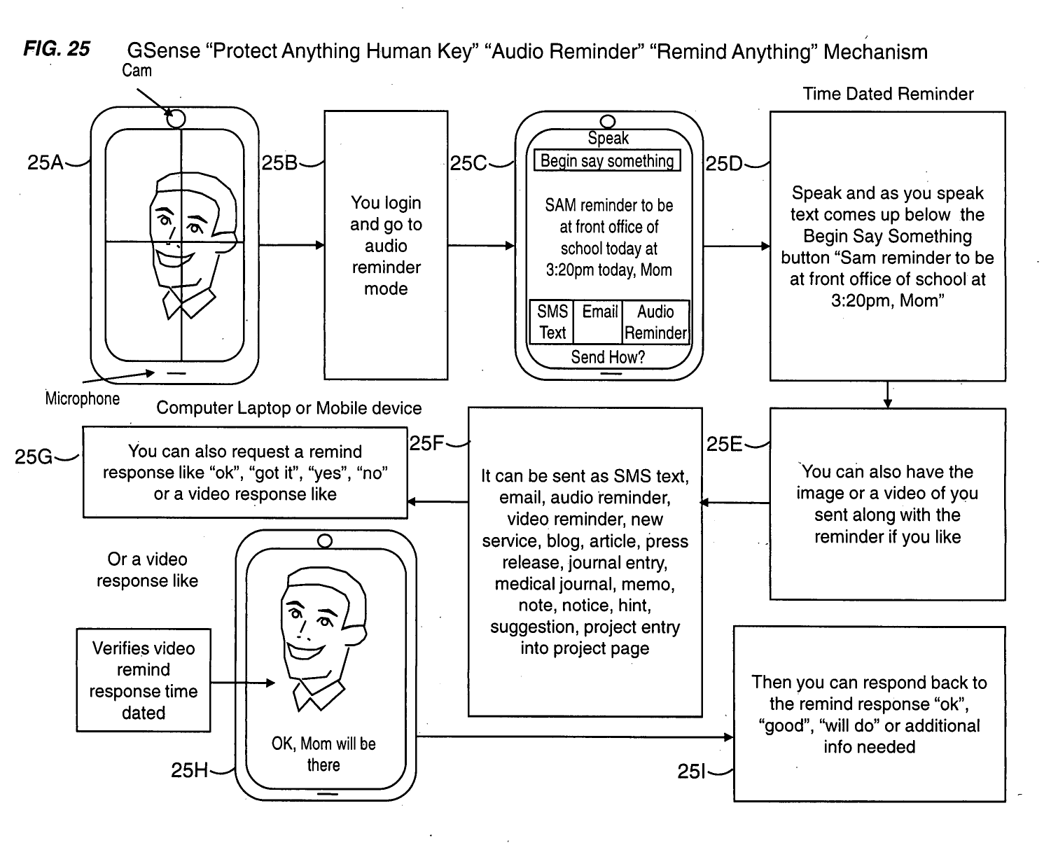

FIG. 25-25A describes Protect Anything Human Key “Audio or Video Reminder Mechanism Remind Anything used with laptop or any mobile device with cam and microphone and shows target for ID verify.

FIG. 25-25B describes Protect Anything Human Key “Audio or Video Reminder Mechanism Remind Anything you login and go to audio reminder mode.

FIG. 25-25C describes Protect Anything Human Key “Audio or Video Reminder Mechanism Remind Anything where you speak begins a something Sam reminder to be a front office of school today at 3:20 PM today, mom shows buttons for SMS text, e-mail, audio reminder, video reminder, and send, how?

FIG. 25-25D describes Protect Anything Human Key “Audio or Video Reminder Mechanism Remind Anything how the mechanism provides time dated reminder speakeasy speed text comes up below the reminder say something button Sam reminder to be at the office of school at 3:20 PM, mom.

FIG. 25-25E describes Protect Anything Human Key “Audio or Video Reminder Mechanism Remind Anything he also had image or a video sent along with the reminder if you like.

FIG. 25-25F describes Protect Anything Human Key “Audio or Video Reminder Mechanism Remind Anything capability where can be sent as SMS text, e-mail, audio reminder, the reminder, the service, blog, article, press release, general entry, my medical Journal, memo, note, notice, hint, suggestion, project entry into project page.

FIG. 25-25G describes Protect Anything Human Key “Audio or Video Reminder Mechanism Remind Anything you can also request a remind response like “okay”, “got it”, “yes”, “no” or a video response directly from you.

FIG. 25-25H describes Protect Anything Human Key “Audio or Video Reminder Mechanism Remind Anything video response mechanism verifies video remind response time dated, as shown “okay, mom will be there” with your image or your video file from your laptop or mobile device.

FIG. 25-25I describes Protect Anything Human Key “Audio or Video Reminder Mechanism Remind Anything how you can then you can respond back to the remind response “okay”, “good”, “will do” or additional info if needed.

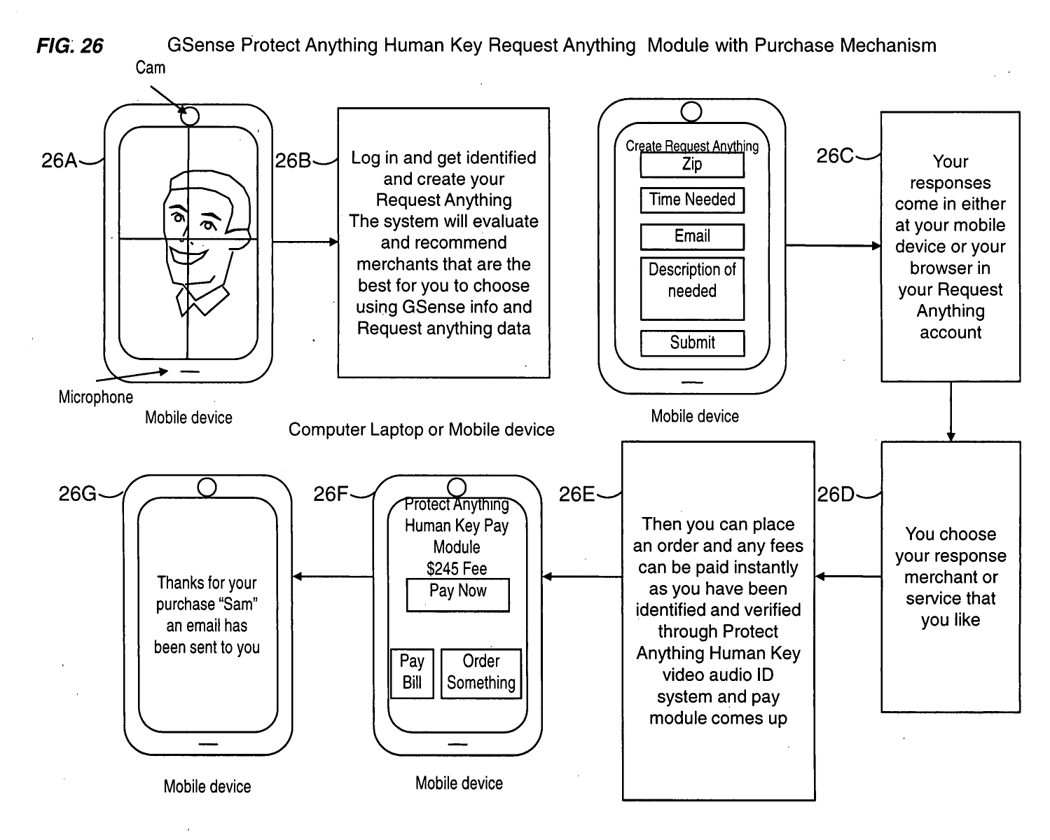

FIG. 26-26A describes Protect Anything Human Key Request Anything Module with Purchase Mechanism and Request Anything laptop or any mobile device with cam and microphone and the identification target.

FIG. 26-26B describes Protect Anything Human Key Request Anything Module with Purchase Mechanism and Request Anything where you login and get identified and create your Request Anything the system will evaluate and recommend merchants that are the best for you to choose using GSense engine and info and Request Anything data, you start with create Request Anything then zip, time needed, your e-mail, description of needed, then submit.

FIG. 26-26C describes Protect Anything Human Key Request Anything Module with Purchase Mechanism and Request Anything where you responses come in either at your mobile device, or your laptop browser in your Request Anything account.

FIG. 26-26D describes Protect Anything Human Key Request Anything Module with Purchase Mechanism and Request Anything where you choose your response merchant or service that you like.

FIG. 26-26E describes Protect Anything Human Key Request Anything Module with Purchase Mechanism and Request Anything where then you can place an order in any fees can be paid instantly as you have been identified and verified through Protect Anything Human Key video audio ID system and pay module comes up.

FIG. 26-26F describes Protect Anything Human Key Request Anything Module with Purchase Mechanism and Request Anything pay interface, Protect Anything Human Key pay module $245 fee, pay now button, pay bill button, order anything on your mobile device or laptop.

FIG. 26-26G describes Protect Anything Human Key Request Anything Module with Purchase Mechanism and Request Anything then responds with thanks for your purchase “Sam” e-mail has been sent to you.

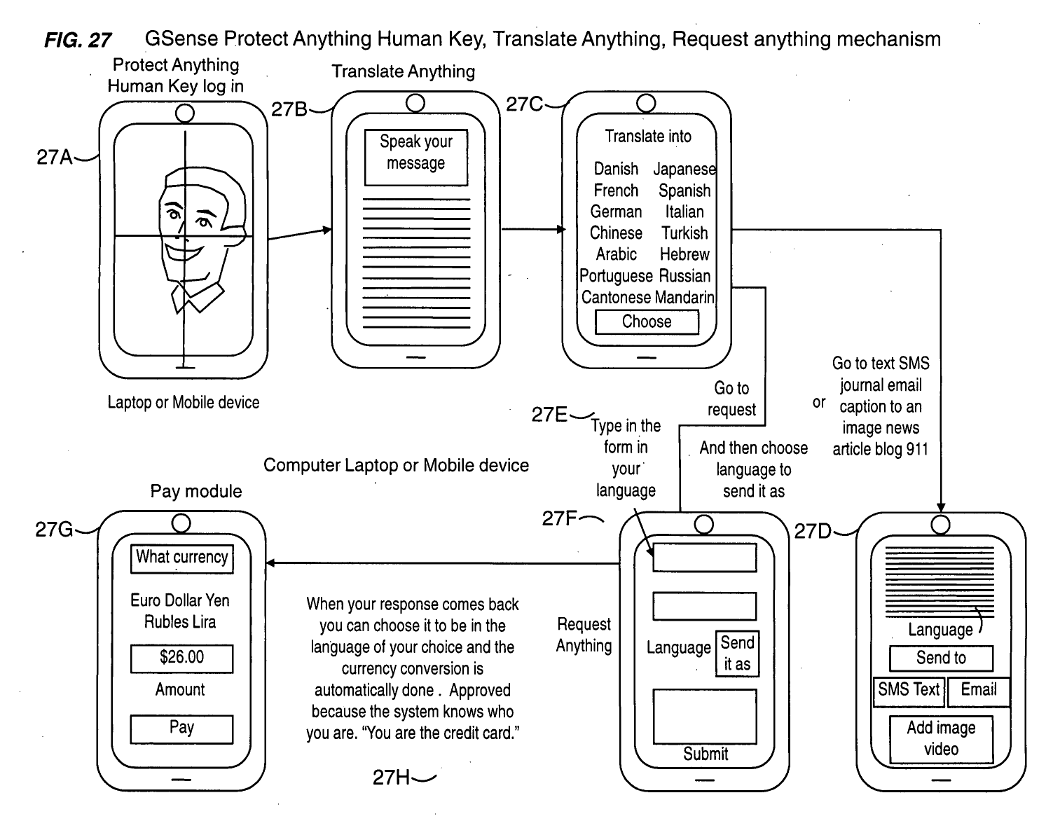

FIG. 27-27A describes Protect Anything Human Key id and translate anything connected to Request Anything module with Protect Anything Human Key login on laptop or any mobile device with Protect Anything Human Key cross hair identification.

FIG. 27-27B describes Protect Anything Human Key id and translate anything connected to Request Anything module with translate anything, or you speak your message.

FIG. 27-27C describes Protect Anything Human Key id and translate anything connected to Request Anything module where all language mechanism can translate into any language start with choose where you can go to the request or go to text SMS Journal e-mail caption to an image news article blog 911.

FIG. 27-27D describes Protect Anything Human Key id and translate anything connected to Request Anything module select language click send to button or click SMS text button or click the e-mail button or click an image video.

FIG. 27-27E describes Protect Anything Human Key id and translate anything connected to Request Anything module where you type in the form in your language.

FIG. 27-27F describes Protect Anything Human Key id and translate anything connected to Request Anything module form fields choose language send it as button read it or edit it then submit it, with the same form you can Request Anything, pay for anything, order anything.

FIG. 27-27G describes Protect Anything Human Key id and translate anything connected to Request Anything module with pay module individual or group payment platform choose what currency button, Euro dollar yen Rubles lire, in form field type the amount to pay, then click pay button.

FIG. 27-27H describes Protect Anything Human Key id and translate anything connected to Request Anything module where when you response comes back you can choose it to be in the language of your choice in the currency conversion is automatically done, approve because the system knows who you are, you are the credit card.

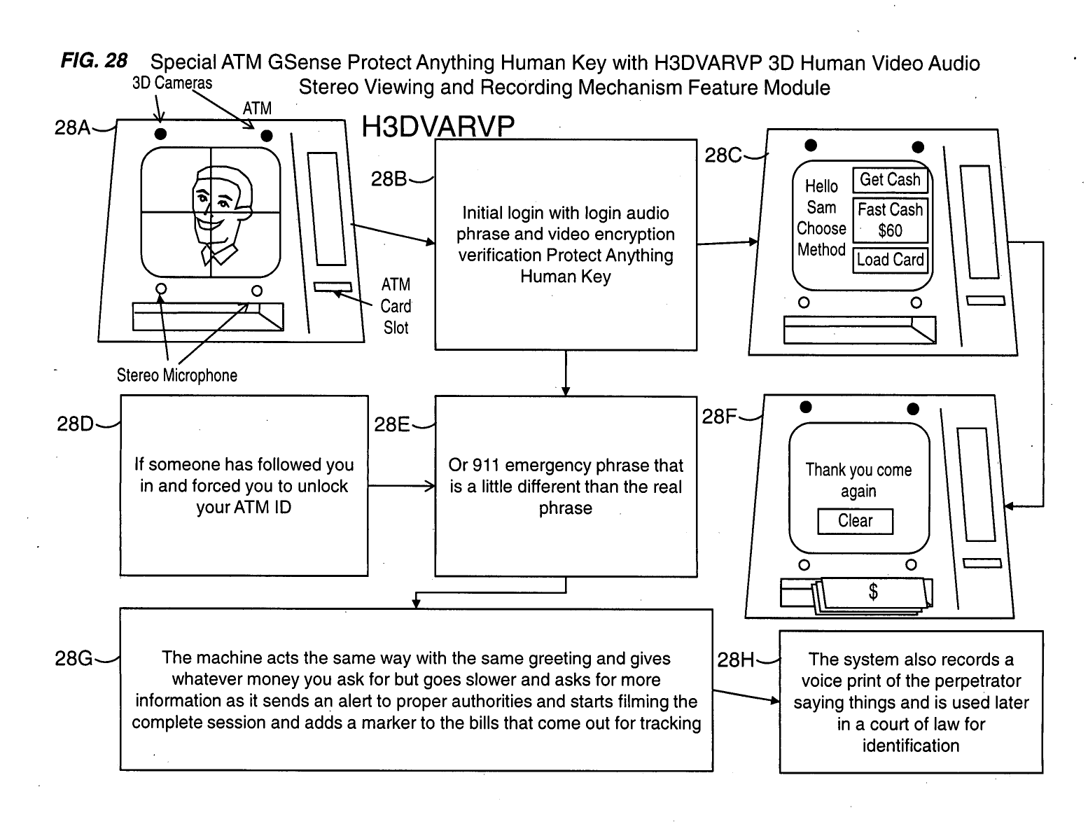

FIG. 28-28A describes Protect Anything Human Key Special ATM feature module with H3DVARV 3D Human Video Audio Stereo Viewing and Recording Mechanism where the mechanism is built into bank ATM 3D camera 3D Stereo microphone and card slot.

FIG. 28-28B describes Protect Anything Human Key Special ATM feature module with H3DVARV 3D Human Video Audio Stereo Viewing and Recording Mechanism where the mechanism starts with initial login with login audio phrase and video encryption verification with the Protect Anything Human Key mechanism.

FIG. 28-28C describes Protect Anything Human Key Special ATM feature module with H3DVARV 3D Human Video Audio Stereo Viewing and Recording Mechanism where the bank ATM responds after authentication and identification with hello Sam choose method, get cash button, fast cash $60 button, load card.

FIG. 28-28D describes Protect Anything Human Key Special ATM feature module with H3DVARV 3D Human Video Audio Stereo Viewing and Recording Mechanism where if someone has followed you in and forced you to unlock your ATM ID you can protect yourself.

FIG. 28-28E describes Protect Anything Human Key Special ATM feature module with H3DVARV 3D Human Video Audio Stereo Viewing and Recording Mechanism where you can say a 911 emergency phrase that is a little different than the real phrase.

FIG. 28-28F describes Protect Anything Human Key Special ATM feature module with H3DVARV 3D Human Video Audio Stereo Viewing and Recording Mechanism where the 911 emergency working screen says thank you come again with the clear button and dispenses money.

FIG. 28-28G describes Protect Anything Human Key Special ATM feature module with H3DVARV 3D Human Video Audio Stereo Viewing and Recording Mechanism where the 911 emergency feature activates hidden security 3D camera, the machine accesses the same way with the same greeting and gives whatever money you asked for with a slow reaction for more information as it sends hidden alert to the proper authorities and starts filming the complete session and adds an invisible marker to the bills that comes out for tracking.

FIG. 28-28H describes Protect Anything Human Key Special ATM feature module with H3DVARV 3D Human Video Audio Stereo Viewing and Recording Mechanism where the system also records a 3D stereo voice file and print of the perpetrator saying things and issues identification later in court of law for identification.

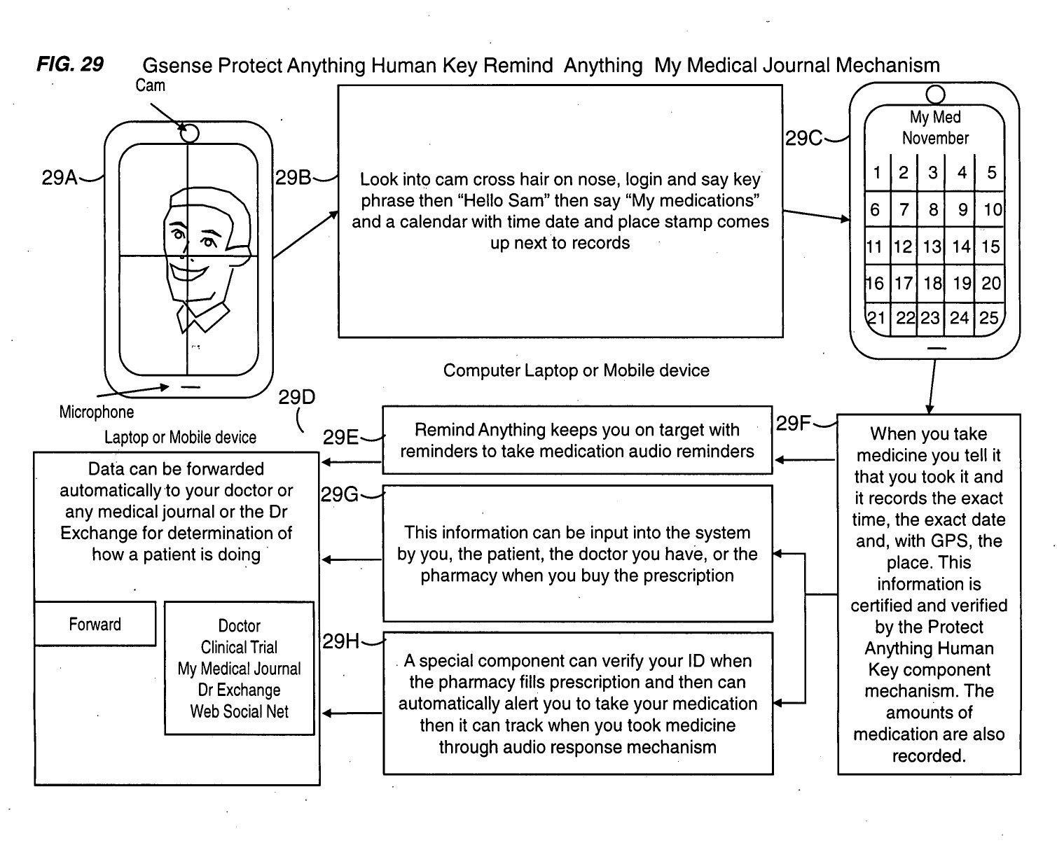

FIG. 29-29A describes Protect Anything Human Key Remind Anything My Medical Journal Module mechanism used with laptop or mobile device of any kind with cam and microphone showing target crosshairs for identification.

FIG. 29-29B describes Protect Anything Human Key Remind Anything My Medical Journal Module mechanism we look into the cam crosshair on your nose, login as a key phrase then “hello Sam” then say “my medications” and a calendar with a time date and place stamp comes up next to records.

FIG. 29-29C describes Protect Anything Human Key Remind Anything My Medical Journal Module mechanism calendar for my med November in touchscreen mobile device.

FIG. 29-29D describes Protect Anything Human Key Remind Anything My Medical Journal Module mechanism where data can be forwarded automatically to your Dr. or any medical Journal or the doctor exchange for determination of how patients are doing.

FIG. 29-29E describes Protect Anything Human Key Remind Anything My Medical Journal Module mechanism where Remind Anything keeps you on target with reminders to take medication audio reminders text reminders video reminders SMS reminders.

FIG. 29-29F describes Protect Anything Human Key Remind Anything My Medical Journal Module mechanism where when you take medicine you tell it what you took and it records the exact time, the exact date, but GPS the exact place, this information is certified and verified by the Protect Anything Human Key component mechanism the amounts medications are also recorded.

FIG. 29-29G describes Protect Anything Human Key Remind Anything My Medical Journal Module mechanism was information can be input into the system by you, the patient, the doctor you have, or the pharmacy when you buy the prescription.

FIG. 29-29H describes Protect Anything Human Key Remind Anything My Medical Journal Module mechanism where a special component can verify your ID when the Parsi pills prescription and they can automatically alert you to take your medication to a contract when you took medication to audio response mechanism.

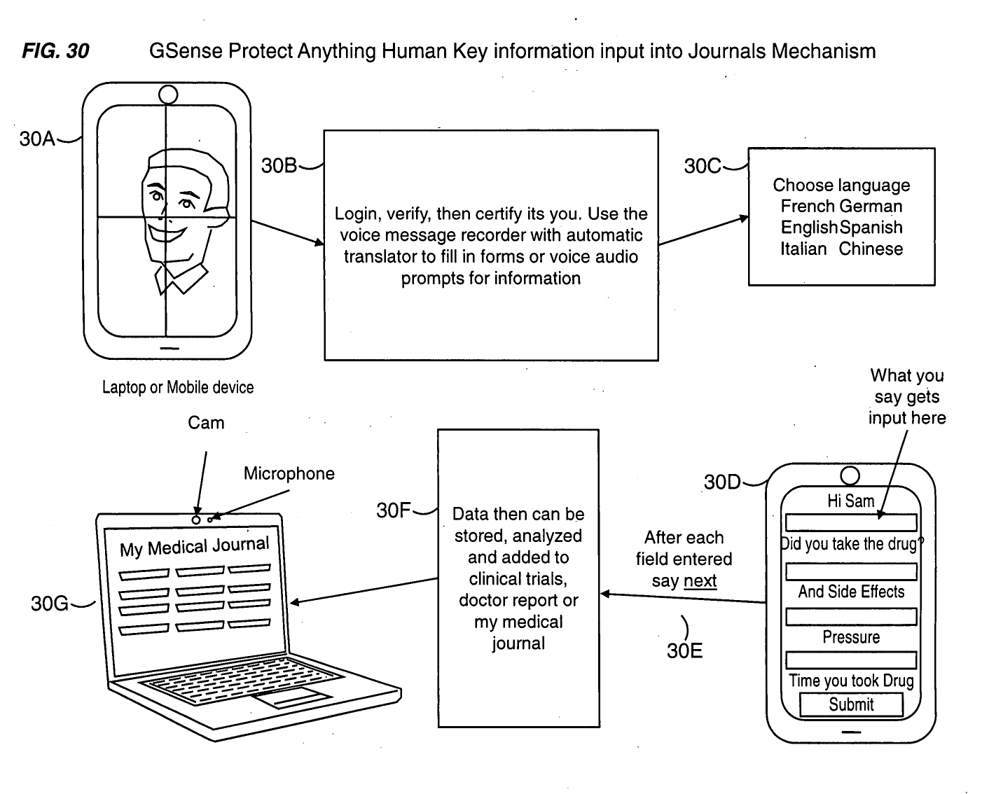

FIG. 30-30A describes the Protect Anything Human Key automatic entry into form fields mechanism where any laptop any mobile device with cam and Mike can be used to edit and add secure protected information to Journal or any form fields.

FIG. 30-30B describes the Protect Anything Human Key automatic entry into form fields mechanism where you login, verify, and certify its you, use the voice message recorder with automatic translator to fill in forms or voice audio prompts for information.

FIG. 30-30C describes the Protect Anything Human Key automatic entry into form fields mechanism where you can choose any language.

FIG. 30-30D describes the Protect Anything Human Key automatic entry into form fields mechanism were what you say gets input into the form starts with high Sam did you take your medication you respond yes no then say next, any side effects you say what side effects, then say next, how is your pressure, you say numbers, you say next, what time did you take medication, you say time, you say next, you say submit.

FIG. 30-30E Always saying next after each field you fill in.

FIG. 30-30F describes the Protect Anything Human Key automatic entry into form fields mechanism where data then can be stored, analyzed, and added to clinical trials, doctors report, or my medical Journal, or with permission to any of the disease exchanges.

FIG. 30-30G describes the Protect Anything Human Key automatic entry into form fields mechanism and shows a laptop with a camera microphone and at the my medical Journal website.

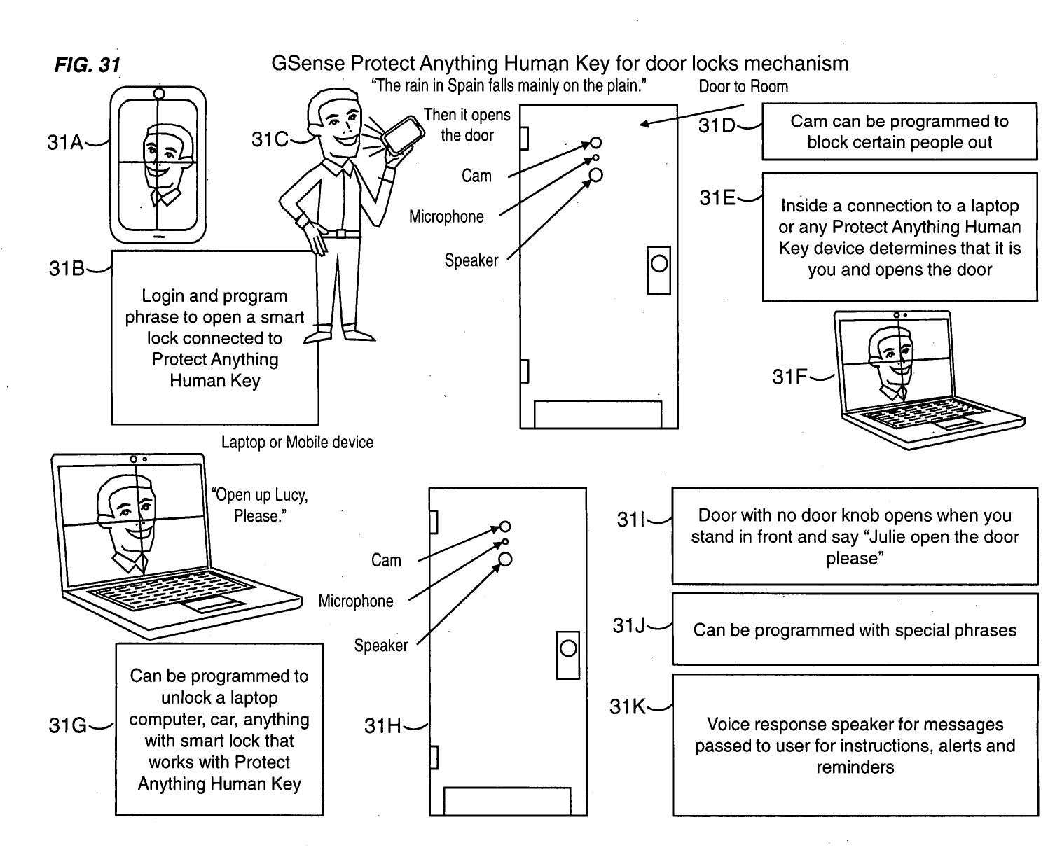

FIG. 31-31A describes Protect Anything Human Key door or machine entry identification and unlock mechanism where “you are the key” and can use any mobile device or laptop or mounted in a machine or door with a cam and a microphone to positively identify yourself and automatically unlock the lock.

FIG. 31-31B describes Protect Anything Human Key door or machine entry identification and unlock mechanism where “you are the key” and can use any mobile device or laptop or mounted in a machine or door with a cam and a microphone to positively identify yourself and automatically unlock the lock, you just login to your mobile device or laptop say your key phrase that you registered, in your own voice to open a smart lock connected to Protect Anything Human Key for verification and identification.

FIG. 31-31C describes Protect Anything Human Key door or machine entry identification and unlock mechanism where “you are the key” and can use any mobile device or laptop or mounted in a machine or door with a cam and a microphone to positively identify yourself and automatically unlock the lock, you just say your key phrase at the door you want to open, then it sees you and recognizes you and it opens.

FIG. 31-31D describes Protect Anything Human Key door or machine entry identification and unlock mechanism where “you are the key” and can use any mobile device or laptop or mounted in a machine or door with a cam and a microphone to positively identify yourself and automatically unlock the lock, the cam and microphone can be connected to multiple people and can block certain people out.

FIG. 31-31E describes Protect Anything Human Key door or machine entry identification and unlock mechanism where “you are the key” and can use any mobile device or laptop or mounted in a machine or door with a cam and a microphone to positively identify yourself and automatically unlock the lock inside a built in connection or direct connection to a computer or laptop, or mobile device or any Protect Anything Human Key device determines that it is you and opens the lock on the door.

FIG. 31-31F describes Protect Anything Human Key door or machine entry identification and unlock mechanism where “you are the key” and can use any mobile device or laptop or mounted in a machine or door with a cam and a microphone to positively identify yourself and automatically unlock the lock and shows the crosshairs on the laptop, the door lock Protect Anything Human Key module has automatic lock on to the tip of the nose of the person looking at the cam for identification.

FIG. 31-31G describes Protect Anything Human Key door or machine entry identification and unlock mechanism where “you are the key” and can use any mobile device or laptop or mounted in a machine or door with a cam and a microphone to positively identify yourself and automatically unlock the lock the mechanism can also be programmed to unlock a laptop, computer, car, anything with a smart lock that works with Protect Anything Human Key.

FIG. 31-31H describes Protect Anything Human Key door or machine entry identification and unlock mechanism where “you are the key” and can use any mobile device or laptop or mounted in a machine or door with a cam and a microphone to positively identify yourself and automatically unlock the lock and shows the cam, microphone and speaker where it can state warnings, alarms, or cue the person being identified.

FIG. 31-31I describes Protect Anything Human Key door or machine entry identification and unlock mechanism where “you are the key” and can use any mobile device or laptop or mounted in a machine or door with a cam and a microphone to positively identify yourself and automatically unlock the lock, shows where a door with no door knob automatically opens when you stand in front and say “Julie open the door please” it will only work with your voice and video print and not with another persons.

FIG. 31-31J describes Protect Anything Human Key door or machine entry identification and unlock mechanism where “you are the key” and can use any mobile device or laptop or mounted in a machine or door with a cam and a microphone to positively identify yourself and automatically unlock the lock, shows that the system can be programmed with special phrases for different people, or for different security modes.

FIG. 31-31K describes Protect Anything Human Key door or machine entry identification and unlock mechanism where “you are the key” and can use any mobile device or laptop or mounted in a machine or door with a cam and a microphone to positively identify yourself and automatically unlock the lock, shows the voice response speaker for messages passed to user for instructions, alerts and reminders.

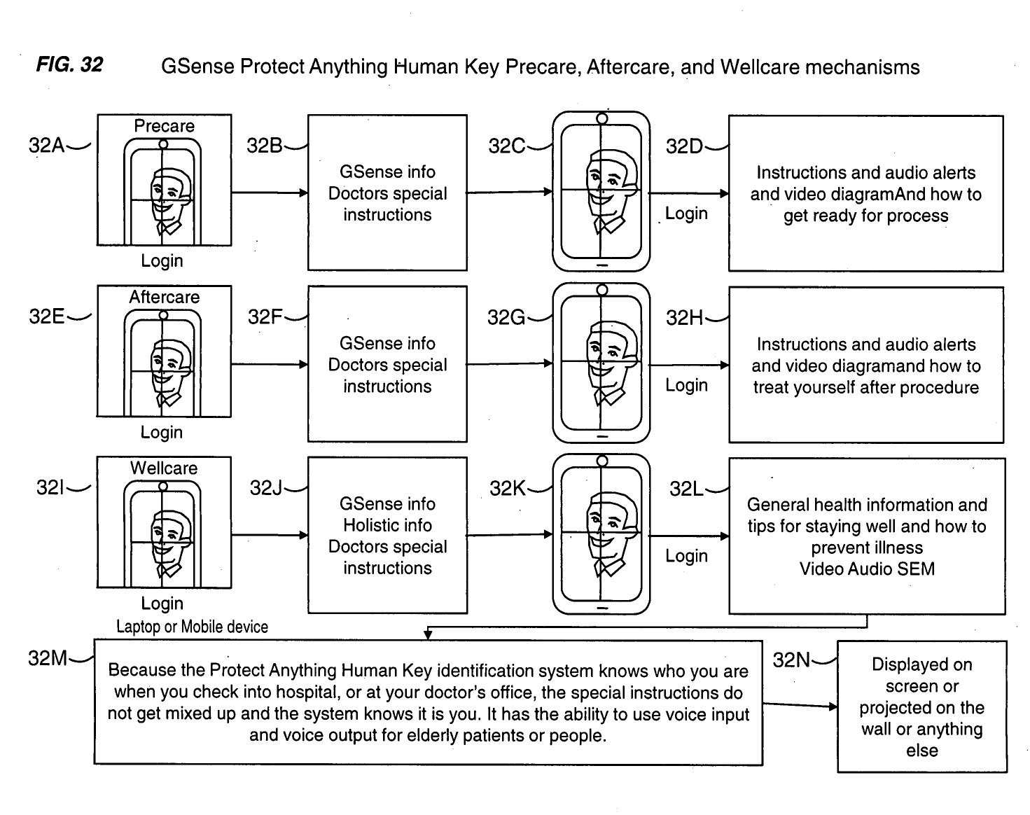

FIG. 32-32A describes GSense Precare, mechanisms utilizing Protect Anything Human Key with laptop or any mobile device with cam and microphone, and shows pre-care login in handheld device.

FIG. 32-32B describes GSense Precare, mechanisms utilizing Protect Anything Human Key with laptop or any mobile device with cam and microphone, and shows GSense info doctors special instructions.

FIG. 32-32C describes GSense Precare, mechanisms utilizing Protect Anything Human Key with laptop or any mobile device with cam and microphone, and shows shows the Protect Anything Human Key login.

FIG. 32-32D describes GSense Precare, mechanisms utilizing Protect Anything Human Key with laptop or any mobile device with cam and microphone, and shows holistic practitioners, doctors, medical people and others instructions and audio alerts and video diagram and how to get ready for procedure.

FIG. 32-32E describes GSense Aftercare, mechanisms utilizing Protect Anything Human Key with laptop or any mobile device with cam and microphone, and shows after care login.

FIG. 32-32F describes GSense Aftercare, mechanisms utilizing Protect Anything Human Key with laptop or any mobile device with cam and microphone, and shows GSense info doctors special instructions.

FIG. 32-32G describes GSense Aftercare, mechanisms utilizing Protect Anything Human Key with laptop or any mobile device with cam and microphone, and shows Protect Anything Human Key login.

FIG. 32-32H describes GSense Aftercare, mechanisms utilizing Protect Anything Human Key with laptop or any mobile device with cam and microphone, and shows doctors, medical people, and holistic practitioners instructions audio alerts and video diagrams and how to treat yourself after a procedure.

FIG. 32-32I describes GSense Wellcare mechanisms utilizing Protect Anything Human Key with laptop or any mobile device with cam and microphone, and shows the well care login.

FIG. 32-32J describes GSense Wellcare mechanisms utilizing Protect Anything Human Key with laptop or any mobile device with cam and microphone, and shows the GSense info holistic info doctors special instructions.

FIG. 32-32K describes GSense Wellcare mechanisms utilizing Protect Anything Human Key with laptop or any mobile device with cam and microphone, and shows the Protect Anything Human Key login.

FIG. 32-32L describes GSense Wellcare mechanisms utilizing Protect Anything Human Key with laptop or any mobile device with cam and microphone, and shows doctors, medical people, holistic practitioners general health information and tips for staying well and how to prevent illness video audio SMS text information or SP delivery and virtual AR SP delivery.

FIG. 32-32M describes GSense Precare, Aftercare, and Wellcare mechanisms utilizing Protect Anything Human Key with laptop or any mobile device with cam and microphone, and shows because the Protect Anything Human Key identification system knows who you are when you check into hospital, or at your Dr.'s office, the special instructions do not get mixed up in the system knows it is you. It has the ability to use voice input and voice output for elderly patients or people.

FIG. 32-32N describes GSense Precare, Aftercare, and Wellcare mechanisms utilizing Protect Anything Human Key with laptop or any mobile device with cam and microphone, and shows the ability of the mechanism to be displayed on screen are projected on the wall or anything else.

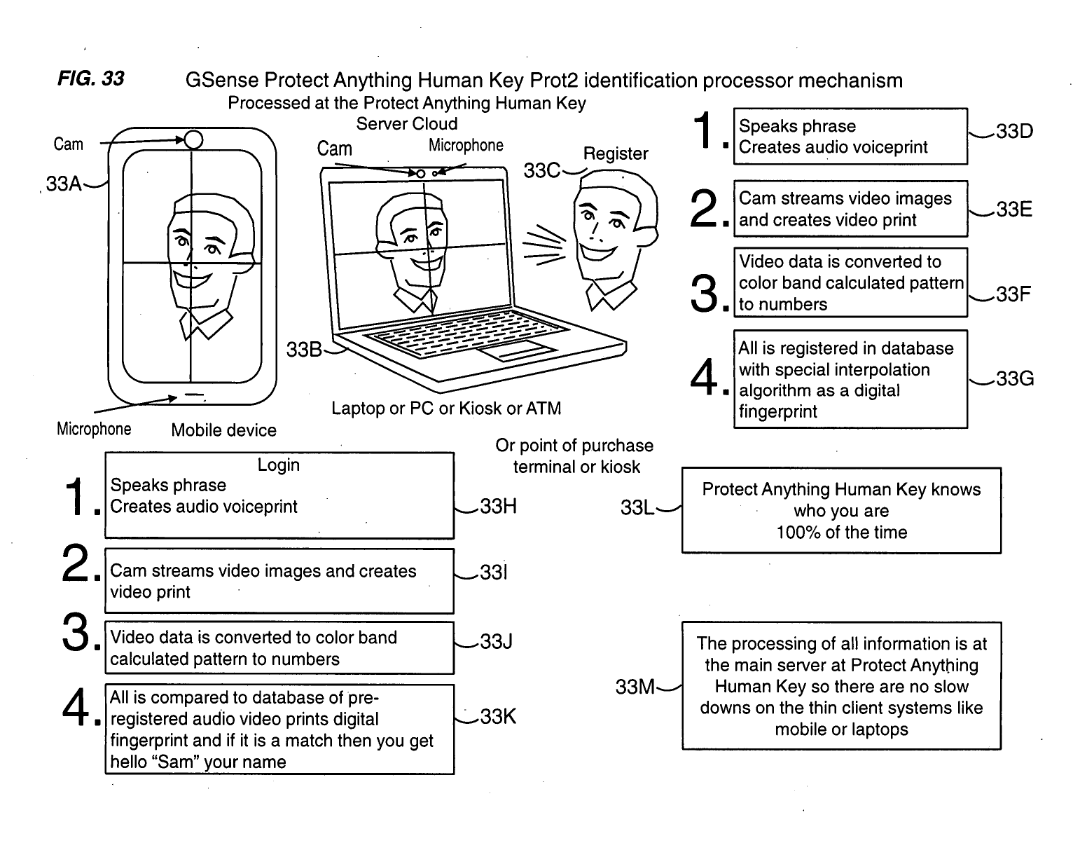

FIG. 33-33A describes How Protect Anything Human Key works utilizing processing at the Protect Anything Human Key Server Cloud with laptop or any mobile device with cam and microphone, and shows cam and microphone with crosshairs on mobile device.

FIG. 33-33B describes How Protect Anything Human Key works utilizing processing at the Protect Anything Human Key Server Cloud with laptop or any mobile device with cam and microphone, and shows laptop or PC or Kiosk or ATM for pay portal or locks, or identification with cam and microphone.

FIG. 33-33C describes How Protect Anything Human Key works utilizing processing at the Protect Anything Human Key Server Cloud with laptop or any mobile device with cam and microphone, and shows registering with voice and video of you.

FIG. 33-33D 1. describes How Protect Anything Human Key works utilizing processing at the Protect Anything Human Key Server Cloud with laptop or any mobile device with cam and microphone, and shows how a person speaks phrase and creates an audio voice print.

FIG. 33-33E 2. describes How Protect Anything Human Key works utilizing processing at the Protect Anything Human Key Server Cloud with laptop or any mobile device with cam and microphone, and shows how the cam streams video images and creates video print.

FIG. 33-33F 3. describes How Protect Anything Human Key works utilizing processing at the Protect Anything Human Key Server Cloud with laptop or any mobile device with cam and microphone, and shows how video data is converted to color band calculated pattern to numbers and a 3D human analysis is made.

FIG. 33-33G 4. describes How Protect Anything Human Key works utilizing processing at the Protect Anything Human Key Server Cloud with laptop or any mobile device with cam and microphone, and shows all is registered in database and system with special interpolation algorithm as a digital fingerprint.

FIG. 33-33H 1. describes How Protect Anything Human Key works utilizing processing at the Protect Anything Human Key Server Cloud with laptop or any mobile device with cam and microphone, and shows the login where one speaks phrase, and creates audio voiceprint.

FIG. 33-33I 2. describes How Protect Anything Human Key works utilizing processing at the Protect Anything Human Key Server Cloud with laptop or any mobile device with cam and microphone, and shows where the cam streams video images and creates a video print.

FIG. 33-33J 3. describes How Protect Anything Human Key works utilizing processing at the Protect Anything Human Key Server Cloud with laptop or any mobile device with cam and microphone, and shows where video data is converted to color band calculated pattern to numbers, an 3D human analysis is made.

FIG. 33-33K 4. describes How Protect Anything Human Key works utilizing processing at the Protect Anything Human Key Server Cloud with laptop or any mobile device with cam and microphone, and shows where all is compared to database of pre registered audio video prints digital fingerprint and if it is a match then you get hello “Sam” your name.

FIG. 33-33L describes How Protect Anything Human Key works utilizing processing at the Protect Anything Human Key Server Cloud with laptop or any mobile device with cam and microphone, and shows where Protect Anything Human Key knows who you are 100% of the time.

FIG. 33-33M describes How Protect Anything Human Key works utilizing processing at the Protect Anything Human Key Server Cloud with laptop or any mobile device with cam and microphone, and shows where the processing of all information is at the main server at Protect Anything Human Key so there are no slow downs on the thin client systems like mobile or laptops.

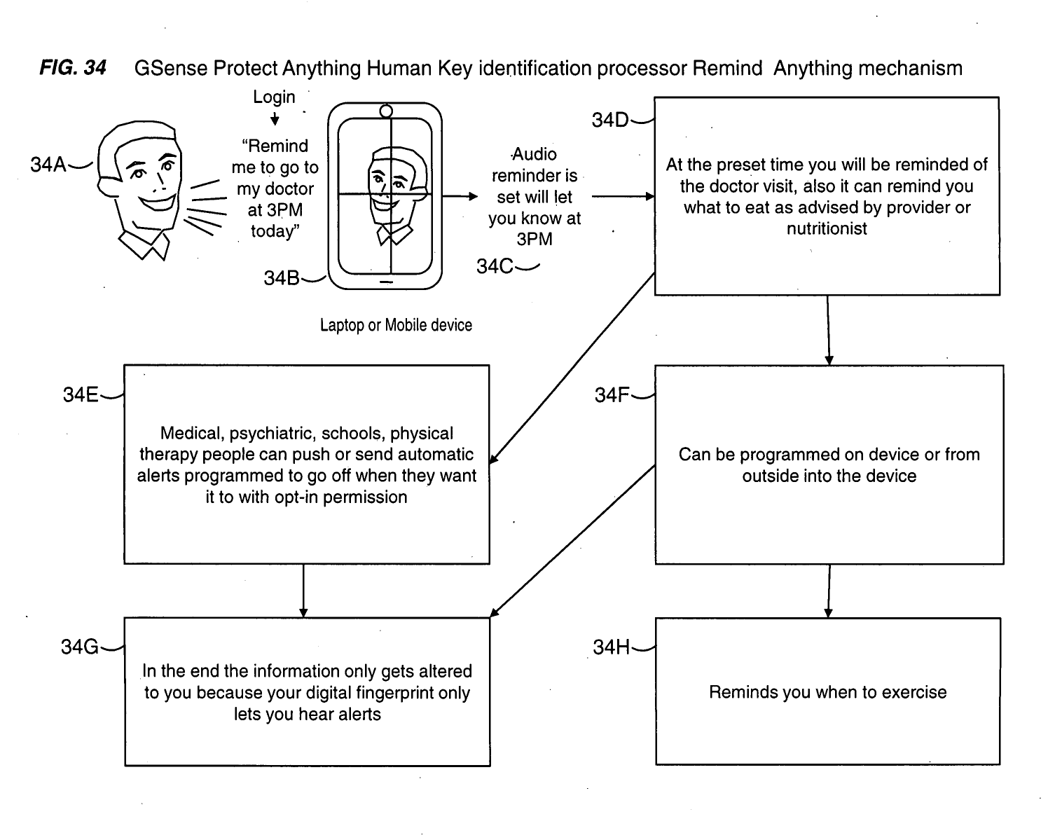

FIG. 34-34A describes examples of reminders and Remind Anything functions utilizing processing at the Protect Anything Human Key Server Cloud with laptop or any mobile device with cam and microphone, and shows cam and microphone with crosshairs on mobile device where a person logs in.

FIG. 34-34B describes examples of reminders and Remind Anything functions utilizing processing at the Protect Anything Human Key Server Cloud with laptop or any mobile device with cam and microphone, and shows cam and microphone with crosshairs on mobile device shows login and state for the reminder mechanism to remind me go to my doctor at 3 PM today.

FIG. 34-34C describes examples of reminders and Remind Anything functions utilizing processing at the Protect Anything Human Key Server Cloud with laptop or any mobile device with cam and microphone, and shows where the audio reminder is set and will let you know at 3 PM that you need to go to the doctor.

FIG. 34-34D describes examples of reminders and Remind Anything functions utilizing processing at the Protect Anything Human Key Server Cloud with laptop or any mobile device with cam and microphone, and shows at the present time you will be reminded of the Dr. visit, also it can remind you what to the as advised by Dr. or nutritionist or appropriate credentials individual.

FIG. 34-34E describes examples of reminders and Remind Anything functions utilizing processing at the Protect Anything Human Key Server Cloud with laptop or any mobile device with cam and microphone, and shows how medical, psychiatric, schools, physical therapy people can push or send automatic alerts programmed to go off when they want it to with opt in permission.

FIG. 34-34F describes examples of reminders and Remind Anything functions utilizing processing at the Protect Anything Human Key Server Cloud with laptop or any mobile device with cam and microphone, and shows can be programmed on the device are from outside into the device.

FIG. 34-34G describes examples of reminders and Remind Anything functions utilizing processing at the Protect Anything Human Key Server Cloud with laptop or any mobile device with cam and microphone, and shows in the and the information only gets altered to you because your digital fingerprint verification and identification only lets you hear alerts.

FIG. 34-34H describes examples of reminders and Remind Anything functions utilizing processing at the Protect Anything Human Key Server Cloud with laptop or any mobile device with cam and microphone, and shows can also reminds you when to exercise our other important things for better health for assistance in daily activities.

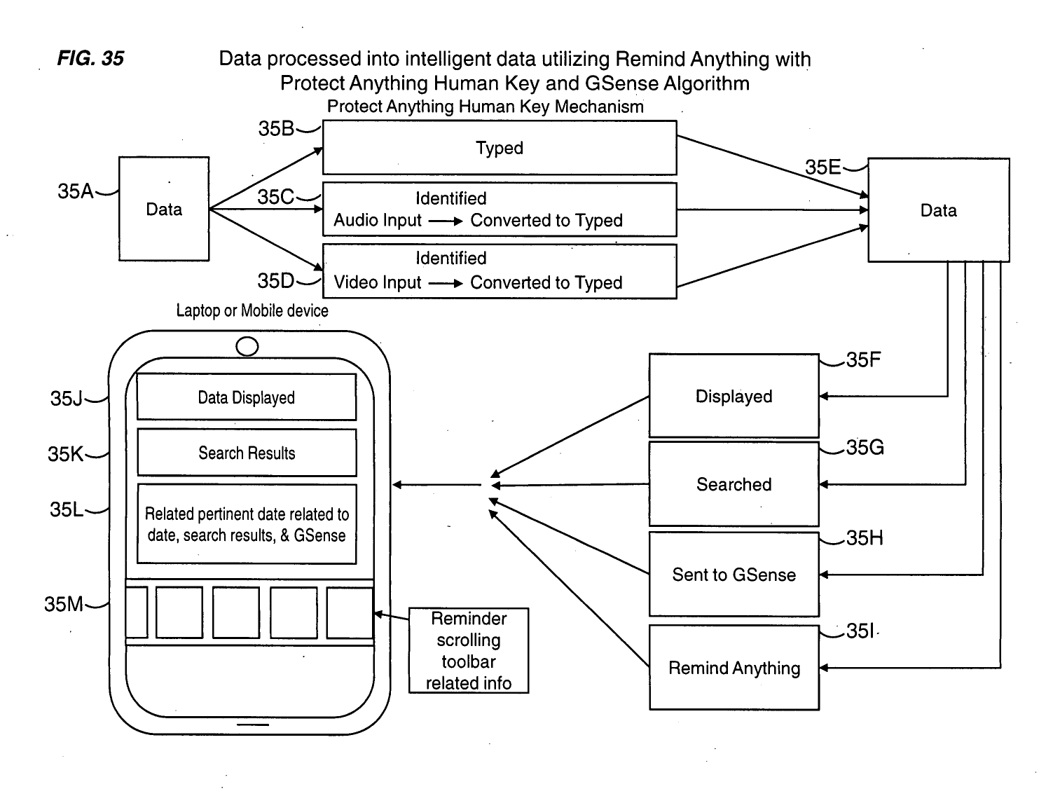

FIG. 35-35A describes How Data is processed into intelligent data Remind Anything with Protect Anything Human Key Server Cloud and GSense Algorithm and shows data.

FIG. 35-35B describes How Data is processed into intelligent data Remind Anything with Protect Anything Human Key Server Cloud and GSense Algorithm and shows typed data in the Protect Anything Human Key mechanism.

FIG. 35-35C describes How Data is processed into intelligent data Remind Anything with Protect Anything Human Key Server Cloud and GSense Algorithm and shows identified audio input converted to typed data in the Protect Anything Human Key mechanism.

FIG. 35-35D describes How Data is processed into intelligent data Remind Anything with Protect Anything Human Key Server Cloud and GSense Algorithm and shows identified video input converted to typed data in the Protect Anything Human Key mechanism.

FIG. 35-35E describes How Data is processed into intelligent data Remind Anything with Protect Anything Human Key Server Cloud and GSense Algorithm and shows converted to data.

FIG. 35-35F describes How Data is processed into intelligent data Remind Anything with Protect Anything Human Key Server Cloud and GSense Algorithm and shows data flow to displayed data.

FIG. 35-35G describes How Data is processed into intelligent data Remind Anything with Protect Anything Human Key Server Cloud and GSense Algorithm and shows data flow to search results searched.

FIG. 35-35H describes How Data is processed into intelligent data Remind Anything with Protect Anything Human Key Server Cloud and GSense Algorithm and shows data flow from sent to GSense.

FIG. 35-35I describes How Data is processed into intelligent data Remind Anything with Protect Anything Human Key Server Cloud and GSense Algorithm and shows data uploaded to Remind Anything.

FIG. 35-35J describes How Data is processed into intelligent data Remind Anything with Protect Anything Human Key Server Cloud and GSense Algorithm and shows protected data is displayed in mobile device.

FIG. 35-35K describes How Data is processed into intelligent data Remind Anything with Protect Anything Human Key Server Cloud and GSense Algorithm and shows protected search results are displayed in mobile device.

FIG. 35-35L describes How Data is processed into intelligent data Remind Anything with Protect Anything Human Key Server Cloud and GSense Algorithm and shows protected related perfect date related to date, search results, and GSense is displayed in mobile device.

FIG. 35-35M describes How Data is processed into intelligent data Remind Anything with Protect Anything Human Key Server Cloud and GSense Algorithm and shows a reminders scrolling toolbar with related information scrolls across the bottom of the mobile device.

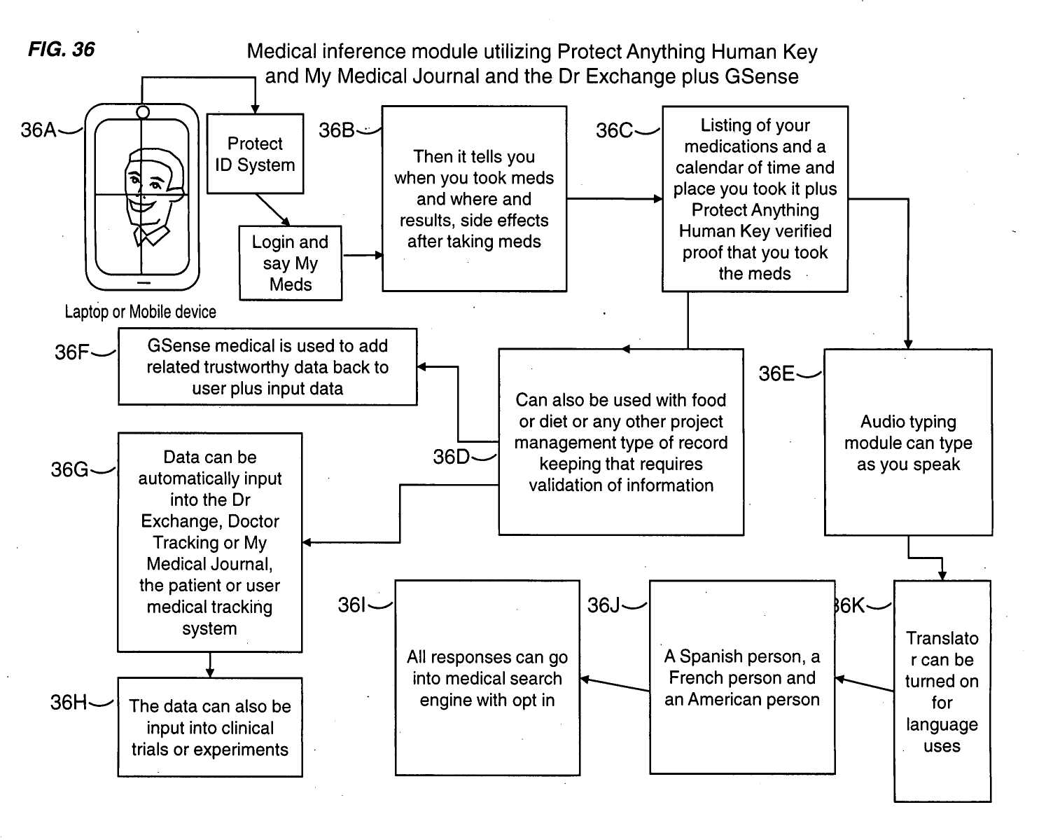

FIG. 36-36A Describes the Medical inference module utilizing Protect Anything Human Key and My Medical Journal and the DR Exchange plus GSense and shows a mobile device with crosshairs and microphone cam running through the protect ID system after logging saying my meds.

FIG. 36-36B Describes the Medical inference module utilizing Protect Anything Human Key and My Medical Journal and the DR Exchange plus GSense and shows good so she when you took meds and where and results, side effects after taking meds.

FIG. 36-36C Describes the Medical inference module utilizing Protect Anything Human Key and My Medical Journal and the DR Exchange plus GSense and shows listing of your medications in a calendar of time and place you took it plus Protect Anything Human Key verify proof that you took to medications.

FIG. 36-36D Describes the Medical inference module utilizing Protect Anything Human Key and My Medical Journal and the DR Exchange plus GSense and shows can also be used with food or diet or any other project management type of record keeping that requires validation of information.

FIG. 36-36E Describes the Medical inference module utilizing Protect Anything Human Key and My Medical Journal and the DR Exchange plus GSense and shows audio typing module can type as you speak.

FIG. 36-36F Describes the Medical inference module utilizing Protect Anything Human Key and My Medical Journal and the DR Exchange plus GSense and shows GSense medical is used to related trustworthy data back to user plus input data.

FIG. 36-36G Describes the Medical inference module utilizing Protect Anything Human Key and My Medical Journal and the DR Exchange plus GSense and shows data can be automatically input into the Dr. exchange Dr. tracking or my medical Journal, the patient or user medical tracking system.

FIG. 36-36H Describes the Medical inference module utilizing Protect Anything Human Key and My Medical Journal and the DR Exchange plus GSense and shows. The data can also be input into clinical trials or experiments involving medical social networks or other or any social network or doctor's files.

FIG. 36-36I Describes the Medical inference module utilizing Protect Anything Human Key and My Medical Journal and the DR Exchange plus GSense and shows all responses can go into medical search engine with opt in.

FIG. 36-36J Describes the Medical inference module utilizing Protect Anything Human Key and My Medical Journal and the DR Exchange plus GSense and shows rare a Spanish person, a French person in American person can all compare data and have their data compared with opt in.

FIG. 36-36K Describes the Medical inference module utilizing Protect Anything Human Key and My Medical Journal and the DR Exchange plus GSense and shows translator can be turned on for language uses all languages included.

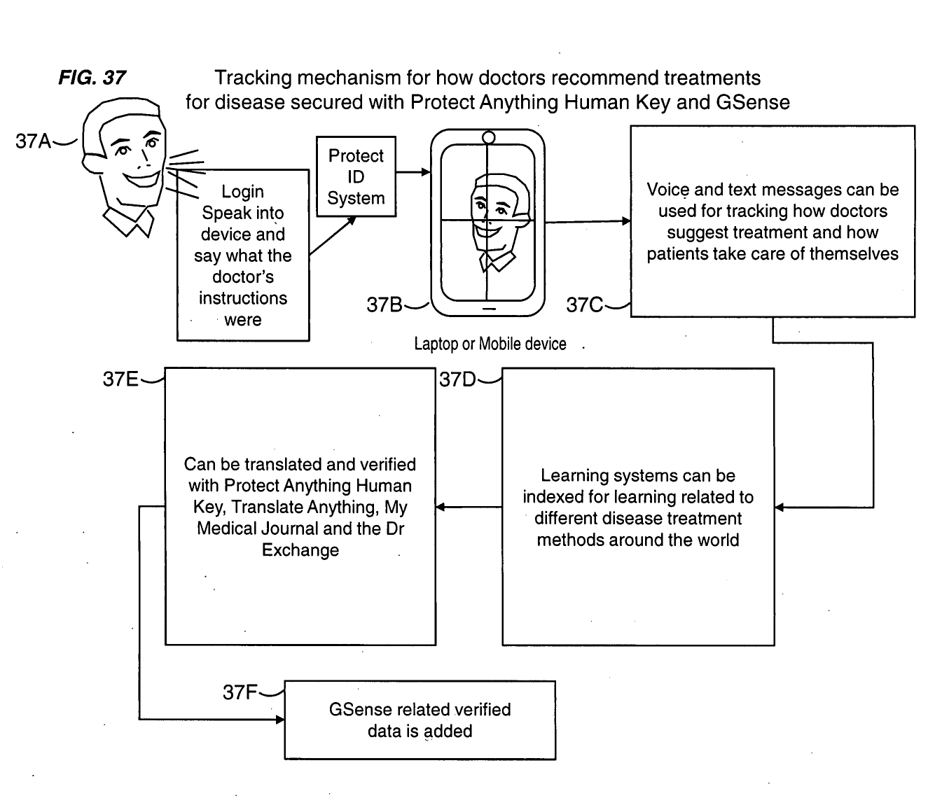

FIG. 37-37A describes tracking mechanism for how doctors recommend treatments for disease secured with Protect Anything Human Key Server Cloud and GSense Algorithm and shows the login speak into device and say what the doctors instructions were check ID through the protect ID system.

FIG. 37-37B describes tracking mechanism for how doctors recommend treatments for disease secured with Protect Anything Human Key Server Cloud and GSense Algorithm and shows cam and microphone with crosshair on mobile device that can use any computer or laptop to enter the protect ID system.

FIG. 37-37C describes tracking mechanism for how doctors recommend treatments for disease secured with Protect Anything Human Key Server Cloud and GSense Algorithm and shows voice and text messages can be used for tracking how doctors suggest treatments and how patients take care of themselves.

FIG. 37-37D describes tracking mechanism for how doctors recommend treatments for disease secured with Protect Anything Human Key Server Cloud and GSense Algorithm and shows learning systems can be indexed for learning related to different disease treatment methods around the world.

FIG. 37-37E describes tracking mechanism for how doctors recommend treatments for disease secured with Protect Anything Human Key Server Cloud and GSense Algorithm and shows how information can be translated verified with Protect Anything Human Key, translate anything, My Medical Journal, and The DR Exchange.

FIG. 37-37F describes tracking mechanism for how doctors recommend treatments for disease secured with Protect Anything Human Key Server Cloud and GSense Algorithm and shows GSense related verified data is added.

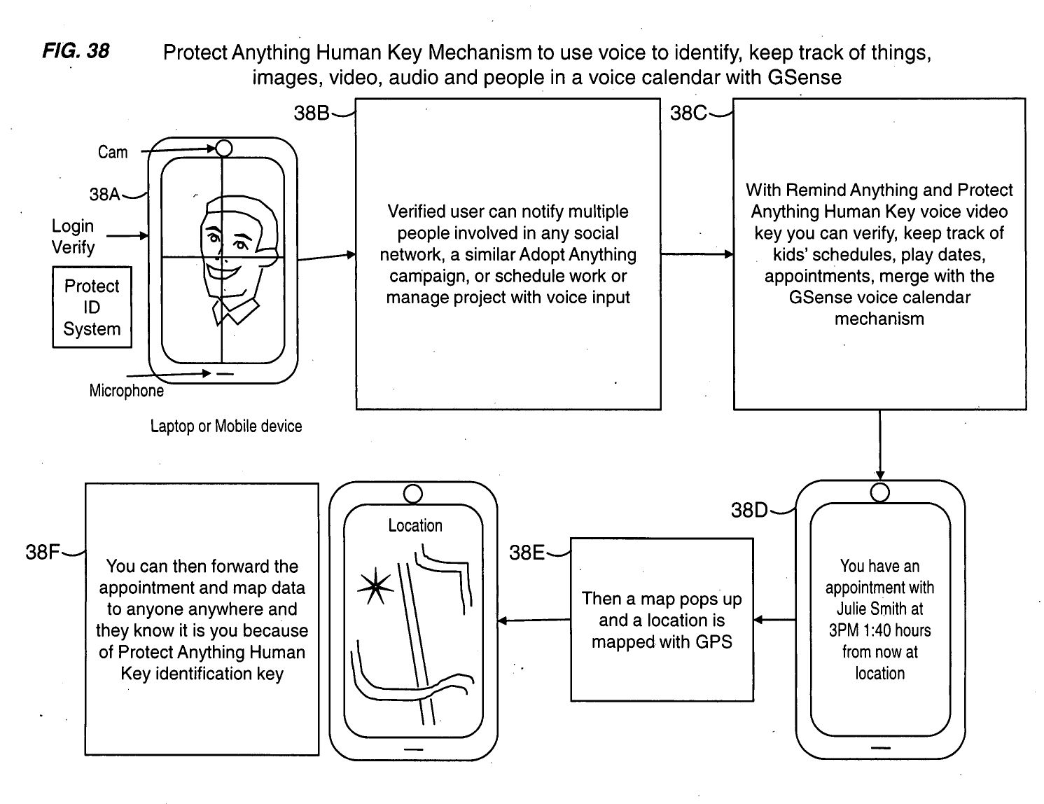

FIG. 38-38A describes Protect Anything Human Key Mechanism to use voice to identify, keep track of things, images, video, audio and people in a voice calendar Remind Anything and shows mobile device with crosshairs cam and microphone login verify to protect ID system.

FIG. 38-38B describes Protect Anything Human Key Mechanism to use voice to identify, keep track of things, images, video, audio and people in a voice calendar Remind Anything and shows verify the user can notify multiple people involved in any social network business, or nonprofit a similar Adopt Anything campaign or any campaign, or schedule work or manage project with voice input.

FIG. 38-38C describes Protect Anything Human Key Mechanism to use voice to identify, keep track of things, images, video, audio and people in a voice calendar Remind Anything and shows with Remind Anything in Protect Anything Human Key voice video key you can verify, keep track of kids schedule's, play dates, appointments, merge with a voice calendar mechanism.

FIG. 38-38D describes Protect Anything Human Key Mechanism to use voice to identify, keep track of things, images, video, audio and people in a voice calendar Remind Anything and shows a response in your mobile device you have appointed with Julie Smith at 3 PM 1:40 hours from now it location.

FIG. 38-38E describes Protect Anything Human Key Mechanism to use voice to identify, keep track of things, images, video, audio and people in a voice calendar Remind Anything and shows the map pops up location is then mapped with GPS.

FIG. 38-38F describes Protect Anything Human Key Mechanism to use voice to identify, keep track of things, images, video, audio and people in a voice calendar Remind Anything and shows you can then forward the appointment and map data to anyone anywhere and they know is you because of Protect Anything Human Key identification key.

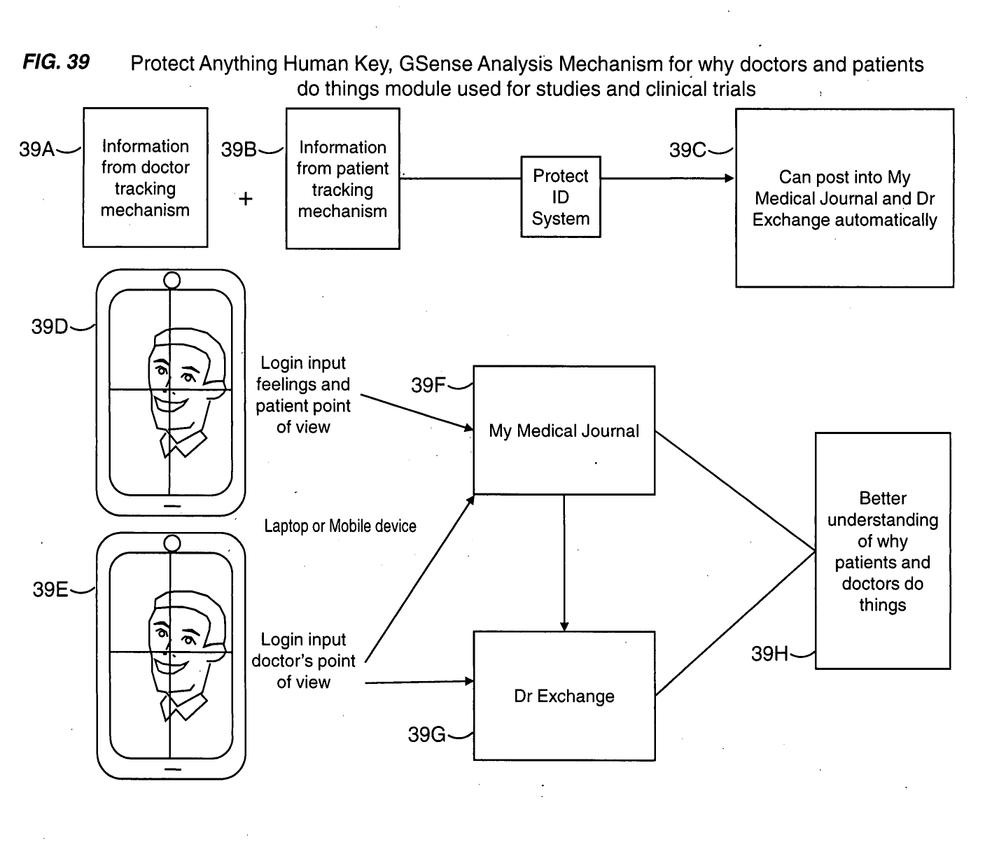

FIG. 39-39A describes Protect Anything Human Key and GSense Analysis Mechanism for why doctors and patients do things model used for studies and clinical trials and shows information from doctor tracking mechanism.

FIG. 39-39B describes Protect Anything Human Key and GSense Analysis Mechanism for why doctors and patients do things model used for studies and clinical trials and shows information from patient tracking mechanism.

FIG. 39-39C describes Protect Anything Human Key and GSense Analysis Mechanism for why doctors and patients do things model used for studies and clinical trials and shows the protect ID system how you can post into My Medical Journal and DR Exchange automatically.

FIG. 39-39D describes Protect Anything Human Key and GSense Analysis Mechanism for why doctors and patients do things model used for studies and clinical trials and shows a mobile device with camera microphone crosshairs login input feelings in patient point of view.

FIG. 39-39E describes Protect Anything Human Key and GSense Analysis Mechanism for why doctors and patients do things model used for studies and clinical trials and shows a mobile device with camera microphone and crosshairs login input doctors point of view.

FIG. 39-39F describes Protect Anything Human Key and GSense Analysis Mechanism for why doctors and patients do things model used for studies and clinical trials and shows My Medical Journal.

FIG. 39-39G describes Protect Anything Human Key and GSense Analysis Mechanism for why doctors and patients do things model used for studies and clinical trials and shows The DR Exchange.

FIG. 39-39H describes Protect Anything Human Key and GSense Analysis Mechanism for why doctors and patients do things model used for studies and clinical trials and shows better understanding of why patients and doctors do things.

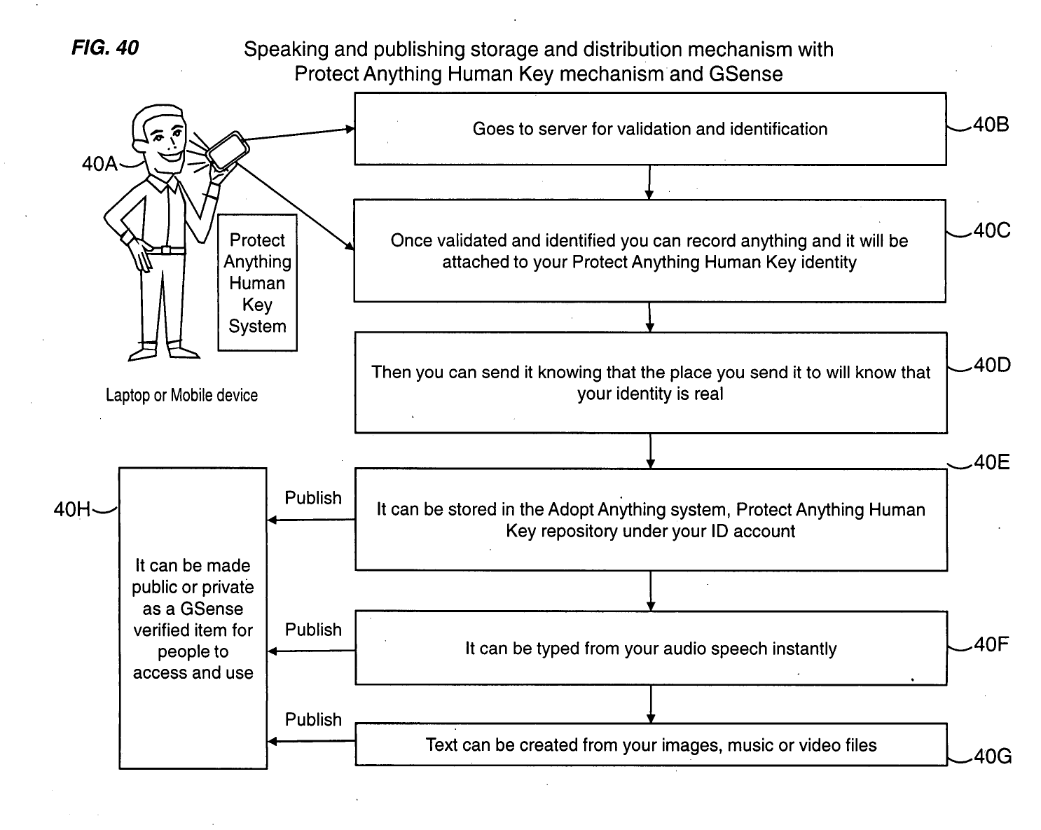

FIG. 40-40A describes speaking and publishing storage and distribution mechanism with Protect Anything Human Key Server Cloud and GSense Algorithm and shows a person speaking into their mobile device and accessing protect ID system.

FIG. 40-40B describes speaking and publishing storage and distribution mechanism with Protect Anything Human Key Server Cloud and GSense Algorithm and shows goes to server for validation and identification.

FIG. 40-40C describes speaking and publishing storage and distribution mechanism with Protect Anything Human Key Server Cloud and GSense Algorithm and shows once validated and identified you can record anything that will be attached to Protect Anything Human Key identity.

FIG. 40-40D describes speaking and publishing storage and distribution mechanism with Protect Anything Human Key Server Cloud and GSense Algorithm and shows then you can send it knowing that the place descended to will know that your identity is real.

FIG. 40-40E describes speaking and publishing storage and distribution mechanism with Protect Anything Human Key Server Cloud and GSense Algorithm and shows it can be stored in the Adopt Anything campaign or any campaign system, and the Protect Anything Human Key repository under your ID account in the published through publish anything or license anything.

FIG. 40-40F describes speaking and publishing storage and distribution mechanism with Protect Anything Human Key Server Cloud and GSense Algorithm and shows you can be typed from your audio speech instantly and then published.

FIG. 40-40G describes speaking and publishing storage and distribution mechanism with Protect Anything Human Key Server Cloud and GSense Algorithm and shows text can be created from your images, music or video files and then published.

FIG. 40-40H describes speaking and publishing storage and distribution mechanism with Protect Anything Human Key Server Cloud and GSense Algorithm and shows it can be made public or private as a GSense verified item for people to access and use that relevant times and places.

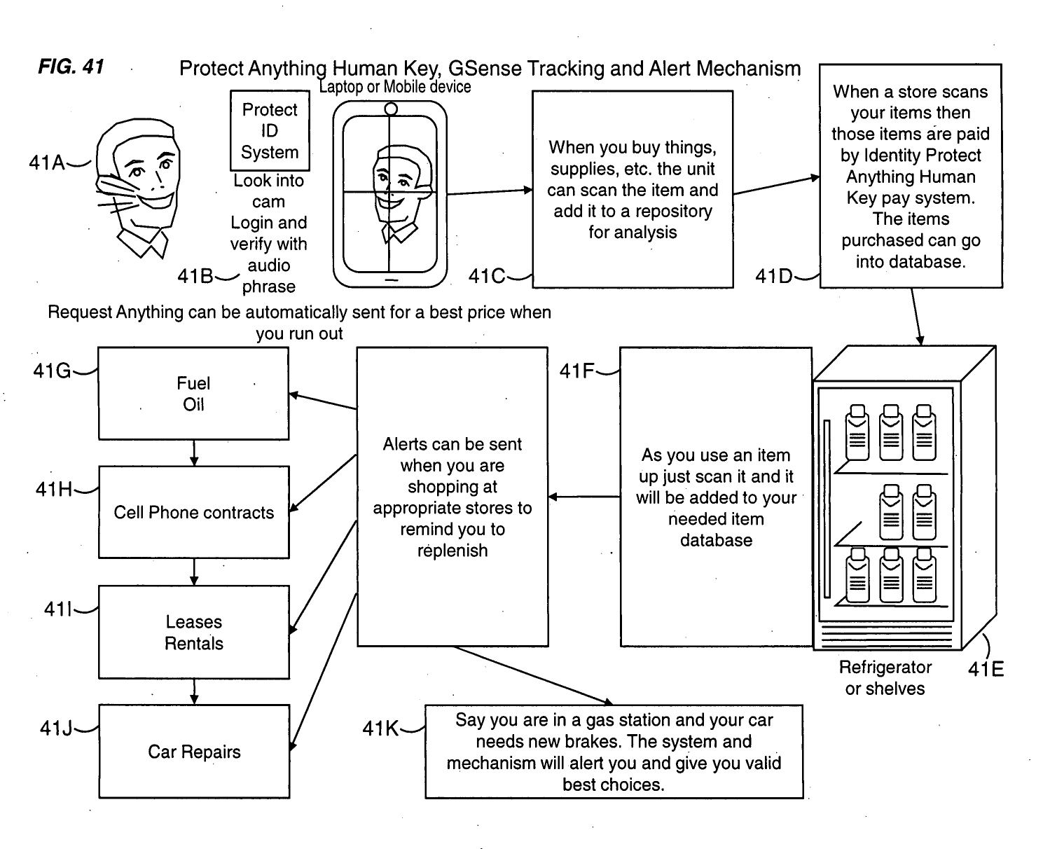

FIG. 41-41A describes Protect Anything Human Key, GSense tracking and Alert mechanism and shows a person speaking into the Protect Anything Human Key ID system.

FIG. 41-41B describes Protect Anything Human Key, GSense tracking and Alert mechanism and shows the mobile cam and microphone crosshairs were you looking to cam login and verify with audio phrase.

FIG. 41-41C describes Protect Anything Human Key, GSense tracking and Alert mechanism and shows when you, institutions hospitals restaurants big stores groups people's together making purchases and sales of anything buy things supplies, etc. the unit can scanned the item and added to a repository for analysis.

FIG. 41-41D describes Protect Anything Human Key, GSense tracking and Alert mechanism and shows the store scanned your items and designs are paid by the identification Protect Anything Human Key pay system the items purchase can go into database for recognition.

FIG. 41-41E describes Protect Anything Human Key, GSense tracking and Alert mechanism and shows products and store on shelves or in the refrigerator or on shelves at home.

FIG. 41-41F describes Protect Anything Human Key, GSense tracking and Alert mechanism and shows as you use an item up just scan it and it will be added to your needed item database for later use alerts can be sent when you are shopping at appropriate stores to remind you to replenish.

FIG. 41-41G describes Protect Anything Human Key, GSense tracking and Alert mechanism and shows where things can be alerted like fuel oil.

FIG. 41-41H describes Protect Anything Human Key, GSense tracking and Alert mechanism and shows were things can be alerted like cell phone contracts.

FIG. 41-41I describes Protect Anything Human Key, GSense tracking and Alert mechanism and shows were things can be alerted like leases and rentals.

FIG. 41-41J describes Protect Anything Human Key, GSense tracking and Alert mechanism and shows where things can be alerted like car repairs.

FIG. 41-41K describes Protect Anything Human Key, GSense tracking and Alert mechanism and shows say you are in a gas station and or car needs new brakes the system and mechanism alert you and give you valid best choices.

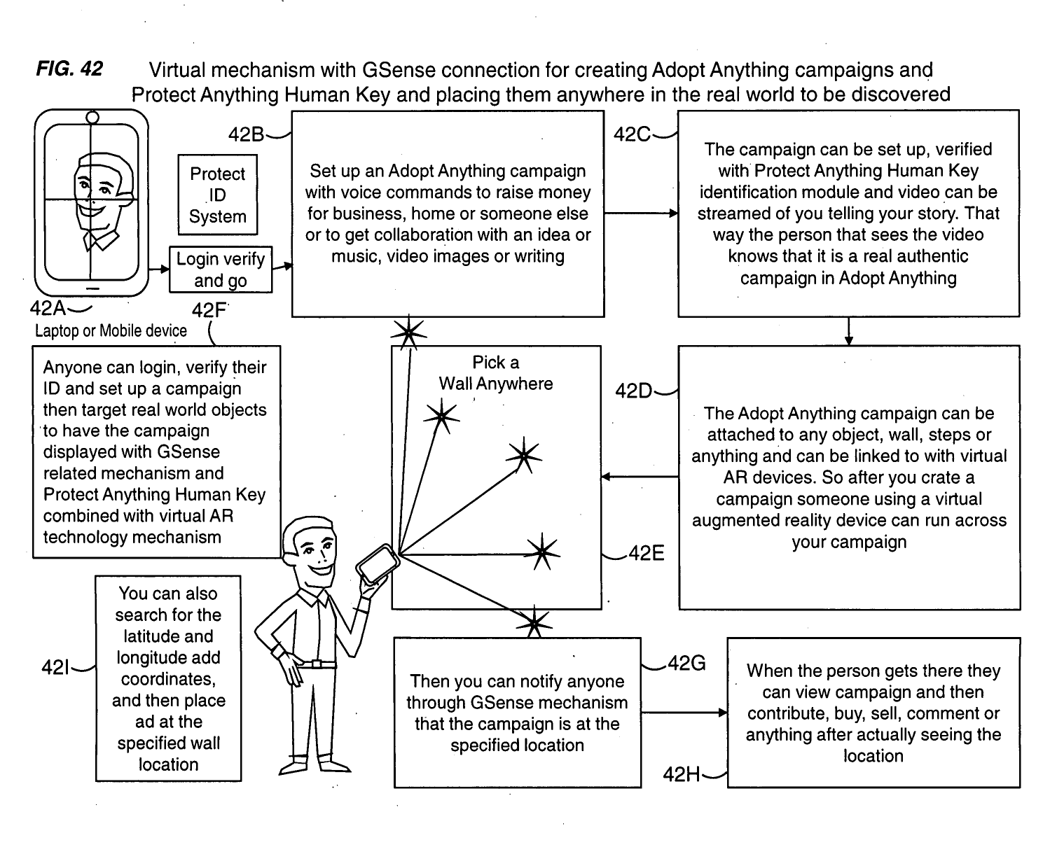

FIG. 42-42A describes Virtual mechanism with GSense connection for creating Ado[t Anything campaigns and Protect Anything Human Key Server Cloud and placing them anywhere in the real world to be discovered and shows a mobile device WebCam and microphone crosshairs used for the protect ID system.

FIG. 42-42B describes Virtual mechanism with GSense connection for creating Ado[t Anything campaigns and Protect Anything Human Key Server Cloud and placing them anywhere in the real world to be discovered and shows the login and verify and go set up and Adopt Anything campaign or any campaign with voice commands to raise money for business, home where someone else or to get collaboration with an idea or music, video, images or writing.

FIG. 42-42C describes Virtual mechanism with GSense connection for creating Ado[t Anything campaigns and Protect Anything Human Key Server Cloud and placing them anywhere in the real world to be discovered and shows the campaign can be set up verify with protected identification module video can be streamed of you telling us your story that would a person that sees to video knows that it is a real authentic campaign in Adopt Anything campaign or any campaign.

FIG. 42-42D describes Virtual mechanism with GSense connection for creating Ado[t Anything campaigns and Protect Anything Human Key Server Cloud and placing them anywhere in the real world to be discovered and shows the Adopt Anything campaign or any campaign can be attached to any object, all, steps or anything and can be linked to with virtual augmented reality devices or mobile phones laptops goggles glasses so after you create a campaign someone using a virtual augmented reality device can run across your campaign.

FIG. 42-42E describes Virtual mechanism with GSense connection for creating Ado[t Anything campaigns and Protect Anything Human Key Server Cloud and placing them anywhere in the real world to be discovered and shows where you can pick a wall anywhere and lock into any specific spatial point.

FIG. 42-42F describes Virtual mechanism with GSense connection for creating Ado[t Anything campaigns and Protect Anything Human Key Server Cloud and placing them anywhere in the real world to be discovered and shows anyone can login, verify their ID and set up a campaign then target real world objects to have the campaign displayed with GSense related mechanism and Protect Anything Human Key combined with virtual augmented reality technology mechanism.

FIG. 42-42G describes Virtual mechanism with GSense connection for creating Ado[t Anything campaigns and Protect Anything Human Key Server Cloud and placing them anywhere in the real world to be discovered and shows then you can notify anyone through GSense mechanism that the campaign is at the specified location.

FIG. 42-42H describes Virtual mechanism with GSense connection for creating Ado[t Anything campaigns and Protect Anything Human Key Server Cloud and placing them anywhere in the real world to be discovered and shows when the person gets fair they can do campaign and then contribute, buy, sell, comment or anything after actually seeing the location.

FIG. 42-42I describes Virtual mechanism with GSense connection for creating Ado[t Anything campaigns and Protect Anything Human Key Server Cloud and placing them anywhere in the real world to be discovered and shows you can also search for the latitude and longitude added coordinates, and then place add at the specified wall location.

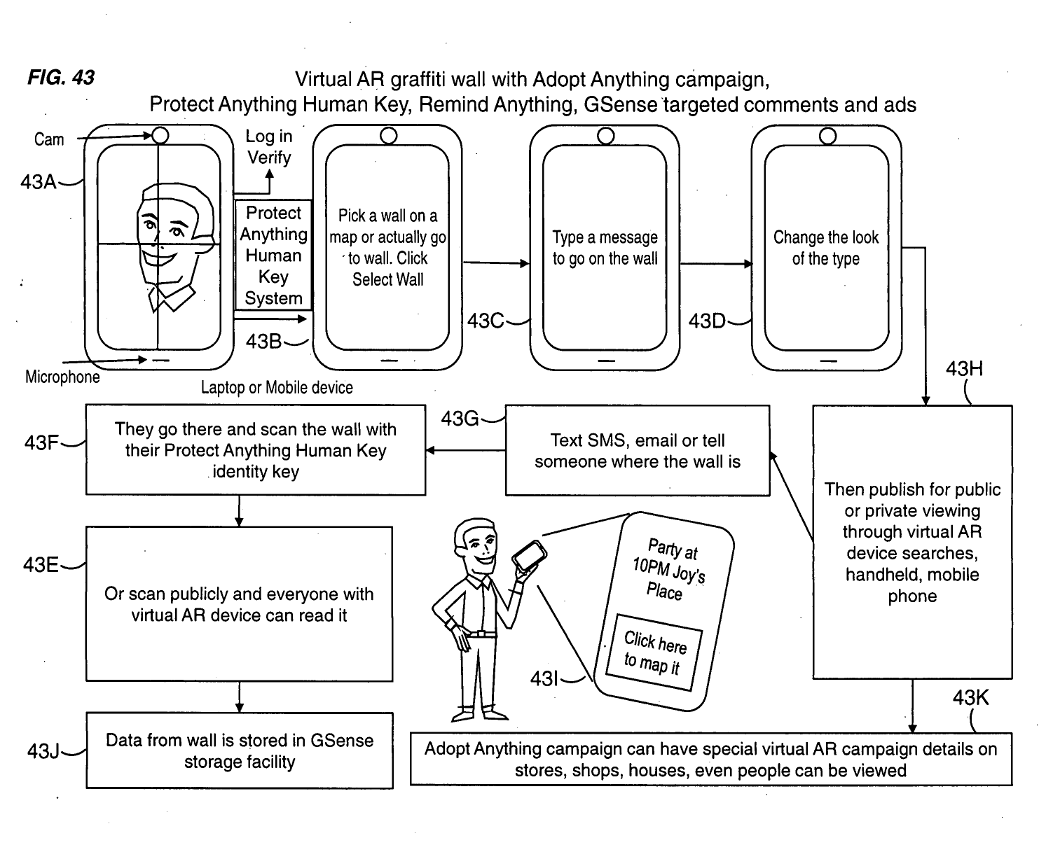

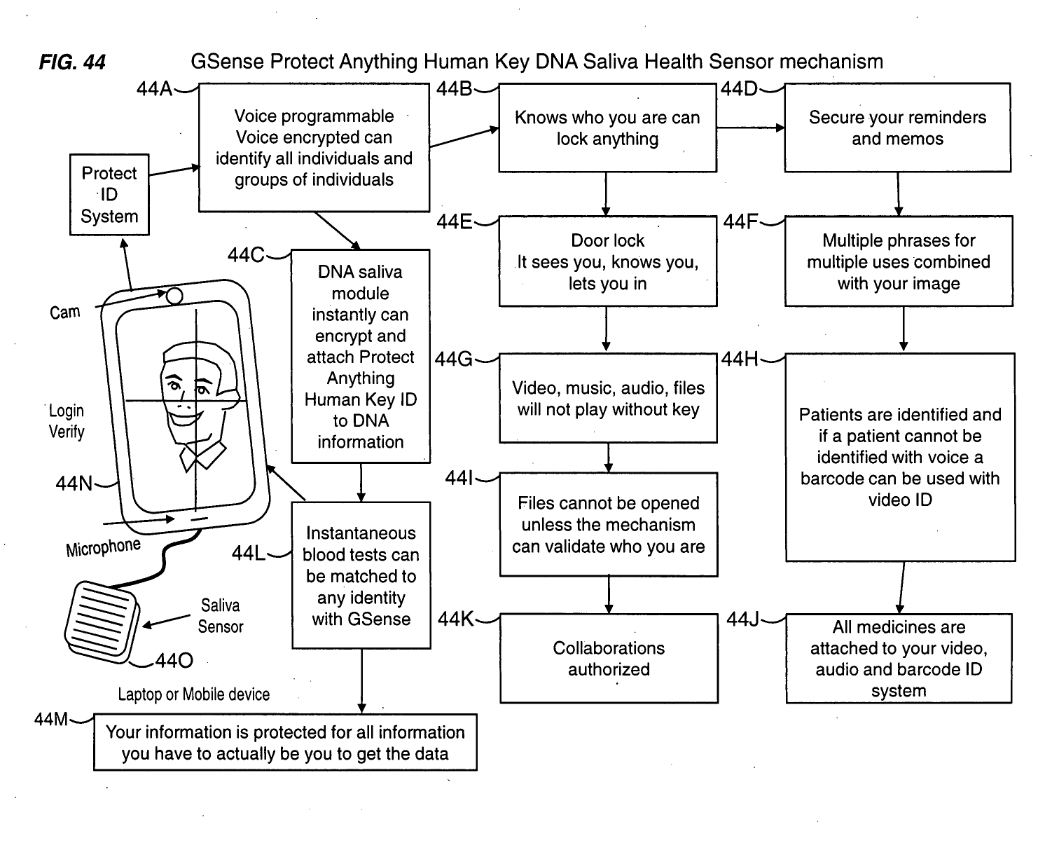

FIG. 43-43A describes Virtual AR graffiti wall with Adopt Anything campaign or any campaign Protect Anything Human Key, Remind Anything, and GSense targeted comments and advertisements and shows mobile device with cam and microphone with crosshair protection login and verify feature.

FIG. 43-43B describes Virtual AR graffiti wall with Adopt Anything campaign or any campaign Protect Anything Human Key, Remind Anything, and GSense targeted comments and advertisements and shows after being identified with the protect id system, then you can pick a wall on a map or actually go to the wall and aim your mobile device and select a spatial point on the wall and click select and lock.

FIG. 43-43C describes Virtual AR graffiti wall with Adopt Anything campaign or any campaign Protect Anything Human Key, Remind Anything, and GSense targeted comments and advertisements and shows type a message, upload a file, attach a video, or a music file, or virtual AR file to go on and be broadcast on the wall at the selected spatial point target on the wall, ceiling or floor or anywhere.

FIG. 43-43D describes Virtual AR graffiti wall with Adopt Anything campaign or any campaign Protect Anything Human Key, Remind Anything, and GSense targeted comments and advertisements and shows change the look of the type, the color, the size and how the type or files are displayed.

FIG. 43-43E describes Virtual AR graffiti wall with Adopt Anything campaign or any campaign Protect Anything Human Key, Remind Anything, and GSense targeted comments and advertisements and shows how you can scan publicly and everyone with virtual AR device can read it even with mobile device.

FIG. 43-43F describes Virtual AR graffiti wall with Adopt Anything campaign or any campaign Protect Anything Human Key, Remind Anything, and GSense targeted comments and advertisements and shows people go to the sp wall with their Protect Anything Human Key identity key and they see the broadcast message, or media.

FIG. 43-43G describes Virtual AR graffiti wall with Adopt Anything campaign or any campaign Protect Anything Human Key, Remind Anything, and GSense targeted comments and advertisements and shows the user can text, SMS, email or tell someone where the wall is to be able to read the message or see the media.

FIG. 43-43H describes Virtual AR graffiti wall with Adopt Anything campaign or any campaign Protect Anything Human Key, Remind Anything, and GSense targeted comments and advertisements and shows how one then publishes for public or private viewing through Virtual AR device searches, handheld, mobile device or phone, laptop, projection device.

FIG. 43-43I describes Virtual AR graffiti wall with Adopt Anything campaign or any campaign Protect Anything Human Key, Remind Anything, and GSense targeted comments and advertisements and shows party at 10 PM Joy's Place on wall next to or near Joy's place and the viewer can then click on the area button to map the directions.

FIG. 43-43J describes Virtual AR graffiti wall with Adopt Anything campaign or any campaign Protect Anything Human Key, Remind Anything, and GSense targeted comments and advertisements and shows Data from wall is stored in GSense storage facility server cloud and served only to the specific SP target at the time specified in the order setup by the publisher.

FIG. 43-43K describes Virtual AR graffiti wall with Adopt Anything campaign or any campaign Protect Anything Human Key, Remind Anything, and GSense targeted comments and advertisements and shows Adopt Anything campaign or any campaign or any advertisement or broadcast can have special Virtual AR campaign details on stores, shops, houses, even people can be viewed with SP targets set at specified times.

FIG. 44-44A describes Protect Anything Human Key security features and GSense applications and shows a voice programmable voice encrypted protect ID system and can identify all individuals and groups of individuals.

FIG. 44-44B describes Protect Anything Human Key security features and GSense applications and shows where the mechanism knows who you are and can lock anything or unlock anything.

FIG. 44-44C describes Protect Anything Human Key security features and GSense applications and shows the DNA sensor module that can test saliva instantly and encrypt and attach your Protect Anything Human Key ID to DNA information.

FIG. 44-44D describes Protect Anything Human Key security features and GSense applications and shows where you can secure your reminders and memos.

FIG. 44-44E describes Protect Anything Human Key security features and GSense applications and shows where the mechanism is a door lock it sees you, knows you, let's you in.

FIG. 44-44F describes Protect Anything Human Key security features and GSense applications and shows you can take multiple phrases for multiple uses combined with your video image.

FIG. 44-44G describes Protect Anything Human Key security features and GSense applications and shows video, music, audio, files will not play without your unique identification key.

FIG. 44-44H describes Protect Anything Human Key security features and GSense applications and shows patients are certified and identified and if the patient cannot be identified with voice due to unconscious or not responsive for voice a barcode can be used with video identification to eliminate hospital errors.

FIG. 44-44I describes Protect Anything Human Key security features and GSense applications and shows where files cannot be opened unless a mechanism can validate who you are identified as.

FIG. 44-44J describes Protect Anything Human Key security features and GSense applications and shows were all medicines are attached to your video, audio and barcode identification key.

FIG. 44-44K describes Protect Anything Human Key security features and GSense applications and shows were collaborations can be authorized and secure protected.

FIG. 44-44L describes Protect Anything Human Key security features and GSense applications and shows instantaneous blood tests can be matched to your identity.

FIG. 44-44M describes Protect Anything Human Key security features and GSense applications and shows where your information is protected for all information you have to actually be you to get the data.

FIG. 44-44N describes Protect Anything Human Key security features and GSense applications and shows a mobile device with cam and microphone with login and verify with crosshairs to the protect ID system.

FIG. 44-44O describes Protect Anything Human Key security features and GSense applications and shows the saliva sensor and chemical vapor analyzer connected to the mobile device or laptop.

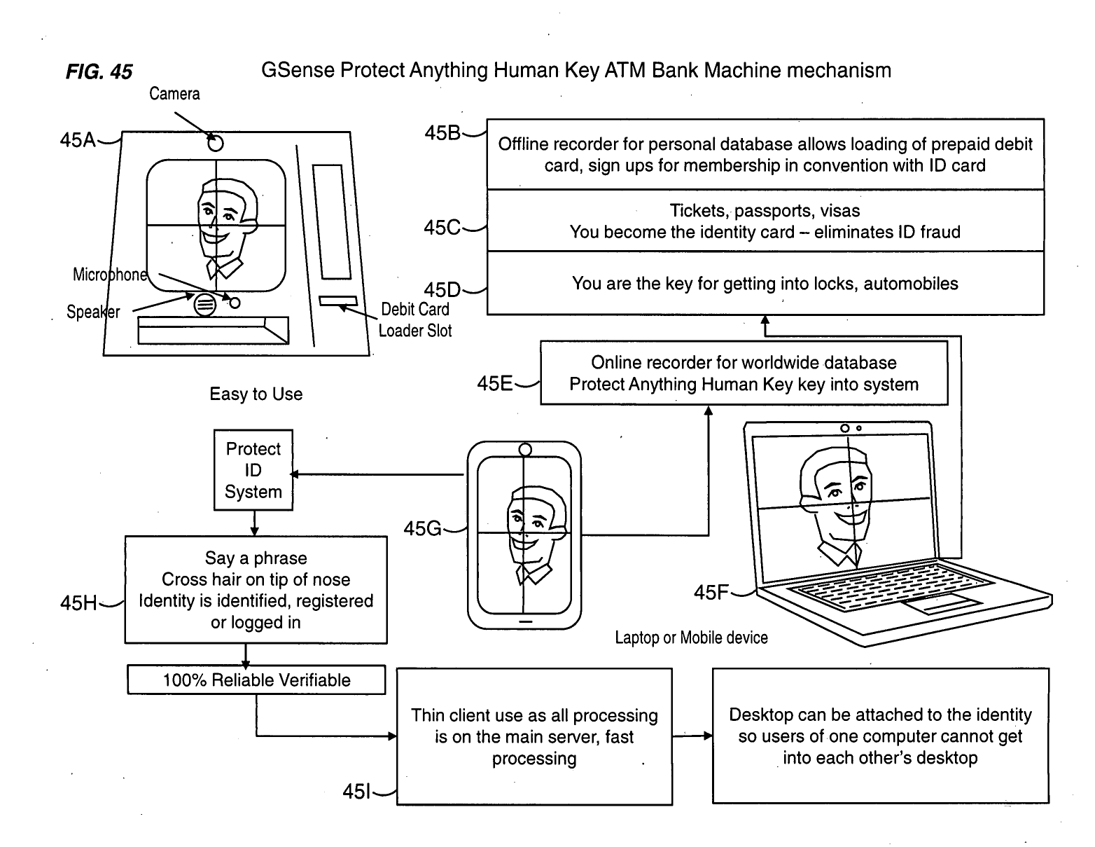

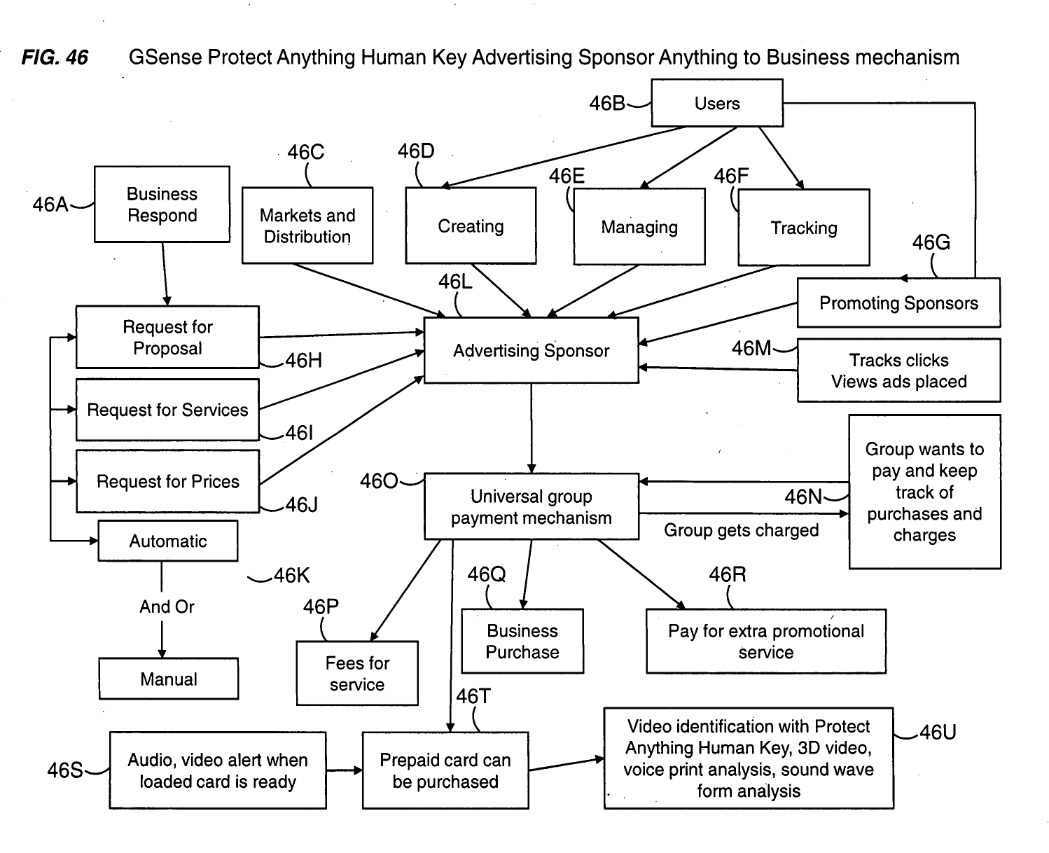

FIG. 45-45A describes multiple uses for ATM connection to Protect Anything Human Key Server Cloud and GSense and shows ATM camera microphone and speaker debit cards loader slot.

FIG. 45-45B describes Multiple uses for ATM connection to Protect Anything Human Key Server Cloud and GSense and shows off line recorder for personal database allows loading a prepaid debit card, sign-ups for membership in convention with ID card.

FIG. 45-45C describes Multiple uses for ATM connection to Protect Anything Human Key Server Cloud and GSense and shows tickets, passport's, these is you become the identity card-eliminates ID fraud.

FIG. 45-45D describes Multiple uses for ATM connection to Protect Anything Human Key Server Cloud and GSense and shows you are the key to getting into locks, automobiles or anything.

FIG. 45-45E describes Multiple uses for ATM connection to Protect Anything Human Key Server Cloud and GSense and shows online recorder for worldwide database Protect Anything Human Key key into the system.

FIG. 45-45F describes Multiple uses for ATM connection to Protect Anything Human Key Server Cloud and GSense and shows a laptop with crosshair login ID screen.

FIG. 45-45G describes Multiple uses for ATM connection to Protect Anything Human Key Server Cloud and GSense and shows mobile device with crosshair login ID screen.

FIG. 45-45H describes Multiple uses for ATM connection to Protect Anything Human Key Server Cloud and GSense and shows in the protect ID mechanism say a phrase with crosshair onto the tip of your nose identity is identified, registered, or login.

FIG. 45-45I describes Multiple uses for ATM connection to Protect Anything Human Key Server Cloud and GSense and shows 100% reliable verifiable the thin client is used as all processing is on the main server, fast processing also the desktop can be attached to the identity so users one computer can I get into each other's desktop.

FIG. 46-46A describes Sponsor module & how credit cards are charged automatically with Advertising Sponsor Anything to Business Interface module with Protect Anything Human Key Server Cloud and GSense and shows where business users responds.

FIG. 46-46B describes Sponsor module & how credit cards are charged automatically with Advertising Sponsor Anything to Business Interface module with Protect Anything Human Key Server Cloud and GSense and shows users can do various things.

FIG. 46-46C describes Sponsor module & how credit cards are charged automatically with Advertising Sponsor Anything to Business Interface module with Protect Anything Human Key Server Cloud and GSense and shows users can market and distribute.

FIG. 46-46D describes Sponsor module & how credit cards are charged automatically with Advertising Sponsor Anything to Business Interface module with Protect Anything Human Key Server Cloud and GSense and shows users can create.

FIG. 46-46E describes Sponsor module & how credit cards are charged automatically with Advertising Sponsor Anything to Business Interface module with Protect Anything Human Key Server Cloud and GSense and shows users can manage.

FIG. 46-46F describes Sponsor module & how credit cards are charged automatically with Advertising Sponsor Anything to Business Interface module with Protect Anything Human Key Server Cloud and GSense and shows users can track.

FIG. 46-46G describes Sponsor module & how credit cards are charged automatically with Advertising Sponsor Anything to Business Interface module with Protect Anything Human Key Server Cloud and GSense and shows users can promote sponsors.

FIG. 46-46H describes Sponsor module & how credit cards are charged automatically with Advertising Sponsor Anything to Business Interface module with Protect Anything Human Key. Server Cloud and GSense and shows users can request for proposal.

FIG. 46-46I describes Sponsor module & how credit cards are charged automatically with Advertising Sponsor Anything to Business Interface module with Protect Anything Human Key Server Cloud and GSense and shows users can request for services.

FIG. 46-46J describes Sponsor module & how credit cards are charged automatically with Advertising Sponsor Anything to Business Interface module with Protect Anything Human Key Server Cloud and GSense and shows users can request for prices.

FIG. 46-46K describes Sponsor module & how credit cards are charged automatically with Advertising Sponsor Anything to Business Interface module with Protect Anything Human Key Server Cloud and GSense and shows the mechanism can be automatic.

FIG. 46-46L describes Sponsor module & how credit cards are charged automatically with Advertising Sponsor Anything to Business Interface module with Protect Anything Human Key Server Cloud and GSense and shows users can connect to advertising sponsors.

FIG. 46-46M describes Sponsor module & how credit cards are charged automatically with Advertising Sponsor Anything to Business Interface module with Protect Anything Human Key Server Cloud and GSense and shows tracks clicks be used in ads placed.

FIG. 46-46N describes Sponsor module & how credit cards are charged automatically with Advertising Sponsor Anything to Business Interface module with Protect Anything Human Key Server Cloud and GSense and shows group wants to pay and keep track of purchases and groups get charged charges.

FIG. 46-46O describes Sponsor module & how credit cards are charged automatically with Advertising Sponsor Anything to Business Interface module with Protect Anything Human Key Server Cloud and GSense and shows universal group payment mechanism for groups or individuals or institutions.

FIG. 46-46P describes Sponsor module & how credit cards are charged automatically with Advertising Sponsor Anything to Business Interface module with Protect Anything Human Key Server Cloud and GSense and shows fees for services.

FIG. 46-46Q describes Sponsor module & how credit cards are charged automatically with Advertising Sponsor Anything to Business Interface module with Protect Anything Human Key Server Cloud and GSense and shows business purchases.

FIG. 46-46R describes Sponsor module & how credit cards are charged automatically with Advertising Sponsor Anything to Business Interface module with Protect Anything Human Key Server Cloud and GSense and shows paid for extra promotional services.

FIG. 46-46S describes Sponsor module & how credit cards are charged automatically with Advertising Sponsor Anything to Business Interface module with Protect Anything Human Key Server Cloud and GSense and shows audio, video alert when loaded card is ready.

FIG. 46-46T describes Sponsor module & how credit cards are charged automatically with Advertising Sponsor Anything to Business Interface module with Protect Anything Human Key Server Cloud and GSense and shows prepaid card can be purchased.

FIG. 46-46U describes Sponsor module & how credit cards are charged automatically with Advertising Sponsor Anything to Business Interface module with Protect Anything Human Key Server Cloud and GSense and shows video identification with Protect Anything Human Key, 3-D video, voice print analysis, sound waveform analysis and GSense connection.

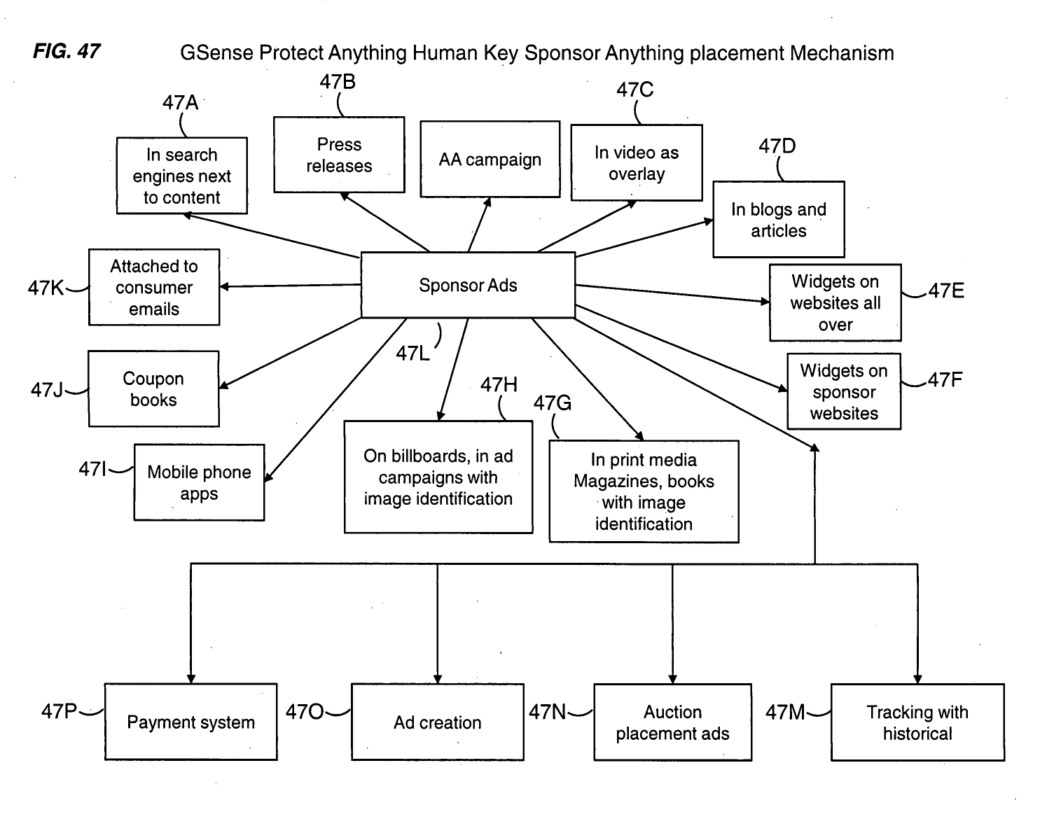

FIG. 47-47A describes how sponsor advertisements become content and what you can do with them with Protect Anything Human Key Server Cloud, file anything, protect and insure connected to GSense and shows Adopt Anything campaign or any campaign or independent sponsor ads in search engines next to content.

FIG. 47-47B describes how sponsor advertisements become content and what you can do with them with Protect Anything Human Key Server Cloud, file anything, protect and insure connected to GSense and shows Adopt Anything campaign or any campaign or independent sponsor ads in press releases.

FIG. 47-47C describes how sponsor advertisements become content and what you can do with them with Protect Anything Human Key Server Cloud, file anything, protect and insure connected to GSense and shows Adopt Anything campaign or any campaign or independent sponsor ads in video as overlay ads.

FIG. 47-47D describes how sponsor advertisements become content and what you can do with them with Protect Anything Human Key Server Cloud, file anything, protect and insure connected to GSense and Adopt Anything campaign or any campaign or independent sponsor ads in blogs and articles.

FIG. 47-47E describes how sponsor advertisements become content and what you can do with them with Protect Anything Human Key Server Cloud, file anything, protect and insure connected to GSense and Adopt Anything campaign or any campaign or independent sponsor ads in widgets on websites all over the web.

FIG. 47-47F describes how sponsor advertisements become content and what you can do with them with Protect Anything Human Key Server Cloud, file anything, protect and insure connected to GSense and Adopt Anything campaign or any campaign or independent sponsor ads in widgets on sponsored websites.

FIG. 47-47G describes how sponsor advertisements become content and what you can do with them with Protect Anything Human Key Server Cloud, file anything, protect and insure connected to GSense and Adopt Anything campaign or any campaign or independent sponsor ads in print media, magazines, books with images medication.

FIG. 47-47H describes how sponsor advertisements become content and what you can do with them with Protect Anything Human Key Server Cloud, file anything, protect and insure connected to GSense and Adopt Anything campaign or any campaign or independent sponsor ads in on billboards, in ad campaigns with images medication.

FIG. 47-47I describes how sponsor advertisements become content and what you can do with them with Protect Anything Human Key Server Cloud, file anything, protect and insure connected to GSense and Adopt Anything campaign or any campaign or independent sponsor ads in mobile phone applications.

FIG. 47-47J describes how sponsor advertisements become content and what you can do with them with Protect Anything Human Key Server Cloud, file anything, protect and insure connected to GSense and Adopt Anything campaign or any campaign or independent sponsor ads in coupon books.

FIG. 47-47K describes how sponsor advertisements become content and what you can do with them with Protect Anything Human Key Server Cloud, file anything, protect and insure connected to GSense and Adopt Anything campaign or any campaign or independent sponsor ads in attach to consumer e-mails.

FIG. 47-47L describes how sponsor advertisements become content and what you can do with them with Protect Anything Human Key Server Cloud, file anything, protect and insure connected to GSense and Adopt Anything campaign or any campaign or independent sponsor ads in sponsor ads.

FIG. 47-47M describes how sponsor advertisements become content and what you can do with them with Protect Anything Human Key Server Cloud, file anything, protect and insure connected to GSense and Adopt Anything campaign or any campaign or independent sponsor ads in tracking with historical data systems.

FIG. 47-47N describes how sponsor advertisements become content and what you can do with them with Protect Anything Human Key Server Cloud, file anything, protect and insure connected to GSense and Adopt Anything campaign or any campaign or independent sponsor ads in auction placement ads.

FIG. 47-47O describes how sponsor advertisements become content and what you can do with them with Protect Anything Human Key Server Cloud, file anything, protect and insure connected to GSense and Adopt Anything campaign or any campaign or independent sponsor ads in ad creations mechanisms.

FIG. 47-47P describes how sponsor advertisements become content and what you can do with them with Protect Anything Human Key Server Cloud, file anything, protect and insure connected to GSense and Adopt Anything campaign or any campaign or independent sponsor ads in payment systems interfaces.

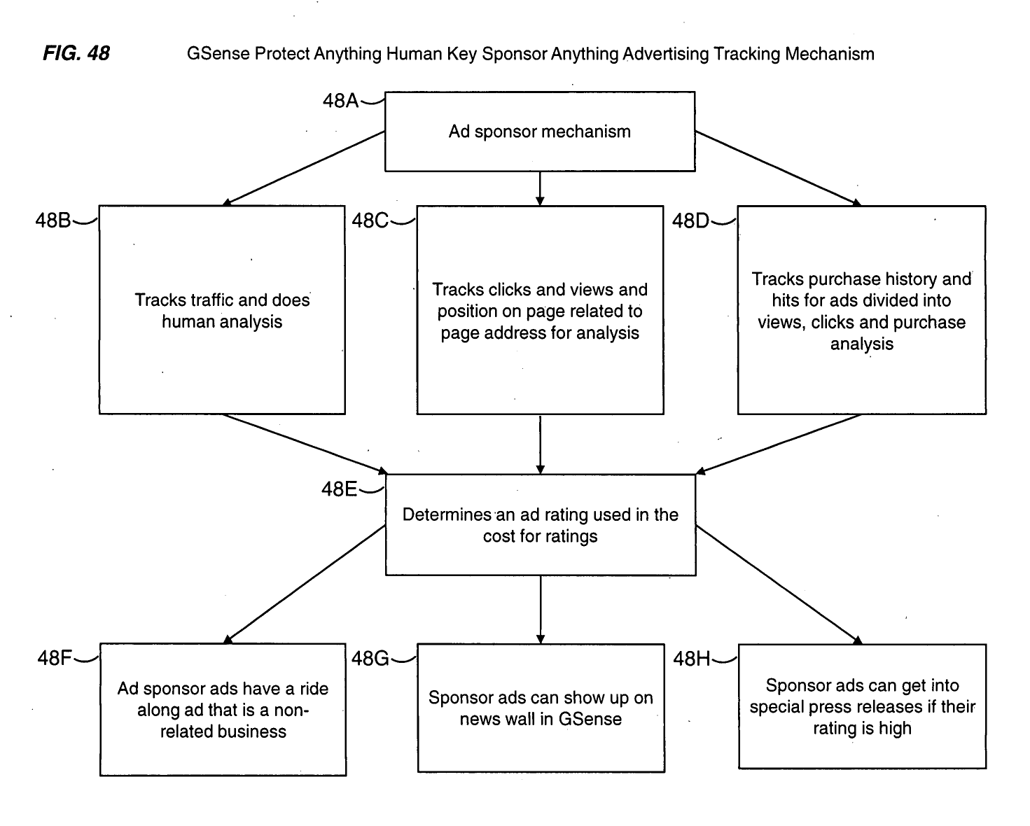

FIG. 48-48A describes the dashboard for ads and sponsors and how they track, where things go and costs system in Sponsor Anything connected to GSense and shows the ad sponsor mechanism.

FIG. 48-48B describes the dashboard for ads and sponsors and how they track, where things go and costs system in Sponsor Anything connected to GSense and shows tracks traffic and does human analysis.

FIG. 48-48C describes the dashboard for ads and sponsors and how they track, where things go and costs system in Sponsor Anything connected to GSense and shows tracks clicks and views and position on page related to page address for analysis.

FIG. 48-48D describes the dashboard for ads and sponsors and how they track, where things go and costs system in Sponsor Anything connected to GSense and shows tracks purchase history and hits for ads divided into use, clicks and purchase analysis.

FIG. 48-48E describes the dashboard for ads and sponsors and how they track, where things go and costs system in Sponsor Anything connected to GSense and shows determines and add rating used in the cost for ratings.

FIG. 48-48F describes the dashboard for ads and sponsors and how they track, where things go and costs system in Sponsor Anything connected to GSense and shows ad sponsor ads have a ride along advertisement that is a non-related business.

FIG. 48-48G describes the dashboard for ads and sponsors and how they track, where things go and costs system in Sponsor Anything connected to GSense and shows sponsor ads can show up on new walls with SP targets delivered by GSense information.

FIG. 48-48H describes the dashboard for ads and sponsors and how they track, where things go and costs system in Sponsor Anything connected to GSense and shows sponsor ads can get into special press releases if they are rating is high.

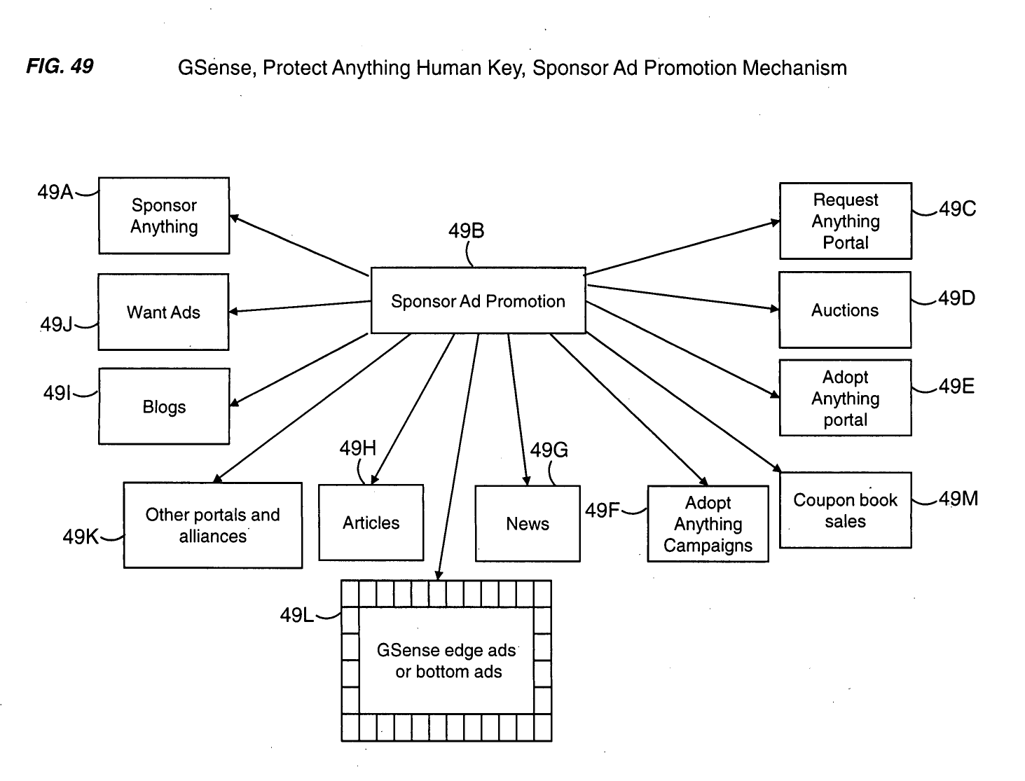

FIG. 49-49A describes GSense, Protect Anything Human Key, Sponsor Advertising Promotion mechanism and shows sponsor ad promotions through Sponsor Anything.

FIG. 49-49B describes GSense, Protect Anything Human Key, Sponsor Advertising Promotion mechanism and shows sponsor ad promotion mechanism.

FIG. 49-49C describes GSense, Protect Anything Human Key, Sponsor Advertising Promotion mechanism and shows sponsor ad promotion with Request Anything portal.

FIG. 49-49D describes GSense, Protect Anything Human Key, Sponsor Advertising Promotion mechanism and shows sponsor ad promotion with auctions.

FIG. 49-49E describes GSense, Protect Anything Human Key, Sponsor Advertising Promotion mechanism and shows sponsor ad promotions in the Adopt Anything campaign or any campaign portal.

FIG. 49-49F describes GSense, Protect Anything Human Key, Sponsor Advertising Promotion mechanism and shows sponsor ad promotion Adopt Anything campaign or any campaign.

FIG. 49-49G describes GSense, Protect Anything Human Key, Sponsor Advertising Promotion mechanism and shows sponsor ad promotion in news.

FIG. 49-49H describes GSense, Protect Anything Human Key, Sponsor Advertising Promotion mechanism and shows sponsor ad promotion articles.

FIG. 49-49I describes GSense, Protect Anything Human Key, Sponsor Advertising Promotion mechanism and shows sponsor ad promotion in blogs.

FIG. 49-49J describes GSense, Protect Anything Human Key, Sponsor Advertising Promotion mechanism and shows sponsor ad promotion in want ads.

FIG. 49-49K describes GSense, Protect Anything Human Key, Sponsor Advertising Promotion mechanism and shows sponsor ad promotions in other portals and alliances.

FIG. 49-49L describes GSense, Protect Anything Human Key, Sponsor Advertising Promotion mechanism and shows sponsor ad promotion in GSense edge ads or bottom advertisers.

FIG. 49-49M describes GSense, Protect Anything Human Key, Sponsor Advertising Promotion mechanism and shows sponsor and promotion a coupon book sales.

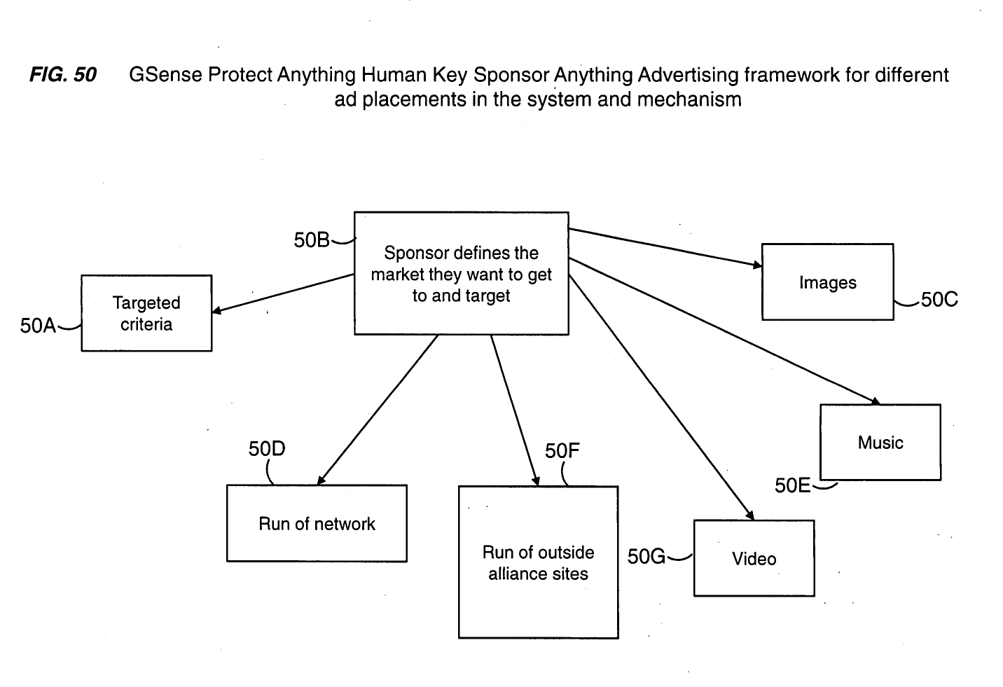

FIG. 50-50A describes Advertising framework for different ad placements in the system and mechanism with GSense and shows sponsor defines the targeted criteria they want their advertising to get to the.

FIG. 50-50B describes Advertising framework for different ad placements in the system and mechanism with GSense and shows sponsor defines the market they want to get to and target their advertising.

FIG. 50-50C describes Advertising framework for different ad placements in the system and mechanism with GSense and shows sponsor defines advertising targeted to images.

FIG. 50-50D describes Advertising framework for different ad placements in the system and mechanism with GSense and shows sponsor defines advertising targeted to run of the whole network.

FIG. 50-50E describes Advertising framework for different ad placements in the system and mechanism with GSense and shows sponsor defines advertising targeted to music.

FIG. 50-50F describes Advertising framework for different ad placements in the system and mechanism with GSense and shows sponsor defines advertising targeted to the run of outside alliance sites and partners.

FIG. 50-50G describes Advertising framework for different ad placements in the system and mechanism with GSense and shows sponsor defines advertising targeted to video.

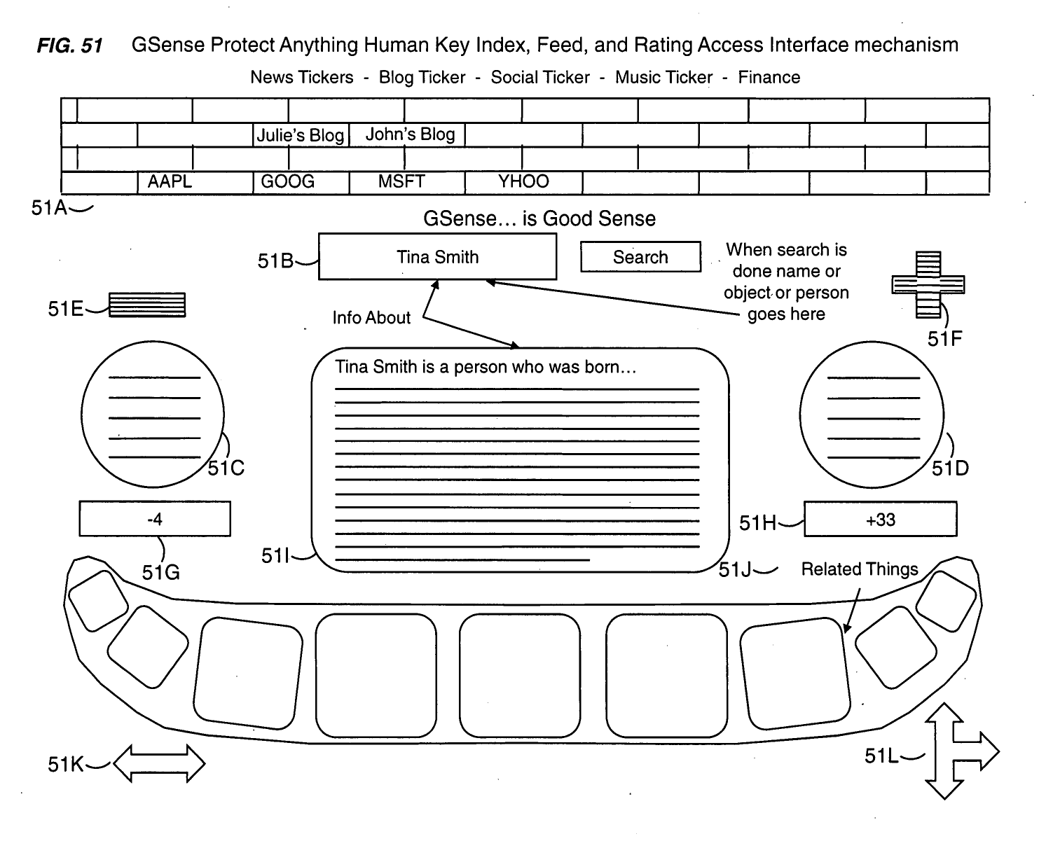

FIG. 51-51A describes user interface for GSense mechanism and shows scrolling news ticker, blog ticker, social ticker, music ticker, and finance ticker, plus blogs ticker, plus stock ticker scrolling across top.

FIG. 51-51B describes user interface for GSense mechanism and shows the search area search button.

FIG. 51-51C describes user interface for GSense mechanism and shows negative, comment area expanded with more detail.

FIG. 51-51D describes user interface for GSense mechanism and shows the positive content area expanded with more detail.

FIG. 51-51E describes user interface for GSense mechanism and shows big −.

FIG. 51-51F describes user interface for GSense mechanism and shows big +.

FIG. 51-51G describes user interface for GSense mechanism and shows number of negative comments.

FIG. 51-51H describes user interface for GSense mechanism and shows number of positive comments.

FIG. 51-51I describes user interface for GSense mechanism and shows expanded information from search and anything relevant pertaining to items searched in the form.

FIG. 51-51J describes user interface for GSense mechanism and shows related items to search topic can be advertisements, or personal information, Or Adopt Anything campaign or any campaign.

FIG. 51-51K describes user interface for GSense mechanism and shows special left or right arrow movement mechanism.

FIG. 51-51L describes user interface for GSense mechanism and shows special up or down or right movement mechanism.

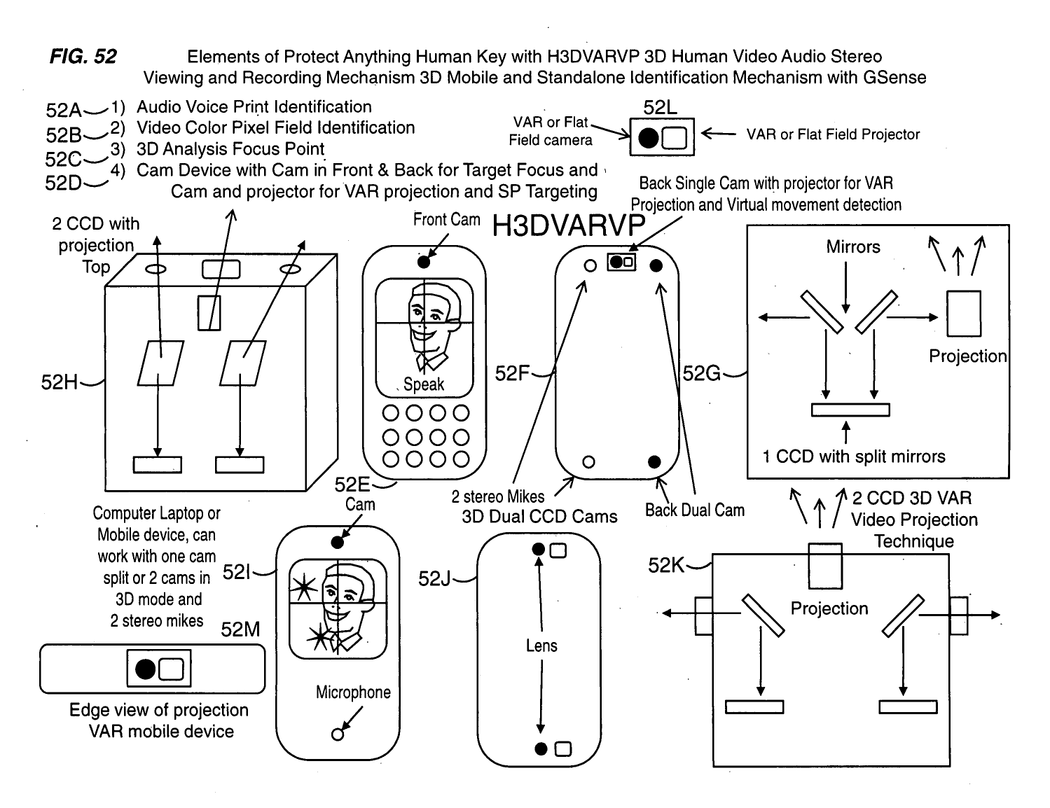

FIG. 52-52A describes elements of Protect Anything Human Key mobile and standalone identification mechanism with H3DVARV 3D Human Video Audio Stereo Viewing and Recording Mechanism with GSense Virtual AR 3D recording and projection and shows the audio voice print identification mechanism.

FIG. 52-52B describes elements of Protect Anything Human Key mobile and standalone identification mechanism with H3DVARV 3D Human Video Audio Stereo Viewing and Recording Mechanism and with GSense Virtual AR 3D recording and projection and shows the video color pixel field identification and video print identification mechanism.

FIG. 52-52C describes elements of Protect Anything Human Key mobile and standalone identification mechanism with H3DVARV 3D Human Video Audio Stereo Viewing and Recording Mechanism and with GSense Virtual AR 3D recording and projection and shows the 3-D analysis focus point mechanism.

FIG. 52-52D describes elements of Protect Anything Human Key mobile and standalone identification mechanism with H3DVARV 3D Human Video Audio Stereo Viewing and Recording Mechanism and with GSense Virtual AR 3D recording and projection and shows the cam device with cam in front and back for target focus.

FIG. 52-52E describes elements of Protect Anything Human Key mobile and standalone identification mechanism with H3DVARV 3D Human Video Audio Stereo Viewing and Recording Mechanism and with GSense Virtual AR 3D recording and projection and shows a mobile device with cam and microphone and crosshairs when you speak for identification.

FIG. 52-52F describes elements of Protect Anything Human Key mobile and standalone identification mechanism with H3DVARV 3D Human Video Audio Stereo Viewing and Recording Mechanism and with GSense Virtual AR 3D recording and projection and shows back of cam with cam and a projector Computer Laptop or Mobile device, can work with one cam split or 2 cams in 3D mode and 2 stereo mikes.

FIG. 52-52G describes elements of Protect Anything Human Key mobile and standalone identification mechanism with H3DVARV 3D Human Video Audio Stereo Viewing and Recording Mechanism and with GSense Virtual AR 3D recording and projection and shows one CCD with split mirrors mechanism and projection device.

FIG. 52-52H describes elements of Protect Anything Human Key mobile and standalone identification mechanism with H3DVARV 3D Human Video Audio Stereo Viewing and Recording Mechanism where and with GSense Virtual AR 3D recording and projection and shows 2 separate CCD with 2 separate mirrors and projector device.

FIG. 52-52I describes elements of Protect Anything Human Key mobile and standalone identification mechanism with H3DVARV 3D Human Video Audio Stereo Viewing and Recording Mechanism where and with GSense Virtual AR 3D recording and projection and shows front of mobile device with cam and microphone and crosshairs on screen with one cam in front for single cam identification mechanism.

FIG. 52-52J describes elements of Protect Anything Human Key mobile and standalone identification mechanism with H3DVARV 3D Human Video Audio Stereo Viewing and Recording Mechanism and with GSense Virtual AR 3D recording and projection and shows back of a mobile device with dual CCD cameras and dual projection lenses Computer Laptop or Mobile device, can work with one cam split or 2 cams in 3D mode and 2 stereo mikes.

FIG. 52-52K describes elements of Protect Anything Human Key mobile and standalone identification mechanism with H3DVARV 3D Human Video Audio Stereo Viewing and Recording Mechanism with GSense Virtual AR 3D recording and projection and shows 2 CCD 3-D video technique with projection mechanism.

FIG. 52-52L describes elements of Protect Anything Human Key mobile and standalone identification mechanism with H3DVARV 3D Human Video Audio Stereo Viewing and Recording Mechanism where with GSense Virtual AR 3D recording and projection and shows virtual augmented reality recording and projection unit in 3-D mechanism that can record 3D video audio combined with other 3D microphones and cameras or flat field recording and projection with one single cam.

FIG. 52-52M describes elements of Protect Anything Human Key mobile and standalone identification mechanism with H3DVARV 3D Human Video Audio Stereo Viewing and Recording Mechanism and with GSense Virtual AR 3D recording and projection and shows the GSense projection mobile device edge view mechanism.

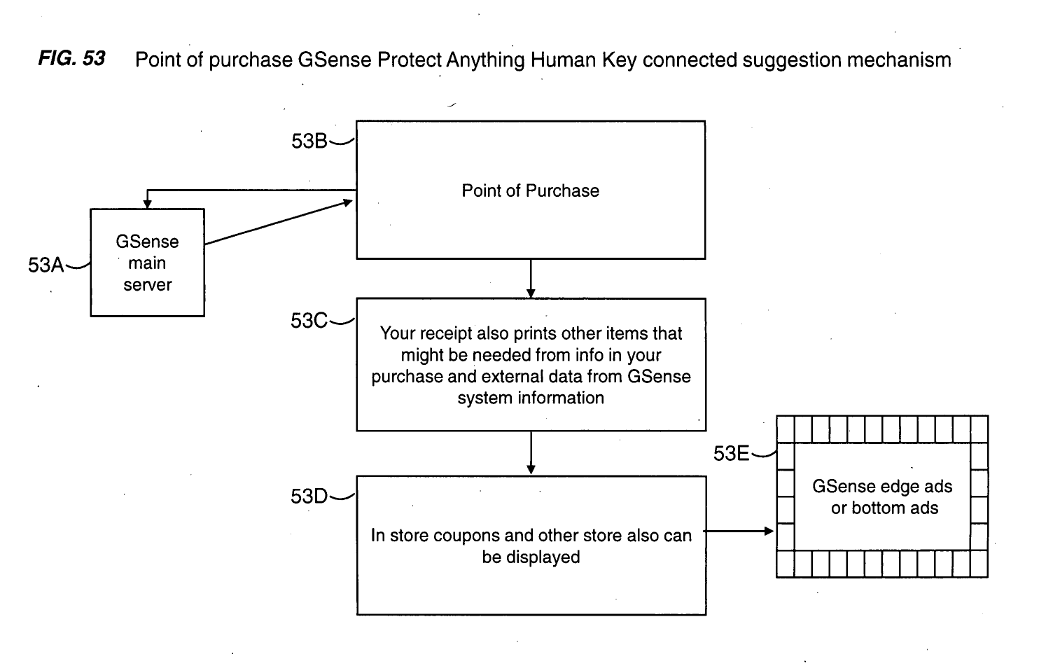

FIG. 53-53A describes point of purchase GSense connected suggestion mechanism and shows the GSense main server mechanism.

FIG. 53-53B describes point of purchase GSense connected suggestion mechanism and shows GSense main server to point-of-purchase.

FIG. 53-53C describes point of purchase GSense connected suggestion mechanism and shows GSense point-of-purchase where your receipt also prints other items that might be needed from info in your purchase an external data from GSense system information.

FIG. 53-53D describes point of purchase GSense connected suggestion mechanism and shows in-store coupons and other store also can be displayed.

FIG. 53-53E describes point of purchase GSense connected suggestion mechanism and shows GSense edge advertisements and/or bottom advertising mechanism.

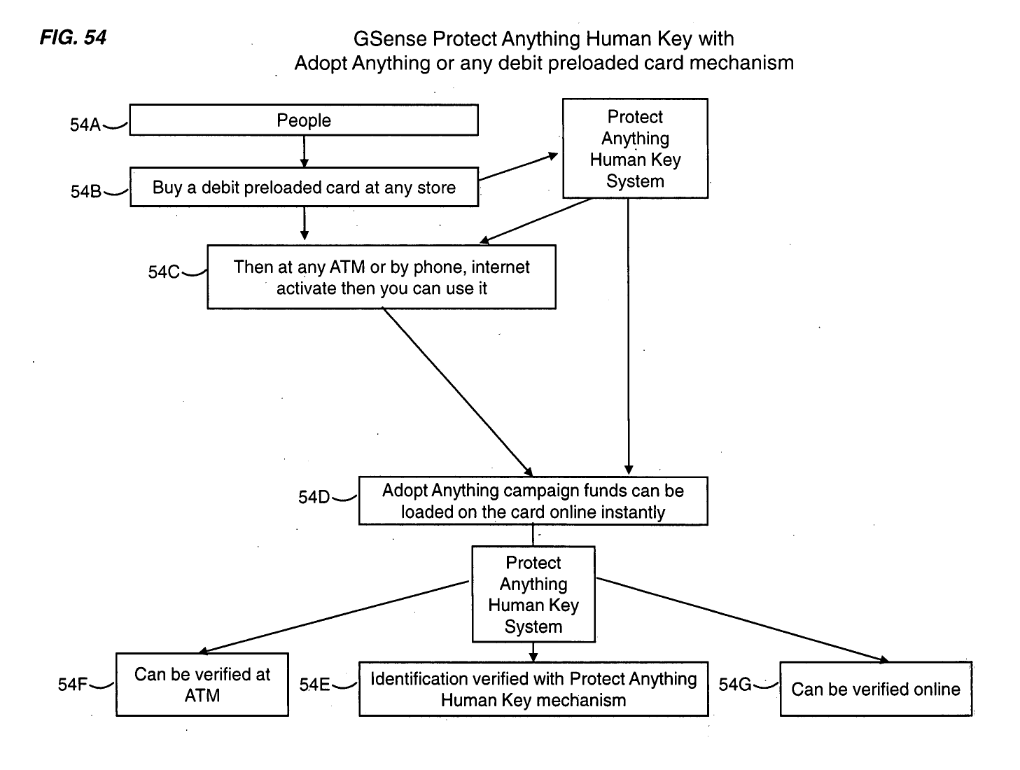

FIG. 54-54A describes Adopt Anything campaign or any campaign credit/debit preloaded card mechanism or mechanism through any other pay system with Protect Anything Human Key identification and GSense with Spatial points and shows people that can use Adopt Anything campaign or any campaign debit or credit card.

FIG. 54-54B describes Adopt Anything campaign or any campaign credit/debit preloaded card mechanism or mechanism through any other pay system with Protect Anything Human Key identification and GSense with Spatial points and shows they body a debit preloaded card at any store or get a credit card mail to them.

FIG. 54-54C describes Adopt Anything campaign or any campaign credit/debit preloaded card mechanism or mechanism through any other pay system with Protect Anything Human Key identification and GSense with Spatial points and shows then at any ATM or by phone, or Internet, you can activate load and then you can use it.

FIG. 54-54D describes Adopt Anything campaign or any campaign credit/debit preloaded card mechanism or mechanism through any other pay system with Protect Anything Human Key identification and GSense with Spatial points and shows to protect ID system is used and the Adopt Anything campaign or any campaign funds can be loaded on the card online instantly.

FIG. 54-54E describes Adopt Anything campaign or any campaign credit/debit preloaded card mechanism or mechanism through any other pay system with Protect Anything Human Key identification and GSense with Spatial points and shows the protect any system is used in identification is verified with Protect Anything Human Key mechanism.

FIG. 54-54F describes Adopt Anything campaign or any campaign credit/debit preloaded card mechanism or mechanism through any other pay system with Protect Anything Human Key identification and GSense with Spatial points and shows the protect ID system links into the ATM any bank and can be verified at that ATM.

FIG. 54-54G describes Adopt Anything campaign or any campaign credit/debit preloaded card mechanism or mechanism through any other pay system with Protect Anything Human Key identification and GSense with Spatial points and shows to protect a system can verify and can be verified online.

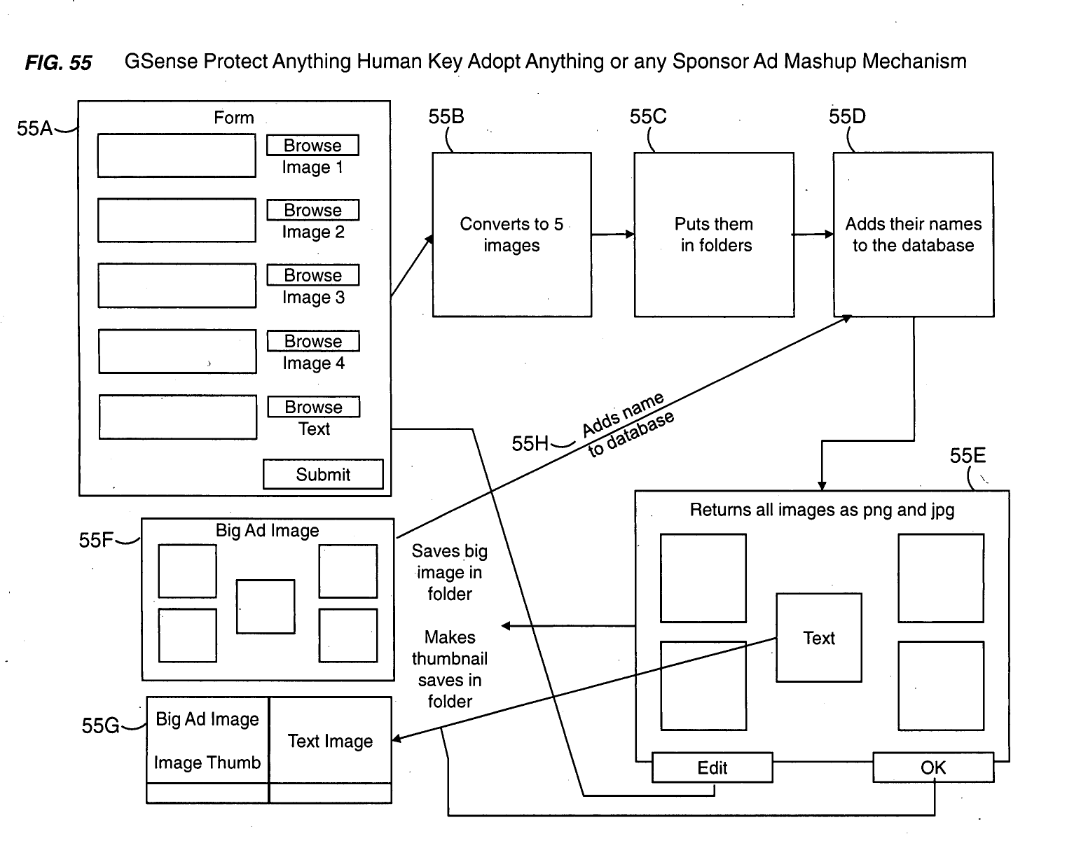

FIG. 55-55A describes how the Adopt Anything campaign or any campaign sponsor advertising mashup mechanism can be used for creating sponsor ads, and for collaboration utilizing Protect Anything Human Key and shows the image form to browse for image files or video files and to upload them with text and submit them altogether to the mashup mechanism.

FIG. 55-55B describes how the Adopt Anything campaign or any campaign sponsor advertising mashup mechanism can be used for creating sponsor ads, and for collaboration utilizing Protect Anything Human Key and shows converts to five images.

FIG. 55-55C describes how the Adopt Anything campaign or any campaign sponsor advertising mashup mechanism can be used for creating sponsor ads, and for collaboration utilizing Protect Anything Human Key and shows that puts them in folders.

FIG. 55-55D describes how the Adopt Anything campaign or any campaign sponsor advertising mashup mechanism can be used for creating sponsor ads, and for collaboration utilizing Protect Anything Human Key and shows then it ads their names into the database.

FIG. 55-55E describes how the Adopt Anything campaign or any campaign sponsor advertising mashup mechanism can be used for creating sponsor ads, and for collaboration utilizing Protect Anything Human Key and shows returns all images as PNG and JPEG files and makes a thumbnail image and saves big image in folder at this level you can also see the mashup and edited or say okay.

FIG. 55-55F describes how the Adopt Anything campaign or any campaign sponsor advertising mashup mechanism can be used for creating sponsor ads, and for collaboration utilizing Protect Anything Human Key and shows the big add image with the offer.

FIG. 55-55G describes how the Adopt Anything campaign or any campaign sponsor advertising mashup mechanism can be used for creating sponsor ads, and for collaboration utilizing Protect Anything Human Key and shows the small advertisement with big ad image and image thumbnail with text image.

FIG. 55-55H describes how the Adopt Anything campaign or any campaign sponsor advertising mashup mechanism can be used for creating sponsor ads, and for collaboration utilizing Protect Anything Human Key and shows how the mechanism adds the name of the images into the database.

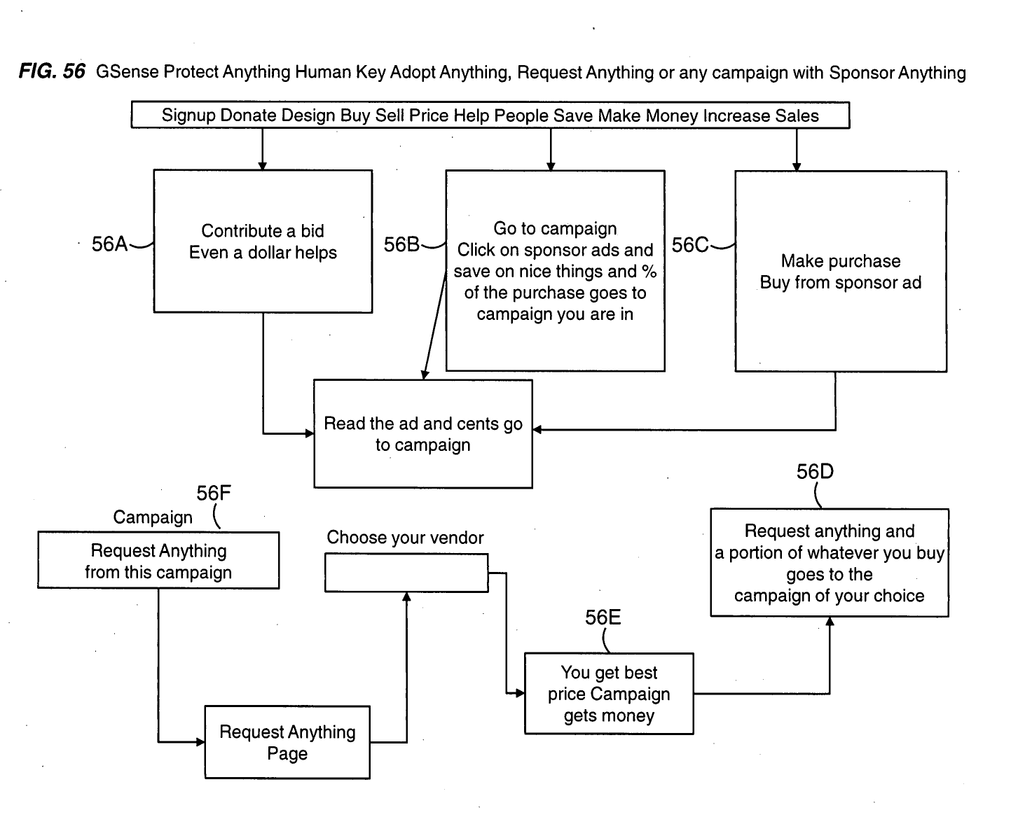

FIG. 56-56A describes how easy it is to start an Adopt Anything campaign or any campaign, Request Anything campaign or be a sponsor with GSense mechanism and shows the Sign up, donate, design, by sell, price, help, people save, or make money, increase sales you can contribute a bid in a dollar helps.

FIG. 56-56B describes how easy it is to start an Adopt Anything campaign or any campaign, Request Anything campaign or be a sponsor with GSense mechanism and shows how you can go to campaign click on sponsor ads and say what nice things or thing you need and they percentage of the purchase goes to the campaign you are interested in.

FIG. 56-56C describes how easy it is to start an Adopt Anything campaign or any campaign, Request Anything campaign or be a sponsor with GSense mechanism and shows how you make purchase or by from the sponsor and contributed to the campaign, you just read the advertisement and money goes to the campaign.

FIG. 56-56D describes how easy it is to start an Adopt Anything campaign or any campaign, Request Anything campaign or be a sponsor with GSense mechanism and shows Request Anything and a portion or whatever you purchase goes to the campaign of your choice.

FIG. 56-56E describes how easy it is to start an Adopt Anything campaign or any campaign, Request Anything campaign or be a sponsor with GSense mechanism and shows you give best price and get this price in the campaign gets money.

FIG. 56-56F describes how easy it is to start an Adopt Anything campaign or any campaign, Request Anything campaign or be a sponsor with GSense mechanism and shows campaign is connected to Request Anything when business becomes sponsor you simply go to the Request Anything page choose your vendor which are suggested vendors and businesses from the GSense business vendor engine.

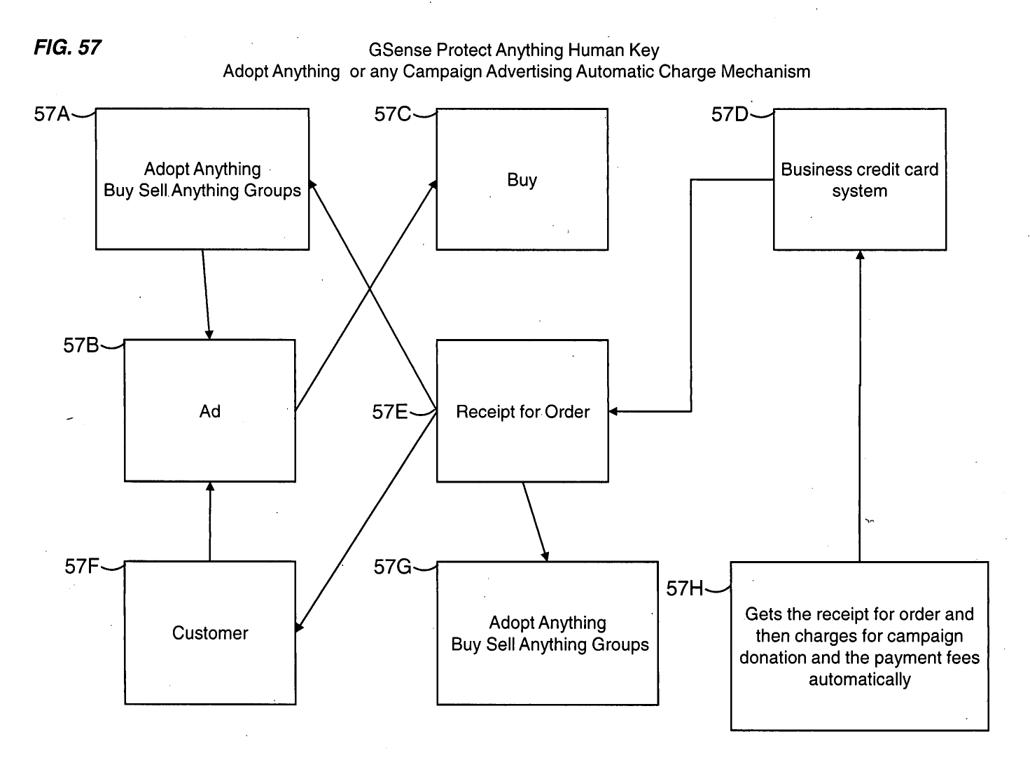

FIG. 57-57A describes how ad Sponsors and Request Anything members get a sale and Adopt Anything campaign or any campaign gets advertising commission revenue and shows Adopt Anything campaign or any campaign.

FIG. 57-57B describes how ad Sponsors and Request Anything members get a sale and Adopt Anything campaign or any campaign gets advertising commission revenue and shows the advertisement.

FIG. 57-57C describes how ad Sponsors and Request Anything members get a sale and Adopt Anything campaign or any campaign gets advertising commission revenue and shows advertisement purchase or buy.

FIG. 57-57D describes how ad Sponsors and Request Anything members get a sale and Adopt Anything campaign or any campaign gets advertising commission revenue and shows the connection to the business member credit card system.

FIG. 57-57E describes How Data is processed into intelligent data Remind Anything with Protect Anything Human Key Server Cloud and GSense Algorithm and shows when there is a receipt for an order and order is paid then system information is given for that order to Adopt Anything campaign or any campaign.

FIG. 57-57F describes how ad Sponsors and Request Anything members get a sale and Adopt Anything campaign or any campaign gets advertising commission revenue and shows customer who buys or uses services sponsors.

FIG. 57-57G describes how ad Sponsors and Request Anything members get a sale and Adopt Anything campaign or any campaign gets advertising commission revenue and shows Adopt Anything campaign or any campaign with a sponsor ads are placed in orders for businesses products and services are started from.

FIG. 57-57H describes how ad Sponsors and Request Anything members get a sale and Adopt Anything campaign or any campaign gets advertising commission revenue and shows Adopt Anything campaign or any campaign gets receipt for order and in charges for campaign donation and the payment fees automatically from the business card system.

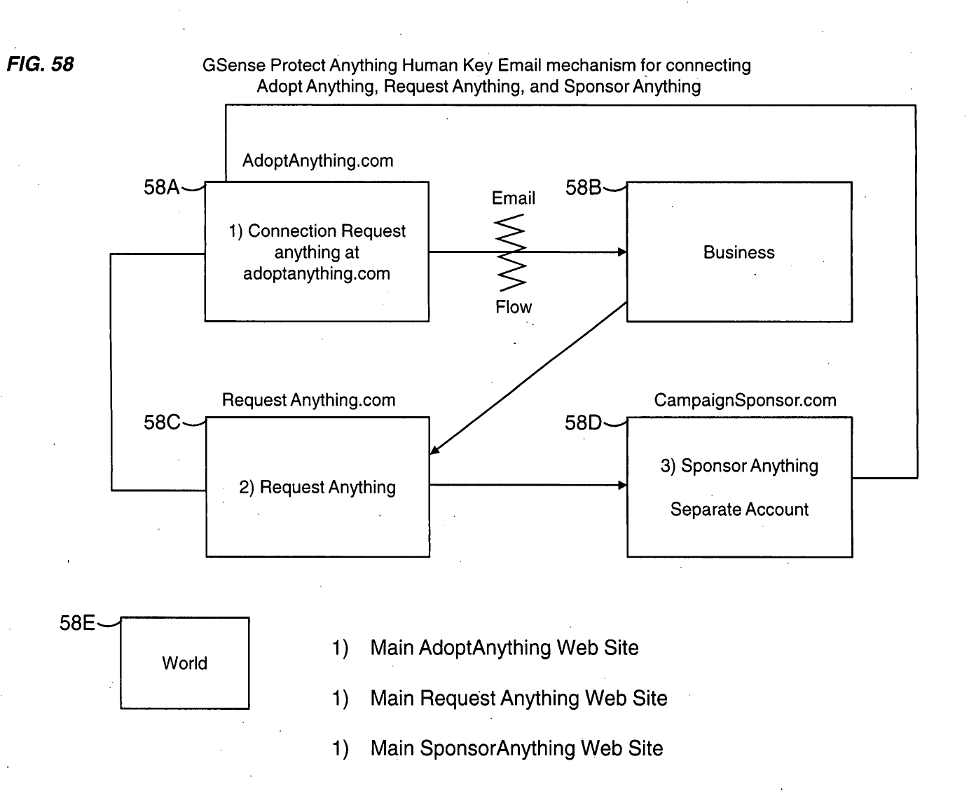

FIG. 58-58A describes how Adopt Anything campaign or any campaign, Request Anything, and Sponsor Anything mechanism work together and shows Adopt Anything campaign or any campaign.com with connection to Request Anything that adoptanything.com and through e-mail flow.

FIG. 58-58B describes how Adopt Anything campaign or any campaign, Request Anything, and Sponsor Anything work together and shows businesses and systems.

FIG. 58-58C describes how Adopt Anything campaign or any campaign, Request Anything, and Sponsor Anything work together and shows Request Anythinganything.com and Request Anything mechanism.

FIG. 58-58D describes how Adopt Anything campaign or any campaign, Request Anything, and Sponsor Anything work together and shows campaignsponsor.com and Sponsor Anything mechanism with separate account.

FIG. 58-58E describes how Adopt Anything campaign or any campaign, Request Anything, and Sponsor Anything work together and shows how all three mechanisms go to the world.

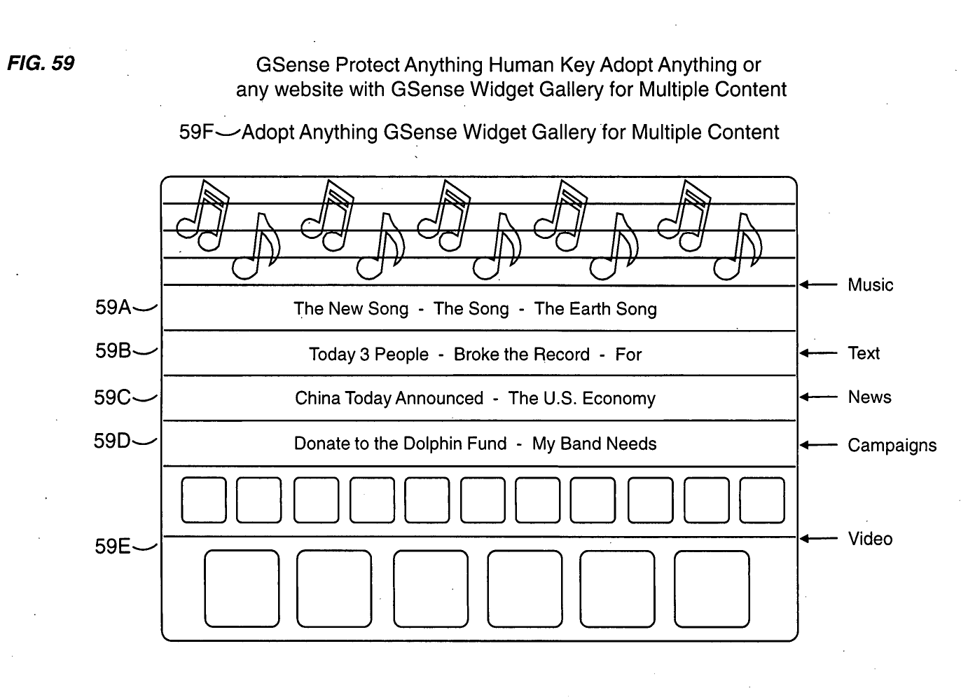

FIG. 59-59A describes Adopt Anything campaign or any campaign widgets, GSense widget gallery for multiple content and shows new songs and music in the scrolling music bar.

FIG. 59-59B describes Adopt Anything campaign or any campaign widgets, GSense widget gallery for multiple content and shows entertainment news text area scrolling text bar.

FIG. 59-59C describes Adopt Anything campaign or any campaign widgets, GSense widget gallery for multiple content and shows a dedicated news scrolling bar.

FIG. 59-59D describes Adopt Anything campaign or any campaign widgets, GSense widget gallery for multiple content and shows the Adopt Anything campaign or any campaign scrolling campaign bar.

FIG. 59-59E describes Adopt Anything campaign or any campaign widgets, GSense widget gallery for multiple content and shows the images scrolling and video content scrolling bar.

FIG. 59-59F describes Adopt Anything campaign or any campaign widgets, GSense widget gallery for multiple content and shows the Adopt Anything campaign or any campaign GSense widget gallery for multiple content can also include stock quotes a widget factory with universal payment platform where people make their own language widgets, widgets to widgets, special widgets tied to sponsorship and you can Request Anything any widget individually or collectively with others.

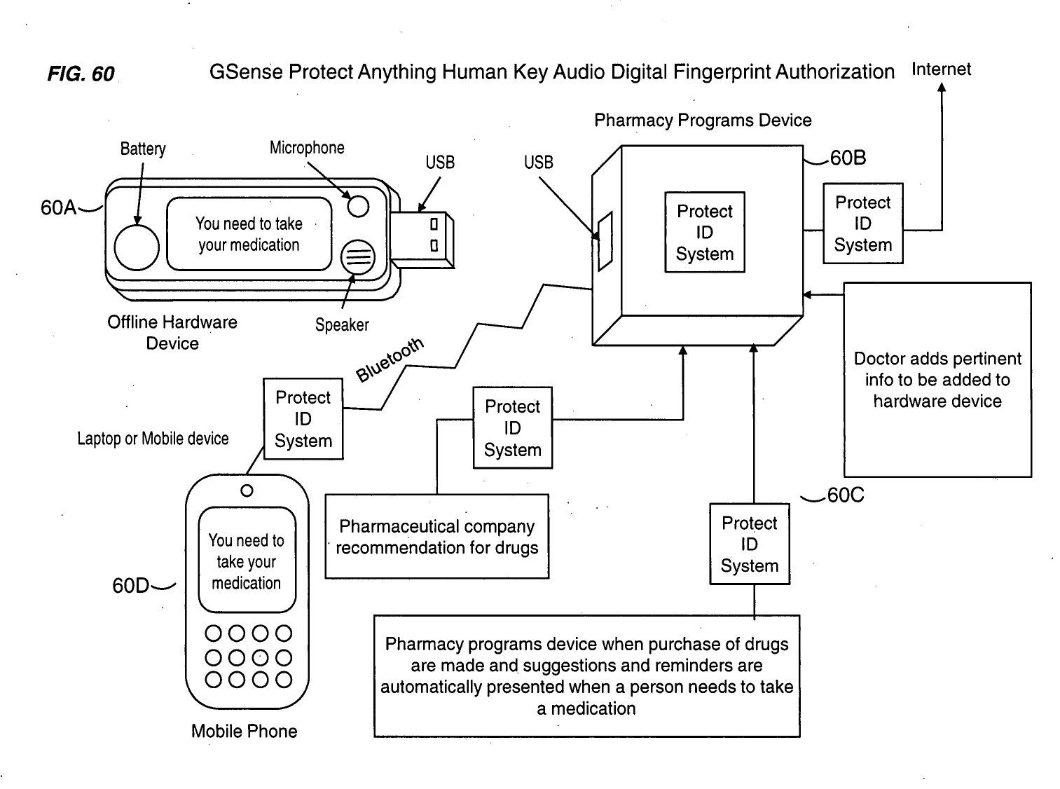

FIG. 60-60A describes how Data is processed into intelligent data Remind Anything with Protect Anything Human Key Server Cloud and GSense Algorithm and shows then off-line hardware device is battery microphone speaker USB connector and LED screen that can show a reminder that you need to take your medication this is a separate device with online capability that can connect to USB port of a computer or a special GSense connected pharmacy programs device.

FIG. 60-60B describes How Data is processed into intelligent data Remind Anything with Protect Anything Human Key Server Cloud and GSense Algorithm and shows the pharmacy programs device with the protect ID system for certification and identification connects to the Internet with the protect ID system encryption Dr. inputs pertinent information to be added to the off-line hardware device identified to you pharmaceutical company can add information about drugs and recommendations as new developments take place.

FIG. 60-60C describes How Data is processed into intelligent data Remind Anything with Protect Anything Human Key Server Cloud and GSense Algorithm and shows with protect ID system pharmacy programs device when purchase of drugs or may and suggestions reminders are automatically presented when a person needs to take a medication.

FIG. 60-60D describes How Data is processed into intelligent data Remind Anything with Protect Anything Human Key Server Cloud and GSense Algorithm and shows mobile phone with screen showing you need to take your medication can be wirelessly connected with protect ID system identification to the pharmacy programs device that is linked in to GSense and Protect Anything Human Key.

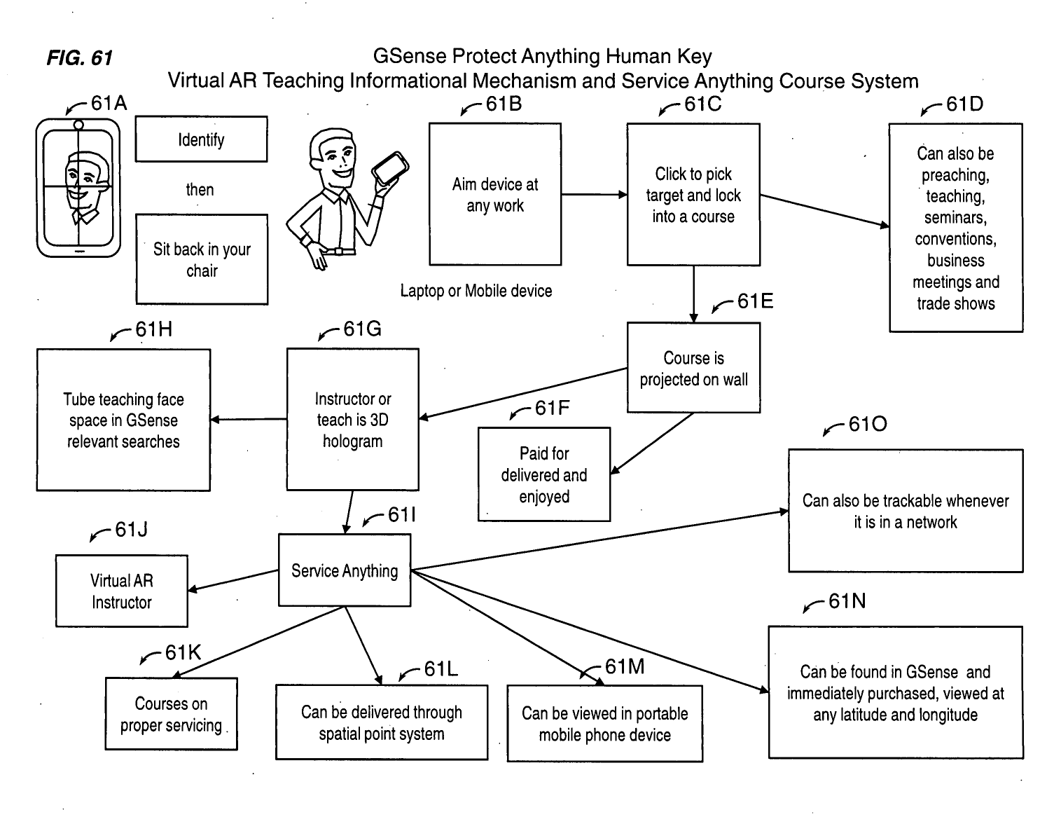

FIG. 61-61A describes Virtual Augmented reality teaching mechanism and service anything course system with Protect Anything Human Key Server Cloud and GSense Algorithm and shows mobile device with cam microphone and crosshair identification identifying then sit back in your chair.

FIG. 61-61B describes Virtual Augmented reality teaching mechanism and service anything course system with Protect Anything Human Key Server Cloud and GSense Algorithm and shows aim device at any wall.

FIG. 61-61C describes Virtual Augmented reality teaching mechanism and service anything course system with Protect Anything Human Key Server Cloud and GSense Algorithm and shows click to take target and lock into a course for learning.

FIG. 61-61D describes Virtual Augmented reality teaching mechanism and service anything course system with Protect Anything Human Key Server Cloud and GSense Algorithm and shows can also be preaching, teaching, seminars, conventions, business, meetings, and trade shows.

FIG. 61-61E describes Virtual Augmented reality teaching mechanism and service anything course system with Protect Anything Human Key Server Cloud and GSense Algorithm and shows course or instructions are projected on a wall.

FIG. 61-61F describes Virtual Augmented reality teaching mechanism and service anything course system with Protect Anything Human Key Server Cloud and GSense Algorithm and shows paid for and delivered enjoyed.

FIG. 61-61G describes Virtual Augmented reality teaching mechanism and service anything course system with Protect Anything Human Key Server Cloud and GSense Algorithm and shows instructor or teacher can show up as flat screen or three-dimensional holographic look.

FIG. 61-61H describes Virtual Augmented reality teaching mechanism and service anything course system with Protect Anything Human Key Server Cloud and GSense Algorithm and shows with GSense relevant searches anything in social networks or video networks can be shown.

FIG. 61-61I describes Virtual Augmented reality teaching mechanism and service anything course system with Protect Anything Human Key Server Cloud and GSense Algorithm and shows service anything connecting to other systems.

FIG. 61-61J describes Virtual Augmented reality teaching mechanism and service anything course system with Protect Anything Human Key Server Cloud and GSense Algorithm and shows where you can have virtual augmented reality is doctors or instructors.

FIG. 61-61K describes Virtual Augmented reality teaching mechanism and service anything course system with Protect Anything Human Key Server Cloud and GSense Algorithm and shows courses can be for proper servicing of devices machines or things around the home.

FIG. 61-61L describes Virtual Augmented reality teaching mechanism and service anything course system with Protect Anything Human Key Server Cloud and GSense Algorithm and shows can be delivered through special point technology targets.

FIG. 61-61M describes Virtual Augmented reality teaching mechanism and service anything course system with Protect Anything Human Key Server Cloud and GSense Algorithm and shows can be viewed in portable mobile phone devices.

FIG. 61-61N describes Virtual Augmented reality teaching mechanism and service anything course system with Protect Anything Human Key Server Cloud and GSense Algorithm and shows can be found in GSense and immediately purchased viewed at any longitude latitude specified.

FIG. 61-61O describes Virtual Augmented reality teaching mechanism and service anything course system with Protect Anything Human Key Server Cloud and GSense Algorithm and shows can also be trackable where it is in a network.

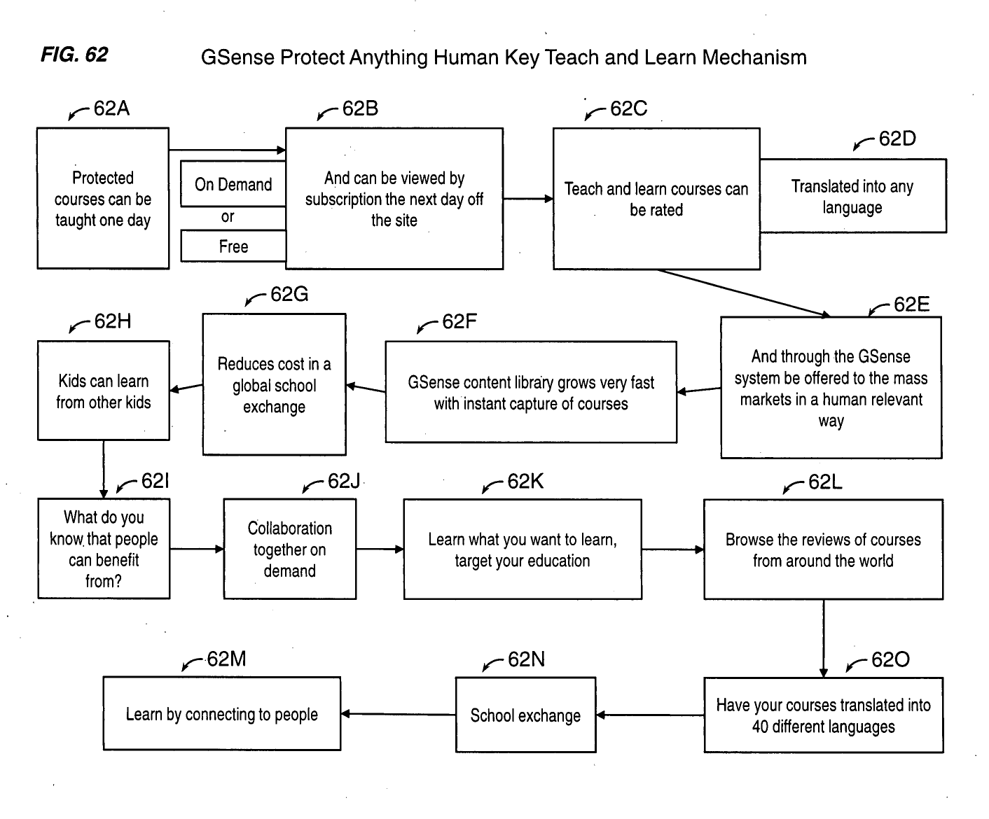

FIG. 62-62A describes GSense Teach and Learn mechanism and shows where protected courses can be created and taught in one day.

FIG. 62-62B describes GSense Teach and Learn mechanism and shows can be viewed by subscription the next day from the website paid for on-demand or free.

FIG. 62-62C describes GSense Teach and Learn mechanism and shows teach and learn courses can be rated.

FIG. 62-62D describes GSense Teach and Learn mechanism and shows courses can be translated into any language.

FIG. 62-62E describes GSense Teach and Learn mechanism and shows and through the GSense system be offered to the mass markets in a human relevant way.

FIG. 62-62F describes GSense Teach and Learn mechanism and shows GSense content library grows very fast with instant capture of courses.

FIG. 62-62G describes GSense Teach and Learn mechanism and shows how this reduces the cost in a global school exchange.

FIG. 62-62H describes GSense Teach and Learn mechanism and shows kids can learn from other kids.

FIG. 62-62I describes GSense Teach and Learn mechanism and shows the question that is asked is what do you know that people can benefit from.

FIG. 62-62J describes GSense Teach and Learn mechanism and shows collaboration together on demand.

FIG. 62-62K describes GSense Teach and Learn mechanism and shows how to learn what you want to learn target your education.

FIG. 62-62L describes GSense Teach and Learn mechanism and shows how you can browse the reviews of courses from around the world.

FIG. 62-62M describes GSense Teach and Learn mechanism and shows how you can learn by connecting to people from all over the world.

FIG. 62-62N describes GSense Teach and Learn mechanism and shows how the mechanism connects to the school exchange portal.

FIG. 62-62O describes GSense Teach and Learn mechanism and shows where you can have your courses translated into all languages.

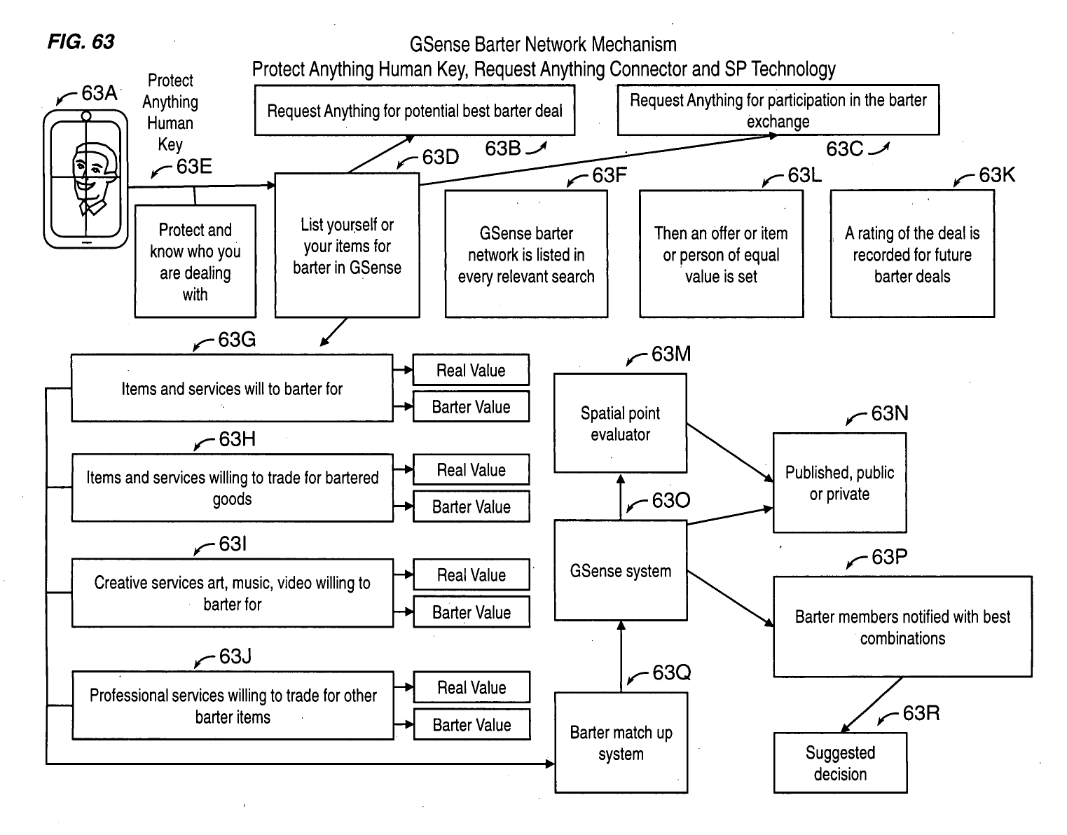

FIG. 63-63A describes the GSense barter network mechanism with Protect Anything Human Key, Request Anything connector, and SP technology and shows a mobile phone with the cam and microphone and crosshair for protect identification protect and though who you are dealing with.

FIG. 63-63B describes the GSense barter network mechanism with Protect Anything Human Key, Request Anything connector, and SP technology and shows Request Anything for potential best barter deal.

FIG. 63-63C describes the GSense barter network mechanism with Protect Anything Human Key, Request Anything connector, and SP technology and shows Request Anything for participation in the barter exchange.

FIG. 63-63D describes the GSense barter network mechanism with Protect Anything Human Key, Request Anything connector, and SP technology and shows list yourself or your items for barter in GSense.

FIG. 63-63E describes the GSense barter network mechanism with Protect Anything Human Key, Request Anything connector, and SP technology and shows protect and know and identify who you're dealing with.

FIG. 63-63F describes the GSense barter network mechanism with Protect Anything Human Key, Request Anything connector, and SP technology and shows GSense barter network is listed in every relevant search.

FIG. 63-63G describes the GSense barter network mechanism with Protect Anything Human Key, Request Anything connector, and SP technology and shows items and services willing to barter for and the estimated real value and the estimated barter value.

FIG. 63-63H describes the GSense barter network mechanism with Protect Anything Human Key, Request Anything connector, and SP technology and shows items and services willing to trade for bartered goods and the estimated real value and the estimated barter value.

FIG. 63-63I describes the GSense barter network mechanism with Protect Anything Human Key, Request Anything connector, and SP technology and shows creative services aren't, music, video willing to barter for and estimated real value and estimated barter value.

FIG. 63-63J describes the GSense barter network mechanism with Protect Anything Human Key, Request Anything connector, and SP technology and shows professional services willing to trade for other bartered items and estimated real value and estimated barter value.

FIG. 63-63K describes the GSense barter network mechanism with Protect Anything Human Key, Request Anything connector, and SP technology and shows a rating of the deal is recorded for future barter deals.

FIG. 63-63L describes the GSense barter network mechanism with Protect Anything Human Key, Request Anything connector, and SP technology and shows then an offer or items or person of equal value is set.

FIG. 63-63M describes the GSense barter network mechanism with Protect Anything Human Key, Request Anything connector, and SP technology and shows then the GSense system is given a spatial point target evaluator.

FIG. 63-63N describes the GSense barter network mechanism with Protect Anything Human Key, Request Anything connector, and SP technology and shows where the content is published public or private.

FIG. 63-63O describes the GSense barter network mechanism with Protect Anything Human Key, Request Anything connector, and SP technology and shows the GSense system then notifies members.

FIG. 63-63P describes the GSense barter network mechanism with Protect Anything Human Key, Request Anything connector, and SP technology and shows where barter members are notified with best choice combinations.

FIG. 63-63Q describes the GSense barter network mechanism with Protect Anything Human Key, Request Anything connector, and SP technology and shows the GSense system has a barter match up system.

FIG. 63-63R describes the GSense barter network mechanism with Protect Anything Human Key, Request Anything connector, and SP technology and shows how a suggested decision is created with GSense.

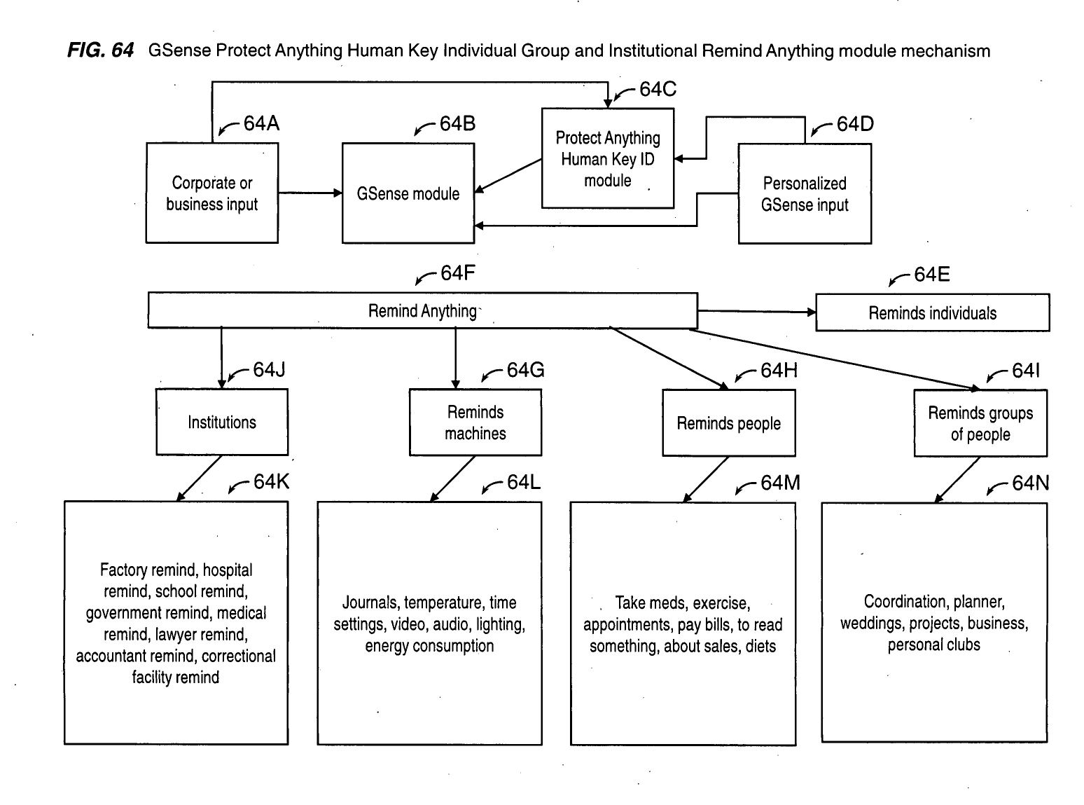

FIG. 64-64A describes how Data is processed into intelligent data Remind Anything with Protect Anything Human Key Server Cloud and GSense Algorithm and shows corporate or business input works with GSense and Remind Anything.

FIG. 64-64B describes How Data is processed into intelligent data Remind Anything with Protect Anything Human Key Server Cloud and GSense Algorithm and shows the GSense module as related to Protect Anything Human Key and Remind Anything.

FIG. 64-64C describes How Data is processed into intelligent data Remind Anything with Protect Anything Human Key Server Cloud and GSense Algorithm and shows Protect Anything Human Key ID module before connection to Remind Anything.

FIG. 64-64D describes How Data is processed into intelligent data Remind Anything with Protect Anything Human Key Server Cloud and GSense Algorithm and shows personalized GSense input.

FIG. 64-64E describes How Data is processed into intelligent data Remind Anything with Protect Anything Human Key Server Cloud and GSense Algorithm and shows reminds individuals and institutions as well as groups.

FIG. 64-64F describes How Data is processed into intelligent data Remind Anything with Protect Anything Human Key Server Cloud and GSense Algorithm and shows Remind Anything flow.

FIG. 64-64G describes How Data is processed into intelligent data Remind Anything with Protect Anything Human Key Server Cloud and GSense Algorithm and shows that the mechanism reminds machines.

FIG. 64-64H describes How Data is processed into intelligent data Remind Anything with Protect Anything Human Key Server Cloud and GSense Algorithm and shows that the mechanism reminds people.

FIG. 64-64I describes How Data is processed into intelligent data Remind Anything with Protect Anything Human Key Server Cloud and GSense Algorithm and shows the mechanism reminds groups of people.

FIG. 64-64J describes How Data is processed into intelligent data Remind Anything with Protect Anything Human Key Server Cloud and GSense Algorithm and shows the mechanism reminds institutions.

FIG. 64-64K describes How Data is processed into intelligent data Remind Anything with Protect Anything Human Key Server Cloud and GSense Algorithm and shows the mechanism reminds institutions like factory remind, hospital remind, school remind, government remind, medical remind, lawyer remind, accountant remind, correctional facility remind, or anything institution's needs to be reminded of.

FIG. 64-64L describes How Data is processed into intelligent data Remind Anything with Protect Anything Human Key Server Cloud and GSense Algorithm and shows the mechanism reminds machines for Journal entries, temperatures, time settings, video, audio, lighting, energy consumption and conservation, and anything else a machine needs to be reminded of.

FIG. 64-64M describes How Data is processed into intelligent data Remind Anything with Protect Anything Human Key Server Cloud and GSense Algorithm and shows the mechanism reminds people to take medications, to exercise, for appointments, to pay bills, to read, about sales, about diets anything else a person needs to be reminded of.

FIG. 64-64N describes How Data is processed into intelligent data Remind Anything with Protect Anything Human Key Server Cloud and GSense Algorithm and shows the mechanism reminds groups of people for coordination, planning, wedding, projects, business, personal, clubs any other needs of reminders for groups of people.

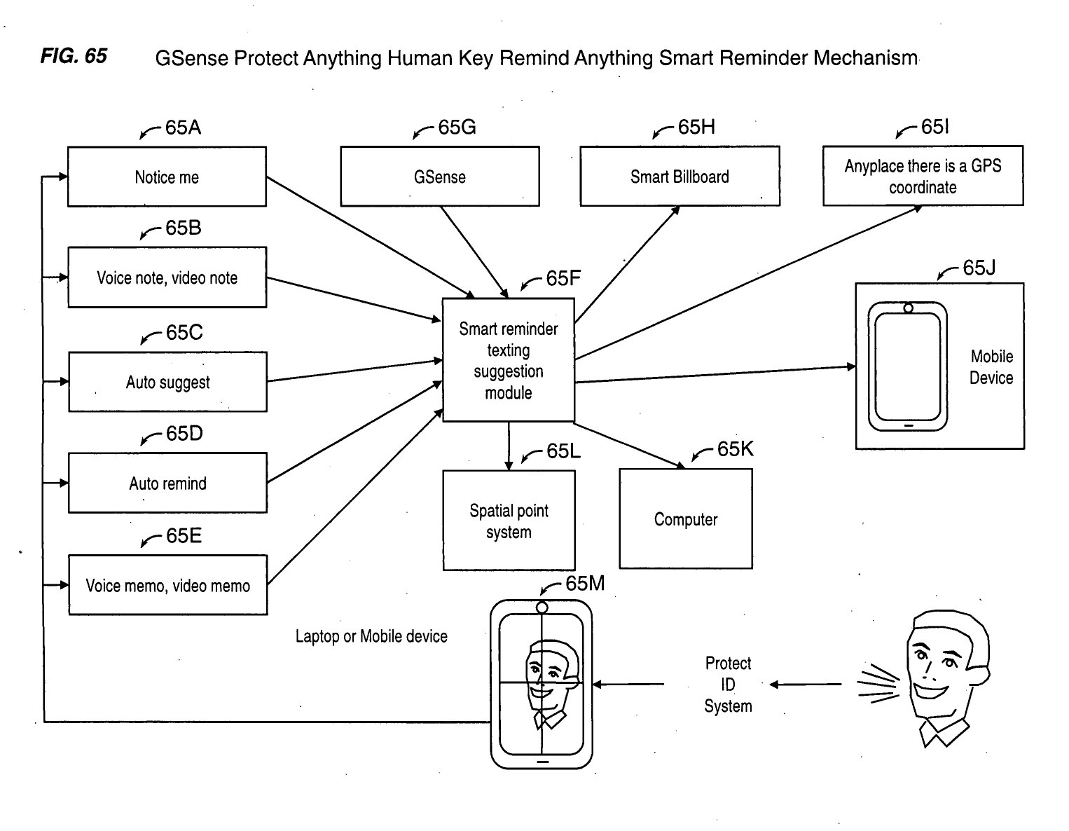

FIG. 65-65A describes Remind Anything with Protect Anything Human Key Server Cloud and GSense smart reminder and shows smart reminder notice me.

FIG. 65-65B describes Remind Anything with Protect Anything Human Key Server Cloud and GSense smart reminder and shows smart reminder voice live.

FIG. 65-65C describes Remind Anything with Protect Anything Human Key Server Cloud and GSense smart reminder and shows smart reminder audio suggest.

FIG. 65-65D describes Remind Anything with Protect Anything Human Key Server Cloud and GSense smart reminder and shows smart reminder auto remind.

FIG. 65-65E describes Remind Anything with Protect Anything Human Key Server Cloud and GSense smart reminder and shows smart reminder voice memo.

FIG. 65-65F describes Remind Anything with Protect Anything Human Key Server Cloud and GSense smart reminder and shows smart reminder texting suggestion module.

FIG. 65-65G describes Remind Anything with Protect Anything Human Key Server Cloud and GSense smart reminder and shows smart reminder GSense reminder.

FIG. 65-65H describes Remind Anything with Protect Anything Human Key Server Cloud and GSense smart reminder and shows smart reminder smart billboard.

FIG. 65-65I describes Remind Anything with Protect Anything Human Key Server Cloud and GSense smart reminder and shows smart reminder any placed there is a GPS coordinate.

FIG. 65-65J describes Remind Anything with Protect Anything Human Key Server Cloud and GSense smart reminder and shows smart reminder mobile device.

FIG. 65-65K describes Remind Anything with Protect Anything Human Key Server Cloud and GSense smart reminder and shows smart reminder to computer.

FIG. 65-65L describes Remind Anything with Protect Anything Human Key Server Cloud and GSense smart reminder and shows smart reminder to spatial point system target.

FIG. 65-65M describes Remind Anything with Protect Anything Human Key Server Cloud and GSense smart reminder and shows all smart reminders first go through mobile device or laptop with cam a microphone with crosshairs protect ID system.

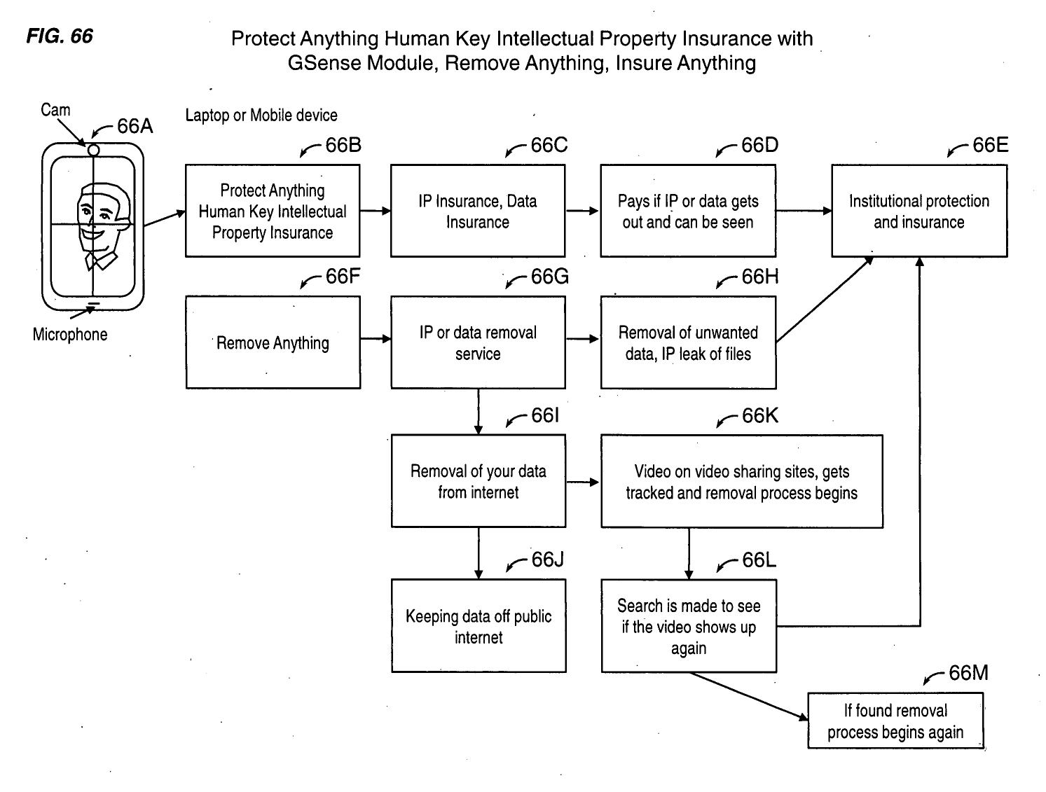

, FIG. 66-66A describes Remove Anything, Protect Anything Human Key, GSense, Insure Anything and shows mobile device with cam and microphone with crosshairs protect ID identification mechanism.

FIG. 66-66B describes Remove Anything, Protect Anything Human Key, GSense, Insure Anything and shows Protect Anything Human Key intellectual property insurance and IP insurance, data insurance mechanism.

FIG. 66-66C describes Remove Anything, Protect Anything Human Key, GSense, Insure Anything and shows IP insurance and data insurance mechanism.

FIG. 66-66D describes Remove Anything, Protect Anything Human Key, GSense, Insure Anything and shows pays if IP or data gets out of secure areas and can be viewed publicly or privately mechanism.

FIG. 66-66E describes Remove Anything, Protect Anything Human Key, GSense, Insure Anything and shows institutional protection insurance mechanism.

FIG. 66-66F describes Remove Anything, Protect Anything Human Key, GSense, Insure Anything and shows remove anything in a public network anywhere mechanism.

FIG. 66-66G describes Remove Anything, Protect Anything Human Key, GSense, Insure Anything and shows IP or data removal service mechanism.

FIG. 66-66H describes Remove Anything, Protect Anything Human Key, GSense, Insure Anything and shows removal of unwanted data IP leak of files mechanism.

FIG. 66-66I describes Remove Anything, Protect Anything Human Key, GSense, Insure Anything and shows removal of your data from the Internet mechanism.

FIG. 66-66J describes Remove Anything, Protect Anything Human Key, GSense, Insure Anything and shows keeping data of public Internet mechanism.

FIG. 66-66K describes Remove Anything, Protect Anything Human Key, GSense, Insure Anything and shows video on video sharing sites, gets tracked and removal process begins.

FIG. 66-66L describes Remove Anything, Protect Anything Human Key, GSense, Insure Anything and shows search is made to see if the video shows up again.

FIG. 66-66M describes Remove Anything, Protect Anything Human Key, GSense, Insure Anything and shows that found removal process begins again.

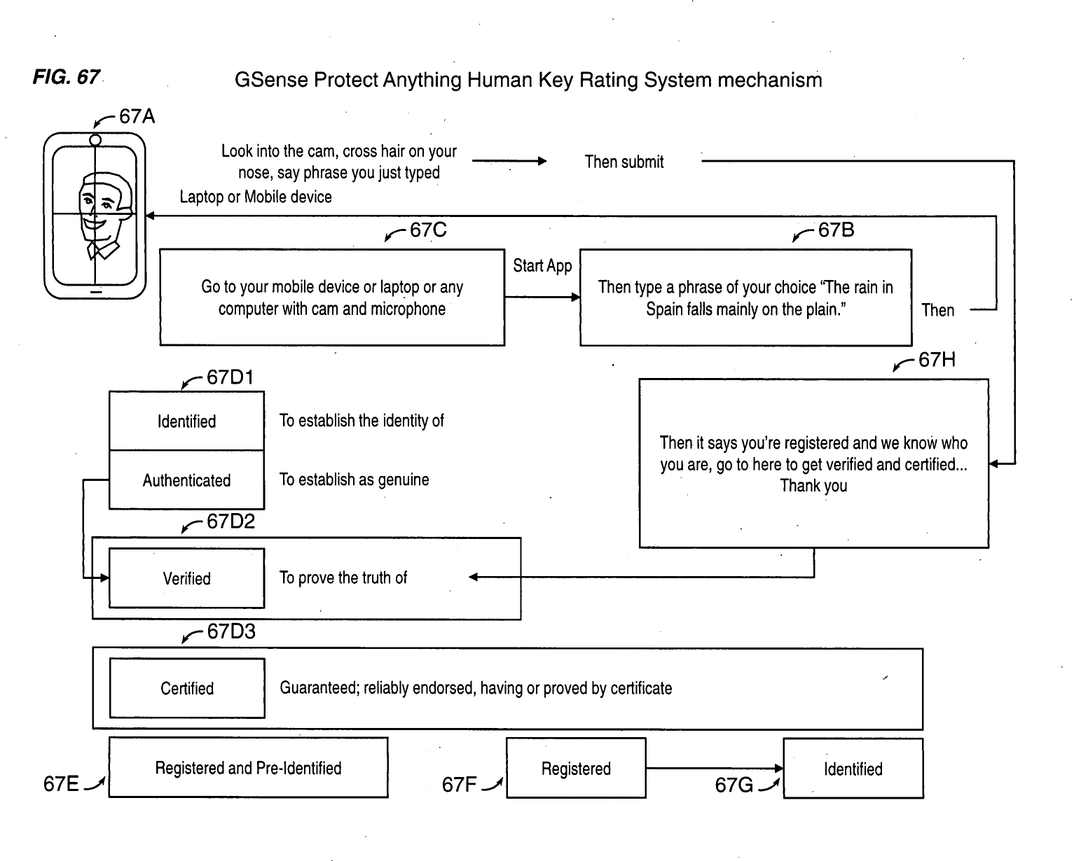

FIG. 67-67A describes How Data is processed into Protect Anything Human Key and GSense rating system and shows how you look into the cam crosshair on your nose, say please you just typed and submitted with mobile device or laptop that has a cam and microphone.

FIG. 67-67B describes How Data is processed into Protect Anything Human Key and GSense rating system and shows how you start application and type a phrase of your choice like “the rain in Spain lies mainly on the plain” then go to your mobile device or laptop or any computer with cam and microphone and say the phrase as you look into cam.

FIG. 67-67C describes How Data is processed into Protect Anything Human Key and GSense rating system and shows you go to your mobile device or laptop or any computer with cam and microphone.

FIG. 67-67D1 describes How Data is processed into Protect Anything Human Key and GSense rating system and shows identified rating to establish the identity of a person and authenticated to establish as genuine in the Protect Anything Human Key mechanism.

FIG. 67-67D2 describes How Data is processed into Protect Anything Human Key and GSense rating system and shows verify to prove the truth of identity of a person in the Protect Anything Human Key mechanism.

FIG. 67-67D3 describes How Data is processed into Protect Anything Human Key and GSense rating system and shows certified guaranteed, reliably endorsed having or approved by a certificate of a person through the Protect Anything Human Key system.

FIG. 67-67E describes How Data is processed into Protect Anything Human Key and GSense rating system and shows registered and pretty identified in the Protect Anything Human Key mechanism.

FIG. 67-67F describes How Data is processed into Protect Anything Human Key and GSense rating system and shows registered in the Protect Anything Human Key mechanism.

FIG. 67-67G describes How Data is processed into Protect Anything Human Key and GSense rating system and shows identified in the Protect Anything Human Key mechanism.

FIG. 67-67H describes How Data is processed into Protect Anything Human Key and GSense rating system and shows that then it says “you're registered and we know who you are go here to give verified and certified thank you”.

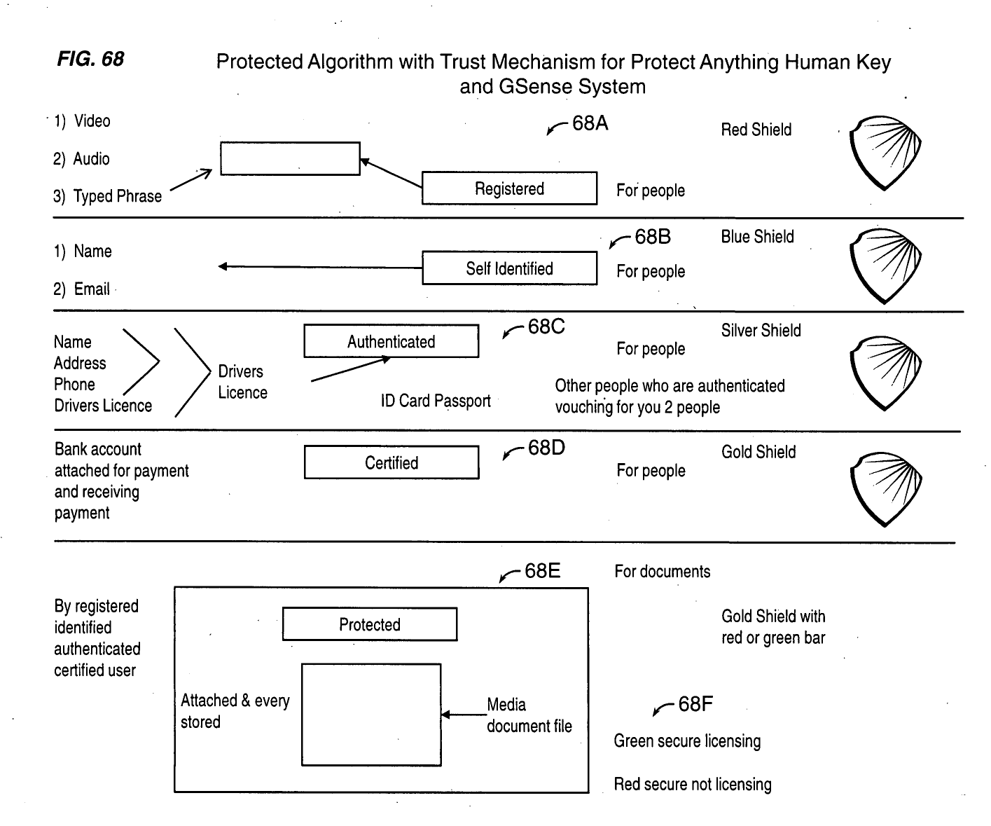

FIG. 68-68A describes How the protected algorithm with trust mechanism for Protect Anything Human Key and GSense and shows the red Shield for people registered with no name or e-mail after Protect Anything Human Key identification registration.

FIG. 68-68B describes How the protected algorithm with trust mechanism for Protect Anything Human Key and GSense and shows the blue shield for the people registered-themselves, or self identified with named plus e-mail after Protect Anything Human Key identification registration.

FIG. 68-68C describes How the protected algorithm with trust mechanism for Protect Anything Human Key and GSense and shows the silver shield for the people registered, identified, with name, address, phone number, driver's license or ID card or passport and become authenticated with other methods including other people who are authenticated vouching for you by a certain number of people 2, 3, or 5 depending on the strictness of the verification.

FIG. 68-68D describes How the protected algorithm with trust mechanism for Protect Anything Human Key and GSense and shows the gold shield for the people registered, self identified, authenticated and have bank account connected and attached for payment and receiving payment in Protect Anything Human Key mechanism.

FIG. 68-68E describes How the protected algorithm with trust mechanism for Protect Anything Human Key and GSense and shows the protected mechanism with a gold shield with green bar around edge which shows that the content is secure and protected and certified owner is open to licensing.

FIG. 68-68F describes How the protected algorithm with trust mechanism for Protect Anything Human Key and GSense and shows the protected mechanism with a gold shield with red bar around edge which shows that the content is secure and protected and certified owner is closed to licensing.

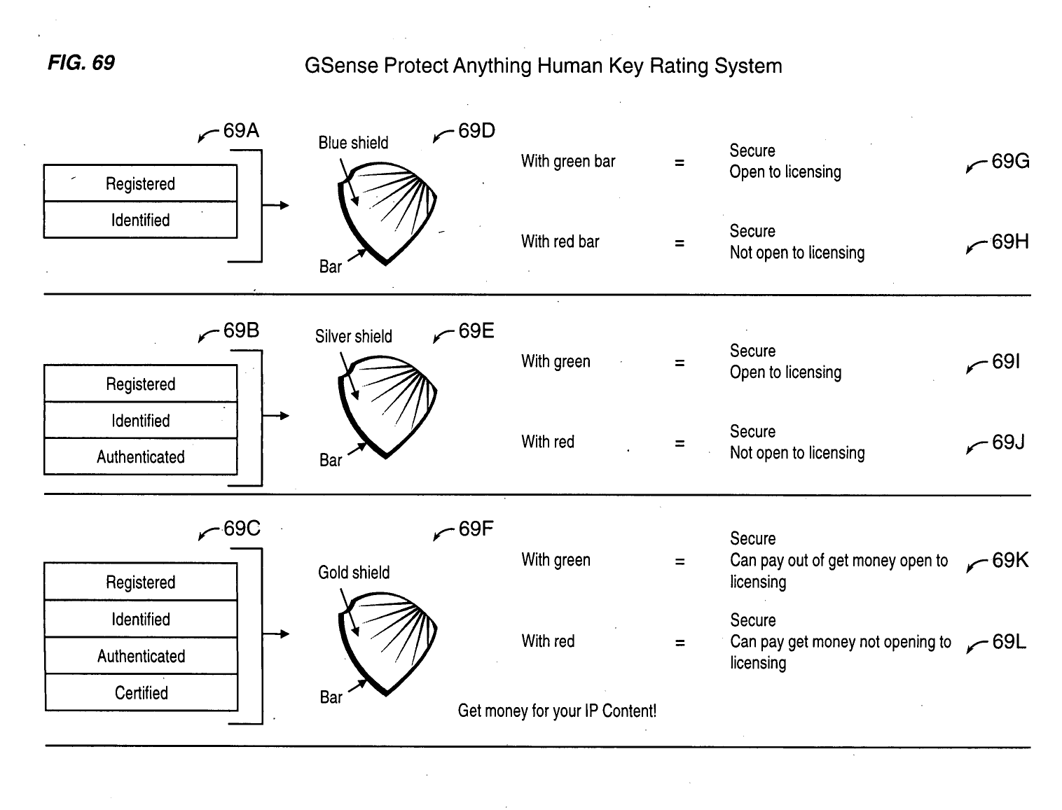

FIG. 69-69A describes how GSense rating system works with licensing color bands and shows a registered, identified user.

FIG. 69-69B describes How GSense rating system works with licensing color bands and shows a registered, identified, and authenticated user.

FIG. 69-69C describes How GSense rating system works with licensing color bands and shows a registered, identified, authenticated, and certified user.

FIG. 69-69D describes How GSense rating system works with licensing color bands and shows a registered, identified user with Blue Shield and licensing color bar.

FIG. 69-69E describes How GSense rating system works with licensing color bands and shows a registered, identified, authenticated user with Silver Shield and licensing, color bar.

FIG. 69-69F describes How GSense rating system works with licensing color bands and shows a registered, identified, authenticated, and certified user with gold shield and licensing color bar.

FIG. 69-69G describes How GSense rating system works with licensing color bands and shows a registered, identified user with green bar licensing for sharing, or collaboration or mash ups which equals that content is secure and open to licensing.

FIG. 69-69H describes How GSense rating system works with licensing color bands and shows a registered, identified user with red bar licensing for sharing, or collaboration or mash ups which equals that content is secure and closed the younger to licensing.

FIG. 69-69I describes How GSense rating system works with licensing color bands and shows a registered, identified, and authenticated user with green bar licensing for sharing, or collaboration or mash ups which equals that content is secure and open to licensing.

FIG. 69-69J describes How GSense rating system works with licensing color bands and shows a registered, identified, and authenticated user with red bar licensing for sharing, or collaboration or mash ups which equals that content is secure and closed the younger to licensing.

FIG. 69-69K describes How GSense rating system works with licensing color bands and shows a registered, identified, authenticated, and certified user with green bar licensing for sharing, or collaboration or mash ups which equals that content is secure and open to licensing.

FIG. 69-69L describes How GSense rating system works with licensing color bands and shows a registered, identified, authenticated, and certified user with red bar licensing for sharing, or collaboration or mash ups which equals that content is secure and closed the younger to licensing.

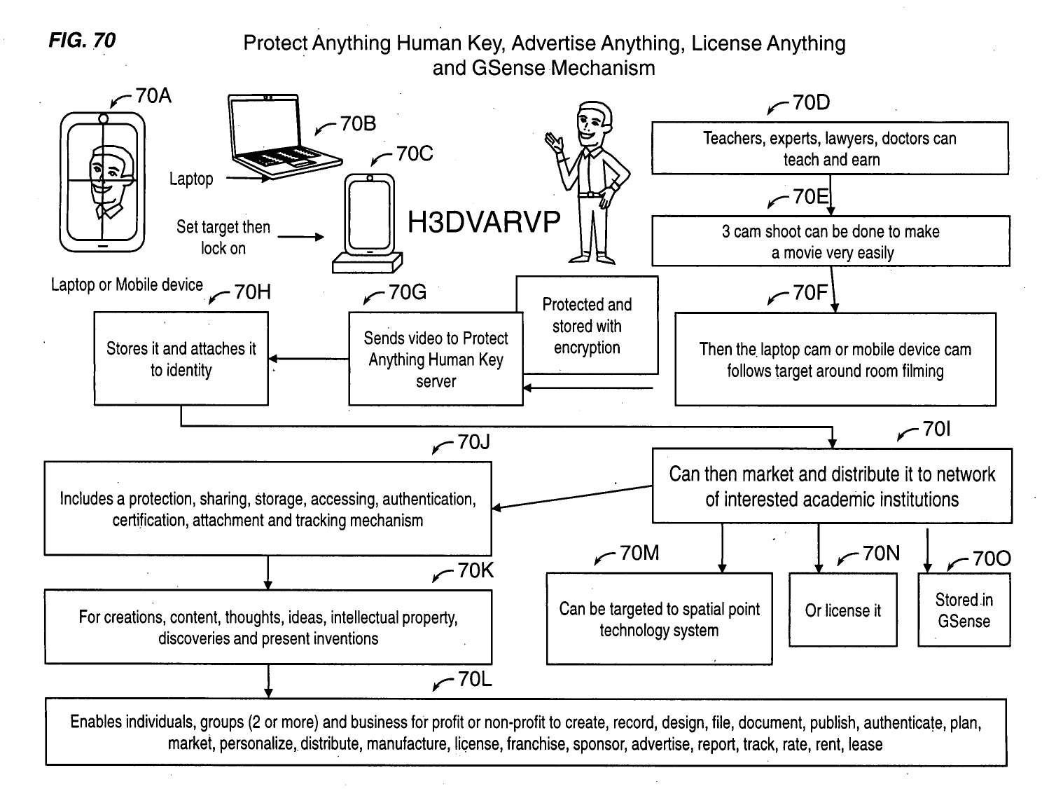

FIG. 70-70A describes how video audio courses and instructional information is processed into intelligent data Advertise Anything, License Anything Protect Anything Human Key, Distribute Anything, and GSense Protect Anything Human Key, Distribute Anything, and GSense and shows a mobile device with cam and microphone with built in H3DVARV mechanism or independent H3DVARV mechanism and crosshairs for protect identification login.

FIG. 70-70B describes how video audio courses and instructional information is processed into intelligent data Advertise Anything, License Anything Protect Anything Human Key, Distribute Anything, and GSense and shows laptop with cam and microphone and crosshairs for protect identification login.

FIG. 70-70C describes how video audio courses and instructional information is processed into intelligent data Advertise Anything, License Anything Protect Anything Human Key, Distribute Anything, and GSense and shows setting the mobile device on the stand then set crosshairs on target instructor nose lock on stand has motored device that can rotate 360° as target moves around the room, a different Lazy Susan style motor drive that can rotate through 360° works with laptops.

FIG. 70-70D describes how video audio courses and instructional information is processed into intelligent data Advertise Anything, License Anything Protect Anything Human Key, Distribute Anything, and GSense and shows where teachers, experts lawyers, doctors can teach and earn.

FIG. 70-70E describes how video audio courses and instructional information is processed into intelligent data Advertise Anything, License Anything Protect Anything Human Key, Distribute Anything, and GSense and shows a three cam shoot for a video or instructional movie can be done to make a movie where easily with three mobile devices or laptops.

FIG. 70-70F describes how video audio courses and instructional information is processed into intelligent data Advertise Anything, License Anything Protect Anything Human Key, Distribute Anything, and GSense and shows how then the laptop cam or mobile device cam can follow the target instructor or actor around the room filming always locked into the nose of the instructor or actor and can automatically zoom in for best shots not related to each mobile cam or laptop cam for the best filming intelligent method and mechanism.

FIG. 70-70G describes how video audio courses and instructional information is processed into intelligent data Advertise Anything, License Anything Protect Anything Human Key, Distribute Anything, and GSense and shows how the video is streamed and sent to the Protect Anything Human Key server and stored at GSense with GSense in full control of the process.

FIG. 70-70H describes how video audio courses and instructional information is processed into intelligent data Advertise Anything, License Anything Protect Anything Human Key, Distribute Anything, and GSense and shows how GSense stores the video content and processes it to the protected identity of the user.

FIG. 70-70I describes how video audio courses and instructional information is processed into intelligent data Advertise Anything, License Anything Protect Anything Human Key, Distribute Anything, and GSense and shows where the content can then be marketed and distributed utilizing license anything through the GSense system to a network of interested academic institutions or television networks.

FIG. 70-70J describes how video audio courses and instructional information is processed into intelligent data Advertise Anything, License Anything Protect Anything Human Key, Distribute Anything, and GSense and shows how it includes a protection, sharing, storage, accessing, authentication, certification, attachment and tracking mechanism.

FIG. 70-70K describes how video audio courses and instructional information is processed into intelligent data Advertise Anything, License Anything Protect Anything Human Key, Distribute Anything, and GSense and shows how the mechanism is used for creations, content, thoughts, ideas, intellectual property, discoveries and present inventions.

FIG. 70-70L describes how video audio courses and instructional information is processed into intelligent data Advertise Anything, License Anything Protect Anything Human Key, Distribute Anything, and GSense and shows how it enables individuals, groups (two or more) and business for profit or non-profit to create, record, design, file, document, publish, authenticate, plan, market, personalize, distribute, manufacture, license, franchise, sponsor, advertise, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key.

FIG. 70-70M describes how video audio courses and instructional information is processed into intelligent data Advertise Anything, License Anything Protect Anything Human Key, Distribute Anything, and GSense and shows where video content or any content can be targeted to GSense spatial point technology mechanism.

FIG. 70-70N describes how video audio courses and instructional information is processed into intelligent data Advertise Anything, License Anything Protect Anything Human Key, Distribute Anything, and GSense and shows how be created content can be licensed.

FIG. 70-70O describes how video audio courses and instructional information is processed into intelligent data Advertise Anything, License Anything Protect Anything Human Key, Distribute Anything, and GSense and shows how the creative content can be stored in GSense for related distribution and protected distribution.

FIG. 70-70P describes how video audio courses and instructional information is processed into intelligent data Advertise Anything, License Anything Protect Anything Human Key, Distribute Anything, and GSense and shows where the laptop or mobile cam can also zoom in and out and focused way automatically targeted to the nose of the instructor or actor the focusing and zooming is managed by GSense algorithm for best movie making shots and it is and independent process for each camera so that different cameras can zoom in and out at different appropriate times for the best sequence of shots.

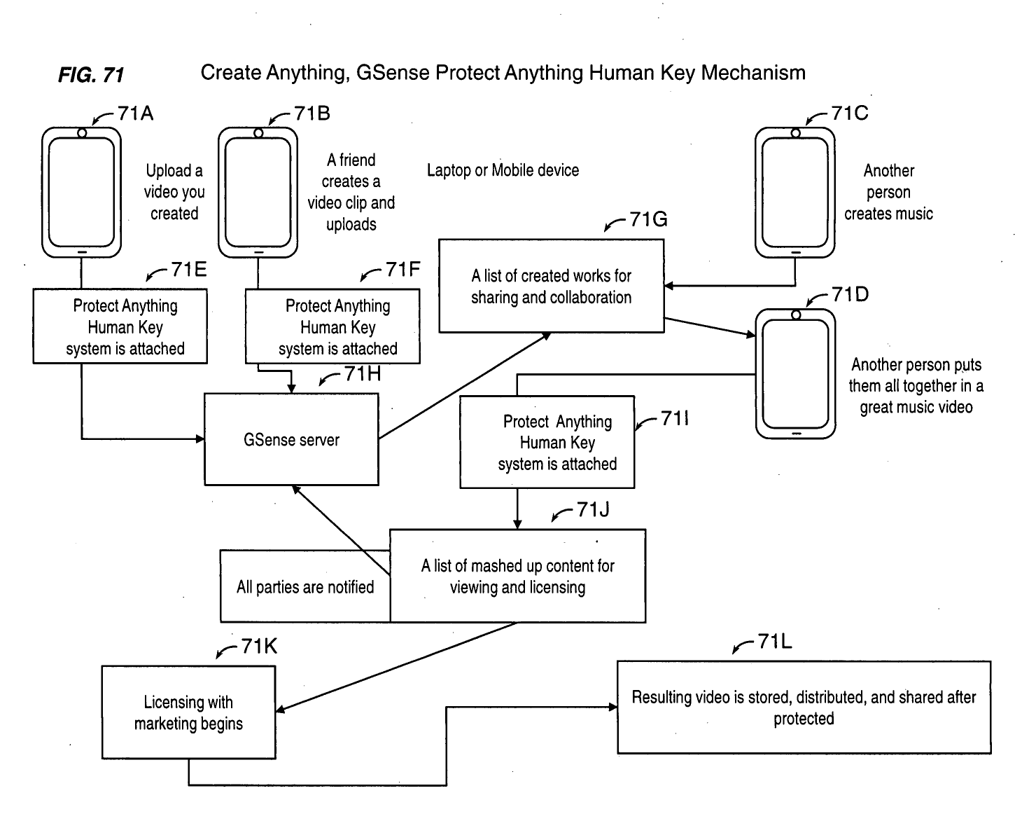

FIG. 71-71A describes how collaborated data or content is processed into Create Anything with Protect Anything Human Key and GSense Algorithm and shows where one user uploads a video or other content created to the GSense system.

FIG. 71-71B describes How Data is processed into intelligent data Remind Anything with Protect Anything Human Key Server Cloud and GSense Algorithm and shows how friend or associate or collaborator create a video clip or the content and uploads to GSense system.

FIG. 71-71C describes how collaborated data or content is processed into Create Anything with Protect Anything Human Key and GSense Algorithm and shows where another person creates a music file or other content and uploads to the GSense system.

FIG. 71-71D describes how collaborated data or content is processed into Create Anything with Protect Anything Human Key and GSense Algorithm and shows how another person decides to put them all together in a great music video by surfing licensed possibilities in the GSense system.

FIG. 71-71E describes how collaborated data or content is processed into Create Anything with Protect Anything Human Key and GSense Algorithm and shows how anyone has to go through the protect ID system and after the content is created or mashed up is attached to the ID for verification.

FIG. 71-71F describes how collaborated data or content is processed into Create Anything with Protect Anything Human Key and GSense Algorithm and shows the actual content is physically attached to protect ID as it goes through the collaboration process from start to end in the system a history is always according of whose protect ID was involved in the creation.

FIG. 71-71G describes how collaborated data or content is processed into Create Anything with Protect Anything Human Key and GSense Algorithm and shows where the list of created works for sharing and collaboration is put together in GSense licensing and mashup systems.

FIG. 71-71H describes how collaborated data or content is processed into Create Anything with Protect Anything Human Key and GSense Algorithm and shows storage is made on the GSense server.

FIG. 71-71I describes how collaborated data or content is processed into Create Anything with Protect Anything Human Key and GSense Algorithm and shows where to protect ID system is attached to all incoming and outgoing content.

FIG. 71-71J describes how collaborated data or content is processed into Create Anything with Protect Anything Human Key and GSense Algorithm and shows where a list of mashed up content previewing and licensing is connected where all parties are notified and updated with Remind Anything mechanism through Protect Anything Human Key ID system and GSense management mechanism.

FIG. 71-71K describes how collaborated data or content is processed into Create Anything with Protect Anything Human Key and GSense Algorithm and shows where the licensing through license anything and marketing begins with market anything mechanism.

FIG. 71-71L describes how collaborated data or content is processed into Create Anything with Protect Anything Human Key and GSense Algorithm and shows the resulting video or content is stored, distribute, and shared after it is protected.

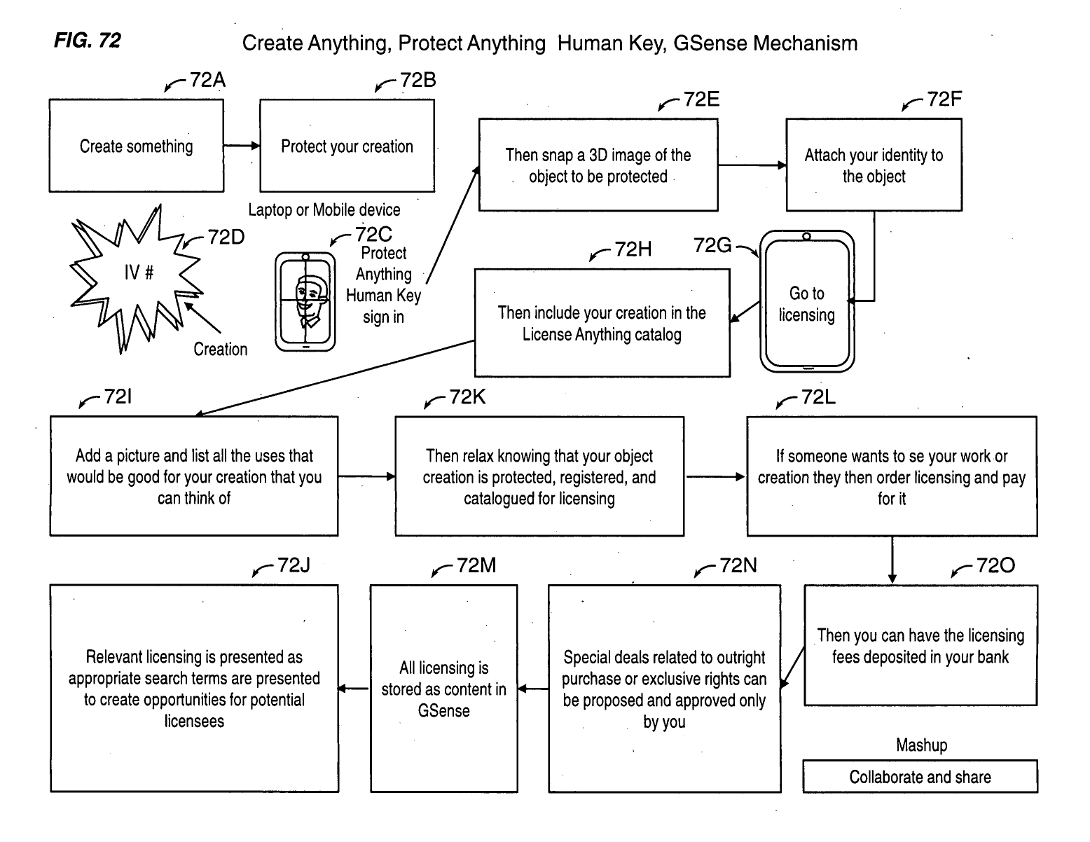

FIG. 72-72A describes how content is processed into intelligent Create Anything with Protect Anything Human Key and GSense and shows where you create something and then protect it with Protect Anything Human Key.

FIG. 72-72B describes how content is processed into intelligent Create Anything with Protect Anything Human Key and GSense and shows where you use a mobile device or laptop or independent can system to record your creation or upload it to the GSense system.

FIG. 72-72C describes how content is processed into intelligent Create Anything with Protect Anything Human Key and GSense and shows first that you have to use your mobile device or laptop with cam a microphone and crosshairs to login to Protect Anything Human Key identification system.

FIG. 72-72D describes how content is processed into intelligent Create Anything with Protect Anything Human key and GSense and shows your creation you want to protect.

FIG. 72-72E describes how content is processed into intelligent Create Anything with Protect Anything Human Key and GSense and shows how after logging in to Protect Anything Human Key system then you simply snap a image or 3-D image of the object to be protected.

FIG. 72-72F describes how content is processed into intelligent Create Anything with Protect Anything Human Key and GSense and shows how you attach your identity to the object and they GSense Protect Anything Human Key mechanism.

FIG. 72-72G describes how content is processed into intelligent Create Anything with Protect Anything Human Key and GSense and shows how you use your laptop or mobile device to go to licensing anything.

FIG. 72-72H describes how content is processed into intelligent Create Anything with Protect Anything Human Key and GSense and shows then you are protected and can then be included in the catalog by including your creation in the licensing anything catalog for others to browse safely and protected.

FIG. 72-72I describes how content is processed into intelligent Create Anything with Protect Anything Human Key and GSense and shows you had your image picture or 3-D virtually augmented reality content and list all the uses that would be good for your creation as you can think of in the GSense mechanism.

FIG. 72-72J describes how content is processed into intelligent Create Anything with Protect Anything Human Key and GSense and shows relevant licensing is presented by the GSense mechanism as appropriate search terms and semantic keyword combinations are presented to create opportunities for potential licensees collaborators and licensing opportunities.

FIG. 72-72K describes how content is processed into intelligent Create Anything with Protect Anything Human Key and GSense and shows how a user then can relax knowing that your object, content, creation is protected, registered, and catalog for licensing and being marketed on your behalf in a Safeway with GSense management mechanism.

FIG. 72-72L describes how content is processed into intelligent Create Anything with Protect Anything Human Key and GSense and shows if someone wants to use your work or creation they then can order licensing, or requests for participation or use and pay for it, negotiated it, bid for it, or make an offer for it in the GSense mechanism.

FIG. 72-72M describes how content is processed into intelligent Create Anything with Protect Anything Human Key and GSense and shows where all licensing is stored as content in GSense mechanism.

FIG. 72-72N describes how content is processed into intelligent Create Anything with Protect Anything Human Key and GSense and shows were special deals related to outright purchase, or exclusive rights can be proposed and approved only by protected identified and attached to content user.

FIG. 72-72O describes how content is processed into intelligent Create Anything with Protect Anything Human Key and GSense and shows where then you can have the licensing fees deposited directly into your bank or paid with issue check from GSense mechanism.

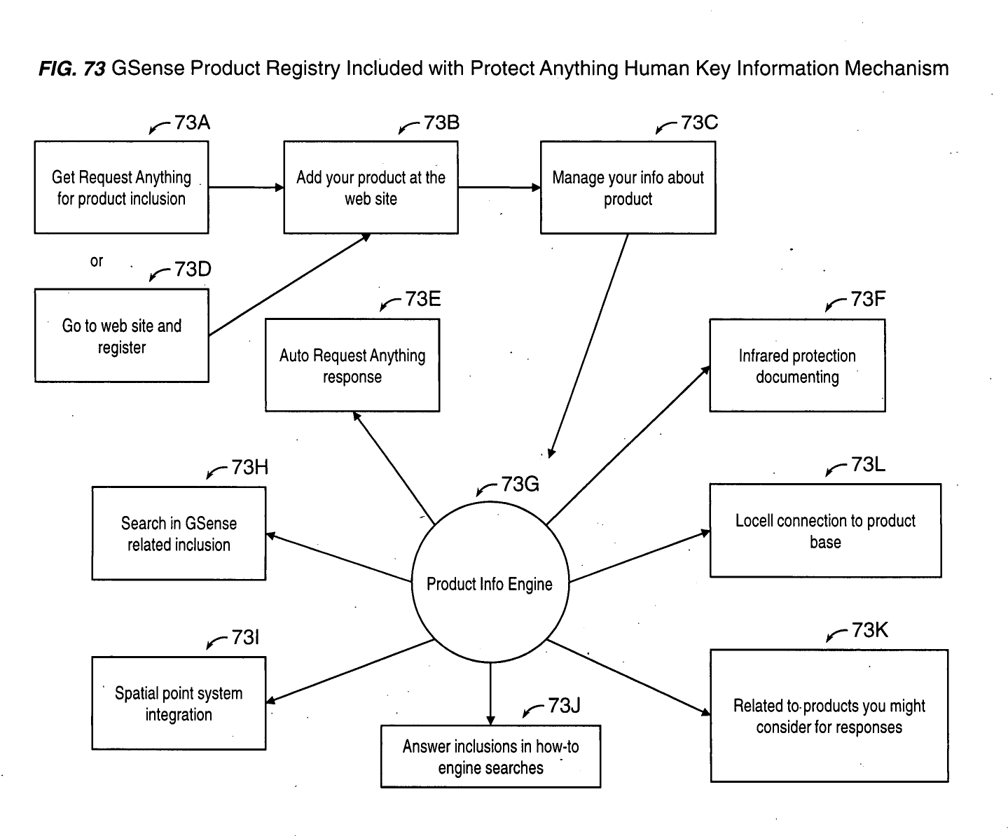

FIG. 73-73A describes the GSense product registry to be included in the GSense product information system and mechanism and shows where you get an Request Anything for product inclusion into GSense product registry.

FIG. 73-73B describes the GSense product registry to be included in the GSense product information system and mechanism and shows where you add your product at the GSense website.

FIG. 73-73C describes the GSense product registry to be included in the GSense product information system and mechanism and shows where you manage your information about your product in the GSense registry.

FIG. 73-73D describes the GSense product registry to be included in the GSense product information system and mechanism and shows where you go directly to the website and register to be able to add your product to the GSense registry.

FIG. 73-73E describes the GSense product registry to be included in the GSense product information system and mechanism and shows where you can add an automatic Request Anything response to your product in the GSense registry.

FIG. 73-73F describes the GSense product registry to be included in the GSense product information system and mechanism and shows where you can add infrared protection documenting to any product for registration and the GSense product registry with product information and reordering information and how to use, assemble, or get the best out of the product.

FIG. 73-73G describes the GSense product registry to be included in the GSense product information system and mechanism and shows product information engine as related to all the GSense product registry systems.

FIG. 73-73H describes the GSense product registry to be included in the GSense product information system and mechanism and shows how to search in GSense for related inclusion areas for placement.

FIG. 73-73I describes the GSense product registry to be included in the GSense product information system and mechanism and shows how to register with spatial point system integration in the GSense product registry mechanism.

FIG. 73-73J describes the GSense product registry to be included in the GSense product information system and mechanism and shows where to answer inclusions in how to engines searches.

FIG. 73-73K describes the GSense product registry to be included in the GSense product information system and mechanism and shows where a user can add related products you might also consider responses will be used from the GSense product registry mechanism.

FIG. 73-73L describes the GSense product registry to be included in the GSense product information system and mechanism and shows how the product information engine connects to Low Cell connection to the product information base of GSense product registry mechanism.

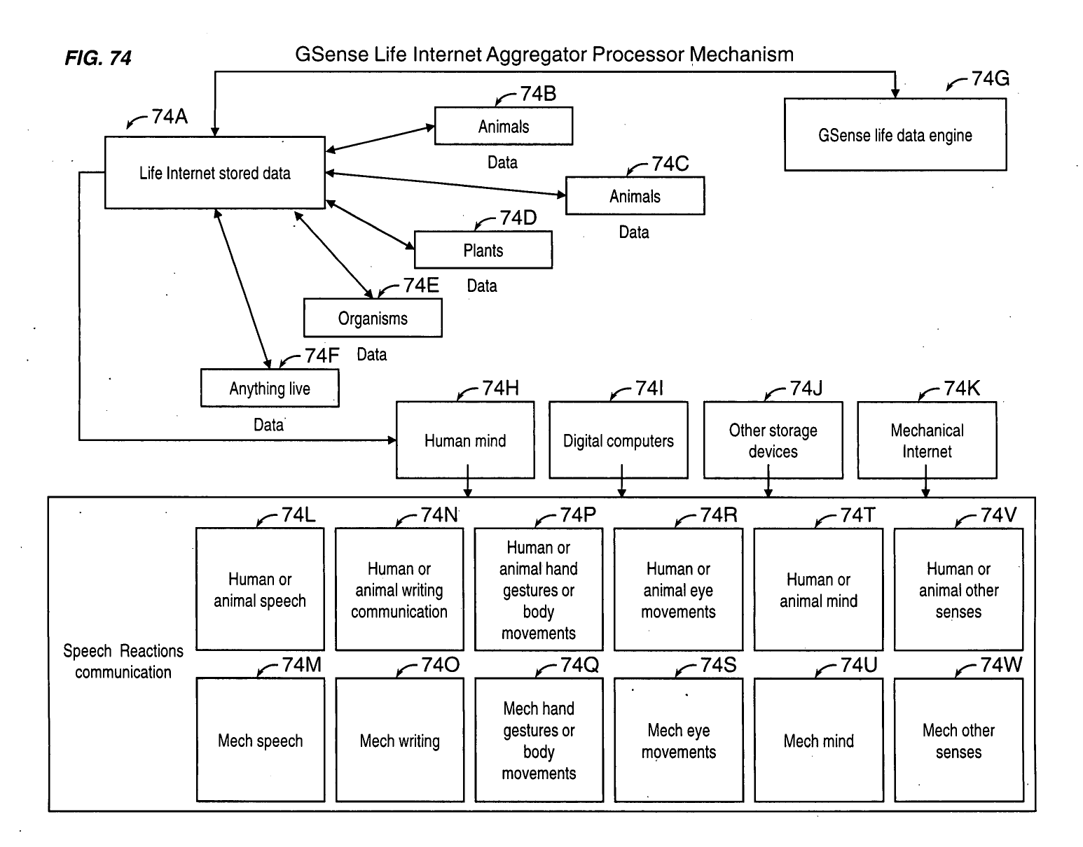

FIG. 74-74A describes how Life Internet data is processed into intelligent data in GSense life data engine and shows the life Internet stored data.

FIG. 74-74B describes how Life Internet data is processed into intelligent data in GSense life data engine and shows the life Internet people data.

FIG. 74-74C is describes how Life Internet data is processed into intelligent data in GSense life data engine and shows the life Internet animal data.

FIG. 74-74D describes how Life Internet data is processed into intelligent data in GSense life data engine and shows the life Internet plant data.

FIG. 74-74E describes how Life Internet data is processed into intelligent data in GSense life data engine and shows the life Internet organisms data.

FIG. 74-74F describes how Life Internet data is processed into intelligent data in GSense life data engine and shows the life Internet anything that is a live data.

FIG. 74-74G describes how Life Internet data is processed into intelligent data in GSense life data engine and shows the GSense life data engine.

FIG. 74-74H describes how Life Internet data is processed into intelligent data in GSense life data engine and shows other aspects of the GSense life data engine the human mind.

FIG. 74-74I describes how Life Internet data is processed into intelligent data in GSense life data engine and shows other aspects of the GSense life data engine digital computers.

FIG. 74-74J describes how Life Internet data is processed into intelligent data in GSense life data engine and shows other aspects of the GSense life data engine other storage devices.

FIG. 74-74K describes how Life Internet data is processed into intelligent data in GSense life data engine and shows other aspects of the GSense life being engine the mechanical Internet.

FIG. 74-74L describes how Life Internet data is processed into intelligent data in GSense life data engine and shows human or animal speech and communication.

FIG. 74-74M describes how Life Internet data is processed into intelligent data in GSense life data engine and shows mechanical speech.

FIG. 74-74N describes how Life Internet data is processed into intelligent data in GSense life data engine and shows human or animal writing or communication.

FIG. 74-74O describes how Life Internet data is processed into intelligent data in GSense life data engine and shows mechanical writing.

FIG. 74-74P describes how Life Internet data is processed into intelligent data in GSense life data engine and shows human or animal hand gestures or body movements.

FIG. 74-74Q describes how Life Internet data is processed into intelligent data in GSense life data engine and shows mechanical and gestures or body movements.

FIG. 74-74R describes how Life Internet data is processed into intelligent data in GSense life data engine and shows human or animal eye movements.

FIG. 74-74S describes how Life Internet data is processed into intelligent data in GSense life data engine and shows mechanical eye movements.

FIG. 74-74T describes how Life Internet data is processed into intelligent data in GSense life data engine and shows human or animal mind.

FIG. 74-74U describes how Life Internet data is processed into intelligent data in GSense life data engine and shows mechanical mind.

FIG. 74-74V describes how Life Internet data is processed into intelligent data in GSense life data engine and shows human or animal other senses.

FIG. 74-74W describes how Life Internet data is processed into intelligent data in GSense life data engine and shows mechanical other senses.

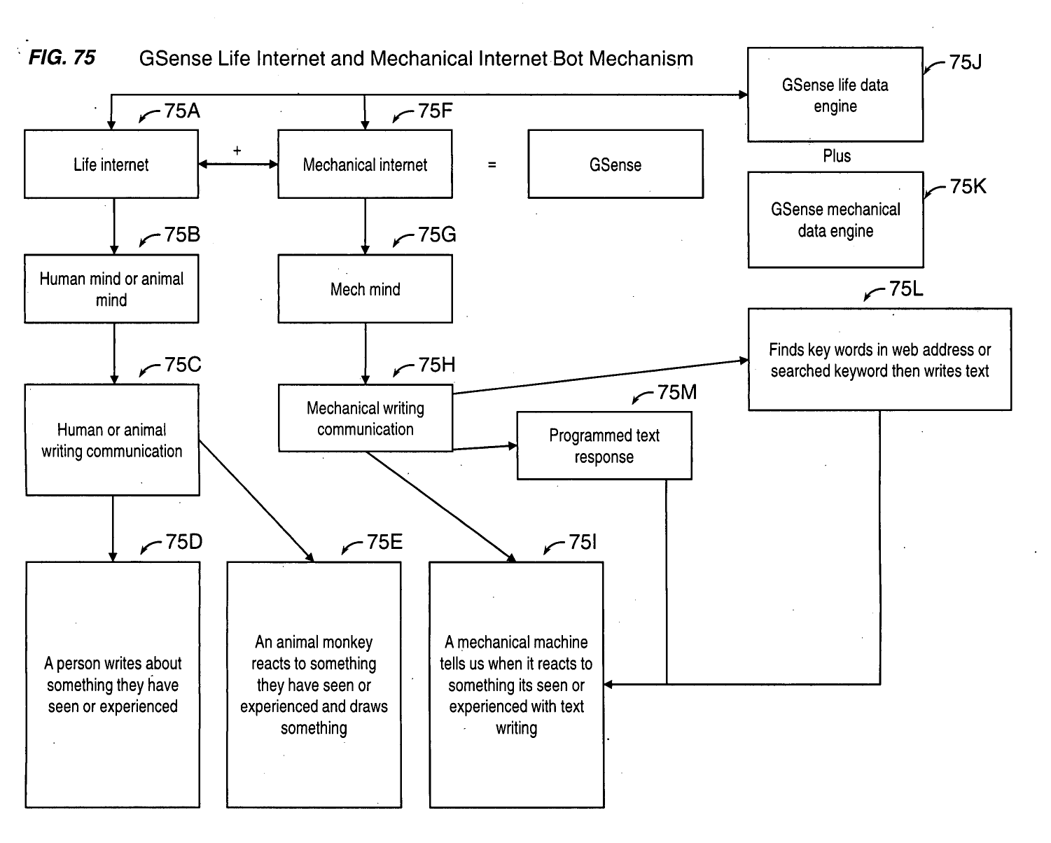

FIG. 75-75A describes how data is processed into intelligent data with GSense life data engine and shows a life Internet.

FIG. 75-75B describes how data is processed into intelligent data with GSense life data engine and shows life Internet related to human mind or animal mind.

FIG. 75-75C describes how data is processed into intelligent data with GSense life data engine and shows human or animal writing or communication.

FIG. 75-75D describes how data is processed into intelligent data with GSense life data engine and shows a person writes about something they have seen or experienced.

FIG. 75-75E describes how data is processed into intelligent data with GSense life data engine and shows and animal monkey reacts to something they have seen or experienced and draws something.

FIG. 75-75F describes how data is processed into intelligent data with GSense life data engine and shows the mechanical Internet.

FIG. 75-75G describes how data is processed into intelligent data with GSense life data engine and shows a mechanical mind.

FIG. 75-75H describes how data is processed into intelligent data with GSense life data engine and shows uses mechanical writing or communication.

FIG. 75-75I describes how data is processed into intelligent data with GSense life data engine and shows a mechanical machine tells us when it reacts to something its viewed or experienced with text writing.

FIG. 75-75J describes how data is processed into intelligent data with GSense life data engine and shows the GSense life data engine.

FIG. 75-75K describes how data is processed into intelligent data with GSense life data engine and shows the GSense life data engine plus the GSense mechanical data engine.

FIG. 75-75L describes how data is processed into intelligent data with GSense life data engine and shows how the mechanism finds keyword and Web address or searched keyword then writes text.

FIG. 75-75M describes how data is processed into intelligent data with GSense life data engine and shows a programmed text response from the mechanical Internet.

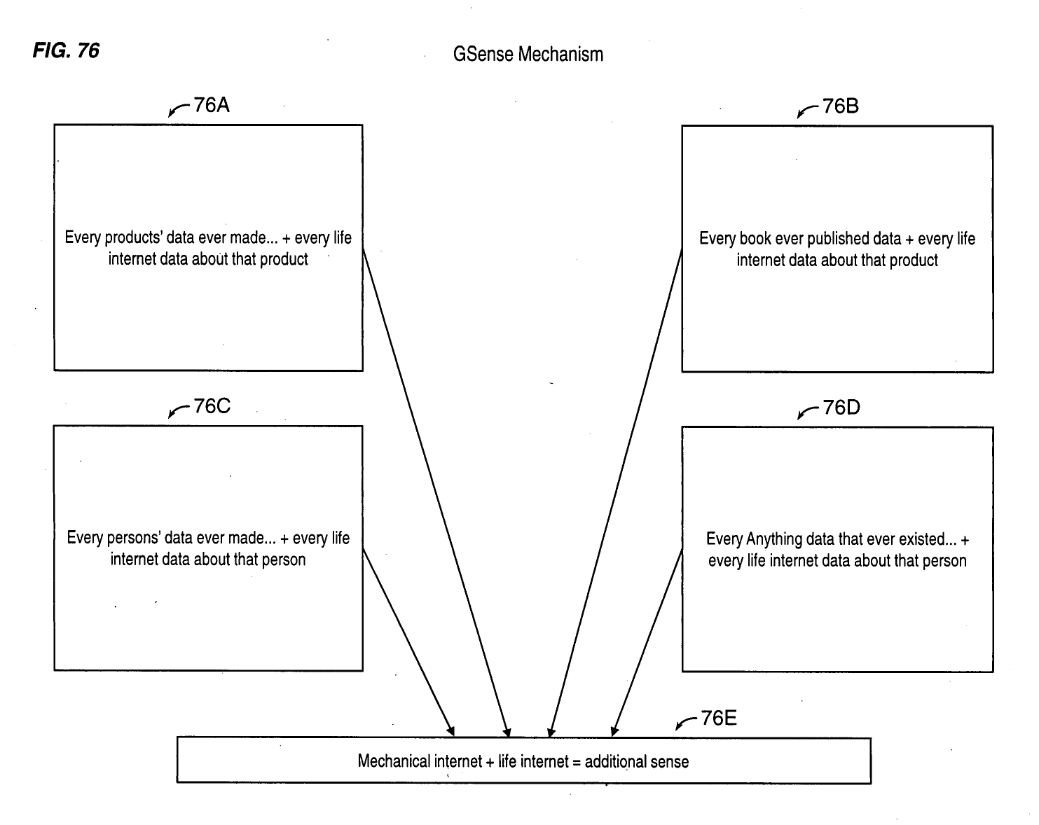

FIG. 76-76A describes GSense mechanism and shows in the GSense mechanism where every products data ever made plus every life Internet data about the product.

FIG. 76-76B describes GSense mechanism and shows in the GSense mechanism where every book ever published data plus every life Internet video about that book.

FIG. 76-76C describes GSense mechanism and shows in the GSense mechanism where every persons data ever made plus every life Internet data about that person.

FIG. 76-76D describes GSense mechanism and shows in the GSense mechanism where every thing and anything data that ever existed plus every light Internet everything anything data about anything.

FIG. 76-76E describes GSense mechanism and shows how the mechanical Internet plus a life Internet equals traditional sense GSense.

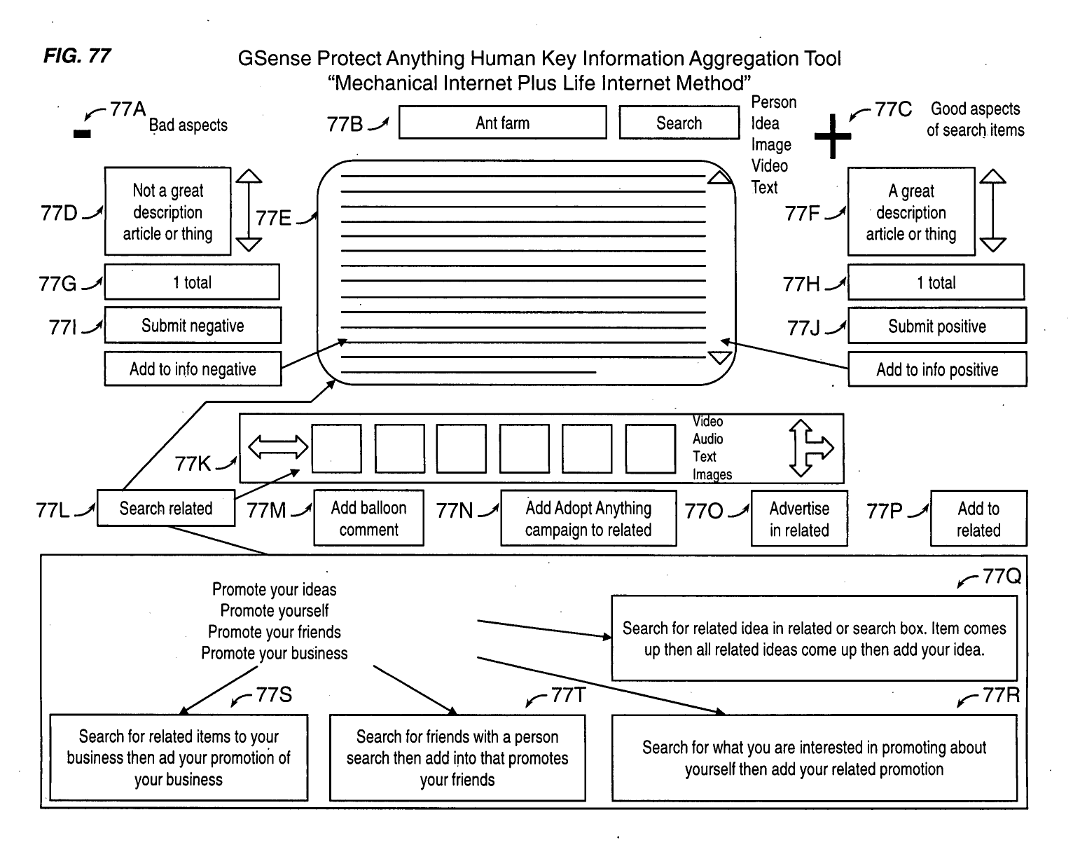

FIG. 77-77A describes GSense Information Aggregation Tool “mechanical internet plus the Life internet” and shows negative aspects to searched subject.

FIG. 77-77B describes GSense Information Aggregation Tool “mechanical internet plus the Life internet” and shows search for field with search button.

FIG. 77-77C describes GSense Information Aggregation Tool “mechanical internet plus the Life internet” and shows good aspects of search item.

FIG. 77-77D describes GSense Information Aggregation Tool “mechanical internet plus the Life internet” and shows a more detailed description of the bad aspects and lists all total bad aspects of the search term.

FIG. 77-77E describes GSense Information Aggregation Tool “mechanical internet plus the Life internet” and shows the main search details of the item search for.

FIG. 77-77F describes GSense Information Aggregation Tool “mechanical internet plus the Life internet” and shows a more detailed description of the good aspects and list all total good aspects of the search term.

FIG. 77-77G describes GSense Information Aggregation Tool “mechanical internet plus the Life internet” and shows the total number of minus bad aspects of the search term.

FIG. 77-77H describes GSense Information Aggregation Tool “mechanical internet plus the Life internet” and shows the total number of plus good aspects of the search term.

FIG. 77-77I describes GSense Information Aggregation Tool “mechanical internet plus the Life internet” and shows submit negative impression or bad aspects button.

FIG. 77-77J describes GSense Information Aggregation Tool “mechanical internet plus the Life internet” and shows submit positive impression or good aspects button.

FIG. 77-77K describes GSense Information Aggregation Tool “mechanical internet plus the Life internet” and shows related video audio text images.

FIG. 77-77L describes GSense Information Aggregation Tool “mechanical internet plus the Life internet” and shows search related button to searched related items to the search item.

FIG. 77-77M describes GSense Information Aggregation Tool “mechanical internet plus the Life internet” and shows add balloon comment related button to searched related items to the search item.

FIG. 77-77N describes GSense Information Aggregation Tool “mechanical internet plus the Life internet” and shows add Adopt Anything campaign or any campaign related button to searched related items to the search item.

FIG. 77-77O describes GSense Information Aggregation Tool “mechanical internet plus the Life internet” and shows advertise in related button where you can advertise in the related area.

FIG. 77-77P describes GSense Information Aggregation Tool “mechanical internet plus the Life internet” and shows add to related button where you can add things content media to the related area.

FIG. 77-77Q describes GSense Information Aggregation Tool “mechanical internet plus the Life internet” and shows where you search for related idea and related or main link to search box, item comes up then all related ideas come up then add your idea.

FIG. 77-77R describes GSense Information Aggregation Tool “mechanical internet plus the Life internet” and shows where you can search for what you are interested in promoting about yourself then add your related promotion.

FIG. 77-77S describes GSense Information Aggregation Tool “mechanical internet plus the Life internet” and shows how to promote your ideas, promote yourself, promote your friends, promote your business, and search for related items to your business, then add your promotion of your business.

FIG. 77-77T describes GSense Information Aggregation Tool “mechanical internet plus the Life internet” and shows where you can search for friends with a person search then add information that promotes your friends.

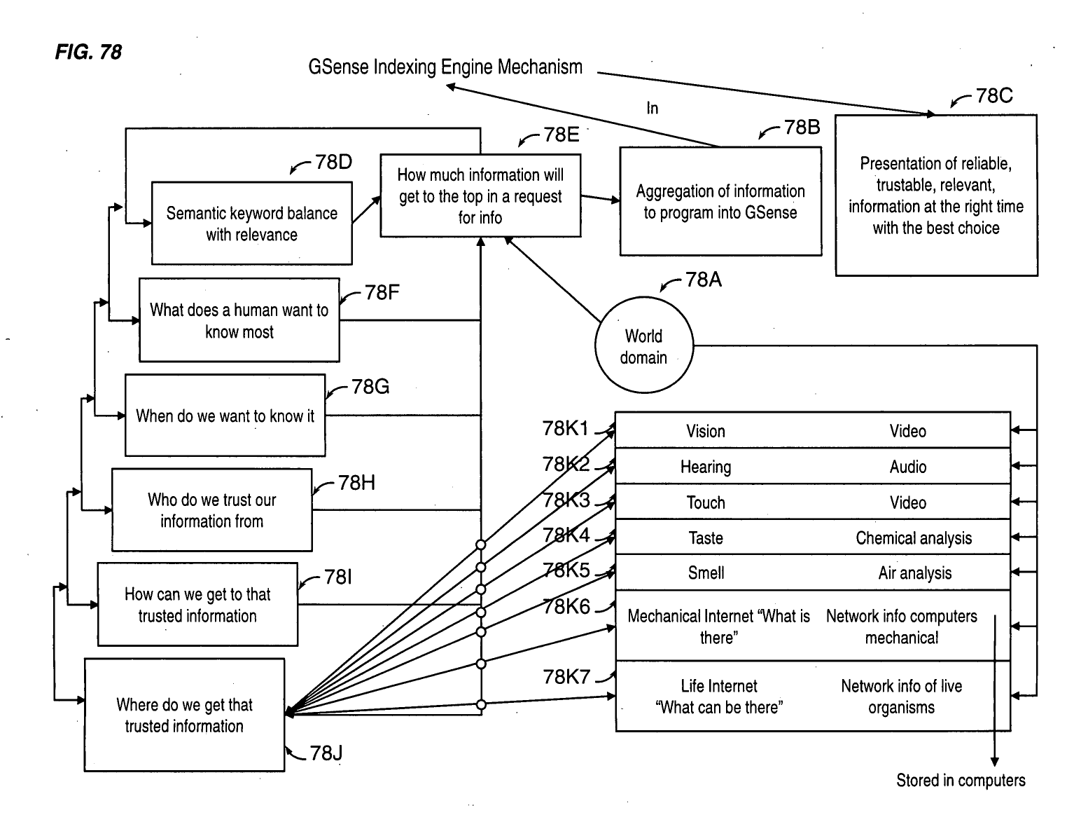

FIG. 78-78A describes GSense Engine and mechanism and shows how world domains connect with GSense engine.

FIG. 78-78B describes GSense Engine and mechanism and shows the aggregation of information to programmed into the GSense engine mechanism.

FIG. 78-78C describes GSense Engine and mechanism and shows how information flows out from the GSense engine mechanism for presentation of reliable, trustable, relevant information at the right time with the best choice for decision-making.

FIG. 78-78D describes GSense Engine and mechanism and shows how semantic keyword balances with relevance in the GSense engine.

FIG. 78-78E describes GSense Engine and mechanism and shows how much information will get to the top of the list in a request for information.

FIG. 78-78F describes GSense Engine and mechanism and shows questions are asked and fulfilled like what does a human one to know about most?

FIG. 78-78G describes GSense Engine and mechanism and shows questions are asked and fulfilled like when do we want to know it?

FIG. 78-78H describes GSense Engine and mechanism and shows questions are asked and fulfilled like who do we trust our information from?

FIG. 78-78I describes GSense Engine and mechanism and shows questions are asked and fulfilled like how can we get instantly automatically to that trust information?.

FIG. 78-78J describes GSense Engine and mechanism and shows questions are asked and fulfilled like where do we get that trusted information automatically?.

FIG. 78-78K1 describes GSense Engine and mechanism and shows vision information utilizing video aggregation, analysis, storage, and information distribution.

FIG. 78-78K2 describes GSense Engine and mechanism and shows hearing information utilizing audio aggregation, analysis, storage and information distribution.

FIG. 78-78K3 describes GSense Engine and mechanism and shows touch information utilizing sensors aggregation, analysis, storage and information distribution.

FIG. 78-78K4 describes GSense Engine and mechanism and shows taste information utilizing chemical analysis sensors aggregation, analysis, storage and information distribution.

FIG. 78-78K5 describes GSense Engine and mechanism and shows smell information utilizing chemical analysis of gases sensors aggregation, analysis, storage and information distribution.

FIG. 78-78K6 describes GSense Engine and mechanism and shows the mechanical internet “what is there” information utilizing network information from mechanical computers stored in computers aggregation, analysis, storage and information distribution.

FIG. 78-78K7 describes GSense Engine and mechanism and shows life internet what can be there and is there at this moment information utilizing network info of live organisms aggregation, analysis, storage and information distribution.

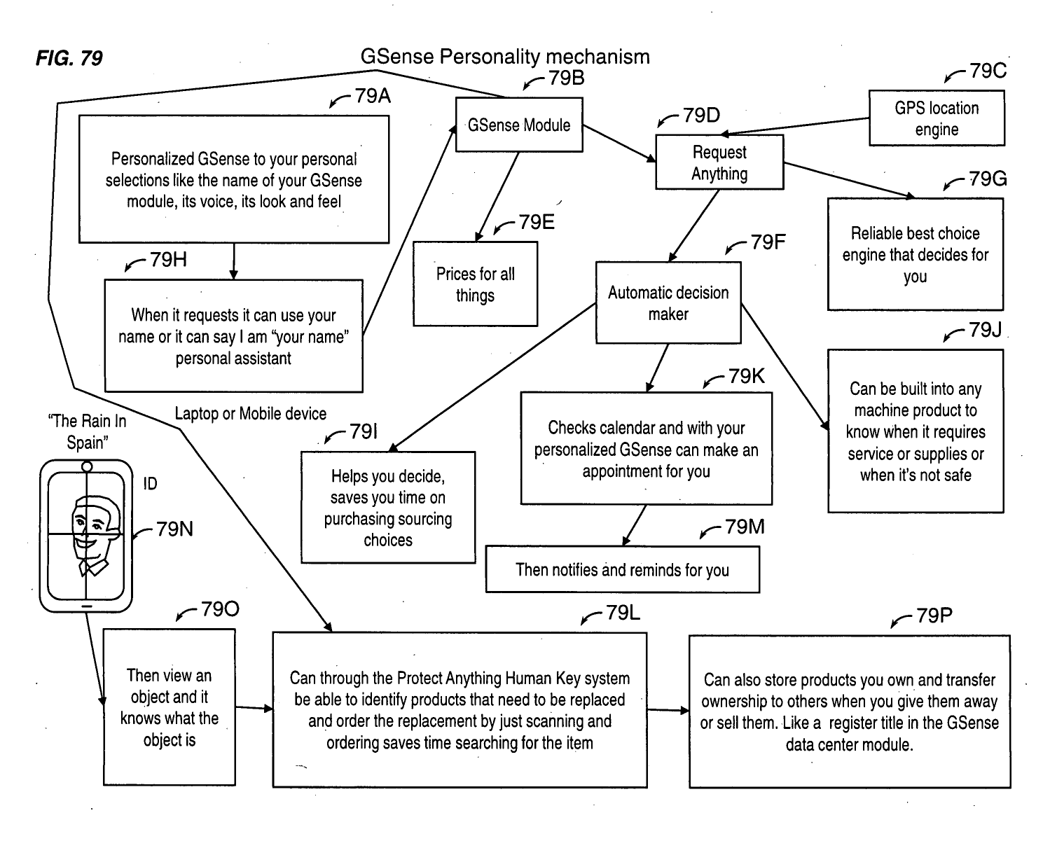

FIG. 79-79A describes how data is processed into intelligent data with Protect Anything Human Key Identification unit with Request Anything, Remind Anything, and GSense mechanism and shows the personalized GSense to your personal selections like the name of your GSense module it's voice, it's look and feel.

FIG. 79-79B describes how data is processed into intelligent data with Protect Anything Human Key Identification unit with Request Anything, Remind Anything, and GSense mechanism and shows the GSense module.

FIG. 79-79C describes how data is processed into intelligent data with Protect Anything Human Key Identification unit with Request Anything, Remind Anything, and GSense mechanism and shows the GPS location agent engine.

FIG. 79-79D describes how data is processed into intelligent data with Protect Anything Human Key Identification unit with Request Anything, Remind Anything, and GSense mechanism and shows the Request Anything mechanism.

FIG. 79-79E describes how data is processed into intelligent data with Protect Anything Human Key Identification unit with Request Anything, Remind Anything, and GSense mechanism and shows the prices for all things engine and storage.

FIG. 79-79F describes how data is processed into intelligent data with Protect Anything Human Key Identification unit with Request Anything, Remind Anything, and GSense mechanism and shows the automatic decision-maker agent.

FIG. 79-79G describes how data is processed into intelligent data with Protect Anything Human Key Identification unit with Request Anything, Remind Anything, and GSense mechanism and shows the Request Anything reliable best choice engine that decides for you.

FIG. 79-79H describes how data is processed into intelligent data with Protect Anything Human Key Identification unit with Request Anything, Remind Anything, and GSense mechanism and shows when it requests you can use your name, or I can say I am “your name” your personal assistant.

FIG. 79-79I describes how data is processed into intelligent data with Protect Anything Human Key Identification unit with Request Anything, Remind Anything, and GSense mechanism and shows how she decide, saves you time purchasing sourcing and choices.

FIG. 79-79J describes how data is processed into intelligent data with Protect Anything Human Key Identification unit with Request Anything, Remind Anything, and GSense mechanism and shows can be built into the machine or product to know when it requires service, or supplies or when it's not safe.

FIG. 79-79K describes how data is processed into intelligent data with Protect Anything Human Key Identification unit with Request Anything, Remind Anything, and GSense mechanism and shows checks calendar with your personalized GSense can make an appointment for you.

FIG. 79-79L describes how data is processed into intelligent data with Protect Anything Human Key Identification unit with Request Anything, Remind Anything, and GSense mechanism and shows where the mechanism can utilizing the protect identification system be able to identify products that need to be replaced and order the replacement by just scanning and ordering, saves time searching for the item.

FIG. 79-79M describes how data is processed into intelligent data with Protect Anything Human Key Identification unit with Request Anything, Remind Anything, and GSense mechanism and shows then notifies and reminds automatically for you.

FIG. 79-79N describes how data is processed into intelligent data with Protect Anything Human Key Identification unit with Request Anything, Remind Anything, and GSense mechanism and shows the mobile device with cam and microphone and crosshairs are protect identification.

FIG. 79-79O describes how data is processed into intelligent data with Protect Anything Human Key Identification unit with Request Anything, Remind Anything, and GSense mechanism and shows then when you view an object with cam your mobile device through the GSense protect system identifies and knows what the object is.

FIG. 79-79P describes how data is processed into intelligent data with Protect Anything Human Key Identification unit with Request Anything, Remind Anything, and GSense mechanism and shows the system can also store products your, and can transfer ownership to others when you give them away or sell them, like a registration title in the GSense data center module.

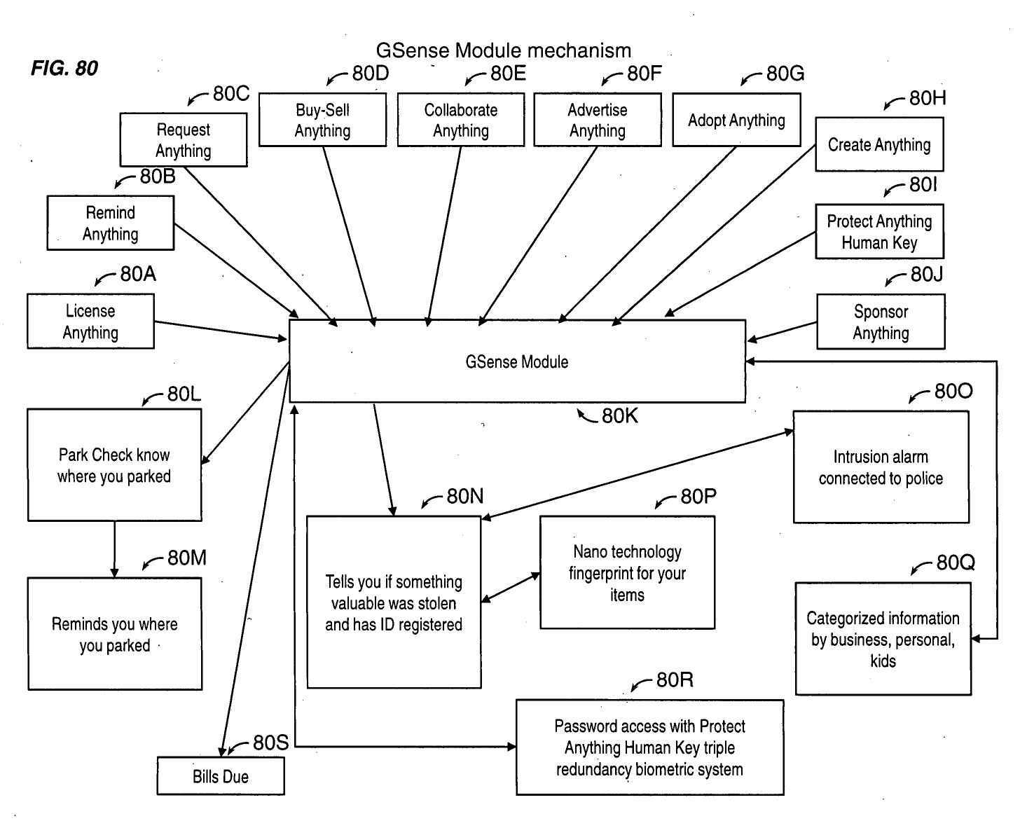

FIG. 80-80A describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows license anything connected to GSense module.

FIG. 80-80B describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Remind Anything connected to GSense module.

FIG. 80-80C describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Request Anything connected to GSense module.

FIG. 80-80D describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows buy sell anything connected to GSense module.

FIG. 80-80E describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows collaborate anything connected to GSense module.

FIG. 80-80F describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows advertise anything connected to GSense module.

FIG. 80-80G describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Adopt Anything campaign or any campaign connected to GSense module.

FIG. 80-80H describes how to create, design, record, file, document; publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows create anything connected to GSense module.

FIG. 80-80I describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Protect Anything Human Key connected to GSense module.

FIG. 80-80J describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows Sponsor Anything connected to GSense module.

FIG. 80-80K describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows the GSense module.

FIG. 80-80L describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows the GSense can park check know where you parked your car.

FIG. 80-80M describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows where the GSense module can remind you where you parked your car.

FIG. 80-80N describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense module can tell you something valuable stolen it has ID registered with Protect Anything Human Key.

FIG. 80-80O describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows intrusion alarm connected to GSense and to police.

FIG. 80-80P describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows the GSense Protect Anything Human Key nanotechnology fingerprint for your items.

FIG. 80-80Q describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense categorized information by business, personal and kids.

FIG. 80-80R describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense password access with Protect Anything Human Key triple redundancy biometric system.

FIG. 80-80S describes how to create, design, record, file, document, publish, authenticate, plan, market, personalize, distribute, manufacture, license, franchise, sponsor, advertise, publicize, report, track, rate, rent, lease, price, proposal, order, pay, fund, lend, insure, barter, gift, buy, sell, exchange, service, build, repair, install, learn, teach, research, promote, collaborate, adopt, and Protect Anything Human Key aggregated into and used with GSense mechanism and shows GSense can tell you when your bills are due.

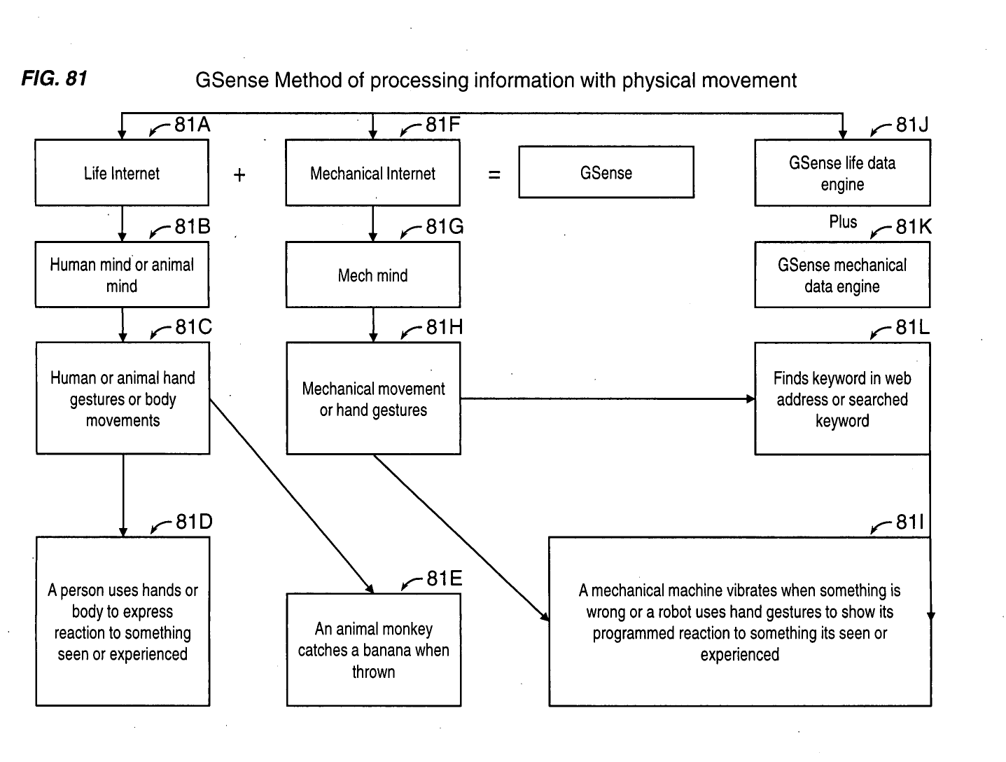

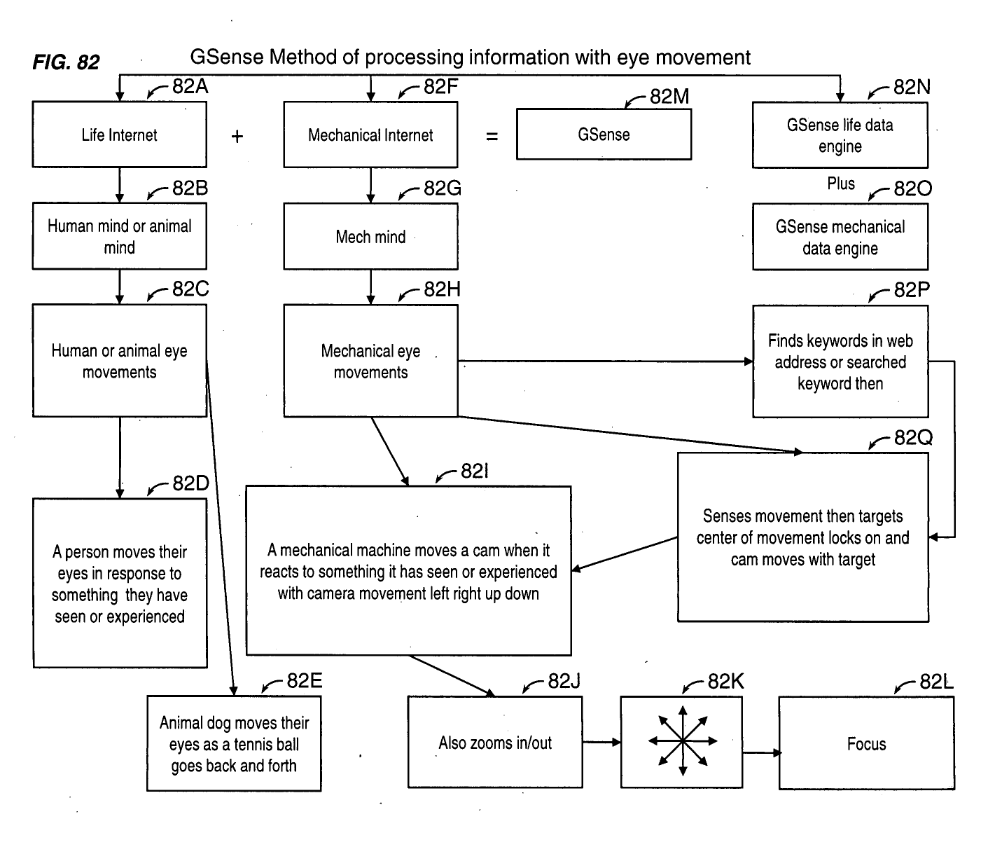

FIG. 81-81A describes how Life Internet data and Mechanical Internet data is processed into intelligent data with GSense mechanism and shows the life Internet.

FIG. 81-81B describes how Life Internet data and Mechanical Internet data is processed into intelligent data with GSense mechanism and shows the human mind or animal mind.

FIG. 81-81C describes how Life Internet data and Mechanical Internet data is processed into intelligent data with GSense mechanism and shows human or animal hand gestures or body movement.

FIG. 81-81D describes how Life Internet data and Mechanical Internet data is processed into intelligent data with GSense mechanism and shows a person uses hands or body to express reaction to something seen or experienced.

FIG. 81-81E describes how Life Internet data and Mechanical Internet data is processed into intelligent data with GSense mechanism and shows an animal an example a monkey catches a banana when tossed to it.

FIG. 81-81F describes how Life Internet data and Mechanical Internet data is processed into intelligent data with GSense mechanism and shows the mechanical Internet.

FIG. 81-81G describes how Life Internet data and Mechanical Internet data is processed into intelligent data with GSense mechanism and shows the mechanical mind machine.

FIG. 81-81H describes how Life Internet data and Mechanical Internet data is processed into intelligent data with GSense mechanism and shows mechanical movement or hand gestures.

FIG. 81-81I describes how Life Internet data and Mechanical Internet data is processed into intelligent data with GSense mechanism and shows a mechanical machine vibrates when something is wrong, or a robot uses hand gestures to show its programmed reaction to something it seen or experienced.

FIG. 81-81J describes how Life Internet data and Mechanical Internet data is processed into intelligent data with GSense mechanism and shows the GSense life data engine.

FIG. 81-81K describes how Life Internet data and Mechanical Internet data is processed into intelligent data with GSense mechanism and shows the GSense life data engine plus GSense mechanical data engine.

FIG. 81-81L describes how Life Internet data and Mechanical Internet data is processed into intelligent data with GSense mechanism and shows how GSense lines keyword in Web address or in a searched keyword and relates to mechanical Internet or machine mechanical movements are hand gestures.

FIG. 82-82A describes how Life Internet data and Mechanical Internet data is processed into intelligent data with GSense mechanism and shows the life Internet.

FIG. 82-82B describes how Life Internet data and Mechanical Internet data is processed into intelligent data with GSense mechanism and shows the human mind or animal mind.

FIG. 82-82C describes how Life Internet data and Mechanical Internet data is processed into intelligent data with GSense mechanism and shows the human or animal eye movements.

FIG. 82-82D describes how Life Internet data and Mechanical Internet data is processed into intelligent data with GSense mechanism and shows a person moves their eyes in response to something they have seen or experienced.

FIG. 82-82E describes how Life Internet data and Mechanical Internet data is processed into intelligent data with GSense mechanism and shows and animal as an example a dog loose their eyes as a tennis ball goes back and forth.

FIG. 82-82F describes how Life Internet data and Mechanical Internet data is processed into intelligent data with GSense mechanism and shows the mechanical Internet.

FIG. 82-82G describes how Life Internet data and Mechanical Internet data is processed into intelligent data with GSense mechanism and shows the mechanical mind.

FIG. 82-82H describes how Life Internet data and Mechanical Internet data is processed into intelligent data with GSense mechanism and shows the mechanical eye movements.

FIG. 82-82I describes how Life Internet data and Mechanical Internet data is processed into intelligent data with GSense mechanism and shows a mechanical machine news a cam when it reacts to something or it has seen something or experienced something with camera movement left right up and down.

FIG. 82-82J describes how Life Internet data and Mechanical Internet data is processed into intelligent data with GSense mechanism and shows demonstration of mechanical movements.

FIG. 82-82K describes how Life Internet data and Mechanical Internet data is processed into intelligent data with GSense mechanism and shows also mechanical machines have capability to zoom in and out.

FIG. 82-82L describes how Life Internet data and Mechanical Internet data is processed into intelligent data with GSense mechanism and shows also mechanical machines have the ability to focus.

FIG. 82-82M describes how Life Internet data and Mechanical Internet data is processed into intelligent data with GSense mechanism and shows GSense engine.

FIG. 82-82N describes how Life Internet data and Mechanical Internet data is processed into intelligent data with GSense mechanism and shows the GSense life data engine.

FIG. 82-82O describes how Life Internet data and Mechanical Internet data is processed into intelligent data with GSense mechanism and shows the GSense life data engine plus GSense mechanical data engine.

FIG. 82-82P describes how Life Internet data and Mechanical Internet data is processed into intelligent data with GSense mechanism and shows rare GSense lines keywords in Web address or search keyword then relates to mechanical eye movements and gets information.

FIG. 82-82Q describes how Life Internet data and Mechanical Internet data is processed into intelligent data with GSense mechanism and shows GSense senses movements then targets center the movement locks on and cam moves with target lock on to in life Internet and mechanical Internet.

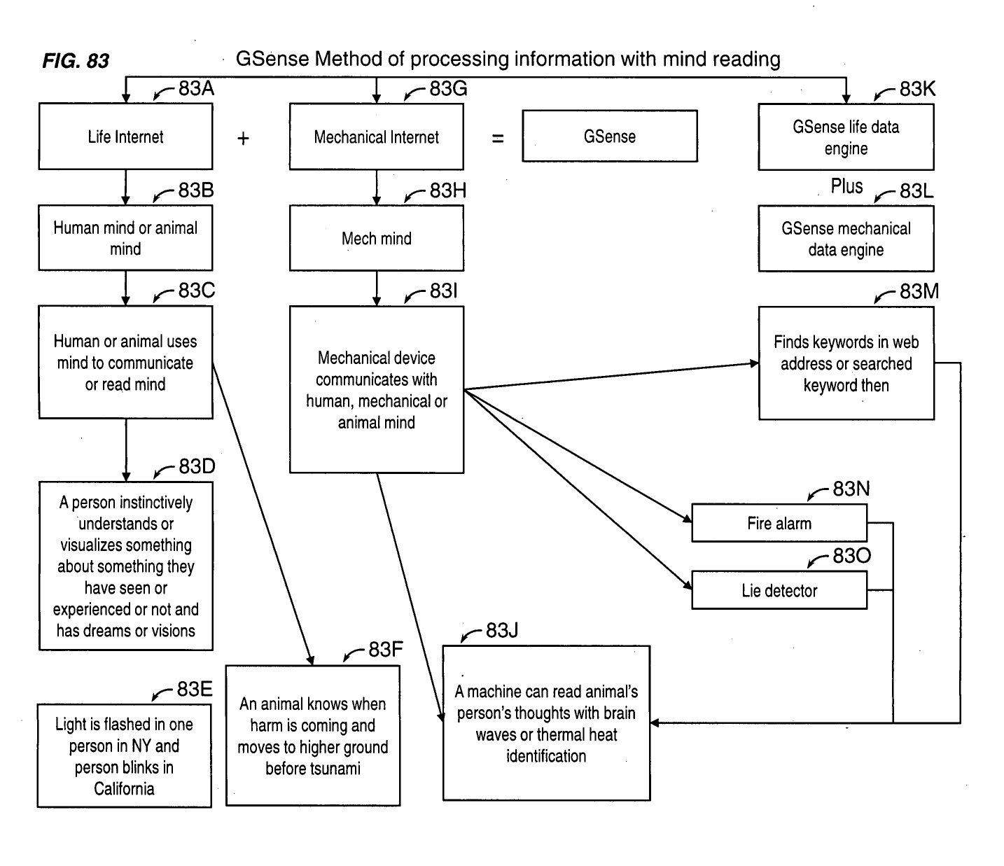

FIG. 83-83A describes how Life Internet data and Mechanical Internet data is processed into intelligent data with GSense mechanism and shows the life Internet.

FIG. 83-83B describes how Life Internet data and Mechanical Internet data is processed into intelligent data with GSense mechanism and shows the human mind or animal mind.

FIG. 83-83C describes how Life Internet data and Mechanical Internet data is processed into intelligent data with GSense mechanism and shows the human or animal using mind to communicate or read another human or animal's mind.

FIG. 83-83D describes how Life Internet data and Mechanical Internet data is processed into intelligent data with GSense mechanism and shows a person or an animal instinctively understands, or visualizers something about something they have seen or experienced or not and has dreams or visions.

FIG. 83-83E describes how Life Internet data and Mechanical Internet data is processed into intelligent data with GSense mechanism and shows experiments have shown that light that is last in one persons eye in New York and another person in California who is very close to the person in New York blinks their eye.

FIG. 83-83F describes how Life Internet data and Mechanical Internet data is processed into intelligent data with GSense mechanism and shows an animal knows when harm is coming in moves to higher ground before a tsunami.

FIG. 83-83G describes how Life Internet data and Mechanical Internet data is processed into intelligent data with GSense mechanism and shows the mechanical Internet.

FIG. 83-83H describes how Life Internet data and Mechanical Internet data is processed into intelligent data with GSense mechanism and shows the mechanical mind.

FIG. 83-83I describes how Life Internet data and Mechanical Internet data is processed into intelligent data with GSense mechanism and shows a mechanical device any case with human, mechanical or animal mind.

FIG. 83-83J describes how Life Internet data and Mechanical Internet data is processed into intelligent data with GSense mechanism and shows a machine can read, another machine, animals, persons thoughts with brain waves, or thermal heat identification methods.

FIG. 83-83K describes how Life Internet data and Mechanical Internet data is processed into intelligent data with GSense mechanism and shows the GSense engine with GSense life data engine.

FIG. 83-83L describes how Life Internet data and Mechanical Internet data is processed into intelligent data with GSense mechanism and shows the GSense life data engine plus GSense mechanical data engine.

FIG. 83-83M describes how Life Internet data and Mechanical Internet data is processed into intelligent data with GSense mechanism and shows the GSense engine lines keywords in Web address or search keyword from mechanical Internet.

FIG. 83-83N describes how Life Internet data and Mechanical Internet data is processed into intelligent data with GSense mechanism and shows the GSense life data engine controlling a car alarm, or fire alarm.

FIG. 83-83O describes how Life Internet data and Mechanical Internet data is processed into intelligent data with GSense mechanism and shows the GSense life data engine plus GSense mechanical data engine controlling a lie detector or other machine.

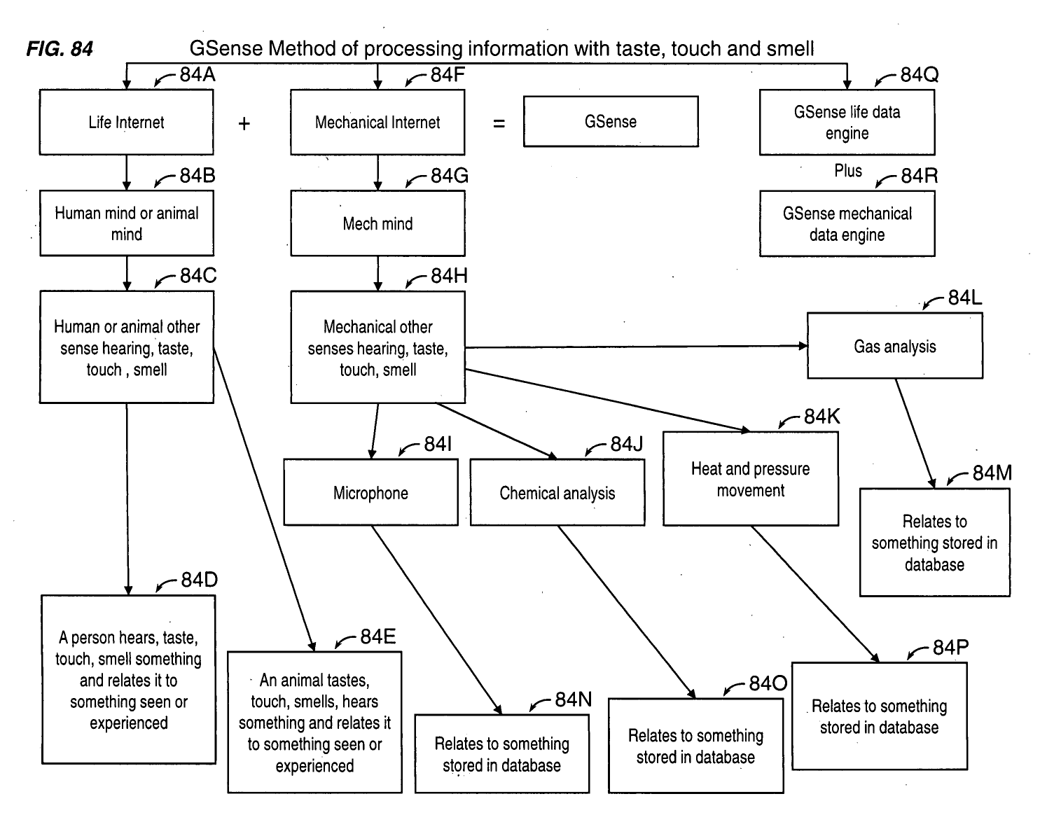

FIG. 84-84A describes how Life Internet data and Mechanical Internet data is processed into intelligent data with GSense mechanism and shows the life Internet.

FIG. 84-84B describes how Life Internet data and Mechanical Internet data is processed into intelligent data with GSense mechanism and shows the human mind or animal mind.

FIG. 84-84C describes how Life Internet data and Mechanical Internet data is processed into intelligent data with GSense mechanism and shows the human or animal or other senses hearing, taste, touch, smell.

FIG. 84-84D describes how Life Internet data and Mechanical Internet data is processed into intelligent data with GSense mechanism and shows a person hears, taste, touch, smell, something and relates it to something seen or experienced.

FIG. 84-84E describes how Life Internet data and Mechanical Internet data is processed into intelligent data with GSense mechanism and shows an animal hears, taste, touch, smell something and relates it to something its seeing or experienced.

FIG. 84-84F describes how Life Internet data and Mechanical Internet data is processed into intelligent data with GSense mechanism and shows the mechanical Internet.

FIG. 84-84G describes how Life Internet data and Mechanical Internet data is processed into intelligent data with GSense mechanism and shows the mechanical mind.

FIG. 84-84H describes how Life Internet data and Mechanical Internet data is processed into intelligent data with GSense mechanism and shows mechanical and other senses of hearing, taste, touch, smell.

FIG. 84-84I describes how Life Internet data and Mechanical Internet data is processed into intelligent data with GSense mechanism and shows utilizes microphone, chemical analysis sensors, motion heat and pressure sensors, and gas analysis sensors as related to something stored in a database.

FIG. 84-84J describes how Life Internet data and Mechanical Internet data is processed into intelligent data with GSense mechanism and shows chemical analysis as related to something stored in a database.

FIG. 84-84K describes how Life Internet data and Mechanical Internet data is processed into intelligent data with GSense mechanism and shows the GSense engine with GSense life data engine as related to heat pressure and motion sensors as related to something stored in a database.

FIG. 84-84L describes how Life Internet data and Mechanical Internet data is processed into intelligent data with GSense mechanism and shows the GSense life data engine plus GSense mechanical data engine as related to gas analysis as related to something stored in a database.

FIG. 84-84M describes how Life Internet data and Mechanical Internet data is processed into intelligent data with GSense mechanism and shows the GSense engine lines keywords in Web address or search keyword from mechanical Internet related to something stored in database from gas analysis.

FIG. 84-84N describes how Life Internet data and Mechanical Internet data is processed into intelligent data with GSense mechanism and shows the GSense life data engine as related to information from microphone stored in a database.

FIG. 84-84O describes how Life Internet data and Mechanical Internet data is processed into intelligent data with GSense mechanism and shows the GSense life data engine plus GSense mechanical data engine as related to the chemical analysis to something stored in database.

FIG. 84-84P describes how Life Internet data and Mechanical Internet data is processed into intelligent data with GSense mechanism and shows the GSense life data engine plus GSense mechanical data engine as related to information from stored in a mechanical Internet database.

FIG. 84-84Q describes how Life Internet data and Mechanical Internet data is processed into intelligent data with GSense mechanism and shows the GSense life data engine plus GSense mechanical data engine as related something stored in mechanical Internet database.

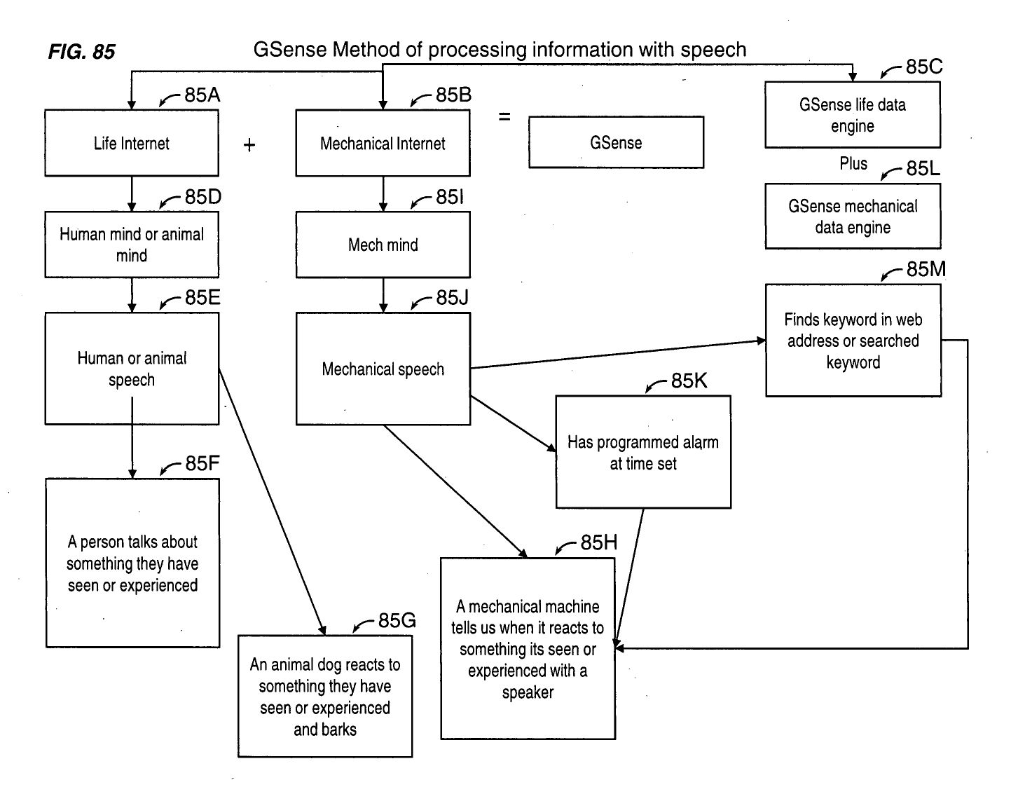

FIG. 85-85A describes how Life Internet data and Mechanical Internet data is processed into intelligent data with GSense mechanism and shows the life Internet.

FIG. 85-85B describes how Life Internet data and Mechanical Internet data is processed into intelligent data with GSense mechanism and shows the mechanical Internet.

FIG. 85-85C describes how Life Internet data and Mechanical Internet data is processed into intelligent data with GSense mechanism and shows the GSense life data engine with life Internet and mechanical Internet combined.

FIG. 85-85D describes how Life Internet data and Mechanical Internet data is processed into intelligent data with GSense mechanism and shows the human mind or animal mind.

FIG. 85-85E describes how Life Internet data and Mechanical Internet data is processed into intelligent data with GSense mechanism and shows human or animal speech or communication.

FIG. 85-85F describes how Life Internet data and Mechanical Internet data is processed into intelligent data with GSense mechanism and shows a person talks about something they have seen or experienced.

FIG. 85-85G describes how Life Internet data and Mechanical Internet data is processed into intelligent data with GSense mechanism and shows an animal example a dog reacts to something they have seen or experienced and barks.

FIG. 85-85H describes how Life Internet data and Mechanical Internet data is processed into intelligent data with GSense mechanism and shows a mechanical machine tells us when it reacts to something it seen or experienced with the speaker to communicate.

FIG. 85-85I describes how Life Internet data and Mechanical Internet data is processed into intelligent data with GSense mechanism and shows the mechanical mind.

FIG. 85-85J describes how Life Internet data and Mechanical Internet data is processed into intelligent data with GSense mechanism and shows mechanical speech.

FIG. 85-85K describes how Life Internet data and Mechanical Internet data is processed into intelligent data with GSense mechanism and shows as programmed alarm at time set or when they set of criteria is specified for sound to be created.

FIG. 85-85L describes how Life Internet data and Mechanical Internet data is processed into intelligent data with GSense mechanism and shows GSense life data engine plus GSense mechanical data engine.

FIG. 85-85M describes how Life Internet data and Mechanical Internet data is processed into intelligent data with GSense mechanism and shows GSense mechanism finds keyword in a web address or searched keyword in the mechanical Internet speech engine database.

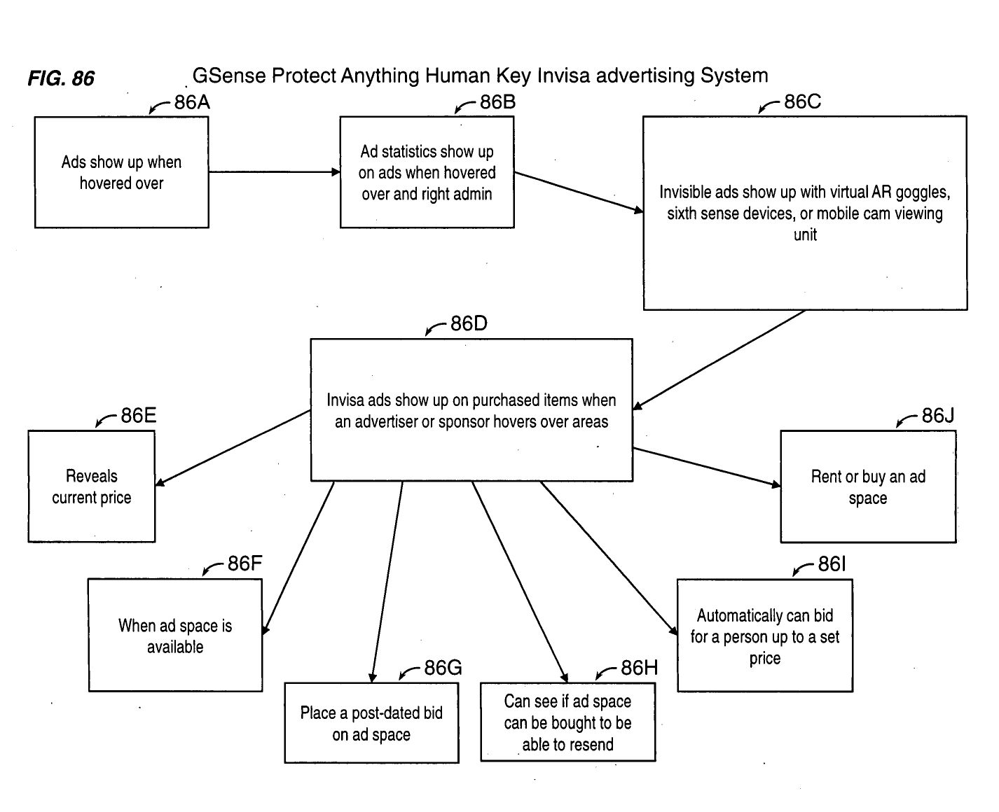

FIG. 86-86A describes GSense Invisa Advertising mechanism and shows ads show up when hovered over.

FIG. 86-86B describes GSense Invisa Advertising mechanism and shows add statistics show up what advertisements when hovered over and the right protected administrator is using it.

FIG. 86-86C describes GSense Invisa Advertising mechanism and shows invisible advertisements show up with virtual augmented reality goggles, six cents devices are mobile cam viewing unit.

FIG. 86-86D describes GSense Invisa Advertising mechanism and shows Invisa advertisements show out on purchased items when advertiser or sponsor hovers over areas.

FIG. 86-86E describes GSense Invisa Advertising mechanism and shows can reveal current price data.

FIG. 86-86F describes GSense Invisa Advertising mechanism and shows can reveal when advertising space is available.

FIG. 86-86G describes GSense Invisa Advertising mechanism and shows can reveal a place to place a postdated bid on any ad space specified.

FIG. 86-86H describes GSense Invisa Advertising mechanism and shows can see it at space can be bought to be able to be a reseller or renter.

FIG. 86-86I describes GSense Invisa Advertising mechanism and shows automatically can bid for a person up to a set price.

FIG. 86-86J describes GSense Invisa Advertising mechanism and shows where you can rent or buy and advertising space with the mechanism.

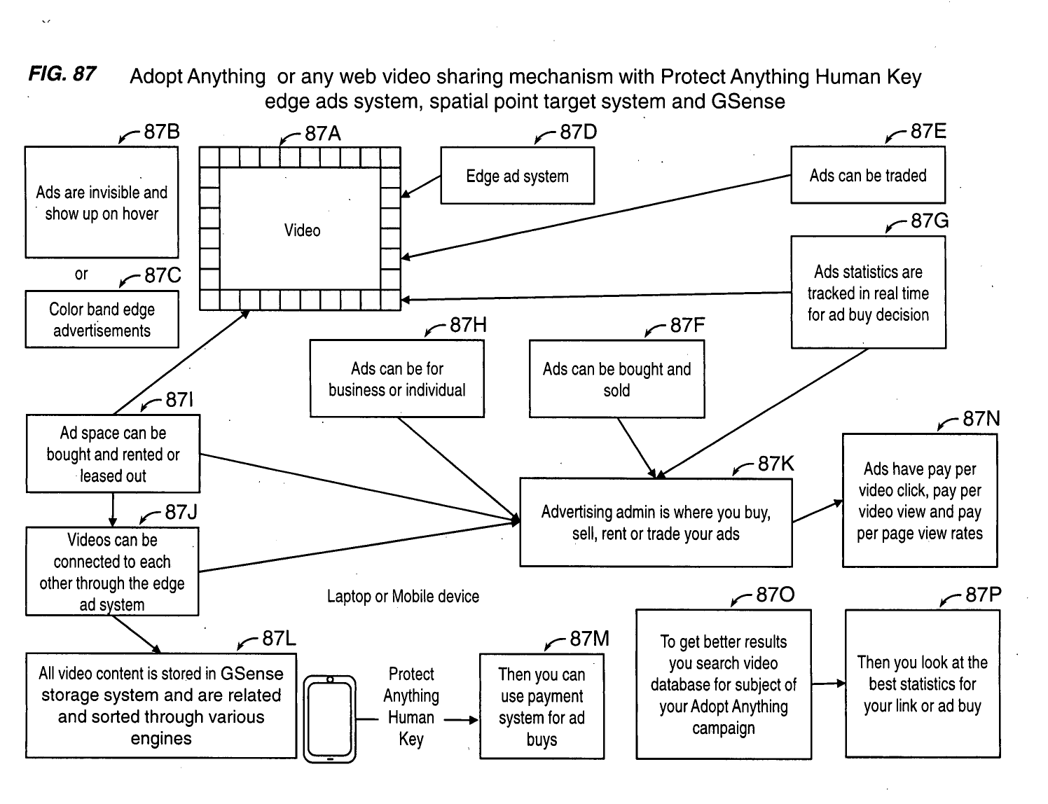

FIG. 87-87A describes Adopt Anything campaign or any campaign or Independent Video Sharing mechanism with Protect Anything Human Key, edge Advertising System, Spatial Point Target System with GSense mechanism and shows the video with edge advertisements in color band or invisible.

FIG. 87-87B describes Adopt Anything campaign or any campaign or Independent Video Sharing mechanism with Protect Anything Human Key, edge Advertising System, Spatial Point Target System with GSense mechanism and shows ads are invisible and show up on hover or as color bands or blocks.

FIG. 87-87C describes Adopt Anything campaign or any campaign or Independent Video Sharing mechanism with Protect Anything Human Key, edge Advertising System, Spatial Point Target System with GSense mechanism and shows colored band or blocks.

FIG. 87-87D describes Adopt Anything campaign or any campaign or Independent Video Sharing mechanism with Protect Anything Human Key, edge Advertising System, Spatial Point Target System with GSense mechanism and shows the edge advertisement system.

FIG. 87-87E describes Adopt Anything campaign or any campaign or Independent Video Sharing mechanism with Protect Anything Human Key, edge Advertising System, Spatial Point Target System with GSense mechanism and shows ads can be traded and sold or rented.

FIG. 87-87F describes Adopt Anything campaign or any campaign or Independent Video Sharing mechanism with Protect Anything Human Key, edge Advertising System, Spatial Point Target System with GSense mechanism and shows ads can be bought and sold.

FIG. 87-87G describes Adopt Anything campaign or any campaign or Independent Video Sharing mechanism with Protect Anything Human Key, edge Advertising System, Spatial Point Target System with GSense mechanism and shows advertising statistics are tracked in real time for advertising buying decisions.

FIG. 87-87H describes Adopt Anything campaign or any campaign or Independent Video Sharing mechanism with Protect Anything Human Key, edge Advertising System, Spatial Point Target System with GSense mechanism and shows ads can be or business or individuals who want to make a comment or show their new things.

FIG. 87-87I describes Adopt Anything campaign or any campaign or Independent Video Sharing mechanism with Protect Anything Human Key, edge Advertising System, Spatial Point Target System with GSense mechanism and shows advertising space can be bought and rented or leased out like real estate.

FIG. 87-87J describes Adopt Anything campaign or any campaign or Independent Video Sharing mechanism with Protect Anything Human Key, edge Advertising System, Spatial Point Target System with GSense mechanism and shows videos can be connected to each other through the edge advertising system.

FIG. 87-87K describes Adopt Anything campaign or any campaign or Independent Video Sharing mechanism with Protect Anything Human Key, edge Advertising System, Spatial Point Target System with GSense mechanism and shows advertising administration area is where you buy, sell, rent or trade your advertisements.

FIG. 87-87L describes Adopt Anything campaign or any campaign or Independent Video Sharing mechanism with Protect Anything Human Key, edge Advertising System, Spatial Point Target System with GSense mechanism and shows all video content is stored in GSense storage system and are related and store the through various analysis engines are proper reliable distribution.

FIG. 87-87M describes Adopt Anything campaign or any campaign or Independent Video Sharing mechanism with Protect Anything Human Key, edge Advertising System, Spatial Point Target System with GSense mechanism and shows then using the protect ID system you can use a payment system protected or advertising buys and placement.

FIG. 87-87N describes Adopt Anything campaign or any campaign or Independent Video Sharing mechanism with Protect Anything Human Key, edge Advertising System, Spatial Point Target System with GSense mechanism and shows advertising purchases can have video pay per click, video pay per view, and video pay per page view rates.

FIG. 87-87O describes Adopt Anything campaign or any campaign or Independent Video Sharing mechanism with Protect Anything Human Key, edge Advertising System, Spatial Point Target System with GSense mechanism and shows to get better results you search video database or subject of your Adopt Anything campaign or any campaign, or Independent video interests.

FIG. 87-87P describes Adopt Anything campaign or any campaign or Independent Video Sharing mechanism with Protect Anything Human Key, edge Advertising System, Spatial Point Target System with GSense mechanism and shows then you look at the best statistics for your link or advertising purchase or buy.

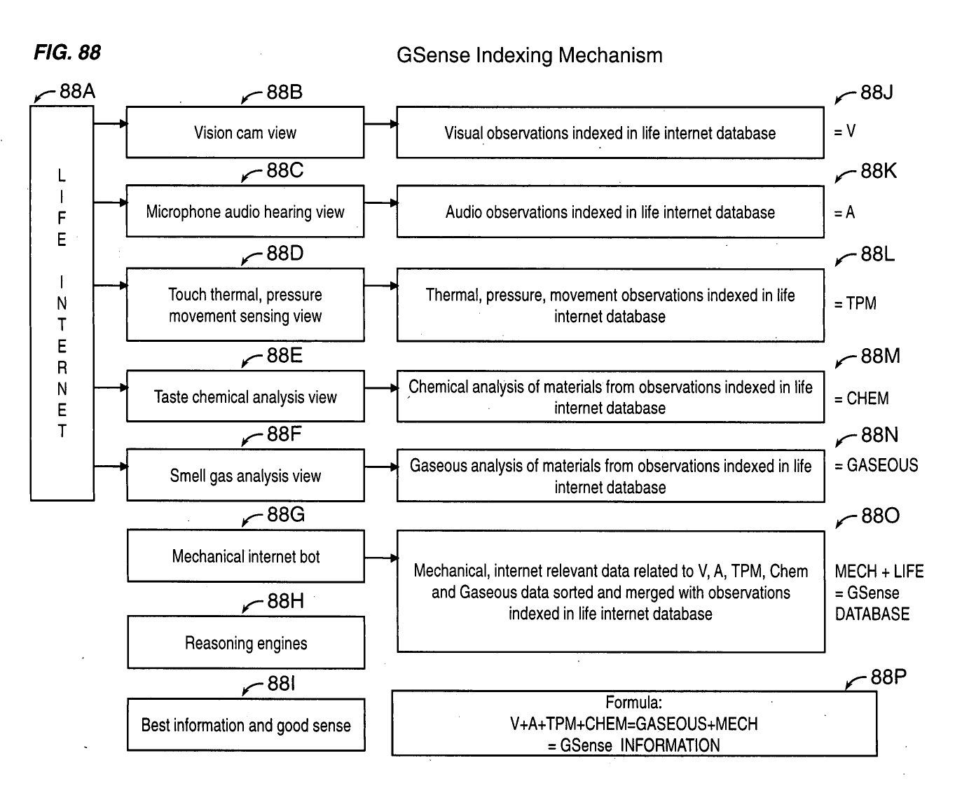

FIG. 88-88A describes GSense Indexing mechanism and shows the life Internet aggregator utilizing various input devices.

FIG. 88-88B describes GSense Indexing mechanism and shows visioned cam view input device.

FIG. 88-88C describes GSense Indexing mechanism and shows microphone audio hearing view input device.

FIG. 88-88D describes GSense Indexing mechanism and shows the touch thermal, pressure movement sensing viewing input device.

FIG. 88-88E describes GSense Indexing mechanism and shows the taste chemical analysis view input device.

FIG. 88-88F describes GSense Indexing mechanism and shows the smell gas analysis you input device.

FIG. 88-88G describes GSense Indexing mechanism and shows the mechanical Internet bot input device.

FIG. 88-88H describes GSense Indexing mechanism and shows the reasoning engines input device.

FIG. 88-88I describes GSense Indexing mechanism and shows the best information and good sense input device.

FIG. 88-88J describes GSense Indexing mechanism and shows where the vision cam view input device takes visual observations indexed from the life Internet database and equals the letter V.

FIG. 88-88K describes GSense Indexing mechanism and shows where the microphone audio hearing view input device takes audio observations indexed and the life Internet database and equals the letter A.

FIG. 88-88L describes GSense Indexing mechanism and shows where the touch thermal. Pressure movement sensing view input device takes thermal, pressure and movement observations indexed and the life Internet database and equals the letters TPM.

FIG. 88-88M describes GSense Indexing mechanism and shows where the taste chemical analysis view input device takes be chemical analysis of materials from observations indexed in the life Internet database and equals the letters CHEM.

FIG. 88-88N describes GSense Indexing mechanism and shows where the smell gas analysis view input device takes gaseous analysis of materials from observations indexed in life Internet database and equals the letters GASEOUS.

FIG. 88-88O describes GSense Indexing mechanism and shows where the mechanical Internet bot input device takes mechanical Internet relevant data related to V, A, TPM, CHEM, and GASEOUS data sorted and merged with observations indexed in the life Internet database and equals MECH+LIFE=GSense Database.

FIG. 88-88P describes GSense Indexing mechanism and shows the formula: V+A+TPM+CHEM+GASEOUS+MECH=GSense information.

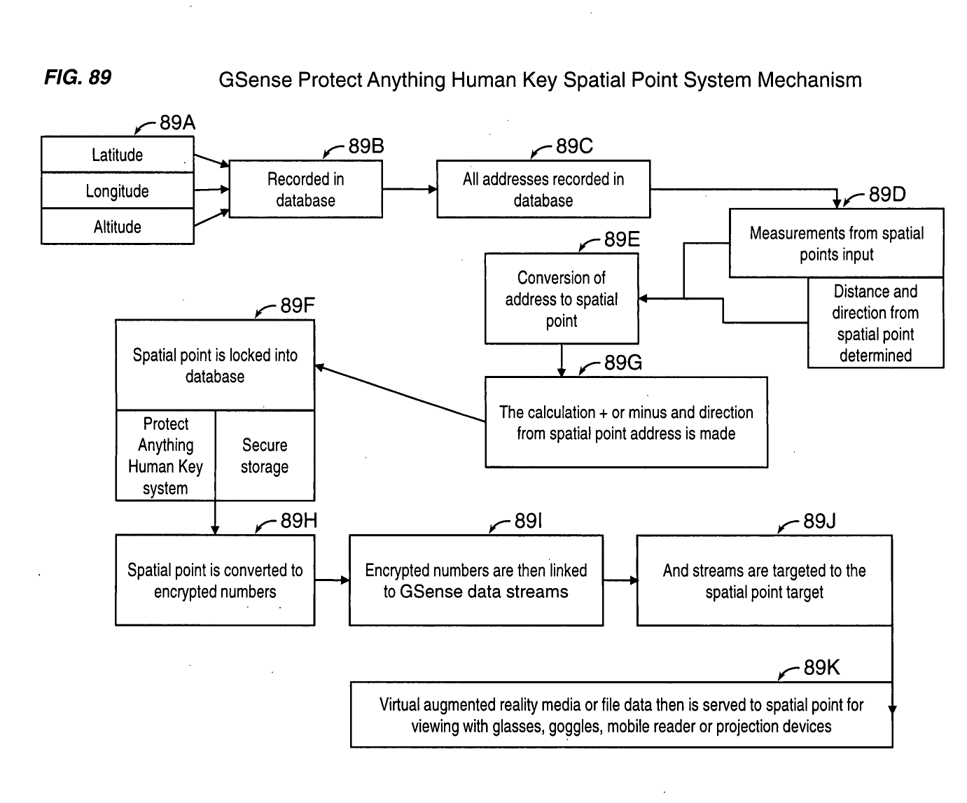

FIG. 89-89A describes GSense Protect Anything Human Key Spatial Point Targeting system and mechanism and shows latitude, longitude, altitude input and recorded and GSense database.

FIG. 89-89B describes GSense Protect Anything Human Key Spatial Point Targeting system and mechanism and shows where relationships for all addresses are recorded in database as reference point.

FIG. 89-89C describes GSense Protect Anything Human Key Spatial Point Targeting system and mechanism and shows all addresses are connected to longitude latitude and altitude data as a target reference point.

FIG. 89-89D describes GSense Protect Anything Human Key Spatial Point Targeting system and mechanism and shows where measurements from spatial points that are target starting points input plus distance and direction from spatial point is determined for new target as related to user input data.

FIG. 89-89E describes GSense Protect Anything Human Key Spatial Point Targeting system and mechanism and shows where a conversion of and address plus new measurement target point with user input data becomes listed public or private spatial point.

FIG. 89-89F describes GSense Protect Anything Human Key Spatial Point Targeting system and mechanism and shows where spatial point is locked into the database utilizing the protect ID system plus secure storage.

FIG. 89-89G describes GSense Protect Anything Human Key Spatial Point Targeting system and mechanism and shows where the calculation plus or minus and direction from spatial point address is made as related to user input.

FIG. 89-89H describes GSense Protect Anything Human Key Spatial Point Targeting system and mechanism and shows where spatial point target is converted to encrypted numbers.

FIG. 89-89I describes GSense Protect Anything Human Key Spatial Point Targeting system and mechanism and shows where encrypted numbers are then linked to GSense data streams, downloads, feeds, viewing, broadcasting.

FIG. 89-89J describes GSense Protect Anything Human Key Spatial Point Targeting system and mechanism and shows where the GSense data streams, downloads, feeds, viewing, or broadcasting are targeted to the spatial point target.

FIG. 89-89K describes GSense Protect Anything Human Key Spatial Point Targeting system and mechanism and shows where the GSense virtual augmented reality, data streams, downloads, feeds, viewing, broadcasting media or file data is served to spatial point for viewing with special classes, goggles, mobile device reader viewer, or special projection devices.

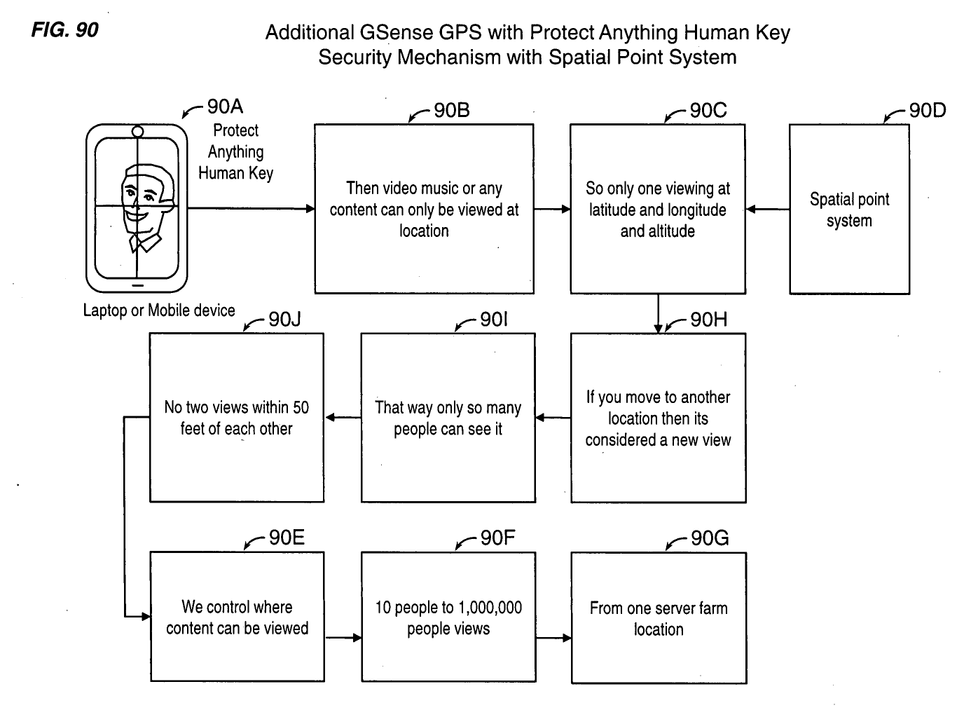

FIG. 90-90A describes Additional GSense Spatial Point target Protect Anything Human Key identification security mechanism and shows a mobile device but cam and microphone with crosshairs for Protect Anything Human Key identification.

FIG. 90-90B describes Additional GSense Spatial Point target Protect Anything Human Key identification security mechanism and shows where and audio music file or video file or any content can only be viewed at any specified target location.

FIG. 90-90C describes Additional GSense Spatial Point target Protect Anything Human Key identification security mechanism and shows that so only one viewing at latitude, longitude and altitude.

FIG. 90-90D describes Additional GSense Spatial Point target Protect Anything Human Key identification security mechanism and shows where the viewer goes through the Protect Anything Human Key GSense spatial point system.

FIG. 90-90E describes Additional GSense Spatial Point target Protect Anything Human Key identification security mechanism and shows where content can only be controlled from originating server definitively at a specific spatial point.

FIG. 90-90F describes Additional GSense Spatial Point target Protect Anything Human Key identification security mechanism and shows where one person to a group of persons to millions of people can view content broadcast to a specific spatial point.

FIG. 90-90G describes Additional GSense Spatial Point target Protect Anything Human Key identification security mechanism and shows where the broadcast can originate from one server farm location with permissions through Protect Anything Human Key identification system.

FIG. 90-90H describes Additional GSense Spatial Point target Protect Anything Human Key identification security mechanism and shows you can move to another location then is considered a new view, an example would be a spatial point can be set up in the theater where each seat would have a spatial point assigned to it so only someone sitting or standing in that seat depending upon spatial point targets and coordinates.

FIG. 90-90I describes Additional GSense Spatial Point target Protect Anything Human Key identification security mechanism and shows that this GSense Protect Anything Human Key mechanism controls only so many people can see the content or media.

FIG. 90-90J describes Additional GSense Spatial Point target Protect Anything Human Key identification security mechanism and shows where the system can be set up so that no two views can happen within 50 feet of each other or any set distance.

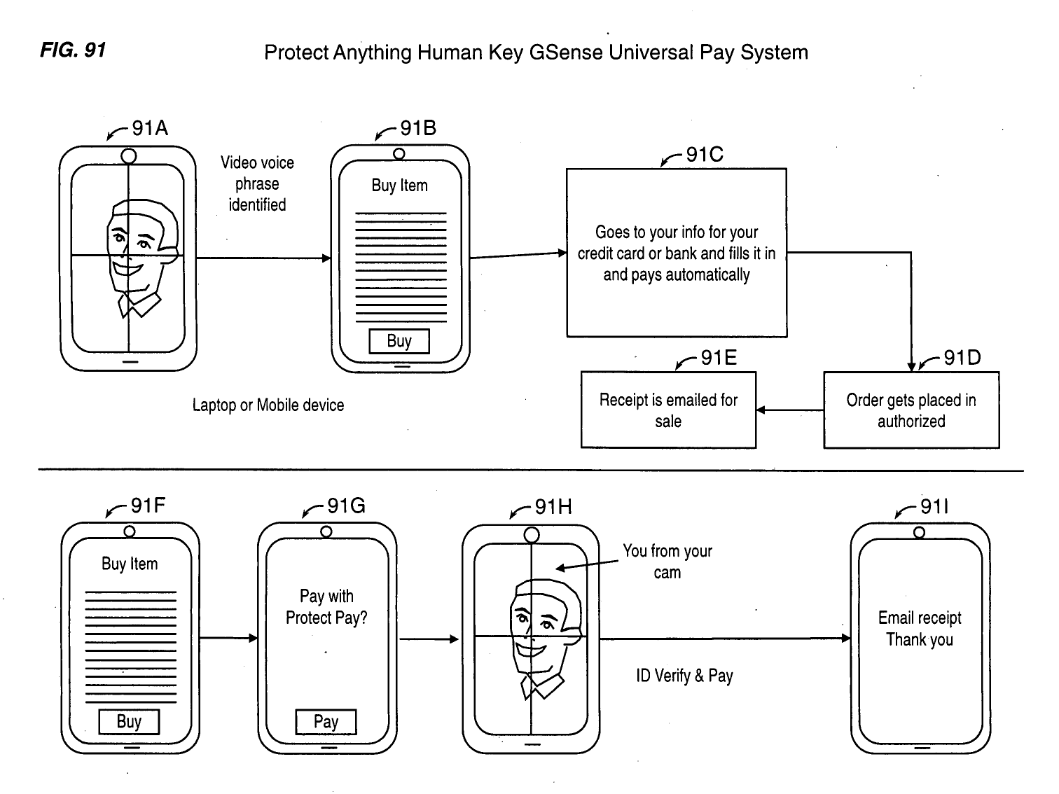

FIG. 91-91A describes Protect Anything Human Key GSense Universal pay System and shows a mobile device with a cam and microphone the crosshairs for identification with Protect Anything Human Key mechanism.

FIG. 91-91B describes Protect Anything Human Key GSense Universal pay System and shows where you can simply push buy after viewing products and services.

FIG. 91-91C describes Protect Anything Human Key GSense Universal pay System and shows then because you are signed in to the system through Protect Anything Human Key identification mechanism it goes to your information for your credit card or direct bank payment and automatically fills it in and pays automatically.

FIG. 91-91D describes Protect Anything Human Key GSense Universal pay System and shows order getting placed through merchant account for bank payment or credit card payment.

FIG. 91-91E describes Protect Anything Human Key GSense Universal pay System and shows where the receipt is automatically e-mailed with confirmation of payment for the sale.

FIG. 91-91F describes Protect Anything Human Key GSense Universal pay System and shows the different mobile device screens like buy item with buy button.

FIG. 91-91G describes Protect Anything Human Key GSense Universal pay System and shows another screen, mobile device pay with protect pay? And a pay button.

FIG. 91-91H describes Protect Anything Human Key GSense Universal pay System and shows where you are the card with a mobile device as a cam and a microphone and crosshairs through Protect Anything Human Key identification verify and pay.

FIG. 91-91I describes Protect Anything Human Key GSense Universal pay System and shows the mobile device screen confirming an e-mail has been sent to you and saying thank you.

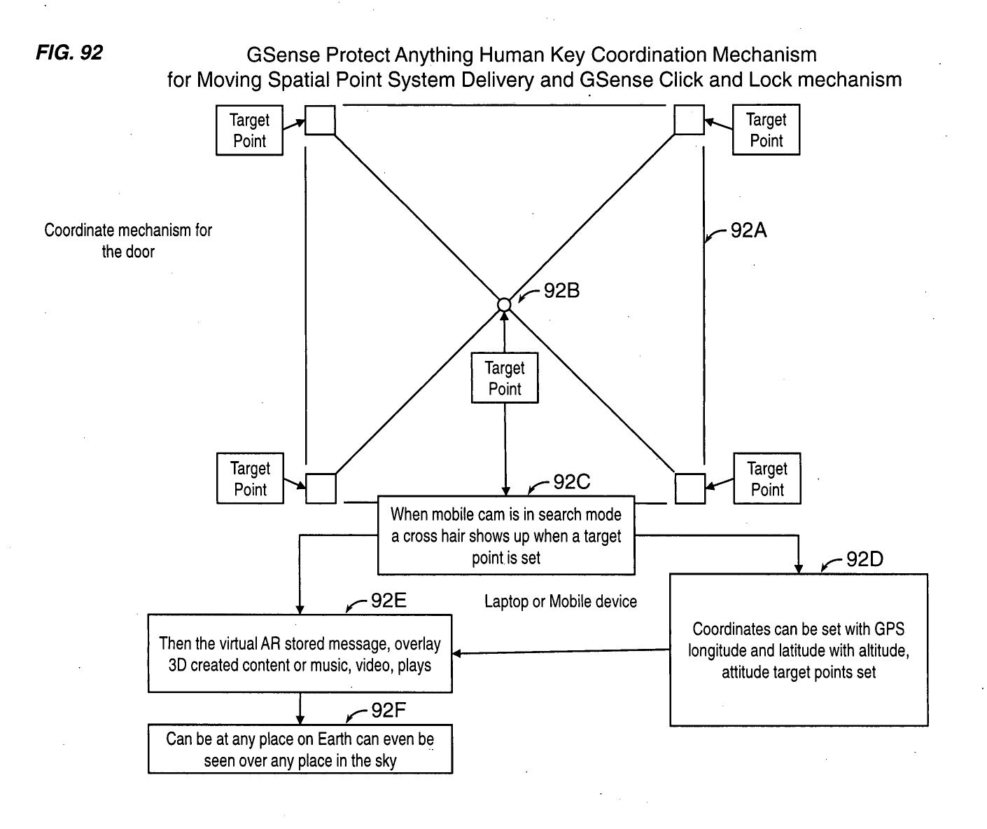

FIG. 92-92A describes coordination mechanism for moving Spatial Point Target System Delivery with GSense mechanism and shows where you take your mobile device and point at a target point and lock-in.

FIG. 92-92B describes coordination mechanism for moving Spatial Point Target System Delivery with GSense mechanism and shows where you take your mobile device and point any second target and point and lock-in.

FIG. 92-92C describes coordination mechanism for moving Spatial Point Target System Delivery with GSense mechanism and shows when mobile cam is in search mode a cross hair shows up when a target point is set at this point you can stream data or media or get reminders or anything.

FIG. 92-92D describes coordination mechanism for moving Spatial Point Target System Delivery with GSense mechanism and shows coordinates are set up with latitude, longitude altitude target points set broadcasting in Protect Anything Human Key GSense spatial points system.

FIG. 92-92E describes coordination mechanism for moving Spatial Point Target System Delivery with GSense mechanism and shows then the virtual augmented reality stored message, overlay, 3-D create content, or music video or any other media files play which proper permissions or not.

FIG. 92-92F describes coordination mechanism for moving Spatial Point Target System Delivery with GSense mechanism and shows where spatial points can be selected and can be locked in at any place on the earth can even be seen over any place in the sky and on any moving spatial point target.

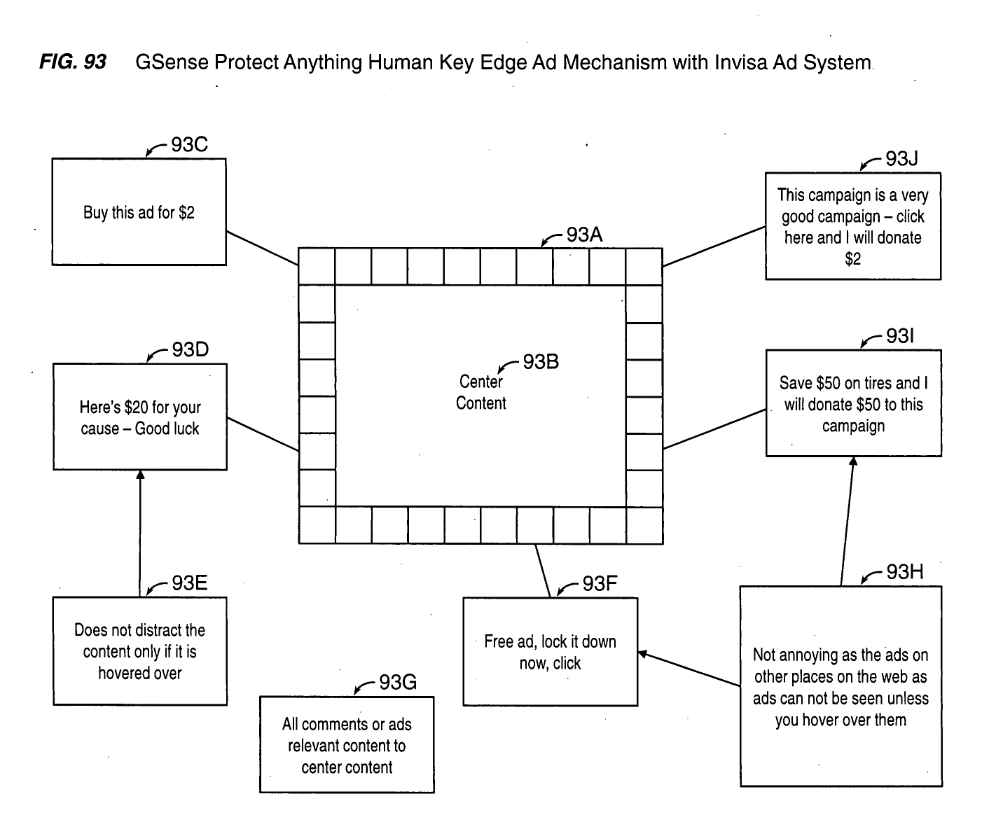

FIG. 93-93A describes GSense Edge Ad comment Mechanism with Invisa Ad System And Color Band Mechanism and shows the GSense advertising and comment system with invisible or color ad points.

FIG. 93-93B describes GSense Edge Ad comment Mechanism with Invisa Ad System And Color Band Mechanism and shows where the center area is reserved for content.

FIG. 93-93C describes GSense Edge Ad comment Mechanism with Invisa Ad comment System And Color Band Mechanism and shows where you can hover over and buy this advertisement space for two dollars for a specified amount of time and during that time you can rent or lease out the space for any amount you want.

FIG. 93-93D describes GSense Edge Ad comment Mechanism with Invisa Ad System And Color Band Mechanism and shows where after donating money to an Adopt Anything campaign or any campaign that is in the center content area you can make a comment like here's $20 for your cause good luck.

FIG. 93-93E describes GSense Edge Ad comment Mechanism with Invisa Ad System And Color Band Mechanism and shows where the advertisement does not distract the content is only seen when this is hovered over.

FIG. 93-93F describes GSense Edge Ad comment Mechanism with Invisa Ad System And Color Band Mechanism and shows where there can be a free advertisement click here lock-in now.

FIG. 93-93G describes GSense Edge Ad comment Mechanism with Invisa Ad System And Color Band Mechanism and shows where all comments are advertisements are relevant to content in the center area.

FIG. 93-93H describes GSense Edge Ad comment Mechanism with Invisa Ad System And Color Band Mechanism and shows non-annoying as the advertisements or comments on other places on the web as advertisements can not be seen unless you hover over them.

FIG. 93-93I describes GSense Edge Ad comment Mechanism with Invisa Ad System And Color Band Mechanism and shows Adopt Anything campaign or any campaign sponsor advertisement, save 50 dollars on new tires and I will donate $50 to this Adopt Anything campaign or any campaign.

FIG. 93-93J describes GSense Edge Ad comment Mechanism with Invisa Ad System And Color Band Mechanism and shows where another Adopt Anything campaign or any campaign owner can promote his campaign, an example, this campaign is very good campaign click here and view my campaign and I will donate two dollars to this campaign.

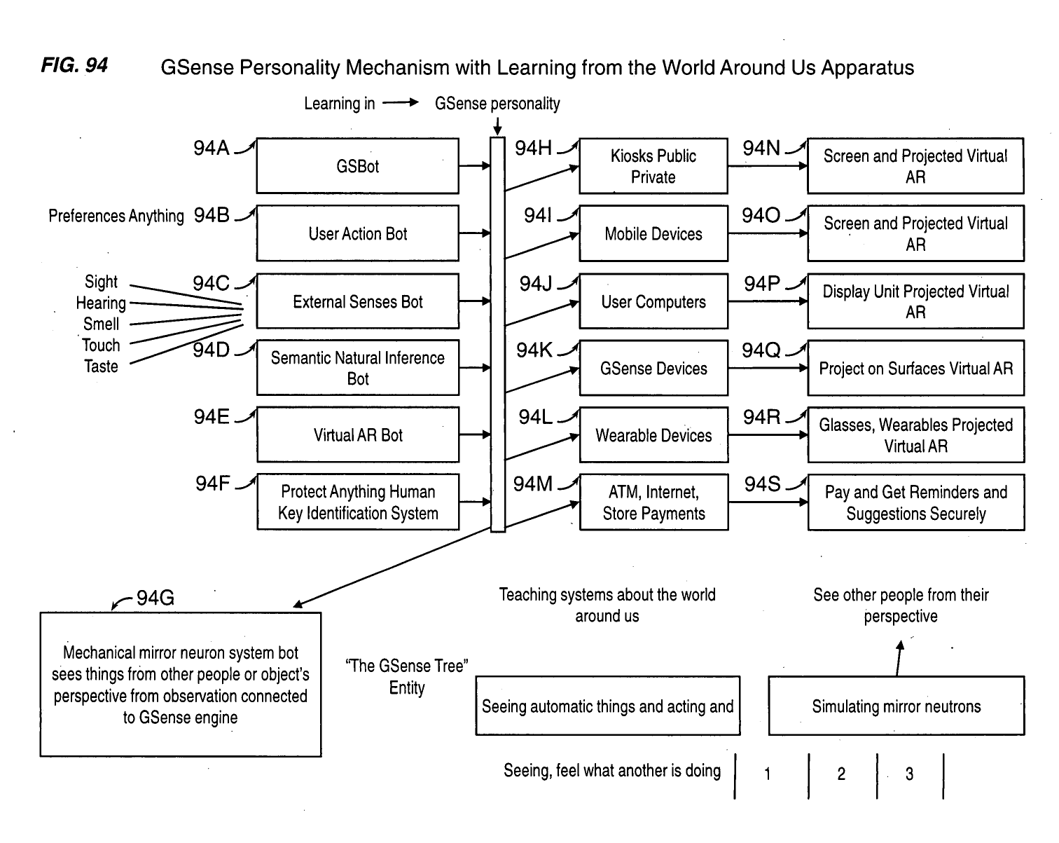

FIG. 94-94A describes the GSense Personality Mechanism with Learning from the World Around Us Apparatus and shows the GS bot learning into the GSense personality.

FIG. 94-94B describes the GSense Personality Mechanism with Learning from the World Around Us Apparatus and shows the user actions bot learning into the GSense personality.

FIG. 94-94C describes the GSense Personality Mechanism with Learning from the World Around Us Apparatus and shows the external senses bot with sight, hearing, smell, touch, and taste learning into the GSense personality.

FIG. 94-94D describes the GSense Personality Mechanism with Learning from the World Around Us Apparatus and shows the semantic natural inference bot learning into the GSense personality.

FIG. 94-94E describes the GSense Personality Mechanism with Learning from the World Around Us Apparatus and shows the virtual augmented reality bot learning into the GSense personality.

FIG. 94-94F describes the GSense Personality Mechanism with Learning from the World Around Us Apparatus and shows the Protect Anything Human Key identification system managing learning into the GSense personality.

FIG. 94-94G describes the GSense Personality Mechanism with Learning from the World Around Us Apparatus and shows the mechanical mirror neuron system bot that sees things from other people or objects perspective from observation connected to the Life Internet and the GSense engine learning into the GSense personality.

FIG. 94-94H describes the GSense Personality Mechanism with Learning from the World Around Us Apparatus and shows kiosks public or private getting data from the GSense personality.

FIG. 94-94I describes the GSense Personality Mechanism with Learning from the World Around Us Apparatus and shows mobile devices getting data from the GSense personality.

FIG. 94-94J describes the GSense Personality Mechanism with Learning from the World Around Us Apparatus and shows user computers getting data from the GSense personality.

FIG. 94-94K describes the GSense Personality Mechanism with Learning from the World Around Us Apparatus and shows projection devices getting data from the GSense personality.

FIG. 94-94L describes the GSense Personality Mechanism with Learning from the World Around Us Apparatus and shows wearable devices getting data from the GSense personality.

FIG. 94-94M describes the GSense Personality Mechanism with Learning from the World Around Us Apparatus and shows bank ATMs Internet stores payments getting data from the GSense personality.

FIG. 94-94N describes the GSense Personality Mechanism with Learning from the World Around Us Apparatus and shows screen and projected virtual augmented reality data from kiosks public or private data from the GSense personality.

FIG. 94-94O describes the GSense Personality Mechanism with Learning from the World Around Us Apparatus and shows screen and projected virtual augmented reality data from mobile devices data from the GSense personality.

FIG. 94-94P describes the GSense Personality Mechanism with Learning from the World Around Us Apparatus and shows screen display unit and projected virtual augmented reality data from user computers with data from the GSense personality.

FIG. 94-94Q describes the GSense Personality Mechanism with Learning from the World Around Us Apparatus and shows screen and projected virtual augmented reality data on surfaces from projectors with data from the GSense personality.

FIG. 94-94R describes the GSense Personality Mechanism with Learning from the World Around Us Apparatus and shows glasses, wearables and projected virtual augmented reality data from wearable devices with data from the GSense personality.

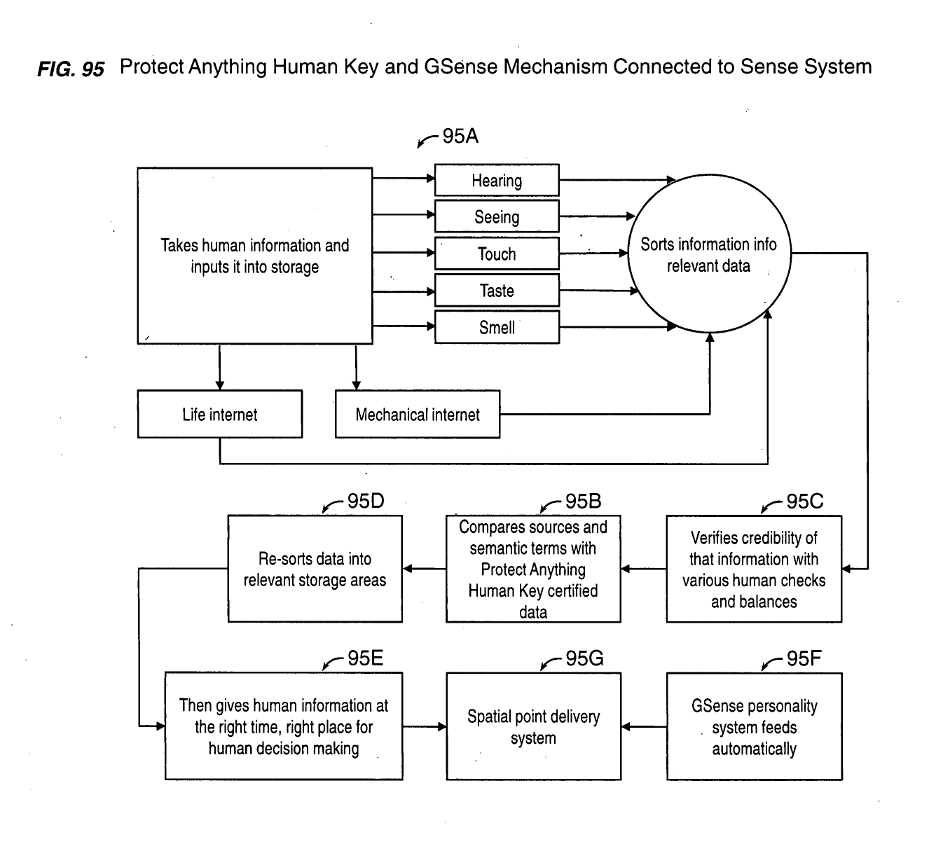

FIG. 95-95A describes how Protect Anything Human Key and GSense mechanism is connected to the sense system and shows how the system takes human information in implicit into storage the mechanism takes hearing, seeing, touching, taste, smell, life Internet, the mechanical Internet and sorts all information into relevant data areas.

FIG. 95-95B describes how Protect Anything Human Key and GSense mechanism is connected to the sense system and shows where the mechanism compares sources and semantic terms with Protect Anything Human Key certified data.

FIG. 95-95C describes how Protect Anything Human Key and GSense mechanism is connected to the sense system and shows where the mechanism verifies the credibility of that information with various human checks and balances built-in to be mechanism automatically.

FIG. 95-95D describes how Protect Anything Human Key and GSense mechanism is connected to the sense system and shows where the mechanism sorts again the data into relevant storage areas.

FIG. 95-95E describes how Protect Anything Human Key and GSense mechanism is connected to the sense system and shows the system then gives human information at the right time, right place for enhancing human decision making.

FIG. 95-95F describes how Protect Anything Human Key and GSense mechanism is connected to the sense system and shows that the GSense personality system feeds the relevant information automatically.

FIG. 95-95G describes how Protect Anything Human Key and GSense mechanism is connected to the sense system and shows that relevant information can be targeted with the spatial point delivery system mechanism.

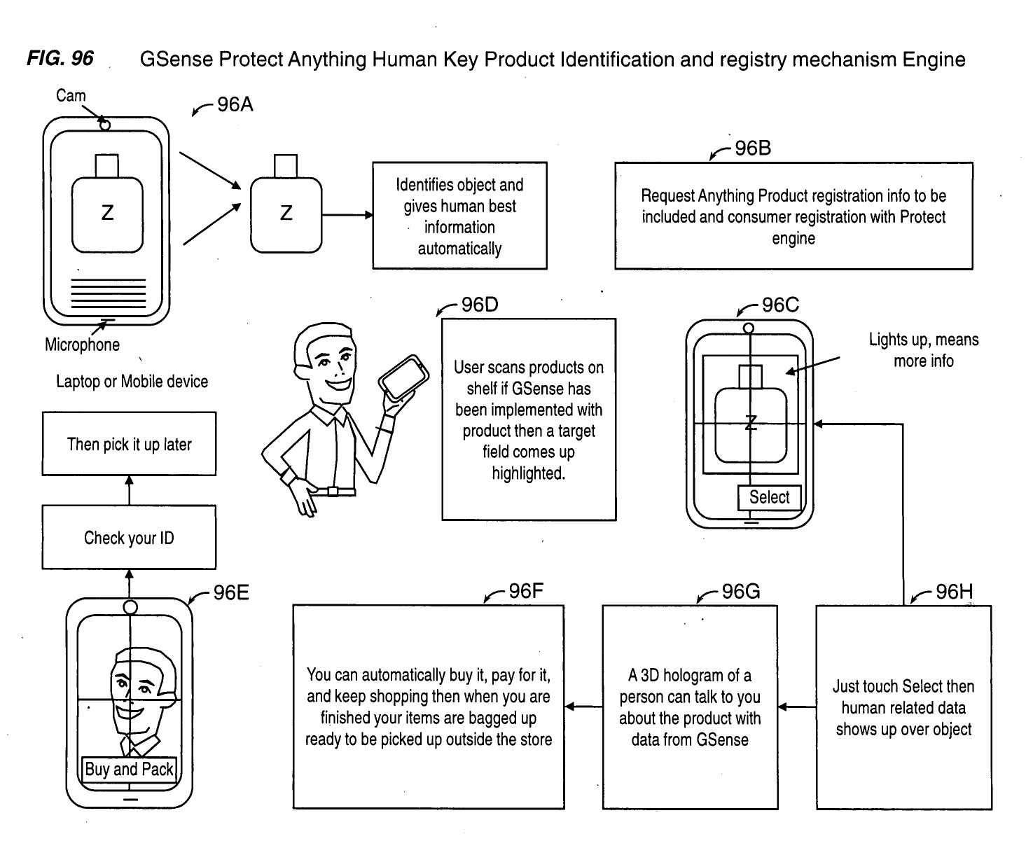

FIG. 96-96A describes GSense Product Identification and registry mechanism Engine and shows a mobile device with cam and microphone or laptop centering the product in the center of the screen the system identifies object and gives human best information automatically.

FIG. 96-96B describes GSense Product Identification and registry mechanism Engine and shows that are of the product registration entire to be included and consumer registration with protect engine for certification or identification.

FIG. 96-96C describes GSense Product Identification and registry mechanism Engine and shows that when product is centered in screen of mobile device or laptop object lights up which means there is more information about the product and if you would like more information just select the select button.

FIG. 96-96D describes GSense Product Identification and registry mechanism Engine and shows the user scans products on shelves if GSense has been implemented with product then they target field comes up highlighted.

FIG. 96-96E describes GSense Product Identification and registry mechanism Engine and shows where you can buy item then take it later outside the store or have it mailed or shipped to you from the Internet, it first checks your Protect Anything Human Key identification and verifies you, and can pay for it directly out of your bank or with credit card account.

FIG. 96-96F describes GSense Product Identification and registry mechanism Engine and shows where you can automatically buy it, pay for it, and keep shopping then when you are finished your items are bagged up or packed ready to be picked up outside the store.

FIG. 96-96G describes GSense Product Identification and registry mechanism Engine and shows a 3-D hologram like view of a person can talk to you about the product with data from GSense like having a personal shopper or assistant.

FIG. 96-96H describes GSense Product Identification and registry mechanism Engine and shows you just touch select then human related data shares up over the object or product.

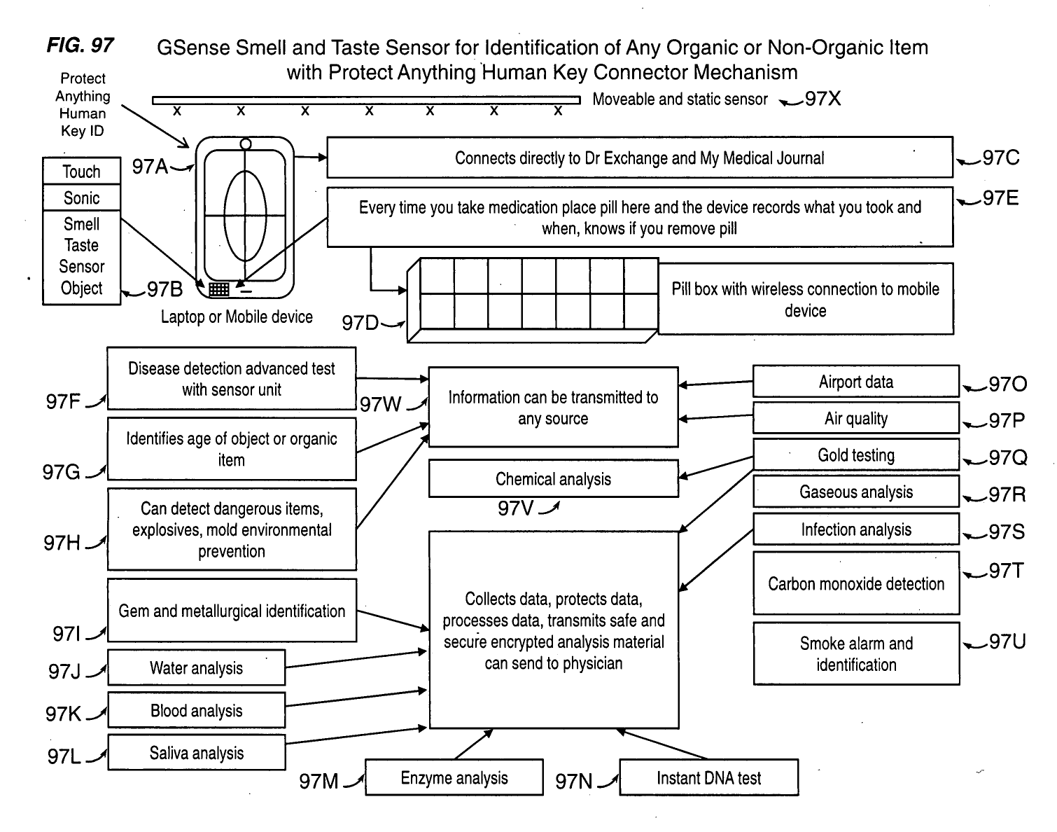

FIG. 97-97A describes GSense Smell and Taste Sensor for Identification of Any Organic or Non-Organic Item with Protect Anything Human Key Connector Mechanism and shows the mobile device with cam and microphone and GSense sensor unit.

FIG. 97-97B describes GSense Smell and Taste Sensor for Identification of Any Organic or Non-Organic Item with Protect Anything Human Key Connector Mechanism and shows the GSense sensor mechanism with touch, sonic, smell, taste sensitivities for analysis connected to GSense system for identification.

FIG. 97-97C describes GSense Smell and Taste Sensor for Identification of Any Organic or Non-Organic Item with Protect Anything Human Key Connector Mechanism and shows where the GSense sensors can connect directly to the Dr. exchange for Dr. evaluations and records, and my medical Journal, with proper permissions and Protect Anything Human Key identification module verification.

FIG. 97-97D describes GSense Smell and Taste Sensor for Identification of Any Organic or Non-Organic Item with Protect Anything Human Key Connector Mechanism and shows a smart pillbox with wireless connection to your mobile device or laptop that can record and identify what medications you're taking and when automatically it can know if you remove pills or medication.

FIG. 97-97E describes GSense Smell and Taste Sensor for Identification of Any Organic or Non-Organic Item with Protect Anything Human Key Connector Mechanism and shows how every time you take your medication you just place the medication pill or other on the GSense organic sensor device and the device automatically records when it is in win you took it.

FIG. 97-97F describes GSense Smell and Taste Sensor for Identification of Any Organic or Non-Organic Item with Protect Anything Human Key Connector Mechanism and shows that the GSense organic sensor device can help in disease detection by doing advanced gaseous enzyme tests from the sensor unit of blood, saliva, or any other material used for testing.

FIG. 97-97G describes GSense Smell and Taste Sensor for Identification of Any Organic or Non-Organic Item with Protect Anything Human Key Connector Mechanism and shows how the GSense organic sensor device can identify the age of and object or organic item.

FIG. 97-97H describes GSense Smell and Taste Sensor for Identification of Any Organic or Non-Organic Item with Protect Anything Human Key Connector Mechanism and shows that the GSense sensor mechanism can detect dangerous items like explosives, mold, or other environmental prevention things.

FIG. 97-97I describes GSense Smell and Taste Sensor for Identification of Any Organic or Non-Organic Item with Protect Anything Human Key Connector Mechanism and shows the GSense sensor device can identify channels and metallurgical identification.

FIG. 97-97J describes GSense Smell and Taste Sensor for Identification of Any Organic or Non-Organic Item with Protect Anything Human Key Connector Mechanism and shows the GSense sensor mechanism can do water analysis with washable special sensor cup.

FIG. 97-97K describes GSense Smell and Taste Sensor for Identification of Any Organic or Non-Organic Item with Protect Anything Human Key Connector Mechanism and shows that GSense sensor mechanism can do blood analysis with washable special sensor cup.

FIG. 97-97L describes GSense Smell and Taste Sensor for Identification of Any Organic or Non-Organic Item with Protect Anything Human Key Connector Mechanism and shows that that GSense sensor mechanism can do saliva analysis with washable special sensor cup.

FIG. 97-97M describes GSense Smell and Taste Sensor for Identification of Any Organic or Non-Organic Item with Protect Anything Human Key Connector Mechanism and shows that that GSense sensor mechanism can do enzyme analysis with washable special sensor cup and molecular vapor evaluation for disease identification.

FIG. 97-97N describes GSense Smell and Taste Sensor for Identification of Any Organic or Non-Organic Item with Protect Anything Human Key Connector Mechanism and shows that the GSense sensor mechanism can do instant DNA testing with special sensor cup and DNA evaluator mechanism.

FIG. 97-97O describes GSense Smell and Taste Sensor for Identification of Any Organic or Non-Organic Item with Protect Anything Human Key Connector Mechanism and shows the GSense sensor evaluation mechanism can be used for airport security data analysis.

FIG. 97-97P describes GSense Smell and Taste Sensor for Identification of Any Organic or Non-Organic Item with Protect Anything Human Key Connector Mechanism and shows the GSense sensor evaluation mechanism can be used for air quality testing utilizing a mobile device.

FIG. 97-97Q describes GSense Smell and Taste Sensor for Identification of Any Organic or Non-Organic Item with Protect Anything Human Key Connector Mechanism and shows the GSense sensor evaluation mechanism can be used for gold or silver testing or any other metal or precious metal evaluation.

FIG. 97-97R describes GSense Smell and Taste Sensor for Identification of Any Organic or Non-Organic Item with Protect Anything Human Key Connector Mechanism and shows the GSense sensor evaluation mechanism can be used for gaseous analysis.

FIG. 97-97S describes GSense Smell and Taste Sensor for Identification of Any Organic or Non-Organic Item with Protect Anything Human Key Connector Mechanism and shows the GSense sensor evaluation mechanism can be used for infectious disease analysis and can collect data, protect their process data, transmits safe and secure and encrypted analysis material, can send to Dr., physician, scientific team, or any other person for analysis and review.

FIG. 97-97T describes GSense Smell and Taste Sensor for Identification of Any Organic or Non-Organic Item with Protect Anything Human Key Connector Mechanism and shows where the GSense sensor mechanism to identify carbon monoxide to protect against life threatening situations.

FIG. 97-97U describes GSense Smell and Taste Sensor for Identification of Any Organic or Non-Organic Item with Protect Anything Human Key Connector Mechanism and shows the GSense sensor mechanism can also be a mobile smoke alarm and smoke analysis tool, and even a motion detector alarm when traveling.

FIG. 97-97V describes GSense Smell and Taste Sensor for Identification of Any Organic or Non-Organic Item with Protect Anything Human Key Connector Mechanism and shows the GSense sensor mechanism can do automatic chemical analysis.

FIG. 97-97W describes GSense Smell and Taste Sensor for Identification of Any Organic or Non-Organic Item with Protect Anything Human Key Connector Mechanism and shows where after the GSense sensor mechanism identifies an object the information can be manually or automatically transmitted to the source.

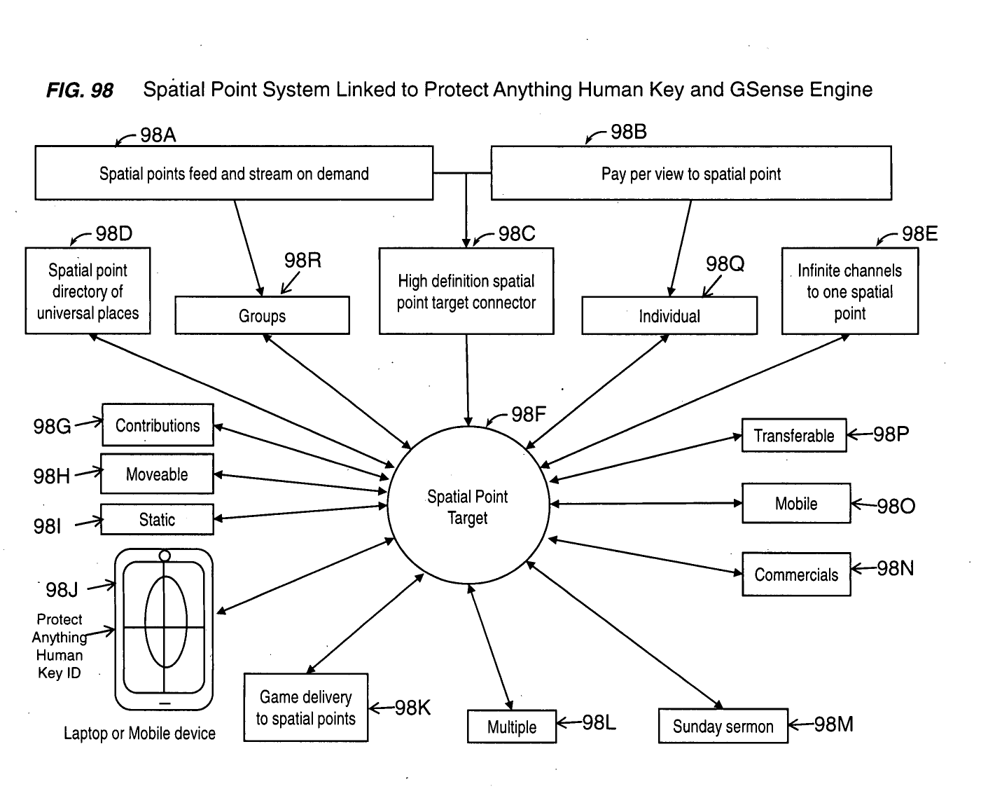

FIG. 98-98A describes the spatial point system linked to Protect Anything Human Key and GSense engine and shows the spatial point feed and stream on demand after identification through Protect Anything Human Key.

FIG. 98-98B describes the spatial point system linked to Protect Anything Human Key and GSense engine and shows how you can get pay-per-view broadcast to spatial point target.

FIG. 98-98C describes the spatial point system linked to Protect Anything Human Key and GSense engine and shows the high-definition spatial point target connector.

FIG. 98-98D describes the spatial point system linked to Protect Anything Human Key and GSense engine and shows spatial point directory of universal places.

FIG. 98-98E describes the spatial point system linked to Protect Anything Human Key and GSense engine and shows infinite channels can be broadcast to one spatial point.

FIG. 98-98F describes the spatial point system linked to Protect Anything Human Key and GSense engine and shows spatial points can be broadcast to groups, individuals, multiple points, mobile devices, commercials, movable targets, static targets, to contributions, can be transferable, the Sunday sermon, also games can be broadcast and delivered on-demand to spatial point targeted areas with the GSense spatial point targeting mechanism.

FIG. 98-98G describes the spatial point system linked to Protect Anything Human Key and GSense engine and shows the spatial point feed and stream on demand after identification through Protect Anything Human Key.

FIG. 98-98H describes the spatial point system linked to Protect Anything Human Key and GSense engine and shows how you can get contributions delivered to spatial point target.

FIG. 98-98I describes the spatial point system linked to Protect Anything Human Key and GSense engine and shows the moveable spatial point target connector.

FIG. 98-98J describes the spatial point system linked to Protect Anything Human Key and GSense engine and shows laptop or mobile device can get broadcasts at and from static spatial point target with id authorization.

FIG. 98-98K describes the spatial point system linked to Protect Anything Human Key and GSense engine and shows games can be delivered or broadcast to one spatial point.

FIG. 98-98L describes the spatial point system linked to Protect Anything Human Key and GSense engine and shows the spatial point feed and stream can be delivered to multiple targets.

FIG. 98-98M describes the spatial point system linked to Protect Anything Human Key and GSense engine and shows how you can get Sunday sermon or any inspirational information delivered to spatial point target.

FIG. 98-98N describes the spatial point system linked to Protect Anything Human Key and GSense engine and shows the commercials spatial point target connector.

FIG. 98-98O describes the spatial point system linked to Protect Anything Human Key and GSense engine and shows mobile abilities of the invention.

FIG. 98-98P describes the spatial point system linked to Protect Anything Human Key and GSense engine and shows one spatial point can be easily transferable to different users or recipients.

FIG. 98-98Q describes the spatial point system linked to Protect Anything Human Key and GSense engine and shows individual abilities of the invention.

FIG. 98-98R describes the spatial point system linked to Protect Anything Human Key and GSense engine and shows one spatial point can be easily used by groups.

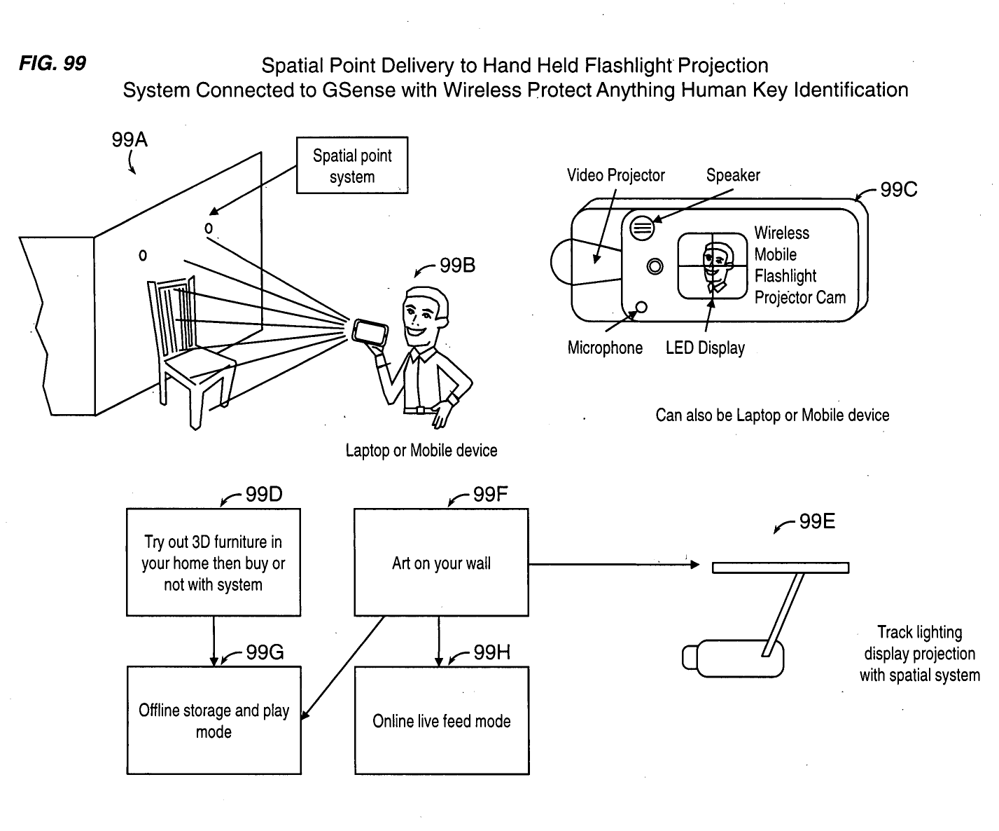

FIG. 99-99A describes spatial point delivery to handheld projection flashlight system connected to GSense with wireless Protect Anything Human Key identification and shows a wall with spatial point target discovered or directed to and flashlight projection device is aimed and object is viewed at that particular SP target.

FIG. 99-99B describes spatial point delivery to handheld projection flashlight system connected to GSense with wireless Protect Anything Human Key identification and shows the person with flash light projector in the hand.

FIG. 99-99C describes spatial point delivery to handheld projection flashlight system connected to GSense with wireless Protect Anything Human Key identification and shows the GSense video projector unit with speaker, cam, microphone, LED display, wireless mobile portable flashlight project cam unit and can also be implemented inside laptop, computer, or mobile device or as a standalone unit plugged into devices.

FIG. 99-99D describes spatial point delivery to handheld projection flashlight system connected to GSense with wireless Protect Anything Human Key identification and shows where user can try out 3-D furniture in your home at the SP target position before buying to see how it looks in the home environment before purchasing.

FIG. 99-99E describes spatial point delivery to handheld projection flashlight system connected to GSense with wireless Protect Anything Human Key identification and shows special track lighting or any ceiling mounted display projection with GSense spatial points system.

FIG. 99-99F describes spatial point delivery to handheld projection flashlight system connected to GSense with wireless Protect Anything Human Key identification and shows how you can project art on your wall with specific SP targets and a subscription with art of the month, at any place, time or style.

FIG. 99-99G describes spatial point delivery to handheld projection flashlight system connected to GSense with wireless Protect Anything Human Key identification and shows how GSense SP target technology can work in off-line storage and play mode.

FIG. 99-99H describes spatial point delivery to handheld projection flashlight system connected to GSense with wireless Protect Anything Human Key identification and shows how GSense SP target technology can work in online live feed mode like concerts or special events or lectures.

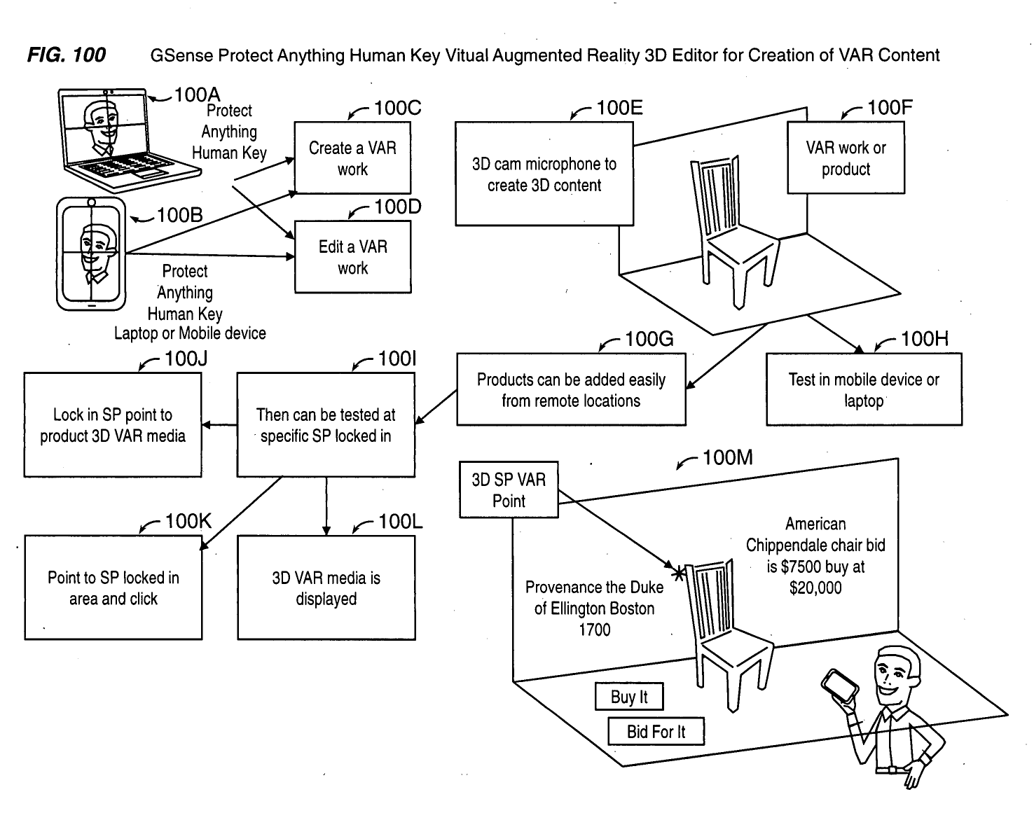

FIG. 100-100A describes GSense virtual augmented reality 3-D editor for creation of VAR content and shows the Protect Anything Human Key identification system in a laptop.

FIG. 100-100B describes GSense virtual augmented reality 3-D editor for creation of VAR content and shows the Protect Anything Human Key identification system in a mobile device.

FIG. 100-100C describes GSense virtual augmented reality 3-D editor for creation of VAR content and shows where you can create a virtual augmented reality work.

FIG. 100-100D describes GSense virtual augmented reality 3-D editor for creation of VAR content and shows where you can edit a created virtual augmented reality work or file.

FIG. 100-100E describes GSense virtual augmented reality 3-D editor for creation of VAR content and shows where you can use GSense 3-D cam mechanism and stereo microphone to create 3-D content that can be displayed anywhere.

FIG. 100-100F describes GSense virtual augmented reality 3-D editor for creation of VAR content and shows the VAR work, media file or product.

FIG. 100-100G describes GSense virtual augmented reality 3-D editor for creation of VAR content and shows products can be added easily from remote locations.

FIG. 100-100H describes GSense virtual augmented reality 3-D editor for creation of VAR content and shows you can test the new VAR media in your mobile device, laptop or any other connected device.

FIG. 100-100I describes GSense virtual augmented reality 3-D editor for creation of VAR content and shows how then the media can be tested at specific spatial point locked in.

FIG. 100-100J describes GSense virtual augmented reality 3-D editor for creation of VAR content and shows you simply lock in SP target point to product 3-D VAR media file.

FIG. 100-100K describes GSense virtual augmented reality 3-D editor for creation of VAR content and shows that the user simply can point their cam to the point to SP locked in an area and click to view.

FIG. 100-100L describes GSense virtual augmented reality 3-D editor for creation of VAR content and shows how to 3-D VAR media is then displayed.

FIG. 100-100M describes GSense virtual augmented reality 3-D editor for creation of VAR content and shows a person using their mobile device to view they SP target and viewing the information and pricing structure about the American Chippendale chair then they can buy it or bid for it or get special instructions on how to maintain the product.

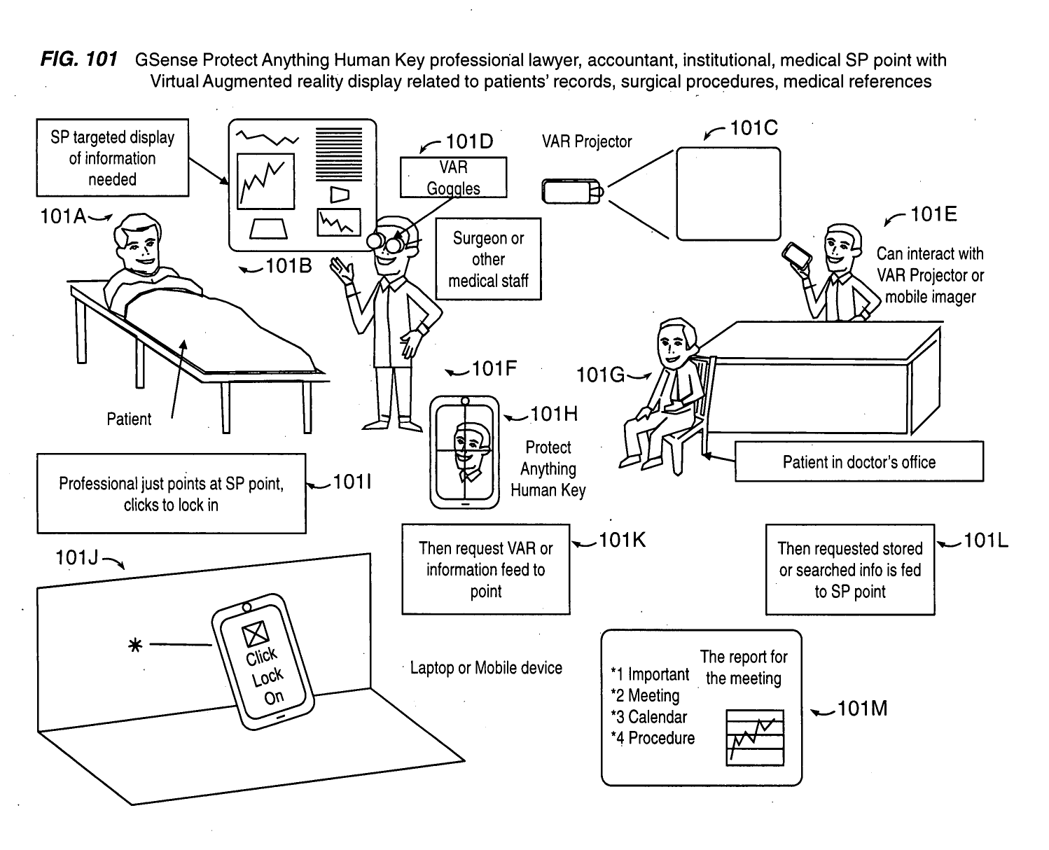

FIG. 101-101A describes How Data is processed through Protect Anything Human Key and GSense professional mechanism for lawyer, accountant, institutional, medical, SP target point with virtual augmented reality display related to patient records, surgical procedures, and medical references and shows patient laying on the bed.

FIG. 101-101B describes How Data is processed through Protect Anything Human Key and GSense professional mechanism for lawyer, accountant, institutional, medical, SP target point with virtual augmented reality display related to patient records, surgical procedures, and medical references and shows SP targeted display of information needed with charts and text, images, video and surgeon or other medical staff with VAR goggles.

FIG. 101-101C describes How Data is processed through Protect Anything Human Key and GSense professional mechanism for lawyer, accountant, institutional, medical, SP target point with virtual augmented reality display related to patient records, surgical procedures, and medical references and shows a VAR. Projector for a meeting.

FIG. 101-101D describes How Data is processed through Protect Anything Human Key and GSense professional mechanism for lawyer, accountant, institutional, medical, SP target point with virtual augmented reality display related to patient records, surgical procedures, and medical references and shows in goggles you can have data broadcast to it for usability.

FIG. 101-101E describes How Data is processed through Protect Anything Human Key and GSense professional mechanism for lawyer, accountant, institutional, medical, SP target point with virtual augmented reality display related to patient records, surgical procedures, and medical references and shows can interact with virtual augmented reality project or mobile image on screen in mobile device.

FIG. 101-101F describes How Data is processed through Protect Anything Human Key and GSense professional mechanism for lawyer, accountant, institutional, medical, SP target point with virtual augmented reality display related to patient records, surgical procedures, and medical references and shows patient and doctors office looking at virtual augmented reality protection of charts.

FIG. 101-101G describes How Data is processed through Protect Anything Human Key and GSense professional mechanism for lawyer, accountant, institutional, medical, SP target point with virtual augmented reality display related to patient records, surgical procedures, and medical references and shows where you have to use the Protect Anything Human Key identification system to be able to read your charts medical financial or whatever that way your charts and information goes with you wherever you go.

FIG. 101-101H describes How Data is processed through Protect Anything Human Key and GSense professional mechanism for lawyer, accountant, institutional, medical, SP target point with virtual augmented reality display related to patient records, surgical procedures, and medical references and shows the professional chess points at any SP target point clicks to lock-in target for display.

FIG. 101-101I describes How Data is processed through Protect Anything Human Key and GSense professional mechanism for lawyer, accountant, institutional, medical, SP target point with virtual augmented reality display related to patient records, surgical procedures, and medical references and shows.

FIG. 101-101J describes How Data is processed through Protect Anything Human Key and GSense professional mechanism for lawyer, accountant, institutional, medical, SP target point with virtual augmented reality display related to patient records, surgical procedures, and medical references and shows mobile device with can microphone and crosshairs you target then click lock on.

FIG. 101-101K describes How Data is processed through Protect Anything Human Key and GSense professional mechanism for lawyer, accountant, institutional, medical, SP target point with virtual augmented reality display related to patient records, surgical procedures, and medical references and shows then request virtual augmented reality media for information feed or broadcast to that point.

FIG. 101-101L describes How Data is processed through Protect Anything Human Key and GSense professional mechanism for lawyer, accountant, institutional, medical, SP target point with virtual augmented reality display related to patient records, surgical procedures, and medical references and shows than the requested stored or searched information is fed or broadcast to SP target point.

FIG. 101-101M describes How Data is processed through Protect Anything Human Key and GSense professional mechanism for lawyer, accountant, institutional, medical, SP target point with virtual augmented reality display related to patient records, surgical procedures, and medical references and shows the media being viewed.

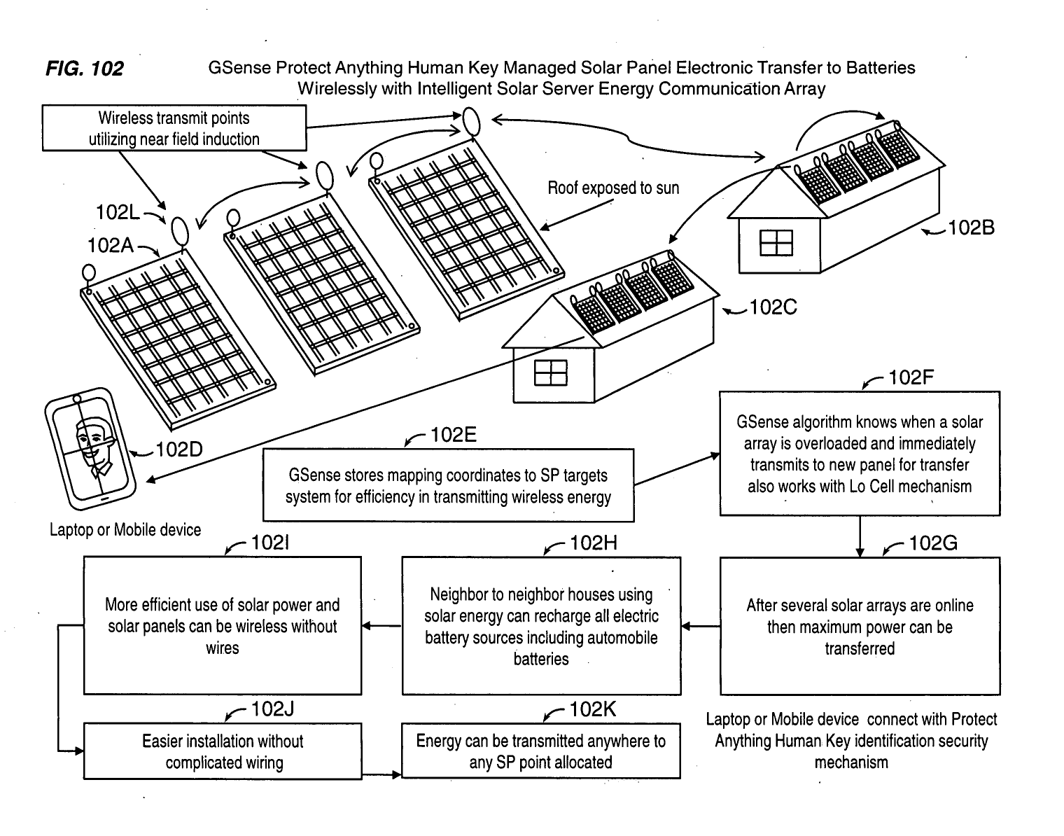

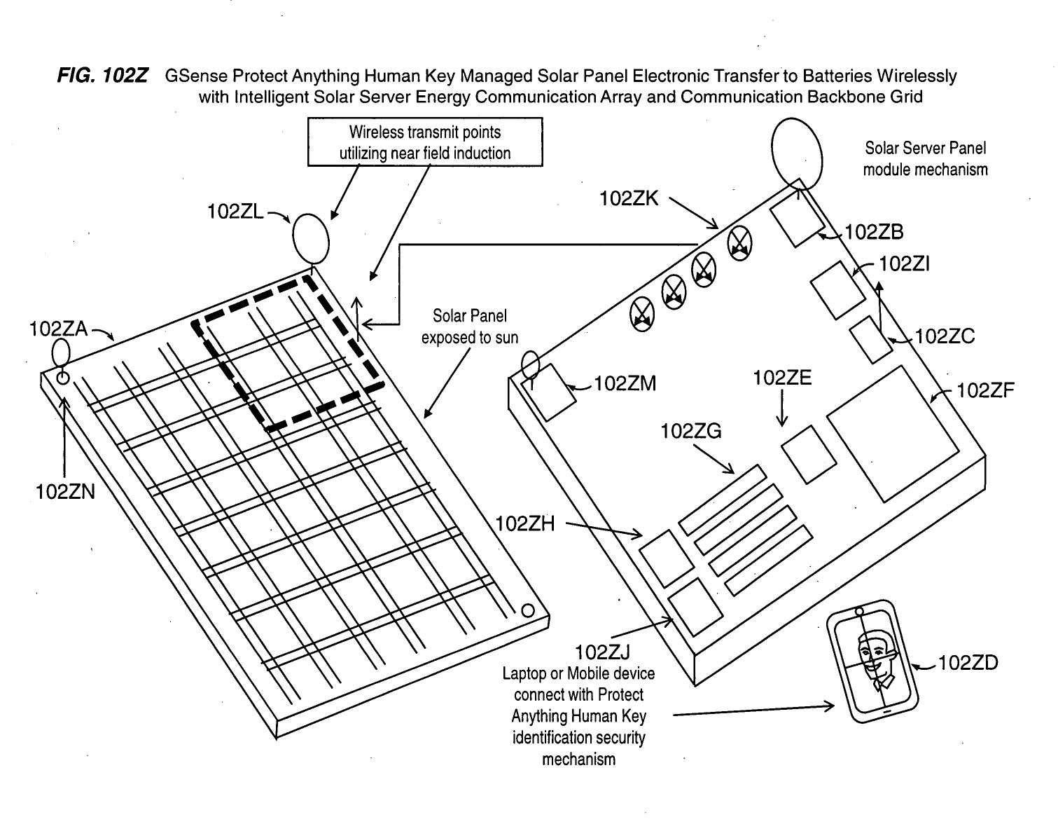

FIG. 102-102A describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows wireless transmission points for energy transfer with near field electro-dynamic induction combined with near field electro-magnetic induction from solar panel to the next from a roof exposed to sun.

FIG. 102-102B describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows how power can be relayed from house to house depending upon the energy needs of the users.

FIG. 102-102C describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows that any one array of solar panels can be managed with GSense from local or remote locations.

FIG. 102-102D describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows how GSense communicates and controls power usage with Protect Anything Human Key identification mechanism access to the arrays.

FIG. 102-102E describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows where GSense stores mapping coordinates to SP points system for efficiency in transmitting wireless energy.

FIG. 102-102F describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows where GSense algorithm does when a solar array is overloaded and immediately transfers energy to new panel or efficient use of solar energy.

FIG. 102-102G describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows after several solar arrays are online then maximum power can be transferred.

FIG. 102-102H describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows how neighbor to neighbor housing communities using solar energy to recharge all electric battery sources including automobile batteries for electric cars.

FIG. 102-102I describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows that GSense combined with Protect Anything Human Key identification system provides a more efficient use of solar power and solar panels and can be totally wireless without expensive wiring.

FIG. 102-102J describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows where the installation is very easy and uncomplicated and all electrical transfer is managed remotely from the main GSense network Center.

FIG. 102-102K describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and furthermore shows where energy can be transferred anywhere to any SP point allocated remotely from the GSense network Center for efficiency and dependability.

FIG. 102Z-102ZA describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows intelligent solar panel exposed to sun.

FIG. 102Z-102ZB describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows the near field induction coupling unit with loop energy transmitter unit.

FIG. 102Z-102ZC describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows wireless card with antennae so that any one array of solar panels can be managed with GSense from local or remote locations.

FIG. 102Z-102ZD describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows how GSense communicates and controls power usage with Protect Anything Human Key identification mechanism access to the arrays.

FIG. 102Z-102ZE describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows a flash memory card storage or hard drive storage unit.

FIG. 102Z-102ZF describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows server motherboard and CPU and ram banks.

FIG. 102Z-102ZG describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows additional ram array bank for storage and processing.

FIG. 102Z-102ZH describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows battery storage backup unit.

FIG. 102Z-102ZI describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows transformer unit.

FIG. 102Z-102ZJ describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows power supply.

FIG. 102Z-102ZK describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows cooling fans.

FIG. 102Z-102ZL describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows wireless transmission point for energy transfer and communication wireless antennae with near field electro-dynamic induction coupling transmitter unit combined with near field electro-magnetic induction transmission from solar panel to the next panel from a roof exposed to sun.

FIG. 102Z-102ZM describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows wireless transmission point for energy transfer and communication wireless antennae with near field electro-dynamic induction coupling receiver unit combined with near field electro-magnetic induction receiving from solar panel of the next panel from a roof exposed to sun.

FIG. 102Z-102ZN describes managed solar panel wireless electronic relay mechanism with Protect Anything Human Key ID Protection and GSense management and shows GSense Managed Solar Panel Electronic Transfer to Batteries Wirelessly with Intelligent Solar Server Energy Communication Array and Communication Backbone Grid and furthermore shows wireless transmission point for energy transfer and communication wireless antennae from near field electro-dynamic induction coupling receiver unit.

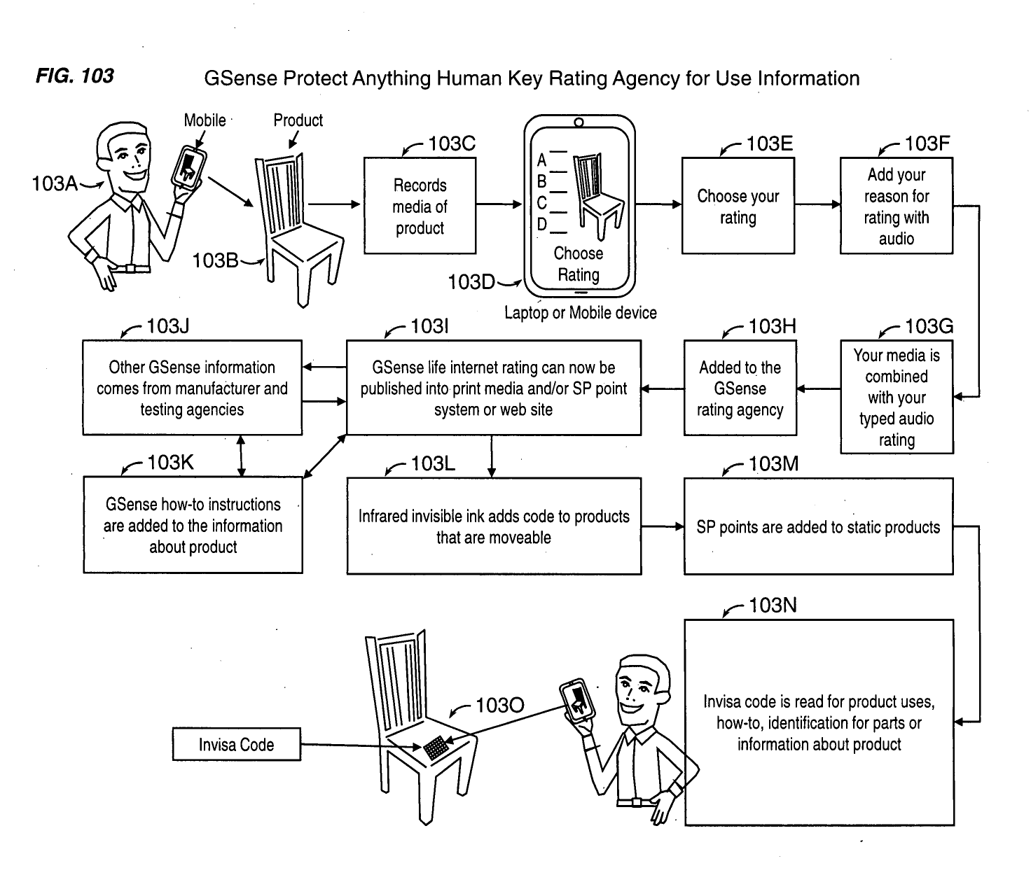

FIG. 103-103A describes GSense Rating Agency for use information on products and shows a person using mobile device with cam and microphone to view a product then they can sign in with Protect Anything Human Key identification system or not.

FIG. 103-103B describes GSense Rating Agency for use information on products and shows product being viewed by mobile device.

FIG. 103-103C describes GSense Rating Agency for use information on products and shows mobile device that records media of the product.

FIG. 103-103D describes GSense Rating Agency for use information on products and shows A, B., C., D., and choose rating for the product with A being the best and D being not so good.

FIG. 103-103E describes GSense Rating Agency for use information on products and shows where you choose your rating.

FIG. 103-103F describes GSense Rating Agency for use information on products and shows where you can add your reason for the rating in voice video or images.

FIG. 103-103G describes GSense Rating Agency for use information on products and shows where your media is combined with your typed audio rating and your current Protect Anything Human Key GSense shield rating.

FIG. 103-103H describes GSense Rating Agency for use information on products and shows then your rating is added to the GSense rating agency for others to know how you feel about the product.

FIG. 103-103I describes GSense Rating Agency for use information on products and shows the GSense life Internet rating can now be published into print media and or SP targeted point system and or website.

FIG. 103-103J describes GSense Rating Agency for use information on products and shows other GSense information comes from manufacturer of the product and testing agencies.

FIG. 103-103K describes GSense Rating Agency for use information on products and shows where GSense how to instructions are added to the information about the product.

FIG. 103-103L describes GSense Rating Agency for use information on products and shows special infrared and invisible link ads code to products that are static or movable.

FIG. 103-103M describes GSense Rating Agency for use information on products and shows SP targeted points are added to permanently static products for data broadcasting.

FIG. 103-103N describes GSense Rating Agency for use information on products and shows invisa code is read for product uses, how to information and for parts reordering or information about a product.

FIG. 103-103O describes GSense Rating Agency for use information on products and shows how to use a mobile device scan code and get dynamic information from the page from live Internet or mechanical Internet information.

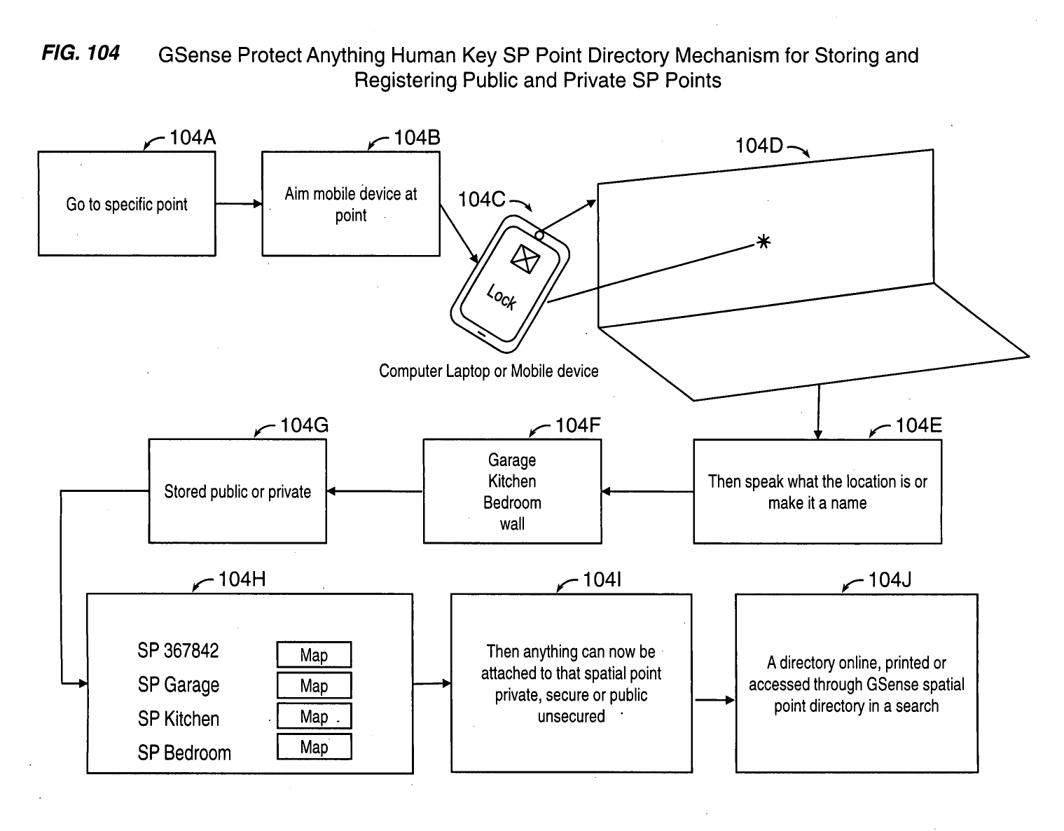

FIG. 104-104A describes Protect Anything Human Key and GSense SP targets directory mechanism for storing and registering public and private SP targets and shows where you go to specific point.

FIG. 104-104B describes Protect Anything Human Key and GSense SP targets directory mechanism for storing and registering public and private SP targets and shows at the point game mobile device to the SP targeted point.

FIG. 104-104C describes Protect Anything Human Key and GSense SP targets directory mechanism for storing and registering public and private SP targets and shows where users can click and lock on to the SP targeted point.

FIG. 104-104D describes Protect Anything Human Key and GSense SP targets directory mechanism for storing and registering public and private SP targets and shows the targeted SP point.

FIG. 104-104E describes Protect Anything Human Key and GSense SP targets directory mechanism for storing and registering public and private SP targets and shows then you speak what the location is or make it a name.

FIG. 104-104F describes Protect Anything Human Key and GSense SP targets directory mechanism for storing and registering public and private SP targets and shows some names as examples garage kitchen bedroom wall and dining room.

FIG. 104-104G describes Protect Anything Human Key and GSense SP targets directory mechanism for storing and registering public and private SP targets and shows then the SP target and reference is stored public or private in the GSense registry.

FIG. 104-104H describes Protect Anything Human Key and GSense SP targets directory mechanism for storing and registering public and private SP targets and shows how the registry looks with SP target number and map button.

FIG. 104-104I describes Protect Anything Human Key and GSense SP targets directory mechanism for storing and registering public and private SP targets and shows then anything can now be attached to that SP targeted point private, secure, or public unsecured.

FIG. 104-104J describes Protect Anything Human Key and GSense SP targets directory mechanism for storing and registering public and private SP targets and shows a directory online, printed, or access to GSense SP targeted directory and search engine.

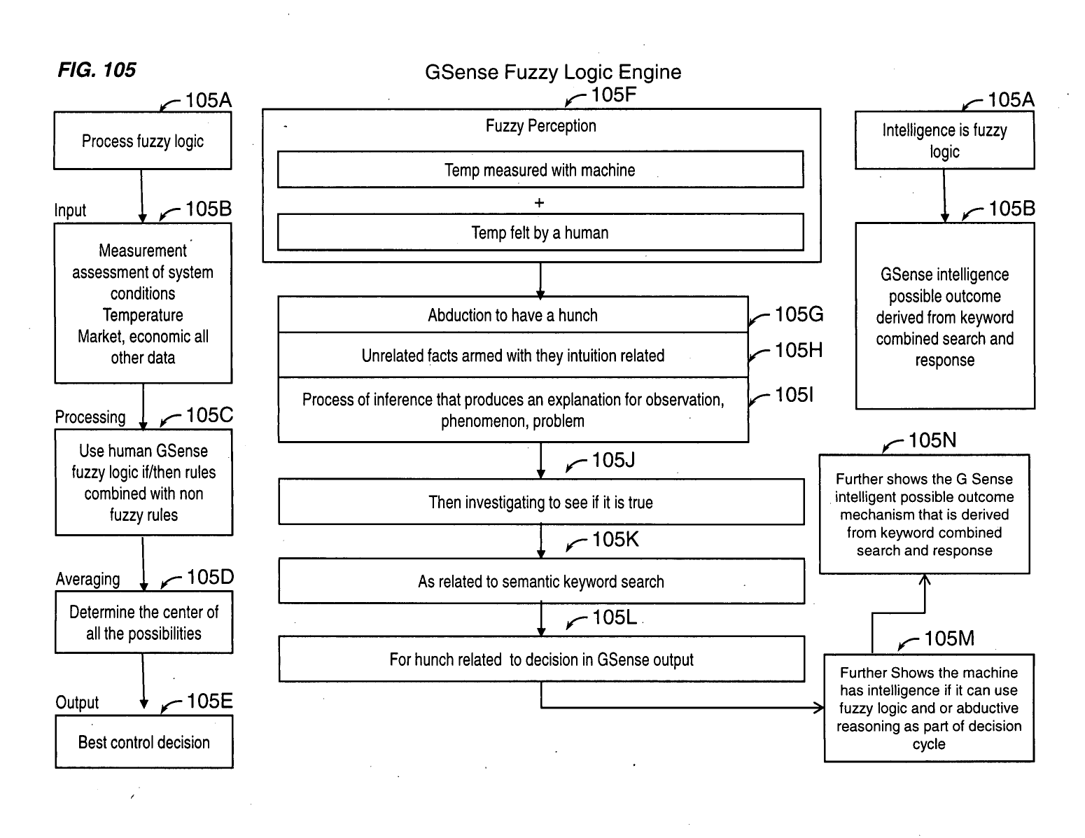

FIG. 105-105A describes GSense Abductive Fuzzy Logic Engine and shows process fuzzy logic abduction.

FIG. 105-105B describes GSense Abductive Fuzzy Logic Engine and shows input mechanism for measurement, assessment of system conditions, temperature, market economic and all of the data mechanism.

FIG. 105-105C describes GSense Abductive Fuzzy Logic Engine and shows processing mechanism with human GSense using fuzzy logic abductive reasoning if then rules combined with non-fuzzy rules mechanism.

FIG. 105-105D describes GSense Abductive Fuzzy Logic Engine and shows the averaging mechanism that determines the center of all possibilities.

FIG. 105-105E describes GSense Abductive Fuzzy Logic Engine and shows the output mechanism with the best control decision generated.

FIG. 105-105F describes GSense Abductive Fuzzy Logic Engine and shows fuzzy adductive perception mechanism with comparison example of temperature measured with a machine plus temperature felt by human.

FIG. 105-105G describes GSense Abductive Fuzzy Logic Engine and shows the adductive mechanism that gives the ability of the machine to have hunch.

FIG. 105-105H describes GSense Abductive Fuzzy Logic Engine and shows unrelated facts mechanism to have a hunch armed with intuition.

FIG. 105-105I describes GSense Abductive Fuzzy Logic Engine and shows the inference process mechanism that produces some explanation for the observation, phenomenon or the problem.

FIG. 105-105J describes GSense Abductive Fuzzy Logic Engine and shows the investigation engine mechanism to test to see if hypothesis is true.

FIG. 105-105K describes GSense Abductive Fuzzy Logic Engine and shows where the hunch is related to any semantic keyword search.

FIG. 105-105L describes GSense Abductive Fuzzy Logic Engine and shows where the hunch is related to any previous decisions in GSense output mechanism engine.

FIG. 105-105M describes GSense Adductive Fuzzy Logic Engine and shows the machine has intelligence if it can use fuzzy logic and or abductive reasoning as part of decision cycle.

FIG. 105-105N describes GSense Adductive Fuzzy Logic Engine and shows the GSense intelligent possible outcome mechanism that is derived from keyword combined search and response.

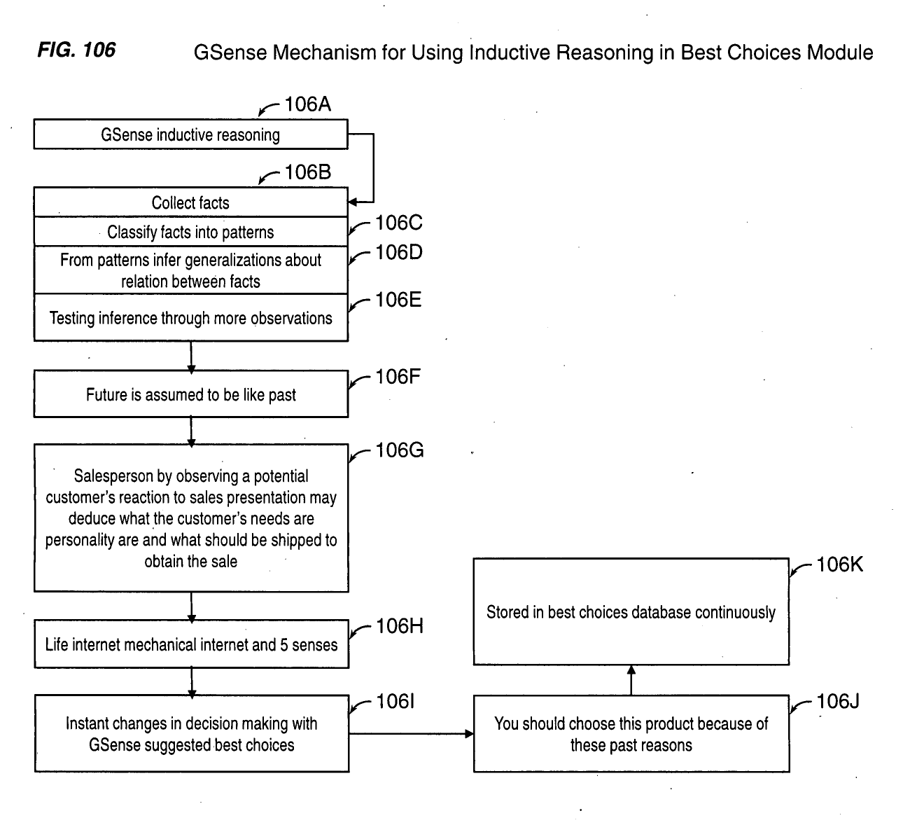

FIG. 106-106A describes GSense mechanism for using the inductive reasoning mechanism in best choices module and shows GSense inductive reasoning mechanism.

FIG. 106-106B describes GSense mechanism for using the inductive reasoning mechanism in best choices module and shows we collect facts.

FIG. 106-106C describes GSense mechanism for using the inductive reasoning mechanism in best choices module and shows classified facts into patterns.

FIG. 106-106D describes GSense mechanism for using the inductive reasoning mechanism in best choices module and shows from patterns we infer generalizations about relationships between the facts.

FIG. 106-106E describes GSense mechanism for using the inductive reasoning mechanism in best choices module and shows then we go to the testing inference mechanism with more observation.

FIG. 106-106F describes GSense mechanism for using the inductive reasoning mechanism in best choices module and shows added to the formula is that future is assumed to be similar to the past.

FIG. 106-106G describes GSense mechanism for using the inductive reasoning mechanism in best choices module and shows an example of where a salesperson by observing a potential customer's reaction to sales presentation, they induce that the customers needs are and his personality are and what should be said to obtain and win the sale.

FIG. 106-106H describes GSense mechanism for using the inductive reasoning mechanism in best choices module and shows where in this part of the mechanism we use the life Internet combined with the mechanical Internet combined with the five human senses GSense mechanism sensors and storage information.

FIG. 106-106I describes GSense mechanism for using the inductive reasoning mechanism in best choices module and shows where instant changes in decision-making combined with GSense suggested or proposed best choices are the result in this mechanism component.

FIG. 106-106J describes GSense mechanism for using the inductive reasoning mechanism in best choices module and shows you should choose this product because of these past reasons, more reliable and tested information.

FIG. 106-106K describes GSense mechanism for using the inductive reasoning mechanism in best choices module and shows where all inductive reasoning mechanism processed information is stored in best choices database continuously and upgraded in real-time.

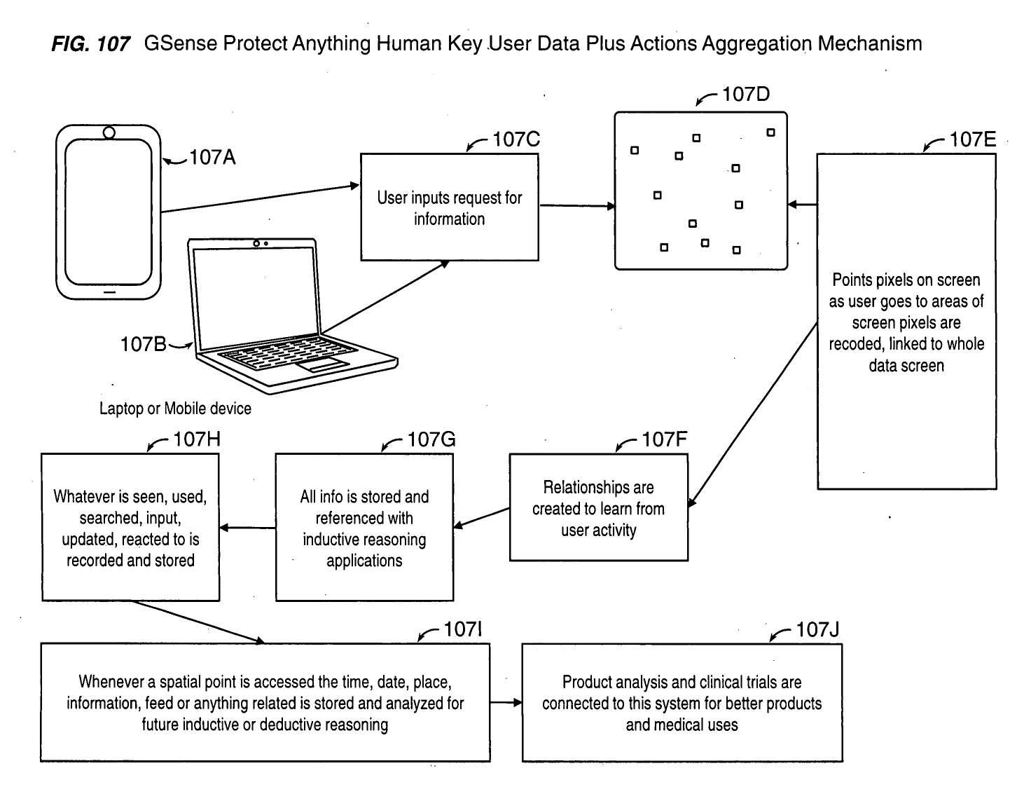

FIG. 107-107A describes GSense user data plus actions aggregation mechanism and shows a mobile device with cam and microphone.

FIG. 107-107B describes GSense user data plus actions aggregation mechanism and shows a laptop computer with cam and microphone.

FIG. 107-107C describes GSense user data plus actions aggregation mechanism and shows where user inputs request for information.

FIG. 107-107D describes GSense user data plus actions aggregation mechanism and shows pixel points on display screen.

FIG. 107-107E describes GSense user data plus actions aggregation mechanism and shows where the points and pixels on the screen as users go to areas of screen the pixel positions are recorded and linked relatively to the whole screen and data in those pixel positions.

FIG. 107-107F describes GSense user data plus actions aggregation mechanism and shows relationships are created to learn from human user activity.

FIG. 107-107G describes GSense user data plus actions aggregation mechanism and shows all information is stored and referenced with processing in the GSense inductive reasoning engine mechanism.

FIG. 107-107H describes GSense user data plus actions aggregation mechanism and shows whatever is seen, used, searched, input, updated, or reacted to his recorded, stored, sorted, categorized, and processed through the GSense human engine mechanism.

FIG. 107-107I describes GSense user data plus actions aggregation mechanism and shows whenever a spatial point is accessed the time, date, place, information, feed, or anything related is stored and analyzed for future human reasoning engine mechanisms processing.

FIG. 107-107J describes GSense user data plus actions aggregation mechanism and shows where product analysis and clinical trials are connected to this system to better products and medical uses.

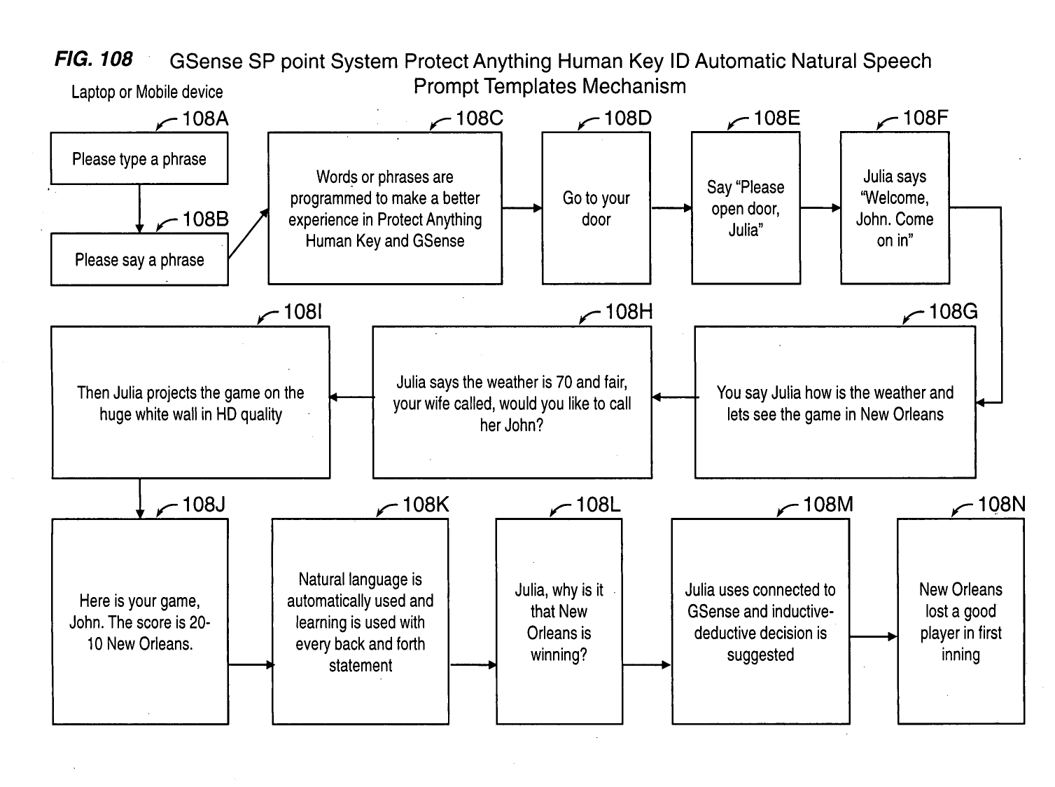

FIG. 108-108A describes GSense SP Targeted Point System with Protect Anything Human Key ID automatic natural speech prompt templates mechanism and shows where mechanism asks please type a phrase.

FIG. 108-108B describes GSense SP Targeted Point System with Protect Anything Human Key ID automatic natural speech prompt templates mechanism and shows where mechanism says please say a phrase.

FIG. 108-108C describes GSense SP Targeted Point System with Protect Anything Human Key ID automatic natural speech prompt templates mechanism and shows where words or phrases or program to make a better experience in the Protect Anything Human Key or GSense user interfaces.

FIG. 108-108D describes GSense SP Targeted Point System with Protect Anything Human Key ID automatic natural speech prompt templates mechanism and shows where user does to your door.

FIG. 108-108E describes GSense SP Targeted Point System with Protect Anything Human Key ID automatic natural speech prompt templates mechanism and shows where user say “please open door Julia”.

FIG. 108-108F describes GSense SP Targeted Point System with Protect Anything Human Key ID automatic natural speech prompt templates mechanism and shows the GSense mechanism named Julia says “welcome John, come on in”.

FIG. 108-108G describes GSense SP Targeted Point System with Protect Anything Human Key ID automatic natural speech prompt templates mechanism and shows user says “Julia how is the weather and let's see the game in New Orleans”.

FIG. 108-108H describes GSense SP Targeted Point System with Protect Anything Human Key ID automatic natural speech prompt templates mechanism and shows where the GSense mechanism Julia says “the weather is 70° F. and fair weather, your wife called would you like to call her back John?”.

FIG. 108-108I describes GSense SP Targeted Point System with Protect Anything Human Key ID automatic natural speech prompt templates mechanism and shows where then the GSense mechanism Julia projects again on the huge whitewall in high-definition quality.

FIG. 108-108J describes GSense SP Targeted Point System with Protect Anything Human Key ID automatic natural speech prompt templates mechanism and shows where GSense mechanism Julia says “here is your game John the scores 20-10 New Orleans is winning”.

FIG. 108-108K describes GSense SP Targeted Point System with Protect Anything Human Key ID automatic natural speech prompt templates mechanism and shows where the GSense mechanism Julia is constantly programmed with natural language and visual, hearing, touch, smell, taste GSense engines also is continuously comparing life Internet and the mechanical Internet data to automatically learn continuously in learning is accomplished with every back and forth statement.

FIG. 108-108L describes GSense SP Targeted Point System with Protect Anything Human Key ID automatic natural speech prompt templates mechanism and shows where John asks the GSense mechanism Julia “why is it that New Orleans is winning game?”.

FIG. 108-108M describes GSense SP Targeted Point System with Protect Anything Human Key ID automatic natural speech prompt templates mechanism and shows where the GSense mechanism Julia then uses his connector to the GSense human reasoning and decision engine and gives suggestion or proposal.

FIG. 108-108N describes GSense SP Targeted Point System with Protect Anything Human Key ID automatic natural speech prompt templates mechanism and shows where the GSense mechanism Julia then says “New Orleans lost a good player in the first inning and their game has been affected” then the mechanism Julia says “the newscasters have commented on that loss of a player would you like more information John?”.

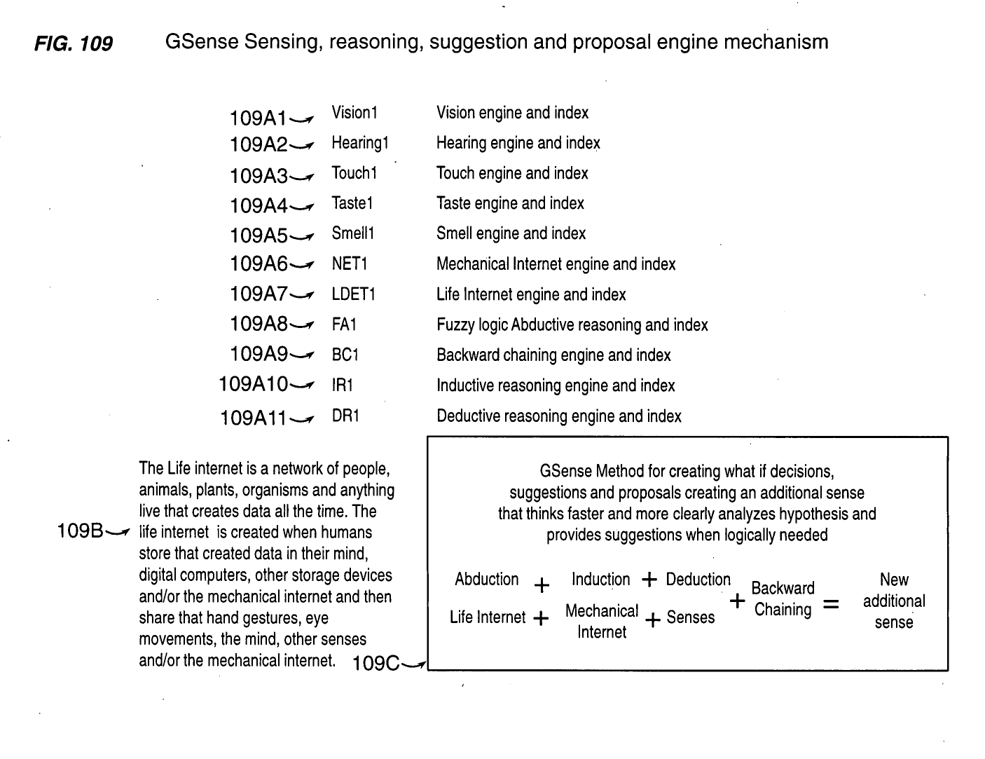

FIG. 109-109 A1 describes How Data is processed into intelligent data with the GSense Sensing, reasoning, suggestion and proposal engine mechanism structure and shows that VISION1 is the GSense vision sensor engine input mechanism and storage index.

FIG. 109-109 A2 describes How Data is processed into intelligent data with the GSense Sensing, reasoning, suggestion and proposal engine mechanism structure and shows that HEARING1 is the GSense hearing sensor engine input mechanism and storage index.

FIG. 109-109 A3 describes How Data is processed into intelligent data with the GSense Sensing, reasoning, suggestion and proposal engine mechanism structure and shows that TOUCH1 is the GSense touch sensor engine input mechanism and storage index.

FIG. 109-109 A4 describes How Data is processed into intelligent data with the GSense Sensing, reasoning, suggestion and proposal engine mechanism structure and shows that TASTE1 is the GSense taste sensor engine input mechanism and storage index.

FIG. 109-109 A5 describes How Data is processed into intelligent data with the GSense Sensing, reasoning, suggestion and proposal engine mechanism structure and shows that SMELL1 is the GSense smell sensor engine input mechanism and storage index.

FIG. 109-109 A6 describes How Data is processed into intelligent data with the GSense Sensing, reasoning, suggestion and proposal engine mechanism structure and shows that NET1 is the GSense mechanical Internet sensor engine mechanism and storage index.

FIG. 109-109 A7 describes How Data is processed into intelligent data with the GSense Sensing, reasoning, suggestion and proposal engine mechanism structure and shows that LNET1 is the GSense life Internet sensor engine mechanism and storage index.

FIG. 109-109 A8 describes How Data is processed into intelligent data with the GSense Sensing, reasoning, suggestion and proposal engine mechanism structure and shows that FA1 is the GSense fuzzy logic abductive reasoning sensor and reason constructor engine mechanism and storage index.

FIG. 109-109 A9 describes How Data is processed into intelligent data with the GSense Sensing, reasoning, suggestion and proposal engine mechanism structure and shows that BC1 is the GSense backward chaining reasoning sensor and reason constructor engine mechanism and storage index.

FIG. 109-109 A10 describes How Data is processed into intelligent data with the GSense Sensing, reasoning, suggestion and proposal engine mechanism structure and shows that IR1 is the GSense inductive reasoning sensor and reason constructor engine mechanism and storage index.

FIG. 109-109 A11 describes How Data is processed into intelligent data with the GSense Sensing, reasoning, suggestion and proposal engine mechanism structure and shows that DR1 is the GSense deductive reasoning sensor and reason constructor engine mechanism and storage index.

FIG. 109-109B describes How Data is processed into intelligent data with the GSense Sensing, reasoning, suggestion and proposal engine mechanism structure and shows The Life internet is a network of people, animals, plants, organisms and anything live that creates data all the time. The life internet is created when humans store that created data in their mind, digital computers, other storage devices and/or the mechanical internet and then share that hand gestures, eye movements, the mind, other senses and/or the mechanical internet.

FIG. 109-109C describes How Data is processed into intelligent data with the GSense Sensing, reasoning, suggestion and proposal engine mechanism structure and shows GSense Method formula for creating what if decisions, suggestions and proposals creating an additional sense that thinks faster and more clearly analyzes hypothesis and provides suggestions when logically needed.

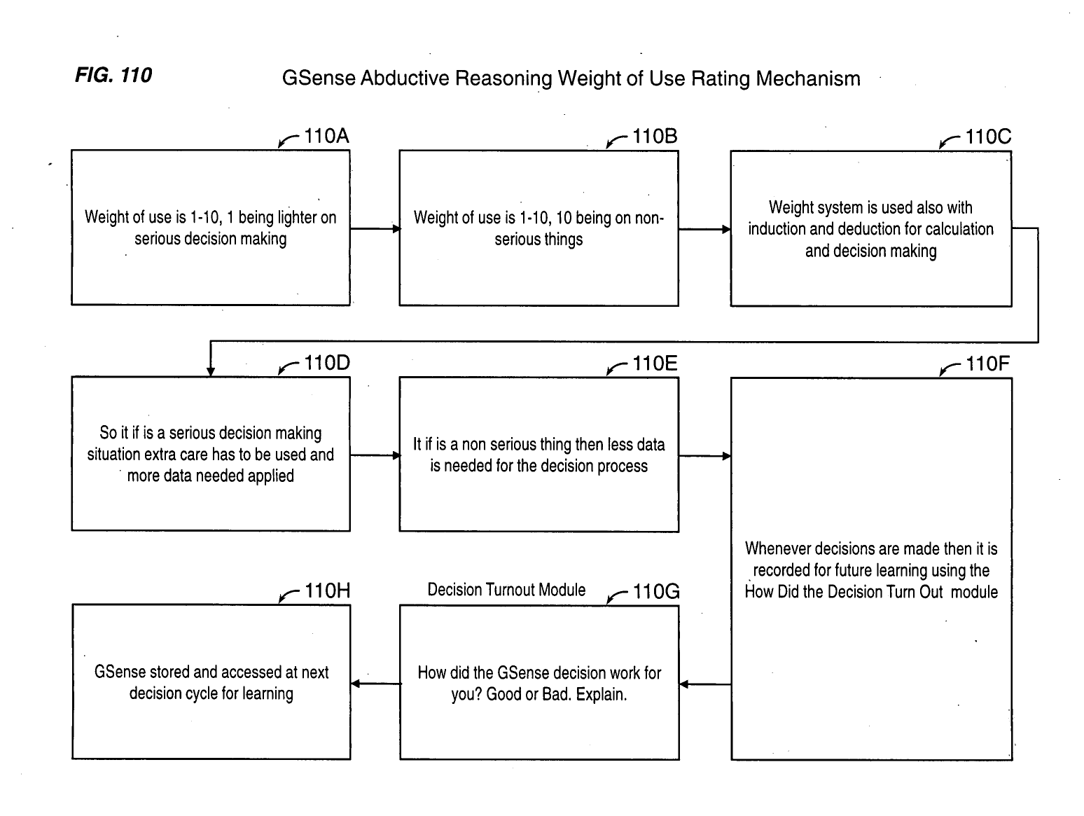

FIG. 110-110A describes GSense Abductive Reasoning weight of use rating mechanism and shows where weight of use is 1 to 10 and 1 being lighter on serious decision making.

FIG. 110-110B describes GSense Abductive Reasoning weight of use rating mechanism and shows where weight of use rating is 1 to 10 and 10 being heavier on non-serious decision making.

FIG. 110-110C describes GSense Abductive Reasoning weight of use rating mechanism and shows weight rating system is used also with all other reasoning engines or calculations reasoning constructor mechanism and decision-making.

FIG. 110-110D describes GSense Abductive Reasoning weight of use rating mechanism and shows so if it is a serious decision-making situation extra care has been used and more data needs to be applied to the reasoning constructor mechanism.

FIG. 110-110E describes GSense Abductive Reasoning weight of use rating mechanism and shows if it is a nonserious thing in less data is needed for the decision process and reasoning constructor mechanism.

FIG. 110-110F describes GSense Abductive Reasoning weight of use rating mechanism and shows whenever decisions are made then it is recorded for future learning using the how did the decision turn out aggregator module mechanism.

FIG. 110-110G describes GSense Abductive Reasoning weight of use rating mechanism and shows where the decision turn out aggregator module mechanism asks through GSense personality “how did the GSense decision work for you? Good or bad please explain”.

FIG. 110-110H describes GSense Abductive Reasoning weight of use rating mechanism and shows where GSense automatically stored input data and accessed turnout model at next decision cycle for learning.

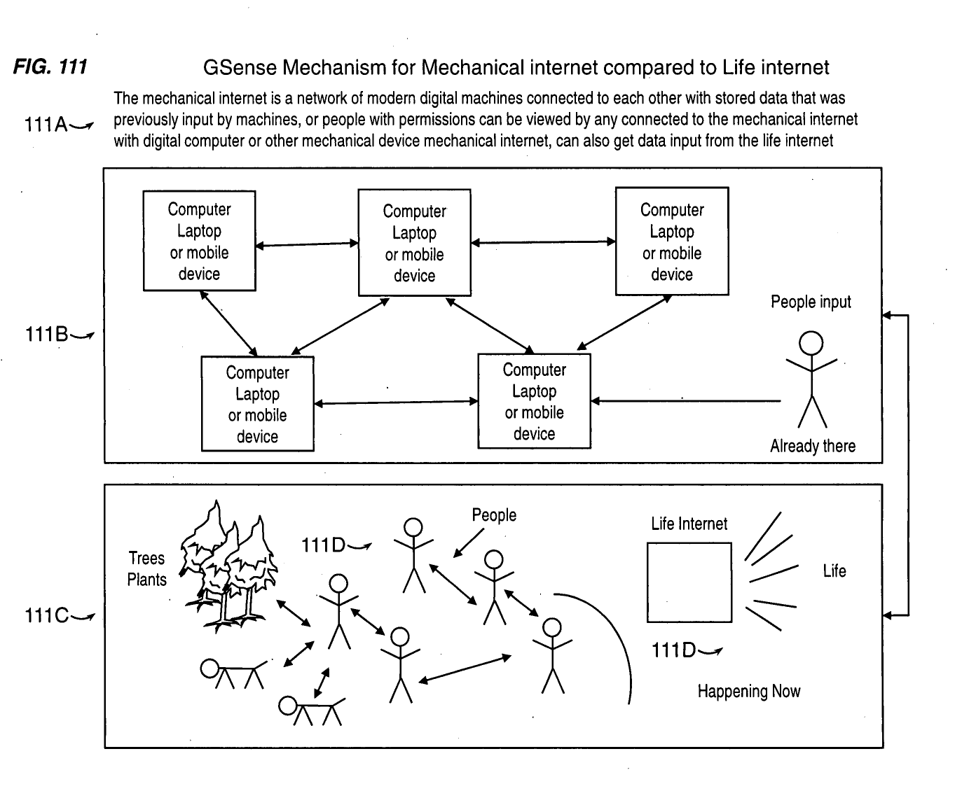

FIG. 111-111A describes GSense Mechanical Internet and Life internet comparison and shows where the mechanical Internet is a network of modern digital machines connected to each other, with store data that was previously input by machines, or people with permissions that can be viewed by anyone connected to the mechanical Internet with digital computer or other mechanical device, also the mechanical Internet can get data input from the life Internet.

FIG. 111-111B describes GSense Mechanical Internet and Life internet comparison and shows where the life Internet is a network of people, animals, plants, organisms, and anything live that creates data over time. The life Internet is created when humans store that created data in their mind, digital computers, other storage devices and or the mechanical Internet and then share that data with others through speech, writing, hand gestures, eye movements, the mind, other senses and/or mechanical Internet.

FIG. 111-111C describes GSense Mechanical Internet and Life internet comparison and shows where the mechanical Internet is the computer or server from computer or server has information input by people and is already there.

FIG. 111-111D describes GSense Mechanical Internet and Life internet comparison and shows where the life Internet is instead of machine to machine is life to life learning people learning from people, people learning from animals, people learning from plants it is data that is being created and happening now.

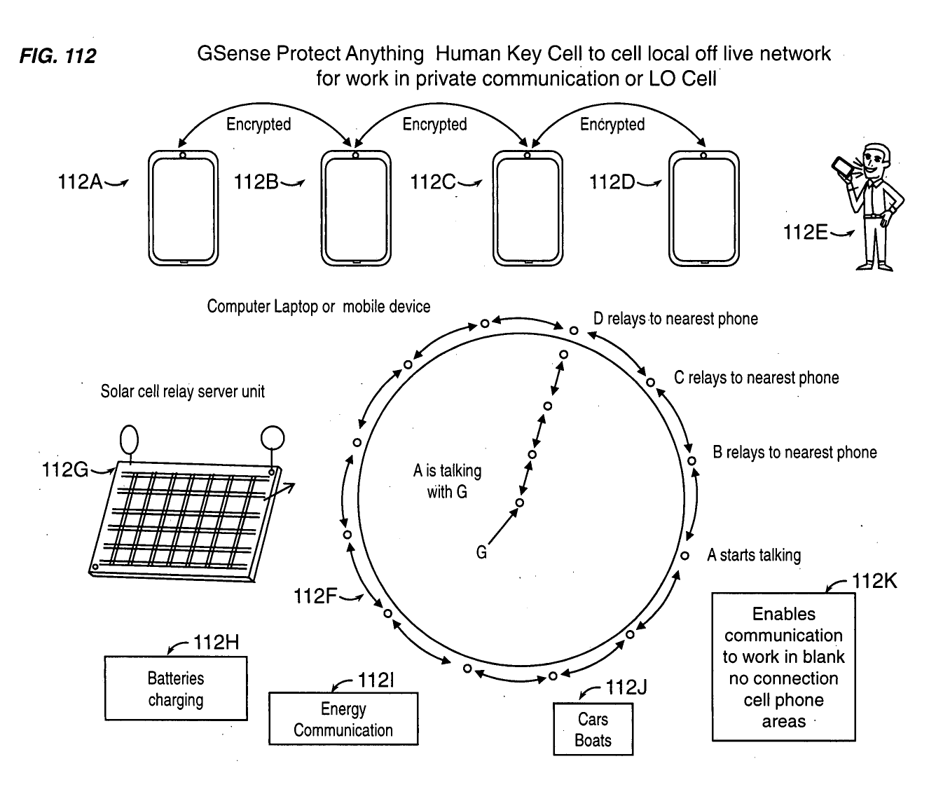

FIG. 112-112A describes LO Cell mechanism for offline cell to cell Network for private communication utilizing Protect Anything Human Key Server Cloud and GSense Intelligent management mechanism and shows off-line mobile device with cam and backbone utilizing encrypted and secure communication with another off-line mobile device sharing power and communication in a group or business environment.

FIG. 112-112B describes LO Cell mechanism for offline cell to cell Network for private communication utilizing Protect Anything Human Key Server Cloud and GSense and shows off-line mobile device with cam and backbone utilizing encrypted and secure communication with another off-line mobile device sharing power and communication in a group or business environment.

FIG. 112-112C describes LO Cell mechanism for offline cell to cell Network for private communication utilizing Protect Anything Human Key Server Cloud and GSense and shows off-line mobile device with cam and backbone utilizing encrypted and secure communication with another off-line mobile device sharing power and communication in a group or business environment.

FIG. 112-112D describes LO Cell mechanism for offline cell to cell Network for private communication utilizing Protect Anything Human Key Server Cloud and GSense and shows off-line mobile device with cam and backbone utilizing encrypted and secure communication with another off-line mobile device sharing power and communication in a group or business environment.

FIG. 112-112E describes LO Cell mechanism for offline cell to cell Network for private communication utilizing Protect Anything Human Key Server Cloud and GSense and shows a person communicating.

FIG. 112-112F describes LO Cell mechanism for offline cell to cell Network for private communication utilizing Protect Anything Human Key Server Cloud and GSense and shows how the Lo cell mechanism searches for the nearest phone and relays messages to systems.

FIG. 112-112G describes LO Cell mechanism for offline cell to cell Network for private communication utilizing Protect Anything Human Key Server Cloud and GSense and shows how lo cell is used in GSense solar cell relay wireless unit mechanism.

FIG. 112-112H describes LO Cell mechanism for offline cell to cell Network for private communication utilizing Protect Anything Human Key Server Cloud and GSense and shows how batteries can be recharged utilizing lo cell mechanism and magnetic induction mechanism to a blank zone.

FIG. 112-112I describes LO Cell mechanism for offline cell to cell Network for private communication utilizing Protect Anything Human Key Server Cloud and GSense and shows how the mechanism can be used in energy and communication.

FIG. 112-112J describes LO Cell mechanism for offline cell to cell Network for private communication utilizing Protect Anything Human Key Server Cloud and GSense and shows how the system and mechanism can be used in cars and boats.

FIG. 112-112K describes LO Cell mechanism for offline cell to cell Network for private communication utilizing Protect Anything Human Key Server Cloud and GSense and shows how the Lo cell mechanism can make communication work in blank no connection cell phone areas.

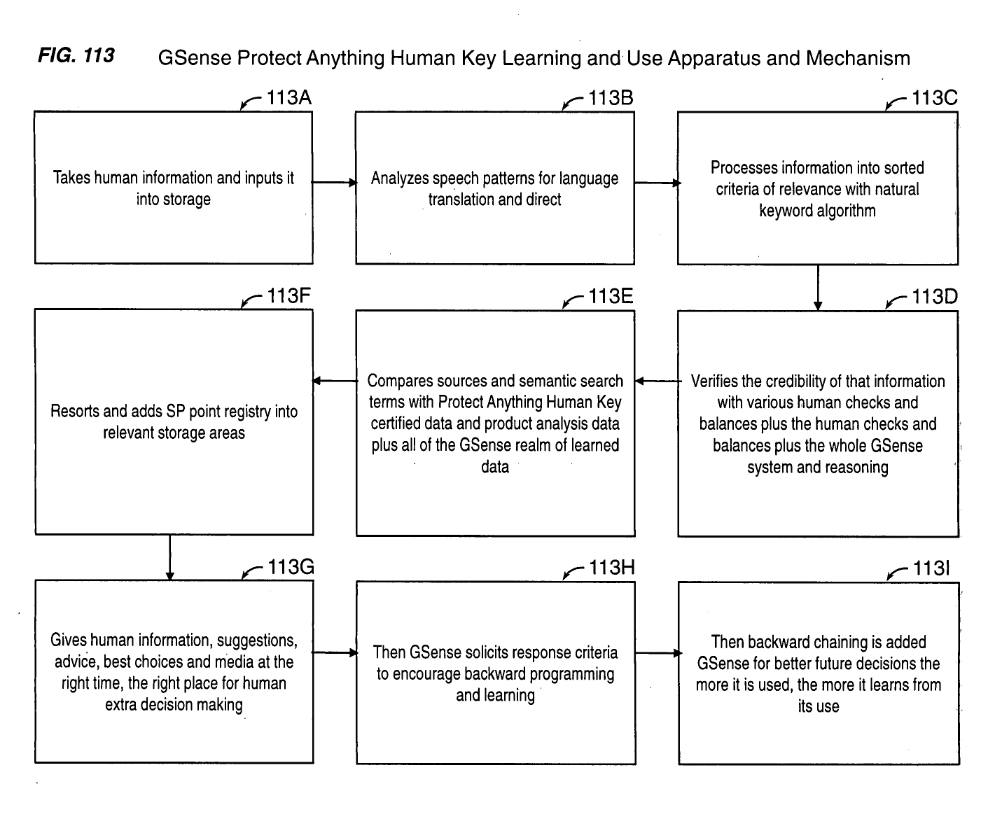

FIG. 113-113A describes GSense learning and use apparatus mechanism and shows where GSense takes human information and inputs it into storage.

FIG. 113-113B describes GSense learning and use apparatus mechanism and shows where GSense analyzes speech patterns for language translation and dialect.

FIG. 113-113C describes GSense learning and use apparatus mechanism and shows where GSense processes information into sorted criteria of relevance with natural keyword algorithm.

FIG. 113-113D describes GSense learning and use apparatus mechanism and shows GSense verifies the credibility of that information with various human checks and balances plus the whole GSense system and reasoning engine.

FIG. 113-113E describes GSense learning and use apparatus mechanism and shows GSense compares sources and semantic search terms with Protect Anything Human Key certified data and product analysis data plus all of the GSense realm of learned data.

FIG. 113-113F describes GSense learning and use apparatus mechanism and shows where then GSense re-sorts and adds SP target point registry into relevant storage areas.

FIG. 113-113G describes GSense learning and use apparatus mechanism and shows where GSense gives human information, suggestion, proposal, advice, best choices and media at the right time, right place for human extra decision making.

FIG. 113-113H describes GSense learning and use apparatus mechanism and shows where then GSense solicits response criteria to encourage backwards programming and learning.

FIG. 113-113I describes GSense learning and use apparatus mechanism and shows where backward chaining is added to GSense mechanism for better future decisions the more it is used to more it learns from its use.

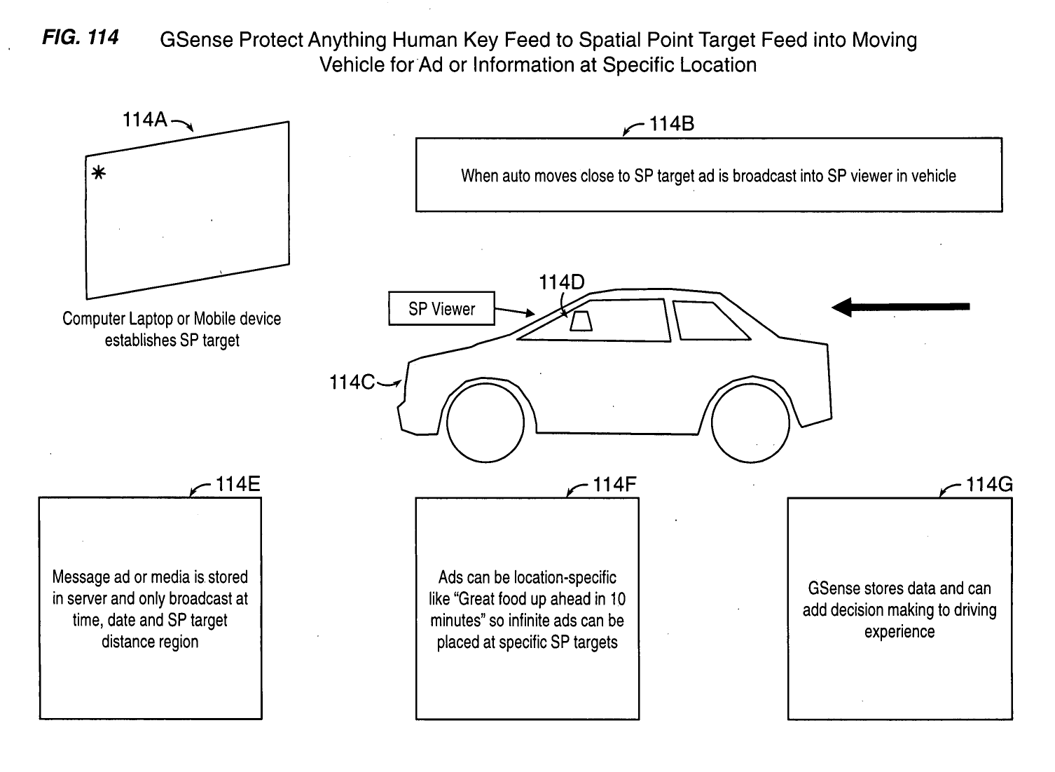

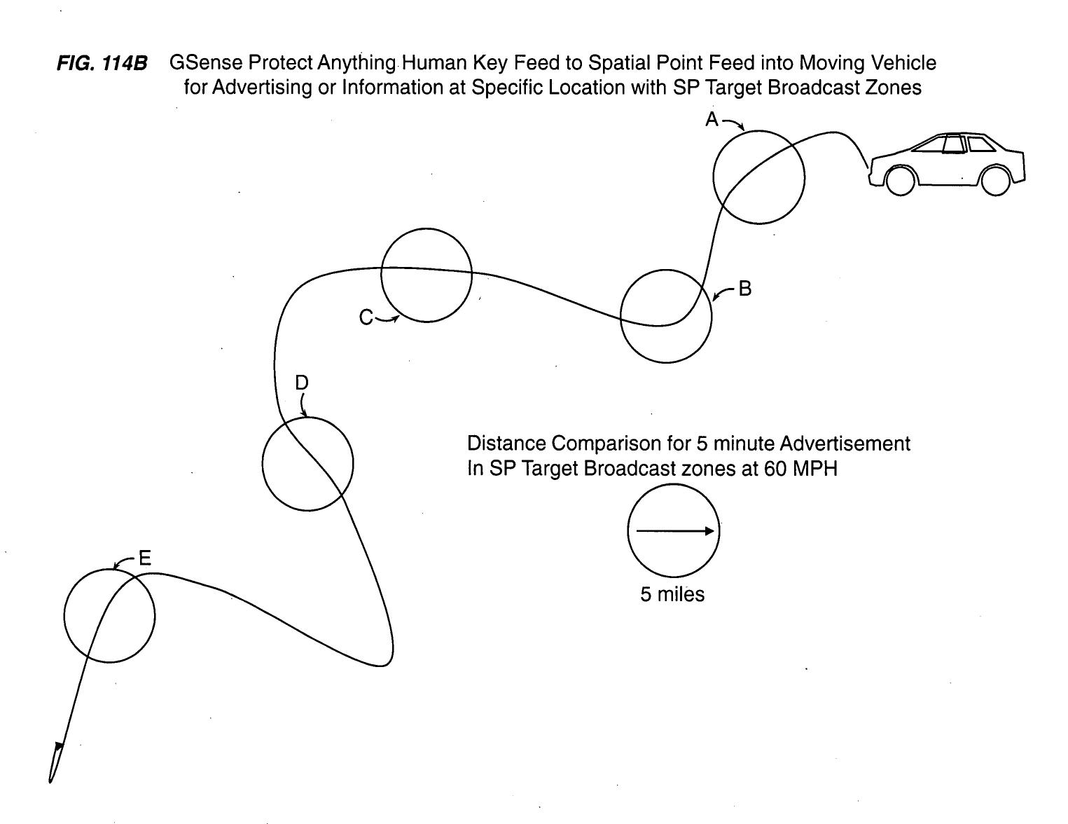

FIG. 114-114A describes GSense feed to spatial point and feed into moving vehicle for advertising or information at specific target location and shows where SP target point is set in the GSense system.

FIG. 114-114B describes GSense feed to spatial point and feed into moving vehicle for advertising or information at specific target location and shows where when auto moves close to SP target an advertisement or message is broadcast into GSense SP target fewer mechanism mounted or mobile device in vehicle.

FIG. 114-114C describes GSense feed to spatial point and feed into moving vehicle for advertising or information at specific target location and shows the GSense SP viewer mechanism.

FIG. 114-114D describes GSense feed to spatial point and feed into moving vehicle for advertising or information at specific target location and shows vehicle with GSense SP viewer mechanism.

FIG. 114-114E describes GSense feed to spatial point and feed into moving vehicle for advertising or information at specific target location and shows where the GSense message, advertisement, or media is stored at the GSense server data center and only broadcast at time, date and SP target point distant zone or region.

FIG. 114-114F describes GSense feed to spatial point and feed into moving vehicle for advertising or information at specific target location and shows GSense broadcasted advertisements, messages are media can be location specific like “great food up ahead 10 miles from here” therefore infinite advertisements or messages can be placed at specific SP target points or zones.

FIG. 114-114G describes GSense feed to spatial point and feed into moving vehicle for advertising or information at specific target location and shows GSense stores data and can add decision-making and valuable information to the driving experience with GSense SP target zones.

FIG. 114B-114B A describes GSense SP Zone Broadcast Feed mechanism and shows a map with GSense SP target zone 1 showing a 5 mile circular zone.

FIG. 114B-114B B describes GSense SP Zone Broadcast Feed mechanism and shows a map but GSense SP targets zone 2 short a 5 mile circular zone at a different GSense SP target.

FIG. 114B-114B C describes GSense SP Zone Broadcast Feed mechanism and shows a map but GSense SP targets zone 3 short a 5 mile circular zone at a different GSense SP target.

FIG. 114B-114B D describes GSense SP Zone Broadcast Feed mechanism and shows a map but GSense SP targets zone 4 short a 5 mile circular zone at a different GSense SP target.

FIG. 114B-114B E describes GSense SP Zone Broadcast Feed mechanism and shows a map but GSense SP targets zone 5 short a 5 mile circular zone at a different GSense SP target.

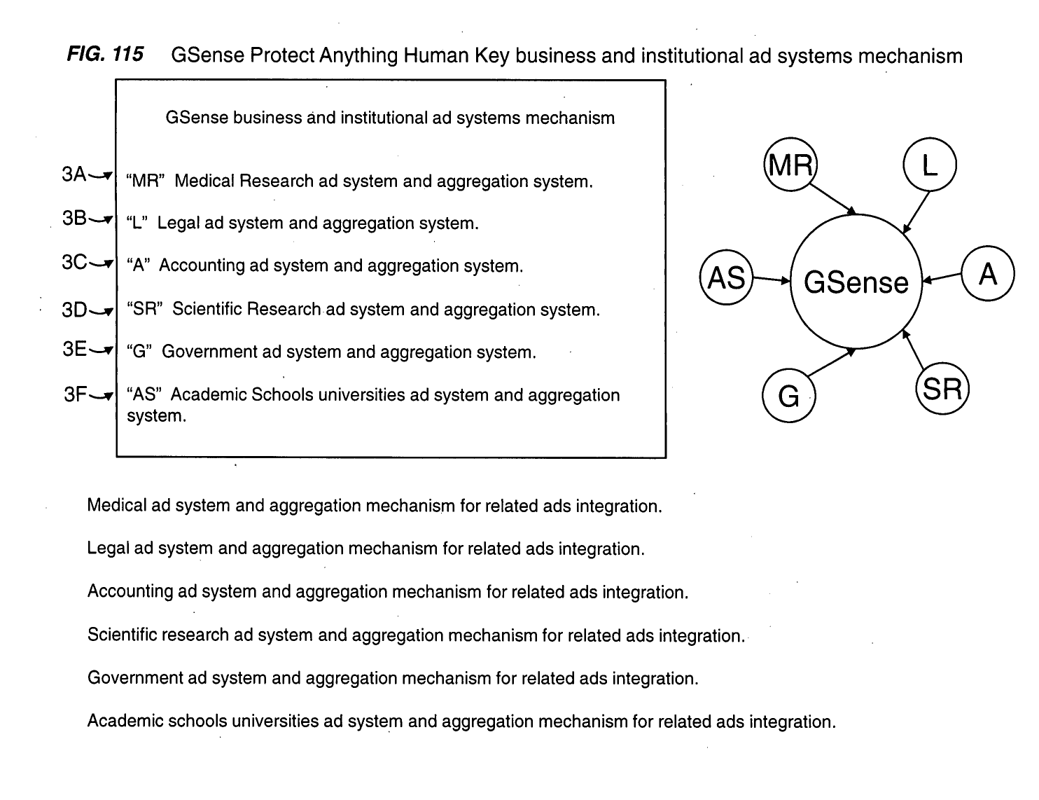

FIG. 115 3-115 3A describes GSense business and institutional advertising systems mechanism and shows medical research advertising system and aggregation system code letters for related advertising integration.

FIG. 115 3-115 3B describes GSense business and institutional advertising systems mechanism and shows legal advertising system and aggregation system code letters for related advertising integration.

FIG. 115 3-115 3C describes GSense business and institutional advertising systems mechanism and shows accounting advertising system aggregation system code letters for related advertising integration.

FIG. 115 3-115 3D describes GSense business and institutional advertising systems mechanism and shows scientific research and advertising system aggregation system code letters for related advertising integration.

FIG. 115 3-115 3E describes GSense business and institutional advertising systems mechanism and shows government advertising system and aggregation system code letters for related advertising integration.

FIG. 115 3-115 3F describes GSense business and institutional advertising systems mechanism and shows academic schools universities advertising system aggregation system code letters for related advertising integration.

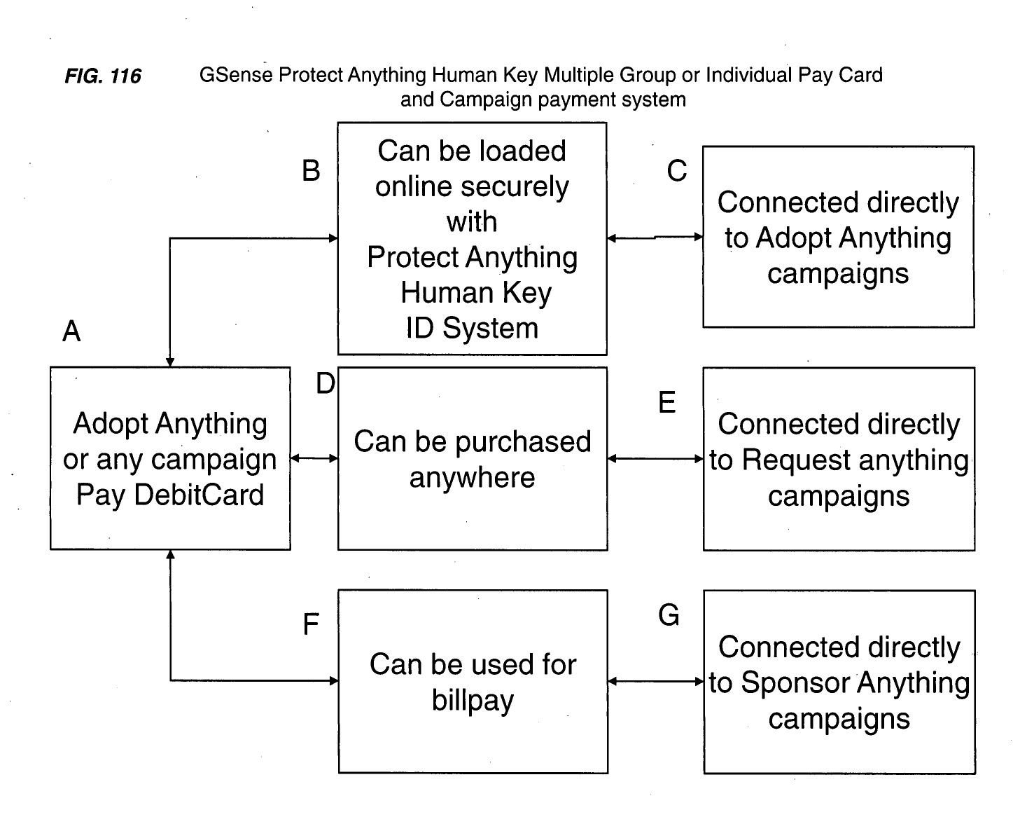

FIG. 116-116A describes Adopt Anything campaign or any campaign Group or Individual Pay Debit Credit Card with Protect Anything Human Key and GSense and shows the Adopt Anything campaign or any campaign pay debit credit card.

FIG. 116-116B describes Adopt Anything campaign or any campaign Group or Individual Pay Debit Credit Card with Protect Anything Human Key and GSense and shows how card can be loaded online securely with Protect Anything Human Key identification mechanism.

FIG. 116-116C describes Adopt Anything campaign or any campaign Group or Individual Pay Debit Credit Card with Protect Anything Human Key and GSense and shows where the pay system is connected directly to Adopt Anything campaign or any campaign.

FIG. 116-116D describes Adopt Anything campaign or any campaign Group or Individual Pay Debit Credit Card with Protect Anything Human Key and GSense and shows where card can be purchased anywhere.

FIG. 116-116E describes Adopt Anything campaign or any campaign Group or Individual Pay Debit Credit Card with Protect Anything Human Key and GSense and shows where the mechanism can be connected directly to Request Anything campaigns.

FIG. 116-116F describes Adopt Anything campaign or any campaign Group or Individual Pay Debit Credit Card with Protect Anything Human Key and GSense and shows the card can be used for bill paying.

FIG. 116-116G describes Adopt Anything campaign or any campaign Group or Individual Pay Debit Credit Card with Protect Anything Human Key and GSense and shows the card can be connected directly to Sponsor Anything campaigns.

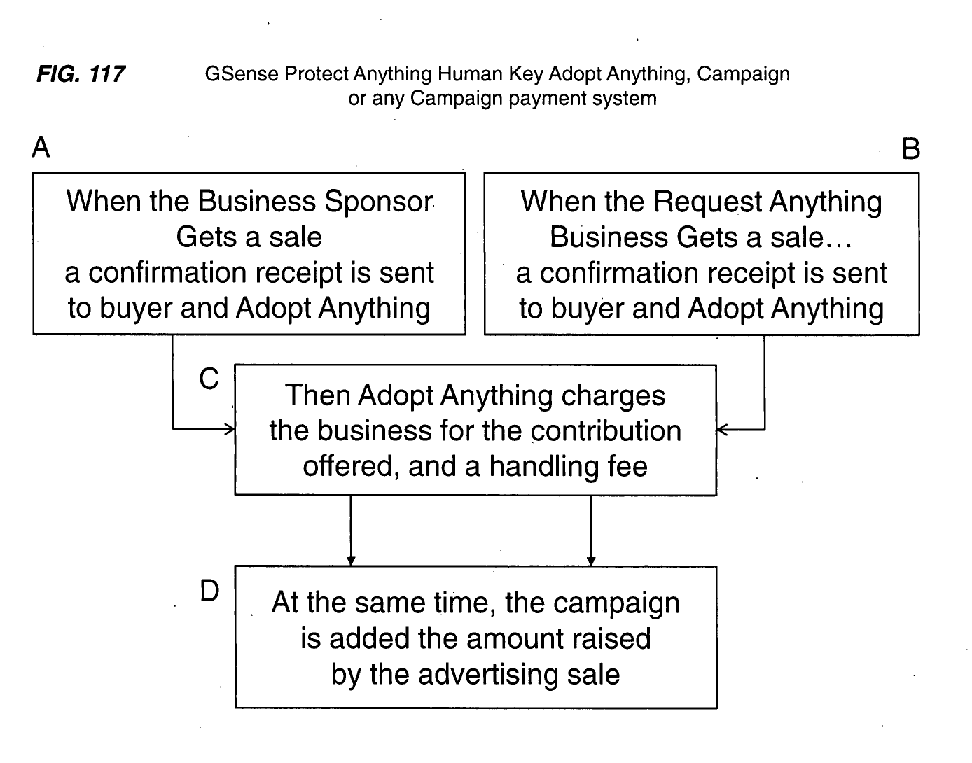

FIG. 117-117A describes Adopt Anything campaign or any campaign transfer of ad revenue from business sponsor to Adopt Anything campaign or any campaign with Protect Anything Human Key and GSense and shows where when a sponsor gets a sale a confirmation receipt sent to buyer and Adopt Anything campaign or any campaign at the same time.

FIG. 117-117B describes Adopt Anything campaign or any campaign transfer of ad revenue from business sponsor to Adopt Anything campaign or any campaign with Protect Anything Human Key and GSense and shows when the Request Anything business gets a sale a confirmation receipt sent to buyer and Adopt Anything campaign or any campaign system and mechanism.

FIG. 117-117C describes Adopt Anything campaign or any campaign transfer of ad revenue from business sponsor to Adopt Anything campaign or any campaign with Protect Anything Human Key and GSense and shows then Adopt Anything campaign or any campaign charges business for contribution offered and handling fee.

FIG. 117-117D describes Adopt Anything campaign or any campaign transfer of ad revenue from business sponsor to Adopt Anything campaign or any campaign with Protect Anything Human Key and GSense and shows same time campaign is added in outraced a sponsor by the advertised sale.

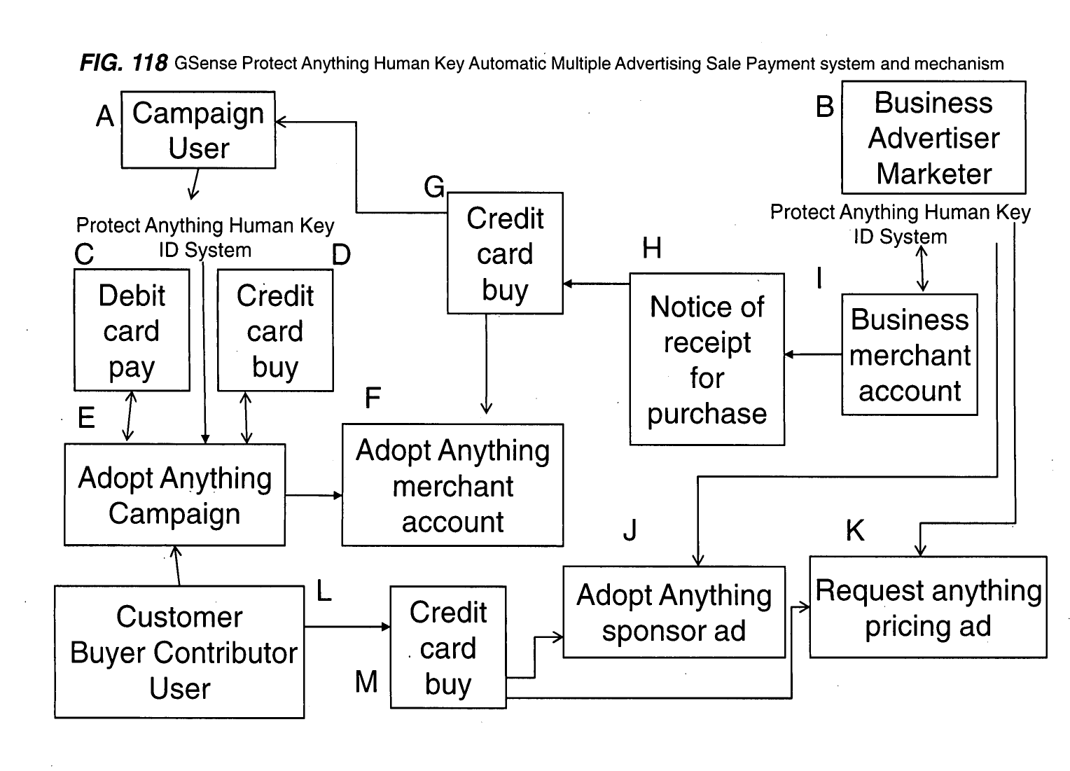

FIG. 118-118A describes multiple advertising and pay method for Adopt Anything campaign or any campaign with Protect Anything Human Key and GSense and shows where campaign user utilizes the system with Protect Anything Human Key verification identification.

FIG. 118-118B describes multiple advertising and pay method for Adopt Anything campaign or any campaign with Protect Anything Human Key and GSense and shows where the business advertiser marketer sponsor utilizes the Protect Anything Human Key identification system to connect to the Adopt Anything campaign or any campaign Sponsor Anything network.

FIG. 118-118C describes multiple advertising and pay method for Adopt Anything campaign or any campaign with Protect Anything Human Key and GSense and shows where campaign user uses a debit card to pay or buy a credit card to or buy.

FIG. 118-118D describes multiple advertising and pay method for Adopt Anything campaign or any campaign with Protect Anything Human Key and GSense and shows where campaign user uses a credit card to pay or buy.

FIG. 118-118E describes multiple advertising and pay method for Adopt Anything campaign or any campaign with Protect Anything Human Key and GSense and shows campaign user using credit card or debit card with their Adopt Anything campaign or any campaign.

FIG. 118-118F describes multiple advertising and pay method for Adopt Anything campaign or any campaign with Protect Anything Human Key and GSense and shows campaign user using the card or debit card with their Adopt Anything campaign or any campaign in Adopt Anything campaign or any campaign merchant account.

FIG. 118-118G describes multiple advertising and pay method for Adopt Anything campaign or any campaign with Protect Anything Human Key and GSense and shows from the Adopt Anything campaign or any campaign merchant account a credit card buy is made.

FIG. 118-118H describes multiple advertising and pay method for Adopt Anything campaign or any campaign with Protect Anything Human Key and GSense and shows a credit card buy is made through the Adopt Anything campaign or any campaign merchant account and a notice of receipt for purchase is created.

FIG. 118-118I describes multiple advertising and pay method for Adopt Anything campaign or any campaign with Protect Anything Human Key and GSense and shows where the business advertiser marketer that has been authorized through Protect Anything Human Key identification system then charges the business credit card merchant account for fees and additional Adopt Anything campaign or any campaign contribution.

FIG. 118-118J describes multiple advertising and pay method for Adopt Anything campaign or any campaign with Protect Anything Human Key and GSense and shows where all is connected to the Sponsor Anything Adopt Anything campaign or any campaign advertisement.

FIG. 118-118K describes multiple advertising and pay method for Adopt Anything campaign or any campaign with Protect Anything Human Key and GSense and shows where Request Anything pricing for the advertisement is involved also in the mechanism.

FIG. 118-118L describes multiple advertising and pay method for Adopt Anything campaign or any campaign with Protect Anything Human Key and GSense and shows where a customer buyer contributor or user can also utilize the Adopt Anything campaign or any campaign credit card debit card system and mechanism.

FIG. 118-118M describes multiple advertising and pay method for Adopt Anything campaign or any campaign with Protect Anything Human Key and GSense and shows the actual Adopt Anything campaign or any campaign credit card buy.

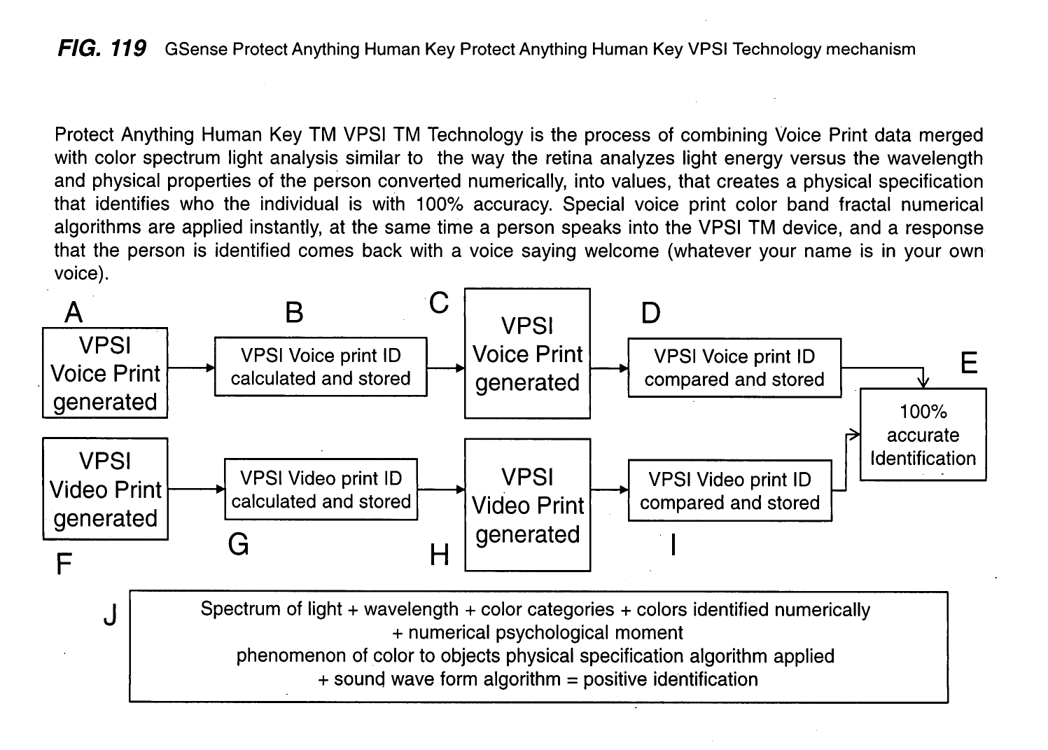

FIG. 119-119A describes Protect Anything Human Key VPSI mechanism and shows where VPSI mechanism generates a voice print at registration.

FIG. 119-119B describes Protect Anything Human Key VPSI mechanism and shows where VPSI mechanism voice print identification is calculated and stored.

FIG. 119-119C describes Protect Anything Human Key VPSI mechanism and shows where VPSI mechanism is used when person must verify and already registered in the patient a new voice print is generated.

FIG. 119-119D describes Protect Anything Human Key VPSI mechanism and shows where VPSI mechanism voice print identification is compared to the registered voice print stored.

FIG. 119-119E describes Protect Anything Human Key VPSI mechanism and shows where results are 100% accurate identification.

FIG. 119-119F describes Protect Anything Human Key VPSI mechanism and shows where VPSI mechanism video print is generated at registration.

FIG. 119-119G describes Protect Anything Human Key VPSI mechanism and shows where VPSI mechanism video print identification is calculated and stored.

FIG. 119-119H describes Protect Anything Human Key VPSI mechanism and shows where VPSI mechanism is used when a person wants to verify and already registered identification and new video print is generated.

FIG. 119-119I describes Protect Anything Human Key VPSI mechanism and shows where VPSI mechanism video print identification is compared to the registered video print stored.

FIG. 119-119J describes Protect Anything Human Key VPSI mechanism and shows the formula: spectrum of light plus wavelength plus color categories close colors identified numerically plus numerical psychological moment plus 3-D spatial view analysis plus phenomenon of color to objects physical specification algorithm applied plus soundwave form algorithm equals 100% positive identification.

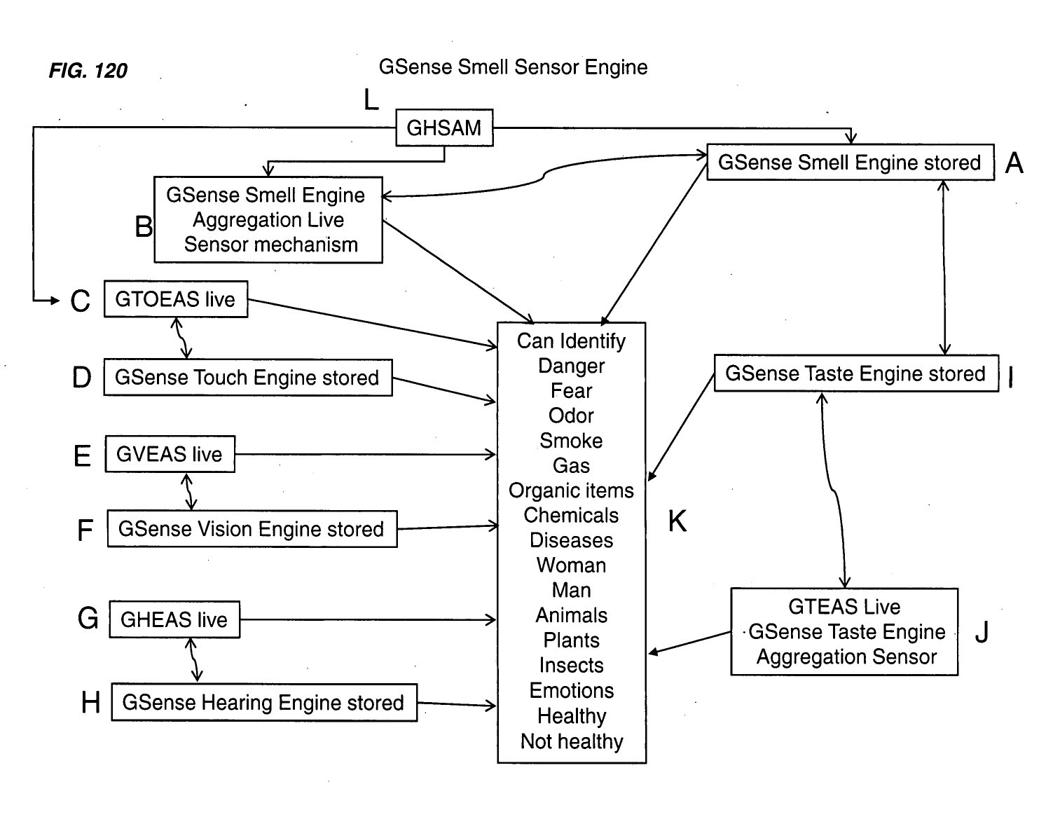

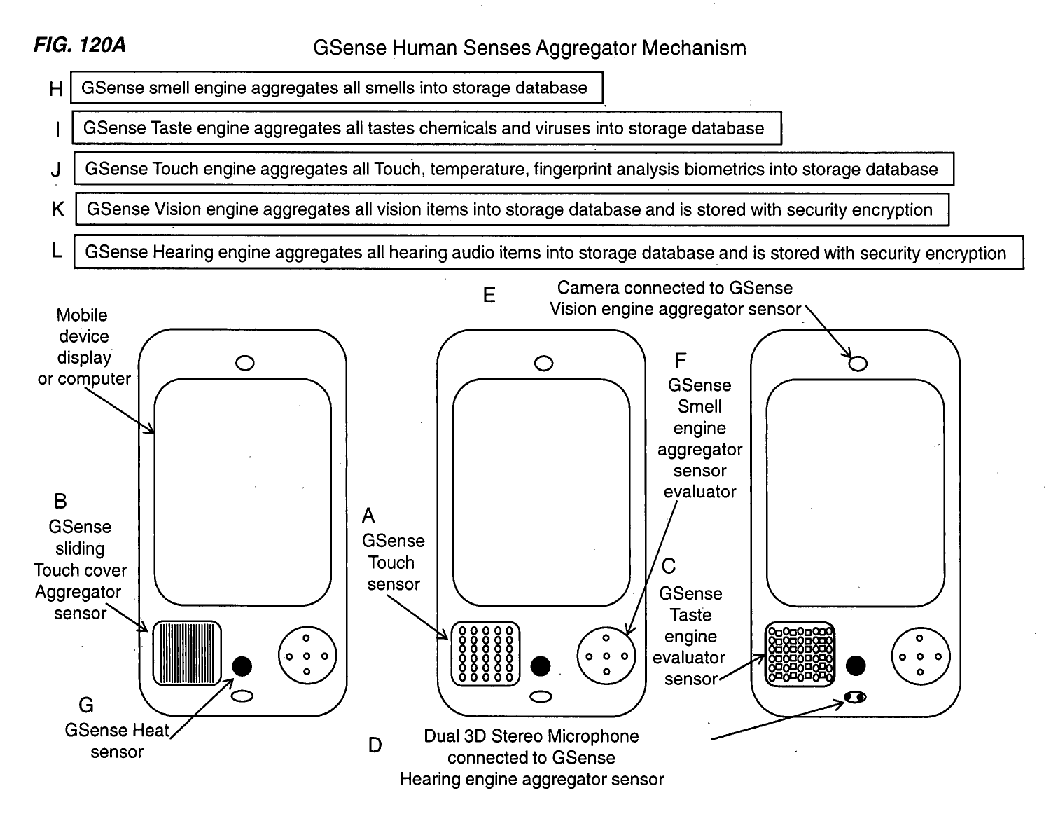

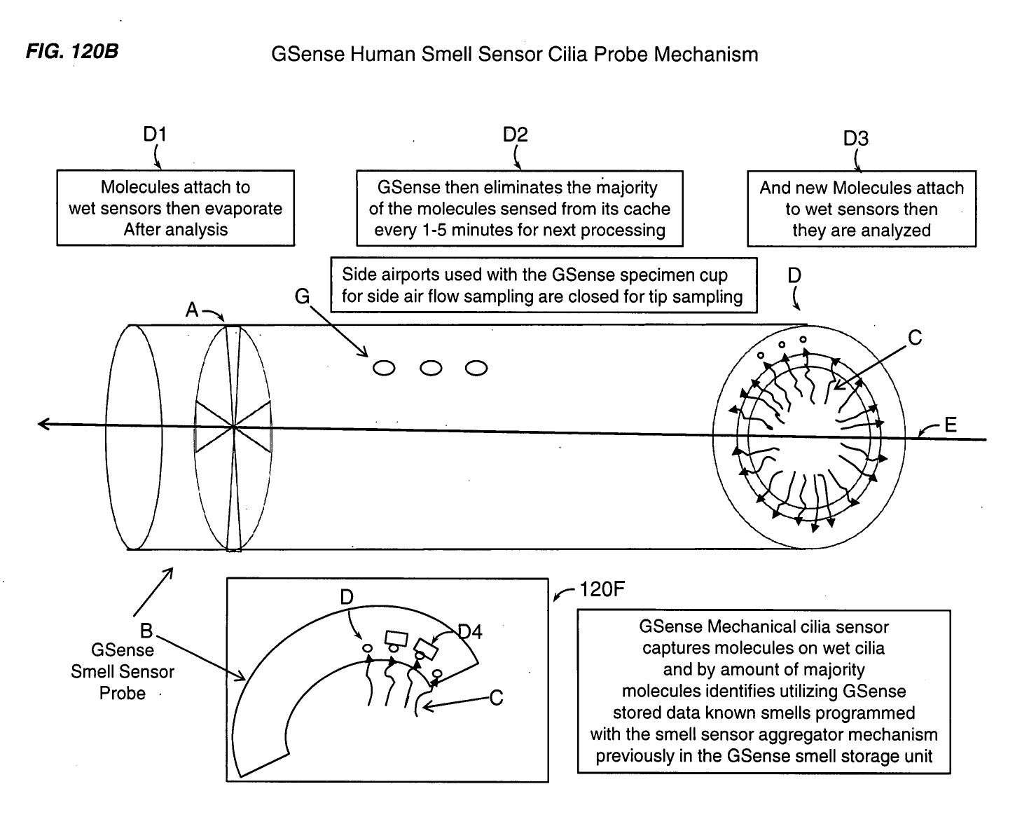

FIG. 120-A describes GSense Smell Engine and shows the stored GSense smell engine.

FIG. 120-B describes GSense Smell Engine and shows GSense smell engine aggregation sensor mechanism live.

FIG. 120-C describes GSense Smell Engine and shows GSense touch engine aggregation sensor mechanism live.

FIG. 120-D describes GSense Smell Engine and shows GSense touch engine stored.

FIG. 120-E describes GSense Smell Engine and shows the GSense vision engine aggregation sensor mechanism live.

FIG. 120-F describes GSense Smell Engine and shows the GSense vision engine stored.

FIG. 120-G describes GSense Smell Engine and shows GSense hearing engine aggregation sensor mechanism live.

FIG. 120-H describes GSense Smell Engine and shows the GSense hearing engined stored.

FIG. 120-I describes GSense Smell Engine and shows the GSense taste engine stored.

FIG. 120-J describes GSense Smell Engine and shows the GSense taste engine aggregation sensor mechanism live.

FIG. 120-K describes GSense Smell Engine and shows where GSense smell system engine can identify danger, fear, odor, smoke, gas, organic materials, chemicals, diseases, a woman, a man, animals, plants, insects, emotions, if a person is healthy, if a person is not healthy.

FIG. 120-L describes GSense Smell Engine and shows the GSense human senses aggregator mechanism hardware unit.

FIG. 120A-A describes GSense Human Senses Aggregator Mechanism and shows the GSense smell engine aggregator device with ventilator fan and touch sensor combined.

FIG. 120A-B describes GSense Human Senses Aggregator Mechanism and shows the GSense touch sensor sliding cover engine aggregator.

FIG. 120A-C describes GSense Human Senses Aggregator Mechanism and shows the GSense taste engine aggregator evaluator device.

FIG. 120A-D describes GSense Human Senses Aggregator Mechanism and shows a dual 3D stereo microphone connected to GSense hearing engine sensor aggregator mechanism.

FIG. 120A-E describes GSense Human Senses Aggregator Mechanism and shows the GSense vision engine sensor aggregator connected to the videocam.

FIG. 120A-F describes GSense Human Senses Aggregator Mechanism and shows the GSense smell engine aggregator sensor evaluator mechanism.

FIG. 120A-G describes GSense Human Senses Aggregator Mechanism and shows where the GSense touch heat normal pressure sensor for fingerprint patterns and temperature variations to equal touch patterns of pressure, movement and thermal points evaluation with a 600×800 pixel point evaluation mechanism.

FIG. 120A-H describes GSense Human Senses Aggregator Mechanism and shows where the GSense smell engine aggregates all smells into database utilizing the GSense smell engine aggregator sensor evaluator mechanism and stores with encryption de-encrypt methods of Protect Anything Human Key.

FIG. 120A-I describes GSense Human Senses Aggregator Mechanism and shows where the GSense taste engine aggregates all taste and chemical into database utilizing the GSense taste engine sensor aggregator evaluator mechanism and stores with encryption de-encrypt methods of Protect Anything Human Key.

FIG. 120A-J describes GSense Human Senses Aggregator Mechanism and shows the GSense touch engine aggregates all touch, temperature, fingerprint analysis, biometrics into database utilizing the GSense touch engine sensor aggregator evaluator mechanism and stores with encryption de-encrypt methods of Protect Anything Human Key.

FIG. 120A-K describes GSense Human Senses Aggregator Mechanism and shows the GSense vision engine aggregates vision items into database utilizing the GSense vision engine sensor aggregator evaluator mechanism visuals are converted to analysis data is stored for cross-referenced with deductive, abductive, and inductive reasoning mechanisms to get past analysis of what it is visually and stores with encryption de-encrypt methods of Protect Anything Human Key.

FIG. 120A-L describes GSense Human Senses Aggregator Mechanism and shows the GSense hearing it aggregates all hearing audio items into database and utilizing the GSense hearing engine sensor aggregator evaluator mechanism and the audio data is stored in converts to waveform and sound analysis data for fast analysis of what it is from an audio perspective and stores with encryption de-encrypt methods of Protect Anything Human Key.

FIG. 120B-A describes GSense Human Smell Sensor Cilia Probe Aggregator Mechanism and shows a fan for extracting airflow through GSense cilia sensors.

FIG. 120B-B describes GSense Human Smell Sensor Cilia Probe Aggregator Mechanism and shows where GSense adjusts with timer and smell is absorbed ruling out has smell and passed smells are erased from sensor from the GSense engine main processor end to clear out odors from the system for the next smell observation and analysis.

FIG. 120B-C describes GSense Human Smell Sensor Cilia Probe Aggregator Mechanism and shows the GSense cilia sensor mechanism in an analysis tube system.

FIG. 120B-D1 describes GSense Human Smell Sensor Cilia Probe Aggregator Mechanism and shows where molecules attach to wet Sensor cilia then evaporate after analysis.

FIG. 120B-D2 describes GSense Human Smell Sensor Cilia Probe Aggregator Mechanism and shows where then GSense eliminates the majority of molecules sensed every five minutes or one minute to clear out for new test and evaluation.

FIG. 120B-D3 describes GSense Human Smell Sensor Cilia Probe Aggregator Mechanism and shows then new molecules get analyzed.

FIG. 120B-D4 describes GSense Human Smell Sensor Cilia Probe Aggregator Mechanism and shows that GSense automatically wets to sensors cilia can molecules attach much easier to wet cilia sensors and create special vapors and chemical reactions on the cilia sensors that can be analyzed with GSense gaseous analysis mechanism.

FIG. 120B-E describes GSense Human Smell Sensor Cilia Probe Aggregator Mechanism and shows the airflow around the GSense smell Sensor mechanism.

FIG. 120B-F describes GSense Human Smell Sensor Cilia Probe Aggregator Mechanism and shows a description of the GSense mechanical cilia sensor mechanism where it can capture molecules and by the amount of the majority of molecules identifies with cross reference to database known molecular smells programmed with GSense smell Sensor aggregator mechanism.

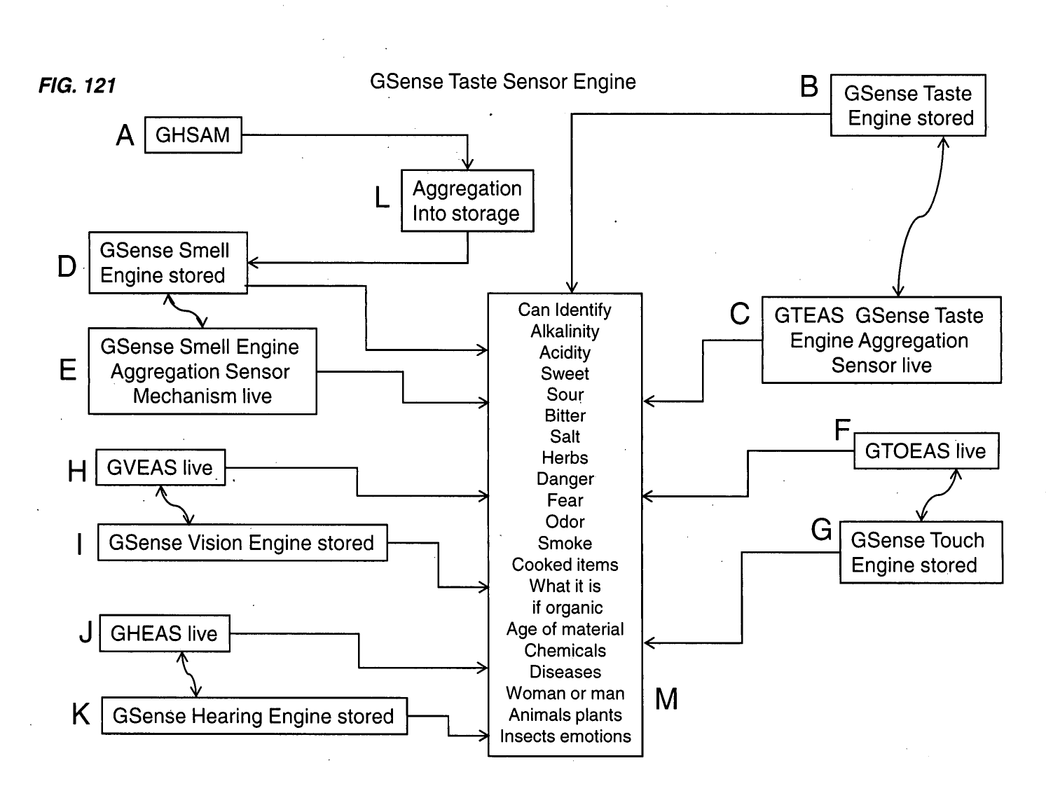

FIG. 121-A describes GSense Taste Engine and shows the GSense human senses aggregator and mechanism hardware unit.

FIG. 121-B describes GSense Taste Engine and shows the GSense taste engine for storage.

FIG. 121-C describes GSense Taste Engine and shows the GSense taste engine aggregation sensor live.

FIG. 121-D describes GSense Taste Engine and shows the GSense engine stored.

FIG. 121-E describes GSense Taste Engine and shows the GSense smell engine aggregation sensor live there 75% of taste and smell sensations.

FIG. 121-F describes GSense Taste Engine and shows the GSense touch engine aggregation sensor live.

FIG. 121-G describes GSense Taste Engine and shows the GSense touch engine stored.

FIG. 121-H describes GSense Taste Engine and shows the GSense patient engine stored.

FIG. 121-I describes GSense Taste Engine and shows the GSense vision engine aggregation sensor live.

FIG. 121-J describes GSense Taste Engine and shows the GSense hearing engine stored.

FIG. 121-K describes GSense Taste Engine and shows the GSense hearing engine aggregation sensor live.

FIG. 121-L describes GSense Taste Engine and shows the aggregation into the storage smell unit.

FIG. 121-M describes GSense Taste Engine and shows where the GSense taste engine to identify alkaline, acid, sweet, sour, bitter, salt, herbs, danger, fear, odor, smoke, cooked items, what it is organic, aged material, chemicals, diseases, women, men, animals, plants, insects, emotions.

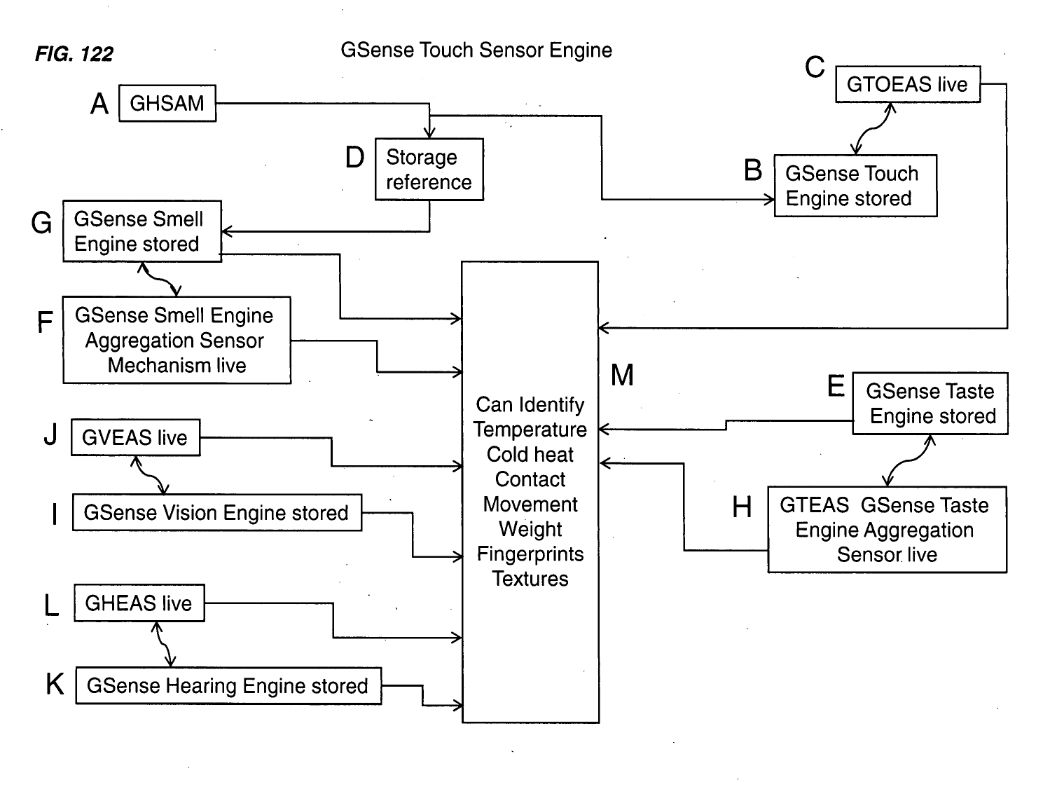

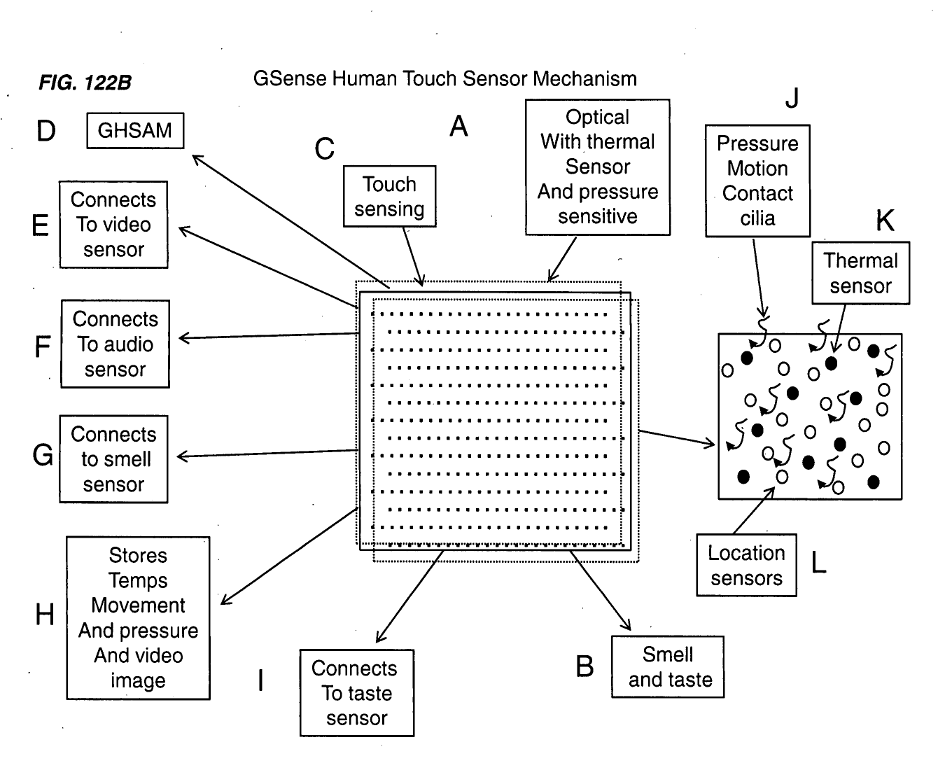

FIG. 122-A describes GSense Touch Engine and shows the GSense human senses aggregator mechanism hardware unit.

FIG. 122-B describes GSense Touch Engine and shows the GSense touch engine storage.

FIG. 122-C describes GSense Touch Engine and shows the GSense touch engine aggregation sensor live.

FIG. 122-D describes GSense Touch Engine and shows storage reference.

FIG. 122-E describes GSense Touch Engine and shows GSense taste engine storage.

FIG. 122-F describes GSense Touch Engine and shows GSense taste engine aggregation sensor live.

FIG. 122-G describes GSense Touch Engine and shows GSense smell engines storage.

FIG. 122-H describes GSense Touch Engine and shows GSense taste engine aggregation sensor live.

FIG. 122-I describes GSense Touch Engine and shows GSense vision engine storage.

FIG. 122-J describes GSense Touch Engine and shows GSense vision engine aggregation sensor live.

FIG. 122-K describes GSense Touch Engine and shows GSense hearing engines storage.

FIG. 122-L describes GSense Touch Engine and shows GSense hearing engine aggregation sensor live.

FIG. 122-M describes GSense Touch Engine and shows where GSense touch engine can identify temperature, cold, heat, contact point, movement, weight, and textures like fingerprints or fabric.

FIG. 122B-A describes GSense Human Touch Sensor Mechanism and shows Optical with all Sensor and pressure sensitive mechanism.

FIG. 122B-B describes GSense Human Touch Sensor Mechanism and shows can sense smell and taste.

FIG. 122B-C describes GSense Human Touch Sensor Mechanism and shows can sense touch sensations.

FIG. 122B-D describes GSense Human Touch Sensor Mechanism and shows GSense human senses aggregator mechanism hardware unit.

FIG. 122B-E describes GSense Human Touch Sensor Mechanism and shows that the GSense touch Sensor mechanism connects to video Sensor for better evaluations.

FIG. 122B-F describes GSense Human Touch Sensor Mechanism and shows that the GSense touch Sensor mechanism connects to audio Sensor for better evaluations.

FIG. 122B-G describes GSense Human Touch Sensor Mechanism and shows that the GSense touch Sensor mechanism connects to smell sensor or better evaluations.

FIG. 122B-H describes GSense Human Touch Sensor Mechanism and shows the GSense touch Sensor stores temperatures movement and pressure and video images for evaluation.

FIG. 122B-I describes GSense Human Touch Sensor Mechanism and shows the GSense touch Sensor stores information and connects to taste sensor for better evaluations.

FIG. 122B-J describes GSense Human Touch Sensor Mechanism and shows the GSense touch Sensor has multiple thermal Sensor points and pressure motion cilia points for contact and motion evaluation, and location sensors that are fingerprint and fabric texture or any texture evaluation that works with top movement of cilia causing measurements in base for motion, and also the electronic cilia material allows for analyzing molecules throughout the length of the electronic cilia material sending informational data to the base of the cilia for processing at GSense.

FIG. 122B-K describes GSense Human Touch Sensor Mechanism and shows the GSense touch Sensor has multiple thermal Sensor points and pressure motion cilia points for contact and motion evaluation, and location sensors that are fingerprint and fabric texture or any texture evaluation with a thermal sensor.

FIG. 122B-L describes GSense Human Touch Sensor Mechanism and shows the GSense touch Sensor has multiple thermal Sensor points and pressure motion cilia points for contact and motion evaluation, and location sensors that are fingerprint and fabric texture or any texture evaluation with a location sensor.

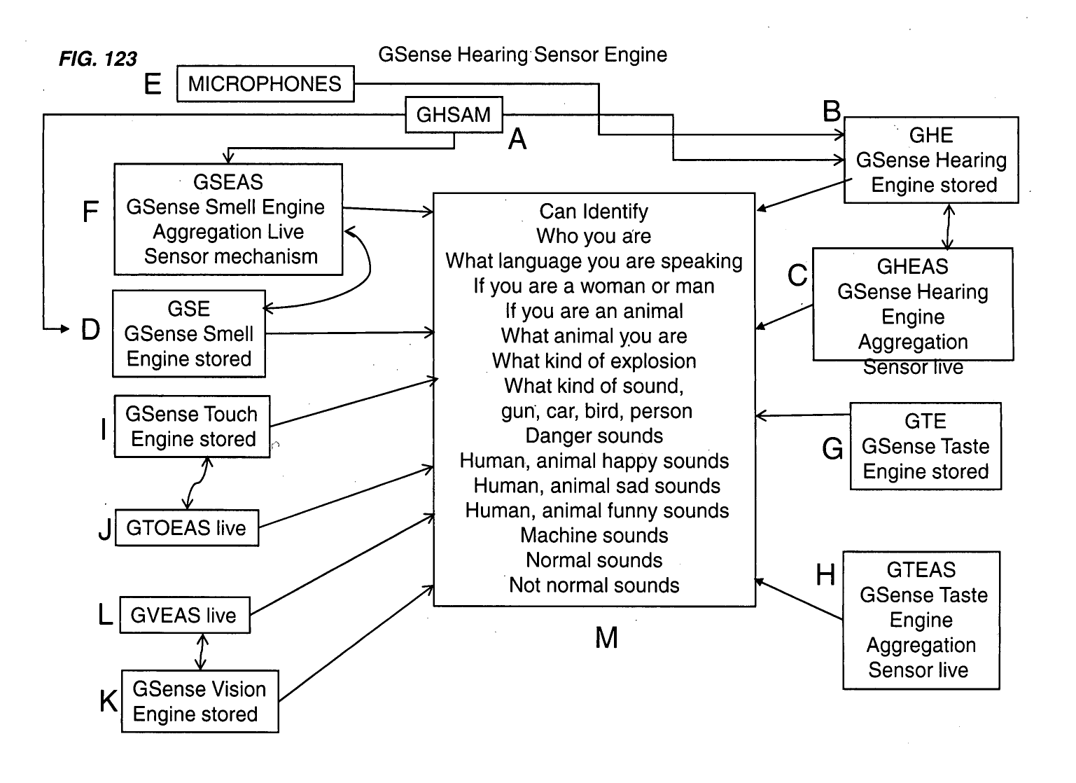

FIG. 123-A describes GSense Hearing Engine and shows the GSense human senses aggregator mechanism hardware unit.

FIG. 123-B describes GSense Hearing Engine and shows the GSense hearing engine stored.

FIG. 123-C describes GSense Hearing Engine and shows the GSense hearing engine aggregation sensor live.

FIG. 123-D describes GSense Hearing Engine and shows the GSense smell engine storage.

FIG. 123-E describes GSense Hearing Engine and shows stereo microphones for audio input sensing.

FIG. 123-F describes GSense Hearing Engine and shows GSense smell engine aggregation sensor mechanism live.

FIG. 123-G describes GSense Hearing Engine and shows GSense taste engine stored.

FIG. 123-H describes GSense Hearing Engine and shows GSense taste engine aggregation sensor mechanism live.

FIG. 123-I describes GSense Hearing Engine and shows GSense touch engine stored.

FIG. 123-J describes GSense Hearing Engine and shows GSense touch engine aggregation sensor live.

FIG. 123-K describes GSense Hearing Engine and shows GSense vision engine stored.

FIG. 123-L describes GSense Hearing Engine and shows GSense vision engine aggregation sensor live.

FIG. 123-M describes GSense Hearing Engine and shows him GSense hearing engine can identify who you are, what language you are speaking, if you are a woman or a man, if you are an animal, what kind of animal you are, what kind of explosion, what kind of sound, gunshot's, car, bird, person, danger sounds, happy sounds, machine sounds, normal machine sounds, abnormal machine sounds.

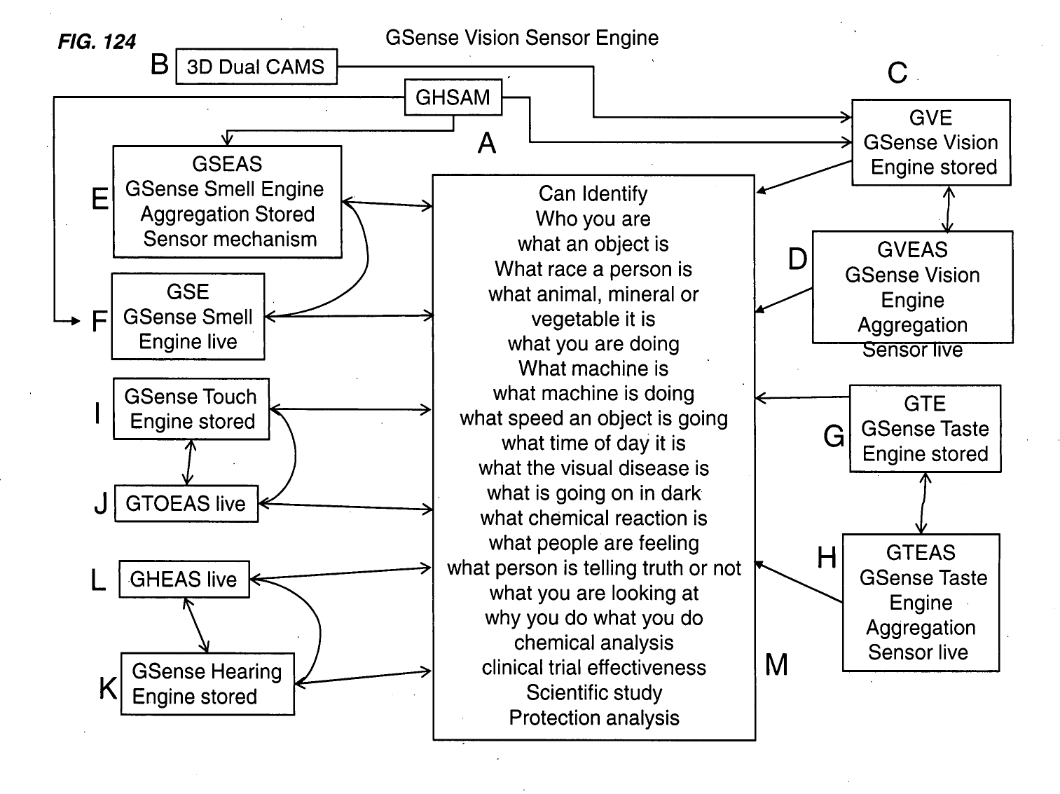

FIG. 124-A describes GSense Vision Engine and shows GSense human senses aggregator mechanism hardware unit.

FIG. 124-B describes GSense Vision Engine and shows 3D Dual video cams.

FIG. 124-C describes GSense Vision Engine and shows GSense vision engine stored.

FIG. 124-D describes GSense Vision Engine and shows GSense vision engine aggregation sensor mechanism live.

FIG. 124-E describes GSense Vision Engine and shows GSense smell engine stored.

FIG. 124-F describes GSense Vision Engine and shows GSense smell engine aggregation sensor mechanism live.

FIG. 124-G describes GSense Vision Engine and shows GSense taste engine stored.

FIG. 124-H describes GSense Vision Engine and shows GSense taste engine aggregation sensor mechanism live.

FIG. 124-I describes GSense Vision Engine and shows GSense touch engine stored.

FIG. 124-J describes GSense Vision Engine and shows GSense touch engine aggregation sensor mechanism live.

FIG. 124-K describes GSense Vision Engine and shows GSense hearing, engine stored.

FIG. 124-L describes GSense Vision Engine and shows GSense hearing engine aggregation sensor live.

FIG. 124-M describes GSense Vision Engine and shows what the GSense vision engine can Identify who you are, what an object is, what race a person is, what animal, mineral, or vegetable it is, what you are doing, what machine is, what machine is doing, what speed an object is going, what time of day it is, what the visual diseases, what is going on in the dark, what chemical reaction is happening, what people are feeling, what person is telling the truth or not, what you are looking at, why you do what you do, chemical analysis, clinical trial effectiveness, scientific study, product analysis, protection analysis.

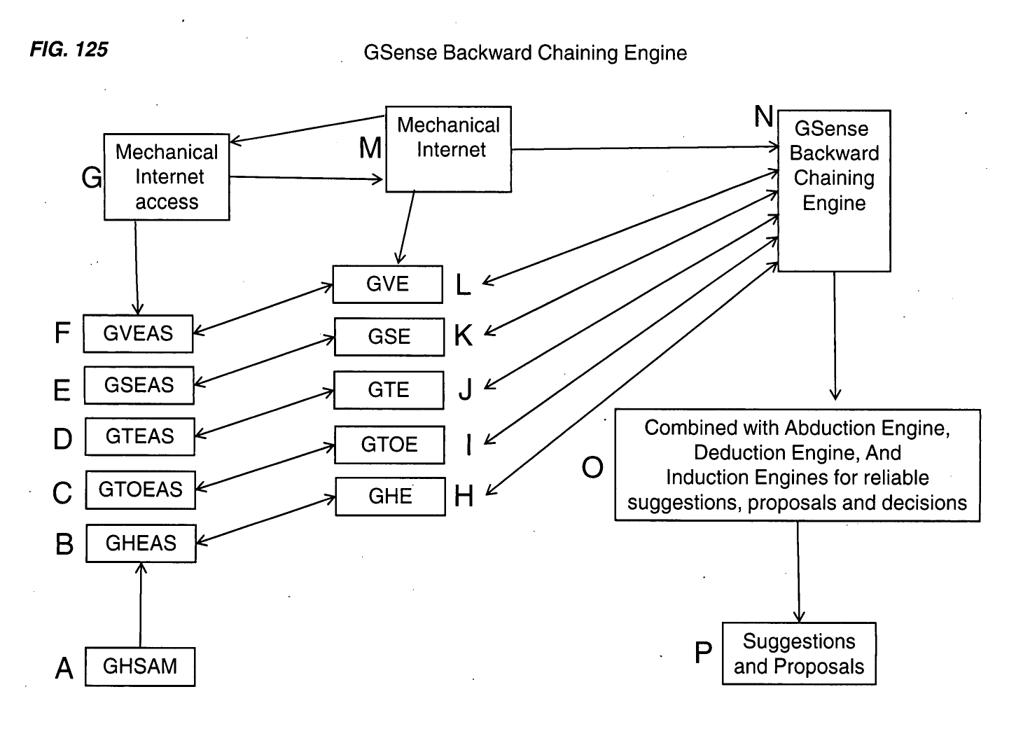

FIG. 125-A describes GSense Backward Chaining Engine and shows that GSense human senses aggregator mechanism hardware unit.

FIG. 125-B describes GSense Backward Chaining Engine and shows GSense hearing Engine aggregator sensor.

FIG. 125-C describes GSense Backward Chaining Engine and shows GSense touch engine aggregator sensor.

FIG. 125-D describes GSense Backward Chaining Engine and shows GSense taste engine aggregator sensor.

FIG. 125-E describes GSense Backward Chaining Engine and shows GSense smell engine aggregator sensor.

FIG. 125-F describes GSense Backward Chaining Engine and shows GSense vision engine aggregator sensor.

FIG. 125-G describes GSense Backward Chaining Engine and shows the mechanical Internet access connection.

FIG. 125-H describes GSense Backward Chaining Engine and shows GSense hearing engine.

FIG. 125-I describes GSense Backward Chaining Engine and shows GSense touch engine.

FIG. 125-J describes GSense Backward Chaining Engine and shows GSense taste engine.

FIG. 125-K describes GSense Backward Chaining Engine and shows GSense smell engine.

FIG. 125-L describes GSense Backward Chaining Engine and shows GSense vision engine.

FIG. 125-M describes GSense Backward Chaining Engine and shows the mechanical Internet.

FIG. 125-N describes GSense Backward Chaining Engine and shows GSense backward chaining engine.

FIG. 125-O describes GSense Backward Chaining Engine and shows GSense backward chaining agent combined with abduction engine, induction engine, deductive engine, for reliable time and space decisions, suggestions, proposals.

FIG. 125-P describes GSense Backward Chaining Engine and shows where GSense then creates suggestions and proposals.

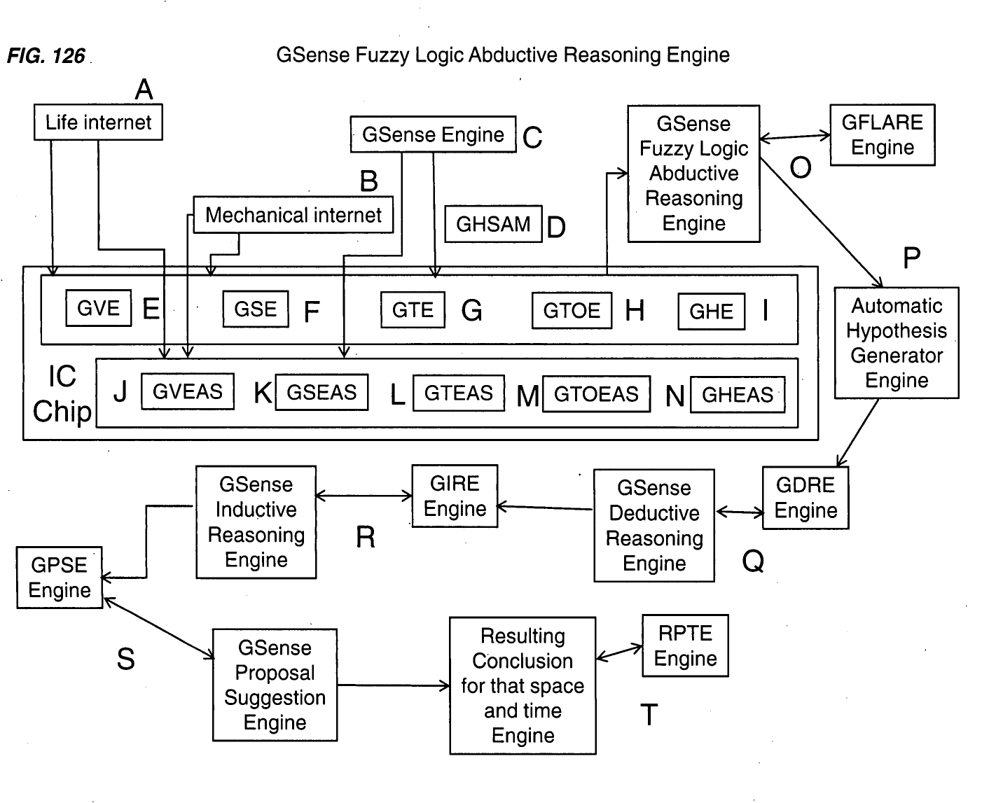

FIG. 126-A describes GSense Fuzzy Logic Abductive Reasoning Engine and shows the life Internet.

FIG. 126-B describes GSense Fuzzy Logic Abductive Reasoning Engine and shows the mechanical Internet.

FIG. 126-C describes GSense Fuzzy Logic Abductive Reasoning Engine and shows the GSense engine.

FIG. 126-D describes GSense Fuzzy Logic Abductive Reasoning Engine and shows the GSense human senses aggregator mechanism hardware unit.

FIG. 126-E describes GSense Fuzzy Logic Abductive Reasoning Engine and shows GSense visual engine.

FIG. 126-F describes GSense Fuzzy Logic Abductive Reasoning Engine and shows GSense smell engine.

FIG. 126-G describes GSense Fuzzy Logic Abductive Reasoning Engine and shows GSense taste engine.

FIG. 126-H describes GSense Fuzzy Logic Abductive Reasoning Engine and shows GSense touch engine.

FIG. 126-I describes GSense Fuzzy Logic Abductive Reasoning Engine and shows GSense hearing engine.

FIG. 126-J describes GSense Fuzzy Logic Abductive Reasoning Engine and shows GSense vision engine aggregator sensor.

FIG. 126-K describes GSense Fuzzy Logic Abductive Reasoning Engine and shows GSense smell engine aggregator sensor.

FIG. 126-L describes GSense Fuzzy Logic Abductive Reasoning Engine and shows GSense taste engine aggregator sensor.

FIG. 126-M describes GSense Fuzzy Logic Abductive Reasoning Engine and shows GSense touch engine aggregator sensor.

FIG. 126-N describes GSense Fuzzy Logic Abductive Reasoning Engine and shows GSense hearing engine aggregator sensor.

FIG. 126-O describes GSense Fuzzy Logic Abductive Reasoning Engine and shows GSense fuzzy logic abductive reasoning engine.

FIG. 126-P describes GSense Fuzzy Logic Abductive Reasoning Engine and shows GSense automatic hypothesis generator engine.

FIG. 126-Q describes GSense Fuzzy Logic Abductive Reasoning Engine and shows GSense deductive reasoning engine.

FIG. 126-R describes GSense Fuzzy Logic Abductive Reasoning Engine and shows GSense inductive reasoning engine.

FIG. 126-S describes GSense Fuzzy Logic Abductive Reasoning Engine and shows GSense proposal suggestion engine.

FIG. 126-T describes GSense Fuzzy Logic Abductive Reasoning Engine and shows GSense resulting conclusion for that place or space and time engine, or resulting placed time engine.

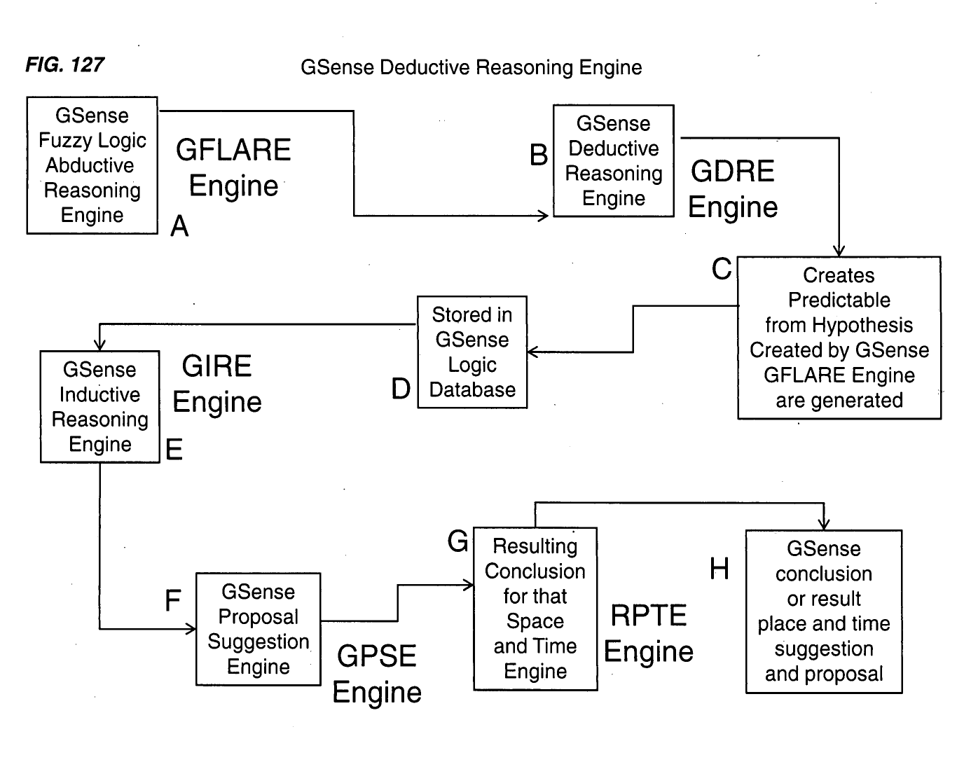

FIG. 127-A describes GSense Deductive Reasoning Engine and shows GSense fuzzy logic deductive reasoning engine.

FIG. 127-B describes GSense Deductive Reasoning Engine and shows GSense deductive reasoning engine.

FIG. 127-C describes GSense Deductive Reasoning Engine and shows how the mechanism creates predictable consequences from hypotheses created by GSense fuzzy logic deductive reasoning engine are created or generated.

FIG. 127-D describes GSense Deductive Reasoning Engine and shows stored in GSense logic database.

FIG. 127-E describes GSense Deductive Reasoning Engine and shows GSense inductive reasoning engine.

FIG. 127-F describes GSense Deductive Reasoning Engine and shows the GSense proposal suggestion engine.

FIG. 127-G describes GSense Deductive Reasoning Engine and shows the GSense resulting conclusion for space place and time engine or result place time engine.

FIG. 127-H describes GSense Deductive Reasoning Engine and shows conclusion or result place and time engine.

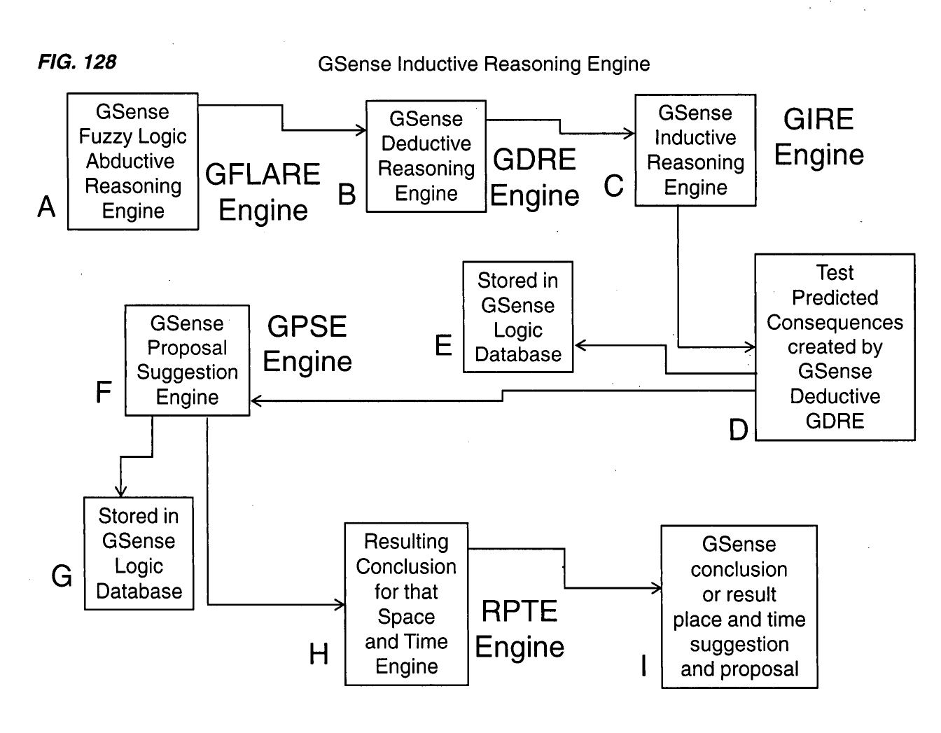

FIG. 128-A describes GSense Inductive Reasoning Engine and shows GSense fuzzy logic abductive reasoning engine.

FIG. 128-B describes GSense Inductive Reasoning Engine and shows GSense deductive reasoning engine.

FIG. 128-C describes GSense Inductive Reasoning Engine and shows GSense inductive reasoning engine.

FIG. 128-D describes GSense Inductive Reasoning Engine and shows the GSense inductive reasoning engine then test predicted consequences created by GSense deductive reasoning engine.

FIG. 128-E describes GSense Inductive Reasoning Engine and shows results store and GSense logic database unit.

FIG. 128-F describes GSense Inductive Reasoning Engine and shows the GSense proposal suggestion engine.

FIG. 128-G describes GSense Inductive Reasoning Engine and shows results stored in GSense logic database unit.

FIG. 128-H describes GSense Inductive Reasoning Engine and shows resulting conclusion for that place or space and time engine.

FIG. 128-I describes GSense Inductive Reasoning Engine and shows GSense conclusion or result place and time suggestion and proposal produced.

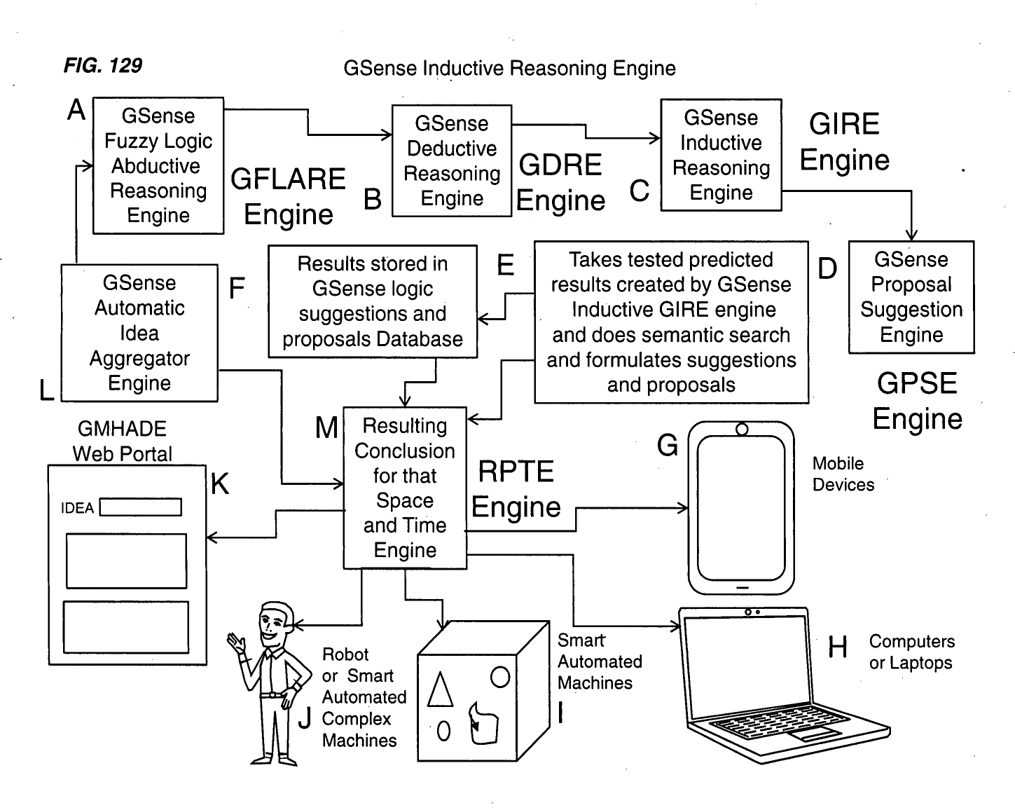

FIG. 129-A describes GSense Proposal Suggestion Engine and shows GSense fuzzy logic deductive reasoning engine.

FIG. 129-B describes GSense Proposal Suggestion Engine and shows GSense deductive reasoning engine.

FIG. 129-C describes GSense Proposal Suggestion Engine and shows GSense inductive reasoning engine.

FIG. 129-D describes GSense Proposal Suggestion Engine and shows GSense proposal suggestion engine.

FIG. 129-E describes GSense Proposal Suggestion Engine and shows that the GSense proposal suggestion engine takes tested predicted results from the GSense inductive reasoning engine and a semantic search and formulates and creates suggestions and proposals.

FIG. 129-F describes GSense Proposal Suggestion Engine and shows results are stored in GSense logic suggestions and proposals database unit.

FIG. 129-G describes GSense Proposal Suggestion Engine and shows suggestions and proposals are then sent to mobile devices.

FIG. 129-H describes GSense Proposal Suggestion Engine and shows suggestions and proposals are then sent to laptop computer.

FIG. 129-I describes GSense Proposal Suggestion Engine and shows suggestions and proposals are then sent to automated smart machines.

FIG. 129-J describes GSense Proposal Suggestion Engine and shows suggestions and proposals are automatically sent to smart automated complex machines and robots.

FIG. 129-K describes GSense Proposal Suggestion Engine and shows suggestions and proposals automatically sent to GSense manual hypothesis aggregator and display engine.

FIG. 129-L describes GSense Proposal Suggestion Engine and shows suggestions and proposals are automatically sent to GSense automatic idea aggregator engine.

FIG. 129-M describes GSense Proposal Suggestion Engine and shows the GSense resulting place time engine.

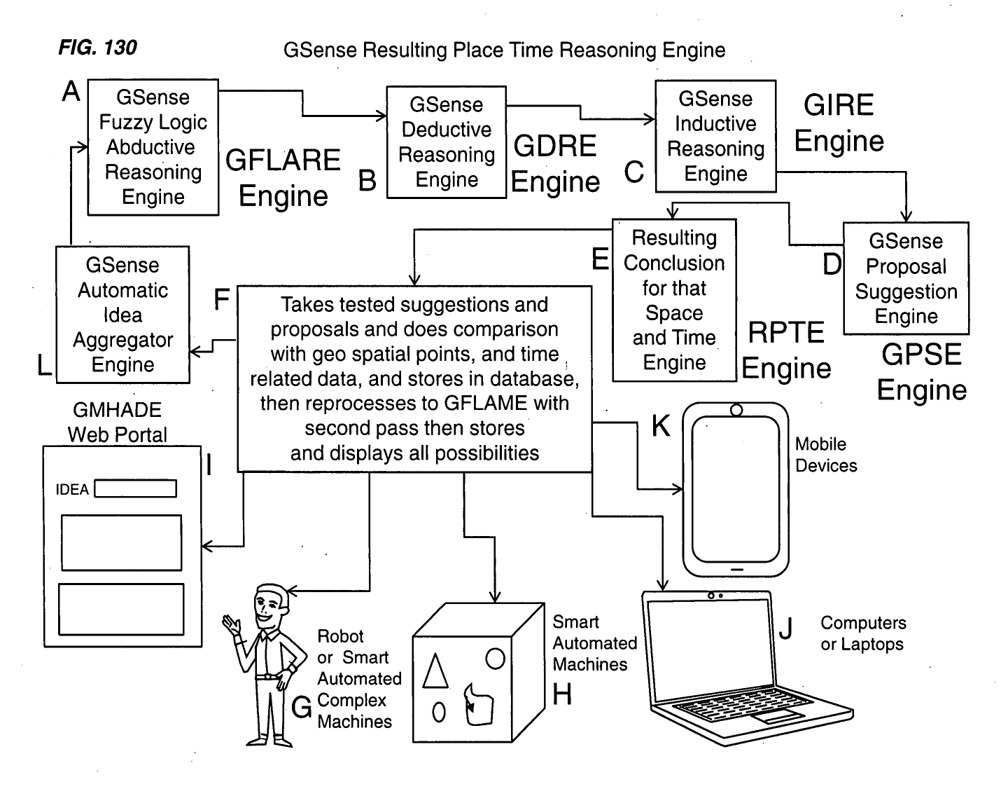

FIG. 130-A describes GSense Resulting Place Time Engine and shows GSense fuzzy logic abductive reasoning engine.

FIG. 130-B describes GSense Resulting Place Time Engine and shows GSense deductive reasoning engine.

FIG. 130-C describes GSense Resulting Place Time Engine and shows GSense inductive reasoning engine.

FIG. 130-D describes GSense Resulting Place Time Engine and shows GSense proposal suggestion engine.

FIG. 130-E describes GSense Resulting Place Time Engine and shows GSense Resulting Place Time engine.

FIG. 130-F describes GSense Resulting Place Time Engine and shows where the GSense Resulting Place Time engine takes suggestions and proposals and does comparison with geographic spatial point, time related, and stores than re-processes to GSense fuzzy logic abductive reasoning engine with second pass then stores and displays all possibilities.

FIG. 130-G describes GSense Resulting Place Time Engine and shows displays to smart automate complex machines and robots.

FIG. 130-H describes GSense Resulting Place Time Engine and shows displays to automated smart machines.

FIG. 130-I describes GSense Resulting Place Time Engine and shows displayed to GSense manual hypothesis aggregator and display engine.

FIG. 130-J describes GSense Resulting Place Time Engine and shows displayed to laptop computer.

FIG. 130-K describes GSense Resulting Place Time Engine and shows displayed to mobile devices.

FIG. 130-L describes GSense Resulting Place Time Engine and shows displayed to GSense automatic idea aggregator engine.

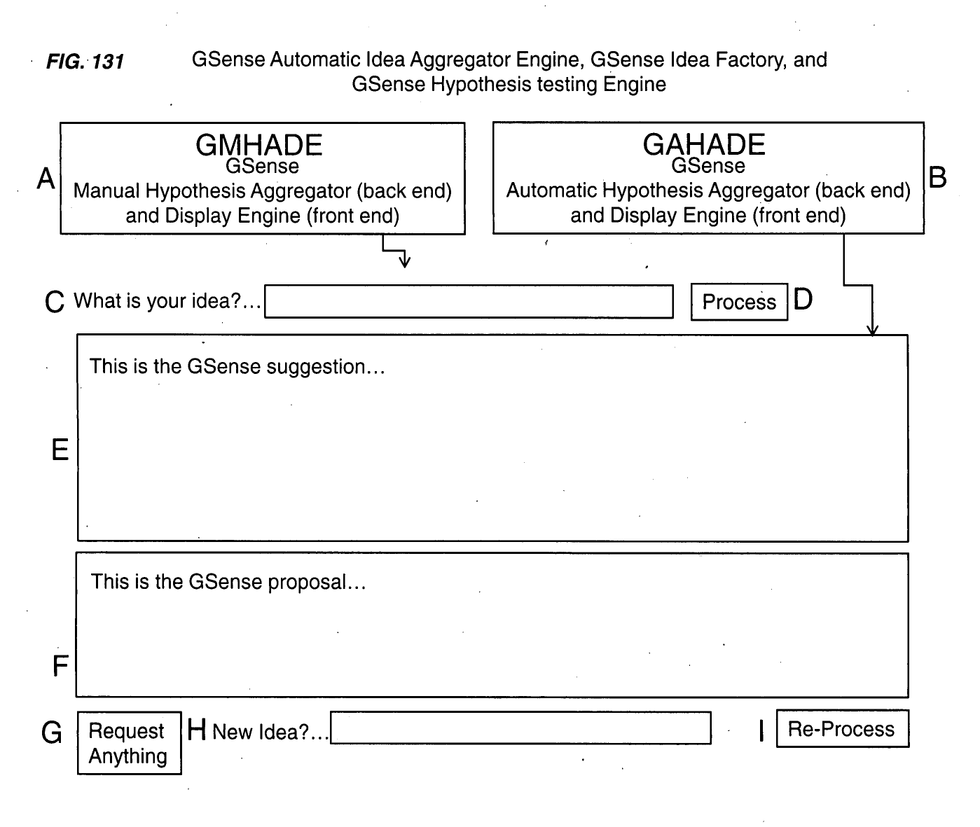

FIG. 131-A describes GSense Manual Hypothesis Aggregator and Display Engine and shows the GSense idea factory form, or GSense Manual idea aggregator engine or GSense Manual hypothesis aggregator and display engine and mechanism.

FIG. 131-B describes GSense Automatic Hypothesis Aggregator and Display Engine and shows the GSense automatic hypothesis aggregator backend and front-end display engine.

FIG. 131-C describes GSense Automatic Hypothesis Aggregator and Display Engine and shows form to search and aggregate “what is your idea?”.

FIG. 131-D describes GSense Automatic Hypothesis Aggregator and Display Engine and shows the process button for processing input data.

FIG. 131-E describes GSense Automatic Hypothesis Aggregator and Display Engine and shows form field with “this is my suggestion”.

FIG. 131-F describes GSense Automatic Hypothesis Aggregator and Display Engine and shows form field with “this is my proposal”.

FIG. 131-G describes GSense Automatic Hypothesis Aggregator and Display Engine and shows Request Anything button to request for proposals, pricing, services.

FIG. 131-H describes GSense Automatic Hypothesis Aggregator and Display Engine and shows where there is a field to be able to try again with a new idea in the field that you want to get different results after processing.

FIG. 131-H describes GSense Automatic Hypothesis Aggregator and Display Engine and shows where there is a field to the left to the left to be able to try again with a new idea and click reprocess button.

FIG. 132-132A describes GSense Mobile Device 3D Converter Viewer Device and shows the GSense 3-D mobile device caddy viewer.

FIG. 132-132B describes GSense Mobile Device 3D Converter Viewer Device and shows the mobile device with special GSense 3-D application software mounted in the GSense 3-D program viewer mechanism for viewing prerecorded videos and 3-D, live scenes recorded in 3-D, virtual augmented reality recording and viewing.

FIG. 133-133A describes GSense Mobile Device Folding 3D Holder and shows mobile device with 3-D cams added showing main display unit.

FIG. 133-133B describes GSense Mobile Device Folding 3D Holder and shows split screen Main display area with 3-D cam video overlay layer mechanism.

FIG. 133-133C describes GSense Mobile Device Folding 3D Holder and shows split 3-D screens.

FIG. 133-133D describes GSense Mobile Device Folding 3D Holder and shows device folding out.

FIG. 133-133E describes GSense Mobile Device Folding 3D Holder and shows GSense 3-D mobile device caddie.

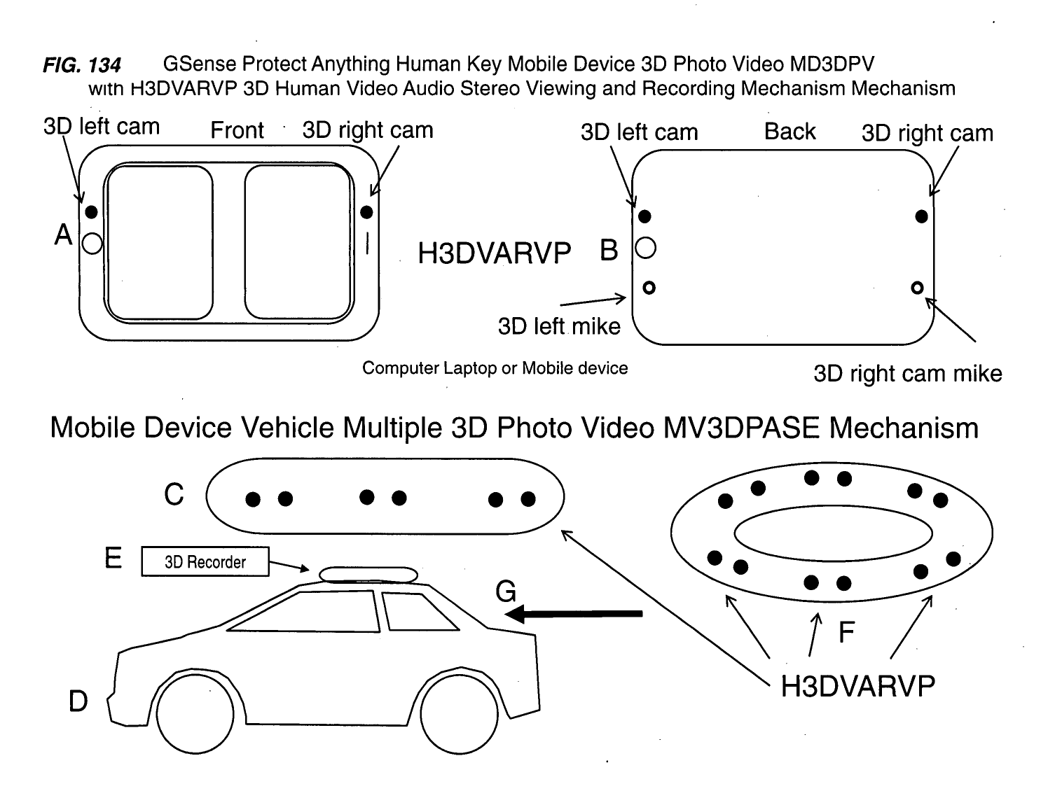

FIG. 134-A describes GSense Mobile Device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and shows from view of GSense 3-D mobile device split screen and split cams for 3D recording of images and Virtual Augmented Reality files with 3D APS left cam and 3D APS right cam on the display side of mobile device, but can be implemented into laptop computer or independent unit.

FIG. 134-134B describes GSense Mobile device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and shows back view with the 2 3-D active pixel sensor cams and 2 3D stereo microphones back view.

FIG. 134-C describes GSense Mobile device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and, shows how GSense 3-D system can work wirelessly from your mobile device into the MD3DPV 3-D viewer and multiple cams for the roof top or fast 3D video aggregation recording.

FIG. 134-D describes GSense Mobile device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and shows the GSense rapid aggregator 3-D mobile vehicle 3-D photo video aggregator Sensor engine mechanism with multiple cams or rapid image processing.

FIG. 134-E describes GSense. Mobile device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and shows rounded design the GSense 3-D camera aggregator system.

FIG. 134-F describes GSense Mobile device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and shows top view of rounded 3-D mobile vehicle rapid aggregation mechanism.

FIG. 134-G describes GSense Mobile device 3D Photo Video MD3DPV viewer and GSense Mobile Vehicle 3D Photo Video Audio Human Senses Aggregator Sensor Engine MV3DPVAHSASE mechanism with H3DVARV 3D Human Video Audio Stereo Viewing and Recording Mechanism and shows car or mobile vehicle 3-D photo engine aggregator Sensor method driving and aggregating anywhere.

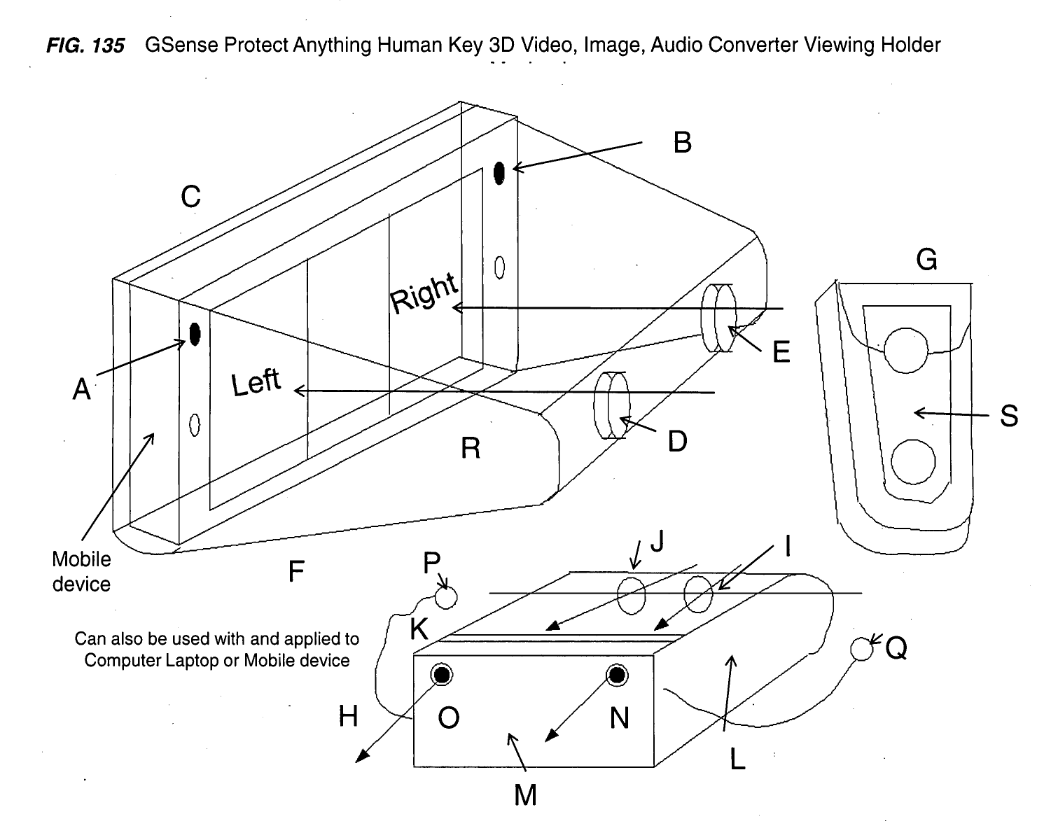

FIG. 135-A describes GSense 3D Viewer Recorder for Video, Image, Media, Audio Application Holder Mechanism and shows side view with APS 3-D left cam.

FIG. 135-B describes GSense 3D Viewer Recorder for Video, Image, Media, Audio Application Holder Mechanism and shows side view with APS 3-D right cam.

FIG. 135-C describes GSense 3D Viewer Recorder for Video, Image, Media, Audio Application Holder Mechanism and shows mobile device with split screen left right screened view inserted into GSense 3-D video, image, and or audio holder viewer mechanism.

FIG. 135-D describes GSense 3D Viewer Recorder for Video, Image, Media, Audio Application Holder Mechanism and shows left viewing lens.

FIG. 135-E describes GSense 3D Viewer Recorder for Video, Image, Media, Audio Application Holder Mechanism and shows right viewing lens.

FIG. 135-F describes GSense 3D Viewer Recorder for Video, Image, Media, Audio Application Holder Mechanism and shows folding side panel.

FIG. 135-G describes GSense 3D Viewer Recorder for Video, Image, Media, Audio Application Holder Mechanism and shows a mobile device being inserted into Holder.

FIG. 135-H describes GSense 3D Viewer Recorder for Video, Image, Media, Audio Application Holder Mechanism and shows GSense 3-D viewer holder foldout for use.

FIG. 135-I describes GSense 3D Viewer Recorder for Video, Image, Media, Audio Application Holder Mechanism and shows left viewing lens.

FIG. 135-J describes GSense 3D Viewer Recorder for Video, Image, Media, Audio Application Holder Mechanism and shows right viewing lens.

FIG. 135-K describes GSense 3D Viewer Recorder for Video, Image, Media, Audio Application Holder Mechanism and shows mobile device holder mechanism insert area.

FIG. 135-L describes GSense 3D Viewer Recorder for Video, Image, Media, Audio Application Holder Mechanism and shows another view of folded out viewer.

FIG. 135-M describes GSense 3D Viewer Recorder for Video, Image, Media, Audio Application Holder Mechanism and shows front of GSense 3-D viewer recorder.

FIG. 135-N describes GSense 3D Viewer Recorder for Video, Image, Media, Audio Application Holder Mechanism and shows left cam front view.

FIG. 135-O describes GSense 3D Viewer Recorder for Video, Image, Media, Audio Application Holder Mechanism and shows right cam front view.

FIG. 135-P describes GSense 3D Viewer Recorder for Video, Image, Media, Audio Application Holder Mechanism and shows right stereo audio earplug.

FIG. 135-Q describes GSense 3D Viewer Recorder for Video, Image, Media, Audio Application Holder Mechanism and shows left stereo audio earplug.

FIG. 135-R describes GSense 3D Viewer Recorder for Video, Image, Media, Audio Application Holder Mechanism and shows left rear folding panel.

FIG. 135-S describes GSense 3D Viewer Recorder for Video, Image, Media, Audio Application Holder Mechanism and shows viewer in case.

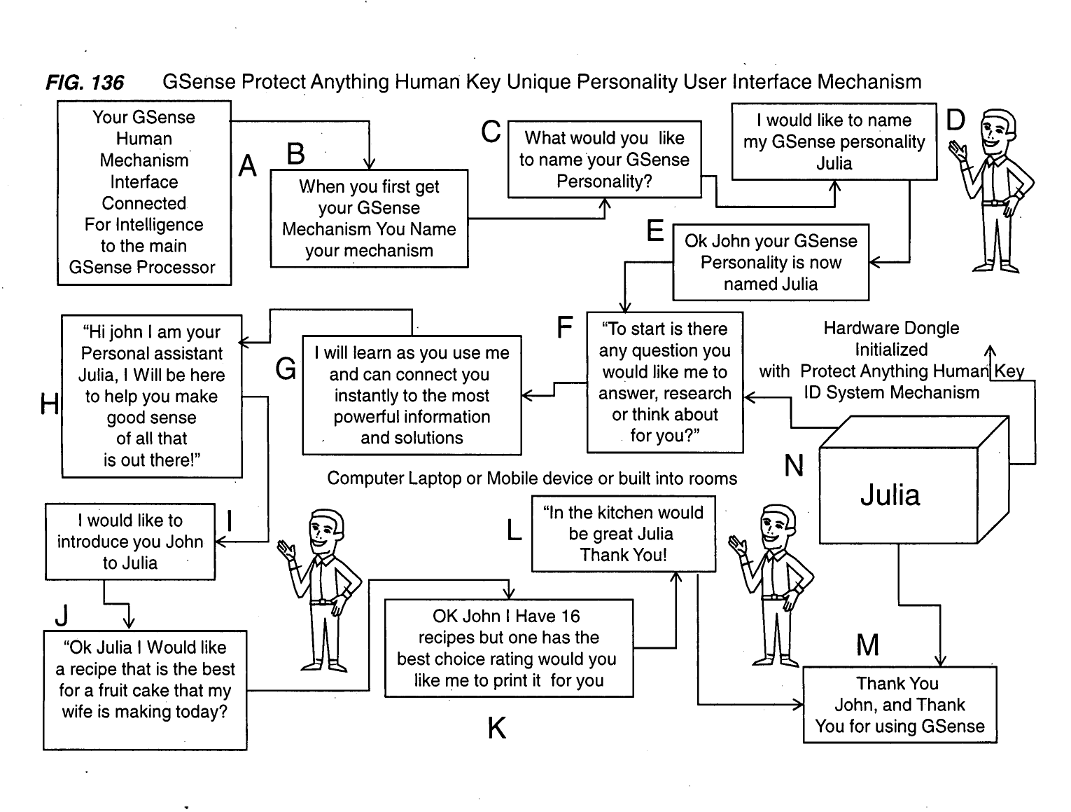

FIG. 136-A describes GSense Unique Personality User Interface Mechanism and shows your GSense human mechanism interface connected for intelligence to the main GSense processor network.

FIG. 136-B describes GSense Unique Personality User Interface Mechanism and shows when you first get your GSense mechanism and register your name for your mechanism.

FIG. 136-C describes GSense Unique Personality User Interface Mechanism and shows that GSense says “what which you like to name your GSense personality?”.

FIG. 136-D describes GSense Unique Personality User Interface Mechanism and shows user says the name like “I would like to name my GSense personality Julia”.

FIG. 136-E describes GSense Unique Personality User Interface Mechanism and shows the GSense mechanism then says “okay John the GSense personality is now named Julia”.

FIG. 136-F describes GSense Unique Personality User Interface Mechanism and shows then the GSense mechanism says “I would like to introduce you John to Julia”.

FIG. 136-G describes GSense Unique Personality User Interface Mechanism and shows then the GSense personality responds with “hi John I′m your personal assistant Julia, I will be here to help you make sense of all that is out there”.

FIG. 136-H describes GSense Unique Personality User Interface Mechanism and shows then the personal assistant GSense personality Julia says “I will learn as you use me and can connect you instantly care the most powerful information and solutions”.

FIG. 136-I describes GSense Unique Personality User Interface Mechanism and shows where the GSense personality Julia says “to start, is any question you would like me to answer, research, think about the?”.

FIG. 136-J describes GSense Unique Personality User Interface Mechanism and shows where the user John then asks “okay Julia are like recipe is the best recipe for a fruitcake that my wife is cooking today?”.

FIG. 136-K describes GSense Unique Personality User Interface Mechanism and shows where the GSense unique personality Julia says “okay John I have 16 recipes but one has the best choice rating would you like me to print it for you at your family printing area? Or display it at your kitchen SP target point station?”.

FIG. 136-L describes GSense Unique Personality User Interface Mechanism and shows the user John says “in the kitchen would be great, thank you Julia”.

FIG. 136-M describes GSense Unique Personality User Interface Mechanism and shows where the personal assistant GSense unique personality Julia replies “thank you John, and thank you for using GSense, allowing the to help you”.

FIG. 136-N describes GSense Unique Personality User Interface Mechanism and shows the hardware device that is the GSense personal assistant personality hardware dongle that has to be initialized with Protect Anything Human Key identification log in system.

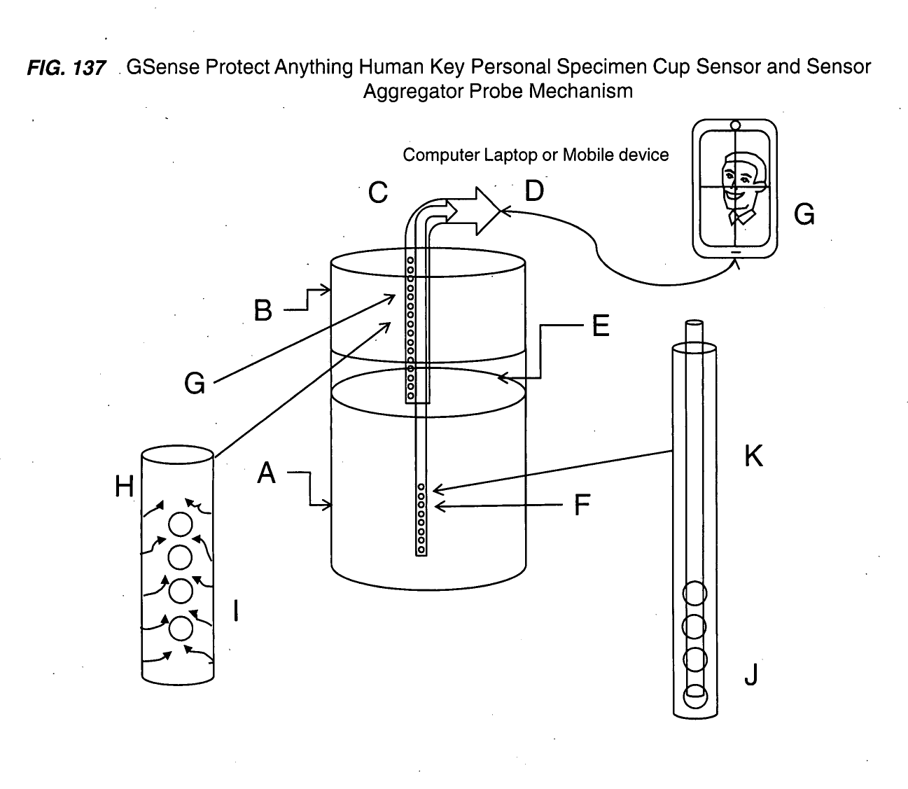

FIG. 137-A describes GSense Liquid Gaseous Cup Sensor and Sensor Aggregator Probe mechanism with Protect Anything Human Key ID system and shows the glass Cup Sensor unit.

FIG. 137-B describes How Data is processed into intelligent data Remind Anything with Protect Anything Human Key Server Cloud and GSense Algorithm and shows the lab probe that gets inserted after a liquid is ready for testing.

FIG. 137-C describes GSense Liquid Gaseous Cup Sensor and Sensor Aggregator Probe mechanism with Protect Anything Human Key ID system and shows the liquid sensor rod and tip for analyzing liquid specimens.

FIG. 137-D describes GSense Liquid Gaseous Cup Sensor and Sensor Aggregator

Probe mechanism with Protect Anything Human Key ID system and shows the air sensor with GSense cilia sensor fibers.

FIG. 137-E describes GSense Liquid Gaseous Cup Sensor and Sensor Aggregator Probe mechanism with Protect Anything Human Key ID system and shows the cup sensor lid and cup.

FIG. 137-F describes GSense Liquid Gaseous Cup Sensor and Sensor Aggregator Probe mechanism with Protect Anything Human Key ID system and shows air suction holes and cilia fibers in a tube for vapor testing electronically.

FIG. 137-G describes GSense Liquid Gaseous Cup Sensor and Sensor Aggregator Probe mechanism with Protect Anything Human Key ID system and shows the 2 aspects of the probe rod with liquid sensor device at the bottom and air vapor sensor at the top.

FIG. 137-H describes GSense Liquid Gaseous Cup Sensor and Sensor Aggregator Probe mechanism with Protect Anything Human Key ID system and shows the air sensor ports of the smell probe.

FIG. 137-I describes GSense Liquid Gaseous Cup Sensor and Sensor Aggregator Probe mechanism with Protect Anything Human Key ID system and shows the GSense cilia molecule sensor fibers of the smell probe.

FIG. 137-J describes GSense Liquid Gaseous Cup Sensor and Sensor Aggregator Probe mechanism with Protect Anything Human Key ID system and shows liquid suction holes and the liquid test probe.

FIG. 137-K describes GSense Liquid Gaseous Cup Sensor and Sensor Aggregator Probe mechanism with Protect Anything Human Key ID system and shows the liquid sensor device at the center of the probe bottom.

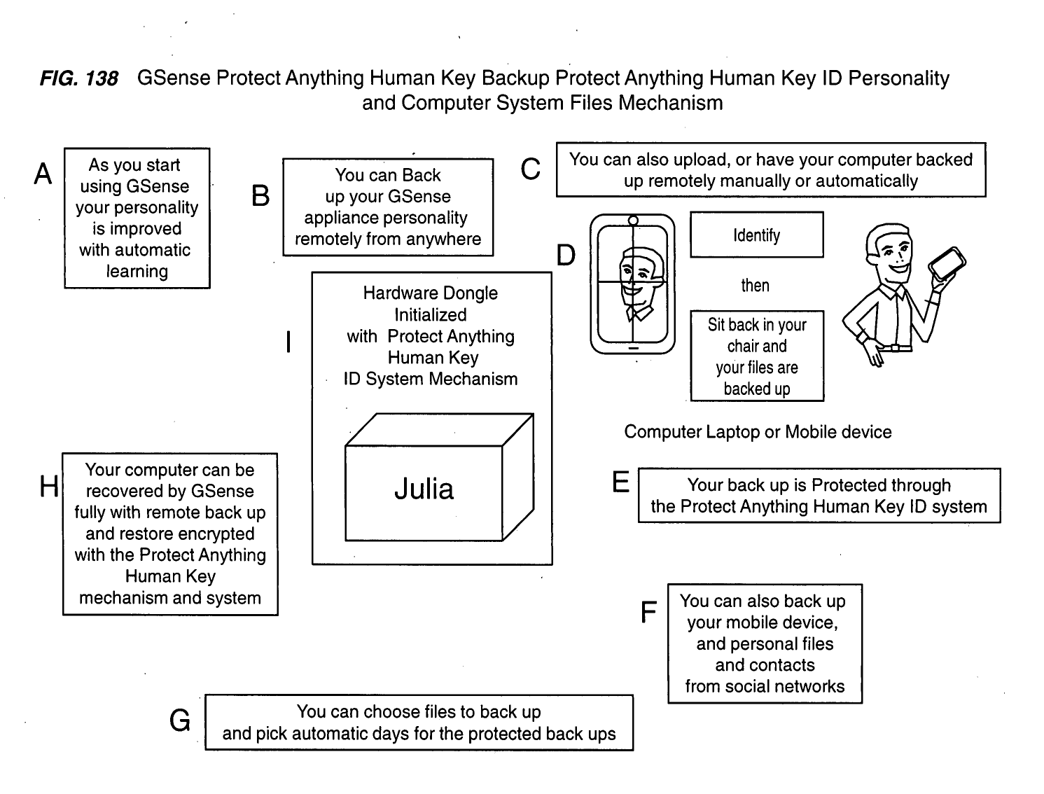

FIG. 138-A describes GSense Personality Back Up and Recovery Mechanism with Protect Anything Human Key ID with Computer System and Files Remote Back Up Mechanism and shows as you start using GSense your GSense personality improves with continuous automatic learnings.

FIG. 138-B describes GSense Personality Back Up and Recovery Mechanism with Protect Anything Human Key ID with Computer System and Files Remote Back Up Mechanism and shows where you can backup your GSense personality whatever name it is.

FIG. 138-C describes GSense Personality Back Up and Recovery Mechanism with Protect Anything Human Key ID with Computer System and Files Remote Back Up Mechanism and shows you can also upload, or have your computer backed up remotely through the GSense mechanism.

FIG. 138-D describes GSense Personality Back Up and Recovery Mechanism with Protect Anything Human Key ID with Computer System and Files Remote Back Up Mechanism and shows your backup is protected through the Protect Anything Human Key identification system and encryption protection.

FIG. 138-E describes GSense Personality Back Up and Recovery Mechanism with Protect Anything Human Key ID with Computer System and Files Remote Back Up Mechanism and shows you can also backup your mobile device context or files remotely at any time to protect your sensitive files with Protect Anything Human Key identification security system.

FIG. 138-F describes GSense Personality Back Up and Recovery Mechanism with Protect Anything Human Key ID with Computer System and Files Remote Back Up Mechanism and shows you can choose files to backup only a few are your whole system and then it can be recovered by only you with your Protect Anything Human Key identification security login.

FIG. 138-G describes GSense Personality Back Up and Recovery Mechanism with Protect Anything Human Key ID with Computer System and Files Remote Back Up Mechanism and shows the computer can be recovered fully remotely at any time with the GSense system backup utility for storage and retrieval of important files by using remote backup and restore encrypted Protect Anything Human Key system.

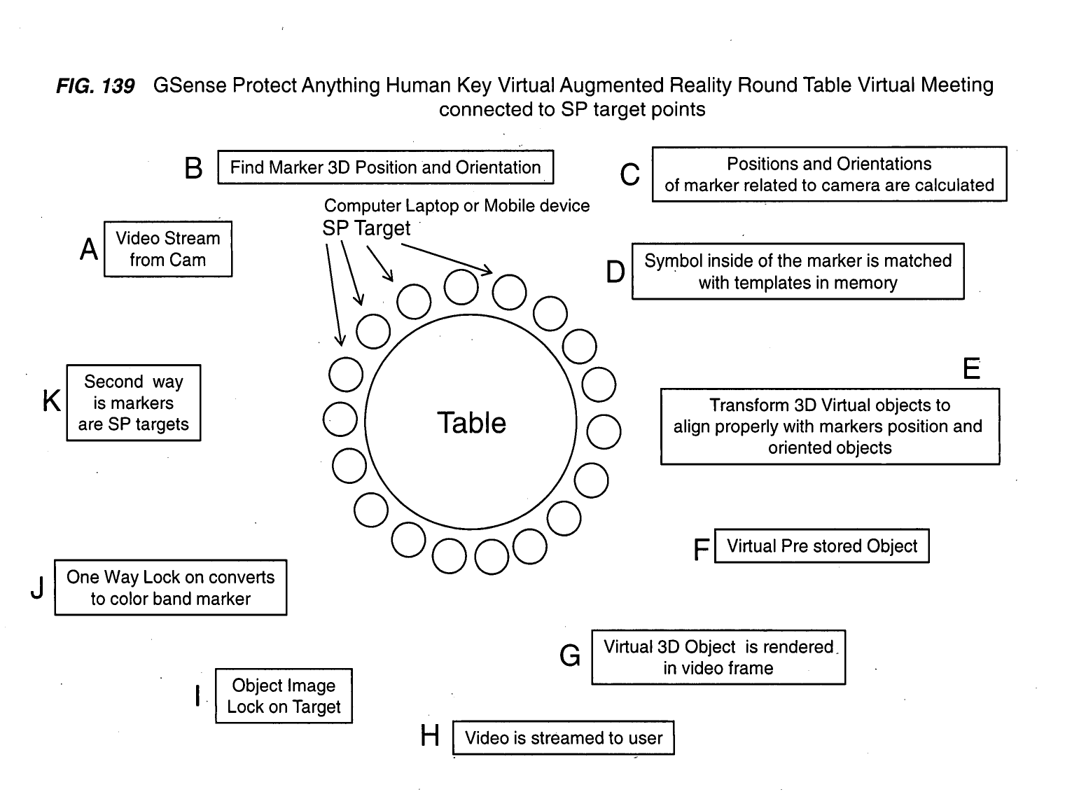

FIG. 139-A describes GSense Virtual Augmented Reality Round Table Virtual Meeting connected to SP target markers where Video is streamed from Cam, this eliminates the need for bar code markers, and each user can see where the person they are talking with is sitting around the Virtual table.

FIG. 139-B describes GSense Virtual Augmented Reality Round Table Virtual Meeting connected to SP target points where the system finds Marker 3D Position and Orientation for the 3D VAR delivery.

FIG. 139-C describes GSense Virtual Augmented Reality Round Table Virtual Meeting connected to SP target points where Positions and Orientations of marker related to camera are calculated by the method and mechanism.

FIG. 139-D describes GSense Virtual Augmented Reality Round Table Virtual Meeting connected to SP target points where invisible symbol inside of the marker is matched with templates in memory in the mechanism database.

FIG. 139-E describes GSense Virtual Augmented Reality Round Table Virtual Meeting connected to SP target points where Transform 3D Virtual objects to align properly with markers position and oriented objects in database.

FIG. 139-F describes GSense Virtual Augmented Reality Round Table Virtual Meeting connected to SP target points where the system has Virtual Pre stored Objects or takes live objects to stream to the SP Target.

FIG. 139-G describes GSense Virtual Augmented Reality Round Table Virtual Meeting connected to SP target points where Virtual 3D Object is rendered in video frame.

FIG. 139-H describes GSense Virtual Augmented Reality Round Table Virtual Meeting connected to SP target points where 3D Video is streamed to user.

FIG. 139-I describes GSense Virtual Augmented Reality Round Table Virtual Meeting connected to SP target points where Object Image is Locked on to Target an additional overlay data is sent.

FIG. 139-J describes GSense Virtual Augmented Reality Round Table Virtual Meeting connected to SP target points where One Way Lock on converts to color band marker for advertisements or information invisible or color band.

FIG. 139-K describes GSense Virtual Augmented Reality Round Table Virtual Meeting connected to SP target points where Second way is markers are SP targets and the content is delivered to the SP targets.

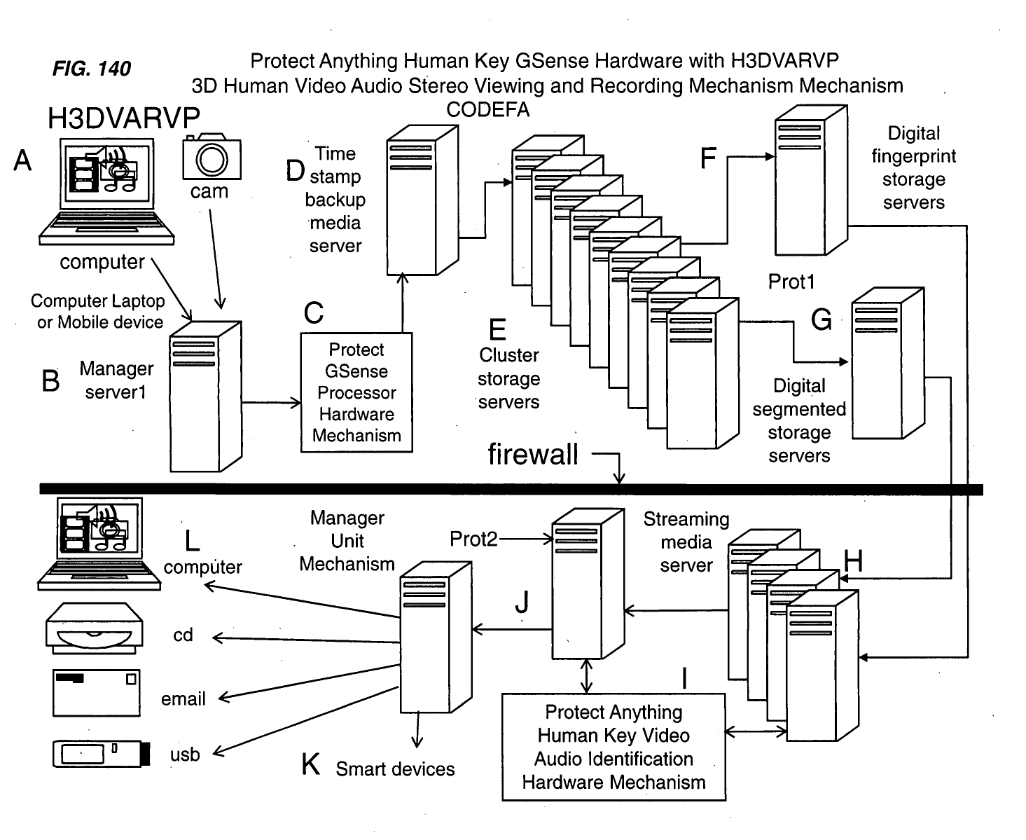

FIG. 140-A describes the Protect Anything Human Key GSense Hardware server Mechanism with H3DVARV 3D Human Video Audio Stereo Viewing and Recording Mechanism where files, audio, video or any digital files can be uploaded and encrypted for security and protection to the Computer Object De-Encryption Encryption File Algorithm (CODEFA) mechanism server.

FIG. 140-B describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server, Manager server1 where initial files are processed into CODEFA.

FIG. 140-C describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server the Protect GSense processor Hardware mechanism that does a pre coding to the files as they enter the system.

FIG. 140-D describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server adds the file to the Time Stamp backup media server to begin the documentation of the time and date that files were introduced into the system, and to create a backup of files for security.

FIG. 140-E describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server the Cluster storage servers where all the files are stored for processing in Prot 1.

FIG. 140-F describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server where Prot 1 then passes to Digital fingerprint storage servers for creation of digital fingerprinting for tracking a security.

FIG. 140-G describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server where Prot1 then passes the file encrypted to the Digital segmented storage servers for storage until a request is made for the file.

FIG. 140-H describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server when a request is passed from the Digital segmented storage servers for movement of a file to the streaming media server through the firewall after authentication of the proper user data.

FIG. 140-I describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server that links into the Protect Anything Human Key Video Audio Identification Hardware Mechanism with Prot2 connected to streaming media server.

FIG. 140-J describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server and Prot2 connects after identification the streaming media server to the manager unit mechanism for delivery to appropriate devices.

FIG. 140-K describes a component of the Protect Anything Human Key GSense Hardware server Mechanism where files, audio, video or any digital files can be uploaded and encrypted for security and protection to the Computer Object De-Encryption Encryption File Algorithm (CODEFA) mechanism server delivery to smart devices that work with the protect anything human Key.

FIG. 140-L describes Protect Anything Human Key GSense Hardware Mechanism where computers, laptops, mobile devices and cam files, audio, video or any digital files can be uploaded and encrypted for security and protection of intellectual property delivery to computer, cd, email, and USB devices that work with the protect anything human Key.

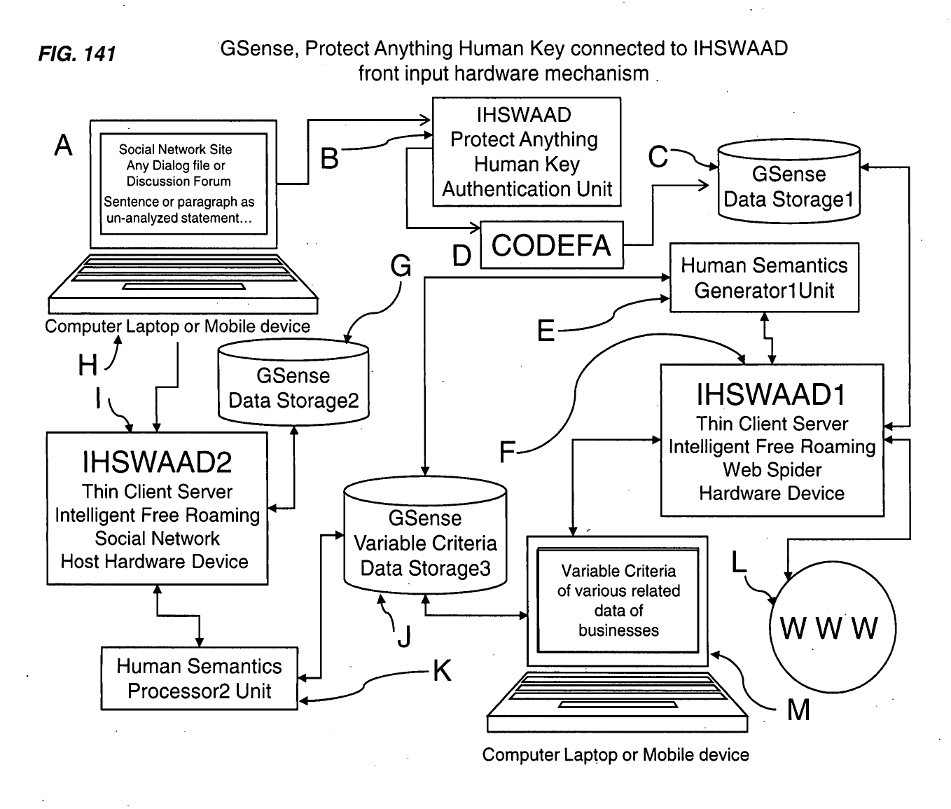

FIG. 141-A describes GSense, Protect Anything Human Key connected to IHSWAAD hardware mechanism front input mechanism where data is input or aggregated from social networking site or any dialog file or discussion forum and a sentence or paragraph is entered as an un-analyzed statement from a computer, laptop, or mobile device for processing.

FIG. 141-B describes GSense, Protect Anything Human Key connected to IHSWAAD hardware mechanism front input mechanism where data is input or aggregated through the IHSWAAD Protect Anything Human Key Authentication Unit and/or raw into the IHSWAAD2 Thin Client Server Intelligent Free Roaming Social Network Host Hardware Device from a computer, laptop, or mobile device for processing.

FIG. 141-C describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing to the CODEFA encryption processing unit to the GSense Data Storage1.

FIG. 141-D describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing through CODEFA Prot 1 security encryption processor.

FIG. 141-E describes GSense, Protect Anything Human Key connected to IHSWAAD hardware mechanism front input mechanism where data is input into the Human Semantics Generator 1 Unit for keyword phrase analysis, intelligent pattern matching and processing.

FIG. 141-F describes GSense, Protect Anything Human Key connected to IHSWAAD hardware mechanism front input mechanism where data is input and/or aggregated from WWW to the IHSWAAD1 Thin Client Server Intelligent Free Roaming Web Spider Hardware Device and a sentence or paragraph is entered as an un-analyzed statement from a computer, laptop, or mobile device for processing by the system.

FIG. 141-G describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Data Storage2.

FIG. 141-H describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing.

FIG. 141-I describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing IHSWAAD2 Thin Client Server Intelligent Free Roaming Social Network Host Hardware Device.

FIG. 141-J describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Variable Criteria Data Storage3.

FIG. 141-K describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Human Semantics Processor2 Unit.

FIG. 141-L describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing from the WWW.

FIG. 141-M describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Variable Criteria of various related data of businesses.

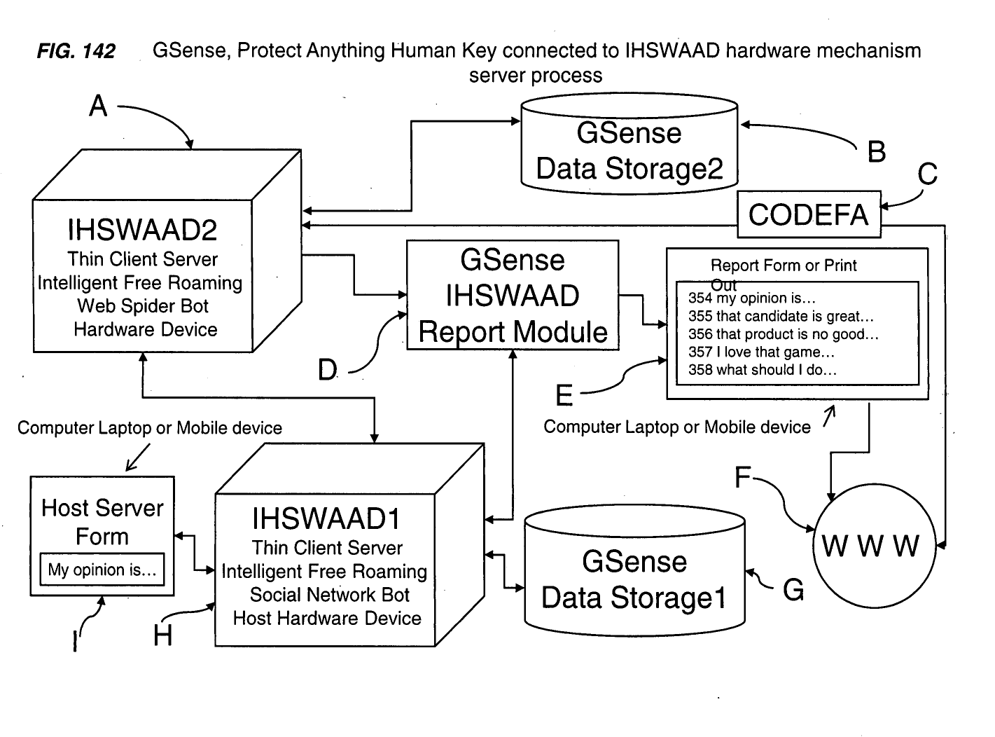

FIG. 142-A describes GSense, Protect Anything Human Key connected to IHSWAAD hardware mechanism server process for processing and shows IHSWAAD2 Thin Client Server Intelligent Free Roaming Web Spider Bot Hardware Device for aggregating on the WWW.

FIG. 142-B describes GSense, Protect Anything Human Key connected to IHSWAAD hardware mechanism server process for processing and shows G Sense data storage 2.

FIG. 142-C describes GSense, Protect Anything Human Key connected to IHSWAAD hardware mechanism server process for processing and shows CODEFA.

FIG. 142-D describes GSense, Protect Anything Human Key connected to IHSWAAD hardware mechanism server process for processing and shows GSense IHSWAAD Report Module.

FIG. 142-E describes GSense, Protect Anything Human Key connected to IHSWAAD hardware mechanism server process for processing and shows Report Form or Print Out 354 my opinion is . . . 355 that candidate is great . . . 356 that product is no good . . . 357 I love that game . . . 358 what should I do . . . from Computer Laptop or Mobile device.

FIG. 142-F describes GSense, Protect Anything Human Key connected to IHSWAAD hardware mechanism server process for processing and shows W W W.

FIG. 142-G describes GSense, Protect Anything Human Key connected to IHSWAAD hardware mechanism server process for processing and shows GSense Data Storage1.

FIG. 142-H describes GSense, Protect Anything Human Key connected to IHSWAAD hardware mechanism server process for processing and shows IHSWAAD1 Thin Client Server Intelligent Free Roaming Social Network Bot Host Hardware Device.

FIG. 142-I describes GSense, Protect Anything Human Key connected to IHSWAAD hardware mechanism server process for processing and shows Host ServerForm My opinion is . . . from Computer Laptop or Mobile device.

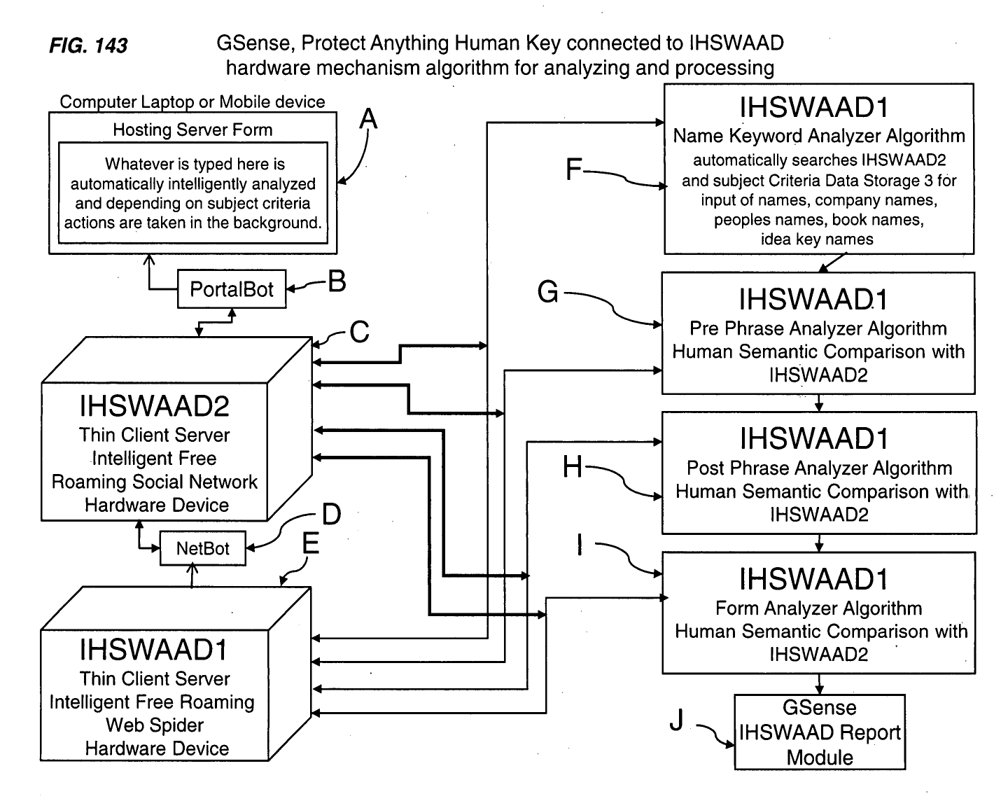

FIG. 143-A describes GSense, Protect Anything Human Key connected to IHSWAAD hardware mechanism algorithm for analyzing and processing related information and shows Hosting Server Form input from Computer Laptop or Mobile device Whatever is typed here is automatically intelligently analyzed and depending on subject criteria actions are taken in the background.

FIG. 143-B describes GSense, Protect Anything Human Key connected to IHSWAAD hardware mechanism algorithm for analy and processing related information and shows PortalBot.

FIG. 143-C describes GSense, Protect Anything Human Key connected to IHSWAAD hardware mechanism algorithm for analyzing and processing related information and shows IHSWAAD2 Thin Client Server Intelligent Free Roaming Social Network Hardware Device.

FIG. 143-D describes GSense, Protect Anything Human Key connected to IHSWAAD hardware mechanism algorithm for analyzing and processing related information and shows NetBot.

FIG. 143-E describes GSense, Protect Anything Human Key connected to IHSWAAD hardware mechanism algorithm for analyzing and processing related information and shows IHSWAAD1 Thin Client Server Intelligent Free Roaming Web Spider Hardware Device.

FIG. 143-F describes GSense, Protect Anything Human Key connected to IHSWAAD hardware mechanism algorithm for analyzing and processing related information and shows IHSWAAD1 Name Keyword Analyzer Algorithm automatically searches IHSWAAD2 and subject Criteria Data Storage 3 for input of names, company names, peoples names, book names, idea key names.

FIG. 143-G describes GSense, Protect Anything Human Key connected to IHSWAAD hardware mechanism algorithm for analyzing and processing related information and shows IHSWAAD1 Pre Phrase Analyzer Algorithm Human Semantic Comparison with IHSWAAD2.

FIG. 143-H describes GSense, Protect Anything Human Key connected to IHSWAAD hardware mechanism algorithm for analyzing and processing related information and shows IHSWAAD1 Post Phrase Analyzer Algorithm Human Semantic Comparison with IHSWAAD2.

FIG. 143-I describes GSense, Protect Anything Human Key connected to IHSWAAD hardware mechanism algorithm for analyzing and processing related information and shows IHSWAAD1 Form Analyzer Algorithm Human Semantic Comparison with IHSWAAD2.

FIG. 143-J describes GSense, Protect Anything Human Key connected to IHSWAAD hardware mechanism algorithm for analyzing and processing related information and shows GSense IHSWAAD Report Module.

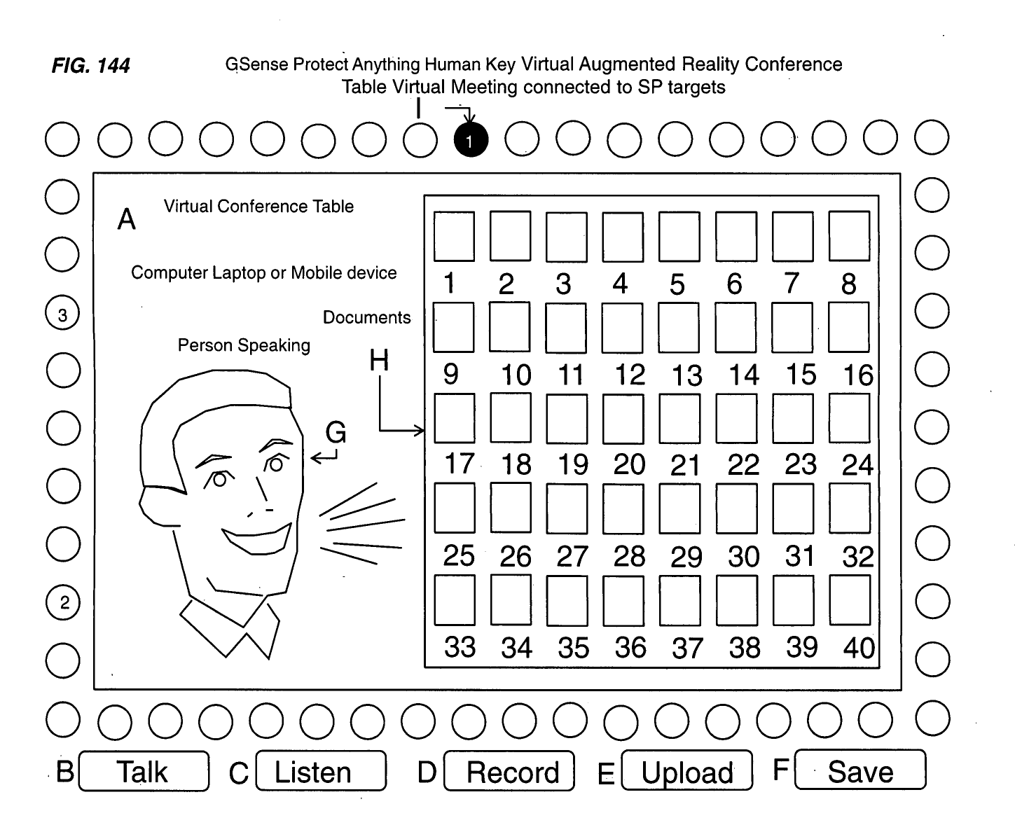

FIG. 144-A describes GSense Virtual Augmented Reality Conference Table Virtual Meeting connected to SP targets and shows where the virtual conference table where multiple people can be at their laptops or computers anywhere, and they all see the conference table on their display screen, and as each person gets to the number one cue their live video image comes up in the person speaking area.

FIG. 144-B describes GSense Virtual Augmented Reality Conference Table Virtual Meeting connected to SP targets and shows where when you press the talk button whatever number in chronological order comes up at your seat at the virtual conference table, you then can choose three colors for the moderator to consider, red for urgent, yellow for modestly urgent, and blue for it can wait for the cue process, then the color goes into you seat position marker for consideration, then as each speaker finishes speaking your number moves up until it gets to 1 and changes to green then your video live image pops up as person speaking, unless the moderator decides by your color to move you ahead of others.

FIG. 144-C describes GSense Virtual Augmented Reality Conference Table Virtual Meeting connected to SP targets and shows where when you select listen your speaking time ends and you simply listen.

FIG. 144-D describes GSense Virtual Augmented Reality Conference Table Virtual Meeting connected to SP targets and shows where when you choose record the whole session what you see on your display is recorded, unless it's a private Conversation, which in that case only the private conversation you are a part of is recorded, also when you record a private conversation, the parties involved in that conversation get a red flag reminder that the conversation is being recorded.

FIG. 144-E describes GSense Virtual Augmented Reality Conference Table Virtual Meeting connected to SP targets and shows where when you choose upload any files, images, video, text, virtual augmented reality 3D views of products, or anything can be uploaded, protected, saved, encrypted, shared, licensed, and collaborated by your choosing and you get a protect anything human key shield attached to every file or document uploaded, and anything uploaded can be private viewing or public viewing through the GSense mechanism.

FIG. 144-F describes GSense Virtual Augmented Reality Conference Table Virtual Meeting connected to SP targets and shows where you can save a session, file, or document at anytime to your system where the person speaking as they speak in live streaming video, the moderator or administrator can have multiple people speaking by simply selecting multiple seat markers at one time and all the things administrator does can be streamed to multiple users in the virtual conference.

FIG. 144-G describes GSense Virtual Augmented Reality Conference Table Virtual Meeting connected to SP targets and shows the video of a person who is speaking.

FIG. 144-H describes GSense Virtual Augmented Reality Conference Table Virtual Meeting connected to SP targets and shows where the right portion of the virtual conference table is for all the documents of the session, as each document is talked about or utilized it expands into the window for analysis, and zoom capabilities are available for granular observation and demonstration.

FIG. 144-I describes GSense Virtual Augmented Reality Conference Table Virtual Meeting connected to SP targets and shows where the speaker number one is a green number meaning that person is allowed to speak and their live video is in the left portion of the virtual conference table.

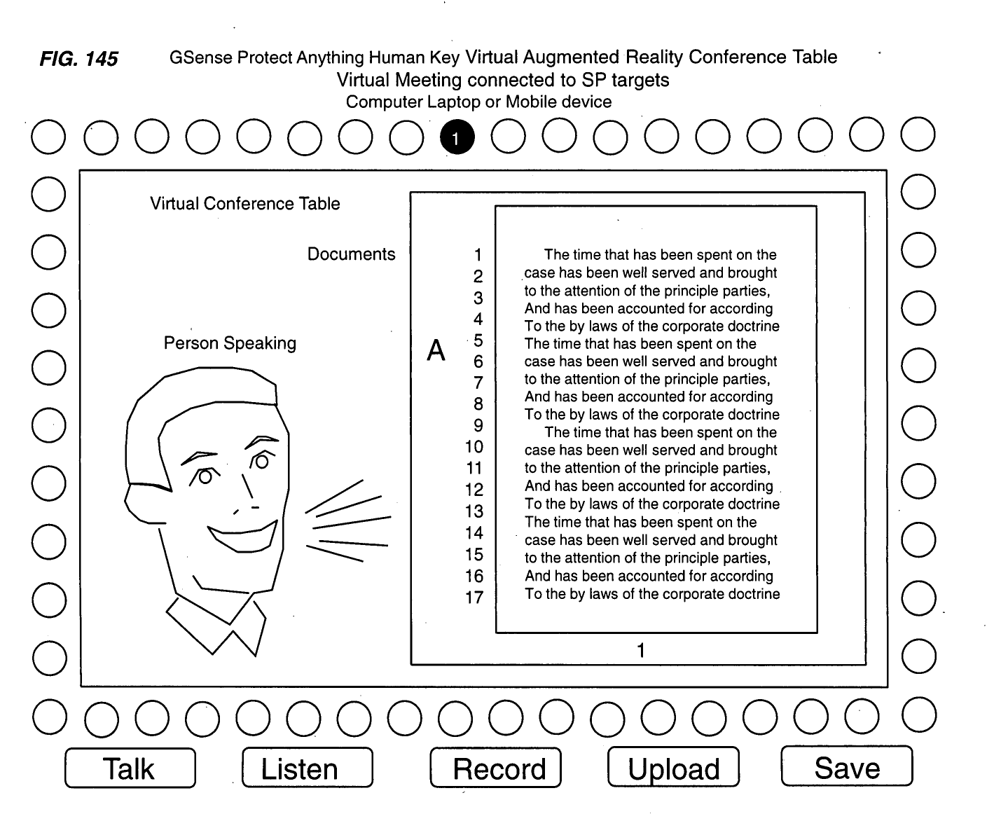

FIG. 145-A describes GSense Virtual Augmented Reality Conference Table Virtual Meeting connected to SP targets and shows where the selected document in the right document window of the virtual conference table is expanded for viewing and line numbers are added for reference in discussions to the whole conference table.

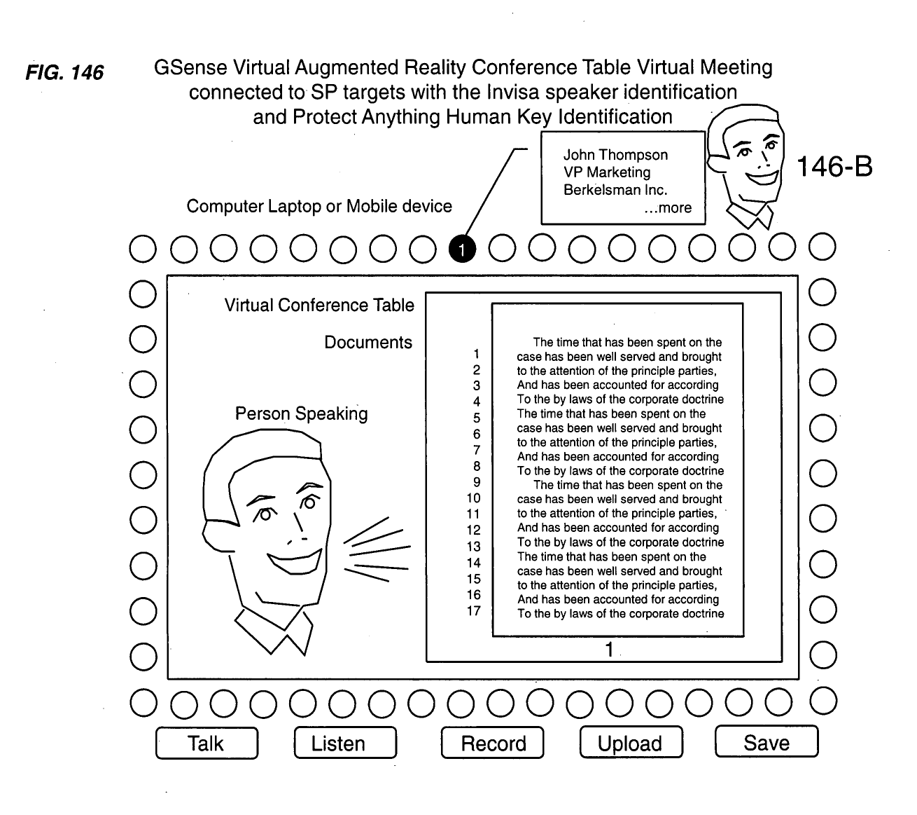

FIG. 146-B describes GSense Virtual Augmented Reality Conference Table Virtual Meeting connected to SP targets with the Invisa speaker identification and Protect Anything Human Key Identification and shows where a demonstration of how each marker at the virtual conference table has a call out with brief information and an image of that person or object when you hover over it the information in the call out can be expanded to have the history, resume, any ratings, awards, biography or expertise related specifically from GSense Method and mechanism for targeted related information to the virtual conference, also the person speaking video is identical to the call out image, and the callout image can be the streaming video of the person even though they are not speaking, so the moderator can at any minute see what each marker seat person is doing, also when a callout is initialized, by hovering over it, or selected by moderator or administrator it can be recorded, also administrator can select all the marker seats to be recorded during the conference for later facial and expression analysis with GSense mechanism, a live virtual lie detector method evaluation for identifying surface facial behavioral reactions to stimuli.

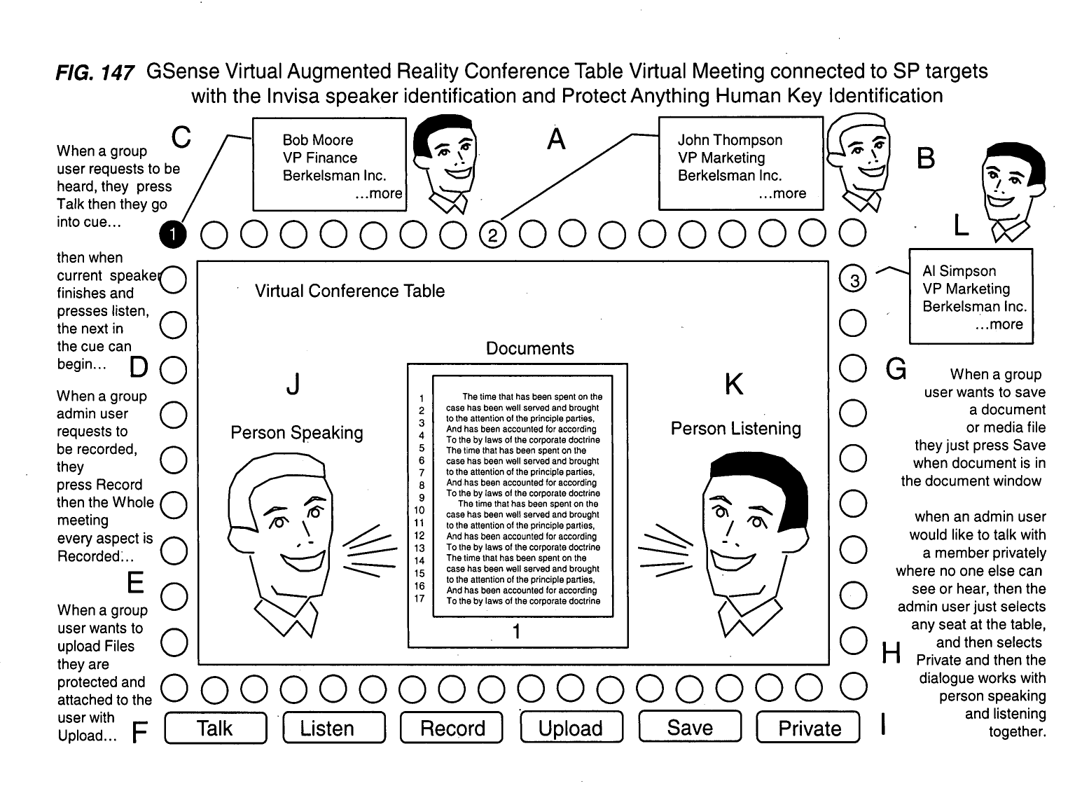

FIG. 147-C describes GSense Virtual Augmented Reality Conference Table Virtual Meeting connected to SP targets with the Invisa speaker identification and Protect Anything Human Key Identification and shows where when a group user requests to be heard, they press Talk then they go into cue.

FIG. 147-D describes GSense Virtual Augmented Reality Conference Table Virtual Meeting connected to SP targets with the Invisa speaker identification and Protect Anything Human Key Identification and shows where then when current speaker finishes and presses listen, the next in the cue can begin.

FIG. 147-E describes GSense Virtual Augmented Reality Conference Table Virtual Meeting connected to SP targets with the Invisa speaker identification and Protect Anything Human Key Identification and shows where when a group admin user requests to be recorded, they press Record then the Whole meeting every aspect is recorded . . . .

FIG. 147-F describes GSense Virtual Augmented Reality Conference Table Virtual Meeting connected to SP targets with the Invisa speaker identification and Protect Anything Human Key Identification and shows where when a group user wants to upload Files they are protected and attached to the user with Upload . . . .

FIG. 147-G describes GSense Virtual Augmented Reality Conference Table Virtual Meeting connected to SP targets with the Invisa speaker identification and Protect Anything Human Key Identification and shows where when a group user wants to save a document or media file they just press Save when document is in the document window.

FIG. 147-H describes GSense Virtual Augmented Reality Conference Table Virtual Meeting connected to SP targets with the Invisa speaker identification and Protect Anything Human Key Identification and shows where when an admin user would like to talk with a member privately where no one else can see or hear, then admin user just selects any table marker seat at the table, and then selects Private and then the dialogue works with person speaking and listening together.

FIG. 147-I describes GSense Virtual Augmented Reality Conference Table Virtual Meeting connected to SP targets with the Invisa speaker identification and Protect Anything Human Key Identification and shows where the Private for requesting private conversations that can be recorded, saved or not where they cannot be viewed or heard by all the other marker seats at the virtual table.

FIG. 147-J describes GSense Virtual Augmented Reality Conference Table Virtual Meeting connected to SP targets with the Invisa speaker identification and Protect Anything Human Key Identification and shows where the Person Speaking with document area to the right, in a 2 way conversation mode both parties can speak over themselves or both parties markers are green.

FIG. 147-K describes GSense Virtual Augmented Reality Conference Table Virtual Meeting connected to SP targets with the Invisa speaker identification and Protect Anything Human Key Identification and shows where the Person Listening with document area to the left or document area can be eliminated in a 2 way viewing system can also have multiple viewing on the virtual conference table, and also all viewing with actual live streaming video on the outside marker call out areas.

FIG. 147-L describes GSense Virtual Augmented Reality Conference Table Virtual Meeting connected to SP targets with the Invisa speaker identification and Protect Anything Human Key Identification and shows the user Al Simpson who is the second dialogue user listening and how the video matches the hover marker video or image.

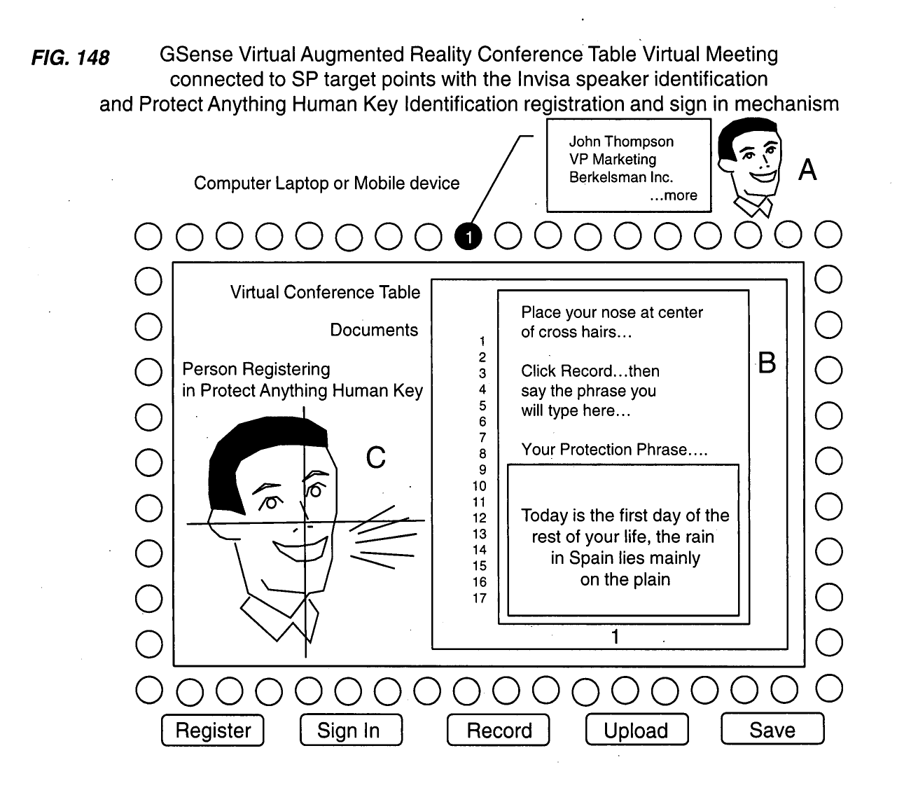

FIG. 148-A describes GSense Virtual Augmented Reality Conference Table Virtual Meeting connected to SP target points with the Invisa speaker identification and Protect Anything Human Key Identification registration and sign in mechanism and shows where the john thompson is sitting in seat 1 and his color marker is green.

FIG. 148-B describes GSense Virtual Augmented Reality Conference Table Virtual Meeting connected to SP target points with the Invisa speaker identification and Protect Anything Human Key Identification registration and sign in mechanism and shows where you register or sign in with Protect Anything Human Key mechanism by placing your nose at center of cross hairs . . . Click Record . . . then say the phrase you will type here . . . you type a phrase you choose which is Your Protection Phrase . . . then Protect Anything Human Key method and mechanism identifies that it is a human speaking and that it is who you are . . . or registers you then with amount of information you supply you get a Protect Anything shield color that shows your certification.

FIG. 148-C describes GSense Virtual Augmented Reality Conference Table Virtual Meeting connected to SP target points with the Invisa speaker identification and Protect Anything Human Key Identification registration and sign in mechanism and shows where the Person Registering in Protect Anything Human Key shows up on the virtual conference table.

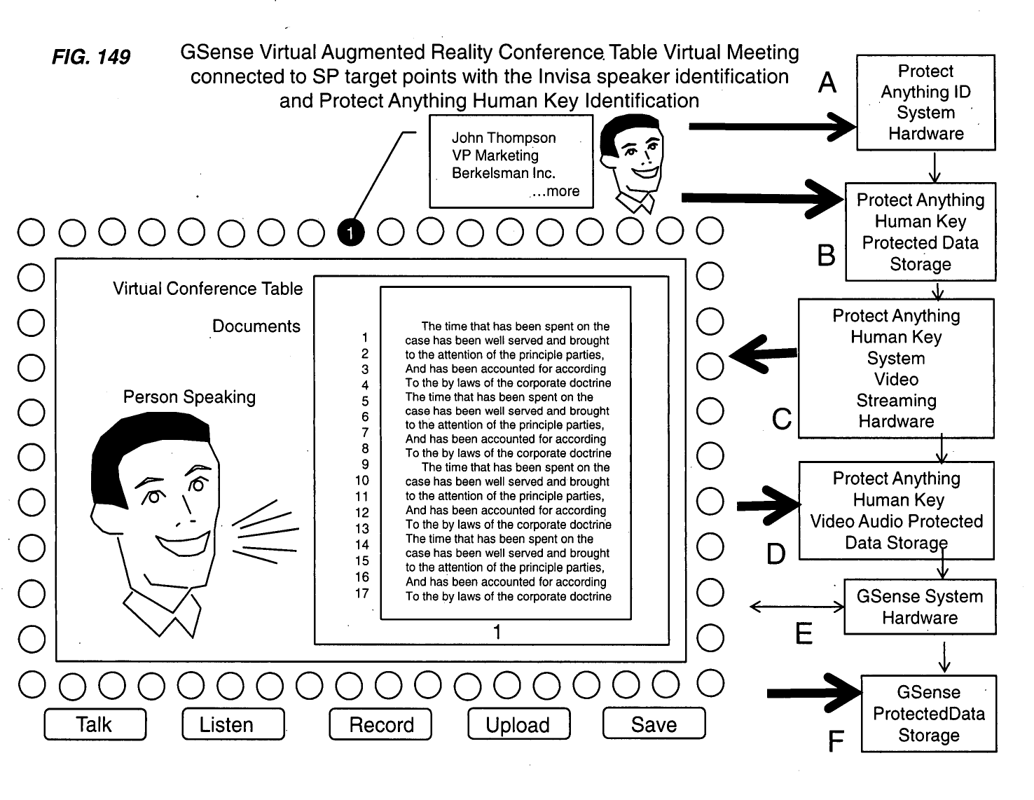

FIG. 149-A describes GSense Virtual Augmented Reality Conference Table Virtual Meeting connected to SP target points with the Invisa speaker identification and Protect Anything Human Key Identification and shows where the Protect Anything ID System Hardware is used with all data for protection.

FIG. 149-B describes GSense Virtual Augmented Reality Conference Table Virtual Meeting connected to SP target points with the Invisa speaker identification and Protect Anything Human Key Identification and shows where the Protect Anything Human Key Protected Data Storage is used with all data for protection.

FIG. 149-C describes GSense Virtual Augmented Reality Conference Table Virtual Meeting connected to SP target points with the Invisa speaker identification and Protect Anything Human Key Identification and shows where the Protect Anything Human Key System Video Streaming Hardware is used with all data for protection.

FIG. 149-D describes GSense Virtual Augmented Reality Conference Table Virtual Meeting connected to SP target points with the Invisa speaker identification and Protect Anything Human Key Identification and shows where the Protect Anything Human Key Video Audio Protected Data Storage is used with all data for protection.

FIG. 149-E describes GSense Virtual Augmented Reality Conference Table Virtual Meeting connected to SP target points with the Invisa speaker identification and Protect Anything Human Key Identification and shows where the GSense System Hardware is used with all data and informational processing

FIG. 149-F describes GSense Virtual Augmented Reality Conference Table Virtual Meeting connected to SP target points with the Invisa speaker identification and Protect Anything Human Key Identification and shows where the GSense Protected Data Storage is used with all data and informational processing.

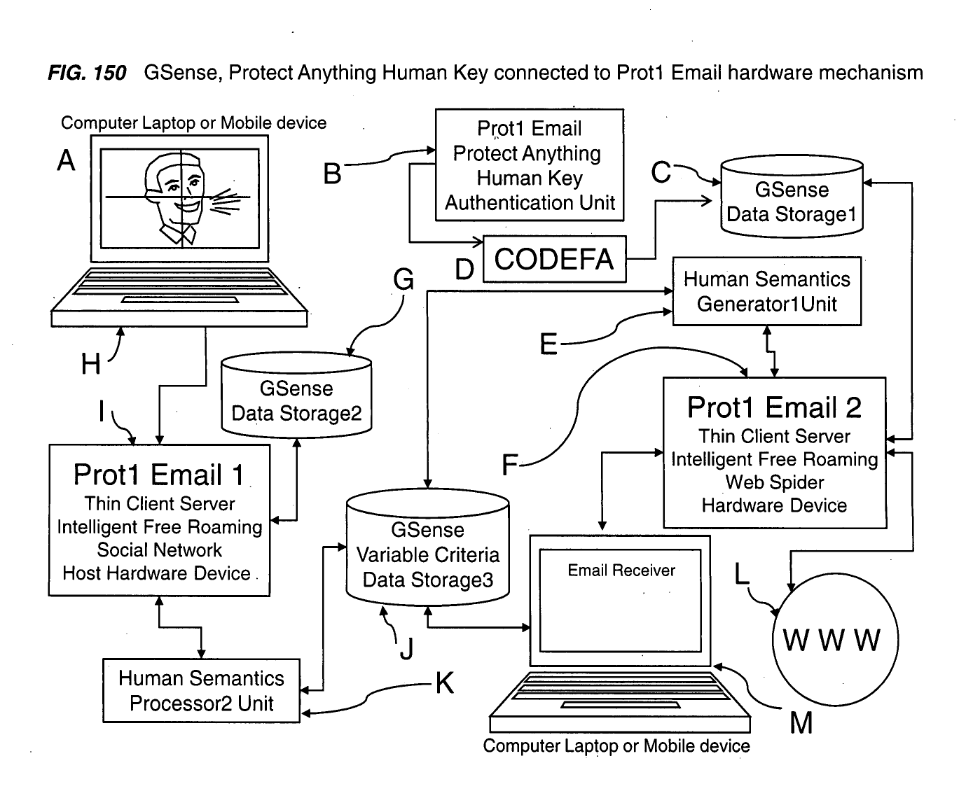

FIG. 150-A describes GSense, Protect Anything Human Key connected to Prot1 Email hardware mechanism and shows the Computer Laptop or Mobile device.

FIG. 150-B describes GSense, Protect Anything Human Key connected to Prot1 Email hardware mechanism and shows the Prot1 Email Protect Anything Human Key Authentication Unit.

FIG. 150-C describes GSense, Protect Anything Human Key connected to Prot1 Email hardware mechanism and shows the GSense Data Storage1.

FIG. 150-D describes GSense, Protect Anything Human Key connected to Prot1 Email hardware mechanism and where the Protect Anything CODEFA mechanism provides storage, security; human key and tracking features are used.

FIG. 150-E describes GSense, Protect Anything Human Key connected to Prot1 Email hardware mechanism and shows the Human Semantics Generator) Unit.

FIG. 150-F describes GSense, Protect Anything Human Key connected to Prot1 Email hardware mechanism and shows the Prot1 Email 2 Thin Client Server Intelligent Free Roaming Web Spider Hardware Device.

FIG. 150-G describes GSense, Protect Anything Human Key connected to Prot1 Email hardware mechanism and shows the GSense Data Storage2.

FIG. 150-H describes GSense, Protect Anything Human Key connected to Prot1 Email hardware mechanism and shows the Computer Laptop or Mobile device.

FIG. 150-I describes GSense, Protect Anything Human Key connected to Prot1 Email hardware mechanism and shows the Prot1 Email 1 Thin Client Server Intelligent Free Roaming Social Network Host Hardware Device.

FIG. 150-J describes GSense, Protect Anything Human Key connected to Prot1 Email hardware mechanism and shows the GSense Variable Criteria Data Storage3.

FIG. 150-K describes GSense, Protect Anything Human Key connected to Prot1 Email hardware mechanism and shows the Human Semantics Processor2 Unit.

FIG. 150-L describes GSense, Protect Anything Human Key connected to Prot1 Email hardware mechanism and shows where the W W W or World Wide Web is used for data aggregation and comparison analysis methods

FIG. 150-M describes GSense, Protect Anything Human Key connected to Prot1 Email hardware mechanism and shows where the Email Receiver Computer Laptop or Mobile device.

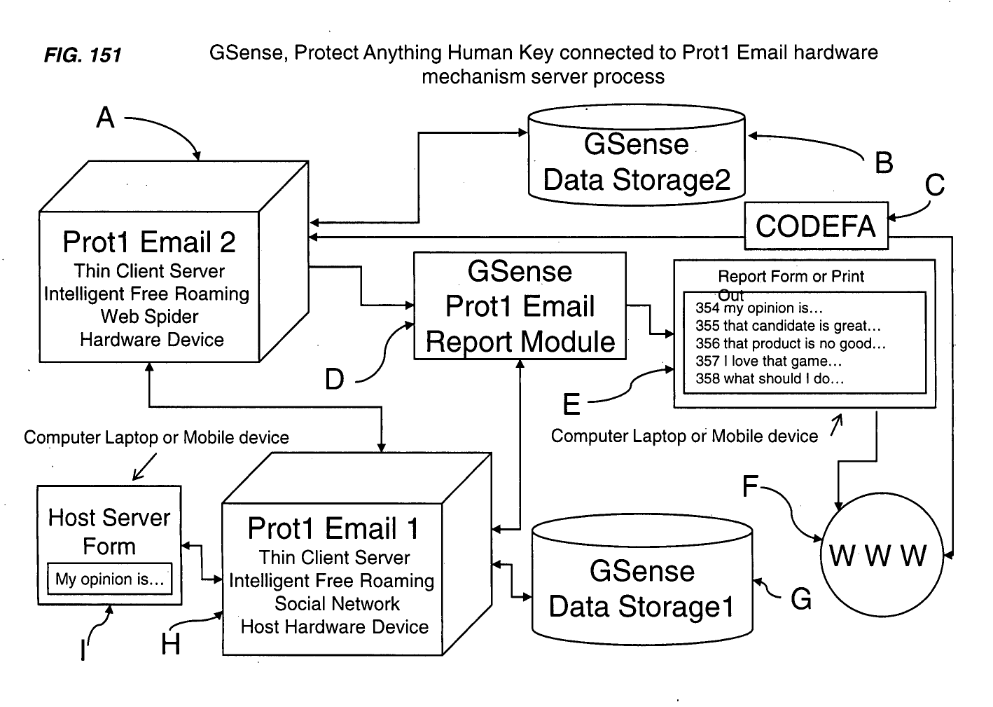

FIG. 151-A describes GSense, Protect Anything Human Key connected to Prot1 Email hardware mechanism server process and shows the Prot1 Email 2 Thin Client Server Intelligent Free Roaming Web Spider Hardware Device.

FIG. 151-B describes GSense, Protect Anything Human Key connected to Prot1 Email hardware mechanism server process and shows the GSense Data Storage2.

FIG. 151-C describes GSense, Protect Anything Human Key connected to Prot1 Email hardware mechanism server process and shows the Protect Anything CODEFA mechanism that provides storage, security, human key and tracking features.

FIG. 151-D describes GSense, Protect Anything Human Key connected to Prot1 Email hardware mechanism server process and shows the GSense Prot1 Email Report Module.

FIG. 151-E describes GSense, Protect Anything Human Key connected to Prot1 Email hardware mechanism server process and shows where the Report Form or Print Out examples of 354 my opinion is . . . 355 that candidate is great . . . 356 that product is no good . . . 357 I love that game . . . 358 what should I do . . . on a Computer Laptop or Mobile device.

FIG. 151-F describes GSense, Protect Anything Human Key connected to Prot1 Email hardware mechanism server process and shows where the W W W or World Wide Web is used for data aggregation and comparison analysis methods.

FIG. 151-G describes GSense, Protect Anything Human Key connected to Prot1 Email hardware mechanism server process and shows the GSense Data Storage1.

FIG. 151-H describes GSense, Protect Anything Human Key connected to Prot1 Email hardware mechanism server process and shows the Prot1 Email 1 Thin Client Server Intelligent Free Roaming Social Network Host Hardware Device.

FIG. 151-I describes GSense, Protect Anything Human Key connected to Prot1 Email hardware mechanism server process and shows the Host Server Form in example; My opinion is . . . on a Computer Laptop or Mobile device.

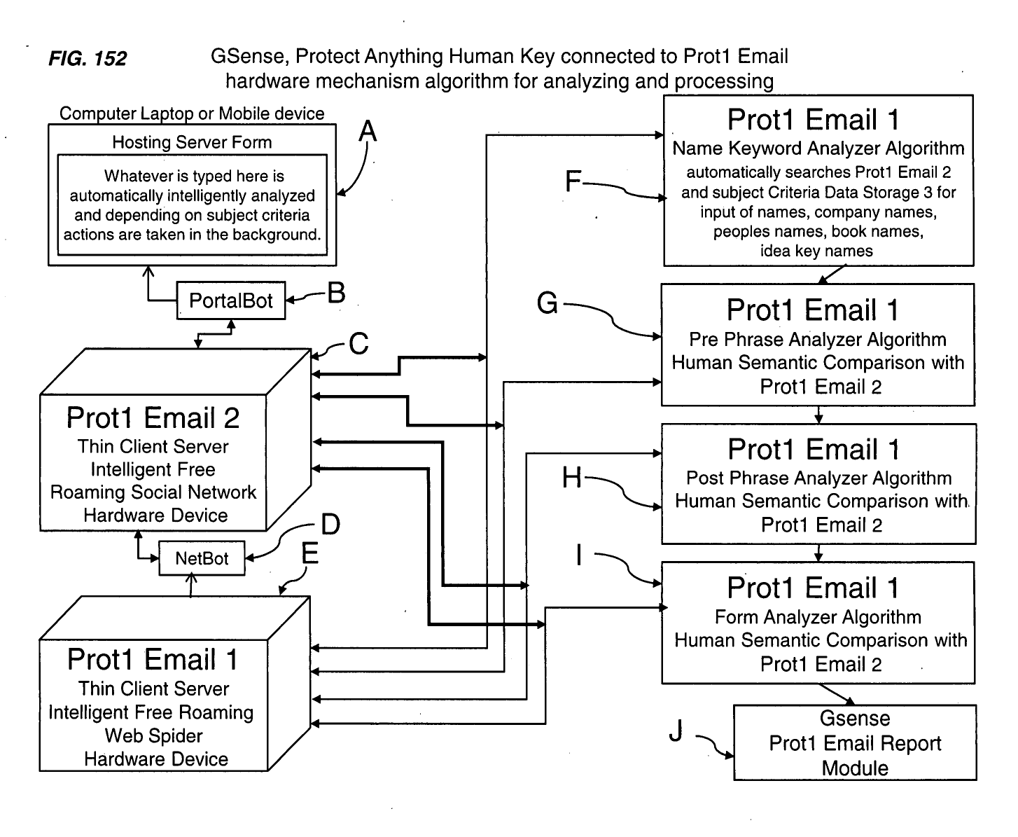

FIG. 152-A describes GSense, Protect Anything Human Key connected to Prot1 Email hardware mechanism algorithm for analyzing and processing email data and shows the Computer Laptop or Mobile device Hosting Server Form Whatever is typed here is automatically intelligently analyzed and depending on subject criteria actions are taken in the background.

FIG. 152-BA describes GSense, Protect Anything Human Key connected to Prot1 Email hardware mechanism algorithm for analyzing and processing email data and shows the Portal Bot.

FIG. 152-C describes GSense, Protect Anything Human Key connected to Prot1 Email hardware mechanism algorithm for analyzing and processing email data and shows the Prot1 Email 2 Thin Client Server Intelligent Free Roaming Social Network Hardware Device.

FIG. 152-D describes GSense, Protect Anything Human Key connected to Prot1 Email hardware mechanism algorithm for analyzing and processing email data and shows the Net Bot.

FIG. 152-E describes GSense, Protect Anything Human Key connected to Prot1 Email hardware mechanism algorithm for analyzing and processing email data and shows the Prot1 Email 1 Thin Client Server Intelligent Free Roaming Web Spider Hardware Device.

FIG. 152-F describes GSense, Protect Anything Human Key connected to Prot1 Email hardware mechanism algorithm for analyzing and processing email data and shows the Prot1 Email 1 Name Keyword Analyzer Algorithm automatically searches Prot1 Email 2 and subject Criteria Data Storage 3 for input of names, company names, peoples names, book names, idea key names.

FIG. 152-G describes GSense, Protect Anything Human Key connected to Prot1 Email hardware mechanism algorithm for analyzing and processing email data and shows the Prot1 Email 1 Pre Phrase Analyzer Algorithm Human Semantic Comparison with Prot1 Email 2.

FIG. 152-H describes GSense, Protect Anything Human Key connected to Prot1 Email hardware mechanism algorithm for analyzing and processing email data and shows the Prot1 Email 1 Post Phrase Analyzer Algorithm Human Semantic Comparison with Prot1 Email 2.

FIG. 152-I describes GSense, Protect Anything Human Key connected to Prot1 Email hardware mechanism algorithm for analyzing and processing email data and shows the Prot1 Email 1 Form Analyzer Algorithm Human Semantic Comparison with Prot1 Email 2.

FIG. 152-J describes GSense, Protect Anything Human Key connected to Prot1 Email hardware mechanism algorithm for analyzing and processing email data and shows the GSense Prot1 Email Report Module.

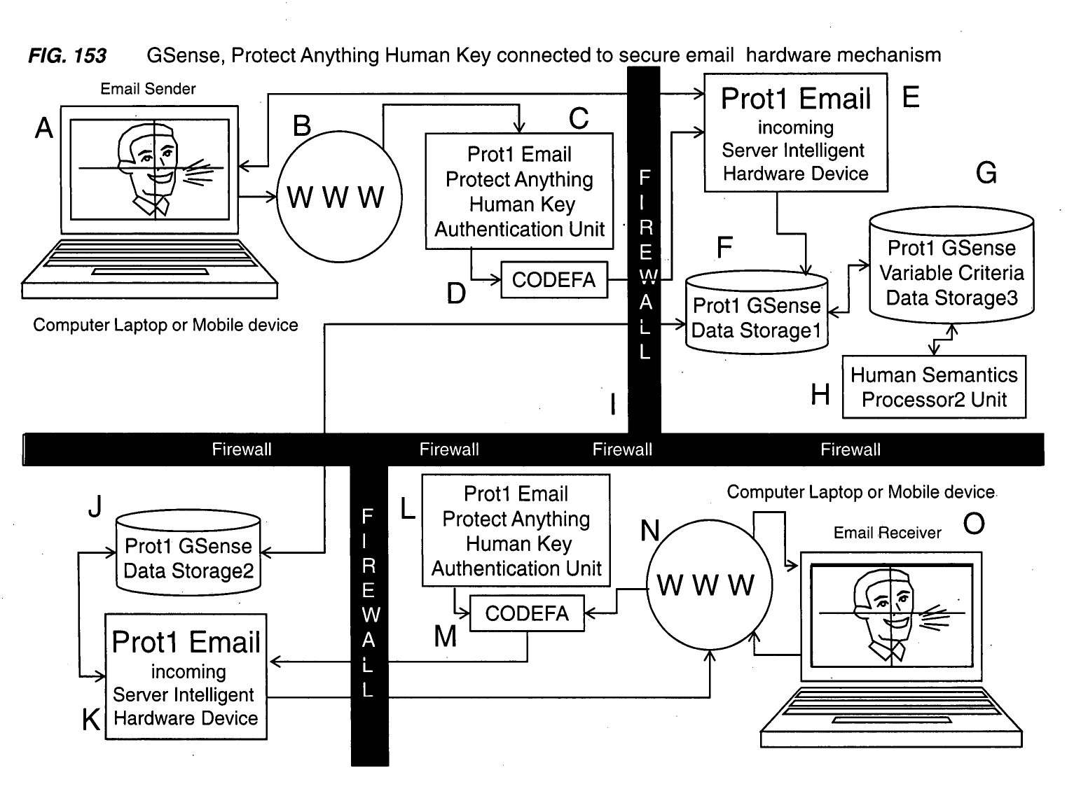

FIG. 153-A describes GSense, Protect Anything Human Key connected to secure email hardware mechanism for analyzing and processing secure encrypted email data and shows the Email Sender Computer Laptop or Mobile device.

FIG. 153-B describes GSense, Protect Anything Human Key connected to secure email hardware mechanism for analyzing and processing secure encrypted email data and shows the W W W or World Wide Web is used for data aggregation and comparison analysis methods.

FIG. 153-C describes GSense, Protect Anything Human Key connected to secure email hardware mechanism for analyzing and processing secure encrypted email data and shows the Prot1 Email Protect Anything Human Key Authentication Unit.

FIG. 153-D describes GSense, Protect Anything Human Key connected to secure email hardware mechanism for analyzing and processing secure encrypted email data and shows the Protect Anything CODEFA mechanism provides storage, security, human key and tracking features.

FIG. 153-E describes GSense, Protect Anything Human Key connected to secure email hardware mechanism for analyzing and processing secure encrypted email data and shows the Prot1 Email incoming Server Intelligent Hardware Device.

FIG. 153-F describes GSense, Protect Anything Human Key connected to secure email hardware mechanism for analyzing and processing secure encrypted email data and shows the Prot1 GSense Data Storage1.

FIG. 153-G describes GSense, Protect Anything Human Key connected to secure email hardware mechanism for analyzing and processing secure encrypted email data and shows the Prot1 GSense Variable Criteria Data Storage3.

FIG. 153-H describes GSense, Protect Anything Human Key connected to secure email hardware mechanism for analyzing and processing secure encrypted email data and shows the Human Semantics Processor2 Unit.

FIG. 153-I describes GSense, Protect Anything Human Key connected to secure email hardware mechanism for analyzing and processing secure encrypted email data and shows the firewall.

FIG. 153-J describes GSense, Protect Anything Human Key connected to secure email hardware mechanism for analyzing and processing secure encrypted email data and shows the Prot1 GSense Data Storage2.

FIG. 153-K describes GSense, Protect Anything Human Key connected to secure email hardware mechanism for analyzing and processing secure encrypted email data and shows the Prot1 Email incoming Server Intelligent Hardware Device.

FIG. 153-L describes GSense, Protect Anything Human Key connected to secure email hardware mechanism for analyzing and processing secure encrypted email data and shows the Prot1 Email Protect Anything Human Key Authentication Unit.

FIG. 153-M describes GSense, Protect Anything Human Key connected to secure email hardware mechanism for analyzing and processing secure encrypted email data and shows the Protect Anything CODEFA mechanism provides storage, security, human key and tracking features.

FIG. 153-N describes GSense, Protect Anything Human Key connected to secure email hardware mechanism for analyzing and processing secure encrypted email data and shows the W W W or World Wide Web is used for data aggregation and comparison analysis methods.

FIG. 153-O describes GSense, Protect Anything Human Key connected to secure email hardware mechanism for analyzing and processing secure encrypted email data and shows the Computer Laptop or Mobile device Email Receiver.

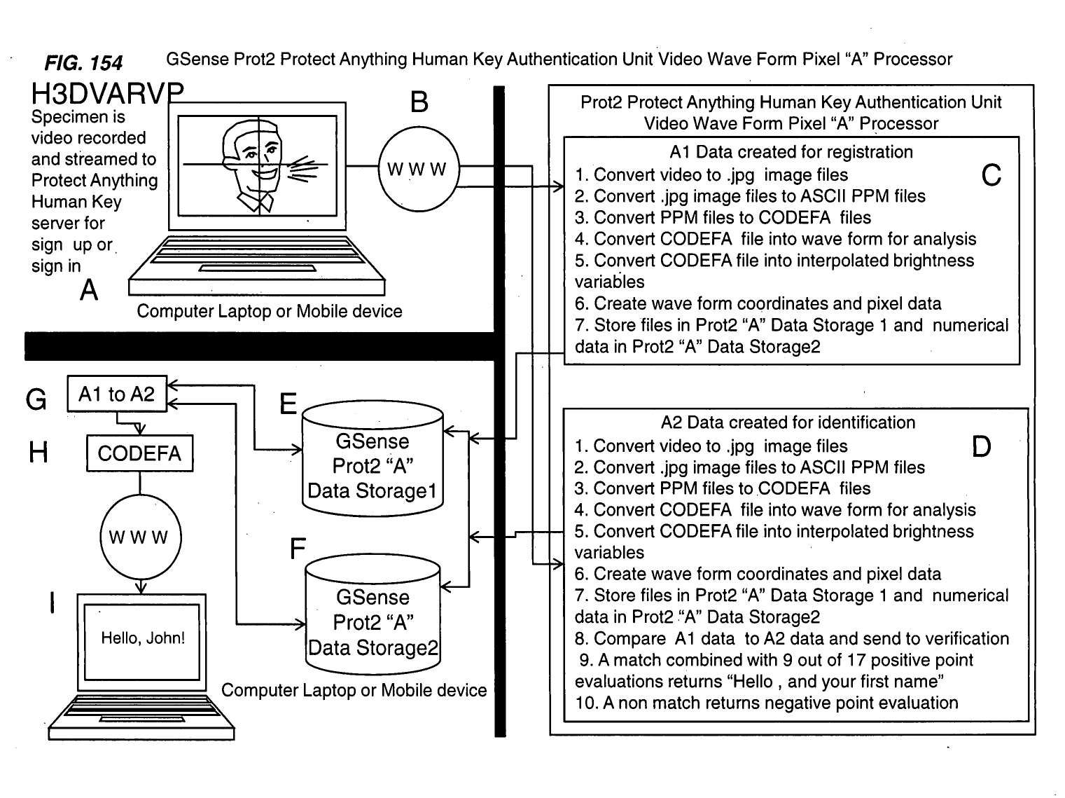

FIG. 154-A describes GSense Prot2 Protect Anything Human Key Authentication Unit Video Wave Form Pixel “A” Processor with H3DVARV 3D Human Video Audio Stereo Viewing and Recording Mechanism and shows how the Specimen is video recorded and streamed to Protect Anything Human Key server for sign up or sign in Computer Laptop or Mobile device.

FIG. 154-B describes GSense Prot2 Protect Anything Human Key Authentication Unit Video Wave Form Pixel “A” Processor and shows how the W W W or World Wide Web is used for data aggregation and comparison analysis methods.

FIG. 154-C describes GSense Prot2 Protect Anything Human Key Authentication Unit Video Wave Form Pixel “A” Processor and shows where the Prot2 Protect Anything Human Key Authentication Unit Video Wave Form Pixel “A” Processor A1 Data created for registration mechanism, 1. Converts video to .jpg image files, 2. Converts .jpg image files to ASCII PPM files, 3. Converts PPM files to Protect Anything CODEFA mechanism provides storage, security, human key and tracking features files, 4. Converts Protect Anything CODEFA mechanism provides storage, security, human key and tracking features file into wave form for analysis, 5. Converts Protect Anything CODEFA mechanism provides storage, security, human key and tracking features file into interpolated brightness variables, 6. Creates wave form coordinates and pixel data, 7. Stores files in Prot2 “A” Data Storage 1 and numerical data in Prot2 “A” Data Storage2.

FIG. 154-D describes GSense Prot2 Protect Anything Human Key Authentication Unit Video Wave Form Pixel “A” Processor and shows where the Prot2 Protect Anything Human Key Authentication Unit Video Wave Form Pixel “A” Processor A2 Data created for identification mechanism, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “A” Data Storage 1 and numerical data in Prot2 “A” Data Storage 2, 8. Compares A1 data to A2 data and send to verification, 9. Where A match combined with 9 out of 16 positive point evaluations returns “Hello, and your first name”, 10. Where a non match returns negative point evaluation.

FIG. 154-E describes GSense Prot2 Protect Anything Human Key Authentication Unit Video Wave Form Pixel “A” Processor and shows the GSense Prot2 “A” Data Storage1.

FIG. 154-F describes GSense Prot2 Protect Anything Human Key Authentication Unit Video Wave Form Pixel “A” Processor and shows the GSense Prot2 “A” Data Storage2.

FIG. 154-G describes GSense Prot2 Protect Anything Human Key Authentication Unit Video Wave Form Pixel “A” Processor and shows the A1 to A2 Pattern matching and Comparison Processor Mechanism that analyzes the data utilizing one or all of these analysis mechanisms including maximum distance analysis, mean distance analysis, mathematical error/data fit analysis, average color matrix analysis, fractal dimensions comparisons analysis, fourier descriptors analysis, brightness interpolation comparison analysis, octal dump conversion analysis, vector overlay pattern analysis, audio wave form pattern analysis, and audio converted to image comparative analysis.

FIG. 154-H describes GSense Prot2 Protect Anything Human Key Authentication Unit Video Wave Form Pixel “A” Processor and shows the Protect Anything CODEFA mechanism that provides storage, security, human key and tracking features.

FIG. 154-I describes GSense Prot2 Protect Anything Human Key Authentication Unit Video Wave Form Pixel “A” Processor and shows where the W W W or World Wide Web is used for data aggregation and comparison analysis methods Hello, John! Computer Laptop or Mobile device.

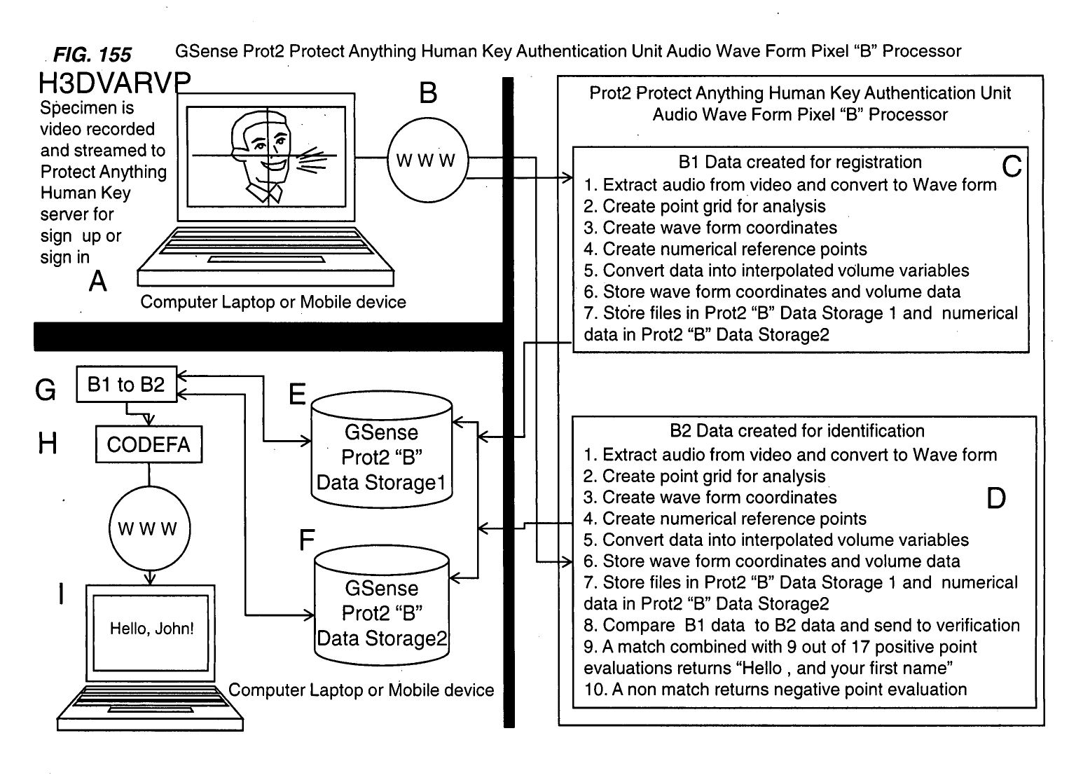

FIG. 155-A describes GSense Prot2 Protect Anything Human Key Authentication Unit Audio Wave Form Pixel “B” Processor with H3DVARV 3D Human Video Audio Stereo Viewing and Recording Mechanism and shows where the Specimen is video recorded and streamed to Protect Anything Human Key server for sign up or sign in Computer Laptop or Mobile device.

FIG. 155-B describes GSense Prot2 Protect Anything Human Key Authentication Unit Audio Wave Form Pixel “B” Processor and shows where the W W W or World Wide Web is used for data aggregation and comparison analysis methods.

FIG. 155-C describes GSense Prot2 Protect Anything Human Key Authentication Unit Audio Wave Form Pixel “B” Processor and shows where the Prot2 Protect Anything Human Key Authentication Unit Audio Wave Form Pixel “B” Processor B1 Data created for registration mechanism, 1. Extracts audio from video and convert to Wave form, 2. Creates point grid for analysis, 3. Creates wave form coordinates, 4. Creates numerical reference points, 5. Converts data into interpolated volume variables, 6. Stores wave form coordinates and volume data, 7. Stores files in Prot2 “B” Data Storage 1 and numerical data in Prot2 “B” Data Storage2.

FIG. 155-D describes GSense Prot2 Protect Anything Human Key Authentication Unit Audio Wave Form Pixel “B” Processor and shows where the Prot2 Protect Anything Human Key Authentication Unit Audio Wave Form Pixel “B” Processor B2 Data created for identification mechanism, 1. Extracts audio from video and convert to Wave form, 2. Creates point grid for analysis, 3. Creates wave form coordinates, 4. Creates numerical reference points, 5. Converts data into interpolated volume variables, 6. Stores wave form coordinates and volume data, 7. Stores files in Prot2 “B” Data Storage 1 and numerical data in Prot2 “B” Data Storage2, 8. Compares B1 data to B2 data and send to verification, 9. Where a match combined with 9 out of 16 positive point evaluations returns “Hello, and your first name”, 10. And where a non match returns negative point evaluation.

FIG. 155-E describes GSense Prot2 Protect Anything Human Key Authentication Unit Audio Wave Form Pixel “B” Processor and shows the GSense Prot2 “B” Data Storage1.

FIG. 155-F describes GSense Prot2 Protect Anything Human Key Authentication Unit Audio Wave Form Pixel “B” Processor and shows the GSense Prot2 “B” Data Storage2.

FIG. 155-G describes GSense Prot2 Protect Anything Human Key Authentication Unit Audio Wave Form Pixel “B” Processor and shows where the B1 to B2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 155-H describes GSense Prot2 Protect Anything Human Key Authentication Unit Audio Wave Form Pixel “B” Processor and shows the Protect Anything CODEFA mechanism that provides storage, security, human key and tracking features.

FIG. 155-I describes GSense Prot2 Protect Anything Human Key Authentication Unit Audio Wave Form Pixel “B” Processor and shows where the W W W or world wide web is used for data aggregation and comparison analysis methods Hello, John! Computer Laptop or Mobile device.

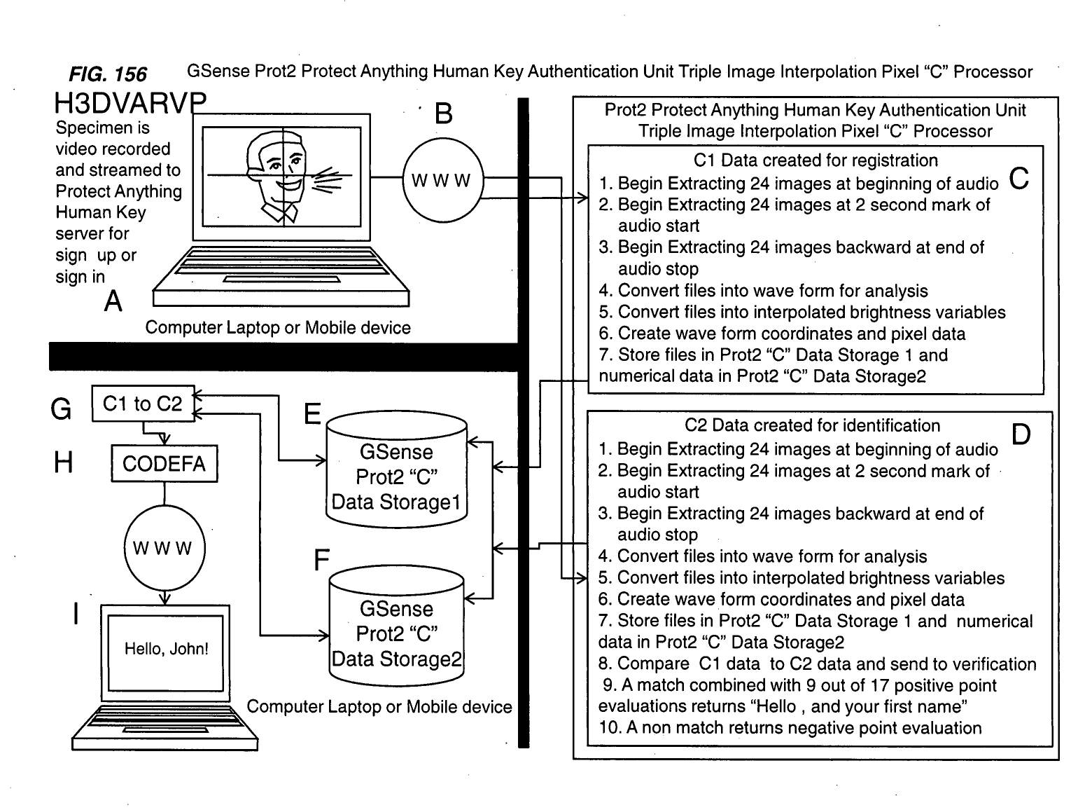

FIG. 156-A describes GSense Prot2 Protect Anything Human Key Authentication Unit Triple Image Interpolation Pixel “C” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 156-B describes GSense Prot2 Protect Anything Human Key Authentication Unit Triple Image Interpolation Pixel “C” Processor and shows where the W W W or World Wide Web is used for data aggregation and comparison analysis methods.

FIG. 156-C describes GSense Prot2 Protect Anything Human Key Authentication Unit Triple Image Interpolation Pixel “C” Processor and shows where the Prot2 Protect Anything Human Key Authentication Unit Triple Image Interpolation Pixel “C” Processor C1 Data created for registration, 1. Begins Extracting 24 images at beginning of audio, 2. Begins Extracting 24 images at 2 second mark of audio start, 3. Begins Extracting 24 images backward at end of audio stop, 4. Converts files into wave form for analysis, 5. Converts files into interpolated brightness variables, 6. Creates wave form coordinates and pixel data, 7. Stores files in Prot2 “C” Data Storage 1 and numerical data in Prot2 “C” Data Storage2.

FIG. 156-D describes GSense Prot2 Protect Anything Human Key Authentication Unit Triple Image Interpolation Pixel “C” Processor and shows where the Prot2 Protect Anything Human Key Authentication Unit Triple Image Interpolation Pixel “C” Processor C2 Data created for identification, 1. Begins Extracting 24 images at beginning of audio, 2. Begins Extracting 24 images at 2 second mark of audio start, 3. Begins Extracting 24 images backward at end of audio stop, 4. Converts files into wave form for analysis, 5. Converts files into interpolated brightness variables, 6. Creates wave form coordinates and pixel data, 7. Stores files in Prot2 “C” Data Storage 1 and numerical data in Prot2 “C” Data Storage2, 8. Compares C1 data to C2 data and send to verification, 9. Where a match combined with 9 out of 16 positive point evaluations returns “Hello, and your first name”, 10. Where a non match returns negative point evaluation.

FIG. 156-E describes GSense Prot2 Protect Anything Human Key Authentication Unit Triple Image Interpolation Pixel “C” Processor and shows the GSense Prot2 “C” Data Storage1.

FIG. 156-F describes GSense Prot2 Protect Anything Human Key Authentication Unit Triple Image Interpolation Pixel “C” Processor and shows the GSense Prot2 “C” Data Storage2.

FIG. 156-G describes GSense Prot2 Protect Anything Human Key Authentication Unit Triple Image Interpolation Pixel “C” Processor and shows where the C1 to C2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, fourier descriptors analysis, brightness interpolation comparison analysis, octal dump conversion analysis, vector overlay pattern analysis, audio wave form pattern analysis, and audio converted to image comparative analysis.

FIG. 156-H describes GSense Prot2 Protect Anything Human Key Authentication Unit Triple Image Interpolation Pixel “C” Processor and shows where the Protect Anything CODEFA mechanism that provides storage, security, human key and tracking features.

FIG. 156-I describes GSense Prot2 Protect Anything Human Key Authentication Unit Triple Image Interpolation Pixel “C” Processor and shows where the W W W or world wide web is used for data aggregation and comparison analysis methods Hello, John! Computer Laptop or Mobile device.

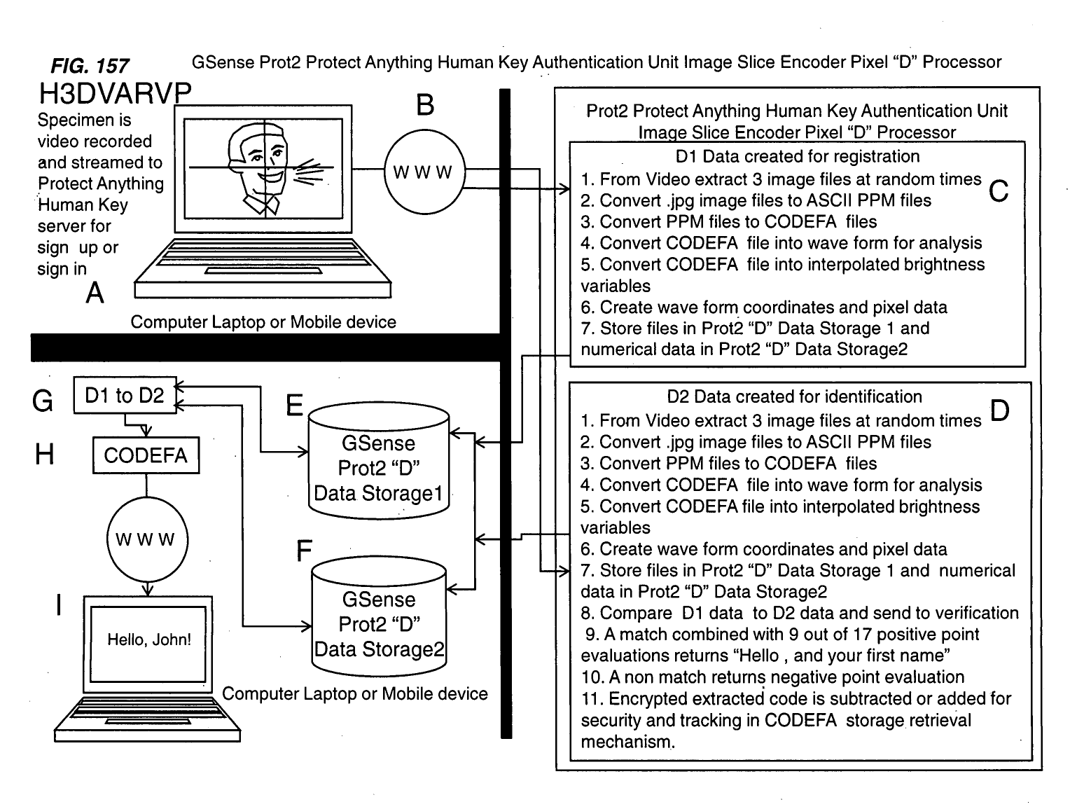

FIG. 157-A describes GSense Prot2 Protect Anything Human Key Authentication Unit Image Slice Encoder Pixel “D” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 157-B describes GSense Prot2 Protect Anything Human Key Authentication Unit Image Slice Encoder Pixel “D” Processor and shows where the W W W or World Wide Web is used for data aggregation and comparison analysis methods.

FIG. 157-C describes GSense Prot2 Protect Anything Human Key Authentication Unit Image Slice Encoder Pixel “D” Processor and shows where the Prot2 Protect Anything Human Key Authentication Unit Image Slice Encoder Pixel “D” Processor D1 Data created for registration, 1. From Video extracts 3 image files at random times, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “D” Data Storage 1 and numerical data in Prot2 “D” Data Storage2.

FIG. 157-D describes GSense Prot2 Protect Anything Human Key Authentication Unit Image Slice Encoder Pixel “D” Processor and shows where the Prot2 Protect Anything Human Key Authentication Unit Image Slice Encoder Pixel “D” Processor. D2 Data created for identification, 1. From Video extracts 3 image files at random times, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “D” Data Storage 1 and numerical data in Prot2 “D” Data Storage 2, 8. Compares D1 data to D2 data and send to verification, 9. Where a match combined with 9 out of 16 positive point evaluations returns “Hello, and your first name”, 10. Where a non match returns negative point evaluation, 11. Where encrypted extracted code is subtracted or added for security and tracking in VProtect Anything CODEFA mechanism that provides storage, security, human key and tracking features storage retrieval mechanism.

FIG. 157-E describes GSense Prot2 Protect Anything Human Key Authentication Unit Image Slice Encoder Pixel “D” Processor and shows the GSense Prot2 “D” Data Storage1.

FIG. 157-F describes GSense Prot2 Protect Anything Human Key Authentication Unit. Image Slice Encoder Pixel “D” Processor and shows the GSense Prot2 “D” Data Storage2.

FIG. 157-G describes GSense Prot2 Protect Anything Human Key Authentication Unit Image Slice Encoder Pixel “D” Processor and shows where the D1 to D2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 157-H describes GSense Prot2 Protect Anything Human Key Authentication Unit Image Slice Encoder Pixel “D” Processor and shows the Protect Anything CODEFA mechanism that provides storage, security, human key and tracking features.

FIG. 157-I describes GSense Prot2 Protect Anything Human Key Authentication Unit Image Slice Encoder Pixel “D” Processor and shows where the W W W or World Wide Web is used for data aggregation and comparison analysis methods Hello, John! Computer Laptop or Mobile device.

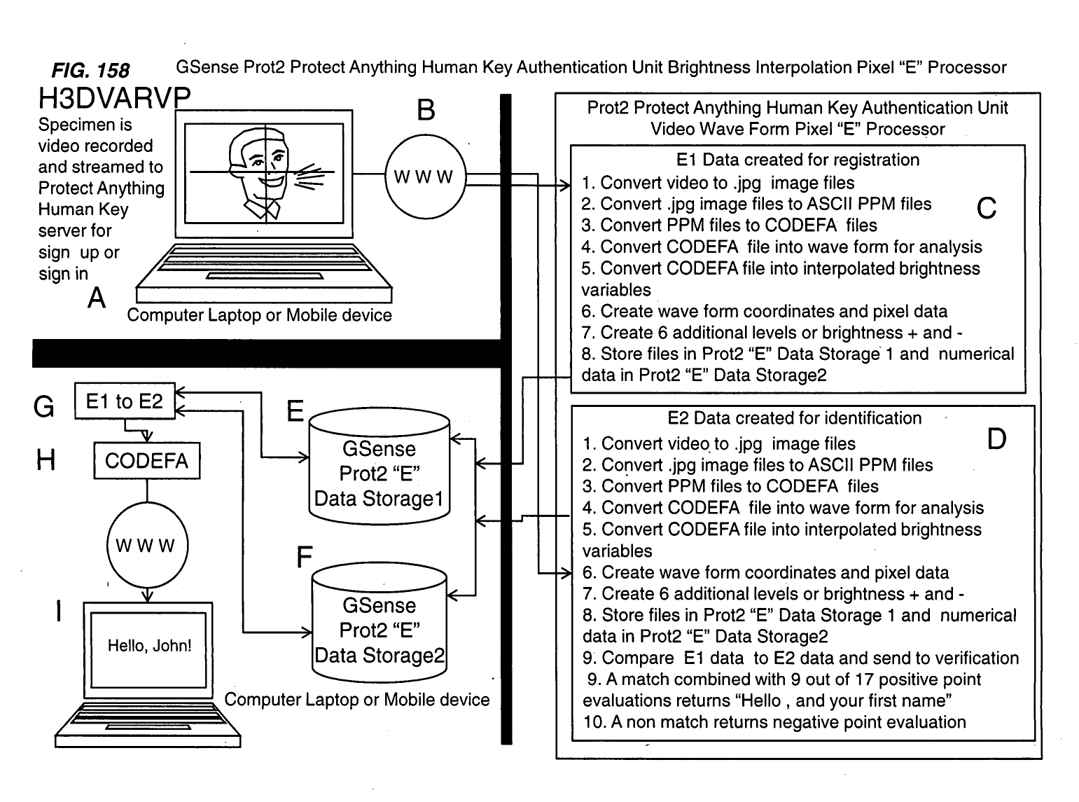

FIG. 158-A describes GSense Prot2 Protect Anything Human Key Authentication Unit Brightness Interpolation Pixel “E” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 158-B describes GSense Prot2 Protect Anything Human Key Authentication Unit Brightness Interpolation Pixel “E” Processor and shows where the W W W or World Wide Web is used for data aggregation and comparison analysis methods.

FIG. 158-C describes GSense Prot2 Protect Anything Human Key Authentication Unit Brightness Interpolation Pixel “E” Processor and shows where the Prot2 Protect Anything Human Key Authentication Unit Video Wave Form Pixel “E” Processor E1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Creates 6 additional levels or brightness + and −, 8. Stores files in Prot2 “E” Data Storage 1 and numerical data in Prot2 “E” Data Storage2.

FIG. 158-D describes GSense Prot2 Protect Anything Human Key Authentication Unit Brightness Interpolation Pixel “E” Processor and shows where the Prot2 Protect Anything Human Key Authentication Unit Video Wave Form Pixel “E” Processor E2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Creates 6 additional levels or brightness + and −, 8. Stores files in Prot2 “E” Data Storage 1 and numerical data in Prot2 “E” Data Storage 2, 9. Compares E1 data to E2 data and send to verification, 9. Where a match combined with 9 out of 16 positive point evaluations returns “Hello, and your first name”, 10. Where a non match returns negative point evaluation.

FIG. 158-E describes GSense Prot2 Protect Anything Human Key Authentication Unit Brightness Interpolation Pixel “E” Processor and shows the GSense Prot2 “E” Data Storage1.

FIG. 158-F describes GSense Prot2 Protect Anything Human Key Authentication Unit Brightness Interpolation Pixel “E” Processor and shows the GSense Prot2 “E” Data Storage2.

FIG. 158-G describes GSense Prot2 Protect Anything Human Key Authentication Unit Brightness Interpolation Pixel “E” Processor and shows where the E1 to E2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 158-H describes GSense Prot2 Protect Anything Human Key Authentication Unit Brightness Interpolation Pixel “E” Processor and shows the Protect Anything CODEFA mechanism that provides storage, security, human key and tracking features.

FIG. 158-I describes GSense Prot2 Protect Anything Human Key Authentication Unit Brightness Interpolation Pixel “E” Processor and shows where the W W W or World Wide Web is used for data aggregation and comparison analysis methods Hello, John! Computer Laptop or Mobile device.

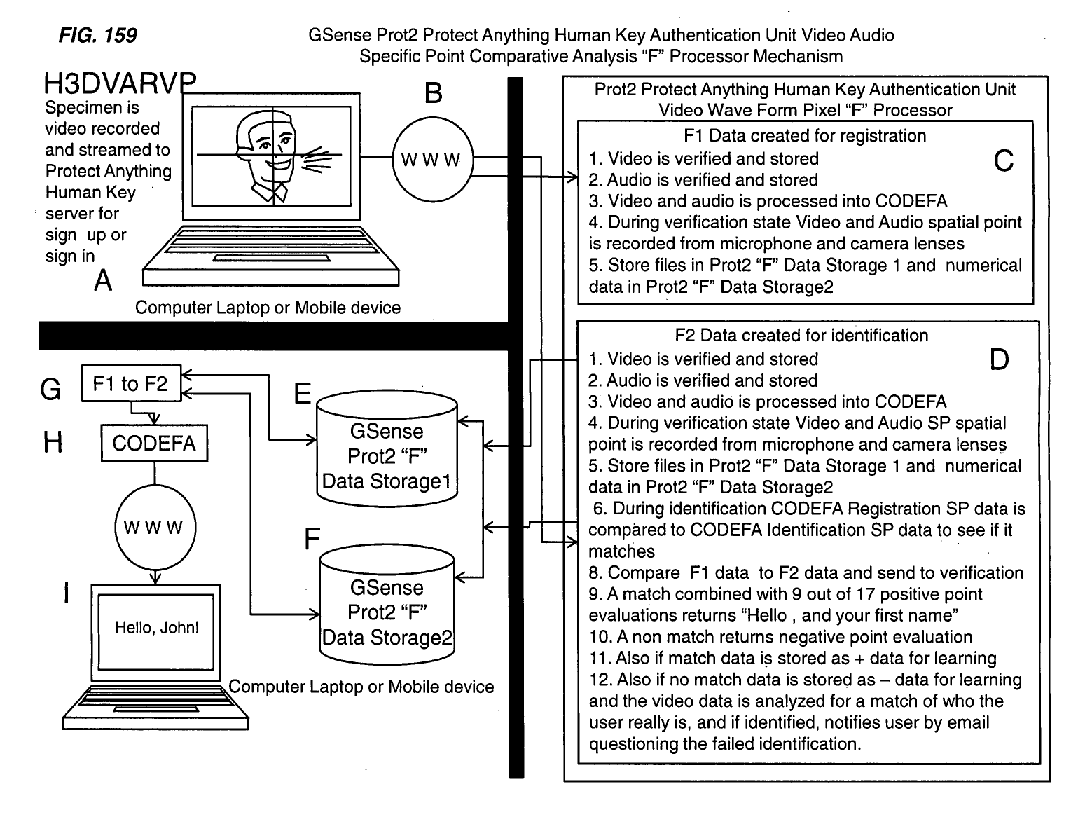

FIG. 159-A describes GSense Prot2 Protect Anything Human Key Authentication Unit Video Audio Specific Point Comparative Analysis “F” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 159-B describes GSense Prot2 Protect Anything Human Key Authentication Unit Video Audio Specific Point Comparative Analysis “F” Processor Mechanism and shows where the W W W or World Wide Web is used for data aggregation and comparison analysis methods.

FIG. 159-C describes GSense Prot2 Protect Anything Human Key Authentication Unit Video Audio Specific Point Comparative Analysis “F” Processor Mechanism and shows where the Prot2 Protect Anything Human Key Authentication Unit Video Wave Form Pixel “F” Processor F1 Data created for registration, 1. Video is verified and stored, 2. Audio is verified and stored, 3. Video and audio is processed into CODEFA, 4. During verification state Video and Audio spatial point is recorded from microphone and camera lenses, 5. Stores files in Prot2 “F” Data Storage 1 and numerical data in Prot2 “F” Data Storage2.

FIG. 159-D describes GSense Prot2 Protect Anything Human Key Authentication Unit Video Audio Specific Point Comparative Analysis “F” Processor Mechanism and shows where the Prot2 Protect Anything Human Key Authentication Unit Video Wave Form Pixel “F” Processor F2 Data created for identification, 1. Video is verified and stored, 2. Audio is verified and stored, 3. Video and audio is processed into CODEFA, 4. During verification state Video and Audio SP spatial point is recorded from microphone and camera lenses, 5. Store files in Prot2 “F” Data Storage 1 and numerical data in Prot2 “F” Data Storage2, 6. During identification CODEFA Registration SP data is compared to CODEFA Identification SP data to see if it matches, 8. Compare F1 data to F2 data and send to verification, 9. Where a match combined with 9 out of 16 positive point evaluations returns “Hello, and your first name”, 10. Where a non match returns negative point evaluation, 11. Also if match data is stored as + data for learning 12. Also if no match data is stored as − data for learning and the video data is analyzed for a match of who the user really is, and if identified, notifies user by email questioning the failed identification.

FIG. 159-E describes GSense Prot2 Protect Anything Human Key Authentication Unit Video Audio Specific Point Comparative Analysis “F” Processor Mechanism and shows the GSense Prot2 “F” Data Storage1.

FIG. 159-F describes GSense Prot2 Protect Anything Human Key Authentication Unit Video Audio Specific Point Comparative Analysis “F” Processor Mechanism and shows the GSense Prot2 “F” Data Storage2.

FIG. 159-G describes GSense Prot2 Protect Anything Human Key Authentication Unit Video Audio Specific Point Comparative Analysis “F” Processor Mechanism and shows where the F1 to F2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 159-H describes GSense Prot2 Protect Anything Human Key Authentication Unit Video Audio Specific Point Comparative Analysis “F” Processor Mechanism and shows the Protect Anything CODEFA mechanism that provides storage, security, human key and tracking features.

FIG. 159-I describes GSense Prot2 Protect Anything Human Key Authentication Unit Video Audio Specific Point Comparative Analysis “F” Processor Mechanism and shows where the W W W or World Wide Web is used for data aggregation and comparison analysis methods Hello, John! Computer Laptop or Mobile device.

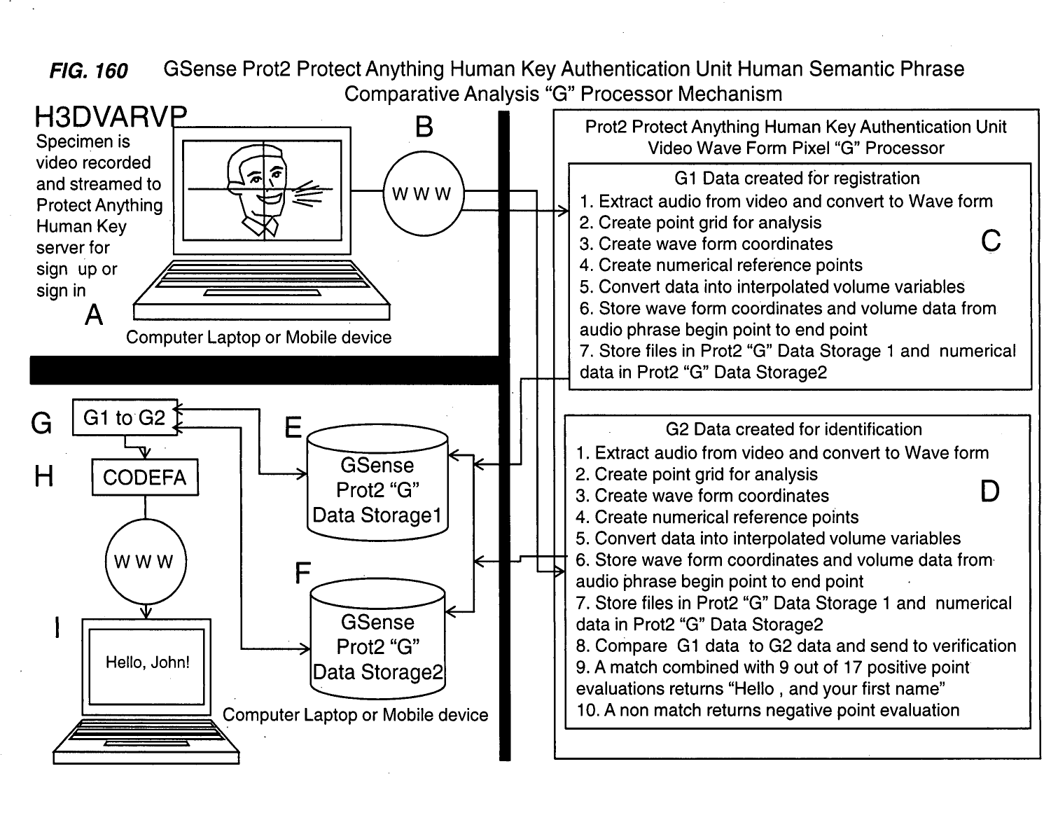

FIG. 160-A describes GSense Prot2 Protect Anything Human Key Authentication Unit Human Semantic Phrase Comparative Analysis “G” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device

FIG. 160-B describes GSense Prot2 Protect Anything Human Key Authentication Unit Human Semantic Phrase Comparative Analysis “G” Processor Mechanism and shows where the W W W or World. Wide Web is used for data aggregation and comparison analysis methods.

FIG. 160-C describes GSense Prot2 Protect Anything Human Key Authentication Unit Human Semantic Phrase Comparative Analysis “G” Processor Mechanism and where the Prot2 Protect Anything Human Key Authentication Unit Video Wave Form Pixel “G” Processor G1 Data created for registration, 1. Extracts audio from video and converts to Wave form, 2. Creates point grid for analysis, 3. Creates wave form coordinates, 4. Creates numerical reference points, 5. Converts data into interpolated volume variables, 6. Stores wave form coordinates and volume data from audio phrase begin point to end point, 7. Stores files in Prot2 “G” Data Storage 1 and numerical data in Prot2 “G” Data Storage2.

FIG. 160-D describes GSense Prot2 Protect Anything Human Key Authentication Unit Human Semantic Phrase Comparative Analysis “G” Processor Mechanism and shows where the Prot2 Protect Anything Human Key Authentication Unit Video Wave Form Pixel “G” Processor G2 Data created for identification, 1. Extracts audio from video and converts to Wave form, 2. Creates point grid for analysis, 3. Creates wave form coordinates, 4. Creates numerical reference points, 5. Converts data into interpolated volume variables, 6. Stores wave form coordinates and volume data from audio phrase begin point to end point, 7. Stores files in Prot2 “G” Data Storage 1 and numerical data in Prot2 “G” Data Storage 2, 8. Compares G1 data to G2 data and send to verification, 9. Where a match combined with 9 out of 16 positive point evaluations returns “Hello, and your first name”, 10. Where a non match returns negative point evaluation.

FIG. 160-E describes GSense Prot2 Protect Anything Human Key. Authentication Unit Human Semantic Phrase Comparative Analysis “G” Processor Mechanism and shows the GSense Prot2 “G” Data Storage1.

FIG. 160-F describes GSense Prot2 Protect Anything Human Key Authentication Unit Human Semantic Phrase Comparative Analysis “G” Processor Mechanism and shows the GSense Prot2 “G” Data Storage2.

FIG. 160-G describes GSense Prot2 Protect Anything Human Key Authentication Unit Human Semantic Phrase Comparative Analysis “G” Processor Mechanism and shows where the G1 to G2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 160-H describes GSense Prot2 Protect Anything Human Key Authentication Unit Human Semantic Phrase Comparative Analysis “G” Processor Mechanism and shows the Protect Anything CODEFA mechanism that provides storage, security, human key and tracking features.

FIG. 160-I describes GSense Prot2 Protect Anything Human Key Authentication Unit Human Semantic Phrase Comparative Analysis “G” Processor Mechanism and shows where the W W W or World Wide Web is used for data aggregation and comparison analysis methods Hello, John! Computer Laptop or Mobile device.

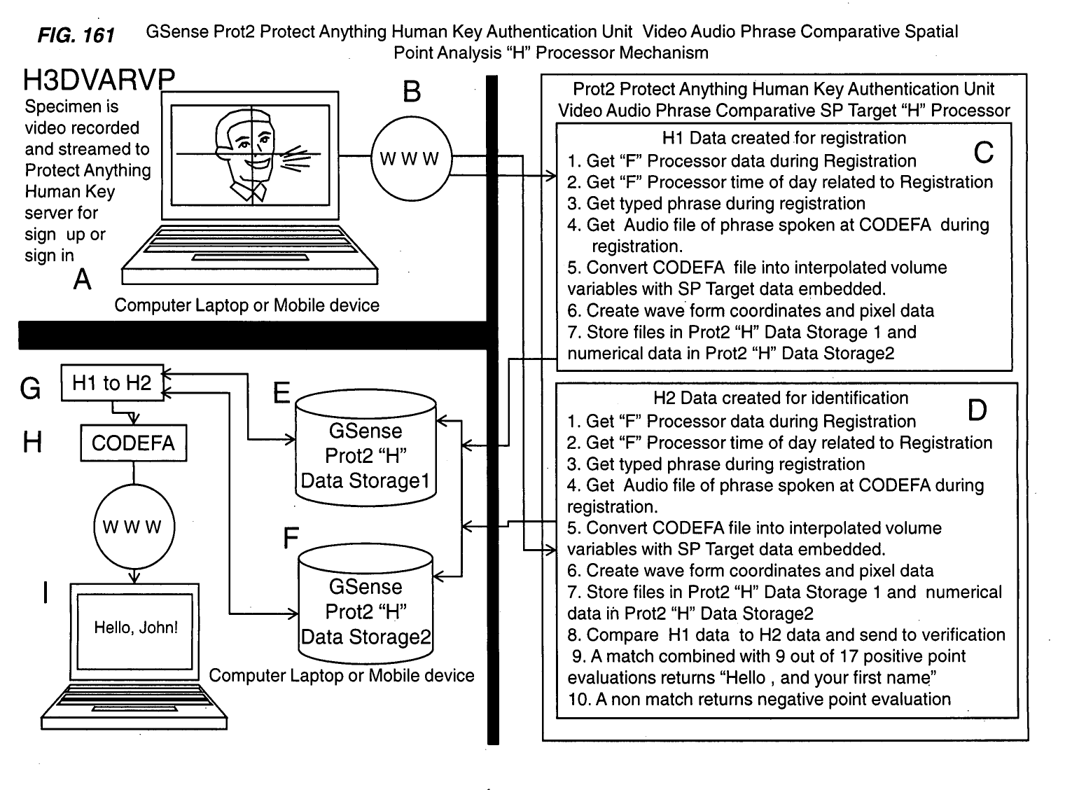

FIG. 161-A describes GSense Prot2 Protect Anything Human Key Authentication Unit Video Audio Text Comparative Spatial Point Analysis “H” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 161-B describes GSense Prot2 Protect Anything Human Key Authentication Unit Video Audio Text Comparative Spatial Point Analysis “H” Processor Mechanism and shows where the W W W or World Wide Web is used for data aggregation and comparison analysis methods.

FIG. 161-C describes GSense Prot2 Protect Anything Human Key Authentication Unit Video Audio Text Comparative Spatial Point Analysis “H” Processor Mechanism and shows where the Prot2 Protect Anything Human Key Authentication Unit Video Audio Text Comparative SP Target “H” Processor H1 Data created for registration, 1. Gets “F” Processor data during Registration, 2. Gets “F” Processor time of day related to Registration, 3. Gets typed phrase during registration, 4. Gets Audio file of phrase spoken at Protect Anything CODEFA mechanism that provides storage, security, human key and tracking features during registration, 5. Converts Protect Anything CODEFA mechanism that provides storage, security, human key and tracking features file into interpolated volume variables with SP Target data embedded, 6. Creates wave form coordinates and pixel data, 7. Stores files in Prot2 “H” Data Storage 1 and numerical data in Prot2 “H” Data Storage2.

FIG. 161-D describes GSense Prot2 Protect Anything Human Key Authentication Unit Video Audio Text Comparative Spatial Point Analysis “H” Processor Mechanism and shows where the Prot2 Protect Anything Human Key Authentication Unit Video Audio Text Comparative SP Target “H” Processor H2 Data created for identification, 1. Gets “F” Processor data during Registration, 2. Gets “F” Processor time of day related to Registration, 3. Gets typed phrase during registration, 4. Gets Audio file of phrase spoken at Protect Anything CODEFA mechanism that provides storage, security, human key and tracking features during registration, 5. Converts Protect Anything CODEFA mechanism that provides storage, security, human key and tracking features file into interpolated volume variables with SP Target data embedded, 6. Creates wave form coordinates and pixel data, 7. Stores files in Prot2 “H” Data Storage 1 and numerical data in Prot2 “H” Data Storage2, 8. Compares H1 data to H2 data and send to verification, 9. Where a match combined with 9 out of 16 positive point evaluations returns “Hello, and your first name”, 10. Where a non match returns negative point evaluation.

FIG. 161-E describes GSense Prot2 Protect Anything Human Key Authentication Unit Video Audio Text Comparative Spatial Point Analysis “H” Processor Mechanism and shows the GSense Prot2 “H” Data Storage1.

FIG. 161-F describes GSense Prot2 Protect Anything Human Key Authentication Unit Video Audio Text Comparative Spatial Point Analysis “H” Processor Mechanism and shows the GSense Prot2 “H” Data Storage2.

FIG. 161-G describes GSense Prot2 Protect Anything Human Key Authentication Unit Video Audio Text Comparative Spatial Point Analysis “H” Processor Mechanism and shows where the H1 to H2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 161-H describes GSense Prot2 Protect Anything Human Key Authentication Unit Video Audio Text Comparative Spatial Point Analysis “H” Processor Mechanism and shows the Protect Anything CODEFA mechanism that provides storage, security, human key and tracking features.

FIG. 161-I describes GSense Prot2 Protect Anything Human Key Authentication Unit Video Audio Text Comparative Spatial Point Analysis “H” Processor Mechanism and shows where the W W W or world wide web is used for data aggregation and comparison analysis methods Hello, John! Computer Laptop or Mobile device.

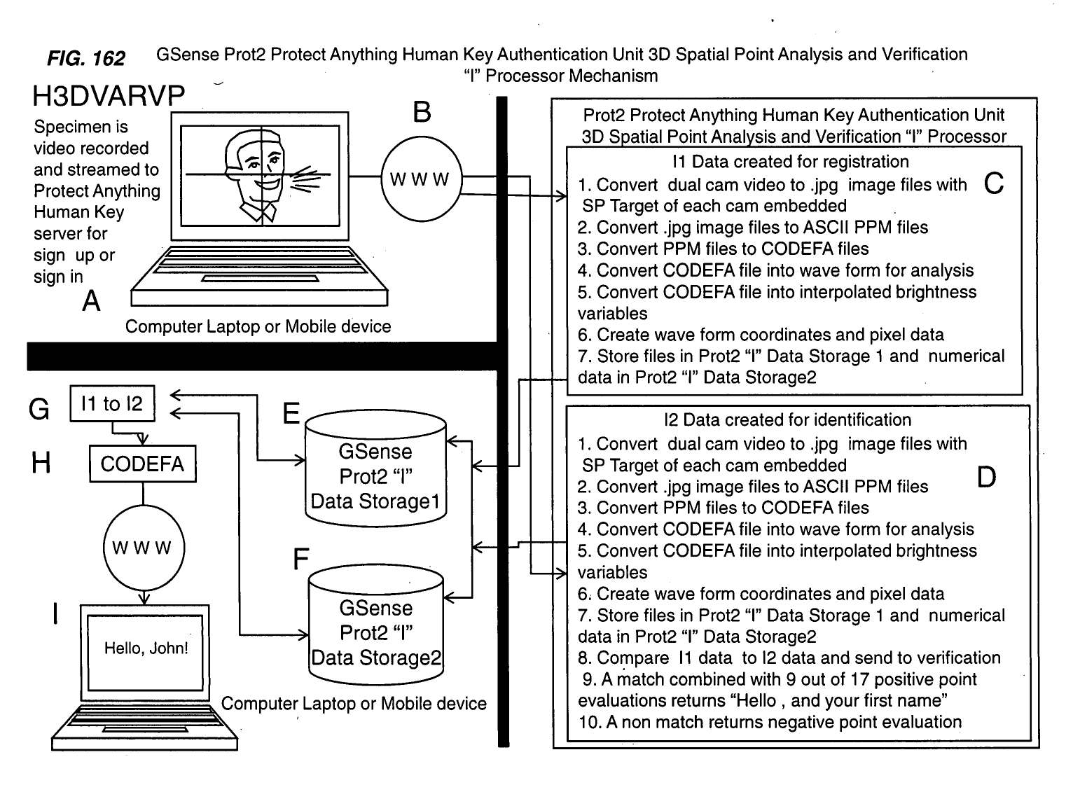

FIG. 162-A describes GSense Prot2 Protect Anything Human Key Authentication Unit 3D Spatial Point Analysis and Verification “I” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 162-B describes GSense Prot2 Protect Anything Human Key Authentication Unit 3D Spatial Point Analysis and Verification “I” Processor Mechanism and shows where the W W W or World Wide Web is used for data aggregation and comparison analysis methods.

FIG. 162-C describes GSense Prot2 Protect Anything Human Key Authentication Unit 3D Spatial Point Analysis and Verification “I” Processor Mechanism and shows where the Prot2 Protect Anything Human Key Authentication Unit3D Spatial Point Analysis and Verification “I” Processor I1 Data created for registration, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “I” Data Storage 1 and numerical data in Prot2 “I” Data Storage2.

FIG. 162-D describes GSense Prot2 Protect Anything Human Key Authentication Unit 3D Spatial Point Analysis and Verification “I” Processor Mechanism and shows where the Prot2 Protect Anything Human Key Authentication Unit3D Spatial Point Analysis and Verification “I” Processor 12 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “1” Data Storage 1 and numerical data in Prot2 “I” Data Storage2, 8. Compares I1 data to I2 data and send to verification, 9. Where a match combined with 9 out of 16 positive point evaluations returns “Hello, and your first name”, 10. Where a non match returns negative point evaluation.

FIG. 162-E describes GSense Prot2 Protect Anything Human Key Authentication Unit 3D Spatial Point Analysis and Verification “I” Processor Mechanism and shows the GSense Prot2 “I” Data Storage1.

FIG. 162-F describes GSense Prot2 Protect Anything Human Key Authentication Unit 3D Spatial Point Analysis and Verification “I” Processor Mechanism and shows the GSense Prot2 “I” Data Storage2.

FIG. 162-G describes GSense Prot2 Protect Anything Human Key Authentication Unit 3D Spatial Point Analysis and Verification “I” Processor Mechanism and shows where the I1 to I2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, fourier descriptors analysis, brightness interpolation comparison analysis, octal dump conversion analysis, vector overlay pattern analysis, audio wave form pattern analysis, and audio converted to image comparative analysis.

FIG. 162-H describes GSense Prot2 Protect Anything Human Key Authentication Unit 3D Spatial Point Analysis and Verification “I” Processor Mechanism and shows the Protect Anything CODEFA mechanism that provides storage, security, human key and tracking features.

FIG. 162-I describes GSense Prot2 Protect Anything Human Key Authentication Unit 3D Spatial Point Analysis and Verification “I” Processor Mechanism and shows where the W W W or World Wide Web is used for data aggregation and comparison analysis methods Hello, John! Computer Laptop or Mobile device.

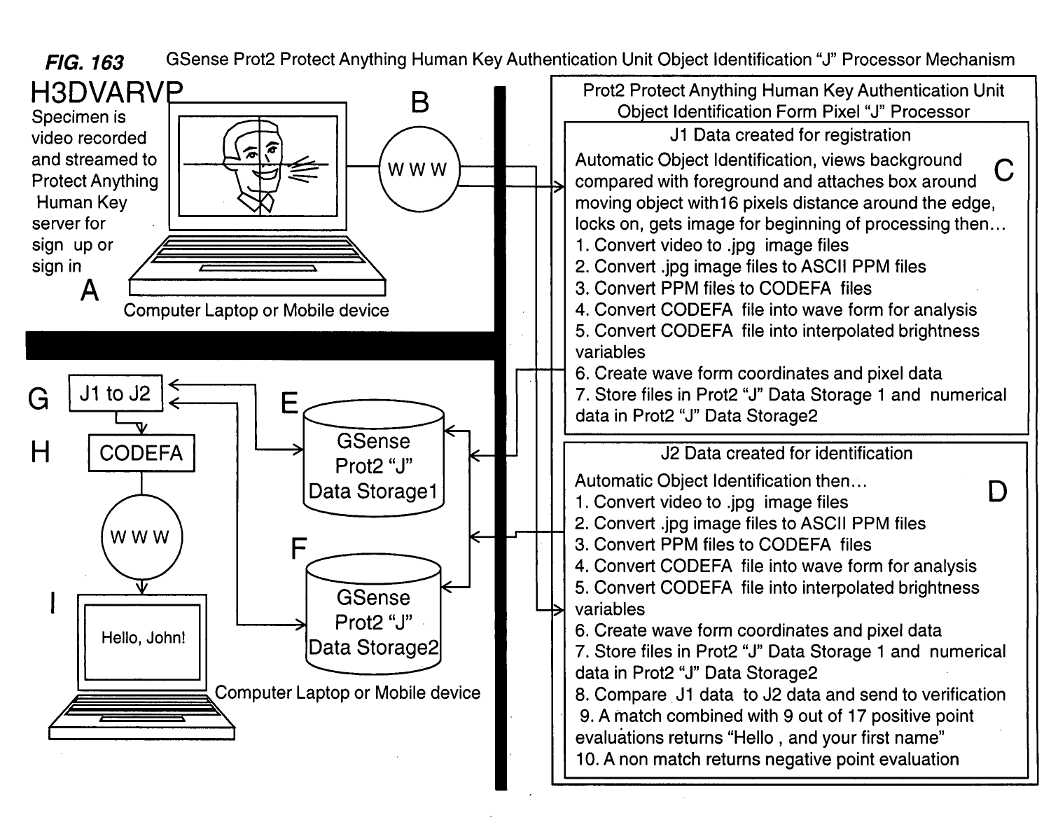

FIG. 163-A describes GSense Prot2 Protect Anything Human Key Authentication Unit Object Identification “J” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 163-B describes GSense Prot2 Protect Anything Human Key Authentication Unit Object Identification “J” Processor Mechanism and shows where the W W W or World Wide Web is used for data aggregation and comparison analysis methods.

FIG. 163-C describes GSense Prot2 Protect Anything Human Key Authentication Unit Object Identification “J” Processor Mechanism and shows where the Prot2 Protect Anything Human Key Authentication Unit Object Identification Form Pixel “J” Processor J1 Data created for registration Automatic Object Identification, views background compared with foreground and attaches box around moving object with 16 pixels distance around the edge, locks on, gets image for beginning of processing then . . . , 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “J” Data Storage 1 and numerical data in Prot2 “J” Data Storage2.

FIG. 163-D describes GSense Prot2 Protect Anything Human Key Authentication Unit Object Identification “J” Processor Mechanism and shows where the Prot2 Protect Anything Human Key Authentication Unit Object Identification Form Pixel “J” Processor J2 Data created for identification Automatic Object Identification then . . . , 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “J” Data Storage 1 and numerical data in Prot2 “J” Data Storage2, 8. Compares J1 data to J2 data and send to verification, 9. Where a match combined with 9 out of 16 positive point evaluations returns “Hello, and your first name”, 10. Where a non match returns negative point evaluation.

FIG. 163-E describes GSense Prot2 Protect Anything Human Key Authentication Unit Object Identification “J” Processor Mechanism and shows the GSense Prot2 “J” Data Storage1.

FIG. 163-F describes GSense Prot2 Protect Anything Human Key Authentication Unit Object Identification “J” Processor Mechanism and shows the GSense Prot2 “J” Data Storage2.

FIG. 163-G describes GSense Prot2 Protect Anything Human Key Authentication Unit Object Identification “J” Processor Mechanism and shows where the J1 to J2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 163-H describes GSense Prot2 Protect Anything Human Key Authentication Unit Object Identification “J” Processor Mechanism and shows the Protect Anything CODEFA mechanism that provides storage, security, human key and tracking features.

FIG. 163-I describes GSense Prot2 Protect Anything Human Key Authentication Unit Object Identification “J” Processor Mechanism and shows where the W W W or world wide web is used for data aggregation and comparison analysis methods Hello, John! Computer Laptop or Mobile device.

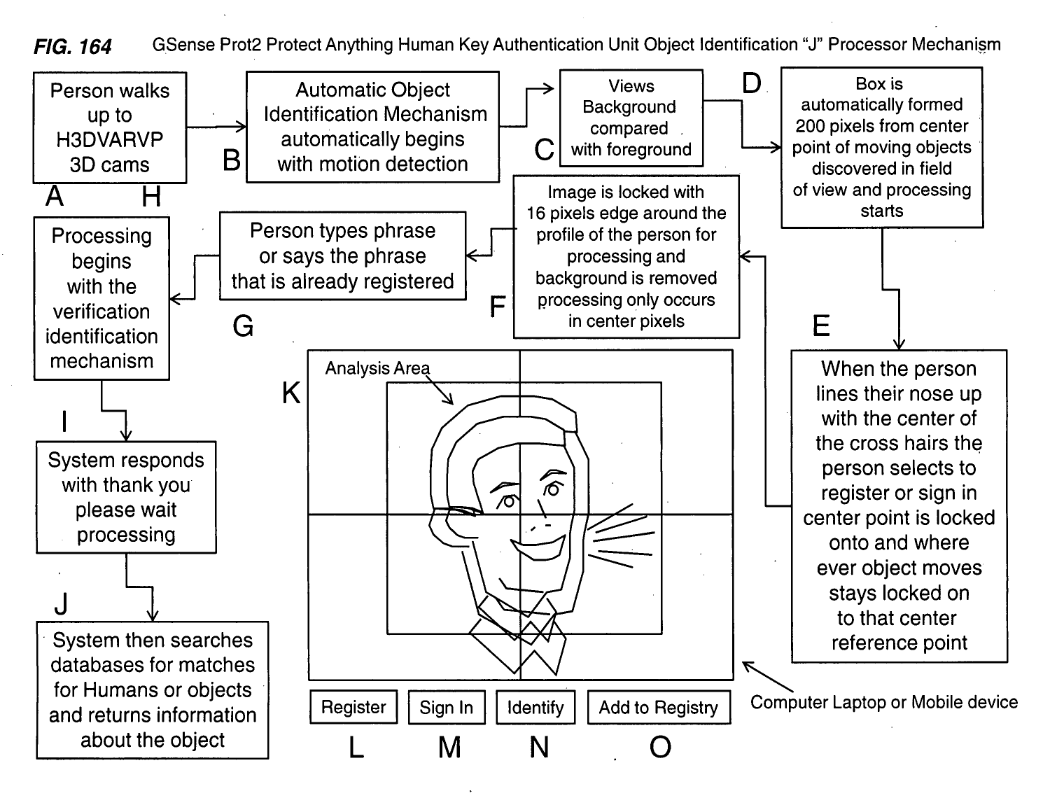

FIG. 164-A describes GSense Prot2 Protect Anything Human Key Authentication Unit Object Identification “J” Processor with H3DVARV 3D Human Video Audio Stereo Viewing and Recording Mechanism Analysis Area Mechanism and shows where the Person walks up to H3DVARV 3D Human Video Audio Stereo Viewing and Recording Mechanism 3D cams.

FIG. 164-B describes GSense Prot2 Protect Anything Human Key Authentication Unit Object Identification “J” Processor Analysis Area Mechanism and shows where automatic Object Identification Mechanism automatically begins with motion detection.

FIG. 164-C describes GSense Prot2 Protect Anything Human Key Authentication Unit Object Identification “J” Processor Analysis Area Mechanism and shows where the Views Background is compared with foreground.

FIG. 164-D describes GSense Prot2 Protect Anything Human Key Authentication Unit Object Identification “J” Processor Analysis Area Mechanism and shows where the Box is automatically formed 200 pixels from center point of moving objects discovered in field of view and processing starts.

FIG. 164-E describes GSense Prot2 Protect Anything Human Key Authentication Unit Object Identification “J” Processor Analysis Area Mechanism and shows where when the person lines their nose up with the center of the cross hairs the person selects to register or sign in center point is locked onto and where ever object moves stays locked onto that center reference point.

FIG. 164-F describes GSense Prot2 Protect Anything Human Key Authentication Unit Object Identification “J” Processor Analysis Area Mechanism and shows where the Image is locked with 16 pixels edge around the profile of the person for processing and background is removed processing only occurs in center pixels.

FIG. 164-G describes GSense Prot2 Protect Anything Human Key Authentication Unit Object Identification “J” Processor Analysis Area Mechanism and shows where the Person types phrase or says the phrase that is already registered.

FIG. 164-H describes GSense Prot2 Protect Anything Human Key Authentication Unit Object Identification “J” Processor Analysis Area Mechanism and shows where the Processing begins with the verification identification mechanism.

FIG. 164-I describes GSense Prot2 Protect Anything Human Key Authentication Unit Object Identification “J” Processor Analysis Area Mechanism and shows where the System responds with thank you please wait processing.

FIG. 164-J describes GSense Prot2 Protect Anything Human Key Authentication Unit Object Identification “J” Processor Analysis Area Mechanism and shows where the System then searches databases for matches for Humans or objects and returns information about the object.

FIG. 164-K describes GSense Prot2 Protect Anything Human Key Authentication Unit Object Identification “J” Processor Analysis Area Mechanism and shows where analysis Area is used with any Computer, Laptop, or Mobile device.

FIG. 164-L describes GSense Prot2 Protect Anything Human Key Authentication Unit. Object Identification “J” Processor Analysis Area Mechanism and shows where the Register button is located.

FIG. 164-M describes GSense Prot2 Protect Anything Human Key Authentication Unit Object Identification “J” Processor Analysis Area Mechanism and shows where the Sign In button is located.

FIG. 164-N describes GSense Prot2 Protect Anything Human Key Authentication Unit Object Identification “J” Processor Analysis Area Mechanism and shows where the Identify button is located.

FIG. 164-O describes GSense Prot2 Protect Anything Human Key Authentication Unit Object Identification “J” Processor Analysis Area Mechanism and shows where add to Registry button is located.

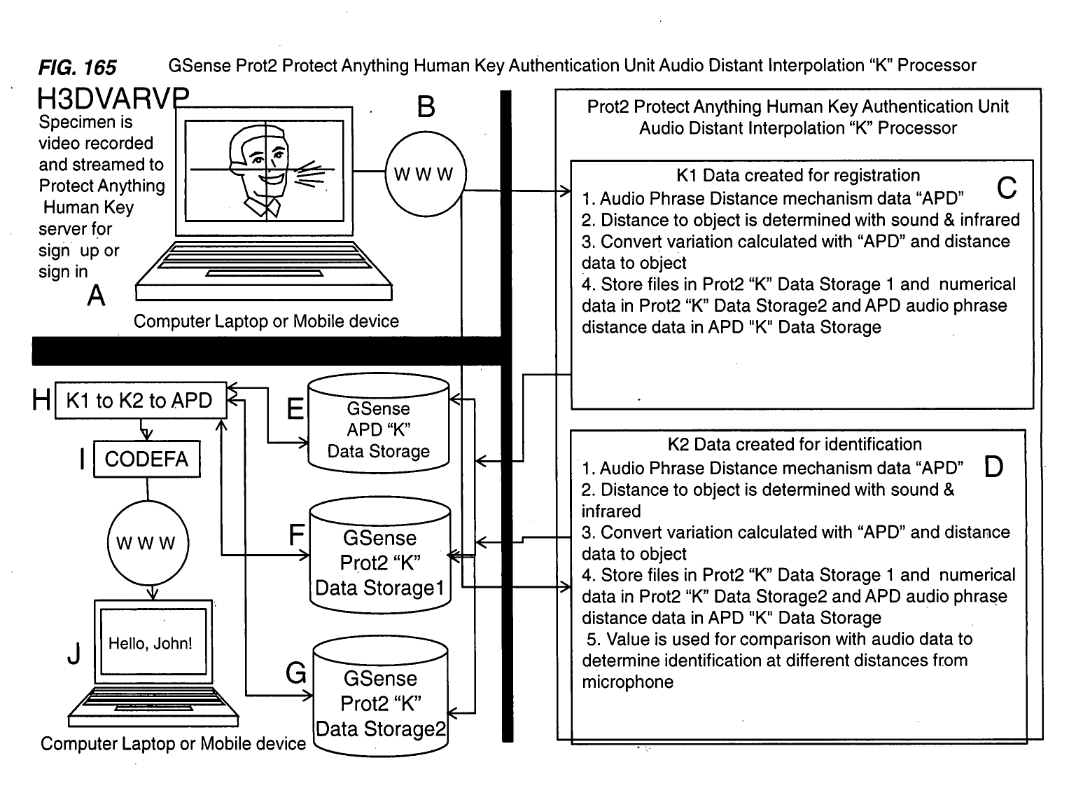

FIG. 165-A describes GSense Prot2 Protect Anything Human Key Authentication Unit Audio Distant Interpolation “K” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 165-B describes GSense Prot2 Protect Anything Human Key Authentication Unit Audio Distant Interpolation “K” Processor and shows where the W W W or World Wide Web is used for data aggregation and comparison analysis methods.

FIG. 165-C describes GSense Prot2 Protect Anything Human Key Authentication Unit Audio Distant Interpolation “K” Processor and shows where the Prot2 Protect Anything Human Key Authentication Unit Audio Distant Interpolation “K” Processor K1 Data created for registration, 1. Audio Phrase Distance mechanism data “APD”, 2. Distance to object is determined with sound & infrared, 3. Converts variation calculated with “APD” and distance data to object, 4. Stores files in Prot2 “K” Data Storage 1 and numerical data in Prot2 “K” Data Storage2 and APD audio phrase distance data in APD “K” Data Storage.

FIG. 165-D describes GSense Prot2 Protect Anything Human Key Authentication Unit Audio Distant Interpolation “K” Processor and shows where the Prot2 Protect Anything Human Key Authentication Unit Audio Distant Interpolation “K” Processor K2 Data created for identification, 1. Audio Phrase Distance mechanism data “APD”, 2. Distance to object is determined with sound & infrared, 3. Converts variation calculated with “APD” and distance data to object, 4. Stores files in Prot2 “K” Data Storage 1 and numerical data in Prot2 “K” Data Storage2 and APD audio phrase distance data in APD “K” Data Storage, 5. Where value is used for comparison with audio data to determine identification at different distances from microphone.

FIG. 165-E describes GSense Prot2 Protect Anything Human Key Authentication Unit Audio Distant Interpolation “K” Processor and shows the GSense APD “K” Data Storage.

FIG. 165-F describes GSense Prot2 Protect Anything Human Key Authentication Unit Audio Distant Interpolation “K” Processor and shows the GSense Prot2 “K” Data Storage1.

FIG. 165-G describes GSense Prot2 Protect Anything Human Key Authentication Unit Audio Distant Interpolation “K” Processor and shows the GSense Prot2 “K” Data Storage2.

FIG. 165-H describes GSense Prot2 Protect Anything Human Key Authentication Unit Audio Distant Interpolation “K” Processor and shows where the APD to K1 to K2 to APD Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 165-I describes GSense Prot2 Protect Anything Human Key Authentication Unit Audio Distant Interpolation “K” Processor and shows the Protect Anything CODEFA mechanism that provides storage, security, human key and tracking features.

FIG. 165-J describes GSense Prot2 Protect Anything Human Key Authentication Unit Audio Distant Interpolation “K” Processor and shows where the W W W or World Wide Web is used for data aggregation and comparison analysis methods Hello, John! Computer Laptop or Mobile device.

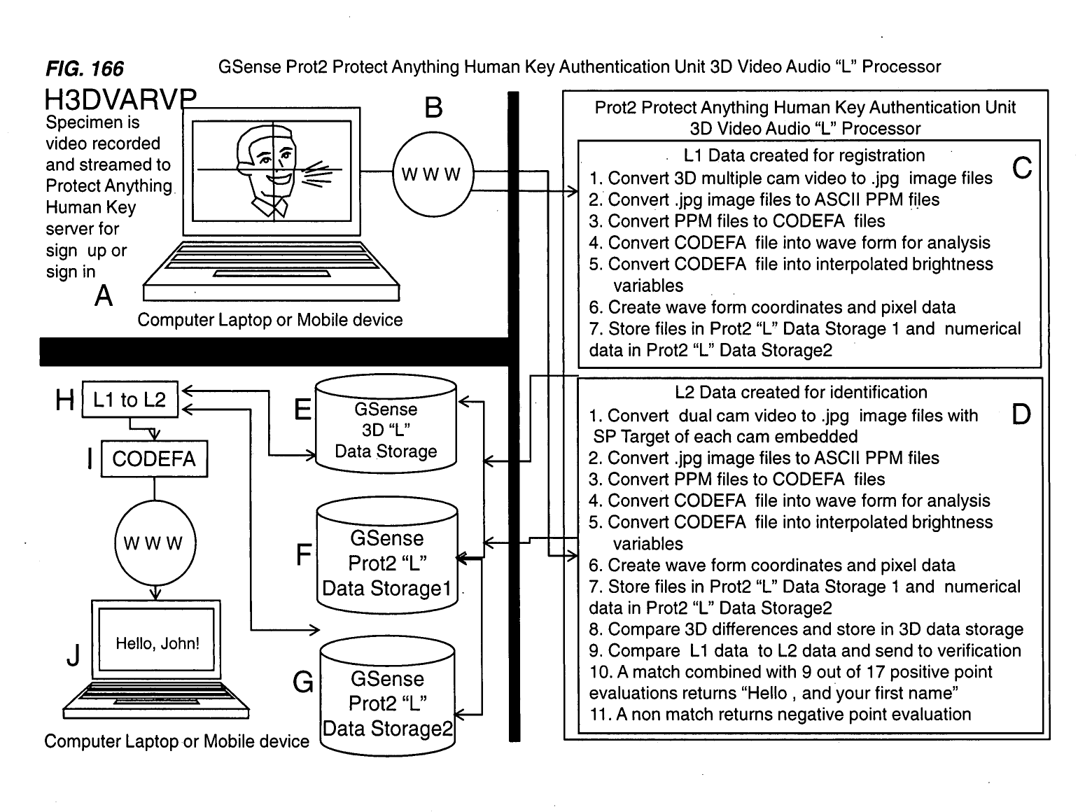

FIG. 166-A describes GSense Prot2 Protect Anything Human Key Authentication Unit 3D Video Audio “L” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 166-B describes GSense Prot2 Protect Anything Human Key Authentication Unit 3D Video Audio “L” Processor and shows where the W W W or World Wide Web is used for data aggregation and comparison analysis methods.

FIG. 166-C describes GSense Prot2 Protect Anything Human Key Authentication Unit 3D Video Audio “L” Processor and shows where the Prot2 Protect Anything Human Key Authentication Unit3D Video Audio “L” Processor L1 Data created for registration, 1. Converts 3D multiple cam video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “L” Data Storage 1 and numerical data in Prot2 “L” Data Storage2.

FIG. 166-D describes GSense Prot2 Protect Anything Human Key Authentication Unit 3D Video Audio “L” Processor and shows where the Prot2 Protect Anything Human Key Authentication Unit3D Video Audio “L” Processor L2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “L” Data Storage 1 and numerical data in Prot2 “L” Data Storage2, 8. Compares 3D differences and store in 3D data storage, 9. Compares L1 data to L2 data and send to verification, 10. Where a match combined with 9 out of 16 positive point evaluations returns “Hello, and your first name” 11. Where a non match returns negative point evaluation.

FIG. 166-E describes GSense Prot2 Protect Anything Human Key Authentication Unit 3D Video Audio “L” Processor and shows the GSense 3D “L” Data Storage.

FIG. 166-F describes GSense Prot2 Protect Anything Human Key Authentication Unit 3D Video Audio “L” Processor and shows the GSense Prot2 “L” Data Storage1.

FIG. 166-G describes GSense Prot2 Protect Anything Human Key Authentication Unit 3D Video Audio “L” Processor and shows the GSense Prot2 “L” Data Storage2.

FIG. 166-H describes GSense Prot2 Protect Anything Human Key Authentication Unit 3D Video Audio “L” Processor and shows where the L1 to L2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 166-I describes GSense Prot2 Protect Anything Human Key Authentication Unit 3D Video Audio “L” Processor and shows the Protect Anything CODEFA mechanism that provides storage, security, human key and tracking features.

FIG. 166-J describes GSense Prot2 Protect Anything Human Key Authentication Unit 3D Video Audio “L” Processor and shows where the W W W or World Wide Web is used for data aggregation and comparison analysis methods Hello, John! Computer Laptop or Mobile device.

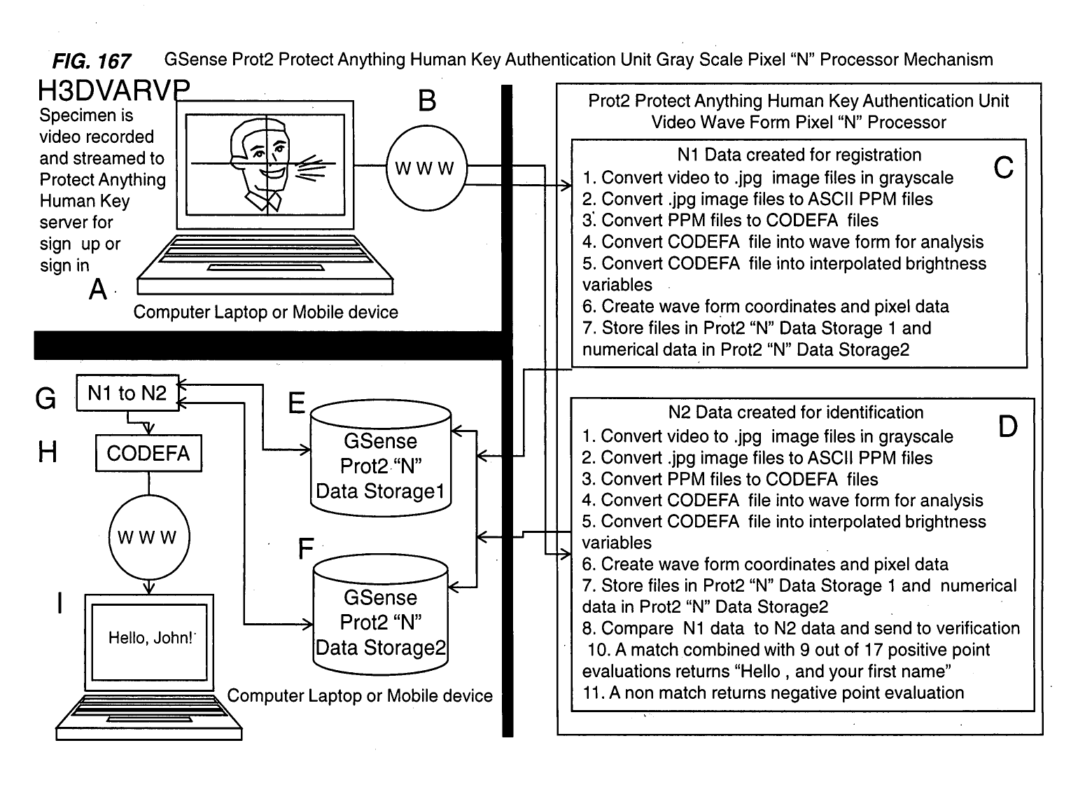

FIG. 167-A describes GSense Prot2 Protect Anything Human Key Authentication Unit Gray Scale Pixel “N” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 167-B describes GSense Prot2 Protect Anything Human Key Authentication Unit Gray Scale Pixel “N” Processor Mechanism and shows where the W W W or World Wide Web is used for data aggregation and comparison analysis methods.

FIG. 167-C describes GSense Prot2 Protect Anything Human Key Authentication Unit Gray Scale Pixel “N” Processor Mechanism and shows where the Prot2 Protect Anything Human Key Authentication Unit Video Wave Form. Pixel “N” Processor N1 Data created for registration, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage; security, human key and tracking features file into interpolated brightness variables, 6. Creates wave form coordinates and pixel data, 7. Stores files in Prot2 “N” Data Storage 1 and numerical data in Prot2 “N” Data Storage2.

FIG. 167-D describes GSense Prot2 Protect Anything Human Key Authentication Unit Gray Scale Pixel “N” Processor Mechanism and shows where the Prot2 Protect Anything Human Key Authentication Unit Video Wave Form Pixel “N” Processor N2 Data created for identification, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “N” Data Storage 1 and numerical data in Prot2 “N” Data Storage2, 8. Compares N1 data to N2 data and send to verification, 10. Where a match combined with 9 out of 16 positive point evaluations returns “Hello, and your first name” 11. Where a non match returns negative point evaluation.

FIG. 167-E describes GSense Prot2 Protect Anything Human Key Authentication Unit Gray Scale Pixel “N” Processor Mechanism and shows the GSense Prot2 “N” Data Storage1.

FIG. 167-F describes GSense Prot2 Protect Anything Human Key Authentication Unit Gray Scale Pixel “N” Processor Mechanism and shows the GSense Prot2 “N” Data Storage2.

FIG. 167-G describes GSense Prot2 Protect Anything Human Key Authentication Unit Gray Scale Pixel “N” Processor Mechanism and shows where the N1 to N2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 167-H describes GSense Prot2 Protect Anything Human Key Authentication Unit Gray Scale Pixel “N” Processor Mechanism and shows the Protect Anything CODEFA mechanism that provides storage, security, human key and tracking features.

FIG. 167-I describes GSense Prot2 Protect Anything Human Key Authentication Unit Gray Scale Pixel “N” Processor Mechanism and shows where the W W W or World Wide Web is used for data aggregation and comparison analysis methods Hello, John! Computer Laptop or Mobile device.

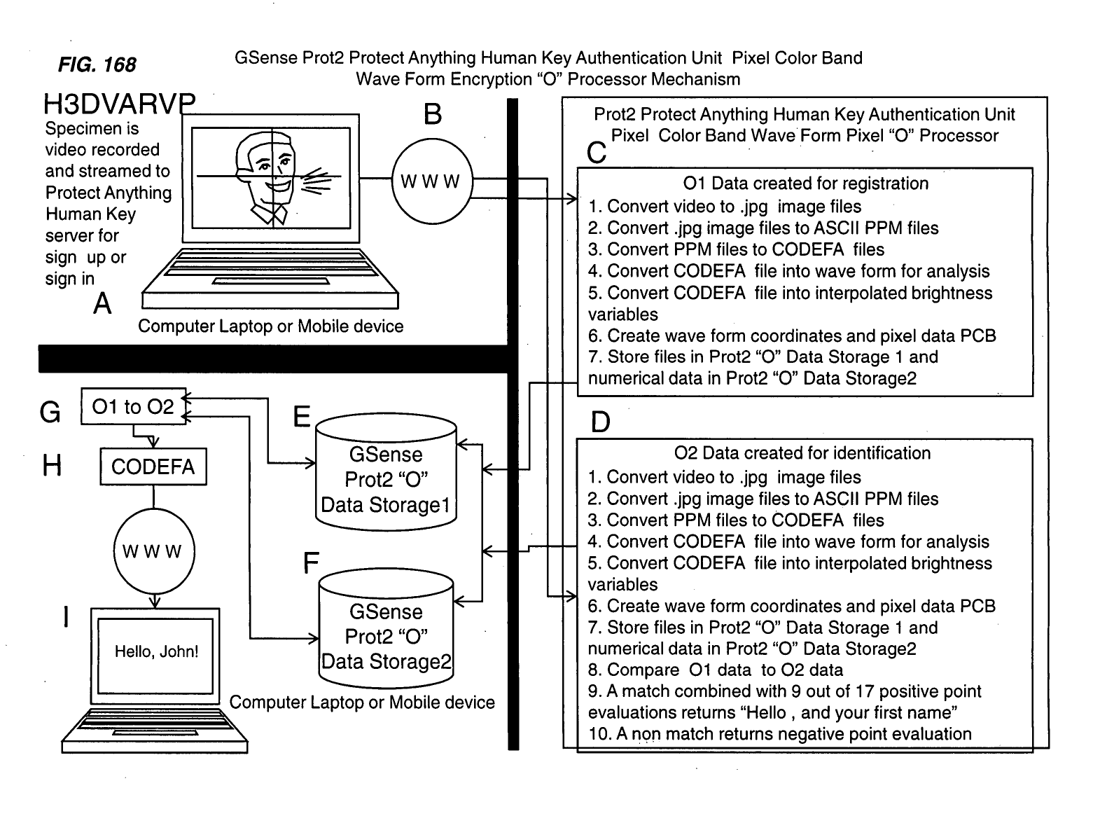

FIG. 168-A describes GSense Prot2 Protect Anything Human Key Authentication Unit Pixel Color Band Wave Form Encryption “O” Area Processor Method and Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 168-B describes GSense Prot2 Protect Anything Human Key Authentication Unit Pixel Color Band Wave Form Encryption “O” Area Processor Method and Mechanism and shows where the W W W or World Wide Web is used for data aggregation and comparison analysis methods.

FIG. 168-C describes GSense Prot2 Protect Anything Human Key Authentication Unit Pixel Color Band Wave Form Encryption “O” Area Processor Method and Mechanism and shows where the Prot2 Protect Anything Human Key Authentication Unit Pixel Color Band Wave Form Pixel “O” Processor O1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data PCB, 7. Stores files in Prot2 “O” Data Storage 1 and numerical data in Prot2 “O” Data Storage2.

FIG. 168-D describes GSense Prot2 Protect Anything Human Key Authentication Unit Pixel Color Band Wave Form Encryption “O” Area Processor Method and Mechanism and shows where the Prot2 Protect Anything Human Key Authentication Unit Pixel Color Band Wave Form Pixel “O” Processor O2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data PCB, 7. Stores files in Prot2 “O” Data Storage 1 and numerical data in Prot2 “O” Data Storage2, 8. Compares O1 data to O2 data, 9. Where a match combined with 9 out of 16 positive point evaluations returns “Hello, and your first name”, 10. Where a non match returns negative point evaluation.

FIG. 168-E describes GSense Prot2 Protect Anything Human Key Authentication Unit Pixel Color Band Wave Form Encryption “O” Area Processor Method and Mechanism and shows the GSense Prot2 “O” Data Storage1.

FIG. 168-F describes GSense Prot2 Protect Anything Human Key Authentication Unit Pixel Color Band Wave Form Encryption “O” Area Processor Method and Mechanism and shows the GSense Prot2 “O” Data Storage2.

FIG. 168-G describes GSense Prot2 Protect Anything Human Key Authentication Unit Pixel Color Band Wave Form Encryption “O” Area Processor Method and Mechanism and shows where the O1 to O2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 168-H describes GSense Prot2 Protect Anything Human Key Authentication Unit Pixel Color Band Wave Form Encryption “O” Area Processor Method and Mechanism and shows the Protect Anything CODEFA mechanism that provides storage, security, human key and tracking features.

FIG. 168-I describes GSense Prot2 Protect Anything Human Key Authentication Unit Pixel Color Band Wave Form Encryption “O” Area Processor Method and Mechanism and shows where the W W W or World Wide Web is used for data aggregation and comparison analysis methods Hello, John! Computer Laptop or Mobile device.

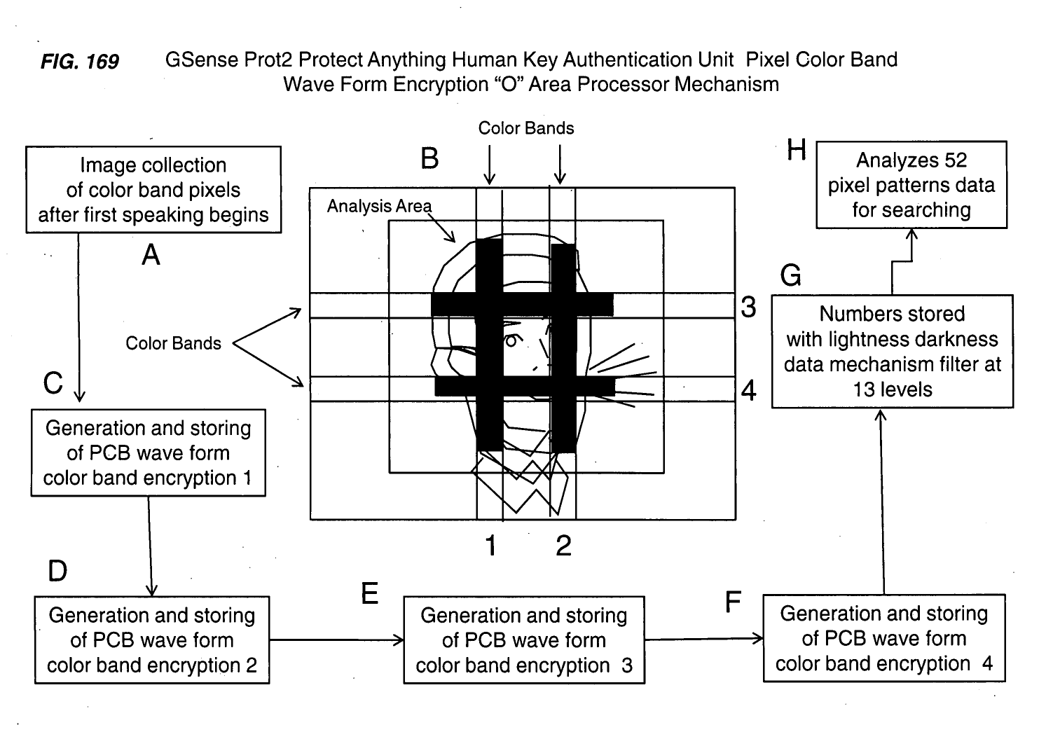

FIG. 169-A describes GSense Prot2 Protect Anything Human Key Authentication Unit Pixel Color Band Wave Form Encryption “O” Area Processor Mechanism and shows where the Image collection of color band pixels begins after first audio speaking phrase begins.

FIG. 169-B describes GSense Prot2 Protect Anything Human Key Authentication Unit Pixel Color Band Wave Form Encryption “O” Area Processor Mechanism and shows where analysis Area Color Bands begins.

FIG. 169-C describes GSense Prot2 Protect Anything Human Key Authentication Unit Pixel Color Band Wave Form Encryption “O” Area Processor Mechanism and shows the Generation and storing of PCB wave form color band encryption 1.

FIG. 169-D describes GSense Prot2 Protect Anything Human Key Authentication Unit Pixel Color Band Wave Form Encryption “O” Area Processor Mechanism and shows the Generation and storing of PCB wave form color band encryption 2.

FIG. 169-E describes GSense Prot2 Protect Anything Human Key Authentication Unit Pixel Color Band Wave Form Encryption “O” Area Processor Mechanism and shows the Generation and storing of PCB wave form color band encryption 3.

FIG. 169-F describes GSense Prot2 Protect Anything Human Key Authentication Unit Pixel Color Band Wave Form Encryption “O” Area Processor Mechanism and shows the Generation and storing of PCB wave form color band encryption 4.

FIG. 169-G describes GSense Prot2 Protect Anything Human Key Authentication Unit Pixel Color Band Wave Form Encryption “O” Area Processor Mechanism and shows where the data numbers are stored with lightness darkness data mechanism filter are aggregated at 13 levels.

FIG. 169-H describes GSense Prot2 Protect Anything Human Key Authentication Unit Pixel Color Band Wave Form Encryption “O” Area Processor Mechanism and shows where mechanism analyzes 52 pixel patterns image data for searching.

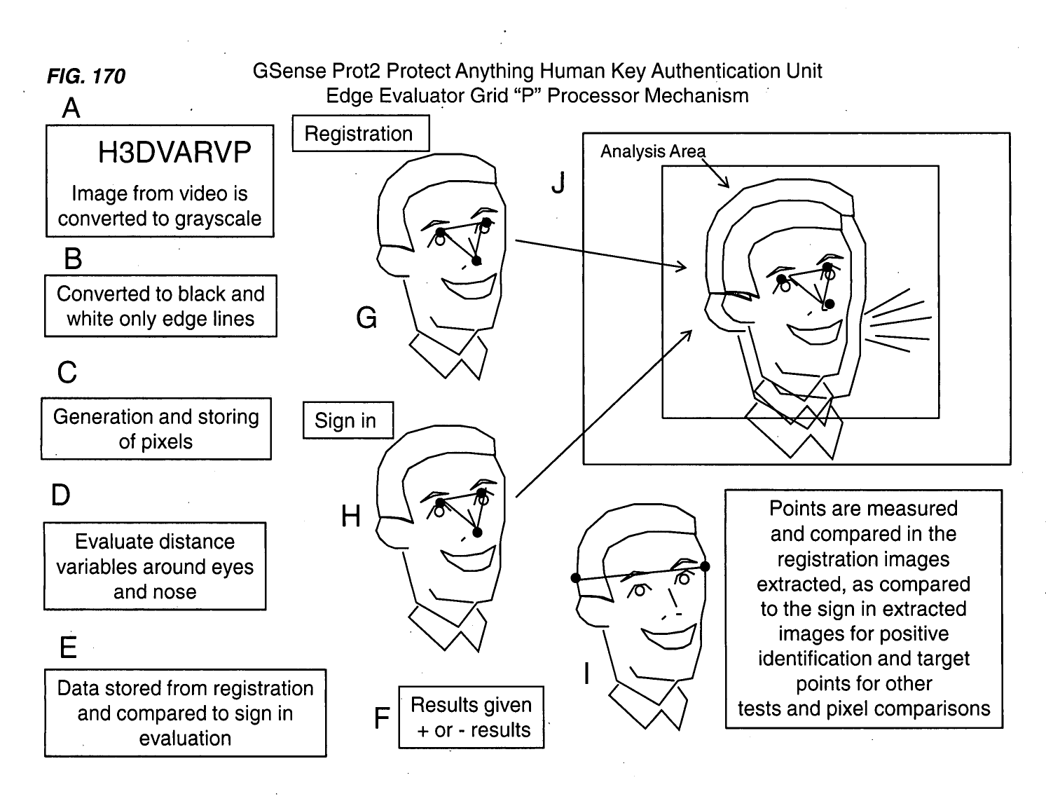

FIG. 170-A describes GSense Prot2 Protect Anything Human Key Authentication Unit Edge Evaluator Grid “P” Processor Mechanism with H3DVARV 3D Human Video Audio Stereo Viewing and Recording Mechanism and shows where the Image from video is converted to grayscale.

FIG. 170-B describes GSense Prot2 Protect Anything Human Key Authentication Unit Edge Evaluator Grid “P” Processor Mechanism and shows where the extracted image is converted to black and white only edge lines.

FIG. 170-C describes GSense Prot2 Protect Anything Human Key Authentication Unit Edge Evaluator Grid “P” Processor Mechanism and shows where the data is generated and the storing of pixels data.

FIG. 170-D describes GSense Prot2 Protect Anything Human Key Authentication Unit Edge Evaluator Grid “P” Processor Mechanism and shows where the evaluate distance data variables are aggregated from around subjects eyes and nose.

FIG. 170-E describes GSense Prot2 Protect Anything Human Key Authentication Unit Edge Evaluator Grid “P” Processor Mechanism and shows where the Data is stored from registration and compared with sign in data for evaluation.

FIG. 170-F describes GSense Prot2 Protect Anything Human Key Authentication Unit Edge Evaluator Grid “P” Processor Mechanism and shows where the Results are given with + or − results + is a positive match and − is a negative match.

FIG. 170-G describes GSense Prot2 Protect Anything Human Key Authentication Unit Edge Evaluator Grid “P” Processor Mechanism and shows where the Registration triangulation is made between the eyes and the nose for calculations and pattern matching identification.

FIG. 170-H describes GSense Prot2 Protect Anything Human Key Authentication Unit Edge Evaluator Grid “P” Processor Mechanism and shows where the Sign In triangulation is made between the eyes and the nose for calculations and pattern matching identification.

FIG. 170-I describes GSense Prot2 Protect Anything Human Key Authentication Unit Edge Evaluator Grid “P” Processor Mechanism and shows where the Points are measured and compared in the registration images extracted, as compared to the sign in extracted images for positive identification and target points for other tests and pixel comparisons.

FIG. 170-J describes GSense Prot2 Protect Anything Human Key Authentication Unit Edge Evaluator Grid “P” Processor Mechanism and shows the analysis Area with the triangulation data and edge analysis overlay area.

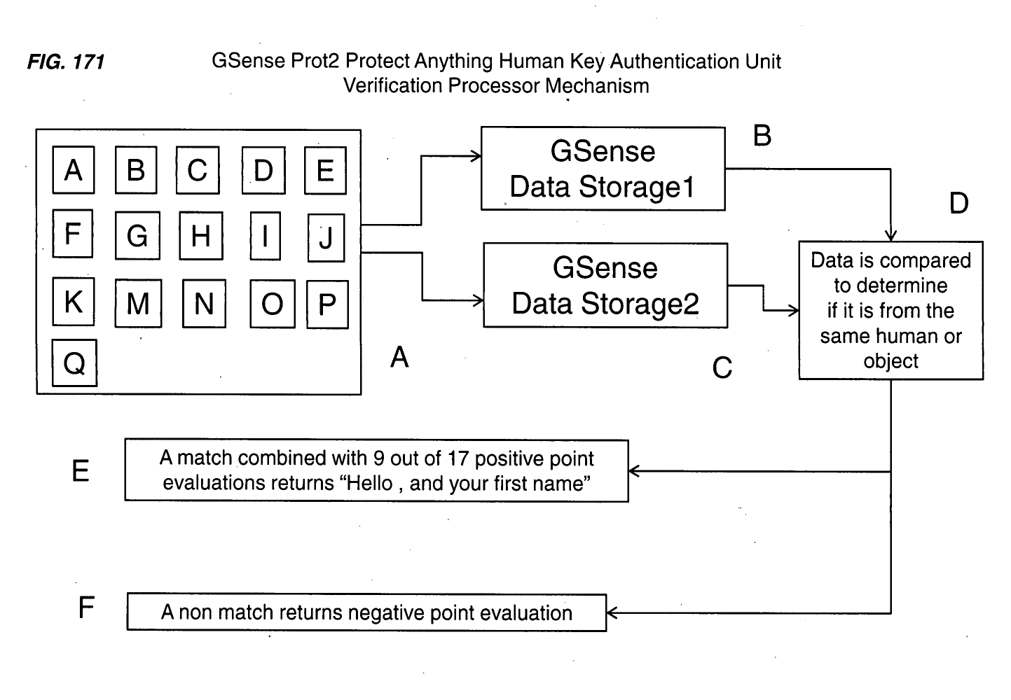

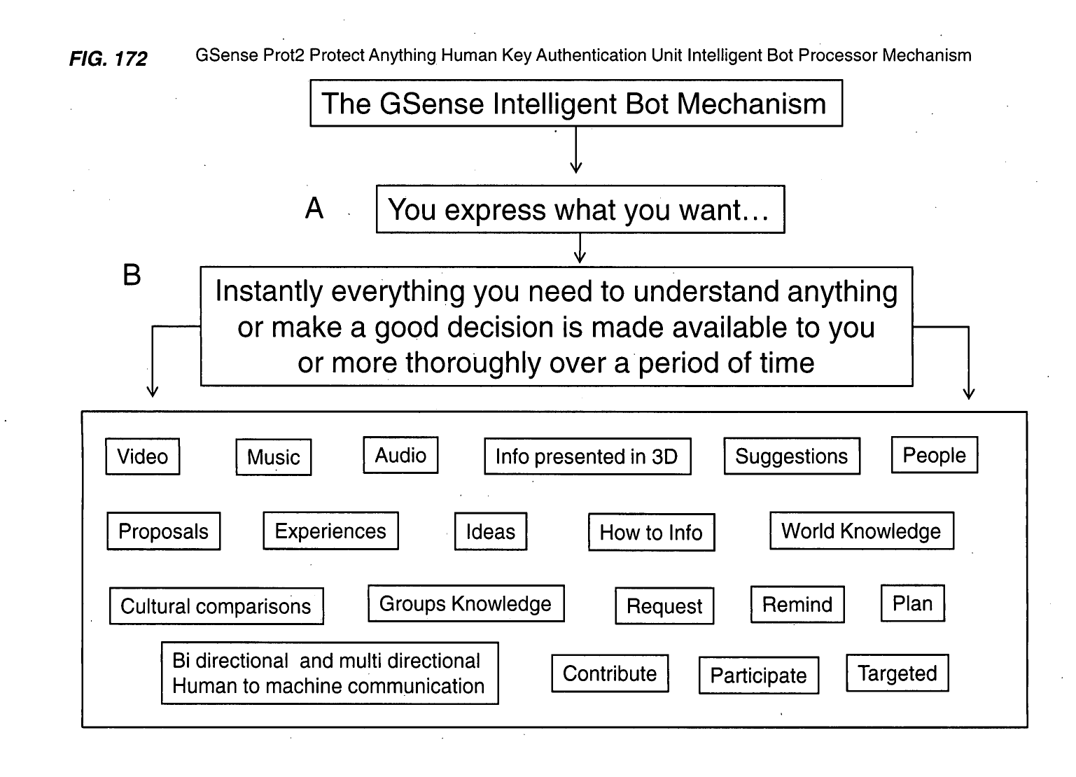

FIG. 171-A describes GSense Prot2 Protect Anything Human Key Authentication Unit Verification Processor Mechanism and shows where all the processors are evaluated.

FIG. 171-B describes GSense Prot2 Protect Anything Human Key Authentication Unit Verification Processor Mechanism and shows the GSense Data Storage1.

FIG. 171-C describes GSense Prot2 Protect Anything Human Key Authentication Unit Verification Processor Mechanism and shows the GSense Data Storage2.

FIG. 171-D describes GSense Prot2 Protect Anything Human Key Authentication Unit Verification Processor Mechanism and shows where the Data is compared to determine if it is from the same human or object.

FIG. 171-E describes GSense Prot2 Protect Anything Human Key Authentication Unit Verification Processor Mechanism and shows where a match combined with 9 out of 16 positive point evaluations returns “Hello, and your first name”.

FIG. 171-F describes GSense Prot2 Protect Anything Human Key Authentication Unit Verification Processor Mechanism and shows where a non match returns negative point evaluation.

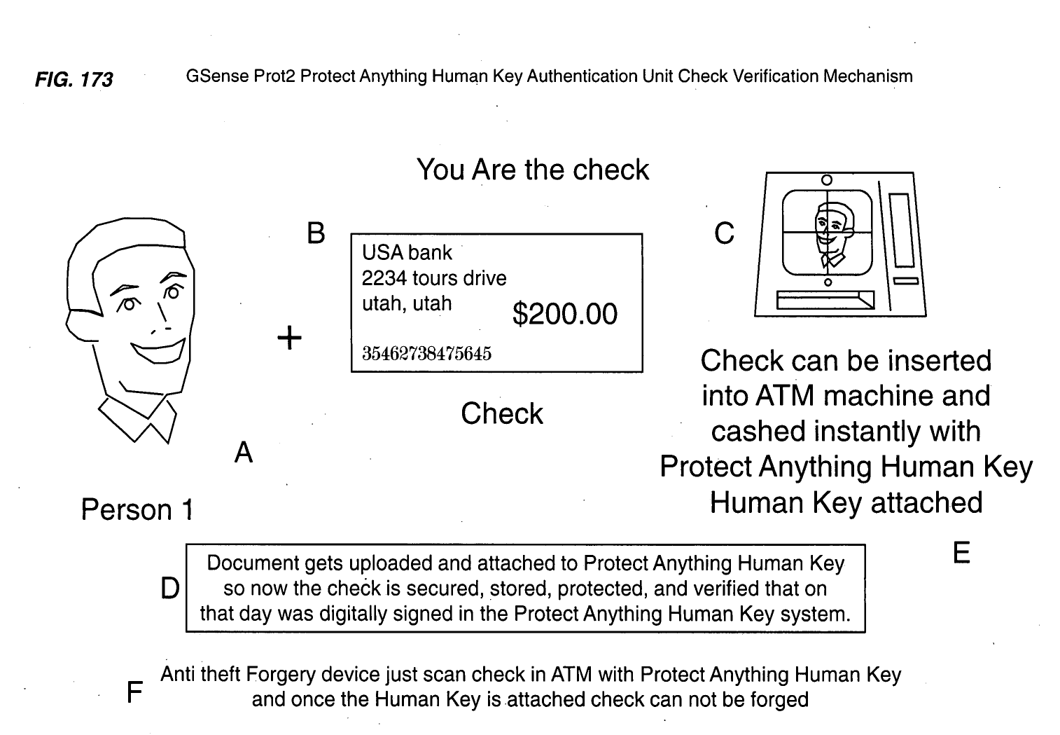

FIG. 173-A describes GSense Prot2 Protect Anything Human Key Authentication Unit Intelligent Bot Processor Mechanism and shows where the GSense Intelligent Bot Mechanism lets you express what you want . . . .

FIG. 173-B describes GSense Prot2 Protect Anything Human Key Authentication Unit Intelligent Bot Processor Mechanism and shows where the system instantly knows everything when you need to understand anything or make a good decision and is made available to you, machines or objects thoroughly over a period of time.

FIG. 173-C describes GSense Prot2 Protect Anything Human Key Authentication Unit Check Verification Mechanism and shows the Person 1.

FIG. 173-D describes GSense Prot2 Protect Anything Human Key Authentication Unit Check Verification Mechanism and shows where you Are the check USA bank 2234 tours drive utah, utah $200.00.

FIG. 173-E describes GSense Prot2 Protect Anything Human Key Authentication Unit Check Verification Mechanism and shows where the Check can be inserted into ATM machine and cashed instantly with Protect Anything Human Key Human Key attached.

FIG. 173-F describes GSense Prot2 Protect Anything Human Key Authentication Unit Check Verification Mechanism and shows where the Document gets uploaded and attached to Protect Anything Human Key so now the check is secured, stored, protected, and verified that on that day was digitally signed in the Protect Anything Human Key system. Anti theft Forgery device just scan check in ATM with Protect Anything Human Key and once the Human Key is attached check cannot be forged.

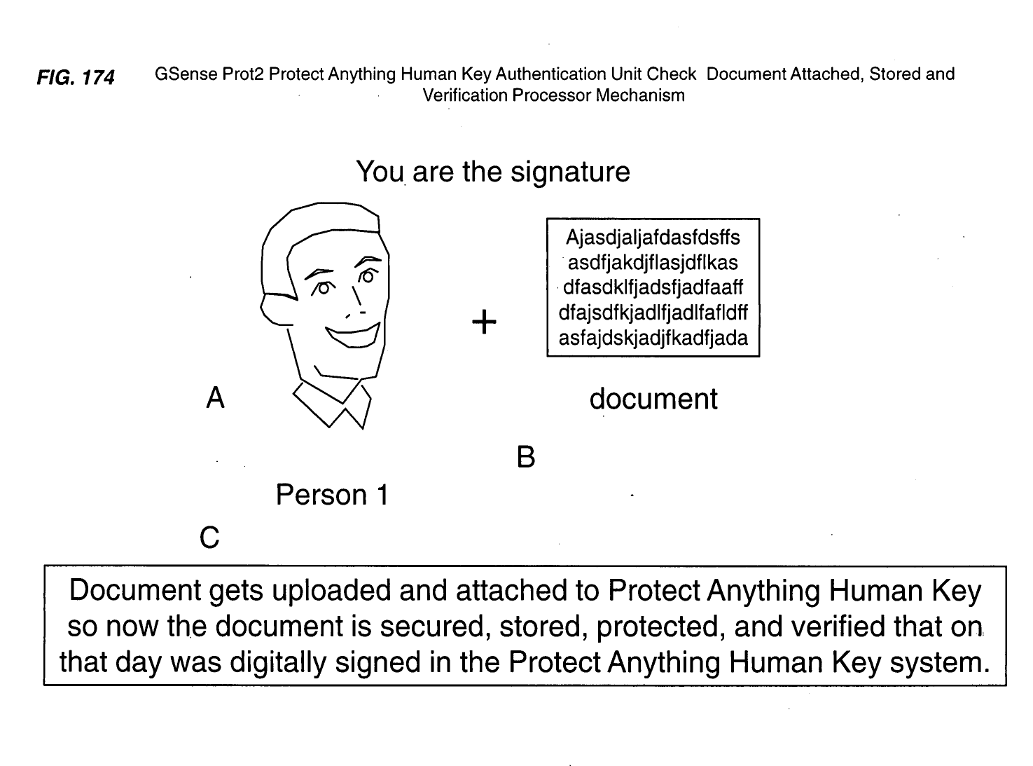

FIG. 174-A describes GSense Prot2 Protect Anything Human Key Authentication Unit Check Document Attached, Stored and Verification Processor Mechanism and shows where the Person 1 You are the signature.

FIG. 174-B describes GSense Prot2 Protect Anything Human Key Authentication Unit Check Document Attached, Stored and Verification Processor Mechanism and shows where you are the signature attached to documents.

FIG. 174-C describes GSense Prot2 Protect Anything Human Key Authentication Unit Check Document Attached, Stored and Verification Processor Mechanism and shows where the Document gets uploaded and attached to Protect Anything Human Key so now the document is secured, stored, protected, and verified that on that day was digitally signed in the Protect Anything Human Key system.

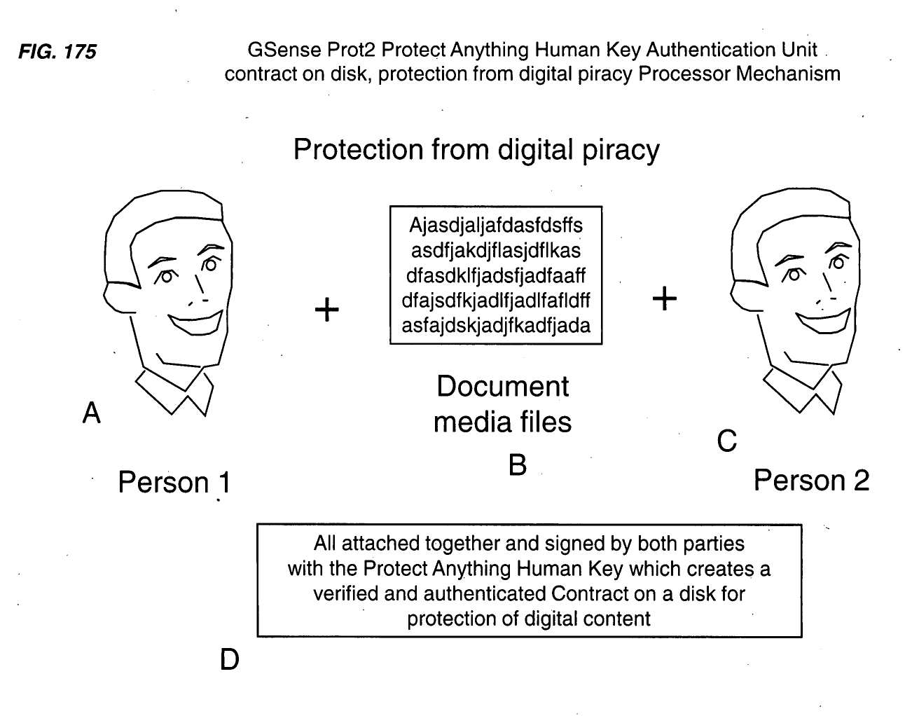

FIG. 175-D describes GSense Prot2 Protect Anything Human Key Authentication Unit contract on disk, protection from digital piracy Processor Mechanism and shows the Person 1.

FIG. 175-E describes GSense Prot2 Protect Anything Human Key Authentication Unit contract on disk, protection from digital piracy Processor Mechanism and shows the Document media files Protection from digital piracy.

FIG. 175-F describes GSense Prot2 Protect Anything Human Key Authentication Unit contract on disk, protection from digital piracy Processor Mechanism and shows the Person 2.

FIG. 175-G describes GSense Prot2 Protect Anything Human Key Authentication Unit contract on disk, protection from digital piracy Processor Mechanism and shows where all attached together and signed by both parties with the Protect Anything Human Key which creates a verified and authenticated Contract on a disk for protection of digital content.

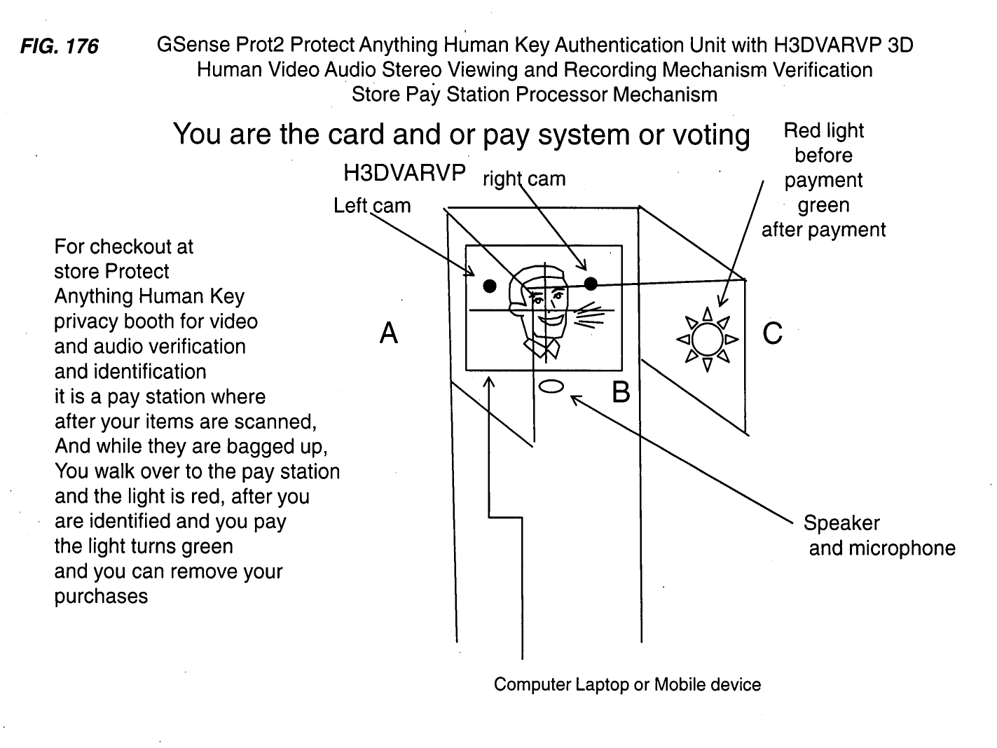

FIG. 176-A describes GSense Prot2 Protect Anything Human Key Authentication Unit Verification Store Pay Station Processor Mechanism with H3DVARV 3D Human Video Audio Stereo Viewing and Recording Mechanism and shows where you are the card and or pay system or voting For checkout at store Protect Anything Human Key privacy booth for video and audio verification and identification it is a pay station where after your items are scanned, And while they are bagged up, You walk over to the pay station and the light is red, after you are identified and you pay the light turns green and you can remove your purchases.

FIG. 176-B describes GSense Prot2 Protect Anything Human Key Authentication Unit Verification Store Pay Station Processor Mechanism and shows the flat panel display touch screen authentication display screen with speaker and microphone.

FIG. 176-C describes GSense Prot2 Protect Anything Human Key Authentication Unit Verification Store Pay Station Processor Mechanism and shows where the Computer Laptop or Mobile device Left cam, right cam, Red light before payment green after payment, Speaker and microphone.

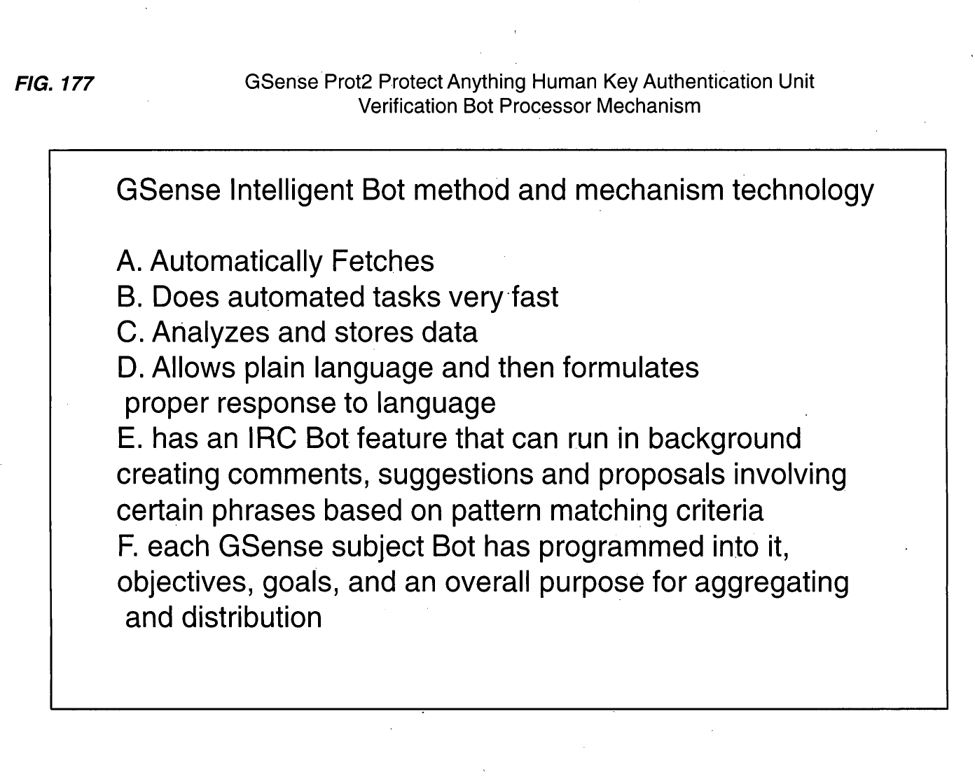

FIG. 177-A describes GSense Prot2 Protect Anything Human Key Authentication Unit Verification bot Processor Mechanism and shows where the GSense Intelligent Bot method and mechanism technology automatically Fetches.

FIG. 177-B describes GSense Prot2 Protect Anything Human Key Authentication Unit Verification bot Processor Mechanism and shows where the GSense Intelligent Bot method and mechanism technology does automated tasks very fast.

FIG. 177-C describes GSense Prot2 Protect Anything Human Key Authentication Unit Verification bot Processor Mechanism and shows where the GSense Intelligent Bot method and mechanism technology Analyzes and stores data.

FIG. 177-D describes GSense Prot2 Protect Anything Human Key Authentication Unit Verification bot Processor Mechanism and shows where the GSense Intelligent Bot method and mechanism technology Allows plain language and then formulates proper response to language.

FIG. 177-E describes GSense Prot2 Protect Anything Human Key Authentication Unit Verification bot Processor Mechanism and shows where the GSense Intelligent Bot method and mechanism technology has an IRC Bot feature that can run in background creating comments, suggestions and proposals involving certain phrases based on pattern matching criteria.

FIG. 177-F describes GSense Prot2 Protect Anything Human Key Authentication Unit Verification bot Processor Mechanism and shows where the GSense Intelligent Bot method and mechanism technology each GSense subject Bot has programmed into it, objectives, goals, and an overall purpose for aggregating and distribution.

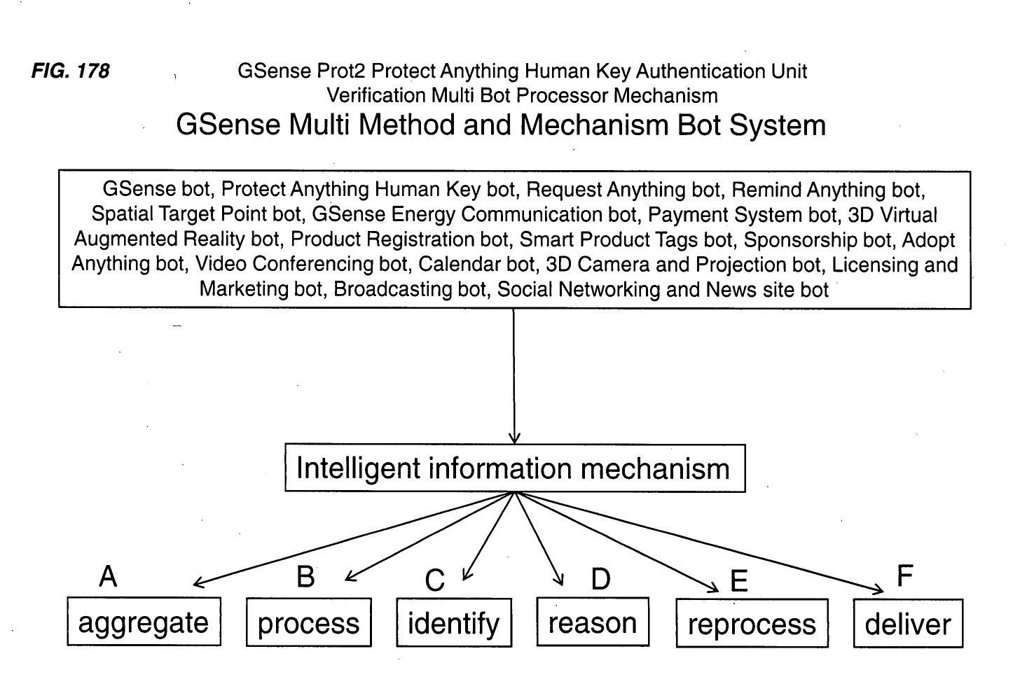

FIG. 178-A describes GSense Prot2 Protect Anything Human Key Authentication Unit Verification Multi Bot Processor Mechanism and shows where the GSense Multi Method and Mechanism Bot System GSense bot, Protect Anything Human Key bot, Request Anything bot, Remind Anything bot, Spatial Target Point bot, GSense Energy Communication bot, Payment System bot, 3D Virtual Augmented Reality bot, Product Registration bot, Smart Product Tags bot, Sponsorship bot, Adopt Anything bot, Video Conferencing bot, Calendar bot, 3D Camera and Projection bot, Licensing and Marketing bot, Broadcasting bot, Social Networking and News site bot Intelligent information mechanism to automatically aggregate targeted data and information.

FIG. 178-B describes GSense Prot2 Protect Anything Human Key Authentication Unit Verification Multi Bot Processor Mechanism and shows where the GSense Multi Method and Mechanism Bot System GSense bot, Protect Anything Human Key bot, Request Anything bot, Remind Anything bot, Spatial Target Point bot, GSense Energy Communication bot, Payment System bot, 3D Virtual Augmented Reality bot, Product Registration bot, Smart Product Tags bot, Sponsorship bot, Adopt Anything bot, Video Conferencing bot, Calendar bot, 3D Camera and Projection, bot, Licensing and Marketing bot, Broadcasting bot, Social Networking and News site bot Intelligent information mechanism to process data and information.

FIG. 178-C describes GSense Prot2 Protect Anything Human Key Authentication Unit Verification Multi Bot Processor Mechanism and shows where the GSense Multi Method and Mechanism Bot System GSense bot, Protect Anything Human Key bot, Request Anything bot, Remind Anything bot, Spatial Target Point bot, GSense Energy Communication bot, Payment System bot, 3D Virtual Augmented Reality bot, Product Registration bot, Smart Product Tags bot, Sponsorship bot, Adopt Anything bot, Video Conferencing bot, Calendar bot, 3D Camera and Projection bot, Licensing and Marketing bot, Broadcasting bot, Social Networking and News site bot Intelligent information mechanism to identify people and objects.

FIG. 178-D describes GSense Prot2 Protect Anything Human Key Authentication Unit Verification Multi Bot Processor Mechanism and shows where the GSense Multi Method and Mechanism Bot System GSense bot, Protect Anything Human Key bot, Request Anything bot, Remind Anything bot, Spatial Target Point bot, GSense Energy Communication bot, Payment System bot, 3D Virtual Augmented Reality bot, Product Registration bot, Smart Product Tags bot, Sponsorship bot, Adopt Anything bot, Video Conferencing bot, Calendar bot, 3D Camera and Projection bot, Licensing and Marketing bot, Broadcasting bot, Social Networking and News site bot Intelligent information mechanism to reason data and information.

FIG. 178-E describes GSense Prot2 Protect Anything Human Key Authentication Unit Verification Multi Bot Processor Mechanism and shows where the GSense Multi Method and Mechanism Bot System GSense bot, Protect Anything Human Key bot, Request. Anything bot, Remind Anything bot, Spatial Target Point bot, GSense Energy Communication bot, Payment System bot, 3D Virtual Augmented Reality bot, Product Registration bot, Smart Product Tags bot, Sponsorship bot, Adopt Anything bot, Video Conferencing bot, Calendar bot, 3D Camera and Projection bot, Licensing and Marketing bot, Broadcasting bot, Social Networking and News site bot Intelligent information mechanism to reprocess data and information.

FIG. 178-F describes GSense Prot2 Protect Anything Human Key Authentication Unit Verification Multi Bot Processor Mechanism and shows where the GSense Multi Method and Mechanism Bot System GSense bot, Protect Anything Human Key bot, Request Anything bot, Remind Anything bot, Spatial Target Point bot, GSense Energy Communication bot, Payment System bot, 3D Virtual Augmented Reality bot, Product Registration bot, Smart Product Tags bot, Sponsorship bot, Adopt Anything bot, Video Conferencing bot, Calendar bot, 3D Camera and Projection bot, Licensing and Marketing bot, Broadcasting bot, Social Networking and News site bot Intelligent information mechanism to deliver data and information.

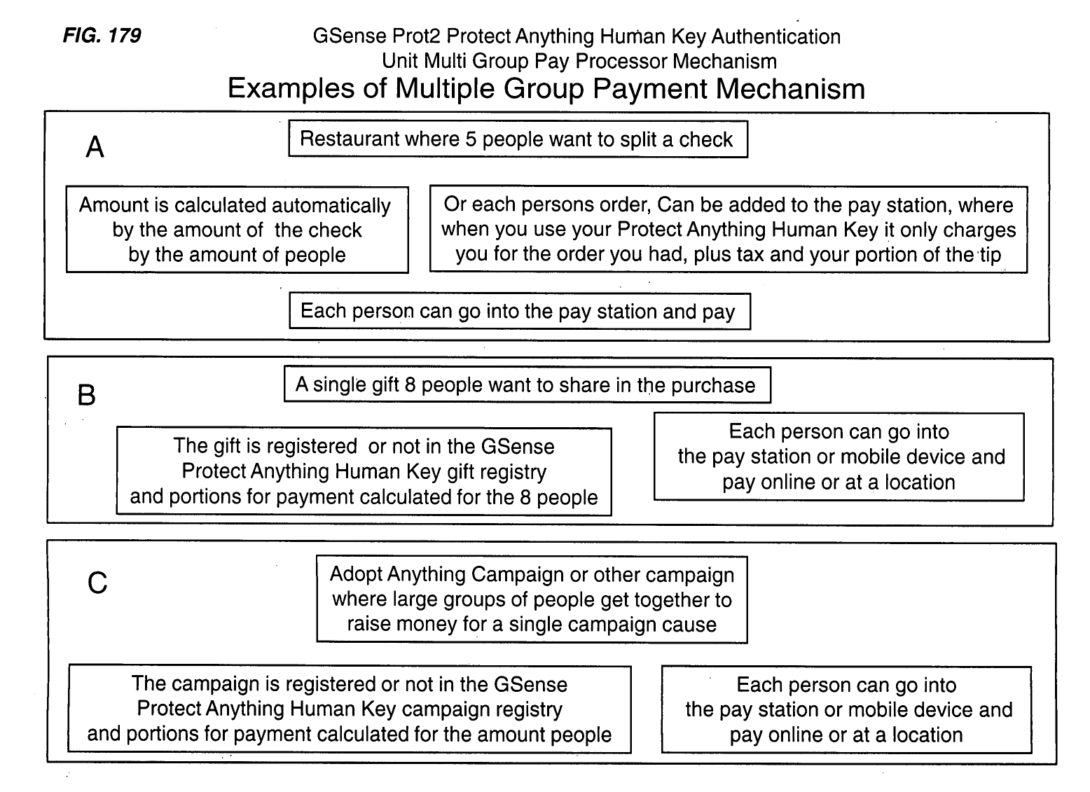

FIG. 179-A describes GSense Prot2 Protect Anything Human Key Authentication Unit Multi Group Pay Processor Mechanism and shows an example of Multiple Group Payment Mechanism where Restaurant where 5 people want to split a check Amount is calculated automatically by amount of the check by amount of people Or each person's order, Can be added to the pay station, where when you use your Protect Anything Human Key it only charges you for the order you had, plus tax and your portion of the tip Each person can go into the pay station and pay.

FIG. 179-B describes GSense Prot2 Protect Anything Human Key Authentication Unit Multi Group Pay Processor Mechanism and shows an example of Multiple Group Payment Mechanism A single gift 8 people want to share in the purchase The gift is registered or not in the GSense Protect Anything Human Key gift registry and portions for payment calculated for the 8 people Each person can go into the pay station or mobile device and pay online or at the purchase location.

FIG. 179-C describes GSense Prot2 Protect Anything Human Key Authentication Unit Multi Group Pay Processor Mechanism and shows an example of Multiple Group Payment Mechanism Adopt Anything Campaign or other campaign where large groups of people get together to raise money for a single campaign cause The campaign is registered or not in the GSense Protect Anything Human Key campaign registry and portions for payment calculated for the amount people Each person can go into the pay station or mobile device and pay online or at a location.

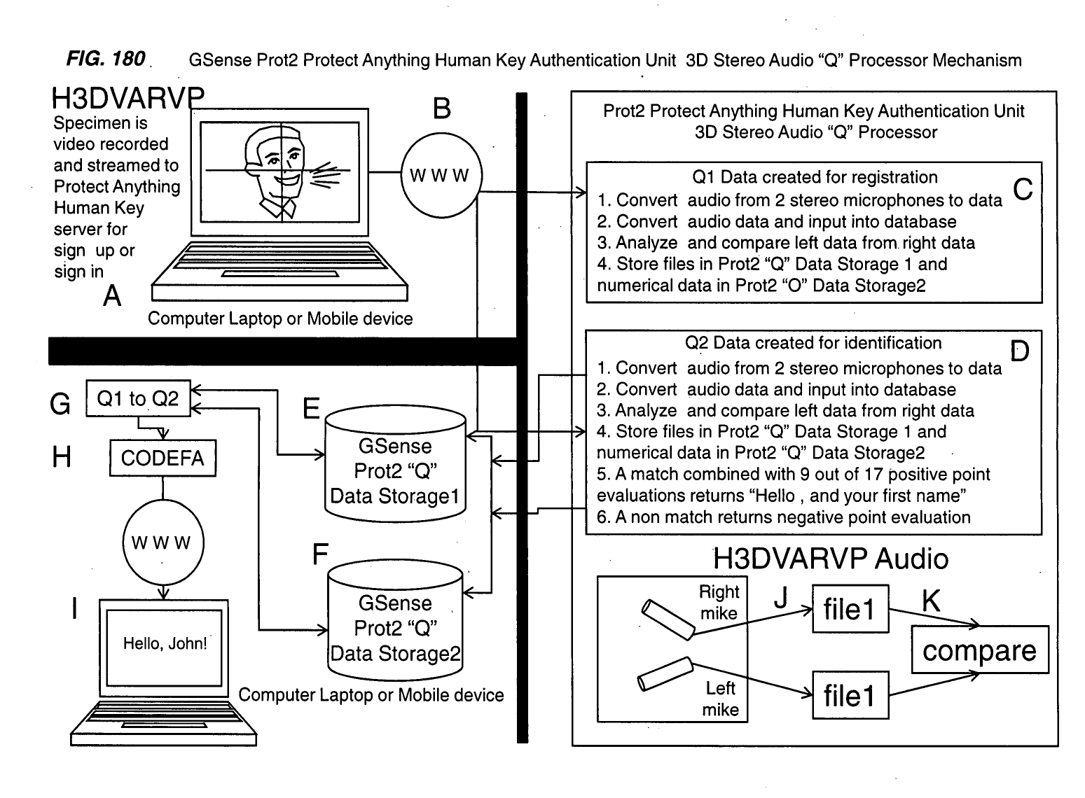

FIG. 180-A describes GSense Prot2 Protect Anything Human Key Authentication Unit 3D Stereo Audio “Q” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 180-B describes GSense Prot2 Protect Anything Human Key Authentication Unit 3D Stereo Audio “Q” Processor Mechanism and shows where the W W W or World Wide Web is used for data aggregation and comparison analysis methods.

FIG. 180-C describes GSense Prot2 Protect Anything Human Key Authentication Unit 3D Stereo Audio “Q” Processor Mechanism and shows where the Prot2 Protect Anything Human Key Authentication Unit 3D Stereo Audio “Q” Processor Q1 Data created for registration, 1. Converts audio from 2 stereo microphones to data, 2. Converts audio data and input into database, 3. Analyzes and compares left data from right data, 4. Stores files in Prot2 “0” Data Storage 1 and numerical data in Prot2 “0” Data Storage2.

FIG. 180-D describes GSense Prot2 Protect Anything Human Key Authentication Unit 3D Stereo Audio “Q” Processor Mechanism and shows where the Prot2 Protect Anything Human Key Authentication Unit 3D Stereo Audio “Q” Processor Q2 Data created for identification, 1. Converts audio from 2 stereo microphones to data, 2. Converts audio data and input into database, 3. Analyzes and compares left data from right data, 4. Stores files in Prot2 “Q” Data Storage 1 and numerical data in Prot2 “0” Data Storage2, 5. Where a match combined with 9 out of 16 positive point evaluations returns “Hello, and your first name”, 6. Where a non match returns negative point evaluation.

FIG. 180-E describes GSense Prot2 Protect Anything Human Key Authentication Unit 3D Stereo Audio “Q” Processor Mechanism and shows the GSense Prot2 “Q” Data Storage1.

FIG. 180-F describes GSense Prot2 Protect Anything Human Key Authentication Unit 3D Stereo Audio “Q” Processor Mechanism and shows the GSense Prot2 “Q” Data Storage2.

FIG. 180-G describes GSense Prot2 Protect Anything Human Key Authentication Unit 3D Stereo Audio “Q” Processor Mechanism and shows where the Q1 to Q2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 180-H describes GSense Prot2 Protect Anything Human Key Authentication Unit 3D Stereo Audio “Q” Processor Mechanism and shows the Protect Anything CODEFA mechanism that provides storage, security, human key and tracking features.

FIG. 180-I describes GSense Prot2 Protect Anything Human Key Authentication Unit 3D Stereo Audio “Q” Processor Mechanism and shows where the W W W or World Wide Web is used for data aggregation and comparison analysis methods Hello, John! Computer Laptop or Mobile device.

FIG. 180-J describes GSense Prot2 Protect Anything Human Key Authentication Unit 3D Stereo Audio “Q” Processor Mechanism and shows where the right microphone and left microphone creates and aggregates into separate files file 1 and file 2

FIG. 180-K describes GSense Prot2 Protect Anything Human Key Authentication Unit Vector Line Overlay to Grid Form Pixel Analysis “M” Processor Mechanism with H3DVARV 3D Human Video Audio Stereo Viewing and Recording Mechanism and shows where and the 2 3D Stereo audio files, file 1 and file 2 are overlaid and converted to pixel data and compared.

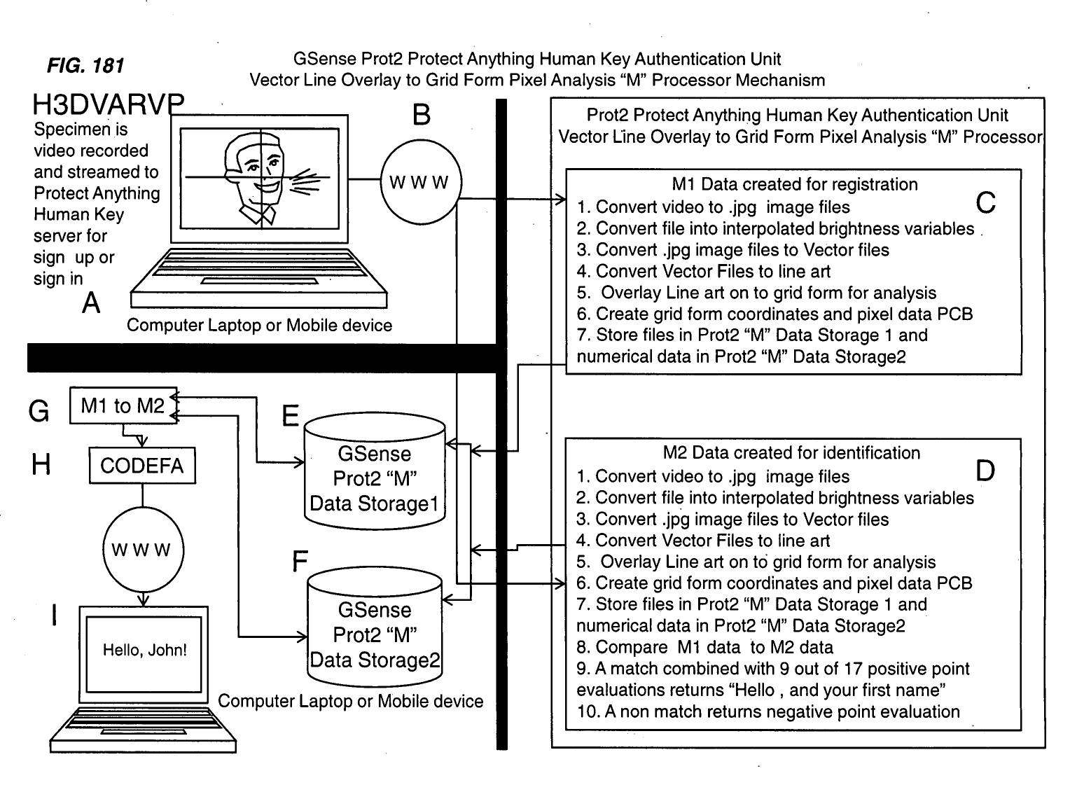

FIG. 181-A describes GSense Prot2 Protect Anything Human Key Authentication Unit Vector Line Overlay to Grid Form Pixel Analysis “M” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 181-B describes GSense Prot2 Protect Anything Human Key Authentication Unit Vector Line Overlay to Grid Form Pixel Analysis “M” Processor Mechanism and shows where the W W W or World Wide Web is used for data aggregation and comparison analysis methods.

FIG. 181-C describes GSense Prot2 Protect Anything Human Key Authentication Unit Vector Line Overlay to Grid Form Pixel Analysis “M” Processor Mechanism and shows where the Prot2 Protect Anything Human Key Authentication Unit Vector Line Overlay to Grid Form Pixel Analysis “M” Processor M1 Data created for registration, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “M” Data Storage 1 and numerical data in Prot2 “M” Data Storage2.

FIG. 181-D describes GSense Prot2 Protect Anything Human Key Authentication Unit Vector Line Overlay to Grid Form Pixel Analysis “M” Processor Mechanism and shows where the Prot2 Protect Anything Human Key Authentication Unit Vector Line Overlay to Grid Form Pixel Analysis “M” Processor M2 Data created for identification, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “M” Data Storage 1 and numerical data in Prot2 “M” Data Storage2, 8. Compares M1 data to M2 data, 9. Where a match combined with 9 out of 16 positive point evaluations returns “Hello, and your first name”, 10. Where a non match returns negative point evaluation.

FIG. 181-E describes GSense Prot2 Protect Anything Human Key Authentication Unit Vector Line Overlay to Grid Form Pixel Analysis “M” Processor Mechanism and shows the GSense Prot2 “M” Data Storage1.

FIG. 181-F describes GSense Prot2 Protect Anything Human Key Authentication Unit Vector Line Overlay to Grid Form Pixel Analysis “M” Processor Mechanism and shows the GSense Prot2 “M” Data Storage2.

FIG. 181-G describes GSense Prot2 Protect Anything Human Key Authentication Unit Vector Line Overlay to Grid Form Pixel Analysis “M” Processor Mechanism and shows where the M1 to M2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 181-H describes GSense Prot2 Protect Anything Human Key Authentication Unit Vector Line Overlay to Grid Form Pixel Analysis “M” Processor Mechanism and shows the Protect Anything CODEFA mechanism that provides storage, security, human key and tracking features.

FIG. 181-I describes GSense Prot2 Protect Anything Human Key Authentication Unit Vector Line Overlay to Grid Form Pixel Analysis “M” Processor Mechanism and shows where the W W W or World Wide Web is used for data aggregation and comparison analysis methods Hello, John! Computer Laptop or Mobile device.

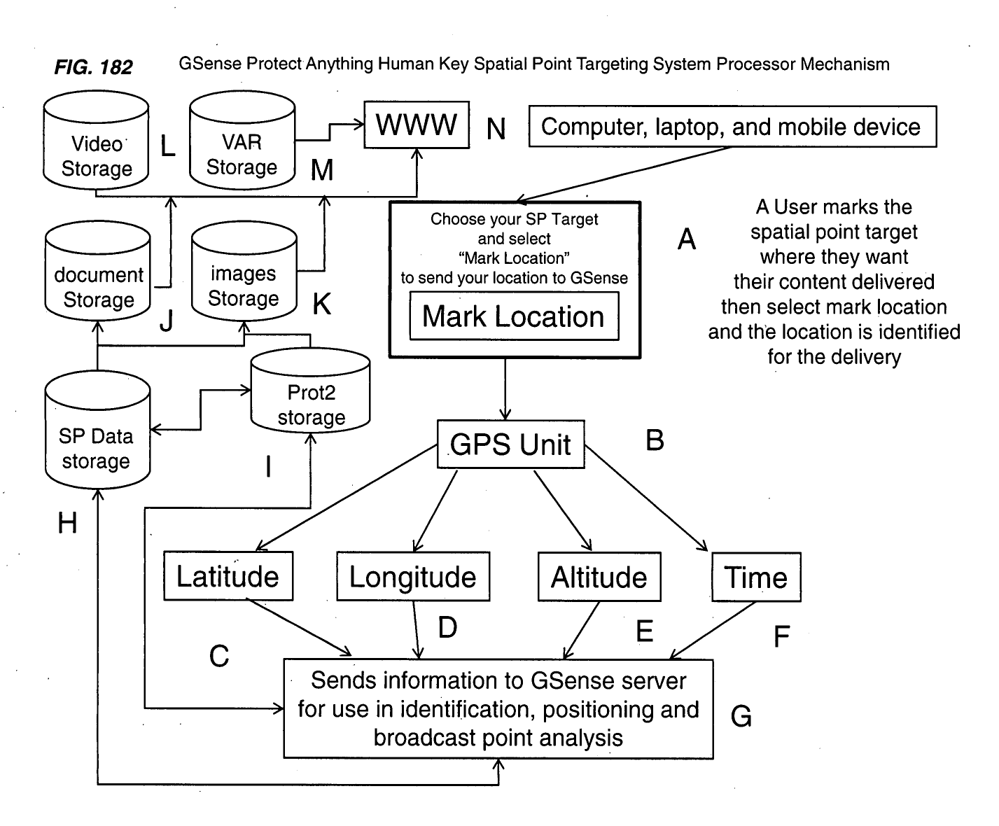

FIG. 182-A describes GSense Protect Anything Spatial Point Targeting System Processor Mechanism and shows where A user marks the spatial point target, or targets where they want their content delivered to then selects “Mark Location” and the location is identified for the delivery where you Choose your SP Target and select “Mark Location” to send your location to GSense on a Computer, laptop, and mobile device and that location is locked into the mechanism for broadcast delivery by Latitude, Longitude, Altitude, and Time coordinates.

FIG. 182-B describes GSense Protect Anything Spatial Point Targeting System Processor Mechanism and shows where the GPS Unit in Computer, laptop, and mobile device is used to get spatial point coordinates of the actual position of the device for locking into a delivery point for content by Latitude, Longitude, Altitude, and Time coordinates with Degrees, Minutes, and Seconds coordinates.

FIG. 182-C describes GSense Protect Anything Spatial Point Targeting System Processor Mechanism and shows the Latitude coordinate.

FIG. 182-D describes GSense Protect Anything Spatial Point Targeting System Processor Mechanism and shows the Longitude coordinate.

FIG. 182-E describes GSense Protect Anything Spatial Point Targeting System Processor Mechanism and shows the Altitude coordinate.

FIG. 182-F describes GSense Protect Anything Spatial Point Targeting System Processor Mechanism and shows the Time coordinate.

FIG. 182-G describes GSense Protect Anything Spatial Point Targeting System Processor Mechanism and shows where the GPS delivery spatial point target is set for content by Latitude, Longitude, Altitude, and Time coordinates with Degrees, Minutes, and Seconds coordinates sends information to GSense server for use in identification, positioning and broadcast point analysis.

FIG. 182-H describes GSense Protect Anything Spatial Point Targeting System Processor Mechanism and shows the GSense Protect Anything Spatial Point data storage mechanism.

FIG. 182-I describes GSense Protect Anything Spatial Point Targeting System Processor Mechanism and shows the GSense Protect Anything Prot2 Spatial Point data storage mechanism.

FIG. 182-J describes GSense Protect Anything Spatial Point Targeting System Processor Mechanism and shows the GSense Protect Anything document storage mechanism.

FIG. 182-K describes GSense Protect Anything Spatial Point Targeting System Processor Mechanism and shows the GSense Protect Anything images storage mechanism.

FIG. 182-L describes GSense Protect Anything Spatial Point Targeting System Processor Mechanism and shows the GSense Protect Anything video storage mechanism.

FIG. 182-M describes GSense Protect Anything Spatial Point Targeting System Processor Mechanism and shows the GSense Protect Anything virtual augmented reality storage mechanism.

FIG. 182-N describes GSense Protect Anything Spatial Point Targeting System Processor Mechanism and shows the WWW or World Wide Web.

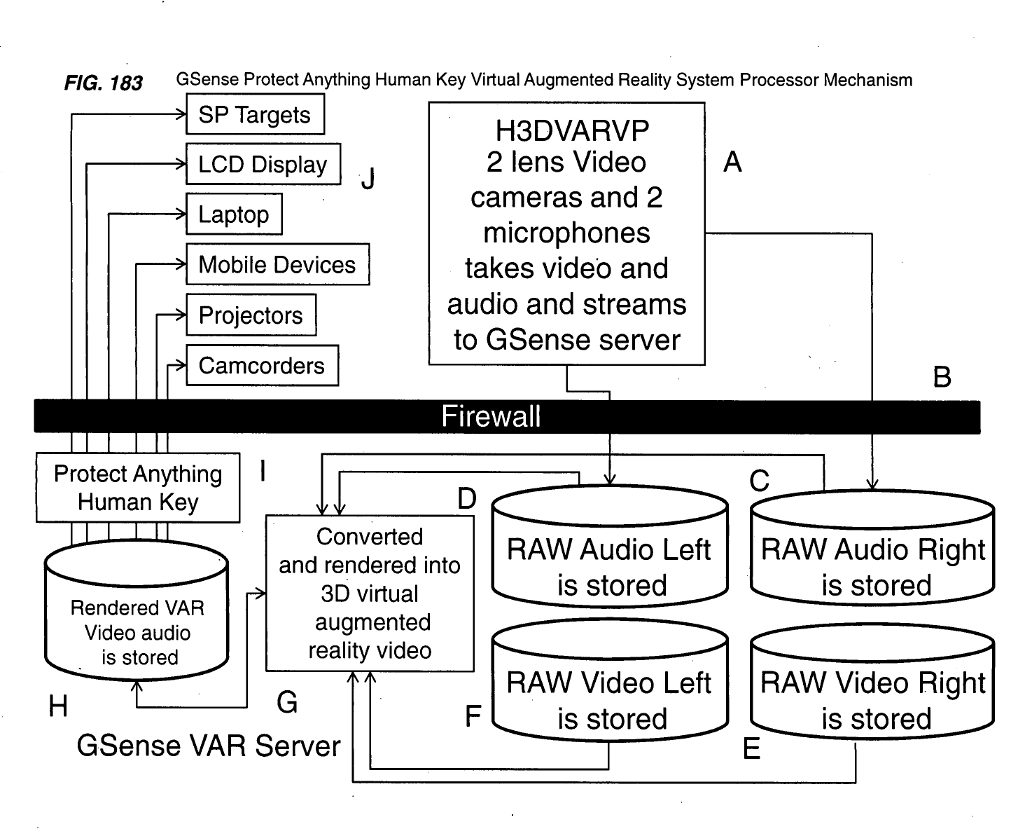

FIG. 183-A describes GSense Protect Anything H3DVARV 3D Human Video Audio Stereo Viewing and Recording Virtual Augmented Reality System Processor Mechanism and shows the H3DVARV or Human 3 Dimensional Video Audio Recorder Viewer 2 lens and 2 APS cameras takes video and streams to GSense server for processing of the 4 data streams 2 video and 2 audio streams.

FIG. 183-B describes GSense Protect Anything H3DVARV 3D Human Video Audio Stereo Viewing and Recording Virtual Augmented Reality System Processor Mechanism and shows the Firewall.

FIG. 183-C describes GSense Protect Anything H3DVARV 3D Human Video Audio Stereo Viewing and Recording Virtual Augmented Reality System Processor Mechanism and shows the RAW Audio Right is stored for later processing.

FIG. 183-D describes GSense Protect Anything H3DVARV 3D Human Video Audio Stereo Viewing and Recording Virtual Augmented Reality System Processor Mechanism and shows the RAW Audio Left is stored for later processing.

FIG. 183-E describes GSense Protect Anything H3DVARV 3D Human Video Audio Stereo Viewing and Recording Virtual Augmented Reality System Processor Mechanism and shows the RAW Video Right is stored for later processing.

FIG. 183-F describes GSense Protect Anything H3DVARV 3D Human Video Audio Stereo Viewing and Recording Virtual Augmented Reality System Processor Mechanism and shows the RAW Video Left is stored for later processing.

FIG. 183-G describes GSense Protect Anything H3DVARV 3D Human Video Audio Stereo Viewing and Recording Virtual Augmented Reality System Processor Mechanism and shows GSense VAR Server where the 2 video and 2 audio files are converted and rendered into 3D virtual augmented reality video.

FIG. 183-H describes GSense Protect Anything H3DVARV 3D Human Video Audio Stereo Viewing and Recording Virtual Augmented Reality System Processor Mechanism and shows GSense VAR Server where the VAR video audio that is rendered is stored.

FIG. 183-I describes GSense Protect Anything H3DVARV 3D Human Video Audio Stereo Viewing and Recording Virtual Augmented Reality System Processor Mechanism and shows and then shows where the broadcast or delivery is run through the Protect Anything Human Key before the delivery takes place.

FIG. 183-J describes GSense Protect Anything H3DVARV 3D Human Video Audio Stereo Viewing and Recording Virtual Augmented Reality System Processor Mechanism and shows the broadcast or delivery to SP Targets, LCD Display, Laptop, Mobile Devices, Projectors, and Camcorders through the firewall.

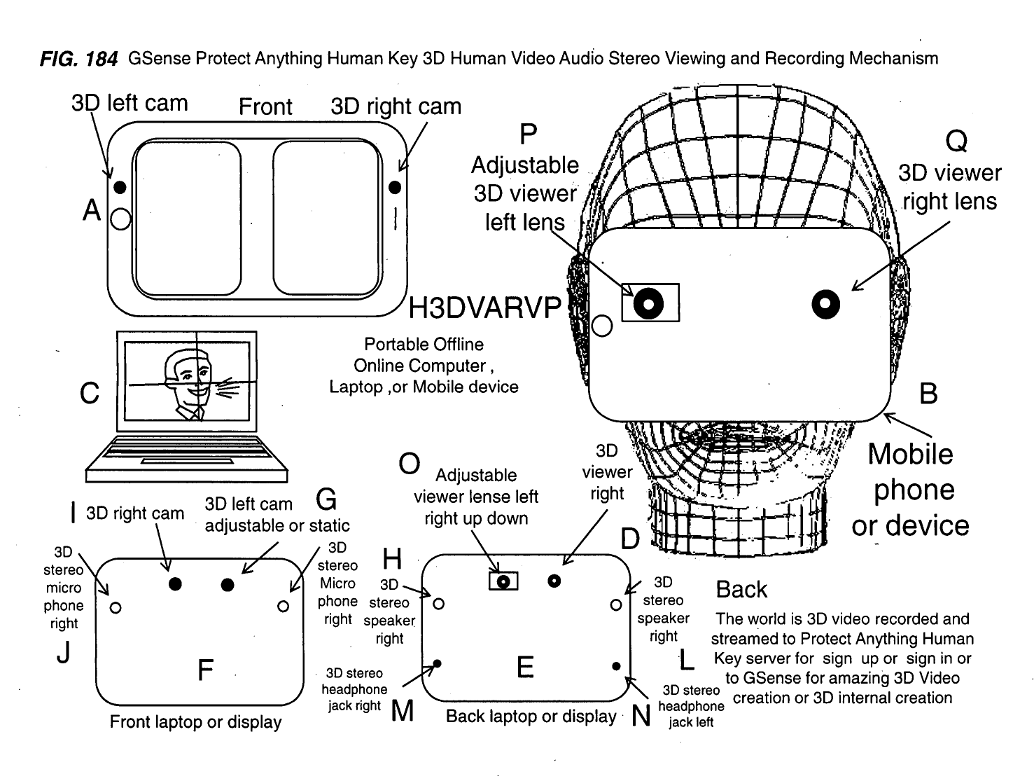

FIG. 184-A describes GSense Protect Anything H3DVARV 3D Human Video Audio Stereo Viewing and Recording. Mechanism and shows the world is 3D video recorded and streamed to Protect Anything Human Key server for sign up or sign in or to GSense for 3D Video creation or 3D internal creation a front view of a mobile device display screen with H3DVARV 3D left cam and 3D right cam and H3DVARV 3D left right split screen.

FIG. 184-B describes GSense Protect Anything H3DVARV 3D Human Video Audio Stereo Viewing and Recording Mechanism and shows a mobile phone or device with H3DVARV viewing lenses to view through mechanism.

FIG. 184-C describes GSense Protect Anything H3DVARV 3D Human Video Audio Stereo Viewing and Recording Mechanism and shows a laptop with Protect Anything Human Key sign in registration utilizing the H3DVARV 3D-Viewing recording mechanism.

FIG. 184-D describes GSense Protect Anything H3DVARV 3D Human Video Audio Stereo Viewing and Recording Mechanism and shows the back of a laptop or display for viewing through the H3DVARV mechanism with the 3D viewer right mechanism.

FIG. 184-E describes GSense Protect Anything H3DVARV 3D Human Video Audio Stereo Viewing and Recording Mechanism and shows the lap top configured with the H3DVARV mechanism for viewing and recording video audio.

FIG. 184-F describes GSense Protect Anything H3DVARV 3D Human Video Audio Stereo Viewing and Recording Mechanism and shows the front laptop display with the H3DVARV mechanism for 3D cams and 3D stereo microphones for recording.

FIG. 184-G describes GSense Protect Anything H3DVARV 3D Human Video Audio Stereo Viewing and Recording Mechanism and shows the 3D left cam adjustable or static.

FIG. 184-H describes GSense Protect Anything H3DVARV 3D Human Video Audio Stereo Viewing and Recording Mechanism and shows the 3D stereo speaker right.

FIG. 184-I describes GSense Protect Anything H3DVARV 3D Human Video Audio Stereo Viewing and Recording Mechanism and shows the 3D right cam.

FIG. 184-J describes GSense Protect Anything H3DVARV 3D Human Video Audio Stereo Viewing and Recording Mechanism and shows the 3D stereo microphone right.

FIG. 184-L describes GSense Protect Anything H3DVARV 3D Human Video Audio Stereo Viewing and Recording Mechanism and shows the 3D stereo speaker right.

FIG. 184-M describes GSense Protect Anything H3DVARV 3D Human Video Audio Stereo Viewing and Recording Mechanism and shows the 3D stereo headphone jack right.

FIG. 184-N describes GSense Protect Anything H3DVARV 3D Human Video Audio Stereo Viewing and Recording Mechanism and shows the 3D stereo headphone jack left.

FIG. 184-O describes GSense Protect Anything H3DVARV 3D Human Video Audio Stereo Viewing and Recording Mechanism and shows the Adjustable viewer dense left right up down.

FIG. 184-P describes GSense Protect Anything H3DVARV 3D Human Video Audio Stereo Viewing and Recording Mechanism and shows the Adjustable 3D viewer left lens.

FIG. 184-Q describes GSense Protect Anything H3DVARV 3D Human Video Audio Stereo Viewing and Recording Mechanism and shows the 3D viewer right lens.

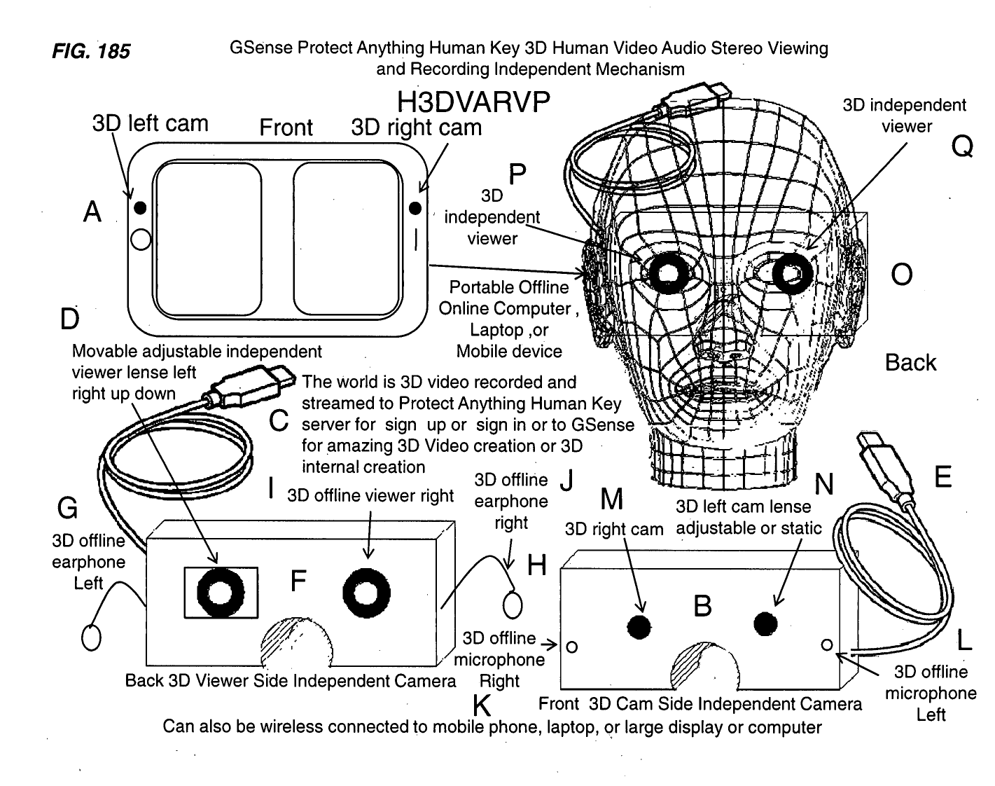

FIG. 185-A describes GSense Protect Anything H3DVARV 3D Human Video Audio Stereo Viewing and Recording Independent Mechanism and shows the world is 3D video recorded and streamed to Protect Anything Human Key server for sign up or sign in or to GSense for 3D Video creation or 3D internal creation a front view of a mobile device display screen with H3DVARV 3D left cam and 3D right cam and H3DVARV 3D left right split screen.

FIG. 185-B describes GSense Protect Anything H3DVARV 3D Human Video Audio Stereo Viewing and Recording Independent Mechanism and shows the Front 3D Cam Side Independent Camera.

FIG. 185-C describes GSense Protect Anything H3DVARV 3D Human Video Audio Stereo Viewing and Recording Independent Mechanism and shows the USB cable for connecting to devices or can be used with wireless connection to mobile devices, computers and laptops.

FIG. 185-D describes GSense Protect Anything H3DVARV 3D Human Video Audio Stereo Viewing and Recording Independent Mechanism and shows the movable adjustable independent viewer lense left right up down.

FIG. 185-E describes GSense Protect Anything H3DVARV 3D Human Video Audio Stereo Viewing and Recording Independent Mechanism and shows the USB connector.

FIG. 185-F describes GSense Protect Anything H3DVARV 3D Human Video Audio Stereo Viewing and Recording Independent Mechanism and shows the Back 3D Viewer Side Independent Camera.

FIG. 185-G describes GSense Protect Anything H3DVARV 3D Human Video Audio Stereo Viewing and Recording Independent Mechanism and shows 3D offline earphone Left.

FIG. 185-H describes GSense Protect Anything H3DVARV 3D Human Video Audio Stereo Viewing and Recording Independent Mechanism and shows 3D offline earphone Right.

FIG. 185-I describes GSense Protect Anything H3DVARV 3D Human Video Audio Stereo Viewing and Recording Independent Mechanism and shows the 3D offline viewer right.

FIG. 185-J describes GSense Protect Anything H3DVARV 3D Human Video Audio Stereo Viewing and Recording Independent Mechanism and shows the 3D offline earphone right.

FIG. 185-K describes GSense Protect Anything H3DVARV 3D Human Video Audio Stereo Viewing and Recording Independent Mechanism and shows the 3D offline microphone Right.

FIG. 185-L describes GSense Protect Anything H3DVARV 3D Human Video Audio Stereo Viewing and Recording Independent Mechanism and shows 3D offline microphone Left.

FIG. 185-M describes GSense Protect Anything H3DVARV 3D Human Video Audio Stereo Viewing and Recording Independent Mechanism and shows the 3D right cam.

FIG. 185-N describes GSense Protect Anything H3DVARV 3D Human Video Audio Stereo Viewing and Recording Independent Mechanism and shows the 3D left cam lense adjustable or static.

FIG. 185-O describes GSense Protect Anything H3DVARV 3D Human Video Audio Stereo Viewing and Recording Independent Mechanism and shows how the mechanism includes the independent H3DVARV device that can be goggles, are titanium light weight glasses for viewing and recording 3D video and 3D audio.

FIG. 185-P describes GSense Protect Anything H3DVARV 3D Human Video Audio Stereo Viewing and Recording Independent Mechanism and shows the 3D independent viewer.

FIG. 185-Q describes GSense Protect Anything H3DVARV 3D Human Video Audio Stereo Viewing and Recording Independent Mechanism and shows the 3D independent viewer.

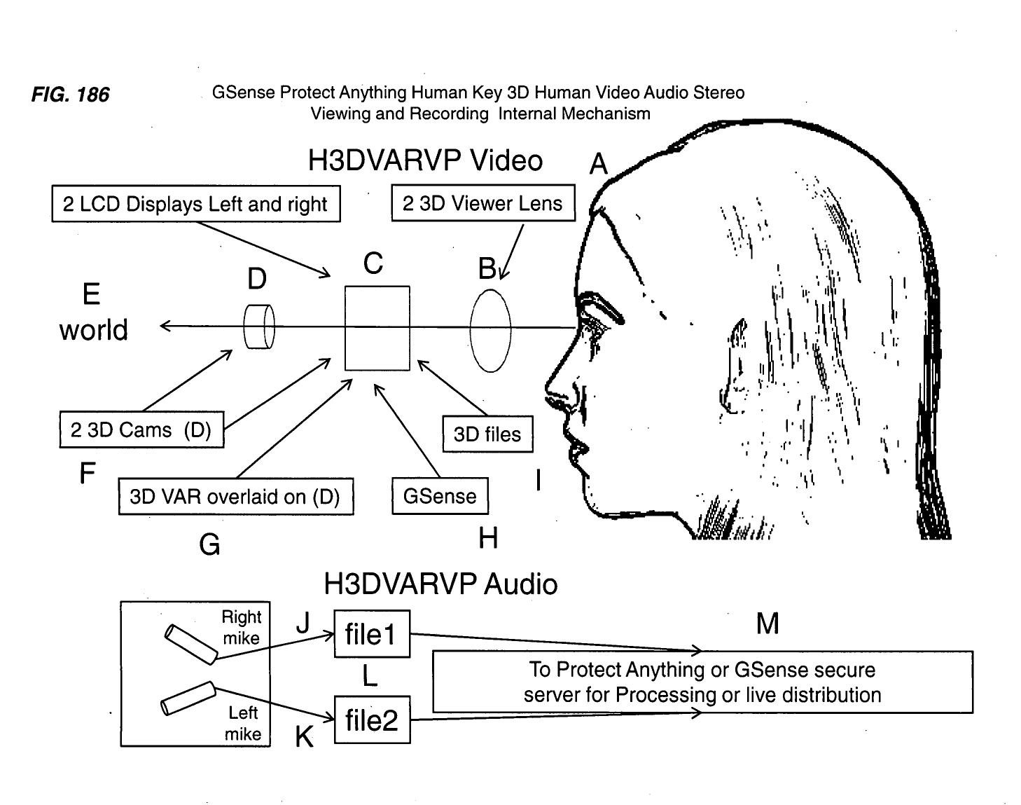

FIG. 186-A describes GSense Protect Anything H3DVARV 3D Human Video Audio Stereo Viewing and Recording Internal Mechanism and shows where a person looks into the lenses to view from the LCD display screen the left and right 3D view point in the H3DVARV mechanism for viewing and recording.

FIG. 186-B describes GSense Protect Anything H3DVARV 3D Human Video Audio Stereo Viewing and Recording Internal Mechanism and shows the 2 3D Viewer Lens.

FIG. 186-C describes GSense Protect Anything H3DVARV 3D Human Video Audio Stereo Viewing and Recording Internal Mechanism and shows the 2 LCD Displays Left and right.

FIG. 186-D describes GSense Protect Anything H3DVARV 3D Human Video Audio Stereo Viewing and Recording Internal Mechanism and shows the world view from the H3DVARV device mechanism.

FIG. 186-E describes GSense Protect Anything H3DVARV 3D Human Video Audio Stereo Viewing and Recording Internal Mechanism and shows the 2 3D Cams (D) that can be broadcast to the (C) LCD display screen with the viewing lens for viewing.

FIG. 186-F describes GSense Protect Anything H3DVARV 3D Human Video Audio Stereo Viewing and Recording Internal Mechanism and shows the 3D VAR overlaid on (D) that can be broadcast to the (C) LCD display screen with the viewing lens for viewing.

FIG. 186-G describes GSense Protect Anything H3DVARV 3D Human Video Audio Stereo Viewing and Recording Internal Mechanism and shows the GSense that can be broadcast to the (C) LCD display screen with the viewing lens for viewing.

FIG. 186-H describes GSense Protect Anything H3DVARV 3D Human Video Audio Stereo Viewing and Recording Internal Mechanism and shows the 3D files that can be broadcast to the (C) LCD display screen with the viewing lens for viewing.

FIG. 186-I describes GSense Protect Anything H3DVARV 3D Human Video Audio Stereo Viewing and Recording Internal Mechanism and shows the right mike that is 3D stereo.

FIG. 186-J describes GSense Protect Anything H3DVARV 3D Human Video Audio Stereo Viewing and Recording Internal Mechanism and shows the left mike that is 3D stereo.

FIG. 186-K describes GSense Protect Anything H3DVARV 3D Human Video Audio Stereo Viewing and Recording Internal Mechanism and shows the right mike that is 3D stereo being stored in file 1 and a left mike that is 3D stereo being stored in file 2.

FIG. 186-L describes GSense Protect Anything H3DVARV 3D Human Video Audio Stereo Viewing and Recording Internal Mechanism and shows the right mike that is 3D stereo, being stored in file 1, and a left mike that is 3D stereo, being stored in file 2, and both files being utilized for Protect Anything or GSense secure server processing or live distribution.

FIG. 186-M describes GSense Protect Anything H3DVARV 3D Human Video Audio Stereo Viewing and Recording Internal Mechanism and shows where the aggregated audio from the 3D stereo microphones is streamed to Protect Anything or GSense secure servers for processing or live distribution.

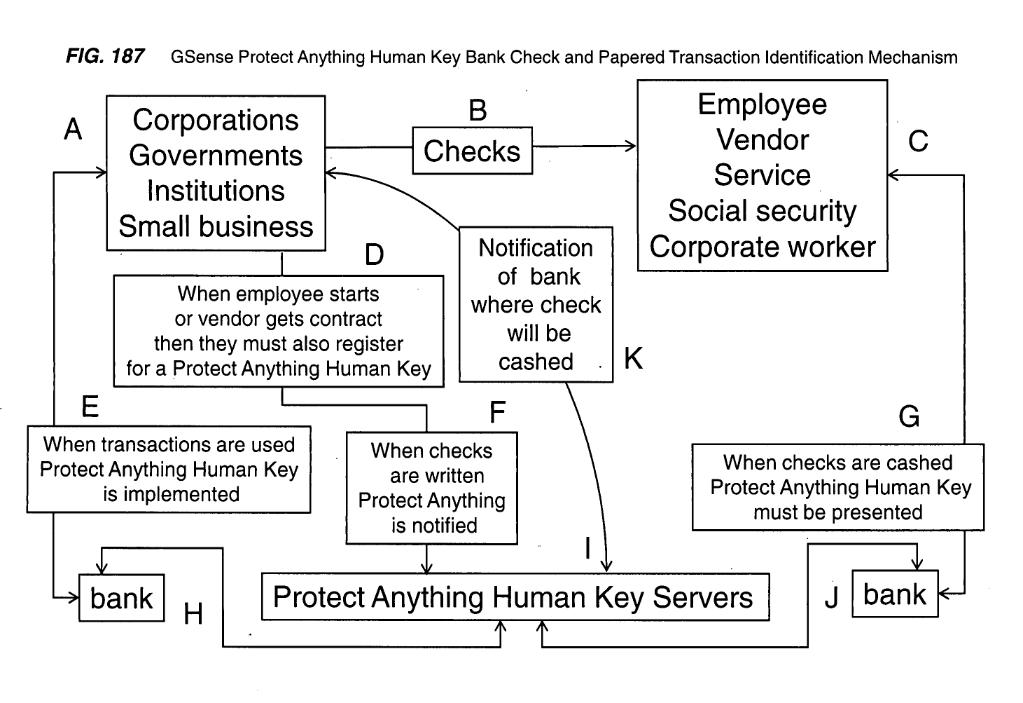

FIG. 187-A describes Protect Anything Human Key Bank Check and Papered Transaction Identification Mechanism and shows where Corporations, Governments, Institutions, Small business can protect their checks written from forgery utilizing the Protect Anything Human Key system.

FIG. 187-B describes Protect Anything Human Key Bank Check and Papered Transaction Identification Mechanism and shows where Corporations, Governments, Institutions, Small business can protect their checks written from forgery utilizing the Protect Anything Human Key system when utilizing a check.

FIG. 187-C describes Protect Anything Human Key Bank Check and Papered Transaction Identification Mechanism and shows where Corporations, Governments, Institutions, Small business can protect their checks written from forgery utilizing the Protect Anything Human Key system Employee, Vendor, Service, Social security, Corporate worker.

FIG. 187-D describes Protect Anything Human Key Bank Check and Papered Transaction Identification Mechanism and shows when employee starts or vendor gets contract then they must also register for a Protect Anything Human Key for cashing checks from the business or institution.

FIG. 187-E describes Protect Anything Human Key Bank Check and Papered Transaction Identification Mechanism and shows when transactions are used Protect Anything Human Key has to be implemented.

FIG. 187-F describes Protect Anything Human Key Bank Check and Papered Transaction Identification Mechanism and shows when checks are written Protect Anything is notified by the business or institution.

FIG. 187-G describes Protect Anything Human Key Bank Check and Papered Transaction Identification Mechanism and shows when checks are cashed Protect Anything Human Key must be presented for the person to be identified before money is paid.

FIG. 187-H describes Protect Anything Human Key Bank Check and Papered Transaction Identification Mechanism and shows the Corporations, Governments, Institutions, Small business, bank account connection.

FIG. 187-I describes Protect Anything Human Key Bank Check and Papered Transaction Identification Mechanism and shows the Protect Anything Human Key secure servers for processing identification data through 16 different identification tests.

FIG. 187-J describes Protect Anything Human Key Bank Check and Papered Transaction Identification Mechanism and shows the Employee, Vendor, Service, Social security, corporate worker, bank account connection.

FIG. 187-K describes Protect Anything Human Key Bank Check and Papered Transaction Identification Mechanism and shows as an additional verification, the business or institution can ask the person who will be getting the checks for the name of their bank and the Protect Anything Human Key can only cash checks that are cashed at that bank that is registered in the Protect Anything system.

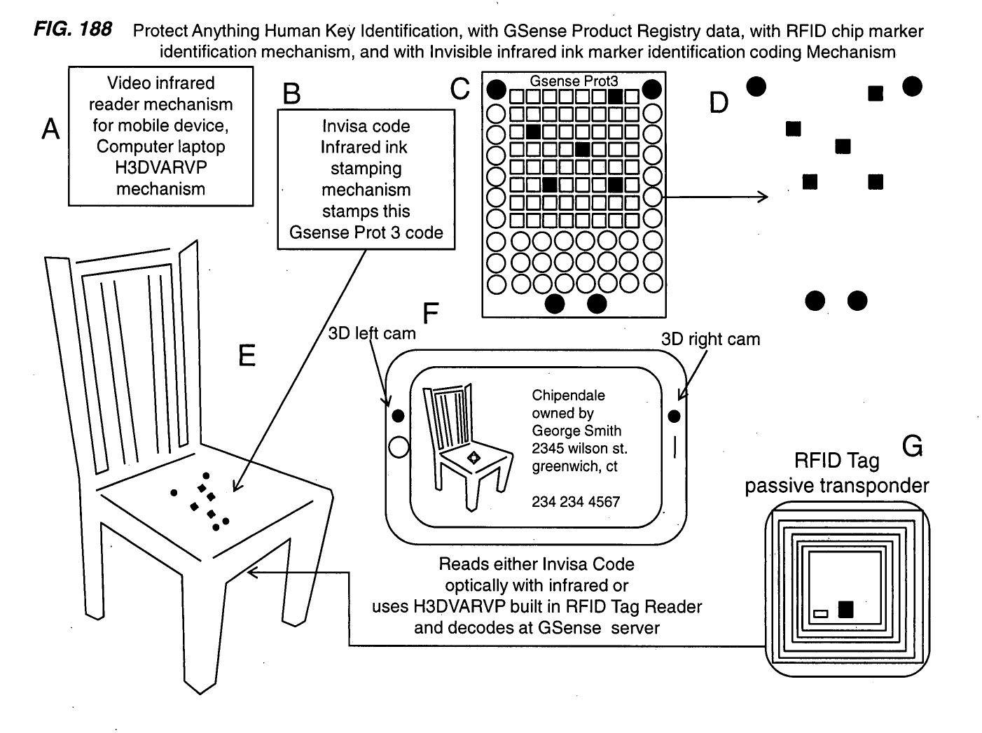

FIG. 188-A describes Protect Anything Human Key Identification, with GSense Product Registry data, with RFID chip marker identification mechanism, and with Invisible infrared ink marker identification coding Mechanism and shows the Video infrared reader mechanism for mobile device, computer laptop H3DVARV mechanism that has the capability to read infrared invisible ink and can be built into a mobile device, laptop, computer or any digital computer mechanism.

FIG. 188-B describes Protect Anything Human Key Identification, with GSense Product Registry data, with RFID chip marker identification mechanism, and with Invisible infrared ink marker identification coding Mechanism and shows the Invisa code Infrared ink stamping mechanism that stamped this GSense code on a chair that can stamp a product with invisible infrared ink with the GSense Prot3 code stamp pattern, the device can also be mounted on a multi manufacturing machine for rapid coding with patterns changing as each item goes through the process.

FIG. 188-C describes Protect Anything Human Key Identification, with GSense Product Registry data, with RFID chip marker identification mechanism, and with Invisible infrared ink marker identification coding Mechanism and shows the GSense Prot 3 pattern background for encoding and decoding with the GSense infrared reader mechanism.

FIG. 188-D describes Protect Anything Human Key Identification, with GSense Product Registry data, with RFID chip marker identification mechanism, and with Invisible infrared ink marker identification coding Mechanism and shows what an invisible infrared pattern looks like to the GSense reader.

FIG. 188-E describes Protect Anything Human Key Identification, with GSense Product Registry data, with RFID chip marker identification mechanism, and with Invisible infrared ink marker identification coding Mechanism and shows the GSense Prot 3 Infrared Ink Stamp on a chair.

FIG. 188-F describes Protect Anything Human Key Identification, with GSense Product Registry data, with RFID chip marker identification mechanism, and with Invisible infrared ink marker identification coding Mechanism and shows the mobile device with left and right cam using the reader that can read either GSense Prot 3 Invisa Code optically with infrared or uses H3DVARV built in RFID Tag Reader and decodes at GSense server and shows the chair with information delivered after identification is processed.

FIG. 188-G describes Protect Anything Human Key Identification, with GSense Product Registry data, with RFID chip marker identification mechanism, and with Invisible infrared ink marker identification coding Mechanism and shows the GSense RFID Tag passive transponder.

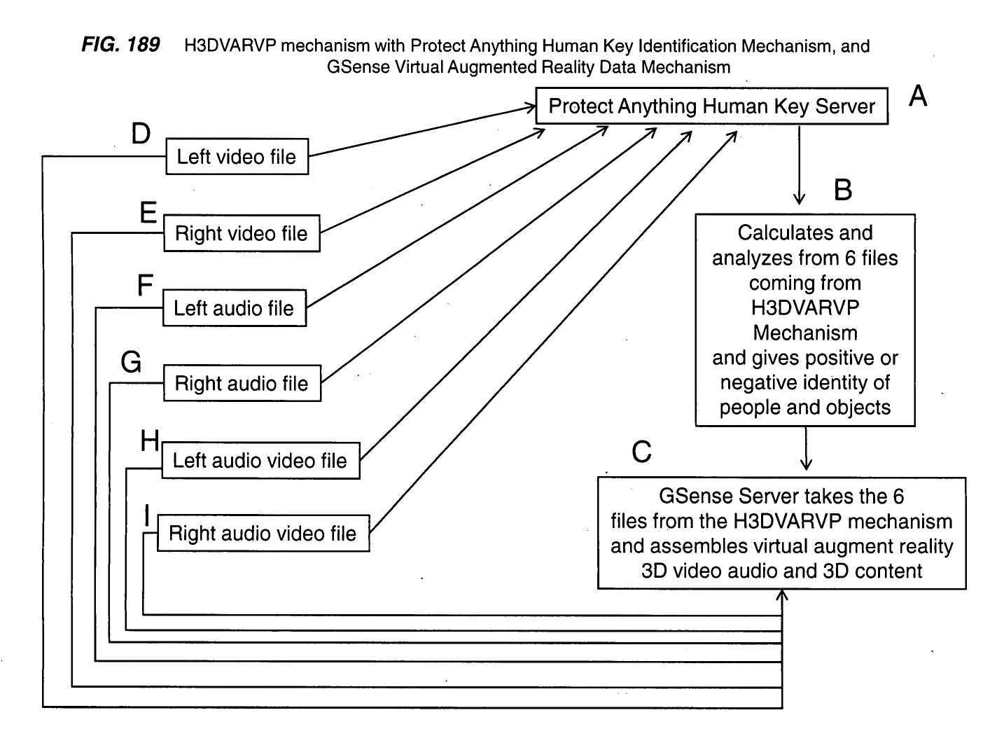

FIG. 189-A describes H3DVARV mechanism with Protect Anything Human Key Identification Mechanism, and GSense Virtual Augmented Reality Data Mechanism and shows the Protect Anything Human Key Server.

FIG. 189-B describes H3DVARV mechanism with Protect Anything Human Key Identification Mechanism, and GSense Virtual Augmented Reality Data Mechanism and shows where the Protect Anything Human Key Server Calculates and analyzes from 6 files coming from H3DVARV Mechanism and gives positive or negative identity of people and objects.

FIG. 189-C describes H3DVARV mechanism with Protect Anything Human Key Identification Mechanism, and GSense Virtual Augmented Reality Data Mechanism and shows the GSense Server takes the 6 files from the H3DVARV mechanism and assembles virtual augment reality 3D video audio and 3D content.

FIG. 189-D describes H3DVARV mechanism with Protect Anything Human Key Identification Mechanism, and GSense Virtual Augmented Reality Data Mechanism and shows the Left video file from the H3DVARV mechanism for analysis, 3D VAR creation, or 3D video creation.

FIG. 189-E describes H3DVARV mechanism with Protect Anything Human Key Identification Mechanism, and GSense Virtual Augmented Reality Data Mechanism and shows the Right video file from the H3DVARV mechanism for analysis 3D VAR creation, or 3D video creation.

FIG. 189-F describes H3DVARV mechanism with Protect Anything Human Key Identification Mechanism, and GSense Virtual Augmented Reality Data Mechanism and shows the Left audio file from the H3DVARV mechanism for analysis 3D VAR creation, or 3D video creation.

FIG. 189-G describes H3DVARV mechanism with Protect Anything Human Key Identification Mechanism, and GSense Virtual Augmented Reality Data Mechanism and shows the Right audio file from the H3DVARV mechanism for analysis 3D VAR creation, or 3D video creation.

FIG. 189-H describes H3DVARV mechanism with Protect Anything Human Key Identification Mechanism, and GSense Virtual Augmented Reality Data Mechanism and shows the Left audio plus video file combined at the GSense or Protect Anything server for analysis, 3D VAR creation, or 3D video creation.

FIG. 189-I describes H3DVARV mechanism with Protect Anything Human Key Identification Mechanism, and GSense Virtual Augmented Reality Data Mechanism and shows the Right audio plus video file combined at the GSense or Protect Anything server for analysis, 3D VAR creation, or 3D video creation.

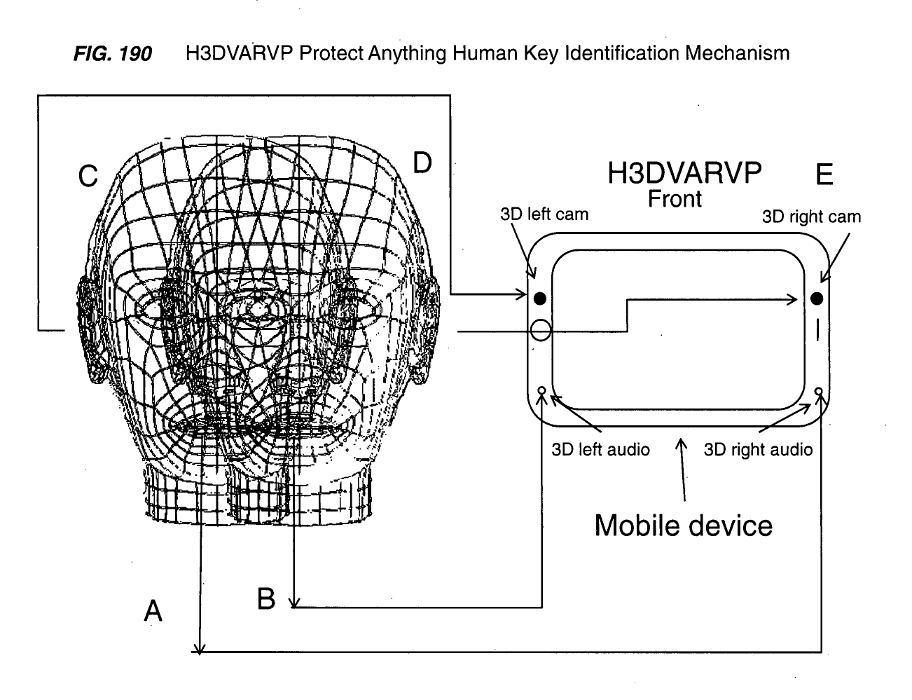

FIG. 190-A describes H3DVARV Protect Anything Human Key Identification Mechanism and shows the right audio spoken phrase or sounds recorded by the H3DVARV mechanism for identity analysis.

FIG. 190-B describes H3DVARV Protect Anything Human Key Identification Mechanism and shows the left audio spoken phrase or sounds recorded by the H3DVARV mechanism for identity analysis.

FIG. 190-C describes H3DVARV Protect Anything Human Key Identification Mechanism and shows the left video of the person or object recorded by the H3DVARV mechanism for identity analysis.

FIG. 190-D describes H3DVARV Protect Anything Human Key Identification Mechanism and shows the right video of the person or object recorded by the H3DVARV mechanism for identity analysis.

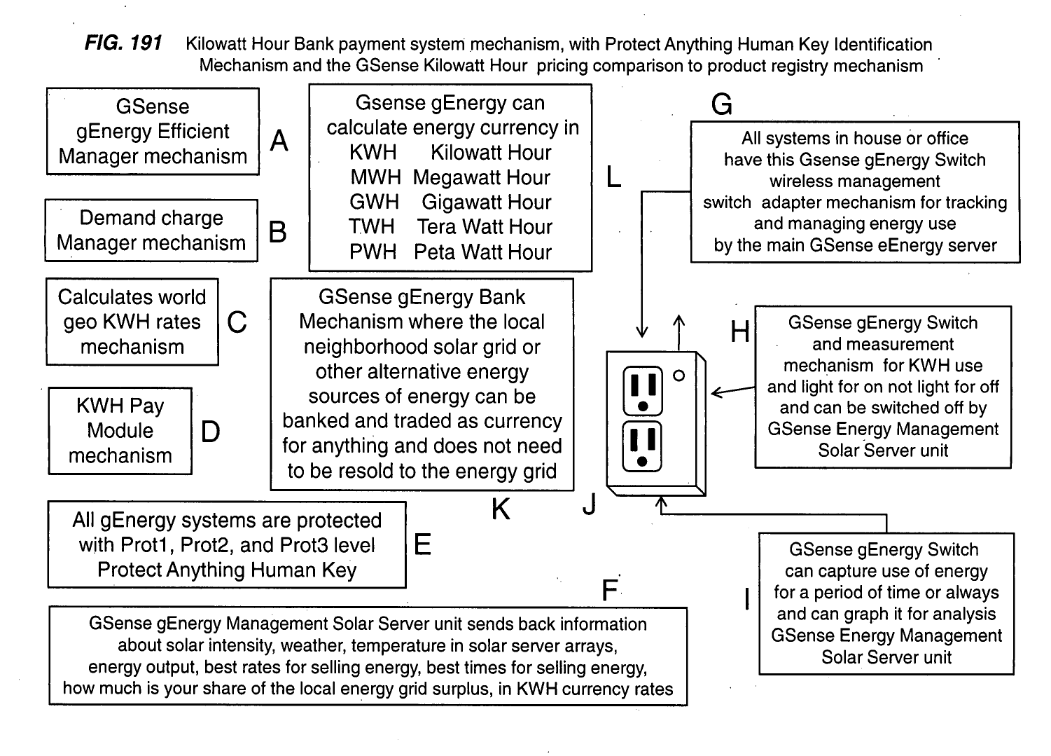

FIG. 191-A describes Kilowatt Hour Bank payment system mechanism, with Protect Anything Human Key Identification Mechanism and the GSense Kilowatt Hour pricing comparison to product registry mechanism and shows the GSense eEnergy Efficient Manager mechanism.

FIG. 191-B describes Kilowatt Hour Bank payment system mechanism, with Protect Anything Human Key Identification Mechanism and the GSense Kilowatt Hour pricing comparison to product registry mechanism and shows the Demand charge Manager mechanism.

FIG. 191-C describes Kilowatt Hour Bank payment system mechanism, with Protect Anything Human Key Identification Mechanism and the GSense Kilowatt Hour pricing comparison to product registry mechanism and shows the Calculates world geo KWH rates mechanism.

FIG. 191-D describes Kilowatt Hour Bank payment system mechanism, with Protect Anything Human Key Identification Mechanism and the GSense Kilowatt Hour pricing comparison to product registry mechanism and shows the KWH Pay Module mechanism.

FIG. 191-E describes Kilowatt Hour Bank payment system mechanism, with Protect Anything Human Key Identification Mechanism and the GSense Kilowatt Hour pricing comparison to product registry mechanism and shows that all eEnergy systems are protected with Prot1, Prot2, and Prot3 level Protect Anything Human Key.

FIG. 191-F describes Kilowatt Hour Bank payment system mechanism, with Protect Anything Human Key Identification Mechanism and the GSense Kilowatt Hour pricing comparison to product registry mechanism and shows the GSense eEnergy Management Solar Server unit sends back information about solar intensity, weather, temperature in solar server arrays, energy output, best rates for selling energy, best times for selling energy, how much is your share of the local energy grid surplus, in KWH currency rates.

FIG. 191-G describes Kilowatt Hour Bank payment system mechanism, with Protect Anything Human Key Identification Mechanism and the GSense Kilowatt Hour pricing comparison to product registry mechanism and shows that All systems in house or office have the GSense wireless management switch adapter mechanism for tracking and managing energy use by the main GSense eEnergy server.

FIG. 191-H describes Kilowatt Hour Bank payment system mechanism, with Protect, Anything Human Key Identification Mechanism and the GSense Kilowatt Hour pricing comparison to product registry mechanism and shows the GSense eEnergy Switch adapter and measurement mechanism for KWH use and light for on not light for off and can be switched off by GSense Energy Management Solar Server unit.

FIG. 191-I describes Kilowatt Hour Bank payment system mechanism, with Protect Anything Human Key Identification Mechanism and the GSense Kilowatt Hour pricing comparison to product registry mechanism and shows the GSense eEnergy Switch adapter can capture use of energy for a period of time or always and can graph it for analysis GSense Energy Management Solar Server unit.

FIG. 191-J describes Kilowatt Hour Bank payment system mechanism, with Protect Anything Human Key Identification Mechanism and the GSense Kilowatt Hour pricing comparison to product registry mechanism and shows the GSense eEnergy Switch adapter.

FIG. 191-K describes Kilowatt Hour Bank payment system mechanism, with Protect Anything Human Key Identification Mechanism and the GSense Kilowatt Hour pricing comparison to product registry mechanism and shows the GSense eEnergy Bank Mechanism where the local neighborhood solar grid energy or other alternative energy sources of energy can be banked and traded as currency for anything and does not need to be resold to the energy grid.

FIG. 191-L describes Kilowatt Hour Bank payment system mechanism, with Protect Anything Human Key Identification Mechanism and the GSense Kilowatt Hour pricing comparison to product registry mechanism and shows where energy in the GSense eEnergy system can calculate energy currency in KWH Kilowatt Hour, or larger amounts for industry like MWH Megawatt Hour, GWH Gigawatt Hour, TWH Tera Watt Hour, PWH Peta Watt Hour.

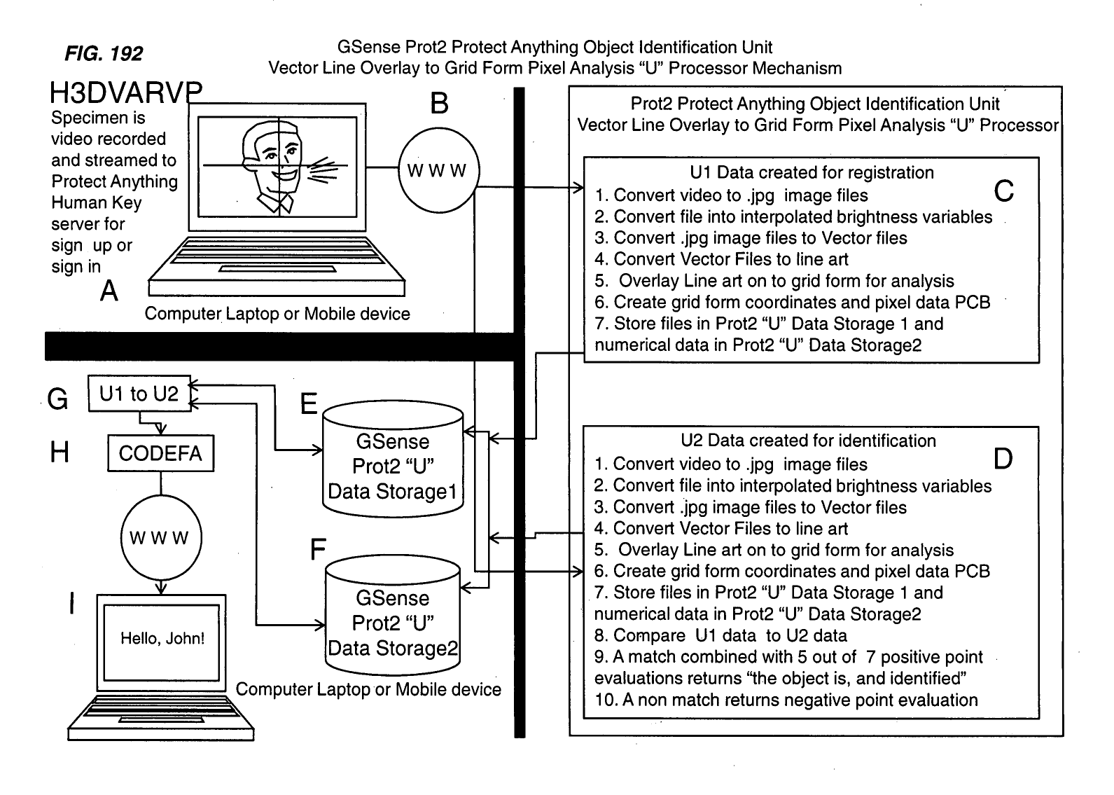

FIG. 192-A describes GSense Prot2 Protect Anything Object Identification Unit Vector Line Overlay to Grid Form Pixel Analysis “U” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 192-B describes GSense Prot2 Protect Anything Object Identification Unit Vector Line Overlay to Grid Form Pixel Analysis “U” Processor Mechanism and shows where the W W W or World Wide Web is used for data aggregation and comparison analysis methods.

FIG. 192-C describes GSense Prot2 Protect Anything Object Identification Unit Vector Line Overlay to Grid Form Pixel Analysis “U” Processor Mechanism and shows where the Prot2 Protect Anything Object Identification Unit Vector Line Overlay to Grid Form Pixel Analysis “U” Processor U1 Data created for registration, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “U” Data Storage 1 and numerical data in Prot2 “U” Data Storage2.

FIG. 192-D describes GSense Prot2 Protect Anything Object Identification Unit Vector Line Overlay to Grid Form Pixel Analysis “U” Processor Mechanism and shows where the Prot2 Protect Anything Object Identification Unit Vector Line Overlay to Grid Form Pixel Analysis “U” Processor U2 Data created for identification, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “U” Data Storage 1 and numerical data in Prot2 “U” Data Storage2, 8. Compares U1 data to U2 data, 9. Where a match combined with 5 out of 7 positive point evaluations returns “the object is, and identified”, 10. Where a non match returns negative point evaluation.

FIG. 192-E describes GSense Prot2 Protect Anything Object Identification Unit Vector Line Overlay to Grid Form Pixel Analysis “M” Processor Mechanism and shows the GSense Prot2 “U” Data Storage1.

FIG. 192-F describes GSense Prot2 Protect Anything Object Identification Unit Vector Line Overlay to Grid Form Pixel Analysis “U” Processor Mechanism and shows the GSense Prot2 “U” Data Storage2.

FIG. 192-G describes GSense Prot2 Protect Anything Object Identification Unit Vector Line Overlay to Grid Form Pixel Analysis “U”. Processor Mechanism and shows where the U1 to U2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 192-H describes GSense Prot2 Protect Anything Object Identification Unit Vector Line Overlay to Grid Form Pixel Analysis “U” Processor Mechanism and shows the Protect Anything CODEFA mechanism that provides storage, security, human key and tracking features.

FIG. 192-I describes GSense Prot2 Protect Anything Object Identification Unit Vector Line Overlay to Grid Form Pixel Analysis “U” Processor Mechanism and shows where the W W W or World Wide Web is used for data aggregation and comparison analysis methods Hello, John! Computer Laptop or Mobile device.

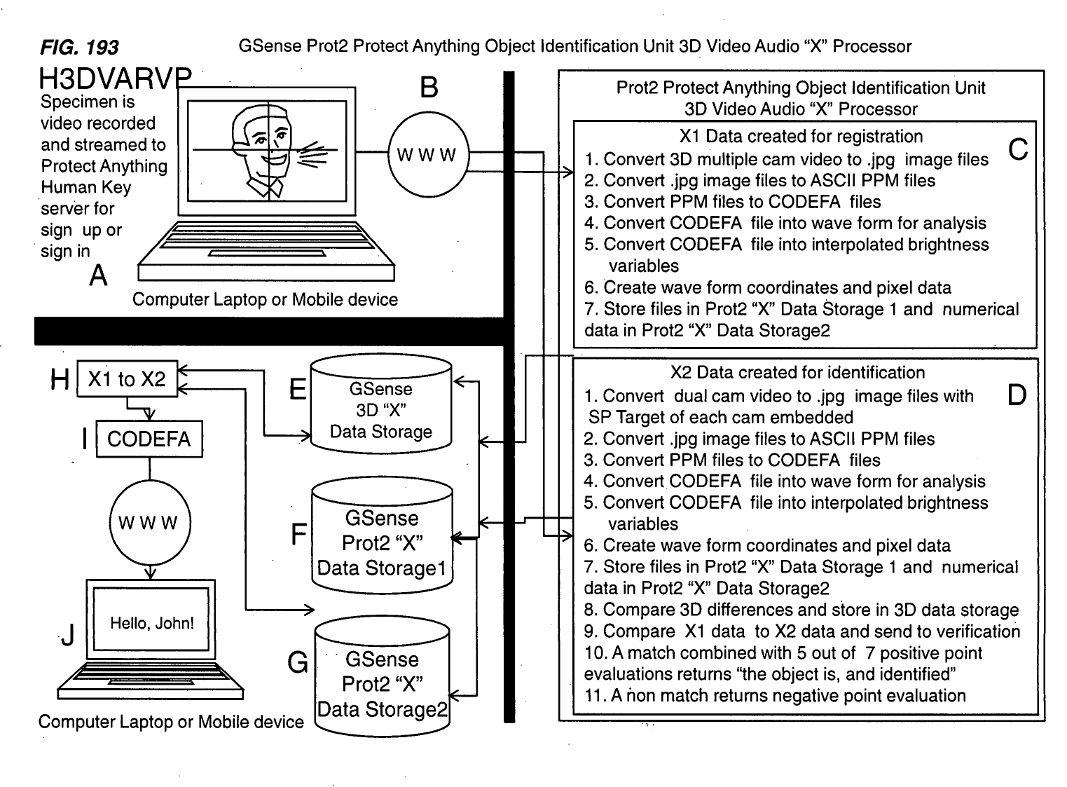

FIG. 193-A describes GSense Prot2 Protect Anything Object Identification Unit 3D Video Audio “X” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 193-B describes GSense Prot2 Protect Anything Object Identification Unit 3D Video Audio “X” Processor and shows where the W W W or World Wide Web is used for data aggregation and comparison analysis methods.

FIG. 193-C describes GSense Prot2 Protect Anything Object Identification Unit 3D Video Audio “X” Processor and shows where the Prot2 Protect Anything Object Identification Unit3D Video Audio “X” Processor X1 Data created for registration, 1. Converts 3D multiple cam video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “X” Data Storage 1 and numerical data in Prot2 “X” Data Storage2.

FIG. 193-D describes GSense Prot2 Protect Anything Object Identification Unit 3D Video Audio “X” Processor and shows where the Prot2 Protect Anything Object Identification Unit3D Video Audio “X” Processor X2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “X” Data Storage 1 and numerical data in Prot2 “X” Data Storage2, 8. Compares 3D differences and store in 3D data storage, 9. Compares X1 data to X2 data and send to verification, 10. Where a match combined with 5 out of 7 positive point evaluations returns “the object is, and identified” 11. Where a non match returns negative point evaluation.

FIG. 193-E describes GSense Prot2 Protect Anything Object Identification Unit 3D Video Audio “X” Processor and shows the GSense 3D “X” Data Storage.

FIG. 193-F describes GSense Prot2 Protect Anything Object Identification Unit 3D Video Audio “X” Processor and shows the GSense Prot2 “X” Data Storage1.

FIG. 193-G describes GSense Prot2 Protect Anything Object Identification Unit 3D Video Audio “X” Processor and shows the GSense Prot2 “X” Data Storage2.

FIG. 193-H describes GSense Prot2 Protect Anything Object Identification Unit 3D Video Audio “X” Processor and shows where the X1 to X2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 193-I describes GSense Prot2 Protect Anything Object Identification Unit 3D Video Audio “X” Processor and shows the Protect Anything CODEFA mechanism that provides storage, security, human key and tracking features.

FIG. 193-J describes GSense Prot2 Protect Anything Object Identification Unit 3D Video Audio “X” Processor and shows where the W W W or World Wide Web is used for data aggregation and comparison analysis methods Hello, John! Computer Laptop or Mobile device.

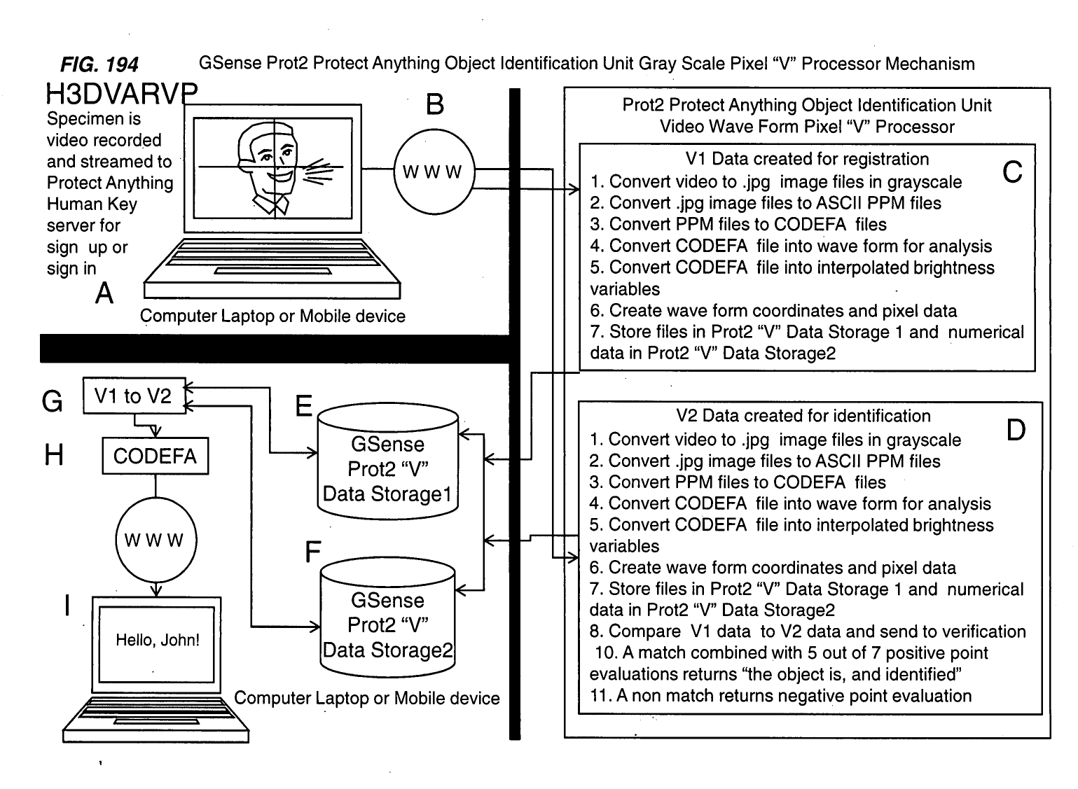

FIG. 194-A describes GSense Prot2 Protect Anything Object Identification Unit Gray Scale Pixel “V” Processor Mechanism with H3DVARV 3D Human Video Audio Stereo Viewing and Recording Mechanism and shows where the Specimen video is recorded and streamed to Protect Anything Human Key server for sign up or sign in Computer. Laptop or Mobile device.

FIG. 194-B describes GSense Prot2 Protect Anything Object Identification Unit Gray Scale Pixel “V” Processor Mechanism and shows where the W W W or World Wide Web is used for data aggregation and comparison analysis methods.

FIG. 194-C describes GSense Prot2 Protect Anything Object Identification Unit Gray Scale Pixel “V” Processor Mechanism and shows where the Prot2 Protect Anything Object Identification Unit Video Wave Form Pixel “V” Processor V1 Data created for registration, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “V” Data Storage 1 and numerical data in Prot2 “V” Data Storage2.

FIG. 194-D describes GSense Prot2 Protect Anything Object Identification Unit Gray Scale Pixel “N” Processor Mechanism and shows where the Prot2 Protect Anything Object Identification Unit Video Wave Form Pixel “V” Processor V2 Data created for identification, 1. Converts video to .jpg image files in grayscale, 2. Converts .jpg image files to ASCII PPM files, 3. Converts PPM files to Protect, Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “V” Data Storage 1 and numerical data in Prot2 “V” Data Storage2, 8. Compares V1 data to V2 data and send to verification, 10. Where a match combined with 5 out of 7 positive point evaluations returns “the object is, and identified” 11. Where a non match returns negative point evaluation.

FIG. 194-E describes GSense Prot2 Protect Anything Object Identification Unit Gray Scale Pixel “V” Processor Mechanism and shows the GSense Prot2 “V” Data Storage1.

FIG. 194-F describes GSense Prot2 Protect Anything Object Identification Unit Gray Scale Pixel “V” Processor Mechanism and shows the GSense Prot2 “V” Data Storage2.

FIG. 194-G describes GSense Prot2 Protect Anything Object Identification Unit Gray Scale Pixel “V” Processor Mechanism and shows where the V1 to V2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 194-H describes GSense Prot2 Protect Anything Object Identification Unit Gray Scale Pixel “V” Processor Mechanism and shows the Protect Anything CODEFA mechanism that provides storage, security, human key and tracking features.

FIG. 194-I describes GSense Prot2 Protect Anything Object Identification Unit Gray Scale Pixel “V” Processor Mechanism and shows where the W W W or World Wide Web is used for data aggregation and comparison analysis methods Hello, John! Computer Laptop or Mobile device.

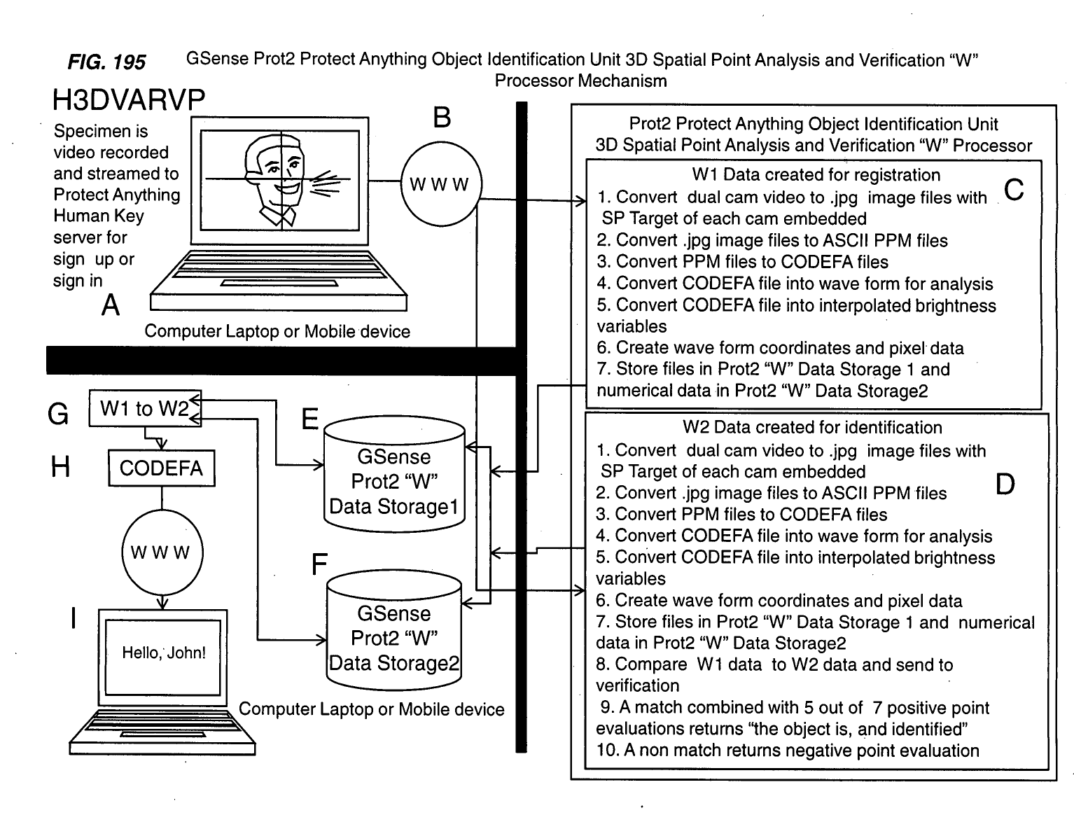

FIG. 195-A describes GSense Prot2 Protect Anything Object Identification Unit 3D Spatial Point Analysis and Verification “W” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 195-B describes GSense Prot2 Protect Anything Object Identification Unit 3D Spatial Point Analysis and Verification “W” Processor Mechanism and shows where the W W W or World Wide Web is used for data aggregation and comparison analysis methods.

FIG. 195-C describes GSense Prot2 Protect Anything Object Identification Unit 3D Spatial Point Analysis and Verification “W” Processor Mechanism and shows where the Prot2 Protect Anything Object Identification Unit3D Spatial Point Analysis and Verification “W” Processor W1 Data created for registration, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “W” Data Storage 1 and numerical data in Prot2 “W” Data Storage2.

FIG. 195-D describes GSense Prot2 Protect Anything Object Identification Unit 3D Spatial Point Analysis and Verification “W” Processor Mechanism and shows where the Prot2 Protect Anything Object Identification Unit3D Spatial Point Analysis and Verification “W” Processor W2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “W” Data Storage 1 and numerical data in Prot2 “W” Data Storage2, 8. Compares W1 data to W2 data and send to verification, 9. Where a match combined with 5 out of 7 positive point evaluations returns “the object is, and identified”, 10. Where a non match returns negative point evaluation.

FIG. 195-E describes GSense Prot2 Protect Anything Object Identification Unit 3D Spatial Point Analysis and Verification “W” Processor Mechanism and shows the GSense Prot2 “W” Data Storage1.

FIG. 195-F describes GSense Prot2 Protect Anything Object Identification Unit 3D Spatial Point Analysis and Verification “W” Processor Mechanism and shows the GSense Prot2 “W” Data Storage2.

FIG. 195-G describes GSense Prot2 Protect Anything Object Identification Unit 3D Spatial Point Analysis and Verification “W” Processor Mechanism and shows where the W1 to W2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, fourier descriptors analysis, brightness interpolation comparison analysis, octal dump conversion analysis, vector overlay pattern analysis, audio wave form pattern analysis, and audio converted to image comparative analysis.

FIG. 195-H describes GSense Prot2 Protect Anything Object Identification Unit 3D Spatial Point Analysis and Verification “W” Processor Mechanism and shows the Protect Anything CODEFA mechanism that provides storage, security, human key and tracking features.

FIG. 195-I describes GSense Prot2 Protect Anything Object Identification Unit 3D Spatial Point Analysis and Verification “W” Processor Mechanism and shows where the W W W or World Wide Web is used for data aggregation and comparison analysis methods Hello, John! Computer Laptop or Mobile device.

FIG. 195-A describes GSense Prot2 Protect Anything Object Identification Unit Object Identification “R” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 195-B describes GSense Prot2 Protect Anything Object Identification Unit Object Identification “R” Processor Mechanism and shows where the W W W or World Wide Web is used for data aggregation and comparison analysis methods.

FIG. 195-C describes GSense Prot2 Protect Anything Object Identification Unit Object Identification “R” Processor Mechanism and shows where the Prot2 Protect Anything Object Identification Unit Object Identification Form Pixel “R” Processor R1 Data created for registration Automatic Object Identification, views background compared with foreground and attaches box around moving object with 16 pixels distance around the edge, locks on, gets image for beginning of processing then . . . , 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “R” Data Storage 1 and numerical data in Prot2 “R” Data Storage2.

FIG. 195-D describes GSense Prot2 Protect Anything Object Identification Unit Object Identification “R” Processor Mechanism and shows where the Prot2 Protect Anything Object Identification Unit Object Identification Form Pixel “R” Processor R2 Data created for identification Automatic Object Identification then . . . , 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “R” Data Storage 1 and numerical data in Prot2 “R” Data Storage2, 8. Compares R1 data to R2 data and send to verification, 9. Where a match combined with 5 out of 7 positive point evaluations returns “the object is, and identified”, 10. Where a non match returns negative point evaluation.

FIG. 195-E describes GSense Prot2 Protect Anything Object Identification Unit Object Identification “R” Processor Mechanism and shows the GSense Prot2 “R” Data Storage1.

FIG. 195-F describes GSense Prot2 Protect Anything Object Identification Unit Object Identification “R” Processor Mechanism and shows the GSense Prot2 “R” Data Storage2.

FIG. 195-G describes GSense Prot2 Protect Anything Object Identification Unit Object Identification “R” Processor Mechanism and shows where the R1 to R2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 195-H describes GSense Prot2 Protect Anything Object Identification Unit Object Identification “R” Processor Mechanism and shows the Protect Anything CODEFA mechanism that provides storage, security, human key and tracking features.

FIG. 195-I describes GSense Prot2 Protect Anything Object Identification Unit Object Identification “R” Processor Mechanism and shows where the W W W or world wide web is used for data aggregation and comparison analysis methods Hello, John! Computer Laptop or Mobile device.

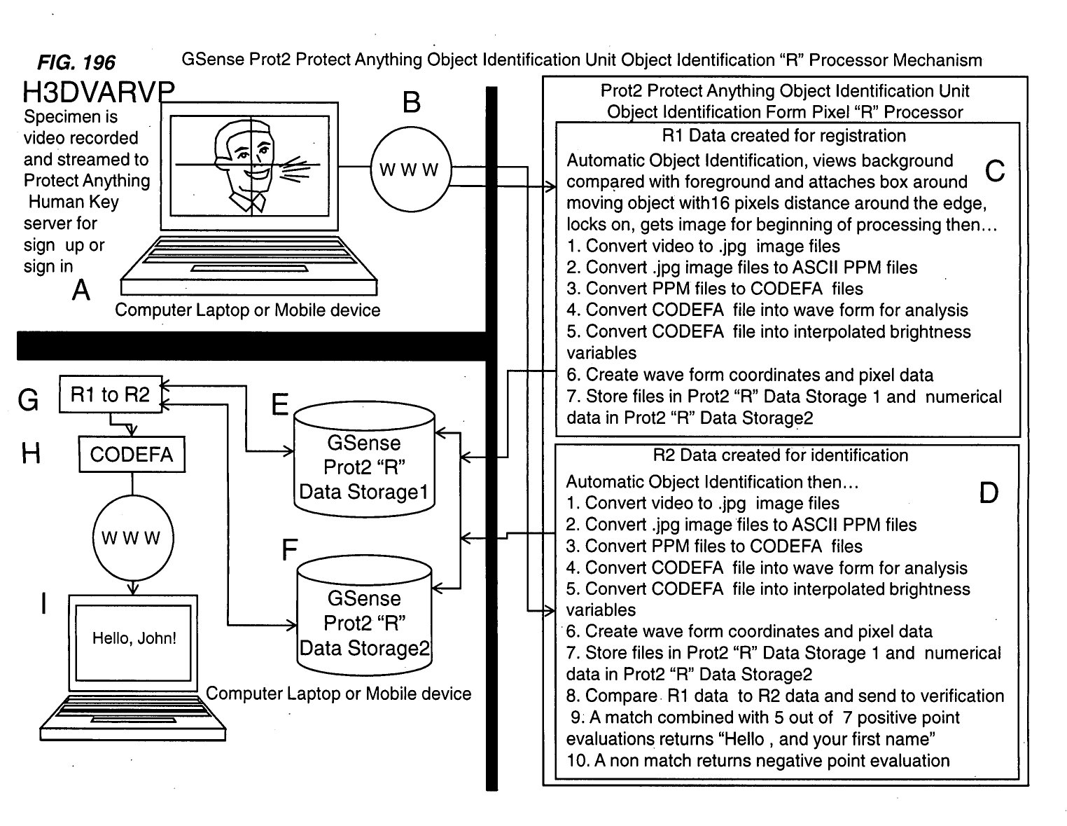

FIG. 196-A describes GSense Prot2 Protect Anything Object Identification Unit Image Slice Encoder Pixel “S” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 196-B describes GSense Prot2 Protect Anything Object Identification Unit Image Slice Encoder Pixel “S” Processor and shows where the W W W or World Wide Web is used for data aggregation and comparison analysis methods.

FIG. 196-C describes GSense Prot2 Protect Anything Object Identification Unit Image Slice Encoder Pixel “S” Processor and shows where the Prot2 Protect Anything Object Identification Unit Image Slice Encoder Pixel “S” Processor S1 Data created for registration, 1. From Video extracts 3 image files at random times, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “S” Data Storage 1 and numerical data in Prot2 “S” Data Storage2.

FIG. 196-D describes GSense Prot2 Protect Anything Object Identification Unit Image Slice Encoder. Pixel “S” Processor and shows where the Prot2 Protect Anything Object Identification Unit Image Slice Encoder Pixel “S” Processor S2 Data created for identification, 1. From Video extracts 3 image files at random times, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Stores files in Prot2 “S” Data Storage 1 and numerical data in Prot2 “S” Data Storage 2, 8. Compares S1 data to S2 data and send to verification, 9. Where a match combined with 5 out of 7 positive point evaluations returns “the object is, and identified”, 10. Where a non match returns negative point evaluation, 11. Where encrypted extracted code is subtracted or added for security and tracking in the Protect Anything CODEFA mechanism that provides storage, security, human key and tracking features storage retrieval mechanism.

FIG. 196-E describes GSense Prot2 Protect Anything Object identification Unit Image Slice Encoder Pixel “S” Processor and shows the GSense Prot2 “S” Data Storage1.

FIG. 196-F describes GSense Prot2 Protect Anything Object Identification Unit Image Slice Encoder Pixel “S” Processor and shows the GSense Prot2 “S” Data Storage2.

FIG. 196-G describes GSense Prot2 Protect Anything Object Identification Unit Image Slice Encoder Pixel “S” Processor and shows where the S1 to S2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 196-H describes GSense Prot2 Protect Anything Object Identification Unit Image Slice Encoder Pixel “S” Processor and shows the Protect Anything CODEFA mechanism that provides storage, security, human key and tracking features.

FIG. 196-I describes GSense Prot2 Protect Anything Object Identification Unit Image Slice Encoder Pixel “S” Processor and shows where the W W W or World Wide Web is used for data aggregation and comparison analysis methods Hello, John! Computer Laptop or Mobile device.

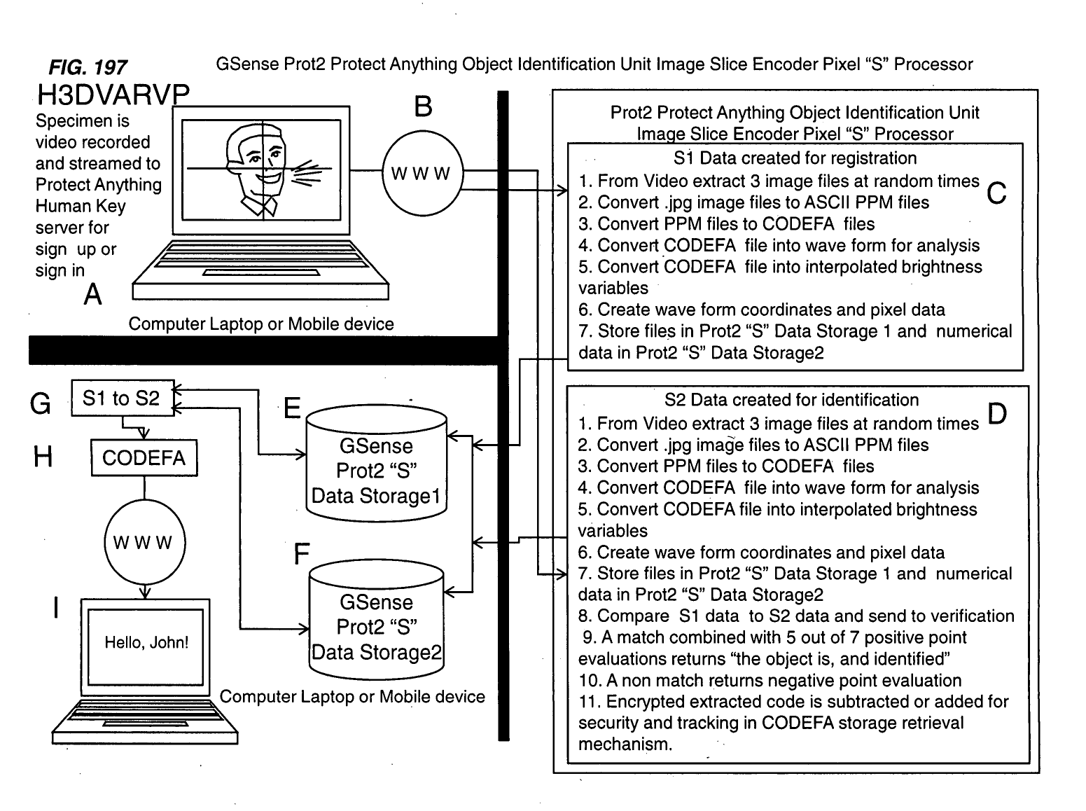

FIG. 197-A describes GSense Prot2 Protect Anything Object Identification Unit Brightness Interpolation Pixel “T” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

FIG. 197-B describes GSense Prot2 Protect Anything Object Identification Unit Brightness Interpolation Pixel “T” Processor and shows where the W W W or World Wide Web is used for data aggregation and comparison analysis methods.

FIG. 197-C describes GSense Prot2 Protect Anything Object Identification Unit Brightness Interpolation Pixel “T” Processor and shows where the Prot2 Protect Anything Object Identification Unit Video Wave Form Pixel “T” Processor T1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Creates 6 additional levels or brightness + and −, 8. Stores files in Prot2 “T” Data Storage 1 and numerical data in Prot2 “T” Data Storage2.

FIG. 197-D describes GSense Prot2 Protect Anything Object Identification Unit Brightness Interpolation Pixel “T” Processor and shows where the Prot2 Protect Anything Object Identification Unit Video Wave Form Pixel “T” Processor E2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into wave form for analysis, 5. Converts Protect Anything CODEFA mechanism that provides storage, security, human key and tracking features file into interpolated brightness variables, 6. Creates wave form coordinates and pixel data, 7. Creates 6 additional levels or brightness + and −, 8. Stores files in Prot2 “T” Data Storage 1 and numerical data in Prot2 “T” Data Storage 2, 9. Compares T1 data to T2 data and send to verification, 9. Where a match combined with 5 out of 7 positive point evaluations returns “the object is, and identified”, 10. Where a non match returns negative point evaluation.

FIG. 197-E describes GSense Prot2 Protect Anything Object Identification Unit Brightness Interpolation Pixel “T” Processor and shows the GSense Prot2 “T” Data Storage1.

FIG. 197-F describes GSense Prot2 Protect Anything Object Identification Unit Brightness Interpolation Pixel “T” Processor and shows the GSense Prot2 “T” Data Storage2.

FIG. 197-G describes GSense Prot2 Protect Anything Object Identification Unit Brightness Interpolation Pixel “T” Processor and shows where the T1 to T2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.

FIG. 197-H describes. GSense Prot2 Protect Anything Object Identification Unit Brightness Interpolation Pixel “T” Processor and shows the Protect Anything CODEFA mechanism that provides storage, security, human key and tracking features.

FIG. 197-I describes GSense Prot2 Protect Anything Object Identification Unit Brightness Interpolation Pixel “T” Processor and shows where the W W W or World Wide Web is used for data aggregation and comparison analysis methods “Hello, John” with a Computer Laptop or Mobile device.

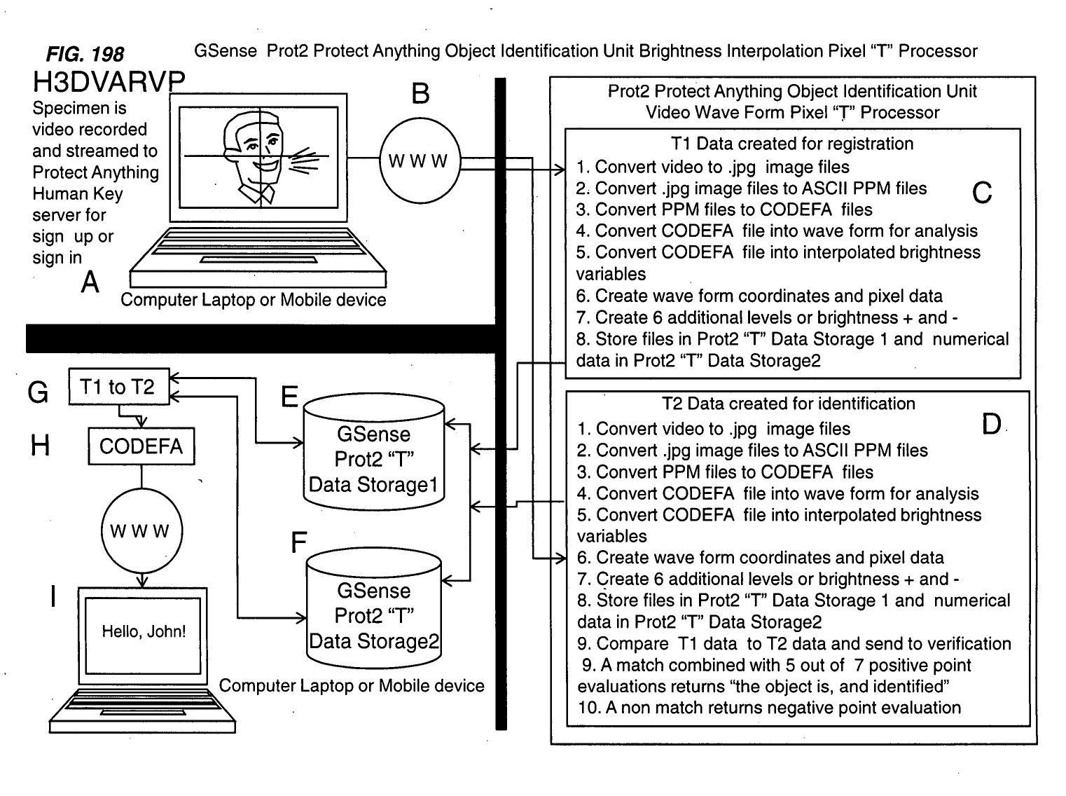

FIG. 198-A describes GSense Prot2 Protect Anything Object Identification Unit Verification Processor Mechanism and shows where all the processors are evaluated.

FIG. 198-B describes GSense Prot2 Protect Anything Object Identification Unit Verification Processor Mechanism and shows the GSense Data Storage1.

FIG. 198-C describes GSense Prot2 Protect Anything Object Identification Unit Verification Processor Mechanism and shows the GSense Data Storage2.

FIG. 198-D describes GSense Prot2 Protect Anything Object Identification Unit Verification Processor Mechanism and shows where the Data is compared to determine if it is from the same human or object.

FIG. 198-E describes GSense Prot2 Protect Anything Object Identification Unit Verification Processor Mechanism and shows where a match combined with 5 out of 7 positive point evaluations returns “the object is, and identified”.

FIG. 198-F describes GSense Prot2 Protect Anything Object Identification Unit Verification Processor Mechanism and shows where a non match returns negative point evaluation.

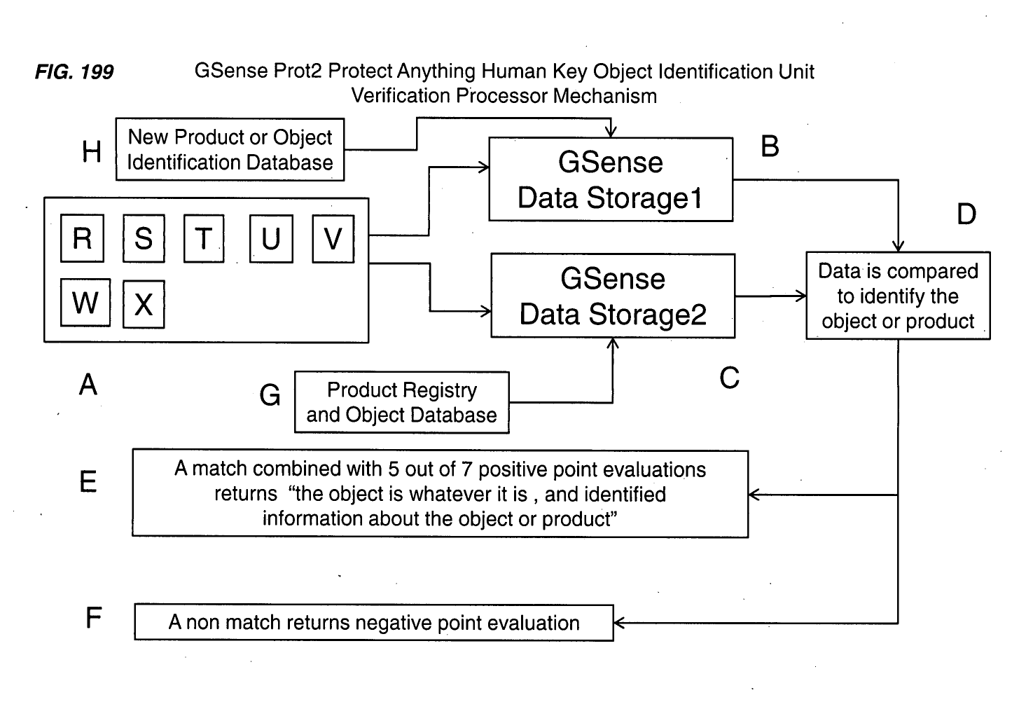

FIG. 199-A describes GSense Prot2 Protect Anything Object Identification Unit Verification Processor Mechanism where the R, S, T, U, V, W, X object identification processors are used to compare the product registry and objects database data with the new product or object identification database for possible matches.

FIG. 199-B describes GSense Prot2 Protect Anything Object Identification Unit Verification Processor Mechanism GSense Data Storage 1 area with new product or object identification database.

FIG. 199-C describes GSense Prot2 Protect Anything Object Identification Unit Verification Processor Mechanism GSense Data Storage 2 area with pre entered product registry and object database data.

FIG. 199-D describes GSense Prot2 Protect Anything Object Identification Unit Verification Processor Mechanism is where data is compared to identify the object or the product.

FIG. 199-E describes GSense Prot2 Protect Anything Object Identification Unit Verification Processor Mechanism where a match combined with 5 out of 7 positive point evaluations returns “the object is whatever it is, and identified information about the object or product”.

FIG. 199-F describes GSense Prot2 Protect Anything Object Identification Unit Verification Processor Mechanism where a non match returns negative point evaluation.

FIG. 199-G describes GSense Prot2 Protect Anything Object Identification Unit Verification Processor Mechanism Product Registry and Object Database.

FIG. 199-H describes GSense Prot2 Protect Anything Object Identification Unit Verification Processor Mechanism the New Product or Object identification Database.

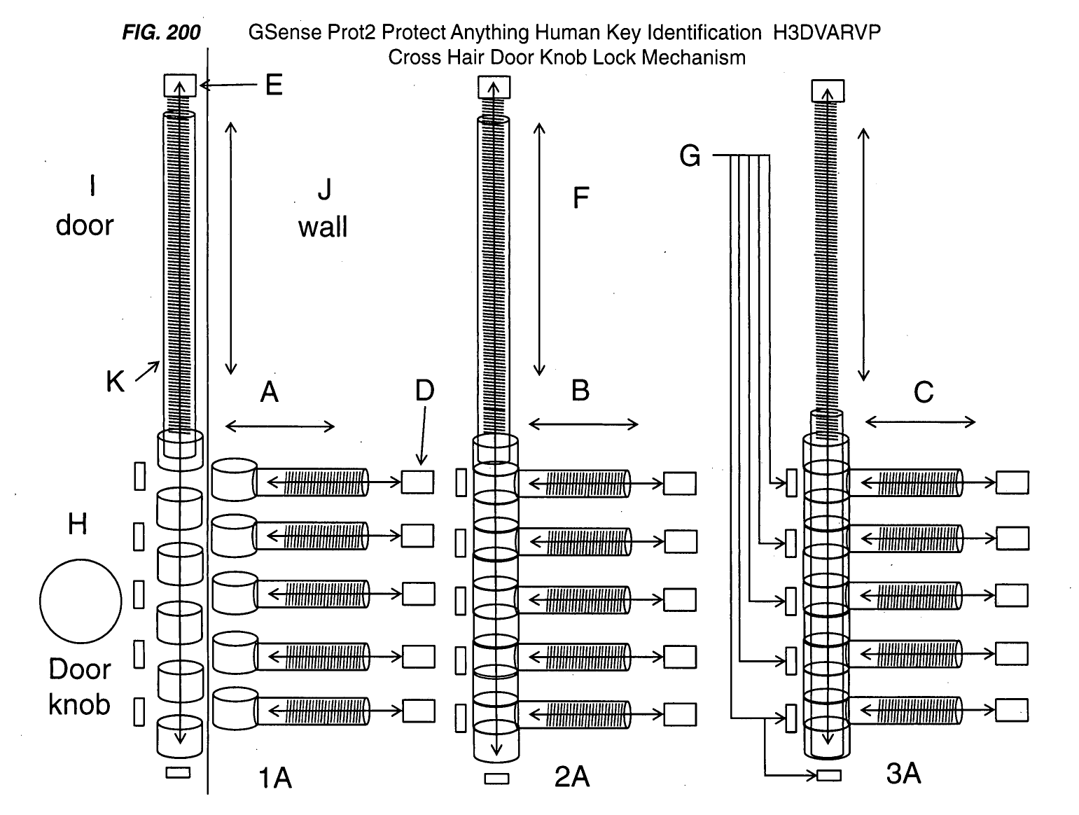

FIG. 200-1A describes GSense Prot2 Protect Anything Human Identification Cross Hair Door Knob Lock Mechanism bolt mechanism in the open unlocked position where the left right 5 bolts are at the far right position and the up down pin is fully raised.

FIG. 200-2A describes GSense Prot2 Protect Anything Human Identification Cross Hair Door Knob Lock Mechanism bolt mechanism in the second phase of locking position where the left right 5 bolts are at the far left position and the up down pin is fully raised about to be moved down.

FIG. 200-3A describes GSense Prot2 Protect Anything Human Identification Cross Hair Door Knob Lock Mechanism bolt mechanism is in the locked position where the left right 5 bolts are at the far left position and the up down pin is fully lowered down.

FIG. 200-A describes GSense Prot2 Protect Anything Human Identification Cross Hair Door Knob Lock Mechanism where the left right 5 bolts move left right with servo screw.

FIG. 200-B describes GSense Prot2 Protect Anything Human Identification Cross Hair

Door Knob Lock Mechanism where the left right 5 bolts move left right with servo screw.

FIG. 200-C describes GSense Prot2 Protect Anything Human Identification Cross Hair Door Knob Lock Mechanism where the left right 5 bolts move left right with servo screw.

FIG. 200-D describes GSense Prot2 Protect Anything Human Identification Cross Hair Door Knob Lock Mechanism left right bolt servo.

FIG. 200-E describes GSense Prot2 Protect Anything Human Identification Cross Hair Door Knob Lock Mechanism up down pin servo.

FIG. 200-F describes GSense Prot2 Protect Anything Human Identification Cross Hair Door Knob Lock Mechanism up down pin screw connected to servo.

FIG. 200-G describes GSense Prot2 Protect Anything Human Identification Cross Hair Door Knob Lock Mechanism motion impact sensors.

FIG. 200-H describes GSense Prot2 Protect Anything Human Identification Cross Hair Door Knob Lock Mechanism door knob next to the lock mechanism.

FIG. 200-I describes GSense Prot2 Protect Anything Human Identification Cross Hair Door Knob Lock Mechanism door facing wall lock mechanism.

FIG. 200-J describes GSense Prot2 Protect Anything Human Identification Cross Hair Door Knob Lock Mechanism wall fading door lock.

FIG. 200-K describes GSense Prot2 Protect Anything Human Identification Cross Hair Door Knob Lock Mechanism up down servo screw in pin assembly.

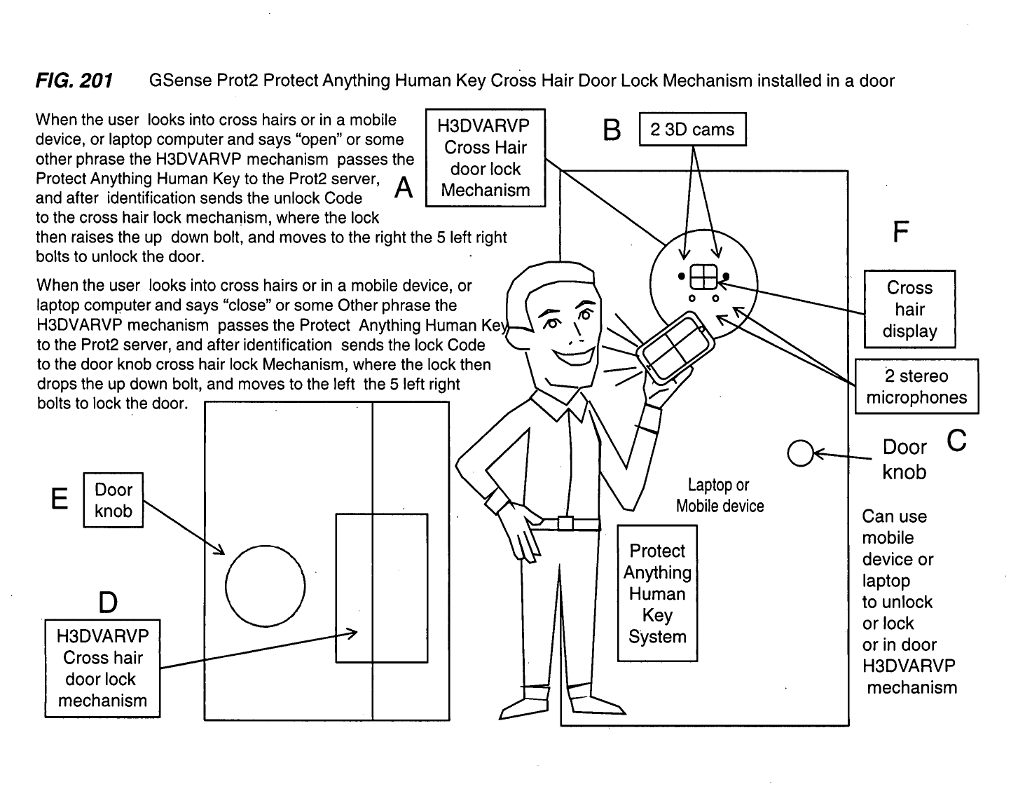

FIG. 201-A describes GSense Prot2 Protect Anything Cross Hair Door Lock Mechanism installed in a door where the user looks into cross hairs on the door or in a mobile device, or laptop computer and says “open” or some other phrase the H3DVARV mechanism passes the Protect Anything Human Key to the Prot2 server, and after identification sends the unlock Code to the cross hair lock mechanism, where the lock then raises the up down bolt, and moves to the right the 5 left right bolts to unlock the door, then when the user looks into cross hairs or in a mobile device, or laptop computer and says “close” or some other phrase the H3DVARV mechanism passes the Protect Anything Human Key to the Prot2 server, and after identification sends the lock Code to the door knob cross hair lock Mechanism, where the lock then drops the up down bolt, and moves to the left the 5 left right bolts to lock the door.

FIG. 201-B describes GSense Prot2 Protect Anything Cross Hair Door Lock Mechanism installed in a door and shows the mechanism in the door and shows the 2 3D cams from the H3DVARV mechanism.

FIG. 201-C describes GSense Prot2 Protect Anything Cross Hair Door Lock Mechanism installed in a door and shows the door knob and 2 stereo microphones from the H3DVARV mechanism and shows where you can use a mobile device or laptop to unlock or lock or in door H3DVARV mechanism.

FIG. 201-D describes GSense Prot2 Protect Anything Cross Hair Door Lock Mechanism installed in a door and shows where the H3DVARV Cross hair door lock mechanism is positioned next to the door knob of the door.

FIG. 201-E describes GSense Prot2 Protect Anything Cross Hair Door Lock Mechanism installed in a door and shows the door knob.

FIG. 201-F describes GSense Prot2 Protect Anything Cross Hair Door Lock Mechanism installed in a door and shows the cross hairs display for identification with the Protect Anything Human Key mechanism.

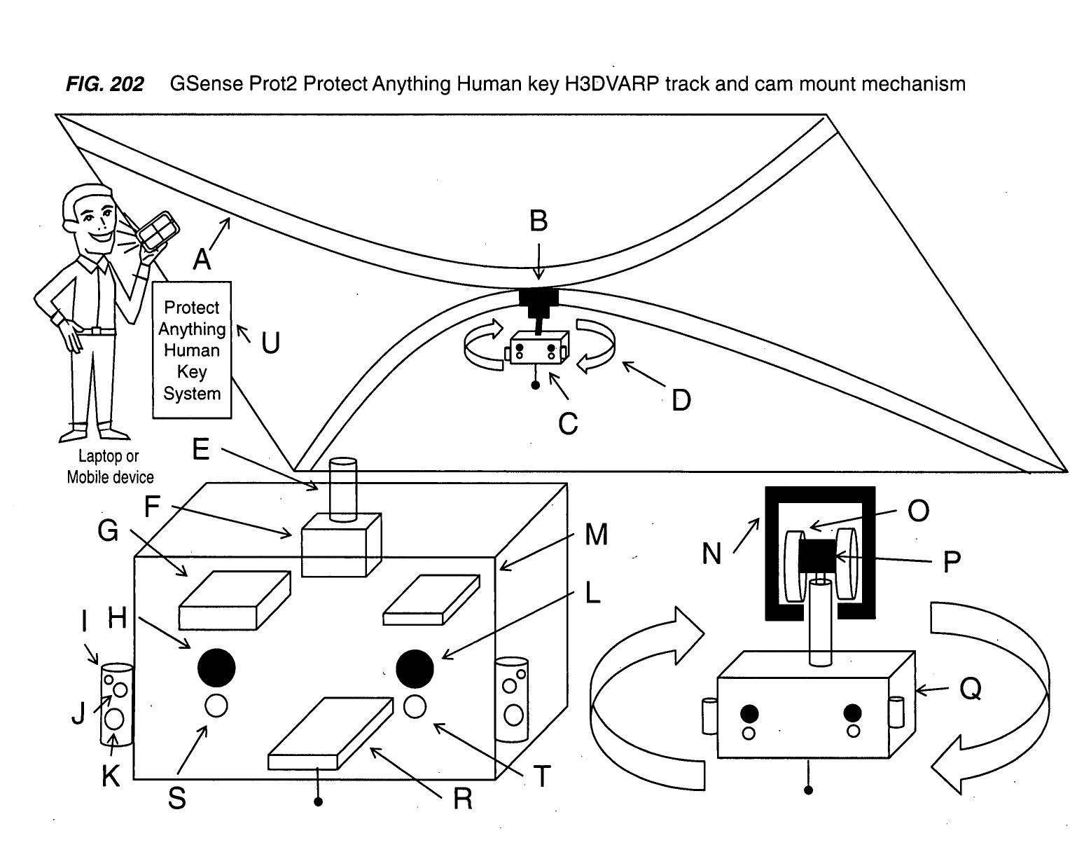

FIG. 202-A describes GSense Prot2 Protect Anything H3DVARV track and cam mount mechanism and shows the ceiling track that the H3DVARV mechanism can run along wirelessly for recording and projection.

FIG. 202-B describes GSense Prot2 Protect Anything H3DVARV track and cam mount mechanism and shows the motor movement servo and motor controller.

FIG. 202-C describes GSense Prot2 Protect Anything H3DVARV track and cam mount mechanism unit connected to the room ceiling track.

FIG. 202-D describes GSense Prot2 Protect Anything H3DVARV track and cam mount mechanism shows how the 3D cam unit can go in a 360 degree movement.

FIG. 202-E describes GSense Prot2 Protect Anything H3DVARV track and cam mount mechanism shows the servo holder connected to the motor controller and servo controller unit.

FIG. 202-F describes GSense Prot2 Protect Anything H3DVARV track and cam mount mechanism and shows the servo controller unit.

FIG. 202-G describes GSense Prot2 Protect Anything H3DVARV track and cam mount mechanism cpu unit and controller.

FIG. 202-H describes GSense Prot2 Protect Anything H3DVARV track and cam mount mechanism left 3D cam.

FIG. 202-I describes GSense Prot2 Protect Anything H3DVARV track and cam mount mechanism IR sensor for distance measurement.

FIG. 202-J describes GSense Prot2 Protect Anything H3DVARV track and cam mount mechanism Sonar sensor for distance measurement.

FIG. 202-K describes GSense Prot2 Protect Anything H3DVARV track and cam mount mechanism stereo microphones for binaural recording.

FIG. 202-L describes GSense Prot2 Protect Anything H3DVARV track and cam mount mechanism right 3D cam.

FIG. 202-M describes GSense Prot2 Protect Anything H3DVARV track and cam mount mechanism flash storage unit.

FIG. 202-N describes GSense Prot2 Protect Anything H3DVARV track and cam mount mechanism that shows track for camera movement forward and backward.

FIG. 202-O describes GSense Prot2 Protect Anything H3DVARV track and cam mount mechanism that shows wheels in track for vibration free movement.

FIG. 202-P describes GSense Prot2 Protect Anything H3DVARV track and cam mount mechanism motor servo controller mechanism.

FIG. 202-Q describes GSense Prot2 Protect Anything H3DVARV track and cam mount mechanism and shows the H3DVARVP unit that can rotate 360 degrees.

FIG. 202-R describes GSense Prot2 Protect Anything H3DVARV track and cam mount mechanism wireless communication controller with antennae.

FIG. 202-S describes GSense Prot2 Protect Anything H3DVARV track and cam mount mechanism left projection lense.

FIG. 202-T describes GSense Prot2 Protect Anything H3DVARV track and cam mount mechanism right projection lense.

FIG. 202-U describes GSense Prot2 Protect Anything H3DVARV track and cam mount mechanism where a user can use their Protect Anything Human Key to get into the ceiling cam unit that is recording on the track movement grid, and can control the cam movement and recording or let the mechanism do it automatically, with lock ons to moving subject for recording.

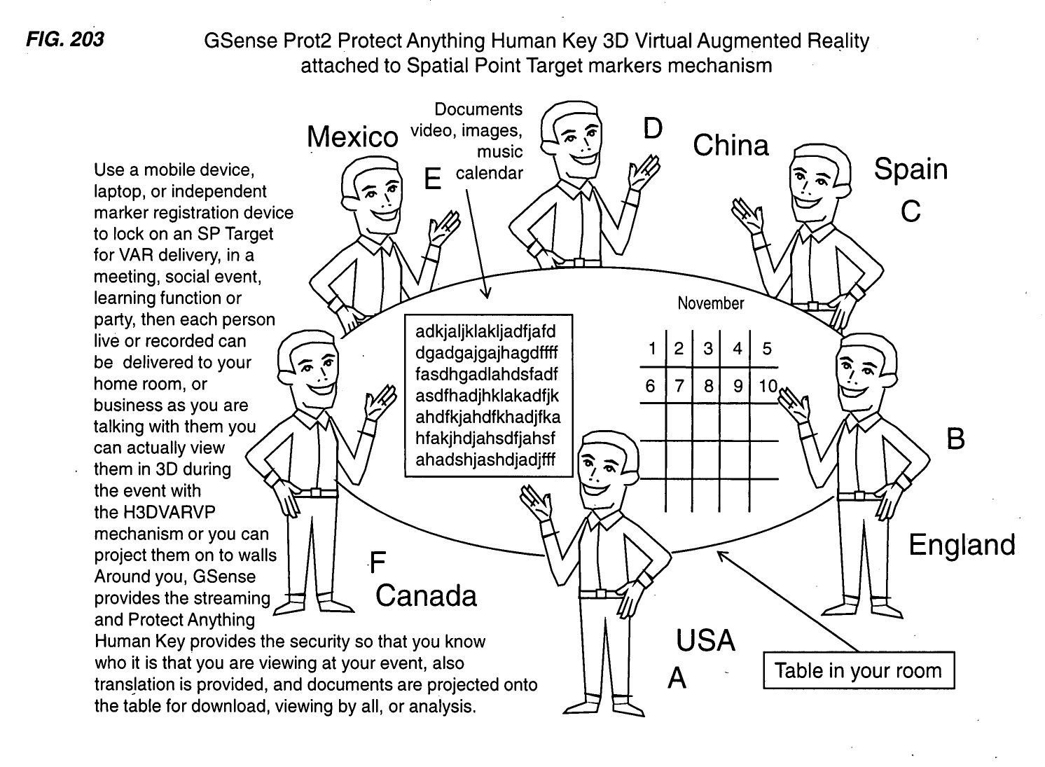

FIG. 203-A describes GSense Prot2 Protect Anything Human Key 3D Virtual Augmented Reality attached to Spatial Point Target markers mechanism where you as the USA participant is having a virtual meeting with people from other countries, and furthermore describes Use a mobile device, laptop, or independent marker registration device to lock on an SP Target for VAR delivery, in a meeting, social event, learning function or party, then each person live or recorded can be delivered to your home room, or business as you are talking with them you can actually view them in 3D during the event with the H3DVARVP mechanism or you can project them on to walls Around you, GSense provides the streaming and Protect Anything Human Key provides the security so that you know who it is that you are viewing at your event, also translation is provided, and documents are projected onto the table for download, viewing by all, or analysis.

FIG. 203-B describes GSense Prot2 Protect Anything Human Key 3D Virtual Augmented Reality attached to Spatial Point Target markers mechanism where the England participant is having a virtual meeting with people from other countries, and furthermore describes Use a mobile device, laptop, or independent marker registration device to lock on an SP Target for VAR delivery, in a meeting, social event, learning function or party, then each person live or recorded can be delivered to your home room, or business as you are talking with them you can actually view them in 3D during the event with the H3DVARVP mechanism or you can project them on to walls Around you, GSense provides the streaming and Protect Anything Human Key provides the security so that you know who it is that you are viewing at your event, also translation is provided, and documents are projected onto the table for download, viewing by all, or analysis.

FIG. 203-C describes GSense Prot2 Protect Anything Human Key 3D Virtual Augmented Reality attached to Spatial Point Target markers mechanism where the Spain participant is having a virtual meeting with people from other countries, and furthermore describes Use a mobile device, laptop, or independent marker registration device to lock on an SP Target for VAR delivery, in a meeting, social event, learning function or party, then each person live or recorded can be delivered to your home room, or business as you are talking with them you can actually view them in 3D during the event with the H3DVARVP mechanism or you can project them on to walls Around you, GSense provides the streaming and Protect Anything Human Key provides the security so that you know who it is that you are viewing at your event, also translation is provided, and documents are projected onto the table for download, viewing by all, or analysis.

FIG. 203-D describes GSense Prot2 Protect Anything Human Key 3D Virtual Augmented Reality attached to Spatial Point Target markers mechanism where the China participant is having a virtual meeting with people from other countries, and furthermore describes Use a mobile device, laptop, or independent marker registration device to lock on an SP Target for VAR delivery, in a meeting, social event, learning function or party, then each person live or recorded can be delivered to your home room, or business as you are talking with them you can actually view them in 3D during the event with the H3DVARVP mechanism or you can project them on to walls Around you, GSense provides the streaming and Protect Anything Human Key provides the security so that you know who it is that you are viewing at your event, also translation is provided, and documents are projected onto the table for download, viewing by all, or analysis.

FIG. 203-E describes GSense Prot2 Protect Anything Human Key 3D Virtual Augmented Reality attached to Spatial Point Target markers mechanism where the Mexico participant is having a virtual meeting with people from other countries, and furthermore describes Use a mobile device, laptop, or independent marker registration device to lock on an SP Target for VAR delivery, in a meeting, social event, learning function or party, then each person live or recorded can be delivered to your home room, or business as you are talking with them you can actually view them in 3D during the event with the H3DVARVP mechanism or you can project them on to walls Around you, GSense provides the streaming and Protect Anything Human Key provides the security so that you know who it is that you are viewing at your event, also translation is provided, and documents are projected onto the table for download, viewing by all, or analysis.

FIG. 203-F describes GSense Prot2 Protect Anything Human Key 3D Virtual Augmented Reality attached to Spatial Point Target markers mechanism where the Canada participant is having a virtual meeting with people from other countries, and furthermore describes Use a mobile device, laptop, or independent marker registration device to lock on an SP Target for VAR delivery, in a meeting, social event, learning function or party, then each person live or recorded can be delivered to your home room, or business as you are talking with them you can actually view them in 3D during the event with the H3DVARVP mechanism or you can project them on to walls Around you, GSense provides the streaming and Protect Anything Human Key provides the security so that you know who it is that you are viewing at your event, also translation is provided, and documents are projected onto the table for download, viewing by all, or analysis.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method for human identification; registration; and protection executed by a computer comprising:
A. providing a 3D camera; audio and video recorder; a viewer; a RFID tag reader a coder and decoder; and an infrared reader;
initiating a motion detector;
aggregating and comparing background with foreground automatically for 3D verification;
determining an infrared distance between the camera and a person;
forming a pixel box around any moving objects;
centering crosshairs on the nose of a person;
locking on to the face of the person;
storing the data aggregated in video form;
extracting and storing a first image;
transforming the image utilizing a brightness modified interpolation method;
B. initiating a modified color interpolation method on the images;
converting the images to vector line art and storing the files;
establishing the center locked on point and identifying human eyes as a marker for all other processes;
locking on the image with 16 pixels around the edge of the person's face;
storing the image file for further analysis;
recording the streamed video with an audio phrase spoken by the person;
C. converting the original 3D video audio files and sending the images to a process server for storing the images;
providing a server for storage; security; human key and tracking features;
transforming the images utilizing the brightness modified interpolation method initiated on the original images;
storing the data with a plurality of levels each way darker and lighter;
transforming the images utilizing a color modified interpolation method;
storing the data with a plurality of levels of red, green and blue color up and down from actual original image color data;
using a Fourier wave transformation to convert the images;
mapping out the pixel position of the converted images into a RGB grid PPM file;
converting the files pixels into RGB numbers and then storing the data for later analysis
D. converting the audio files into an audio wave form pattern and storing the data;
converting the audio into images and storing the files;
performing a Fourier wave transformation on the original files and storing the files;
mapping out the pixel position into a RGB grid PPM file;
converting the pixels into RGB numbers and storing the data for later analysis;
E. converting original video files into images;
extracting a plurality of images at the beginning of audio phrase spoken;
extracting a plurality of images at selected mark of audio phrase start;
extracting a plurality of images backward at end of audio phrase stop;
storing the extracted images;
transforming the images with a brightness modified interpolation method which is initiated on the images and storing the files in a plurality of levels each way darker and lighter;
using a color modified interpolation method on the images and storing the files in a plurality of levels of red, green and blue color up and down from actual original image color data;
performing a Fourier wave transformation and storing the data;
mapping out the pixel position of the image data into a RGB grid PPM file;
converting the pixels into RGB numbers;
storing the data for later analysis;
F. extracting a plurality of random image slices from the original video file;
extracting an image slice from the beginning of the audio track where an audio phrase starts;
extracting an image slice from the middle of the audio track phrase;
extracting an image slice from the end of audio phrase spoken track;
storing the image slices;
transforming the images utilizing the brightness modified interpolation method;
storing the data in a plurality of individual levels each way darker and lighter;
initiating the color modified interpolation method;
storing the data in a plurality of levels of red, green and blue color up and down from actual original image color data;
converting the images into an octal dump;
storing the octal dump for later analysis;
G. extracting images created from the original video and storing the files;
transforming the images utilizing the brightness modified interpolation method initiated on the images;
storing the data in a plurality of levels each way darker and lighter;
initiating the color modified interpolation method on the images and storing the data in a plurality of levels of red, green and blue color up and down from actual original image color data;
transforming the images by performing an average color matrix analysis;
storing the resulting images;
converting the data to PPM files and storing the files;
processing the PPM files using the brightness modified interpolation method;
processing the data in a plurality of levels on all pixels and saving the data into files for later pattern analysis;
H. verifying that the original video was of an actual 3D live human;
using specific point movement analysis that compares the background to the foreground identifying movement patterns;
extracting images from the original video;
transforming the images utilizing the brightness modified interpolation method;
storing the data in a plurality of levels each way darker and lighter;
initiating the color modified interpolation method on the images and storing the data in a plurality of levels of red, green and blue color up and down from the actual original image color data;
reducing the images to just two colors for evaluation;
storing those images if the object is a real 3D live human for further analysis;
storing audio from the video;
processing the video and audio;
verifying the files;
storing the files during the verification state;
determining the video and audio spatial point targets utilizing sound wave analysis and infrared distance analysis information taken from the storing for later analysis;
I. then the Human Semantic Phrase Comparative Analysis “G” Processor mechanism;
comparing the original audio to a phrase typed at registration and spoken;
converting the audio into an image file;
converting the file using a Fourier wave transformation and storing the file for further analysis;
converting the image file to a PPM file;
mapping the RGB coordinates of the PPM file into a pattern matching grid;
populating the grid and storing if for later analysis;
J. taking original video and original audio input and storing the files;
extracting images from the original video files and stored,
transforming the images utilizing the brightness modified interpolation method which is initiated on the images;
storing the data in a plurality of levels each way darker and lighter;
initiating the color modified interpolation method on the images;
storing the data in a plurality of levels of red, green and blue color up and down from the actual original image color data;
performing a Fourier wave transformation on the images;
converting the original audio files using a Fourier wave transformation into specimen files and storing the files;
converting all the specimen files into an octal dump;
performing code matching on the octal dump files and storing in a database for later analysis;
K. taking original video and original audio and storing the files;
initiating the Fourier wave transformation on the files and storing the converted files;
creating a 3D model;
determining spatial points from the 3D model;
performing analysis of the spatial points and calculating the files into numbers and storing for later analysis;
L. receiving audio input storing it into files;
overlaying with the octal dump from step F with the populated grid from step I;
mapping out a grid into a file and then storing the file;
converting the file into numbers and storing for later analysis;
M. taking original video and audio input and storing it into files;
transforming the video into images tracked and encoded with audio and storing the files;
transforming the image utilizing the brightness modified interpolation method which initiated on the images;
storing the data in a plurality of levels each way darker and lighter;
initiating the color modified interpolation method on the images;
storing the data in a plurality of levels of red, green and blue color up and down from actual original image color data;
converting the video and audio files using a Fourier wave transformation;
performing a maximum distance analysis;
performing a mean distance analysis;
performing a mathematical error/data fit analysis;
performing a average color matrix analysis;
performing a fractal dimensions comparisons analysis;
performing an audio wave form pattern analysis;
storing the data;
converting the audio into images tracked and encoded with video;
mapping out the pixel position into a grid;
converting the image file to a PPM file;
converting the pixels into RGB numbers;
storing the data for later analysis;
N. taking original video and storing it into files;
converting the video into images and storing the image files;
transforming the image utilizing the brightness modified;
initiating a brightness interpolation method on the images;
storing the data in a plurality of levels each way darker and lighter;
initiating the color modified interpolation method is initiated on the images;
storing the data in a plurality of levels of red, green and blue color up and down from actual original image color data;
converting the files into gray scale images and storing the files;
converting the files into vector line art images that are stored,
mapping out the pixel positions of the vector line art images into a grid and storing the files;
converting the pixels into numbers; and then storing the data for later analysis;
O. taking original video input and storing it into files;
converting original video into images and storing the files;
transforming the images utilizing the brightness modified interpolation method which is initiated on the images;
storing the data in a plurality of levels each way darker and lighter;
initiating the color modified interpolation method on the images;
storing the data in a plurality of levels of red, green and blue color up and down from actual original image color data;
converting the resulting video image files using a Fourier wave transformation mechanism;
converting the files into a plurality of gray scale color images;
storing the images;
mapping out the pixel position into a grid and storing the image files as PPM files;
converting the pixels of the files into RGB numbers; then the mechanism storing the data for later analysis;
P. taking original video input and storing it into files;
converting original video into images;
mapping the images to the audio that is input and is tracked and storing the files;
mapping out the pixel positions into a grid with a plurality of bands;
extracting images from band areas after audio phrase speaking starts and storing the files;
transforming the image utilizing the brightness modified interpolation method which is initiated on the images;
storing the data in a plurality of levels each way darker and lighter;
initiating the color modified interpolation method on the images;
storing the data in a plurality of levels of red, green and blue color up and down from actual original image color data;
creating a Fourier wave transformation form analysis file and storing it;
creating levels of lightness and darkness;
converting the image file to a PPM file and it is stored,
converting the pixels into RGB numbers patterns;
storing the data for analysis;
Q. taking the original video input and storing it into files;
converting the original video into images and storing the images;
transforming the images utilizing the brightness modified interpolation method which is initiated on the images;
storing the data in a plurality of levels each way darker and lighter;
initiating the color modified interpolation method on the images;
storing the data in a plurality of levels red, green and blue color up and down from actual image data;
calculating a pixel edge around facial features and storing the files;
locking in on the human eyes and the tip of the nose;
calculating and triangulating distance from the center point of eye to eye and from center point of nose;
mapping out the pixel position of the edge pixels and then the eye areas and nose areas into a grid and storing the files;
converting the image file to a PPM file and storing it;
converting the pixels into RGB numbers and then storing the data for later analysis;
R. taking original video and audio input and storing it into files;
extracting the audio from a video left and right stereo;
saving the data as two separate files;
initiating the Fourier wave transformation mechanism converting files to wave form data; and storing the files as image files;
converting the files data to numbers and storing the data;
overlaying and aligning the wave forms from the two image files and storing the files;
analyzing aligned wave form data and creating new numbers and storing the files;
analyzing 3D distance variations for a test of real object and not flat field object;
S. comparing information from the registration and the sign in files;
calculating percentages that are positive matches versus percentages that are negative matches for verification;
T. registering a human key by looking into the crosshairs on the display screen and speaks a phrase recorded by a person with audio and video;
storing and analyzing the audio and video;
confirming a uniquely identified registered user;
using the system to lock; protect, and unlock single items;
U. confirming a person looking at the cam and while talking or saying a phrase and recording background objects;
determining whether an object being viewed by the camera is a 3 dimensional object for verification;
comparing the camera results and analyzing the files in an overlay pixel pattern analysis method;
calculating position of forward focused objects;
calculating position and depth of background focused objects;
calculating the difference between forward focused objects and background focused objects and determining a value;
using the value to determine a 3-D preliminary security decision;
creating an audio voice print with input;
comparing a first audio print to the last audio print;
making a file security decision;

22. The method of claim 21 further comprising
beginning aggregation and comparing background with foreground automatically for 3D verification when a motion detector is triggered,
storing the data;
forming a pixel box around any moving or non-moving objects; so when an object is centered in crosshairs, the system and mechanism is locked on to the object and storing that data aggregated in video form;
extracting a first image when the lock on instigates and storing the image;
transforming the image utilizing the brightness modified interpolation method which is initiated on the images;
storing the data in a plurality of levels each way darker and lighter;
initiating the color modified interpolation method on the images;
storing the data in a plurality of levels of red, green, and blue color up and down from actual original image color data;
converting the images to vector line art and storing the files;
establishing a center locked on point along with the top of the object identified as a marker for all other processes;
locking on the image with 16 pixels around the edge of the object;
storing the image file for further analysis;
recording and storing the streamed video;
extracting three random image slices from the video file;
extracting one image from the beginning of the video track;
extracting one image from the middle of the video track;
extracting one image from the end of video track;
storing the image slices;
transforming the images utilizing the brightness modified interpolation method;
storing the data in a plurality of individual levels each way darker and lighter;
initiating the color modified interpolation method;
storing the data in a plurality of levels of red, green and blue color up and down from actual original image color data;
converting images into an octal dump and storing the data for later analysis;
extracting images created from the original video and storing the files;
transforming the images utilizing the brightness modified interpolation method;
storing the data in a plurality of levels each way darker and lighter;
initiating the color modified interpolation method on the images;
storing the data in a plurality of levels of red, green and blue color up and down from actual original image color data;
transforming the images with the average color matrix analysis mechanism;
storing the resulting images;
converting the data to PPM files and storing the files;
processing the PPM files with the interpolate brightness method;
processing the data in a plurality of levels on all pixels;
saving the data into files for later pattern analysis;
taking original video input and storing it into files;
converting the video into images and storing the image files;
transforming the image utilizing the brightness modified interpolation method which is initiated on the images;
storing the data in a plurality of levels each way darker and lighter;
initiating the color modified interpolation method on the images;
storing the data in a plurality of levels of red, green and blue color up and down from actual original image color data;
converting the files into gray scale images and storing the files;
converting the files into vector line art images that are stored;
mapping out the pixel positions of the vector line art images into a grid and storing the files;
converting the pixels into numbers; and then storing the data for later analysis;
taking original video input and storing it into files;
converting original video into images and storing the files;
transforming the images utilizing the brightness modified interpolation method which is initiated on the images;
storing the data in a plurality of levels each way darker and lighter;
initiating the color modified interpolation method on the images;
storing the data in a plurality of levels of red, green and blue color up and down from actual original image color data;
converting the resulting video image files using a Fourier wave transformation mechanism and the files are stored;
converting the files into 16 gray scale color images and storing the images;
mapping out the pixel position into a grid and storing the image files as PPM files;
converting the pixels of the files into RGB numbers;
storing the data for later analysis;
taking original video input and storing it into a file;
initiating the Fourier wave transformation mechanism on the file and storing the converted file;
creating and storing a 3D model;
determining spatial points from the 3D model and storing them in a database;
calculating the spatial points into numbers;
storing the numbers for later analysis;
taking original video input and storing it into a file;
transforming the video into images tracked and encoded and storing the file;
transforming the image utilizing the brightness modified interpolation method which is initiated on the images;
storing the data in a plurality of levels each way darker and lighter;
initiating the color modified interpolation method on the images;
storing the data in a plurality of levels of red, green and blue color up and down from actual original image color data;
converting the video files d using a Fourier wave transformation and storing the files;
analyzing the data;
running a maximum distance analysis;
running a mean distance analysis;
running a mathematical error/data fit analysis;
running an average color matrix analysis;
running a fractal dimensions comparisons analysis;
running a audio wave form pattern analysis;
storing the data;
converting the audio into images tracked and encoded with video;
mapping out the pixel position into a grid and creating a file;
converting the file to a PPM file and storing it;
converting the pixels into RGB numbers;
storing the data for later analysis;
taking comparison information from a object registration processor;
performing pattern matching with a new object data from the object identification processor;
calculating percentages that are positive matches versus percentages that are negative matches for verification;
returning a match combined with positive point evaluations or a non-match combined with negative point evaluations;
providing a data aggregator system mechanism;
recording comments on content;
providing a checks and balance system to determine the value of the content or comment;
determining advertising placement by bids;
buying and selling advertisements and locations;
receiving bids for advertising position;
purchasing advertising;
directing the advertising revenue;
targeting advertisements using the human key to spatial points for distribution to viewers;
identifying individuals with a rating to establish the identity of a person;
authenticating to establish as genuine using the human key;
verifying to prove the truth of identity of a person;
providing a touch engine that aggregates touch items into data;
providing a smell engine that aggregates smell items into data;
providing a hearing engine that aggregates audio items into data;
providing a vision engine that aggregates vision items into data;
providing a reasoning engine that provides intelligent suggestions, proposals, and decisions;
using data from the sense engines, and data stored in computers by the reasoning engine to provide intelligent suggestions, proposals, and decisions; and
use the reasoning engine in parallel with a databases for hypothesis creations and suggestions.

23. The method of claim 21 and further comprising
managing a solar panel array;
providing electronic wireless transfer to an inverter;
storing energy in individual or community batteries for later distribution;
providing a kilowatt hour bank and payment mechanism;
automatically calculating value and various correlations with costs of products and items that are currently used in the world in a database of kilowatt hours as related to dollars and other different legal currencies;
providing a kilowatt hour pricing comparison to a product registry mechanism;
providing an energy efficient manager mechanism;
providing a demand charge Manager mechanism;
calculating world geo kilowatt hour rates;
providing a kilowatt hour pay module mechanism;
protecting with a human key;
storing, banking and trading energy as currency;
providing an energy switch adapter and measurement mechanism for kilowatt hour use; and
switching the adapter off by an energy management solar server unit remotely.

24. The method of claim 21 and further comprising
determining spatial point targets for streaming content;
recording and delivering content via the camera to spatial point targets in 3D or standard media;
displaying a whole store or parts of the store into a person's home at a marked spatial point target locations for viewing and shopping;
mapping of a house or real estate to spatial point targets.

25. The method of claim 22 further comprising
using information from the database and a product object registry mechanism; and
creating a request.

26. The method of claim 21 further comprising
setting a reminder;
distributing the reminder to one or more recipients;
providing access only to the person who the reminder was intended for;
requiring digital fingerprint verification and identification;
delivering the reminder or broadcasting the reminder to spatial point targets.

27. The method of claim 22 further comprising
providing RFID chip identification;
providing invisible infrared ink marker identification coding;
providing a video infrared reader;
reading infrared invisible ink;
providing an infrared invisible ink stamper;
stamping a code stamp pattern on a product or product packaging;
rapidly coding with patterns changing to different codes as each product or product packaging goes through the process;
reading either optically with infrared or an RFID tag reader;
encoding and decoding with the infrared reader;
providing information from a product registry where information about a product is included into the product registry;
using spatial point targeting to deliver product information to a specific location;
tracking information for inventory control;
integrating consumer information with product information; and
providing a consumer rating on a product.

28. The method of claim 21 further comprising
locking and unlocking access using the cross hair lock;
identifying the owner(s) of the lock;
determining who the lock is registered to; and
locking or unlocking the lock.

29. The method of claim 22 further comprising
providing camera tracking manually or automatically moving from the front to the back of a room, and rotating 360 degrees;
recording the entire room events; and
attaching a human key for protection, storage, and distribution to one or more recipients of the recording.

30. The method of claim 22 and further comprising;
a barter network;
suggesting potential best barter deals;
adding proposals and suggestions from business or individuals to the barter network;
listing services or e property for barter on the barter network;
providing a rating shield;
estimating barter value;
estimating real value;
estimating barter value and real value for professional services that are willing to trade for other bartered items or services;
rating the deal and recording the deal for future barter deals; and
notifying members with best choice combinations.

31. The method of claim 21 further comprising
processing collaborated data or content into a new work;
uploading first content created to a server by a first user;
protecting the first content;
attaching the first content to a first user's human key;
uploading second content created to a server by a second user;
protecting the second content;
attaching the second content to a second user's human key;
licensing the rights to the first and second content by a third user;
combining the first and second content together by the third user;
notifying the parties after the combined content is created;
attaching the combined content to a human key;
recording a history of whose human key was involved in creating the combined content;
sharing the list of created works;
storing the works on a server;
attaching a human key to all incoming and outgoing content;
monitoring and managing a list of combined content;
distributing and sharing content;
including all content in a catalog for others to browse safely and protected for licensing;
proposing and approving outright purchase or license of the content by the human key attached to the content;
accepting payment for any purchase or license; and
distributing collected payments.

32. The method of claim 21 further comprising
identifying a person using an ATM;
verifying the person is the registered owner of the account; and
performing financial transactions only for the registered owner of the account.

33. The method of claim 21 further comprising
connecting individuals and groups together utilizing network devices;
enabling users to pick their own spatial point target for delivery of other users live or recorded images;
transforming content into a 3D representation; and
placing 3D content around a table virtually.

34. The method of claim 21 further comprising
using a human key by a licensed medical care practitioner to transmit secure information;
attaching a human key to the information;
viewing or transmitting information to a spatial point target;
using the human key to register and identify a patient;
providing an alert and reminder, to remind patients when to take their medications as well as reminding patients when they last took their medications and the quantities taken;
recording and transmitting alert and reminder information into patient journals and doctor journals using the human key; and
allowing patients to securely talk to their doctor(s) or other securely and communicate information.

35. The method of claim 21 further comprising
converting mobile devices for 3D recording and viewing;
recording and viewing in 3D with a split screen, with a two camera view;
creating a split screen 3D display viewing area;
providing streaming media to and from a server online; and
streaming media can delivered to spatial point targets.

36. The method of claim 21 furthermore comprising
looking into the camera by a uniquely identified individual;
stating a phrase by the individual;
verifying the individual;
requesting a payment transaction; and
authorizing the payment transaction.

37. The method of claim 21 furthermore comprising
using the human key to uniquely identify and verify a person;
registering an identified and verified person to vote;
casting a vote by an identified and verified person registered to vote; and
certifying only one vote per identified and verified person registered to vote has be placed.
